(19) United States
(12) Patent Application Publication
(10) Pub. No.: US 2007/0027787 A1
(43) Pub. Date: Feb. 1, 2007

(54) Software system for real monetary instruments

(76) Inventor: Thomas W. Tripp, Burnsville, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 10/897,358

(22) Filed: Jul. 23, 2004

Related U.S. Application Data
(63) Continuation-in-part of application No. 09/412,020, filed on Oct. 6, 1999, now abandoned.

(51) Int. Cl. G06F 17/60

(52) U.S. Cl. 705/36

(57) ABSTRACT

A data processing method for introducing an asset-backed fixed-income security that will function as a master real currency unit with a constant value. The method consists of the steps of tracking by means of a digital computer: 1) the flow of quantitative data generated by originating financial instruments denominated in a real currency unit and amortized with a real rate of interest; 2) pooling the real financial instruments for the purpose of establishing a tax conduit to issue asset-backed securities; and 3) the flow of quantitative data generated by using structured financing, such that the conduit issues a class of regular certificates and a residual class of certificates; and then denominating Class “A” certificates in a master real currency unit which can then be used by the holders to represent and transfer purchasing power in a constant monetary unit.

### I. BACKGROUND OF THE INVENTION

A. Introduction:
Article 1: Next Economic Crisis May Stem From Woes Of the World's Banks The Wall Street Journal, May 7, 1997

On May 7, 1997, the Wall Street Journal published the above article, which quotes Michel Camdessus, managing director of the International Monetary Fund, as predicting that the next international monetary crisis will begin with a banking crisis, or at least be worsened by a banking crisis. Drawing on information from the IMF, the article states that:
133 of the 181 IMF members have had significant problems since 1980 with their banking system. And, 52 developing countries have lost most or all of their banking capital, and some repeatedly.
The United States spent 3% of gross domestic product (GDP) to clean up its thrift problem, while a dozen developing countries spent 10% or more of their annual GDP to clean up a banking problem.
Cleaning up banking problems in developing countries, and those converting from communist economies, has cost close to $250 billion since 1980.
Moody's Investor Service has rated 58 banks around the world as most likely to need rescuing with 9 in Japan and 40 in emerging markets. The biggest bank rescue may be in China, where one analyst puts total potential financial losses at 20% of GDP.
Article 2: ‘It was too easy to make money’ And now the Thai economy is barely afloat, U.S. News & World Report, Jul. 28, 1997
Article 3: PARADISE LOST? As Currency Crisis Roils Asia, Thais Ask I.M.F.'s Help, Forbes, Aug. 25, 1997
Article 4: Thailand gets the bill & What the doctor ordered The Economist, Aug. 9^{th}, 1997

Less than two months later, the next crisis arrived and proved that the IMF managing director was quite correct in his prediction. This new crisis was summarized on Jul. 28, 1997, when the U.S. News & World Report published the Article 2 above, which explained that Thailand's economy was reeling from a currency devaluation of 20%. By August, Forbes magazine reported in Article 3 above that the Thai currency devaluation reached 50%. Only last year, the World Bank had praised the Thai economy for growing faster over the previous decade than any other economy in the world. Now, one of the most respected central banks in Asia, the Bank of Thailand, is striving to prevent a chain reaction of failures among financial institutions. The August 9th issue of the Economist published Article 4, which states that on August 5th, the Bank of Thailand announced that it had so far lent more than $19 billion (more than 10% of the GDP) to keep Thailand's 91 financial institutions afloat. Article 4 continued, “Understandably, the Bank (of Thailand) decided it could no longer keep printing money to sustain this . . . . Following negotiations with the IMF (for a $15 billion loan), Thailand published a list of 42 finance companies to be “suspended”, added to the 16 already closed for business while they look for a buyer or a partner for a merger. Most are likely to be shut for good.” Worst of all, the effects of Thailand's devaluation is spilling over to other Asian economies, where the impact has resulted in the stock markets of the Phillippines and Malaysia falling. In the following months, still other Asian countries watched as their currencies declined and their financial institutions began to collapse.
Article 5: Bonds Take a $659 Billion Drubbing Fortune, Jun. 27, 1994

Contrary to the Wall Street Journal (Article 1), that tended to place the emphasis on developing countries, we have experienced similar situations in the United States since 1980. While this Article cited the loss of 3% of GDP for cleaning up the savings and loan fiasco, it overlooked our own bond market crash in 1994. Fortune magazine on Jun. 27, 1994 published Article 5, which quotes Morningstar, the mutual fund research company, as stating that bond funds gave up negative returns of between 3.11% and 5.19% through Apr. 22nd of 1994, resulting in an estimated loss of $650 billion. The “good news” was that this $650 billion loss was less than the stock market's loss of $1 trillion in 1987. These losses respectively ran from 12% to 20% of the United States gross domestic product, but they generally received less press than bank and thrift bailouts because these losses were not incurred by the government-backed institutions but directly by investors in the private sector. However, a loss is still a loss. The taxpayers, who are expected to bail out the thrift industry over the next 40 years, are essentially the same people who own the publicly traded stock.

So what is going on here? We believe the answer to the volatility in our financial world is fundamentally simple. Each and every one of these financial crises, regardless of the country of origin, all have one thing in common: They are all dealing with financial instruments, institutions and economies that are based upon nominal currencies that are not adjusted for inflation. This is in stark contrast to the period from 1944 to about 1971 when the world experienced relative stability on a system of fixed exchanged rates referred to as the Bretton Woods System. Quite simply, the United States dollar was pegged to gold at $35 per ounce, and then other currencies were pegged to the U.S. dollar. This system was gradually replaced when the United States in 1971, due to inflationary pressures, switched to a floating exchange rate. In the following years, this system of floating exchange rates was adopted by most other countries. This tradition of floating rates has largely carried on until today, meaning that there is not a single currency in the world that is tied to anything of intrinsic value. It is all fiat money, issued at the whim of the various governments of the world. Recently, some countries like Thailand actually tied their currency to the U.S. dollar, but this was a futile gesture since the U.S. dollar itself is fiat money. Now, many of these countries such as Thailand are finding that they have to let their currencies float, since they are unable to maintain a relative value pegged to the ever-stronger U.S. dollar.

By converting to financial instruments, institutions and economies based upon real currencies, these financial crises can be largely avoided. By the term “real currencies,” we simply mean currencies that are backed by an asset and are self-adjusting for inflation. The remedy is obvious and extremely simple, but is rarely discussed by professional economists and financiers because it has been historically impossible to create such an asset-backed real currency.
Article 6: Precious Little Upside: Why gold's price has plunged—and could tumble even lower, Barron's, Jul. 14, 1997

Nonetheless, there are some “gold bugs,” who are promoting a return to the gold standard. The problem is that there is not enough gold in the world to adequately back even the major currencies, much less all of the world's currencies. On Jul. 14, 1997, Barron's published an Article 6 above, which includes a chart that shows the total official gold reserves of the world's central banks at 1,099,500,000 troy ounces. At the current price of $314 per ounce (in the fall of 1997), the world's total official gold reserves have a value of $345.2 billion, which is no longer sufficient to back even the amount of U.S. paper currency in circulation.

At the current time (in the fall of 1997), the estimated amount of U.S. paper dollars in circulation is $452 billion, the gross domestic product of the United States was $7.85 trillion and the capitalized value of the U.S. stock market is $10.15 trillion. It has also been estimated that 71% of the U.S. paper dollars are in circulation outside the United States. This leaves a net of approximately $131 billion in circulation in the United States, making the value of the U.S. GDP a multiple of 59.92, and the U.S. stock market a multiple of 77.48, of the actual paper currency in circulation in the United States. Not only are these multiples extremely high, but they are multiples of a paper currency that has no intrinsic value. In addition, any and all other forms of currency transfer, such as electronic transfers and checks, are defined in units of the paper currency. The situation of other countries around the world is similar, except the multiples are even larger. Even our financial contracts are defined in paper currency units that are rarely, if ever, adjusted for inflation. As such, any shift in the value of the paper currencies around the world can reverberate through our marketplaces, financial institutions and economies like an earth quake periodically toppling the weaker financial structures.

This means that our current monetary system is fragile and highly susceptible to periodic boom and bust cycles all tied to the speculative valuation of each country's nominal money supply. In a very real way, it is a crap shoot, where fortunes can be built and/or lost in a fortnight; because the system has no mooring. All values are subjective, and as the sentiments in the marketplace about the relative values of nominal currencies change, so too do the fates of consumers, investors, financial institutions, economies and whole countries. We are living in a world that is susceptible to financial nightmares, but it does not have to be this way.

Is it any wonder that our financial institutions are subject to recurring financial crashes? There is no under-pinning, no support system. When markets panic and/or currency speculators intervene, as they did in Thailand and other Asian countries over the past year (1997 to 1998), there is nothing to support the value of the respective currencies by which all financial transactions in these countries are measured. Currencies are the life blood of the marketplace, financial institutions and whole economies. When currencies begin to fail, all other financial and economic endeavors are adversely affected. The problem with our financial institutions is that they conduct their financial affairs with nominal currencies that are not asset-backed and are not self-adjusting for inflation. This leaves countries around the world prone to currency speculation, sudden devaluations and crippling losses for most citizens and financial institutions, except perhaps for the most brazen who bet on the pending collapse. They and their supporters assert that they are providing a service, and so they are, by showing us the tenuous nature of our financial systems. Nonetheless, it is difficult to accept that the teachers are making billions, while the average citizen in these countries are being impoverished as students. Especially, when the average students have historically had so very little control over the fiat money supply that was ordained by their political and banking systems.

This is about to change, since there is now a legitimate alternative to using gold to hedge our currencies. The alternative hedge is real estate, which is considered to be the second best hedge against inflation after gold. However, real estate is different than gold, since the amount and the value of improved real estate roughly increases with a country's population over time. Currently, there are about $5 trillion in mortgages on improved real estate in the United States. If these mortgages were properly structured as real financial instruments, then they could be securitized and stripped into their component cash flows for the purpose of creating an asset-backed real money supply. As such, it is now possible to monetize real estate into a currency-equivalent in much the same way that gold was melted down and cast into coins. Without any increase in the total volume of mortgages, we could create a $5 trillion real money supply in the United States alone. This would reduce the value of the United States GDP to a multiple of about 1.96 of the total money supply and it would reduce the capitalized value of the U.S. stock market to a multiple of 2.54 times the real money supply. By using an asset-backed real money supply that is self-adjusting for inflation, rampant currency speculation and sudden devaluations would become a thing of the past. It would not only eliminate inflation, but also the fear of inflation. Nonetheless, creating an asset-backed real money supply will require certain key elements.

Key Elements Required for Monetizing Real Estate:
(1) the unconstrained right to own and sell real estate in a free and open marketplace,
(2) the right to legally pledge such real estate to borrow funds with mortgages that protect the lender's right to seize the real estate in the event of default,
(3) the right to legally securitize pools of mortgages backed by said real estate for the purpose of making a liquid after-market for such mortgages,
(4) a monetary paradigm shift in the marketplace from nominal to real terms,
(5) powerful personal computers, and
(6) sophisticated financial software to track the resulting cash flows, thereby creating a conceptual bridge to facilitate the paradigm shift, from nominal to real monetary terms.

In many countries around the world, the first five elements are already available to one degree or another. Nonetheless, the final element has been missing everywhere, which is the sophisticated financial software that will be required for the creation and introduction of an asset-backed real money supply into the traditional nominal monetary marketplace. The invention, described herein, will fill this role.

The invention, Real Monetary Software™, will be used to carry out a process called Real Monetization™. The purpose of Real Monetization™ is to create a conceptual bridge between the nominal monetary paradigm and the real monetary paradigm, so the benefits of real financial instruments can be understood in traditional nominal monetary terms. The logical end-result of Real Monetization™ will be the issuance of an asset-backed real money supply. However, we are just beginning this process, so there are still many things that must be properly explained. We must begin with the fundamental elements of economics and finance.

B. The Concepts of Money and Inflation

Money is the life blood of our financial marketplaces, but what is money? Money is anything currently accepted as legal tender for the payment of debts. Money has been defined in any number of ways, but it generally serves three purposes depending upon how it is used.

Money is Used:
(1) as a medium of exchange between consumers, businesses and governments,
(2) as a unit of account for measuring purchasing power, and
(3) as a store of value for measuring the economic wealth of current income for spending in future years.

Whether used as a medium of exchange, a unit of account or a store of value, we can say that money is supposed to represent purchasing power. In an abstract sense, money is purchasing power.

If money is purchasing power, then how does inflation affect money?

Inflation Destroys Money:
(1) as a medium of exchange by continuously altering the price-level of goods and services,
(2) as a unit of account by continually reducing the purchasing power of each monetary unit, and
(3) as a store of value by destroying the purchasing power of money over time.

Whether money is used as a medium of exchange, a unit of account or a store of value, we can say that inflation destroys money by destroying its purchasing power. By losing sight of the fact that money is supposed to represent purchasing power, each of us in our own way contributes to a silent, unconscious conspiracy that allows inflation to persist. This is not a political or financial conspiracy, but rather a conspiracy of ignorance. The important question is: Why do we unconsciously participate in this conspiracy?

1. Why is Inflation Uncontrollable?

The knowledge that money represents purchasing power, and that inflation destroys monetary purchasing power, is well known and broadly understood. So why can't we eliminate the destructive effects of inflation on our money? Some of the most powerful political leaders and economists of the twentieth century have thought about inflation and our inability to deal with it.

### Lenin & Keynes on Inflation

“Lenin is said to have declared that the best way to destroy the capitalist system was to debauch the currency. By a continuing process of inflation, governments can confiscate, secretly and unobserved, an important part of the wealth of their citizens. By this method they can confiscate arbitrarily . . . Lenin was certainly right. There is no subtler, no surer means of overturning the existing basis of society than to debauch the currency. The process engages all of the hidden forces of economic law on the side of destruction, and does so in a manner which not one man in a million is able to diagnose.”
   —John Maynard Keynes

The irony of Lenin's statement is that you can track the decline and fall of the Soviet Union, the empire he founded, by tracking the decline and fall of the Soviet Union's ruble. (And yet, the lesson has not been learned. By the fall of 1998, Russia has begun to shift away from capitalism, represented by the free market system. And this movement has been fueled by the collapse of the new Russian ruble. This has occurred despite the assistance of western economists and even the International Monetary Fund. It appears that some lessons are beyond our grasp, whether we are communists or capitalists. A recent joke in Russia asks: “What is the difference between a ruble and a dollar?” The answer is a dollar.)

Nonetheless, while Lenin is historically correct, the problem goes far beyond any government conspiracy. In the past, many governments, including our own, have intentionally inflated the currency at one time or another. For instance, Franklin Delano Roosevelt intentionally inflated the U.S. dollar in 1933 to raise commodity prices, so farmers could make a decent living wage. This may be one of the few times that inflation served a worthy purpose, since it was an important step in reversing the crippling effects of the Great Depression; but it still robbed Peter to pay Paul.

Article 7: Lessons of the Great Depression, Fortune, Aug. 18, 1997

Many historians today believe that the major cause of the Great Depression was the government's adherence to the gold standard. Fortune magazine in Article 7 above stated:
“ . . . ‘there now prevails a remarkable degree of consensus among specialists about the cause of the Great Depression,’ according to Stanford's Barry Eichengreen and Peter Temin of the Massachusetts Institute of Technology. ‘Recent scholarship has resulted in striking agreement on the reasons for the crisis.’ The culprit in the modern view is the gold standard.”

When the economy began to collapse after the 1929 stock market crash, the governments believed that they had to keep their currencies tied to gold at all costs. Policymakers felt that the only way to restore economic stability within the constraints of the gold standard was to let prices and wages fall. In the words of U.S. Treasury Secretary, Andrew Mellon, to “liquidate labor, liquidate stocks, liquidate the farmers, liquidate real estate . . . purge the rottenness out of the system.”

Only when FDR took office and inflated commodity prices, did the system begin to renew itself. What we are seeing here is the pendulum swing from a rigid gold standard in 1929 with a money supply that was limited by the amount of available gold; to the absence of any currency standard with the floating exchange rates that commenced in 1971, that now accounts for our current fragile financial systems. Each historical extreme is defined by the need for a viable asset-backed real money supply without which we swing from the destructive effects of deflation to the equally destructive effects of inflation.

2. The Paradigm Effect:

Nonetheless, the times are changing. Today, a number of countries are offering government bonds that are indexed to the inflation rate. The very offering of these bonds tends to indicate the good will on the government's part to control inflation. Yet, the problem of inflation still exists. Even when inflation is low, the specter of inflation haunts our financial markets. So we can no longer simply blame a government conspiracy for inflation. But if there is no government conspiracy to perpetuate inflation, then why does the specter of inflation still haunt our financial marketplaces? Indeed, the problem goes much deeper, since the solution will involve a monetary paradigm shift from nominal to real terms. Why is inflation uncontrollable? Because until now, we have had neither the vision nor the tools required to work out a solution beyond our own nominal monetary paradigm. For there is no solution to inflation in our current nominal monetary paradigm. In fact, the very term “nominal” refers to currencies, interest rates or financial instruments that are not adjusted for inflation.

But what is a “paradigm?” Consider the following quote:

### Resistance to Change

“What does it take for a company to see the need for a change? I think about the savings and loan industry which looks at $450 billion in losses and says, “Maybe we should change.” . . . Why do we resist change?
There is an answer and it was supplied to us by Thomas S. Kuhn in a rather obscure book called “The Structure of Scientific Revolutions.” Kuhn said resistance to change was caused by paradigms . . . A paradigm is a set of rules and regulations that establish boundaries for our thinking, and then go on to tell us how to be successful by solving problems within these boundaries.
Kuhn analyzed the way scientists looked at data and he discovered why scientists failed to anticipate new developments. Kuhn discovered that paradigms acted as a filter. They screen data being analyzed by the scientist. If the data agreed with the paradigms it passed right through his mind effortlessly.
However, if the data was unexpected and didn't agree with the paradigms, the scientist's had trouble perceiving it. Sometimes the scientists distorted the data to make it conform to the existing paradigms. In extreme cases, Kuhn found that the scientists were physiologically unable to deal with the expected data. To them, the data simply didn't exist . . . (This filtering process has been called) the ‘paradigm effect’ . . . ”
   —New Directions (videotape)

Now, consider the following quote about the aftermath of the 1929 stock market crash and the cause of the Great Depression:

### Paradigm Paralysis: 1929-1933

“Finally, when the misfortune had struck, the attitudes of the time kept anything from being done about it. This perhaps, was the most disconcerting feature of all. Some people were hungry in 1930 and 1931 and 1932. Others were tortured by the fear that they might go hungry. Yet others suffered the agony of the descent from the honor and respectability that goes with income into poverty. And still others feared that they would be next. Meanwhile, everyone suffered from a sense of helplessness. Nothing it seemed could be done. And, given the ideas which controlled policy, nothing could be done.”
   —The Great Crash by John Kenneth Galbraith

Although the terminology was not in vogue at the time Galbraith wrote his book, he was talking about the inability of the policymakers to breach their own monetary paradigm. Despite the fact that there was no answer to the Great Depression in their own monetary paradigm, they would not shift to a new paradigm in search of an answer. This is often referred to as “paradigm paralysis,” which is caused by the paradigm effect. Until FDR had the courage to inflate commodity prices, nothing could be done about the Great Depression. While the depression began with the stock market crash of 1929, it was the tight money policy ordained by the gold standard that exacerbated a stock market crash into the Great Depression. The policy makers were gripped by a paradigm paralysis that did not allow a paradigm shift to correct the problem. In a similar fashion, the world today cannot see the solution to inflation (deflation and the resulting currency crisis leading to financial instability), because it is firmly in the grip of the nominal monetary paradigm. Why is this? Undoubtedly, it is because people cannot surmise the true nature of inflation, just as Keynes noted. But what is the true nature of inflation?

3. Who is Counting the Money?

We have already stated that inflation destroys money by continuously altering the purchasing power of nominal currencies. This suggests a new way of analyzing inflation, representing a shift to a new paradigm. Using this new paradigm, we can begin to see that inflation is not the cause, but rather the effect. One may treat the effects of a disease on a temporary basis, but until the cause is eliminated the effects will return. This is why our financial markets are still haunted by inflation, despite the relatively low inflation in the United States over the past five years or so. As such, we cannot consider inflation to be cured, until it becomes an historical curiosity.

The culprit is not inflation itself, which is only an effect; but rather the nominal currencies, which are the cause. Simply stated: nominal currencies violate the Concept of Whole Numbers, thereby causing inflation (and deflation). Consider the following quote:

### The Concept of Whole Numbers

“As we all know, arithmetic deals with the most basic of quantitative concepts, the whole numbers of 1, 2, 3 . . . If any mathematical idea is universal, it is that of distinguishing degrees of multiplicity, which is to say ‘counting.’”
   —The Mathematical Universe by William Dunham

The Concept of Whole Numbers assumes that the integers 1, 2, 3 . . . represent degrees of multiplicity, meaning that they represent whole units in successively higher amounts. It is this characteristic of being “whole” that allows us to add, subtract, divide and multiply these integers. Understanding the Concept of Whole Numbers is essential in understanding the nature of inflation (and deflation).

Money is supposed to represent purchasing power. Nominal currencies, that are not adjusted for inflation, retain their “whole” integers, despite the fact that inflation is continually eroding their purchasing power into partial units. When these integers are used to count money, they are supposed to represent whole units of purchasing power. Assuming the numerical units of currency remain unchanged, but the actual purchasing power they represent is declining, then the nominal currency is violating the Concept of Whole Numbers. This results in inflation (or deflation).

This cause-and-effect relationship means that inflation (and/or deflation) can be substantially eliminated whenever an economic system switches from a nominal currency to an asset-backed real money supply. Inflation is a phenomenon that is inherently associated with nominal currencies, and it can be eliminated by removing the nominal currencies from circulation, and replacing them with an asset-backed real monetary equivalent. Achieving this goal represents a major task, because it represents a paradigm shift from nominal to real terms. We can eliminate inflation, and substantially reduce both the number and the degree of institutional financial crises throughout the world, by moving from the nominal monetary paradigm to the real monetary paradigm. At the same time, we can eliminate deflation, which has the opposite effect on our nominal currencies, but still represents the violation of the Concept of Whole Numbers. Instead of the whole integers on our nominal currency representing less than one unit, with deflation the whole units begin to represent more than one unit. Once again, our ability to count is destroyed. While a little inflation modestly steals from the lender, a little deflation modestly steals from the borrower. But substantial inflation destroys the lender, and substantial deflation destroys the borrower; and what goes around comes around: eventually destroying both the lender and the borrower.

This situation also suggests very strongly why our currencies and financial institutions are so fragile. This can be stated simply as:

### The Fundamental Problem Underlying Our Global Currency Crisis

(1) If you are using nominal (fiat) currencies, then you are violating the Concept of Whole Numbers.
(2) If you violate the Concept of Whole Numbers, then you cannot accurately add, subtract, divide or multiply.
(3) If you cannot add, subtract, divide and multiply, then how can you expect to manage monetary affairs on a long-term basis?

Our financial institutions are susceptible to failure because our financial professionals cannot count using nominal currencies. Certainly, they can count the integers printed on our paper currency, but they are not truly counting the amount of purchasing power that those integers on our paper currency are supposed to represent. This is a critical flaw, when you realize that money is supposed to represent purchasing power. This is why long term fixed-income instruments are so volatile. No one can be certain what a thirty year bond with a fixed nominal rate of return will actually be worth until after the term has been completed. This forces everyone to react quickly to changing conditions in the marketplace that can adversely affect the value of such instruments, which leads to greater volatility in the marketplace. The ability to react in the short-term becomes a survival tactic, which results in the gradual abandonment of long-term financial planning.

This means that we live in a society where our engineers and scientists can launch a spacecraft on a thirty year journey to a distant heavenly object through the curvature of the space-time continuum and rendezvous on target and on time, but our financial professionals cannot tell you what the purchasing power of the U.S. dollar will be 12 months from now. They can only guess. And, as the number of years increases, their guesses become more erratic and increasingly useless. As the Prime Minister of Great Britain, Winston Churchill once said that when he asked four economists a question, he would get five answers; because Keynes would give him two answers. Were the economists just guessing? When you ask 100 economists what will happen to the economy quantitatively over the next five years, you could undoubtedly plot the answers on a bell-curve, and the top of the bell curve would be the most recent economic measurements. This suggests that the economists are guessing.

Each business day, our financial institutions will enter into financial contracts for 30 years or more without any reasonable method of projecting the outcome in real terms. In fact, when financial instruments are defined in nominal terms there is no way to predict the future purchasing power of the stream of income generated by these instruments. Nonetheless, they are dealing with money, and money is supposed to represent purchasing power. Clearly, few if any of our financial professionals are properly tracking the purchasing power of the invested capital they represent. Nobody is really counting the money. Why do financial professionals, and the rest of our society, deal with money in this manner? They do so because they are stuck in the nominal monetary paradigm.

The time has come to abandon the nominal monetary paradigm. However, the shift to a new paradigm is never simple, especially when you are asking all the participants in our financial marketplaces to make this shift. With Real Monetary Software™ it will be possible to create an asset-backed real money supply, but also to prepare for its distribution by creating a conceptual bridge from the current nominal monetary paradigm to a new real monetary paradigm. The purpose of this conceptual bridge will be to allow people to see the benefits of using real financial instruments, including a real asset-backed money supply, in traditional nominal terms.

So, how do we get there from here? First, we have to understand the shift towards the use of real financial instruments that is already underway. Then, we have to analyze just why these new instruments are having trouble being accepted in the marketplace. Finally, we will show how these problems can be resolved with a process called Real Monetization™, which will be carried out by the Real Monetary Software™. This process will usher in a new generation of real financial instruments, that will solve the problems of the first generation. Finally, we shall show how the second generation will lead to a third generation, which includes the issuance of an asset-backed real money supply.

C. Nominal Financial Instruments Versus the First Generation of Real Financial Instruments

1. Historical Perspective and Certain Definitions

The goal of creating real financial instruments, that are asset-backed as a hedge against inflation, is not a new phenomenon. In the late nineteenth and early twentieth centuries, many governments and corporations issued Gold Bonds that were self-adjusting for inflation. These bonds were so named, because the holder could demand repayment in either nominal dollars or in gold coins (or the monetary equivalent weight in gold) as a hedge against inflation.

These Gold Bonds posed a special problem for President Franklin Delano Roosevelt, who wanted to inflate commodity prices in 1933 so farmers could make a decent living wage. The proposed inflation would devalue the purchasing power of the nominal dollar and most certainly lead to the Gold Bond investors demanding repayment in gold. FDR understood that this would pose an economic hardship, if not bankrupt, both the government and many corporations. FDR's advisors questioned whether the government would even have enough gold on hand to meet such demands.

So, FDR passed legislation in 1933 that made it illegal to hold gold bullion, which made the gold payment clause in the Gold Bonds illegal. Assuming one was actually repaid in gold, and assuming that gold held its value against inflation, then the rate of interest paid on these bonds as well as the monetary units (representing the repayment in gold of the capital borrowed) must be considered “real.” As such, real financial instruments are not new in the United States, but they did depart from the scene in 1933; since the only means of creating such instruments at that time was by hedging them with gold.

The famous investor, and advisor to many presidents, Bernard M. Baruch responded to FDR's proposed legislation in the October, 1993 issue of Fortune magazine:

### Bernard M. Baruch on Going Off the Gold Standard

“By going off the gold standard we have become a nation of dishonest people in our relations with the bondholders . . . . We're raising prices for the benefit of a small proportion—20 percent—of the population, the unemployed, debtor classes—incompetent, unwise people . . . . You don't distribute wealth. You distribute poverty.”

Jesse H. Jones, the FDR appointed head of the Reconstruction Finance Corporation and one of the President's closest economic advisors, stated in his book, My Thirteen Years with the RFC (1932-1945), that:
“The reduction of the gold weight of the dollar (in January, 1934) automatically gave the Treasury a book profit of $2,817,459,420.80.”

The dollar had been officially revalued at 59.06 percent of the gold parity at which it had been established for it in 1900. This means that the total gold reserves of the United States government in January, 1934, amounted to $4,064,463,932.40. Nonetheless, the author, James Grant's in his biography, Bernard M. Baruch, states on page 269:

### James Grant on the Gold Bonds Outstanding in 1933

“The 1930s were filled with issues over which reasonable people argued and fought. On the financial scene one of the most acrimonious was the question of how to dispose of contracts in which payment was specified in gold or in the current price of gold. Ever since the inflationist scare of the 1890s it had been common practice for creditors to stipulate payment in dollars of the same gold weight as they had lent. The Treasury's own bonds, as late as May, 1933, had been sold with this guarantee. All told, an estimated $100 billion worth of gold clause bonds and obligations, public and private, were outstanding.”

Clearly, the Gold Bonds did not work very well as real financial instruments, since they were not truly backed by the gold; only by (fiat) promises to pay in gold. Grant states that over $100 billion in corporate and government Gold Bonds had been issued by 1933, but Jones' quote indicates that the U.S. Treasury only held about $4 billion in gold at that time, and only after the devaluation. While the original concept may have been correct, the Gold Bonds failed because they were not directly backed by gold; only by promises and partial reserves at best. Unfulfilled promises are the bane of mankind. This means that the issuance of the Gold Bonds at the turn of the century followed a path similar to the issuance of our fiat currencies today. They were issued in great volume without a second thought about the representations being made to repay in gold, or relative purchasing power, upon demand. Fortunately, we can correct this flaw.

In the late 1960s, the financial pressures created by President Lyndon Baines Johnson's desire to pursue both the Viet Nam War and the Great Society at the same time, followed shortly thereafter by the OPEC oil embargo; undoubtedly contributed to the inflationary pressures that led to President Richard Milhouse Nixon in 1973 taking the United States off the Bretton Woods System of fixed exchange rates. Inasmuch as the U.S. dollar was the key currency to which all other currencies were tied, this quickly led to all other nations also abandoning the Bretton Woods System. After the shift from the fixed exchange rates to floating exchange rates, waves of inflation began to financially cripple countries around the world. Governments, such as the United States, were no longer constrained in their issuance of paper currency, since they did not have to prop up the value of that paper currency in gold or any other asset. Once the U.S. government was no longer accountable for the purchasing power of its currency, the rise of the federal debt to $5.38 trillion today (i.e. the fall of 1997) was predictable.

In early 1997, a book entitled Mirage by George Hager and Eric Pianin was published, which stated on page 12:

### The Congressional Budget Office (CBO) Forecast on the National Debt

“ . . . the CBO forecasts (the national debt) soaring to more than $21 trillion by 2020 and to a staggering $81 trillion by 2030, almost three times the size of the nation's economy.”

By January 1998, this was overshadowed by the Clinton Administration claiming that the country should balance the budget in 1998, and even generate a surplus.
Article 8: A glimmer behind the deficit glaze Star Tribune, Feb. 8, 1998

However, the Clinton Administration's “balanced budget” is based upon accounting practices that fail to record the total picture. Article 8 published by the Star Tribune on Feb. 8, 1998 states that:

### Accounting for the Federal Deficit

“The biggest distortion in the government's bookkeeping practices is the decision to leave the Social Security trust fund off-budget. The Social Security system runs a large surplus every year and invests it in government bonds. In effect, the U.S. Treasury borrows the surplus each year—last year $80 billion, this year a projected $100 billion—and spends all of the money on non-Social Security programs. For deficit calculating purposes, however, this is not counted as borrowing.
By the way, the government maintains a number of other smaller trust funds, many of which also produce surpluses. From all of these put together, the Treasury can borrow and spend another $45 billion a year without allegedly adding a penny to the deficit.”

In addition, the government is also increasing our paper money supply at the rate of about 8% per annum, which generates another non-interest bearing loan in the amount of about $36 billion more each year. (This is only the tip of the iceberg of another loan that we may very well have to pay one day, if the estimated $320 billion in U.S. currency circulating outside our country begins to return.) Altogether, the government will actually be borrowing approximately $181 billion more in 1998, at the same time that the Clinton Administration will be claiming a balanced budget. This means that the talk about any budget surplus is an illusion.

This creates a certain degree of urgency in the transformation to a new monetary paradigm. As we shall show at a later point, the U.S. government's participation in the issuance of an asset-backed real money supply could pay off a $6 trillion federal debt in about 50 years, assuming the current level of interest payments on the debt were maintained without any assistance from current tax revenues except to maintain the ongoing interest payments. Certainly, the issuance of an asset-backed real money supply is not the only remedy, but it could play a pivotal role in bringing our federal debt under control.
Article 9: PLAM!, Forbes, January, 1989
Article 10: Preliminary Credit Rating Letter Duff & Phelps Credit Rating Company, Jan. 8, 1993

The modern movement to issue real financial instruments began with the Margaret Thatcher's Administration in Great Britain in 1981, when the British government issued bonds that were priced at a margin over an inflationary index. Canada, Sweden, New Zealand, Australia and Israel also issued real bonds in the following years. In January, 1989, Forbes magazine announced in an article entitled: PLAM!, that the United States Department of Housing and Urban Development (HUD) would be issuing Price-Level-Adjusted-Mortgages (PLAMs) in the near future. The inventor reviewed the proposed PLAM and felt that it would not work as presented. Having modified the PLAM to correct certain credit-related problems, the inventor then obtained a Preliminary Credit Rating Letter from the Duff & Phelps Credit Rating Company on Jan. 8, 1993 for the Real Mortgage™. Then on Jan. 29, 1997, the United States government issued the first Treasury Inflation Protection Securities (TIPS) in an $8 billion offering that was priced at a margin over the Consumer Price Index for All Urban Consumers (CPI-U). By January of 1998, the U.S. government had issued $40 billion in TIPS.

Nonetheless, by July of 1997 financial periodicals were beginning to question the viability of the TIPS, stating that the after-market was still sluggish. In fact, the U.S. Treasury warned investors not to purchase the TIPS, unless they could hold the investment to term. Certainly, this is not the kind of advice that would support a vigorous after-market for any class of financial instruments. It appears that history is repeating itself. Despite the British government's desire to sell as many real bonds as possible, only 15% of the British government bond market is composed of real bonds by 1997. HUD never did get its PLAM mortgage going, beyond a few test cases. Nor did the inventor succeed in getting the original Real Mortgage™ funded. For the most part, real financial instruments have never really taken hold in the private sector, either in Great Britain or in the United States; and have had a luke-warm market in the government sector.

However, this is just the beginning. The inventor discovered that there were marketing problems associated with all of these instruments. These marketing problems were primarily caused by the paradigm effect. He discovered that these problems could be resolved by creating a conceptual bridge between the current nominal monetary paradigm and the coming real monetary paradigm. The conceptual bridge can be achieved through a number of processes collectively called Real Monetization™, the key elements of which will be carried out by the proposed invention herein, Real Monetary Software™. As such, the Real Monetary Software™ will carry out functions that will fix these marketing problems, and lead to the development of two new generations of real financial instruments.

For the sake of clarity in explaining these matters, it will be useful to define the following terms:

### Certain Definitions

Nominal Financial Instruments: Financial instruments that are defined in nominal currencies and nominal rates of interest, which are not adjusted for inflation. Each nominal currency unit is defined by the paper currency issued by fiat by the government of each nation.
Real Financial Instruments: Financial instruments that are defined in real terms (i.e. after adjustment for inflation and/or deflation). This includes real currency units and real rates of interest, which are self-adjusting for inflation. The use of real financial instruments is dependent upon the selection of a generally acceptable inflationary index. The percentage change in the inflationary index can be used to convert the abstract real currency unit into the nominal currency unit for actual payment, until such time as an asset-backed real money supply is in general usage. The real interest rate is simply the rate of interest over and above the prevailing rate of inflation as measured by the percentage change in the inflation index for a given time period—usually the previous 12 months.
First Generation Real Financial Instruments: Financial instruments that are priced at a fixed margin over an agreed upon inflation index, resulting in a fixed real rate of interest. Such instruments include the Price Level Adjusted Mortgages (PLAMs) proposed in 1989 by the U.S. Department of Housing and Urban Development, the original Real Mortgage™ for which the inventor obtained a Preliminary Credit Rating Letter in 1993, the real bonds offered by Great Britain in 1981 and by other foreign governments in subsequent years and the Treasury Inflation Protection Securities (TIPS) issued by the U.S. Treasury in 1997.
Second Generation Real Financial Instruments: Financial instruments that are priced at a fixed margin, over an agreed upon market index such as the Treasury Bill Index or the London InterBank Offer Rate (LIBOR), to determine the effective nominal rate of interest. The prevailing rate of inflation is then deducted from effective nominal rate of interest to determine the real rate of interest, which is used to amortize the loan. This results in a variable real rate of interest, which defines the Second Generation of Real Financial Instruments.
Third Generation Real Financial Instruments: Real financial instruments that are derived from, or that benefit by the use of, First and Second Generation Real Financial Instruments. Examples would include: an asset-backed real money supply backed by the derivatives generated from Real Mortgage-Backed Securities or Real Estate Investment Trust (REIT) stock, whereby the underlying properties of the REIT were financed by Real Mortgages™.

With these definitions in mind, we can now examine:
(1) Problems associated with nominal financial instruments.
(2) How the First Generation of Real Financial Instruments can resolve these problems.
(3) Problems associated with the First Generation of Real Financial Instruments.
(4) How the Second Generation of Real Financial Instruments can resolve these new problems.
(5) How the issuance of an asset-backed real money supply will make the use of real financial instruments even easier.

Along the way, we will also discuss why it is virtually impossible for any marketplace, government or country to simply switch from the use of nominal financial instruments to real financial instruments and the use of an asset-backed real money supply without the development of a conceptual bridge.

2. Problems Associated with Nominal Financial Instruments

The Savings and Loan Collapse—Nominal Perspective

The primary problem associated with nominal financial instruments is that they do not properly reflect what is happening to the financial obligation in terms of purchasing power over the life of the instruments. This is a critical flaw; since financial obligations determine monetary transfers, and money is supposed to represent purchasing power. By violating the Concept of Whole Numbers, nominal financial instruments mask the purchasing power of the financial obligations they represent; thereby distorting the purchasing power of the repayment stream. No one can really be certain whether or not the purchasing power that is owed by the borrower to the lender is actually repaid, as in the case of inflation; or whether the purchasing power of the capital borrowed may even be overpaid, as in the case of deflation. This can be a vexing problem for those caught in the nominal dollar paradigm: which leads to a variety of “fixes,” each of which multiples the destructive impact of inflation and deflation. This converts the world of finance from the mathematical realm of certainty to the gambler's den of risk. The consequences for consumers, investors, financial institutions and whole economies can be catastrophic.
Table 1: Nominal Rates of Return for Single Family Fixed-Rate Mortgages in the United States Thrift Industry from 1973 to 1981

Let's consider what happened to the Thrift industry in the United States in the late 1970s and early 1980s. Table 1 shows the nominal rates of return for single family fixed-rate mortgages in the United States thrift industry from 1973 to 1981. These rates were obtained from the Statistical Abstract of the United States. This chart shows the nominal interest rates of new mortgages increasing at one to two percent per annum as inflation began to accelerate. Assuming an equal amount invested in new mortgages each year, this increases the Mortgage Portfolio Average from 8.3% in 1973 to 10.65% in 1981. Beyond that information, it appears that the thrift industry is just chugging along. There is no hint of any financial danger to the thrifts. As a result of the subsequent collapse of the thrift industry, we now know that it was seriously impaired during this time period. As a result of violating the Concept of Whole Numbers, the true impact of inflation on the purchasing power of the nominal mortgages held by the thrifts was not properly recognized.
Table 2: Real Rates of Return for Single Family Fixed-Rate Mortgages in the United States Thrift Industry from 1973 to 1981

We can present the same data in Table 2, but convert the nominal interest rates to real interest rates by simply deducting the prevailing rate of inflation for each year. Now we can begin to see what is really happening to the purchasing power of the thrift industry's mortgage investment portfolio for 1973 to 1981. We can see whether the mortgages held for investment for a given year are generating a positive or negative real rate of return as inflation fluctuates from year to year. Assuming the same amount of mortgages were purchased each year, we can also see what happens to the Mortgage Portfolio Average. In 1974 and 1975, and then again in 1979 and 1980, we can clearly see that the thrifts were receiving a negative real rate of return on their mortgage portfolios. We can see that the thrifts lost 2.47% in real terms for 1974-75, and 5.54% in real terms for 1979-80. Inasmuch as most thrifts only had between 3% to 5% net capital, we can see that virtually the entire thrift industry was under water at least once, if not twice, between 1974 and 1980.

Inasmuch as the accounting standards for our financial institutions was based on nominal terms, and there was no requirement at that time for the thrifts to mark their mortgage investments to the market; the thrift industry sailed right along as if nothing was happening. They were not looking at their situation in real terms (Table 2), but only in nominal terms (Table 1). In a word, no one was properly counting the purchasing power of the invested capital held by the thrifts. Subsequently, when the thrift industry began to collapse, much of the blame was placed on the auditors. Since then, the Financial Accounting Standards Board (FASB) has begun to issue new rules that will begin to force financial institutions to mark their investments to the market on a regular basis.
Article 11: SEC is seeking changes in methods of accounting Star Tribune, Oct. 23, 1990

On Oct. 22, 1990, Richard Breeden, then Chairman of the Securities and Exchange Commission, told the Senate Banking Committee that if mark-to-market accounting rules had been in effect years ago, it would have helped avoid or at least minimize the impact of the thrift industry's financial problems. The accounting practice of marking-to-market is roughly equivalent to tracking the purchasing power of such investments in real terms. However, while the practice of marking-to-market provides a good indication of problems that may be developing with an investment portfolio, it does not tell the thrift or bank managers how to avoid the price volatility of nominal fixed-rate instruments in the first place. If anything, mark-to-the-market accounting only encourages investment managers to shift from long-term financial planning to short-term financial reacting. This occurs because nominal financial instruments can only react to inflationary changes in the short-term and cannot cope with such changes with medium-to-long-term nominal financial instruments.

This means that long-term nominal financial positions require expensive hedges, and even then someone else must accept the transfer of risk. This became evident when financial derivatives resulted in major losses for many corporations and pension funds speculating in such derivatives in 1994. Once again, the FASB is developing one or more new accounting rules that will force companies to recognize the price-volatility of such derivatives on their financial statements. There are many powerful people in our financial marketplaces that are fighting the newly proposed FASB rule(s) on derivatives. In essence, they do not want the general public to see the true nature of the hedges that are being used to offset the price volatility of Nominal Fixed Rate instruments. At the same time, even the Federal Reserve Chairman, Allan Greenspan, has argued against the proposed rule changes. One assumes that Greenspan's position is based upon the recognition that there is no other alternative in the nominal monetary paradigm but to use such hedges; which would cause havoc with the financial statements of our financial institutions if the true volatility of such instruments were properly revealed. Due to the derivative losses, and to the newly proposed derivative accounting rules, it will be more difficult and more expensive than ever for our more conservative financial institutions to properly hedge their positions; since it takes two parties to create a hedge.

Who will accept the price-volatility of nominal fixed rate instruments at a reasonable cost, if the risk must be revealed on one's financial statements? And, if there is no one to accept this risk, then how are banks and thrifts supposed to offer real estate owners long-term financing? When asked this question, the president of a major Twin Cities thrift responded that his institution had solved the problem. “We no longer hold mortgages long-term,” he said. “We learned out lesson, they are too risky!” Instead his institution sells the mortgages to a conduit, which securitizes the mortgages and sells them primarily to the pension industry. This suggests that the next time inflation increases substantially, the pension funds will take the place of thrifts in sustaining major losses; and once again the government will ask the taxpayers to bail out the mess. As an alternative, many lending institutions match loans with deposits, but once again they are simply passing the risk on to someone else. The problem of issuing long-term nominal financial instruments has never been properly resolved. Nor can it be, since such instruments are not adjusted for inflation and deflation, which are the driving forces behind price-volatility.

The 1965 U.S. Treasury Bond—Nominal Perspective
Table 3: Comparative Analysis of a 1965 U.S. Treasury Bond Investment in Nominal and Real Terms

How can an investor tell whether an investment in a nominal financial instruments will generate a real rate of return over and above the rate of inflation? Except for investing solely in short-term instruments, there is no way a financial professional can tell whether nominal financial instruments will beat inflation over time. Consider the 1965 U.S. Treasury Bond, which paid a nominal fixed-rate of 4.2% for thirty years. This represented a variable real rate of 2.28% for the first year of 1965, which initially appears to be a safe investment. However, during the ensuing thirty years, the average inflation rate was 5.42%, which means that the investors holding the 1965 U.S. Treasury Bonds lost an average of 1.22% (or 5.42%-4.22%) per annum on their investment. The cumulative effect of this process was revealed after the 30-year term was completed, when the investors were repaid in nominal dollars that had been devalued by inflation over that time period. For every $1,000 invested in 1965 dollars, the investors received a return of capital equal to only $207.58 in 1965 dollars. The irony is that people still think that nominal U.S. Treasuries are safe. They may be from the standpoint of a credit risk, if one is prepared to ignore the outstanding federal debt situation; but from the standpoint of inflation, nominal fixed-rate Treasuries are just as risky as any other long-term nominal fixed-rate instrument.

The Adjustable Rate Mortgage (ARM)—Nominal Perspective

The adjustable rate mortgage is an attempt to resolve the price-volatility of medium-to-long-term nominal financial instruments. In fact, the development of the ARM in the late 1970s could be viewed as the first significant movement towards the real monetary paradigm. However, ARMs were still defined in nominal terms, which means that they provide a very limited degree of protection to the lender. The degree of protection was limited by the need for interest rate caps and ceilings, which resulted from the fact that the nominal rates of the ARMs still had an inflationary premium built-into their rate structure. As it developed, the inflationary premium effectively limited the degree to which the interest rate could be readjusted, since it led to substantial payment volatility. Nonetheless, it was a movement in the right direction, since it shifted the cost of inflation back to the borrower on at least a limited basis.

Ironically, the losses incurred by the thrifts resulted in gains for their borrowers, but these gains were short-lived. As the thrifts began to collapse, the government bailed them out and billed the taxpayers. However, not only were the taxpayers billed for their earlier gains as borrowers, but they also had to pay the expensive costs involved in the thrifts' bankruptcy proceedings, as well as the present value losses incurred when the Resolution Trust Corporation liquidated mortgage loan portfolios at 20% to 50% discounts. A thorough study of this subject would surely indicate that society as a whole still experienced enormous losses, despite some short-term gains by the borrowers; and that the borrowers, as taxpayers, are being required to pay an enormous penalty for these losses over the next 40-years. While the initial losses of the U.S. thrift industry have been estimated variously at $125 billion to $150 billion, the cost to the taxpayers of paying off the initial losses over the next 40 years have been estimated at $400 billion to $500 billion including interest.
Table 4: Amortization Schedule for 6:2 ARM: Assuming Inflation and the ARM Indexes Increase at 1% Annually

Table 4 shows an amortization schedule for a 6:2 ARM, assuming inflation and the ARM Index increase at 1% per annum and based upon an inflation rate of 1.70%. The designation 6:2 means that the interest rate is “capped,” such that it cannot increase more than 2% per annum; nor can the cumulative increases exceed a 6% “ceiling.” (This schedule also shows an interest rate discount of 1.25% in the first year. This discount is known as the “teaser rate,” which is common for such instruments. The maximum increase of 2% per year is based upon the Initial Rate before the deduction of the 1.25% discount for the teaser rate.) We can see from this schedule that a borrower's payment on a $100,000 ARM could increase from $7,783 to $13,901 per year. Assuming the borrower is qualified at the $7,783 payment level, how can the lender expect the borrower's income to keep up with such increases?
Table 5: Annual Payment Increases for 6:2 ARM: Assuming Inflation and the ARM Index Increase 1% Annually

Using the same assumptions, Table 5 shows the increases in the ARM's payments relative to the increases in the inflation rate. In the first year, the borrower's income has to increase at 873.25% of the rate of inflation to be properly qualified to make the ARM payments. This means that if inflation increases at 1% from 1.70% to 2.70%, and assuming that the ARM index moves up the same 1% (plus the teaser rate discount of 1.25%); then the borrower's payment will increase by 23.58%. Assuming the average borrower's income increases with the inflation rate at 2.70%, then the average borrower will be short about 20.88% in the increase he or she needs to keep abreast of their increasing ARM mortgage payments.

After six years, the ARM mortgage payments will have increased at an average annual rate of 198.10% of the rate of inflations. Who among us believes that their income will increase over a six year period at 198.10% of the increasing rate of inflation? Would you bet your house on it?You are, if you have a 6:2 ARM.
Table 6: Amortization Schedule for 6:2 ARM: Assuming Inflation and the ARM Indexes Increase at 2% Annually
Table 7: Annual Payment Increases for 6:2 ARM: Assuming Inflation and the ARM Index Increase 2% Annually

The initial ARM example (Tables 4 & 5) assumed a mild increase in inflation of just 1% per annum over six years. However, the 6:2 ARM could also increase at 2% per annum for a period of three years. As shown in Tables 6 & 7, this would lead to a payment increase from $7,783 to $14,029. This represents a cumulative increase over a three year period of 386.25% of the cumulative rate of inflation. This means that with a 6:2 ARM, you are willing to bet your house that your income can increase at 386.25% of the increasing rate of inflation over a three year period; if inflation really takes off.

3. Why Do We Need Real Financial Instruments?

The Savings and Loan Collapse—Real Perspective
Table 8: Horizontal Interest-Rate-Symmetry for Single Family Fixed-Rate Mortgages in the United States Thrift Industry from 1973 to 1981

Table 8 simply duplicates Table 1, depicting the nominal rates of return on single family fixed-rate mortgages in the thrift industry from 1973 to 1981; except that it also indicates the horizontal interest-rate-symmetry associated with nominal fixed rate mortgages. As the arrow in Table 8 indicates, mortgages written in 1978 at 9.68% continued to earn a nominal 9.68% fixed rate of return in the ensuing years. Just as the nominal fixed rate mortgages shown in the other years continued to earn the their respective fixed nominal interest rates in the ensuing years. What's wrong with this picture? Once again, we can't really tell in nominal terms, except that we know from Table 2 that this practice of horizontal interest-rate-symmetry led to substantial thrift losses. In fact, a good case could be made that the majority of the thrift losses occurred due to the use of nominal financial instruments that resulted in horizontal interest-rate-symmetry. The problem with horizontal interest-rate-symmetry is that it does not match the reality of what is occurring in the marketplace. Market interest rates, reacting to the degree of actual or perceived inflationary or deflationary risks, will fluctuate from year to year. Nominal financial instruments with a fixed rate of return will not readjust to the ever-changing rates in the marketplace. (And, while ARMs adjust somewhat better within the narrow range of their interest rate caps and ceilings, they provide only limited protection for the lender and cause other problems as noted above.)
Table 9: Vertical Interest-Rate-Symmetry for Single Family Fixed-Rate Mortgages Assuming Mortgages Were Based Upon a 5.5% Real Rate of Interest

We need real financial instruments because they will continuously readjust to the ever-changing conditions in the marketplace. In Table 9, we show what the effective nominal rates of return would have been, if the thrifts had written First Generation Real Mortgages™ with a fixed real rate of interest of 4.5%. We simply added the fixed real rate of 4.5% to the changing rate of inflation each year to determine the effective nominal rate of return. The result is vertical interest-rate-symmetry as denoted by the arrow on Table 9. Each year, the thrifts' entire Real Mortgage™ portfolio would have readjusted, as the vertical interest-rate-symmetry shows, to meet the changing conditions in the marketplace. Certainly, the real interest rate may fluctuate from year to year in the marketplace, but if all the mortgages created were based upon real rates then it would be difficult for a financial institution to get into trouble based upon fluctuating rates in the marketplace.

Formerly, we quoted Breeden from Article 11, the former Chairman of the SEC, stating that the thrift debacle may have been avoided if the thrifts had been forced to use mark-to-market accounting in earlier years. As we pointed out, this practice would have indicated that a problem was developing with the thrifts' mortgage portfolios, but it would not have shown the thrifts how to create financial instruments that would adjust to the changing conditions in the marketplace. However, if the thrift industry had structured their mortgages as real financial instruments, then we can say unequivocally that the thrift debacle would not have occurred. This is why we need real financial instruments. Not only to resolve any future mortgage-related problems of the United States thrift industry, but for similar problems being experienced by banks and other financial institutions around the world.

The 1965 U.S. Treasury Bond—Real Perspective
Table 10: Comparative Analysis Assuming an Investment in a Treasury Inflation Protection Security (TIPS) in 1965

What would have happened if the 1965 U.S. Treasury Bond had been structured as a Real Financial Instrument, similar to the TIPS that are now available from the U.S. Treasury? Table 10 shows what the amortization schedule might have looked like. We have assumed that the TIPS would have been written at the same real rate of interest as the nominal Treasury Bond earned in 1965 less 25 basis points for a fixed real rate of 2.03% (or 4.20%−1.92%−0.25%). We can now compare what did happen with the 1965 U.S. Treasury Bond (shown in Table 3), versus what might have happened if the TIPS had been available in 1965 under the above assumptions (shown in Table 10), as follows:

Comparison of 1965 Treasury Bond Vs. TIPS

| | Actual | Assumed |
|---|---|---|
| | 1965 U.S. | 1965 U.S. |
| | Treasury Bond: | TIPS Bond: |
| Nominal Interest Rate: | 4.20% | N/A |
| Effective Nominal Interest Rate: | N/A | 3.95% |
| Real Interest Rate: | N/A | 2.03% |
| Effective Real Interest Rate: | −1.22% | N/A |
| Present Value in Real and | $1,000 | 1,000 R$ |
| Nominal Dollars at the | | |
| Beginning of 1965: | | |
| Present Value in | $1,000 | $4,817 |
| Nominal Dollars at the | | |
| End of 994: | | |
| Present Value in | 217 R$ | 1,000 R$ |
| Real Dollars in 1994: | | |

It is quite possible that the real rate of interest would have been less than the projected 2.03%, but it could have fallen 325 basis points before it got down to the 1.22% negative real rate of return actually earned by the 1965 Treasury Bond. One should also note that with a Real Financial Instrument structured with a fixed real rate of return, the investor knows exactly what he or she will receive (1) as a real rate of return over time and (2) that he or she will receive the return of capital with the same purchasing power as the capital originally invested. Finally, one can also begin to see how the use of real financial instruments will lead to less interest rate volatility in the marketplace. The real rate equals the nominal rate less the prevailing inflation rate, which means that real rates will be much less volatile than traditional nominal rates. In addition, the vertical interest-rate-symmetry of real financial instruments should mean a substantial reduction in losses incurred by our financial institutions over time. This will reduce the need for central banks to establish arbitrarily high real rates of interest to help replenish the losses of our financial institutions due to the use of nominal financial instruments.

When investors lose money on instruments like the 1965 Treasury Bond, and the nominal fixed-rate mortgages written from 1973 to 1981; then nominal rates in the marketplace are readjusted upwards to recoup these losses. Over time, this creates a roller coaster effect on the economy as interest rates ratchet up and down from one cycle to the next, pushed and pulled by inflation and deflation. In effect, the lender/investor will attempt to recoup the losses on earlier loans by raising the rates on future loans. One way or another, as borrowers or as a taxpayers, the country's citizens will ultimately pay for the losses incurred by the use of nominal financial instruments, unless we switch to the real monetary paradigm.

At the time the RTC was bailing out the thrifts, the banking industry in the United States was also very weak financially. In response, the Federal Reserve raised interest rates substantially to subdue the inflation rate. As the rates increased, the demand for such loans decreased as businesses and consumers cut back on their expenditures. This correction process typically leads to a recession, if not the outright collapse of financial institutions. Then, as inflation came under control, the recession was prolonged by the Federal Reserve keeping short-term real rates of interest artificially high, which effectively served the purpose of increasing the financial strength of the banks and thrifts from the losses they incurred. The real rates in the United States have remained historically high even after our economy has recovered. This has pushed the strength of the dollar to historical highs, which is now resulting in the collapse of fiat currencies in Asia.

At the same time, the inflation rate in the United States has been dramatically reduced to 1.70% by 1997. This has resulted in a return to low nominal fixed rate mortgages, despite the high real rate of return maintained by the Federal Reserve. These lower rates have encouraged round after round of refinancing by home owners and businesses. These low rate mortgages and loans now being written are setting up our financial institutions, and/or our pension funds, for the next round of price volatility when inflation returns. While it may be decades long, the roller-coaster cycle is being repeated, and will continue to be repeated, until we switch to real financial instruments that are self-adjusting for inflation and deflation.

Real financial instruments will break this cycle, because they will assess each and every borrower their fair share of the cost of rising rates in the marketplace. In addition, every borrower will be required to repay the borrowed principal in real terms, meaning that each lender/investor will recoup the original purchasing power of the capital invested. There will be no need to over-charge future loan customers to cover the losses incurred by past loan customers. At the same time, the borrowers will benefit by having the inflationary premium removed from the amortizing rates of their loans, and as taxpayers they will not have to bail out our financial institutions on a periodical basis in the future. Once again, the need for real financial instruments begins to become obvious as we analyze the situation in both nominal and real terms.

The Adjustable Rate Mortgage (ARM)—Real Perspective
Table 11: Amortization Schedule for a First Generation Real Mortgage™ Assuming Inflation Increases at 1% per Annum
Table 12: Annual Payment Increase for the First Generation Real Mortgage™ in Nominal Dollars with Inflation Increasing at 1% per Annum

As stated above, the movement towards adjustable rate mortgages by our financial institutions was an honest attempt to cover many of the problems discussed herein. However, the problem with ARMs is that the protection for the lender/investor is limited by the interest rate caps and ceilings, and the potential payment volatility could break the borrowers. We can see this more clearly if we compare the payment volatility of a Real Financial Instrument (or Real Mortgage™ as shown in Tables 11 & 12) with the payment volatility of a 6:2 ARM (shown in Tables 4 & 5), as restated below:

Comparison of 6:2 ARM Payments Vs. Real Mortgage ™ Payments
Assuming 1% Increases in Inflation and the ARM Index

| | | | Real | | |
|---|---|---|---|---|---|
| | 6:2 ARM | | Mortgage ™ | | |
| Year: | Payments: | Increase: | Payments: | Increase: | Inflation: |
| 1 | $7,783 | N/A | $6,080 | N/A | N/A |
| 2 | $9,618 | 23.58% | $6,244 | 2.70% | 2.70% |
| 3 | $10,463 | 8.78% | $6,475 | 3.70% | 3.70% |
| 4 | $11,315 | 8.15% | $6,780 | 4.70% | 4.70% |
| 5 | $12,174 | 7.59% | $7,166 | 5.70% | 5.70% |
| 6 | $13,036 | 7.08% | $7,646 | 6.70% | 6.70% |
| 7 | $13,901 | 6.63% | $8,235 | 7.70% | 7.70% |
| Change: | $6,118 | N/A | $2,155 | N/A | N/A |
| Total: | N/A | 61.81% | N/A | 31.20% | 31.20% |

We can see that the Real Mortgage™ payments move up gradually with inflation, while the increase in the ARM payments is not related to inflation at all. In real dollars, adjusted for inflation, the Real Mortgage™ payments in this example would be constant, because the real rate of interest is fixed. The problem with the ARM mortgage is that the borrower's ability to make the increasing payments shown above is unlikely, assuming that the borrower was originally qualified to make the 1st year's ARM payment. With an ARM, the borrower's income would have to move up at a multiple of the inflation rate in the early years. While this may occur for certain individual borrowers, it is unlikely to occur for the average borrower in a large pool of ARM mortgages. At the same time, the ARM's interest rate caps and ceilings will limit the inflationary protection for the lender, whereas the Real Mortgage™ requires no interest rate caps and ceilings. With a fixed real rate of interest, the Real Mortgage™ payments move up gradually with inflation over time.
Table 13: Amortization Schedule for a First Generation Real Mortgage™ Assuming Inflation Increases at 2% per Annum
Table 14: Annual Payment Increase for the First Generation Real Mortgage™ in Nominal Dollars with Inflation Increasing at 2% per Annum

Once again, the increase in the inflation rate and ARM Index of one percent per annum (as shown above) is actually the mild scenario for a 6:2 ARM, but does fairly represent ARMs that are limited to a one percent annual cap. However, the payment volatility can be much greater for the 6:2 ARM, if inflation and the ARM index actually increase at the maximum cap rate of 2% per annum. We can see this more clearly if we compare the payment volatility of a Real Financial Instrument (or Real Mortgage™ as shown in Tables 13 & 14) with the payment volatility of a 6:2 ARM (shown in Tables 6 & 7), as restated below:

Comparison of 6:2 ARM Payments Vs. Real Mortgage ™ Payments
Assuming 2% Increases in Inflation and the ARM Index

| | | | Real | | |
|---|---|---|---|---|---|
| | 6:2 ARM | | Mortgage ™ | | |
| Year: | Payments: | Increase: | Payments: | Increase: | Inflation: |
| 1 | $7,783 | N/A | $6,080 | N/A | N/A |
| 2 | $10,477 | 34.61% | $6,305 | 3.70% | 3.70% |
| 3 | $12,231 | 16.74% | $6,665 | 5.70% | 5.70% |
| 4 | $14,029 | 14.70% | $7,178 | 7.70% | 7.70% |
| Change: | $6,246 | N/A | $1,098 | N/A | N/A |
| Total: | N/A | 66.05% | N/A | 17.10% | 17.10% |

Assuming 2% annual increases in the ARM as shown above, the payments over four years would move up approximately four times faster than the corresponding Real Mortgage™ payments (or 66.05%/17.10%=386%). Not only do the ARM mortgage payments move up faster but they also start out higher. This is due to the inflationary premium that is built-into nominal mortgage rates. The Real Mortgage™, being a Real Financial Instrument, is self-adjusting for inflation and requires no inflationary premium. Inasmuch as the Real Mortgage™ payments with a fixed real rate of interest move up precisely with the inflation rate, there is no need to have interest rate caps and ceilings. This means that we can protect the purchasing power of the investor's capital no matter what happens to the rate of inflation. Once agin, this is why we need real financial instruments, and why the ARM will not adequately do the job. The ultimate conclusion is that there is no satisfactory solution to inflation within the nominal monetary paradigm. This should not surprise us, since nominal financial instruments were never designed to deal with inflation. In fact, they are defined in nominal dollars, which cause inflation.

4. Why Doesn't the Government Issue an Asset-Backed Real Money Supply?

Historically, governments have maintained the sovereign right of issuing currencies. So, why don't they issue an asset-backed real money supply? Stated quite simply: governments do not control the assets required to issue such a money supply. Only the participants in the marketplace control such assets. As we have already shown, there are not enough gold reserves available in the world to back the world's currencies. In fact, there is not even enough to back the United States currency. The Bretton Woods System of fixed exchange rates came very close to doing the job, but ultimately collapsed because it depended upon one country (the United States) to keep its financial house in order. When the United States allowed inflation to take off, the Bretton Woods System of fixed exchange rates became the casualty. At the same time, the history of the Gold Bonds illustrates that it is not enough to issue financial instruments that are convertible to an asset, such as gold, on demand, when the asset backing these instruments is limited to partial reserves. When FDR eliminated the gold clause in Gold Bonds, the U.S. Treasury had approximately $4 billion in gold reserves, but the total corporate and government issue of Gold Bonds was estimated to exceed $100 billion. Monetary systems based upon partial reserves do not work.

However, we now have the opportunity to create an asset-backed real money supply, but there are certain key elements required to create such a money supply. First, we need the unconstrained right to own and sell real estate in a free and open marketplace. Why? Because only such a marketplace, where real estate values are determined by supply and demand, can a true inflationary-adjusted value be determined by the marketplace for the real estate. In a country, such as the former Soviet Union, where all of the land is owned by the government, the real estate has no value. No one will pay you for the real estate, because it would be an illegal transaction. The government would simply take your ownership rights away from you at a later point.

When there is only one prospective owner for a given commodity, then that commodity has no market value. If real estate has no value that can be demonstrated by a price level resulting from the supply and demand of a free and open marketplace, then you cannot use it to back a money supply. For the same reason, other governments around the world cannot directly issue an asset-backed real money supply, since they do not control the real estate that would be required. And, any attempt of the government to directly control the real estate would destroy the value of real estate in backing such a real money supply. Only the marketplace, represented by numerous participants, controls the real estate and thereby establishes the value that is required to back a real money supply.

This does not mean that governments cannot indirectly profit from the issuance of a real money supply. Later, we will show how the United States government could pay off a $6 trillion debt in about 50 years, but it will have to move quickly to obtain this advantage. At the same time, the proper reissuance of the federal debt, utilizing real financial instruments, will substantially reduce the interest payments, since we can factor out the inflationary premium.

Finally, the inflationary premium is undoubtedly depressing the economy. As an example, consider the value of an apartment building. Under current interest rates, and a 75% loan-to-value mortgage, the owner would earn about 6.5% cash return on his equity before income taxes. By switching to a Real Mortgage™, the owner would see his cash return on equity jump to about 13.5%. Since the 1986 Tax Reform Act, commercial-investment real estate has been valued based upon its cash flow after operating expenses. Just like any other business. By increasing the owner's cash return on equity from 6.5% to 13.5%, we are increasing the value of his building.

The logical conclusion is that the inflationary premium, which the Real Mortgage™ removes from the owner's amortizing rate, has been depressing the value of the real estate. And, since commercial-investment real estate is now valued like any other business, we can reasonably assert that the inflationary premium built-into consumer, business and government loans has been depressing our entire economy. Certainly, the degree of depression is less than that shown for the apartment building, since the term of the average loan throughout the economy would be much less than the 30-year term of the mortgage. Nonetheless, the impact is still there.

We can see the same effect when we consider what a Real Mortgage™ will do for the home owner. In effect, we can reduce the home owner's first year mortgage payment by 25% to 35% depending upon the indexes at the time. Assuming the average home owner uses this extra cash flow to buy consumer goods, then the home owner's standard of living will increase, businesses will thrive meeting this increase in demand for their products and services and the government's tax revenues will increase without even raising the current tax rates. Now we can truly begin to see what Keynes meant when he said that inflation “ . . . engages all of the hidden forces of economic law on the side of destruction . . . ” We can eliminate inflation and deflation by replacing our nominal dollars with an asset-backed real money supply.

However, to achieve this goal our marketplaces must be transformed from the current nominal monetary paradigm to the coming real monetary paradigm. This cannot be achieved by a fiat order by the government. It must be phased in slowly by creating a conceptual bridge that will allow consumers, businesses and even the government to deal with the changes that a monetary paradigm shift implies. The asset-backed real money supply is the ultimate goal, but there are many small steps that must be taken to get there. We will define these steps as we explain the Real Monetization™ process, and show how the Real Monetary Software™ will carry out the crucial elements of this process.

As we have shown, there are many ways that governments could benefit by allowing the issuance of an asset-backed real money supply. Nonetheless, they must begin to let go of their sovereign control with respect to the issuance of the real money supply, since it must be done within the confines of an unfettered marketplace. But governments can expect to regulate the issuance of the real money supply. And, if they grant a monopoly to one company, perhaps by recognizing it as a quasi-governmental agency; then they expect to participate in monopolistic return. Such profits could be used to pay off the federal debt in the United States, or for similar uses in other countries.

It appears that the issuance of asset-backed real money equivalents can already be achieved under the current laws of most modern countries. If the government waits too long, then multiple players will enter the business of issuing a real money supply, and competition between these players will reduce the monopolistic profits that could be garnered by the government on behalf of its citizens and taxpayers. The logical choice for the government's joint venture partner is the company that can demonstrate how the real money supply can be created. Inasmuch as sophisticated financial software will be required, software that the Real Mortgage Corporation is hereby filing for a patent; the logical choice is the Real Mortgage Corporation.

D. Problems Associated with the First Generation of Real Financial Instruments

If the modern movement to real financial instruments began with Great Britain's offering of real bonds about 15 years ago, then why hasn't more progress been made. At this time, only about 15% of the British government bond market is represented by real bonds. And, the use of real financial instruments in the private sector appears to be minimal or non-existent. Given the substantial benefits available for both the borrower and the lender in using real financial instruments, one would have expected a higher degree of market saturation after 15 years. What is the problem? The inventor believes that the slow progress by the First Generation of Real Financial Instruments is due to three types of problems that could best be described as credit-related problems, a perceptual problem and market-related problems. We will discuss these problems in the context of specific First Generation Real Financial Instruments. Nonetheless, the problems apply substantially to all First Generation Real Financial Instruments.

1. The Price-Level-Adjusted-Mortgage (PLAM)

On Jan. 29, 1989, Forbes magazine published an article entitled: PLAM! The article stated:
“ . . . there is a slight glow on the otherwise dark housing horizon. The U.S. Department of Housing & Urban Development is about to announce new regulations that will expedite a new type of mortgage. If it catches on, the new mortgage stands to make housing more affordable, provide lenders with an excellent hedge against inflation, and, possibly smooth to some extent the steep fluctuations in the housing construction industry.”

Suffice to say the PLAM did not catch on. The inventor reviewed the PLAM, as proposed, and felt it would not work for a number of reasons. This reasons include a number of credit-related problems and one perceptual problem, which can be summarized as follows:

Credit-Related Problems

Qualifying the Borrower:

The mandate that HUD has received from congress was to create housing for the low-to-moderate income families. HUD believed that the PLAM could be used to meet this goal. While the goal in itself is honorable, the inventor felt that the financial markets would not accept what HUD was proposing. To begin with there is the question of how to qualify the borrower. HUD wanted to get families that could not currently qualify for a house loan into a PLAM mortgage. Officials at HUD proposed to do this by qualifying the borrowers at a 4% real rate of interest instead of the current 9% nominal rate in the marketplace. Qualifying the borrowers in this manner will create certain problems, as shown below. But how should borrowers be qualified for a PLAM mortgage, or for any other Real Financial Instrument?

Larger Mortgages are Difficult to Sell to Investors

The fundamental goal of HUD was to qualify people for mortgages that were larger than they could normally qualify to receive under traditional nominal terms. Such a proposal will be very difficult for the traditional mortgage investor to accept. And, the idea of having the U.S. government stand behind and guarantee repayment on such mortgages, at a time when the federal debt and deficit were already out of control, must have been impossible for the conservative administration of President George Bush to accept.

Qualifying at the Real Rate is Inflationary

If HUD made the PLAM mortgage generally available across the United States and qualified people at a 4% real rate of interest, then everyone would qualify for a mortgage loan about 50% higher than they could currently receive under nominal terms. As such mortgage money became widely available, single family home prices would also rise by 50%. After a few years, we would all be living in approximately the same houses, but we would all be paying 50% more for them. In a word, qualifying borrowers at the real rate of interest is inflationary. The problem is that this was the only way that HUD could achieve its objective to provide mortgage funding for low-to-moderate income families. Unfortunately, HUD could not see beyond their own self-imposed goals.

Rents & Incomes Would Have to Keep Up with Inflation

Another problem with qualifying the PLAM at the real rate of interest is that the borrower's income would then have to keep up with inflation. Whenever you have a Real Financial Instrument with a fixed real rate of return, then the mortgage payment is constant in real terms. However, the fixed real dollar mortgage payment must then be converted to nominal dollars for actual payment, since the real dollar is only an abstract concept at this time: This is achieved by multiplying the fixed real dollar mortgage payment by an inflationary adjustment factor (IAF). The IAF simply measures the change in the agreed upon inflation index, since the loan was granted, which results in the nominal dollar mortgage payment increasing with inflation. Historical evidence indicates that rents and incomes do to tend to keep up with inflation over longer time periods of ten to thirty years. However, rents and incomes can also lag behind the inflation rate during recessionary time periods, typically three to seven years in duration. Once again, the inventor felt that the typical mortgage investor would have a hard time accepting the prospect that low-to-moderate income families would have incomes that would consistently keep up with inflation.

Perceptual Problem:

Negative Amortization: The Grand Illusion

Real financial instruments, by definition, are defined in real currencies and amortized with real rates of interest. This generates a payment defined in a real (or constant) currency. Inasmuch as real currencies do not now exist, the real currency payments must be converted to nominal currencies for actual payment. This is done by multiplying the real currency payment by an inflationary adjustment factor (IAF). The IAF is simply the percentage change in the agreed upon inflation index, since the real financial instrument was funded. This means that real financial instruments will be negatively amortizing in nominal terms if the rate of inflation exceeds the rate at which the principal on the instrument is being amortized. In fact, real bonds will be negatively amortizing for their entire term, since bonds by definition pay the entire outstanding principal balance upon with the final payment of the bond. Nonetheless, real financial instruments, such as mortgages that do amortize, will amortize in real terms from the first payment. Where does the negative amortization come from then? It comes from the fact that it will require an increasing amount of nominal paper dollars to equal the declining principal balance of the real financial instrument as defined in real dollars. However, since money is supposed to represent purchasing power, and the real dollars represent a constant amount of purchasing power; we can see that the true outstanding balance of the purchasing power is expressed by the real dollar balances over time. This means that the negatively amortizing nominal dollar balance is a grand illusion. Once again, we are seeing an example of what Keynes meant when he said that inflation was a process that “engages all of the hidden forces of economic law on the side of destruction . . . ”

The negative amortization was especially troubling to the financial community at the time that HUD was proposing the PLAM due to a mortgage called the Graduate Payment Mortgage (GPM). The GPM reduced the amortizing rate so that borrowers could qualify for receiving a larger mortgage amount. However, the balance of the market interest rate was used to negatively amortize the GPM loan balance. Then each year, the amortizing rate was increased and the accruing rate was decreased, until after three to five years, the borrower has a loan that was fully amortized at the nominal market rate of interest. This appears on the surface to be similar to the PLAM mortgage, except that in real terms it is completely different. The rate at which the loan was amortized at any point had nothing to do with the rate of inflation. It was not amortized with a real rate, and the increases in the outstanding principal amount had nothing to do with the prevailing rate of inflation. This was not a real financial instrument in any sense of the word. In fact, this loan was heavily promoted just as inflation was beginning to decline in the early 1980s. As such, the loan became negatively amortizing in real terms. In addition, the payments increased at a rate that was substantially faster than the rate of inflation. This meant that both the value of the house securing the loan, and the home owner's income, had to increase substantially faster than the rate of inflation. When this did not occur, defaults were rampant. And, because there was no amortization in real terms, lenders frequently discovered that they were foreclosing on homes that had mortgage in excess of the net value of the home after resale costs. In the mortgage industry, the GPMs soon became known as the “neutron bomb mortgage,” since all that was left standing were the homes. All the home owners had been wiped out.

In retrospect, it is easy to point out that neither the borrowers, nor the lenders, had any sense at all of what could happen to them with the GPM mortgage. Why was this? Stated quite simply, everyone assumed that the rate of inflation, meaning the increasing value of the homes and the increasing incomes, would equal or surpass the rate of increase in the GPM's outstanding principal balance and mortgage payments. In other words, they simply projected the recent past into the future, and it appeared to work, but there was no direct relationship between the inflation rate and the rates used to determine the GPM's increasing mortgage payments. Instead, history reversed itself and inflation declined, but the GPM continued to increase both the outstanding balance in real terms and the actual mortgage payments.

The reason that the original analysis of the GPM failed is that the parties to the loan attempted to structure an instrument with increasing payments and an increasing principal amount (or negative amortization) that corresponded with the expected rate of inflation. Almost as if they were attempting to mimic real financial instruments, which would not appear on the scene until later. However, the actual interest rates, and the outstanding loan balances of the GPM mortgages, had nothing to do with the rate of inflation as it was experienced in the subsequent years; since the GPMs were not defined in real terms. Nonetheless, when the PLAM was finally offered with the negatively amortizing mortgage balance in nominal terms, it appeared to be very similar to the GPM, once again because the participants did not analyze the instrument in real terms. In reality the GPM and the PLAM are very different instruments, since the first is defined in nominal terms and the second is defined in real terms. Nonetheless, the perceptual problem of the negative amortization made it very difficult to introduce the PLAM. One might say that the final victim of the GPM mortgage was the PLAM mortgage.

2. Treasury Inflation Protection Securities (TIPS)

On Jan. 29, 1997, the U.S. Treasury offered a new 10-year note called Treasury Inflation Protection Securities. Basically, the TIPS were First Generation Real Financial Instruments that were priced at a margin above the Consumer Price Index for All Urban Consumers (CPI-U). This first auction was well-anticipated, since the Treasury Department announced its intent to auction such instruments as early as May of 1996. The response at the first auction of the TIPS was considerable. In excess of $35 billion in bids were received for the offering of $7 billion in TIPS. At the time, it appeared that the TIPS were well-received.

The initial TIPS auction was followed in three month intervals by two additional auctions, one for $8 billion in 10-year TIPS and then an $8 billion auction for 5-year TIPS. In nine months, the U.S. Treasury had sold $23 billion in TIPS. This seems like an amazing feat until you consider the total size of the U.S. government's debt. The total TIPS auctioned in three-quarters of the first year was less than one-half percent of the total Treasury market. The acceptance of the TIPS appears to be moving at a slower rate than the acceptance of the British real bonds. After all, the British real bonds had secured 15% of the market in 15 years, or about 1% per annum. At this rate, it will take the British bond market 100 years to convert to real bonds, and it will take the U.S. market for government bonds even longer to convert to TIPS. (British bonds and TIPS are essentially the same instrument with only minor changes, primarily in the timing of the application of the inflation indexes. Both are First Generation Real Financial Instruments, as defined herein.)

The sluggishness of the market for TIPS was noted by the financial journals. In an article entitled, “Inflation Bond Is Still Getting Cool Response,” the Wall Street Journal stated that:
“The Treasury's first-ever auction of inflation protected securities with five-year maturities got a lackluster response yesterday. The tepid response to the issue, as well as to earlier issues of 10-year notes, underscores the difficulty in developing a widely traded market for such securities . . .
A lack of familiarity with the novel securities also hampers them, despite tireless efforts by the Treasury Department to reach out to the investing public.”

It is also interesting to note that The Wall Street Journal itself seems to be having trouble with the concept of real bonds. The same article goes on to state:
“ . . . the price of the five-year inflation-protected note rose sharply after the auction, trading at a yield of 3.66% late in the day.
Some traders said the auction would serve as a floor for the new securities, arguing that unless a deflationary era emerges prices won't go much lower. Indeed, regular five-year notes with no inflation protection traded at a yield of 6.14% late yesterday, 2.44 percentage points above the yield of the inflation-protected securities, suggesting that even if inflation returns to the modest 3% level, inflation protected securities should do well.”

To begin with, one cannot directly compare the real return of the TIPS at 3.66% with the nominal return of the traditional five-year note of 6.14%. In point of fact, the effective difference between the TIPS and the five-year note was not 2.44%, but rather 0.25% (or 25 basis points) as shown below:

Comparison of TIPS Vs. Notes on Jul. 9, 1997

| | 5-Year | 5-Year |
|---|---|---|
| | Notes: | TIPS: |
| Nominal Rate of Interest: | 6.14% | N/A |
| Real Rate of Interest: | N/A | 3.66% |
| Prevailing Inflation Rate: | 2.23% | 2.23% |
| (thru May, 1997) | | |
| Effective Real Rate of Interest: | 3.91% | N/A |
| Effective Nominal Rate of Interest: | N/A | 5.89% |

By definition, the nominal rate of interest less the prevailing rate of inflation equals the real rate of interest, which allows us to project the effective nominal rate for the TIPS and the effective real rate for the traditional Notes. As such, the effective spread between the traditional five-year Treasury Notes and the five-year TIPS can be calculated in either real or nominal terms as shown below:

| In Nominal Terms: | |
|---|---|
| Traditional Notes | 6.14% |
| Nominal Rate of Interest: | |
| Treasury Inflation Protected Securities | 5.89% |
| Effective Nominal Rate of Interest: | |
| Spread: | .25% |
| In Real Terms: | |
| Traditional Notes | 3.91% |
| Effective Real Rate of Interest: | |
| Treasury Inflation Protected Securities | 3.66% |
| Real Rate of Interest: | |
| Spread: | .25% |

The first lesson in dealing with real financial instruments is that you must subtract apples from apples and oranges from oranges. You cannot subtract apples from oranges to determine how many apples you have left. However, it is interesting to note that if you set up your problem correctly, then you can determine the spread between a Real Financial Instrument and a Nominal Financial Instrument in either nominal or real terms, and you will get the same answer. In fact, getting the same answer is a proof that you have not screwed up the problem in the first place.

Now we can see that the spread between the traditional five-year Treasury Notes and the TIPS on the day of the TIPS auction, or Jul. 2, 1997, was 25 basis points, not the 244 basis points quoted by the article in the Wall Street Journal. So does this mean that you should buy the instrument that has the extra 25 basis points? Not at all. The traditional Treasury Note has a fixed nominal rate of return, which means that it has a variable real rate of return. On the contrary, the TIPS have a fixed real rate of return, which means that the holder will earn 3.66% over-and-above the rate of inflation for the duration of the term. On the other hand, the 3.91% real rate of return initially offered by the traditional Treasury Note is a variable rate which will move inversely with inflation. If one wishes to speculate, then one may wish to ride the variability of the traditional Treasury Note. However, if one has a fiduciary responsibility to protect the purchasing power of other people's capital, then the prudent man rule would certainly dictate an investment in the TIPS; assuming other issues such as liquidity are not a problem.

Finally, the observation in the article that “ . . . even if inflation returns to the modest 3% level, inflation protected securities should do well,” is misleading. In fact, the relative level of inflation for the TIPS, as a First Generation Real Financial Instrument, is moot; since the 3.66% real rate of interest floats above the inflation rate. However, these misguided comments by a financially sophisticated journalist, comments which must have been approved by the editors of the foremost financial journal in this country if not the world; shows just how large a problem the introduction of real financial instruments into the nominal monetary marketplace will be. Once again, this highlights why we cannot simply move from the nominal monetary paradigm to the real monetary paradigm over night.

Other journals have also noted the problems that TIPS appear to be having. On Jun. 23, 1997, an article in Barron's entitled: “Bad Times for TIPS Funds,” states:
“Inflation-indexed securities dramatically underperform when monetary authorities act to prevent inflation, as the Fed did in march . . . And they also lag when inflation is muted and investors' concerns about price pressures are waning, which is the ideal environment for nominal bonds. Further good news on inflation means that TIPS will continue to trail garden-variety bonds . . . ”

Once again, we can see Keynes “destructive forces” at work. When the government adequately controls inflation, very few investors want inflation-protected bonds. Conversely, when inflation begins to soar out-of-control, it may not be in the best interests of the government to issue such bonds. This inflationary paradox seems to keep us trapped inside the nominal monetary paradigm, where inflation can ultimately flourish even if it is periodically subdued. What's happening here? Fundamentally speaking, the paradigm effect will not allow us to see the benefits of real financial instruments. In addition, our current nominal monetary ways of dealing with money also create marketing barriers that must be over-come. There are three such marketing barriers that must be removed, before we can hope to create a dynamic marketplace for real financial instruments.

Market-Related Problems

The Pricing Problem:

When introducing real financial instruments into a traditional nominal monetary marketplace, pricing such instruments becomes an immediate problem. First of all, there is no well-structured marketplace for real rates of interest, as there is for nominal rates of interest. For instance, if one were to price an “A” rated corporate bond, one could review what other “A” rated corporate bonds were selling for at a margin over the Treasury Bill Index. One could even price a new issue of nominal rate Treasuries off the existing Treasury Index. But how do you price the first issue of TIPS, when no such index exists for real financial instruments. (In fact, we will show below that the pricing of the current TIPS in the marketplace has been distorted by a negative interest-rate-anomaly.)

Another problem is that the First Generation of Real Financial Instruments is priced at a margin over the Consumer Price Index (CPI). However, the CPI is not a market-generated index, but is tabulated by an agency of the federal government (the Bureau of Labor Statistics). This makes investors uncomfortable with real financial instruments so structured. As the largest borrower in the marketplace, what happens if the government decides to change the definition of the CPI to lower its borrowing costs? In fact, the government has had serious discussions on altering the definition of the Consumer Price Index over the past few years for the expressed purpose of lowering the cost of its entitlement programs.

Finally, the inflation index measures the past, while market indexes like the Treasury Bill Index measure the markets perception of the future. As such, these two indexes can move in opposite directions in the same time period. The potential for this contrary movement contributes to the confusion in properly pricing real financial instruments.

The Marketing Problem:

First Generation Real Financial Instruments are supposed to offer a trade-off to the lender and the borrower. The lender receives a fixed real rate of interest that floats over and above the rate of inflation, while the borrower has the inflationary premium reduced from his or her amortizing rate of interest. Once the marketplace has fully converted from nominal to real terms, the First Generation of Real Financial Instruments may be the ideal instruments to use. However, the pricing of First Generation Real Financial Instruments off the inflation index also creates a marketing problem. The marketing problem is caused by the removal of the inflationary premium, thereby creating a negative interest-rate-anomaly in favor of the nominal financial instruments. It is almost impossible to sell-fixed income instruments with a negative interest-rate-anomaly, since the buyers will invariably chose the instrument offering the higher nominal rate (if the credit risk is assumed to be equal). Undoubtedly, this is one of the major reasons why no market has developed in the private sector for real financial instruments. And, as the inflationary premium increases with the term of the instruments, the negative interest-rate-anomaly gets bigger and bigger. This is why the government has only offered five-to-ten years TIPS thus far. It is also the reason why there is only a 25 basis point differential in the traditional five-year Treasury Note and the five-year TIPS, as shown above on Jul. 2, 1997. The negative interest-rate-anomaly, caused by the inflationary premium built-into the nominal Treasury Note, has inflated the real rate of interest on the TIPS. As we shall demonstrate below, the spread between the TIPS and the nominal fixed-rate Treasury Note should be much greater. In fact, the five-year and ten-year TIPS are all an incredible bargain at this time.

The Liquidity Problem:

Perhaps the most intractable problem is the liquidity problem. As explained above, real financial instruments, during inflationary time periods, are negatively amortizing in nominal terms. This means that they are accruing interest for part of their terms in the case of amortizing instruments or for all of their terms in the case of bonds. This creates a number of problems for the potential pool of investors.

First of all, the Internal Revenue Service in the United States has ruled that this accruing interest is taxable for taxpaying entities. This effectively eliminates taxpayers as potential investors in real financial instruments. Nonetheless, the British authorities were far-sighted enough to fix this problem. In Britain, the accruing portion of your outstanding balance increases your basis and is therefore not taxed. Inasmuch as money is supposed to represent purchasing power, and the purpose of the accruing interest is to maintain the purchasing power of your invested capital; the British response is the proper way of handling this situation. Otherwise, you are being taxed a portion of your invested capital, which you have already paid taxes upon when you first earned it. Nonetheless, the response by the United States government was predictable, given the country's $5.38 trillion debt. How can the U.S. government forego any possible source of revenue regardless of the morality. Still, one has to note that the British handling of the tax problem, did not substantially increase the demand for the British real bonds.

Perhaps more crucial than the tax problem is the cash flow problem. Certainly, there are trillions of dollars held in the United States by tax exempt entities, that would not have to deal with the tax consequences of the accruing interest. Why have they been slow to respond to the TIPS offerings? Simply stated: cash flow. Each of these tax exempt entities has its own cash flow needs. Real financial instruments are amortized with lower real rates of interest, meaning that they have lower cash payments in the early years. These payments tend to increase with inflation over time in nominal terms and will actually surpass the original cash payments made by competitive nominal financial instruments. But the cross-over point may be a decade or more away. How will these institutions meet their current cash flow needs in the mean time?

In theory, the TIPS investors could simply sell a portion of their TIPS each year to meet the cash flow needs, except that there is no vibrant after-market for the TIPS. In fact, the U.S. Treasury has warned potential investors not to invest in TIPS unless they could hold the investment to term. Why? Because the sale of real financial instruments at mid-term will result in the purchaser discounting the outstanding accrued interest. The discounting will occur, because the outstanding accrued interest looks very much like a zero-coupon bond.

Given these problems with liquidity, why has no one created a liquid market for the accrued interest? To date, no such market appears to exist, despite the fact that Great Britain has been offering Real Bonds for some 15 years. If this is a requirement for creating a liquid after-market for these instruments, then why hasn't the British government promoted such a market? The problem is that sophisticated financial software is required to develop a market for the accrued interest. This is one of the roles that the invention will play. In fact, the Real Monetization™ process, utilizing the Real Monetary Software™, will allow for the creation of the Second Generation of Real Financial Instruments, which will effectively solve all of the credit-related, perceptual and marketing-related problems associated with the First Generation.

### II. SUMMARY OF THE INVENTION

The purpose of the invention, Real Monetary Software™, is to carry out a process known as Real Monetization™. This process includes a number of steps that are designed to facilitate the transformation of the marketplace from the current nominal monetary paradigm to the coming real monetary paradigm by solving specific problems related to this transformation. The ultimate goal being to present the attributes and the benefits of real financial instruments in traditional nominal terms that can be understood by the various participants in the marketplace by building a conceptual bridge by and between the real monetary paradigm and the nominal monetary paradigm. This process will take us from traditional nominal financial instruments to and through the First and Second Generation of Real Financial Instruments and then finally to the Third Generation of Real Financial Instruments, or the issuance of an asset-backed real money supply.

As we proceed, it will become obvious that the Real Monetization™ process will logically result in the issuance of the asset-backed real money supply. Nonetheless, it will also be apparent that the transformation of the marketplace from nominal to real terms will represent a paradigm shift that will require the use of Real Monetization™ as a conceptual bridge. As such, each of the problems involved in the offering of real financial instruments will be set forth below along with the corresponding solution. If the problems have not been fully addressed in Section I above, then they will be dealt with in more detail in this Section II.

A. Nominal Vs. Real Currencies
Problem: The current monetary system is based upon the Nominal Currencies, which Violates the Concept of Whole Numbers thereby causing inflation.
Solution: Create a Multi-Phase Monetary System that is based upon Master Real Currencies that are self-adjusting for inflation, whereby financial obligations can be denominated and tracked in real terms and then converted to nominal terms to meet the expectations of the participants in the nominal monetary marketplace.

The purpose of the Multi-Phase Monetary System is to begin the shift from nominal to real terms by allowing for the creation of real financial instruments that are denominated in real currencies and amortized with Real Interest Rates with the resulting real currency payments being converted to the traditional nominal currency with an Inflationary Adjustment Factor (IAF) for actual payment. Each Real Financial Instrument created will define one unit of its real currency to be equal to the purchasing power of one unit of nominal currency on the day the instrument is created. Then the real monetary transfers from instruments created with variously defined “real currencies” will be convertible to a Master Real Currency using a Master Inflationary Adjustment Factor (MIAF). Each defined real currency will have its own MIAF, depending upon its purchasing power relative to the Master Real Currency, but the Master Real Dollar will have a constant level of purchasing power for all participants within the given monetary system.

Finally, the nominal currency amortization schedule will be distorted, such that the Principal Paid during inflationary time periods will exceed the original principal borrowed in nominal terms. As such, there will be one more monetary phase, referred to simply as the “Currency Phase,” whereby the excess nominal currency Principal Paid column in the amortization schedule will be recast to the Interest Paid column on the Currency amortization schedule. The Beginning Principal and the Ending Principal columns of the nominal currency amortization schedule will also be recast on the Currency amortization schedule to reflect the new amount of Principal Paid for each payment period. The entire process results in the need for four amortization schedules, representing the four monetary phases as described below:

### Multi-Phase Monetary System

Phase 1: Master Real Currency Will have a constant level of purchasing power throughout the given system. Real Financial Instruments will be defined in “real currencies,” which may be converted to the Master Real Currency for monetary transfers in the open marketplace.
Phase 2: Real Currency Each Real Financial Instrument, each Asset, each Conduit, each Issued Currency and each Accrual Right will individually designate the value of its own real currency based upon the inflation index on the origination date, start-up date or issuance date as the case may be. Only those using the same inflation index “date” will have the same defined level of purchasing power for their respective real currency. As such, the valuation of each respective Real Currency becomes an internal matter, making the real currencies inappropriate for monetary transfers in the open marketplace.
   Phase 3: Nominal Currency The nominal currency has the same purchasing power as the Currency at all times, usually representing the paper currency issued by the government. The real financial instrument, using real terms, amortizes the real principal balance to produce the real currency payment. Then the real currency payment is converted with an Inflationary Adjustment Factor to the Nominal Currency for actual payment.
   Phase 4: Currency The nominal currency amortization schedule will be distorted in the conversion process from the Real Currency to the nominal currency, such that the nominal currency amortization schedule will have to be recast to the Currency amortization schedule so that participants may track what is occurring for book purposes in nominal terms.

The Multi-Phase Monetary System serves the following purposes:

(1) It allows the issuer of the Real Financial Instrument to define one unit of the real currency as being equal to one unit of the current nominal currency. This 1:1 ratio is important for people who have not yet made the paradigm shift to real monetary units. Such participants would be unwilling to convert one hundred Nominal Dollars for seventy-five Master Real Dollars, since they will not understand that these relative monetary units may represent the equivalent level of purchasing power on the day of the transaction. The Multi-Phase Monetary System creates a framework by which participants in the market place can gradually make the paradigm shift over time, instead of being forced to convert from a nominal to a real money supply over night. In fact, those with a substantial degree of paradigm paralysis can effectively analyze the use of real financial instruments entirely by simply reviewing only the Currency stage of the given transaction. They can leave the more complex monetary conversions to the financial professionals.

(2) The ability to convert the real currency to the Master Real Currency allows for the creation of a constant monetary unit, so that wealth can be transferred in the marketplace by and between participants in a constant unit. It resolves the problem that each different Real Financial Instrument may have a different definition for the purchasing power of its own defined real currency. This will be crucial later for making a market for the accrued interest that is inherent to all real financial instruments during inflationary time periods. It also begins to redirect the focus of the participants from the current nominal currency to the coming asset-backed real money supply. This is crucial for participants in the marketplace to make the paradigm shift. If they cannot see where this is all leading, then why would they cross the conceptual bridge to the real monetary paradigm? Conversely, when they do begin to see where this is all leading, then it also becomes obvious that a complete transfer to an asset-backed real money supply will greatly simplify everything. At this point of recognition and understanding, we can expect participants in the marketplace to begin to accept the sole use of an asset-backed real money supply. Nonetheless, everyone's paradigm will shift at a different rate, and some may never shift their monetary paradigm. As such, the Multi-Phase Monetary System may be around for some time. This situation is somewhat analogous to the use of the plastic credit and debit cards. While using plastic may be safer and more convenient, there is still a portion of society that resists using plastic and prefers checks and cash transfers.

(3) The ability to define financial instruments in a real currency for conversion into the nominal currency allows for the use of real monetary units in a system where there is no real money supply. In fact, this begins to open the door for the monetary paradigm shift.

(4) The ability to recast the nominal currency to Currency allows the participants in the marketplace to balance their books in the traditional monetary units that they are accustomed to using.

Finally, (5) we can begin to see that we have spanned the conceptual difference between the use of nominal monetary units and real monetary units. Participants in the marketplace can then begin to see the benefits of using real financial instruments in traditional nominal monetary terms. At the same time, as they learn more about the Multi-Phase Monetary System, they can begin to accept and understand the use of a real money supply based upon the Master Real Currency; which will open the door for the issuance of an asset-backed real money supply. By following the monetary structure being created herein, one can begin to see that the logical conclusion of Real Monetization™ process is the removal of the nominal currency from the marketplace by replacing it with an asset-backed real money supply. Inasmuch as inflation is a byproduct of the nominal money supply, there appears to be a reasonable chance that we can substantially eliminate both inflation and the fear of inflation in the future.

B. The Paradigm Effect—Graphic Presentations
Problem: The Paradigm Effect: People have trouble understanding the difference between nominal financial instruments and Real Financial Instruments, because they are only accustomed to working with the nominal currency.
Solution: Graphs: Graphically present the relative performance of both nominal and real financial instruments in both Nominal Currency and real currency. By asking people to analyze what is occurring in both nominal and real terms, we can begin their paradigm shift.

By properly explaining that money is supposed to represent purchasing power, and then showing the relative difference between a Nominal Financial Instrument and a Real Financial Instrument in both the nominal currency and the real currency in a graphic form; most people begin to make the paradigm shift. In other words, they can begin to think in both the nominal currency and the real currency, which will allow them to see the comparative differences. This will also allow them to see the advantages of using real financial instruments in the nominal terms that they are accustomed to seeing.

Table 15: Apartment Owner's Cash Flow Before Taxes (N$)
Table 16: Apartment Owner's Cash Flow Before Taxes (R$)
Table 17: Apartment Owner's Cumulative Reinvested Cash Flow (N$)
Table 18: Apartment Owner's Cumulative Reinvested Cash Flow (R$)
Table 19: Annual Debt Service in Nominal Dollars (N$)
Table 20: Annual Debt Service in Real Dollars (R$)
Table 21: Mortgage Balances in Nominal Dollars (N$)
Table 22: Mortgage Balances in Real Dollars (R$)
Table 23: Mortgage Balances in Nominal Dollars (N$) Vs. Property Value @ 8.5% Capitalization Rate
Table 24: Mortgage Balances in Real Dollars (R$) Vs. Property Value @ 8.5% Capitalization Rate
Table 25: Apartment Cash Flows with Real Mortgage™ (N$)
Table 26: Apartment Cash Flows with Real Mortgage™ (R$)
Table 27: Apartment Cash Flows with Real Mortgage™ (N$) Vs. Cumulative Securities Reserve
Table 28: Apartment Cash Flows with Real Mortgage™ (R$) Vs. Cumulative Securities Reserve

Tables 15 through 28 are examples of monetary graphs that are presented to prospective applicants for the Real Mortgage™ for multi-unit residential properties. Each page depicts two graphs of the same data, but with the top graph expressed in nominal currency while the bottom graph is expressed in real currency. Similar graphs can be created for each different type of borrower and each different type of asset class. The graphs are annotated and should be self-explanatory, but we will discuss Tables 21 and 22 in depth as we discuss the negative amortization problem in Paragraph “C” below. As the participants move beyond the initial definition of the nominal currency and the real currency to the Master Real Currency and the Currency, additional graphs can be used to illustrate the relative difference in the four monetary phases. These graphs are created from a Real Monetary Software™ application that compares the use of a Real Financial Instrument with the traditional Nominal Financial Instrument, such as the Real Mortgage™ versus a nominal fixed-rate mortgage.

C. Negative Amortization
Problem: All real financial instruments during inflationary time periods are negatively amortizing in nominal terms for part or all of their term whenever the inflation rate exceeds the rate of principal payoff. This often concerns both the lenders and the borrowers.
Solution: Graphically present the outstanding loan balance in both the nominal currency and the real currency, so that the participants can see that the negative amortization is actually an illusion since money is supposed to represent purchasing power. Only the real currency represents a constant level of purchasing power, and it positively amortizes from the first payment with real financial instruments.

Participants have to be reminded that money is supposed to equal purchasing power, but that the nominal currency does not hold its purchasing power over time. As such, we can only truly track the purchasing power of our money in constant terms, using a real currency. This means that we can plot the outstanding loan balance of the real financial instrument in both the nominal currency and the real currency to show the borrower what is really happening to his loan balance. While the nominal currency will indicate that the loan is negatively amortizing, the real currency will indicate that the real financial instrument positively amortizes from the first payment in real terms. (Except that, real bonds do not positively or negatively amortize in real terms until the final payment when they are paid off.)

The reason that the real financial instrument appears to be negatively amortizing in the nominal currency is that it takes an ever-increasing amount of the nominal currency to equal the real currency balance that is actually declining. In fact, the nominal currency amount on the first day the loan is originated has a higher level of purchasing power than the amount of the nominal currency at the peak of the negative amortization. We can see this is true by reviewing the same relative points on the graphs in both the nominal currency and the real currency. This explanation can best be made by graphically presenting a projection of the outstanding balance of the real financial instrument in both the nominal currency and the real currency as presented in Tables 21 and 22. Once again, we have found the use of such monetary graphs to be crucial in helping people shift their monetary paradigm from nominal to real terms.

D. Credit-Related Problems
Problem: Issuing real financial instruments in a nominal monetary marketplace can create certain credit-related problems associated with the qualification of the borrower. How should the borrower applying for a Real Financial Instrument be qualified in a nominal monetary marketplace to:
   (1) avoid investors balking at over-sized loans,
   (2) avoid over-sized mortgages creating an uncontrolled, inflationary spiral of asset values and
   (3) avoid the necessity of the borrowers' rents and/or incomes keeping up with inflation.
Solution: Begin the offering of real financial instruments in a nominal monetary marketplace by qualifying the borrower under the traditional nominal terms and conditions being offered in the marketplace to determine the size of the loan. Then grant the same size loan in real terms.

Eventually, price-levels in the marketplace will have to come to a new equilibrium with real financial instruments, since the inflationary premium loaded into nominal financial instruments is depressing asset values. However, this new price level equilibrium can be approached gradually over a period of time, assuming that the agencies and credit rating companies maintain the appropriate standards. Nonetheless, the initial standard, when introducing real financial instruments into the marketplace, should be the existing nominal standard.

First, using the existing nominal standard tells the investors purchasing the loans that you are not using the real terms to give anyone a mortgage any larger then they would currently qualify to receive under current nominal terms. This is an important marketing point, since there is no history for the performance of real financial instruments. This also means that one should think twice before using real financial instruments to bail out a troubled loan situation. If the subject borrower cannot afford to make the loan payment under traditional nominal terms, then giving the borrower the same size loan under real terms could create a major problem later as the debt service payments increase each year in nominal terms.

Second, this qualification process will not unleash excess capital into the marketplace to cause an inflationary price level spiral on the asset class being purchased, until such time as the new price-levels can be allowed to gradually reach a new equilibrium under the guidance of properly qualified financial professionals.

Finally, the borrower is qualified at the higher nominal interest rate, that is loaded with an inflationary premium, which would qualify the borrower to make the higher nominal loan payments. The same size loan is then granted in real terms, which is possible because one unit of the real currency will equal one unit of the nominal currency on the day the Real Financial Instrument is created. However, while the loan amount will be the same, we will switch the borrower to a real rate of interest for amortizing the loan. This smaller real rate of interest will result in a lower loan payment in the first year, which will approximately ratchet up with inflation. The result is that the borrower is now over-qualified to make the loan payments on the Real Financial Instrument. At the same time, the borrower's income and/or rents can actually lag behind inflation, and the borrower will still be qualified to make the payments on the Real Financial Instrument.

E. Credit Enhancement
Problem: Most loan instruments today are used to issue asset-backed securities, which creates a liquid market for these loan instruments. Under nominal terms, most asset-backed securitization programs require external credit enhancement in order to obtain the institutional-quality credit ratings, which are necessary to market the asset-backed securities at a feasible price. How does one obtain such credit enhancement on Real Financial Instruments, when there is no effective history for credit enhancement suppliers to evaluate?
Solution: By qualifying the borrower in nominal terms, as described in Paragraph “D” above, the Real Financial Instrument generates extra cash flow for the borrower by reducing the borrower's loan payments in the early years. A portion of the borrower's extra cash flow, along with part of the spread between the loan's interest rate and the asset-backed securities interest rate, can be set aside as reserves to cover potential defaults.

The credit rating companies will consider the borrower's extra cash flow, and the setting aside of cash reserves, as forms of credit enhancement. The Real Mortgage Corporation (or RMC) has already received a Preliminary Credit Rating Letter from the Duff & Phelps Credit Rating Company for its initial Real Mortgage-Backed Securitization™ Program. This Letter indicates that RMC should be able to obtain institutional-quality credit ratings (“BBB” or higher) on at least 95% of the Real Mortgage-Backed Securities it proposed to issue without any form of external credit enhancement.

Inasmuch as the Second Generation of Real Financial Instruments is new to the marketplace, competition has yet to narrow the effective spreads. This will allow the issuer to set-aside part of the afore-mentioned interest rate spread as a securities reserve to meet the credit enhancement demands of the credit rating companies in the early years. As the spreads narrow through competition, the issuer will have to secure another means of credit enhancement. Nonetheless, the success of the early securitization programs should open up credit enhancement opportunities.

F. Pricing Problem
Problem: The First Generation of Real Financial Instruments creates a Pricing Problem: Investors object to the use of the inflationary index to price real financial instruments, since:
   (1) there is no well-developed marketplace based upon the pricing of financial instruments off an inflationary index;
   (2) the inflationary index is a government-generated index that is not determined by the interaction of supply and demand like a normal market index, which means that the government could one day decrease its borrowing costs by redefining the inflation index; and
   (3) the inflation index measures the past while the traditional market indexes represents the marketplace's expectation of the future, which means the indexes can move in opposite directions in the same time period thereby causing confusion.
Solution: Real financial instruments are “real” because they track the financial obligation in real terms, including a real currency and a Real Interest Rate. As such, the pricing index that is used is not relevant. Therefore, the real financial instruments can be marketed at a margin over a traditional market index to determine the Effective Nominal Interest Rate. Then, the prevailing rate of inflation as measured by an agreed upon inflation index, can be subtracted from the Effective Nominal Interest Rate to determine the Real Interest Rate used to amortize the loan payments. Conversely, when the marketplace is ready to accept the pricing of Real Financial Instruments off the inflation index, then the Real Monetary Software™ can also deal with this situation since the pricing index is not relevant. All that is relevant is denominating the instrument in a real currency and then amortizing the payments with a Real Interest Rate.

This solution to the Pricing Problem creates a Second Generation of Real Financial Instruments that are different than any other in the marketplace today. While the First Generation of Real Financial Instruments were marketed at a margin over the inflation rate, thereby creating a fixed real rate of interest; the Second Generation of Real Financial Instruments depend upon the interaction of both the market index and the inflation index, thereby creating an instrument with a variable real rate of interest.

Nonetheless, this solution solves all of the problems generated by pricing real financial instruments off a non-market index, such as the inflation index:

First, the Real financial Instrument will be priced off an existing nominal market index, so investors can “price” the real financial instruments of the traditional market indexes as they are accustomed to doing.

Second, the investor will not be concerned about the government redefining the inflation index, since the Effective Nominal Interest Rate will be determined by the market index and not the inflation index. And, to the extent that the marketplace believes that the inflation index is distorted, it can compensate accordingly by altering the market index with a shift in the supply and demand curve reflecting the perceived bias.

Finally, the Effective Nominal Rate of Interest will move in unison with the nominal market index, since it priced off the same index. The contradictory movements of the market and inflation indexes will not be of great concern.

Once again, the Real Monetization™ process creates a direct bridge to traditional nominal monetary terms, since the Second Generation Real Financial Instrument is priced in nominal terms off the market index.

G. Marketing Problem
The Problem: The First Generation of Real Financial Instruments creates a Marketing Problem, since they will usually have a negative interest-rate-anomaly relative to Nominal Fixed Rate Instruments. This negative interest-rate-anomaly results from the removal of the inflationary premium from the Real Financial Instrument's Effective Nominal Rate of Interest. Typically, the longer the loan term the greater the inflationary premium and the greater the negative interest-rate-anomaly. This is one of the major reasons for the meager use of the First Generation of Real Financial Instruments in the private sector for long term financial instruments such as mortgages.
Solution: The removal of the inflationary premium means that the yield curve for real financial instruments collapses.

This occurs because the primary difference between the current 30-day and 30-year fixed-rate Nominal Financial Instruments is the inflationary premium. Remove the inflationary premium, as Real Financial Instruments do, and you will have a relatively flat yield curve. This means that there is no real difference between short-term and long-term Real Financial Instruments. (This assumes that there is a liquid market for the resale of the longer-term instruments, which we will address in Paragraph “H” below.) As such, real financial instruments should be priced off the short-term end of the yield curve, which will create a positive interest-rate-anomaly in favor of the Second Generation Real Financial Instrument.

The solution to the Marketing Problem dovetails nicely with the solution to the Pricing Problem. In essence, we should create a Second Generation of Real Financial Instruments that are priced off the short-term end of the traditional market index, such as the Treasury Index or the London InterBank Offer Rate (LIBOR).

We can demonstrate the advantages of the Second Generation by comparing Treasury Inflation Protection Securities (TIPS) with (a) the traditional nominal 90-Day Treasury and (b) the 10-Year Treasury Note of approximately the same term:

Comparative Treasury Rates in August, 1997

| | 90-Day | TIPS* | T. Note |
|---|---|---|---|
| | T. Bill: | Due January 2007: | Due February 2007: |
| Fixed Real Rate: | N/A | 3.55% | N/A |
| Inflation to July | N/A | 2.23% | N/A |
| 1997: | | | |
| Effective Nominal | N/A | 5.78% | N/A |
| Rate: | | | |
| Nominal Rate - | 5.27% | N/A | 6.42% |
| Aug. 25, 1997: | | | |
| Inflation Rate: | 2.23% | N/A | 2.23% |
| Variable Real Rate: | 3.04% | N/A | 4.19% |

*The (First Generation) Treasury Inflation Protection Securities already being issued by the U.S. Treasury

At this time, the (First Generation) Treasury Inflation Protection Securities (TIPS) are being compared to the traditional nominal fixed-rate Treasury Note of equal duration. This causes a marketing problem a negative interest-rate-anomaly as shown below:

(First Generation) TIPS Negative Interest-Rate-Anomaly

| | |
|---|---|
| 10-Year Treasury Note Due February 2007: | 6.42% |
| 10-Year Treasury Inflation Protection | 5.78% |
| Securities Due January 2007: | |
| Negative Interest-Rate-Anomaly: | .63% |

When the market shifts from the nominal monetary paradigm to the Real Monetary paradigm, the (First Generation) TIPS would very attractive offering a fixed real rate of return of 3.55% in August, 1997, while the 10-Year Treasury Note offered a variable real rate of 4.19%. Why? Because the historical average real rate of return on intermediate term U.S. Treasuries is only 2.10%, which makes the fixed real rate of return of 3.55% look very good. However, the market still “thinks” in nominal terms, not in real terms. As such, the (First Generation) TIPS with a current nominal yield of 5.78% are forced to compete against the nominal return of the 10-Year Treasury Note at 6.42%, which creates a negative interest-rate-anomaly of 0.63%. Fixed-income investors look for positive interest-rate-anomalies, assuming the credit risk of the competitive instruments is essentially the same. They will generally shun negative interest-rate-anomalies. As such, the Marketing Problem of the negative interest-rate-anomaly must be considered a major factor in the slow development of the market for First Generation Real Financial instruments, such as the TIPS and the real bonds of other countries. Fortunately, the Second Generation of Real Financial Instruments provides a solution for this problem.

Creating a Positive Interest-Rate-Anomaly by Pricing the
Second Generation TIPS Over a Short-Term Market Index:

| | Second |
|---|---|
| | Generation |
| Pricing: | TIPS: |
| Market Index - 90 Day T. Bill: | 5.27% |
| *Proposed Margin: | .25% |
| Effective Nominal Rate: | 5.52% |
| Less Inflation Rate: | 2.23% |
| Variable Real Rate: | 3.29% |
| Positive Interest-Rate-Anomaly: | |
| Second Generation TIPS: | 5.52% |
| 90-Day Treasury Bill: | 5.27% |
| Positive Interest-Rate-Anomaly: | .25% |
| Immediate Savings: | |
| First Generation TIPS: | 5.78% |
| Second Generation TIPS: | 5.52% |
| Current Savings: | .26% |
| Possible Savings: | |
| First Generation TIPS: | 5.78% |
| Prevailing Inflation Rate: | 2.23% |
| Fixed Real Rate: | 3.55% |
| Second Generation TIPS: | |
| 90-Day T. Bill Average Historical | |
| Real Rate for 1926-1996: | .60% |
| Assumed Margin: | .25% |
| Variable Real Rate: | .85% |
| Possible Savings: | 2.70% |

*Determined at Auction

As demonstrated above, the Second Generation of Real Financial Instruments (even the TIPS) should be priced off a short-term Market Index, such as the 90-Day Treasury Bill to determine the effective nominal rate of return on the instrument. This immediately resolves all questions about the Pricing Index, since the marketplace is already using such nominal market indexes to price financial instruments. Then we simply subtract the prevailing rate of inflation from the effective nominal rate to determine the real rate of interest.

This pricing mechanism creates a Second Generation of Real financial Instruments with a variable real rate of interest, compared with the First Generation which has a fixed real rate of interest. This means that the current savings to the U.S. Treasury in pricing the TIPS over the 90-Day Treasury Bill would be about 0.26%. However, the historical real rate of return from 1926 to 1996 for the 90-Day Treasury Bill is 0.60%, while the current real rate of return for the 90-Day Treasury Bill is 3.04%. Regression-to-the-means suggests that the current high real rate of interest on the 90-Day Treasury Bill will tend to ratchet down towards the historical average over time. This means that the Second Generation Real Financial Instrument can ratchet down with the prevailing real rate of interest on the 90-Day Treasury Bill over time. However, the (First Generation) TIPS are set at a fixed real rate of interest, which will not ratchet down later. As such, the potential savings for the U.S. Treasury in switching from the (First Generation) TIPS to the Second Generation TIPS should be in the range of 0.26% to 2.70%. Considering the current outstanding debt of the federal government, this could amount to an enormous savings over the next 50 years required to pay off the debt.
Table 29: Pricing Real Financial Instruments

Resolving the Pricing and Marketing Problems should also begin to open the door for the use of real financial instruments in the private sector as well. Table 29 uses historical data to show how the Real Mortgage-Backed Securities (RMBS) can also be priced to create a positive interest-rate-anomaly instead of a negative interest-rate-anomaly. (Actually, the underlying Real Mortgages™ would be priced accordingly, and the results would flow through the securitization conduit to the RMBS). The First Generation RMBS are plotted at a margin over the inflation index to demonstrate both anomalies. However, the point being made is that real financial instruments should be priced off of short-term market indexes, until such time as the marketplace has shifted from the nominal monetary paradigm to the real monetary paradigm, in order to resolve the problems that are inherent in the First Generation Real Financial Instruments in a nominal marketplace. (Please note: the rates included in this section come variously from USA Today, Barron's and Ibbotson's.)

H. The Liquidity Problem
The Problem: The resolution of the Pricing Problem and the Marketing Problem, as described in sections “F” and “G” above, only serves to exacerbate the Liquidity Problem. Simply stated: All real financial instruments are negatively amortizing (for at least part, if not all of their terms) in nominal terms during inflationary time periods. This means that investors purchasing Real Financial Instruments will have to wait years or even the full term of the Real Financial Instrument before receiving all of the interest that is due and owing to them in nominal terms on a cash basis. This can create tax and/or cash flow problems for most potential investors. Shifting the pricing of Real Financial Instruments from the inflation index to a short-term market index, means that it is all the more crucial that liquidity be supplied for the accrued interest; since the initial investors are likely to be short-term investors dependent upon the issuer and the participating broker-dealers to make a cash market for their investment.
Solution: Strip off the accrued interest in the form of Accrual Rights, which are attached to each certificate issued for each payment period. Give the Accrual Rights a priority-of-payment over the certificate class from which they were stripped. Then create a wholesale after-market for the Accrual Rights, so the original investors can receive full liquidity. (This creates additional problems, that are explained and resolved below).

There are two immediate problems associated with providing liquidity for all real financial instruments and an additional third problem directly associated with the Second Generation of Real Financial Instruments.

First, there is a tax problem in many countries, such as the United States, that has elected to tax the accrued interest if the owner is a taxpaying entity. Inasmuch, as the actual cash payments in the early years are reduced by the amount of the accrued interest, the subsequent taxing of both the cash and the accrual interest payments means that the cash payment itself is substantially depleted. This effectively eliminates taxpaying entities as prospective investors for real financial instruments, unless full liquidity is supplied to the accrued interest.

Second, even tax exempt entities, such as pension funds, still have financial obligations to meet each month. These entities depend upon their fixed-income investments to provide sufficient cash flow to meet these needs. As such, even most tax exempt entities would shy away from making major investments in the real financial instruments, so long as the accrued interest is not liquid.

Third, by shifting the pricing of the Second Generation of Real Financial Instruments from the inflation index to a short-term market index, we are also shifting from intermediate-to-long-term investors to short-term investors, such as money market accounts and demand deposits at financial institutions. This creates an additional need for creating full liquidity for the accrued interest. (Eventually, intermediate-to-long-term investors should be purchasing real financial instruments, but they will not until they have made the paradigm shift.)

Obstacles to Implementing the Solution:

Unfortunately, there are major obstacles to implementing the solution to the Liquidity Problem. These obstacles include:

First, the conduits used to create asset-backed securities typically have to issue all of the securities on the Start-Up Day of the conduit. How does one sell the accrued interest on the Start-Up Day, when the value of the accrued interest has yet to be determined? The solution is to attach Accrual Rights, like bond coupons, to the certificates issued by the conduit. Each successive Accrual Right would represent the accrued interest earned in each successive time period. For a Class “A” Certificate, they could be labeled “A+1”, A+2”, “A+3” and so on.

Second, any substantially discounted sale of the Accrual Rights will inflate the overall interest rate on the real financial instruments, thereby diminishing the attractiveness of the instruments for borrowers. Creating a liquid market for the Accrual Rights will substantially diminish any possible discount. However, each Accrual Right should also be given a priority-of-payment over the certificate class from which it is stripped. In other words, Accrual right “A+1” would have a priority of payment over the Class “A” Certificates. By granting such a priority, the issuer should be able to receive a higher credit rating on the Accrual Rights, thereby increasing their value and covering the expenses of making the market for such Accrual Rights. Why would the holders of the Class “A” Certificates allow this preferential treatment? Simply stated, because they have nothing to lose and everything to gain. Any investor allowing the sale of the Accrual Rights will have already redeemed their value, so giving the buyers of the Accrual Rights a priority-of-payment does not diminish the investor's position. In fact, the investor that elected to retain the Accrual Rights would have more to lose, since he has yet to redeem their value. Finally, by offering a priority of payment, the investor has not increased his risk, but has avoided a possible discount on the sale of the Accrual Rights.

FIGS. 1, 2 & 3: Double Stripping Real Financial Instruments to Provide Liquidity for the Accrued Interest

FIG. 4: Stripping the Accrual Rights (or Accrued Interest) on a Retail Basis

FIG. 5: Wholesale Stripping of Accrual Rights with Real Monetary Software™

FIG. 6: Creating the Accrual Rights for the Wholesale Market

FIG. 7: Creating a Wholesale Market for the Accrual rights (or Accrued Interest)

Finally, there is also the problem of the Accrual Rights themselves beginning to earn accrued interest in future payment periods. Won't the buyers of the Accrual Rights also expect to have full liquidity? An in-depth explanation of resolving this problem is shown on FIGS. 1 through 7. A brief explanation is explained as follows:

Stripping Twice:

The real financial instruments must be stripped twice. First, the real-interest-only (RIO) payment must be stripped from the real-principal-only (RPO) payment. The RPO must then be stripped into both the nominal-principal-only (NPO) strip and the accrued-interest-only (AIO) strip. The Accrual Rights represent the ownership of the AIO strips for their respective payment periods. (See FIGS. 1, 2 & 3). Currently, the U.S. Treasury is only offering to strip the RIO from the RPO. Nor have we found any evidence that any other issuer of real financial instruments is offering to strip twice.

Stripping Nightmare:

However, in subsequent time periods the Accrual Rights (AIO strips) also begin to earn accrued interest. (They also earn cash payments, which are simply distributed.) As FIG. 4 indicates, this begins to create a stripping nightmare. If we allow new Accrual Rights to be stripped off of the earlier Accrual Rights, then the potential number of Accrual Rights that would be issued from just one original certificate for a 30-year instrument with monthly payment periods is 5.87×10¹⁰⁷. Clearly, this creates a managerial nightmare and is simply not possible to properly track over time. Imagine issuing that many statements to investors. So, we must limit the number of Accrual Rights for each certificate to one less than the number of payment periods, which would be 359 (or 360−1) for Real Mortgage-Backed Securities with 30-year terms; as shown in FIG. 5. But, what happens to the future accrued interest on the Accrual Rights?

Developing a Wholesale Market:

Typically, conduits are allowed to invest in both the primary assets, such as mortgages, and in secondary assets, such as the mortgage-backed securities (defined as the “regular interests”) issued by prior conduits. Therefore, we can resolve the problem of the accrued interest earned by the Accrual Rights by creating a wholesale market, whereby the Accrual Rights are purchased by future conduits. Then, the accrued interest on the Accrual Rights will flow through the new conduit to its investors in the same way that the accrued interest on the Real Mortgage™ pool does. This is legally acceptable, since the Accrual Rights are “regular interests” (as defined in the United States by the law governing Real Estate Mortgage Investment Conduits or REMICs), and are therefore mortgage-backed securities suitable for being purchased by future conduits. (Obviously, a similar structure would have to be created for other types of assets, such as government bonds and consumer loans, etc. Such a structure may now be on the horizon with the Financial Asset Securitization Investment Trust or “FASIT”) This means that the buyers in the wholesale market would probably be limited to new conduits being formed, since investors or investment entities that are not conduits would be stuck with the illiquid accrued interest.

Finally, the nature of this overall solution suggests the need to formally organize a wholesale marketplace to provide for the liquidity of the accrued interest for each given class of assets, such as mortgages, government bonds, consumer loans and so on. This creates the need for the Multi-Phase Monetary System, which will allow for the transfer of the wealth represented by the Accrual Rights by and between the conduits in a Master Real Currency with a constant level of purchasing power for all concerned. An example of how this wholesale marketplace would work is set forth in FIGS. 6 & 7. While the creation of the conceptual bridge, as described herein, is necessary in order to allow participants to appreciate the use of real financial instruments in nominal terms, until their paradigm shifts to real monetary terms; nonetheless, the overall complexity suggests that everyone will ultimately want to shift to the direct use of the master real currency and completely dispense with the nominal currency. This creates a need for an asset-backed real money supply.

I. Creating an Asset-Backed Real Money Supply
Problem: How do we create an asset-backed real money supply?
Solution: We strip Real Mortgage-Backed Securities into RIO and RPO strips. We then place the RPO strip in an open-ended entity that issues the Master Real Currency, which we shall refer to as the Millennium Dollar™ hereafter. The Millennium Dollar™ is backed by the RPO representing both the original nominal principal plus the inflationary adjustment (AIO) required to maintain the purchasing power of the original nominal principal. In essence, the RPO is the perfect asset to back the real money supply. This is especially true, since there is an abundance of improved real estate with which to create Real Mortgages™, Real Mortgage-Backed Securities™ and ultimately Millennium Dollars™. In addition, the volume of improved real estate will tend to increase in proportion to the increasing population over time, which should resolve the former problem of using gold to back the real money supply.

Phase I: The Conceptual Bridge

FIG. 8: Real Mortgage Corporation Announces the Millennium Dollar™

The creation of the asset-backed real money supply in a nominal monetary marketplace will require two distinct phases, as shown in FIG. 8. The first phase basically involves the creation of the conceptual bridge, which we have called Real Monetization™; which is in turn carried out by the Real Monetary Software™. This phase is necessary for all of the problems covered so far in this document, but could be summarized as overcoming the paradigm effect. Participants in the marketplace will not be willing to shift from the nominal currency to the Master Real Currency over night. As such, the open-ended entity issuing the Millennium Dollars™ will have to continuously convert the nominal monetary payments received from the ownership of the RPO strip to either (1) the purchase of additional RPO strips or (2) the repurchase of Millennium Dollars™ from the marketplace. This will be necessary in order to maintain a one-to-one ratio between the real value of the RPO strip and the Millennium Dollars™. It will also be necessary to establish a market-making system, whereby those who do not understand the use of the Millennium Dollars™ can convert them back into the traditional nominal currency. Once again, this will require full liquidity for the accrued interest.

Phase II: Issuing the Asset-Backed Real Money Supply

The second phase shown in FIG. 8 suggests how the asset-backed real money supply could be launched. In essence, the RIO strip could be packaged with the Million Dollar™ (or MR$) for sale as a unit to major institutional investors. Such investors could then use the Millennium Dollars™ for monetary transfers in the marketplace, while retaining the RIO strip as an investment. Assuming the RIO strip represented 200 basis points on the value of the Millennium Dollars™ issued, and assuming a capitalization rate of 8% and an average life of ten years; then the RIO strip would be worth about seventeen cents ($0.17) for each Millennium Dollars issued. Inasmuch as the investor could spend the Millennium Dollars™ the next day, they would be buying eighty-three cent dollars ($1.00−$0.17). The balance of the RIO cash flow would be used to establish a second conduit, and/or beef up the original conduit, such that additional reserves are set-aside to achieve a “AAA” rating on all the remaining RIO strip and the Millennium Dollars™. This creates a “AAA” rated money supply that is backed by real estate, which is known to be an excellent hedge against inflation.

In addition, there are approximately $4 trillion in mortgages in the United States on improved real estate, capable of generating the cash payments that would be due and owing on the Real Mortgages™. Historically, governments have been constrained in the issuance of its currency, since the currency was fiat money that was inflatable. There should be no such problem with the issuance of an asset-backed real money supply. This means that we can reduce the ratio of the Gross Domestic Product to the issued currency from 59.92 to 1.96 as shown below:

Gross Domestic Product Vs. Currency Ratio

| | Fiat Money: | Real Money: |
|---|---|---|
| Gross Domestic Product: | $7,850,000,000,000 | $7,850,000,000,000 |
| U.S. Paper Currency | $131,000,000,000 | N/A |
| in Circulation inside | | |
| the United States: | | |
| Potential Millennium | | |
| Dollars ™ for | N/A | $4,000,000,000,000 |
| circulation: | | |
| GDP/Currency Ratio: | 77.48 | 1.96 |

On an intuitive basis, the monetization of real estate into an asset-backed real money supply, resulting in the ratcheting down of the enormous GDP/Currency Ratio, should begin to eliminate that economic roller-coaster ride that is promoted by inflation. This volatility in our financial marketplaces is directly tied to the fact that virtually all financial transactions are defined in the nominal currency (or the U.S. Dollar in the United States), which is tied to nothing. Therefore any perceived defects in the nominal currency can ripple through our economy by a multiple of the GDP/Currency Ratio. If we have an asset-backed real money supply, and we reduce the GDP/Currency Ratio substantially, then we should begin to minimize this volatility in our financial marketplaces.

The non-inflationary increase in the money supply should reduce the cost of money over time as the supply/demand curve reaches a new equilibrium. This new equilibrium will bring a new era of prosperity that will reach down to the lowest levels of society. Nonetheless, the transformation of a society from a nominal monetary base to an asset-backed real monetary base will require a shift from the current nominal monetary paradigm to the coming real monetary paradigm. The purpose of the invention, Real Monetary Software™, is to facilitate the Real Monetization™ process, which will create a conceptual bridge that will allow participants in the marketplace to understand the benefits of real financial instruments in nominal monetary terms. J. Promoting the Real Money Supply
Problem: How do we promote the acceptance of the asset-backed real money supply?
Solution: Gresham's Law suggests that acceptance of the real asset-backed money supply in the marketplace may not be a problem. Nonetheless, countries have historically retained the sovereign right to issue money. However, the very nature of the asset-backed real money supply is beyond the power of the government to directly maintain, since the government does not control the assets (real estate) in the marketplace used to back the issuance of the asset-backed real money supply. However, this is a right that appears to be slipping away in this modern age of technology, where the difference between money and other financial instruments is becoming minimal. Still, a joint venture between the government and the issuer of the asset-backed real money supply would be beneficial to all concerned.

Gresham's Law:

Gresham's Law states that:
“Bad money will chase good money out of the marketplace.”

What does this mean? Gresham was a financier and merchant who lived in Great Britain in the 16th century. Gresham's Law was his response to the queen on the advisability of issuing a dual currency. As a merchant, Gresham observed that if both a paper (fiat) currency was available, along with gold coins, then everyone would hoard the gold coins and spend the paper currency. This makes perfect sense, since the gold held its value against inflation while the paper currency did not. The issuance of an asset-backed real money supply represents the “good” currency, when comparted to the fiat paper currency already in circulation. This suggests that in the early stages of the distribution the participants in the marketplace will not only accept the real money supply, but will actually hoard it like gold.

The critical difference with the issuance of the Millennium Dollar™ however, is that there will be no limitation on its issuance due to the limitation of gold. Currently, the world's total governmental gold reserves are $345.2 billion, while the total amount of Millennium Dollars™ that could be issued in the United States alone is about $4 trillion. While the initial stage may be the hoarding of the asset-backed real money supply, the final stage will be the outright rejection of the nominal currency as everyone begins to demand payment in Millennium Dollars™.

The Sovereign's Right:

Historically, governments have retained the right to issue the currency that circulates in the local economy. Nonetheless, with the proliferation of credit cards, debit cards, checks, bank cheques and other forms of monetary equivalents, the control over the money supply has been gradually shifting away from the government. On Sep. 8, 1997, Forbes published a sidebar article entitled “The Siege on the Greenback,” which stated:
“For most of recorded history monarchs and central banks have considered it their divine right to control the money supply. When they succeed in doing so, they can finance their operations in part by skimming some of the money. “Seigniorage” is what the economists call the process. In the old days seigniorage took the form of coin clipping—the royal mint would issue a sovereign with less than a sovereign's worth of gold in it. Nowadays seigniorage takes place when the government issues bills that erode with inflation . . . .
Next in the evolution of the dollar competitors: digital cash, exchanged over the Internet and stored on disk drives or micro-chip enhanced smart cards. In principle the technology gives anyone with a server, a network connection and a command of cryptographic protocols the ability to mint money. Your unit of account doesn't have to be non-interest-bearing dollars; it could be a claim on a pile of interest-bearing Treasury bills or shares in the Magellan Fund . . . .
Among the companies working on digital cash systems: Citicorp, Microsoft, Digital Equipment Corp. and Nomura. The systems all have one thing in common: The U.S. Treasury gets cut out of the float.
Could the federal government attempt to regulate or tax competing money systems anyway? The issuers could simply relocate to Zurich or Singapore.”

While governments have enjoyed “seigniorage” for centuries, it is inherently dishonest; but then who is going to throw the government into jail? On the other hand, even international corporations are subject to the law. So it is difficult to imagine why the governments of the world would allow corporations to engage in the practice of seigniorage. In fact, the primary motivation of governments to stop this practice is that it would be inherently inflationary. Just imagine every major international corporation offering its own money supply. The GDP/Currency Ratio of each country would double or triple form its current position within a few years. there would also be a frenzy for people to divest themselves of such currencies and move into safer forms of monetary equivalents. Therefore, assuming that the government will not allow such corporations to engage in seigniorage, but cannot stop them from issuing the monetary equivalents otherwise; then where is the profit motivation to offer currencies such as “digital cash?”

Certainly, the issuance of the Millennium Dollar™, backed by the real-principal-only (RPO) strip of the Real Mortgage-Backed Securities, is already legal since it would be a registered security. In effect, it is simply an asset-backed fixed-income instrument that pays a rate of interest equal to the inflation rate. A mutual fund, or other legal entity, could be created to hold the RPO strips and then to issue the Millennium Dollars™ as credits to the holders account. The holder of the account could then use a checkbook that draws directly upon the account to transfer the Millennium Dollars™ to another individual or entity. In effect, we will be transferring securities representing a certain monetary value. In the case of the Millennium Dollar™, the value will be established as the purchasing power of the United States nominal dollar on Jan. 1, 2000. So the mechanical process of delivering the Millennium Dollars™ to the marketplace can easily be created. But what is the profit motivation of the issuer?

The potential profits for the issuance of the Millennium Dollars™ appear to be huge. In FIG. 8, we assumed that a “AAA” rated real-interest-only strip would pay about 200 basis points (or 2.00%). This is how we arrived at that number:

The Real Seigniorage

| Pricing the Real Mortgage ™ Pool: | |
|---|---|
| Pricing Index (90-Day T. Bill): | 5.270% Aug. 25, 1997 |
| Proposed Margin: | 2.750% |
| Effective Nominal Rate: | 8.020% |
| Less Inflation Rate: | 2.230% thru July, 1997 |
| Real Rate: | 5.790% |
| Pricing the RMBS Collectively: | |
| Effective Nominal Rate of Mortgage Pool: | 8.020% |
| Less: | |
| Securities Reserve: | 1.000% |
| Servicing Fee: | .125% |
| Trust & Auditor: | .125% |
| Administrative Fee: | .125% |
| Subtotal: | 1.375% |
| RMBS Collective Nominal rate: | 6.650% |
| Less Prevailing Inflation Rate: | 2.230% = AIO Strip |
| Real-Interest-Only (RIO) Strip: | 4.420% = RIO Strip |
| Upgrading the RMBS to “AAA” Rating: | |
| RMBS Collective RIO Strip: | 4.420% |
| Less: | |
| Additional Securities Reserve: | 1.000% (to upgrade credit rating) |
| Estimated Expenses and to | 1.420% |
| Cover Variable Rate over time: | |
| | 2.420% |
| Net RIO Strip to Combine | 2.000% |
| with the Millennium Dollar ™ Units: | |
| Assuming U.S. Government Participates in the Issuance | |
| of an the Millennium Dollar ™ as an Asset-Backed Real Money Supply: | |
| Net RIO Strip to Combine | 2.000% |
| with the Millennium Dollar ™ Units: | |
| Unnecessary Securities Reserve Add-Back | 1.000% |
| Assuming Millennium Dollars ™ Issued | |
| as Agency Paper: | |
| The Real Seigniorage: | 3.000% |

Nonetheless, if the offering of the Millennium Dollars™ was done in conjunction with the government, then the additional securities reserve of one percent would not be necessary, since the securities would assume to have a rating equivalent to the government or “AAA”. This could be achieved by the government establishing the Real Mortgage Corporation (or a separate legal entity with a license to use the Real Monetary Software™) as an agency of the government to issue the asset-backed real money supply. This means that the government could earn a Real Seigniorage of approximately 300 basis points or 3.0% on the principal value of the Millennium Dollars™ issued over time.

It should be noted that the historical real rate of return on long-term U.S. Treasuries from 1926 to 1996 is about 2.00%, according to Ibbotson's. Nonetheless, the Millennium Dollar™ is based upon the securitization of Real Mortgages™, and such mortgages are typically priced at a margin over the Treasury Index. This means that the estimated Real Seigniorage of three percent (3.00%) should be achievable. It is also expected that the 1.42% to cover the expenses of offering the Millennium Dollars™ should be subject to substantial savings over time, especially if the Federal Reserve worked to minimize the volatility of the real rate of return.

In addition, this Real Seigniorage should not be inflationary to the supply of Millennium Dollars™, since it is already reflected in our current interest rates. Nonetheless, the issuance of the Millennium Dollars, as an asset-backed real money supply, may be inflationary to the existing nominal currency in circulation. As such, some of the profits from the overall use of real financial instruments should be directed to the gradual withdrawal of the nominal currency from circulation. Given (1) the size of the Real Seigniorage, (2) the interest saved on the outstanding government debt by issuing Second Generation TIPS and (3) the increased tax revenues inherent in an economy using real financial instruments; this should be achievable. While the prospect of the issuance of an asset-backed real money supply will give pause to the government's economic and financial planners, it does represent progress and progress is seldom slowed by people's “concerns.” As the Forbes article suggests, we can expect to see major changes in the future with respect to the issuance of our money supply, and with the advent of the Internet and the opening of the international marketplaces; it is unlikely that any government will be able to forestall these changes for long. However, the arrival of a patent on the Real Monetary Software™ will provide a means by which governments can participate, profit and even control, to some extent, the issuance of the asset-backed real money supply. But this advantage will be lost if government does not move swiftly to secure its position, which it will be able to do with an exclusive license to use the Real Monetary Software™ for the purpose of issuing the asset-backed real money supply. Inasmuch as the officers of the Real Mortgage Corporation have a legal responsibility to earn a profit for their shareholders, the Company will have no choice but to begin licensing others if the government shows no immediate interest in the invention.
Table 30: Federal Debt Reduction with Real Money Supply

What is to be gained from such an alliance? Assuming the Federal Reserve acting on behalf of the government could maintain the Real Seigniorage at the projected level of three percent (3.0%), and that it was applied to the outstanding principal on the federal debt of $6 trillion; then we could pay off the federal debt in about 50 years. The taxpayers would still have to pay the ongoing interest on the federal debt, but then they are already carrying this expense. This is explained in more depth in Table 30. In conclusion, the proposed patent, if obtained on the Real Monetary Software™, could be used to secure the right to issue the asset-backed real money supply in the marketplace; so the U.S. Treasury would not be cut out of the seigniorage, as the Forbes article suggests. Inasmuch as the patent would be good for 20 years, this is the window during which the United States government would have to complete the issuance of the asset-backed real money supply. And, as Gresham's Law suggests, it is not likely that any fiat money supply could compete with as asset-backed real money supply, no matter who issues it.

K. Definitions for the Invention

This document relies upon the following definitions:
$: (1) The symbol for the United States paper dollar, which is used herein as an example to represent the currency phase of the multi-phase monetary system. (2) Any fiat currency, typically issued by the government, which is selected by a given multi-phase monetary system. (3) The monetary phase which represents how real financial instruments will benefit participants in traditional nominal monetary terms. (4) The $ (currency) phase is calculated by recasting the excess N$ in the “principal paid” column in the N$ conversion table to the “interest paid” column in the $ recasting table. This in turn means that the “beginning balance” column and the “ending balance” column in the recasting table will also be changed to reflect the lower rate of principal repayment. (5) The purpose of this recasting to the $ phase is to allow the participants to properly balance their books in the fiat currency they are accustomed to using. In essence, their books will show a total of $100 of principal repaid on an original loan balance of $100 as reported on the recasting table, whereas the N$ conversion table might show 150 N$ repaid for an original loan of 100 N$. The excess amount in the “principal paid” column occurs when the real currency phase is converted by the inflationary adjustment factor to N$ with less purchasing power. It simply takes more N$ to equal the same purchasing power as a set amount of R$, during inflationary time periods. During deflationary time periods, the opposite occurs, and $ must be shifted from the “interest paid” column and so on. See “currency”.
$ recasting table: See “recasting table.”
accrual right: (1) Each “regular interest” issued by a conduit on the start-up date (or by a Financial Asset Securitization Investment Trust (FASIT) on the date of issuance) will have one accrual right attached to it for each payment period except for the final payment period. (2) Each accrual right represents the ownership of the nominal interest accrued on the regular interest to which it was originally attached for its specified payment period. (For instance, the accrual right labeled “A+1” may be said to represent the ownership of the interest accrued on the class “A” certificate (or regular interest) to which it was originally attached for the first payment period.) (3) The accrual rights may be detached and sold separately from the original regular interest in the same way that a bound coupon can be detached from the bond. (4) In subsequent payment periods, an accrual right representing accrued interest may actually accrue interest itself. However, the accrued interest earned on the accrual right is not stripped, but is retained by the respective accrual right until properly paid or otherwise defaulted upon. (5) In essence, the accrual rights are similar to bond coupons. However, it is important that the conduit's documentation properly define the accrual rights as being regular interests of the conduit. Inasmuch as they are regular interests, they may be purchased by other REMICs (and FASITs) as secondary assets. This will allow the accrued interest in future payment periods on the stripped accrual rights to flow through the conduit that has purchased them in the same manner as the accrued interest on the primary assets (mortgages, auto loans, government bonds, etc.) of that conduit. (6) In this manner, a market may be developed for the accrual rights as they are stripped each payment period, whereby the market is composed of future conduits. (7) In essence, this represents the development of a wholesale market functioning beside the traditional retail market, whereby the wholesale participants are conduits and the retail participants are traditional fixed income investors. This essentially duplicates the dual market structure of the major stock exchanges and the over-the-counter stock markets, whereby a the “bid” and the “asked”, representing the wholesale and the retail markets, function side by side to create a liquid market for the given securities. However, in this case a dual market is created for the accrual rights, representing the ownership of the accrued interest earned on the originally issued regular interests.
accrued-interest-only (AIO): (1) The accrued-interest-only (AIO) is the stream of payments on a real financial instrument representing the eventual payment of the accrued interest. (2) When the accrual rights are stripped off the originally issued regular interests, they represent the ownership of the accrued-interest-only (AIO) that has accrued for the given payment period. (3) The accrual rights, whether stripped or not, may continue to earn accrued interest in their own right.
adjustment period: (1) The adjustment period simply refers to how frequently the interest rates are readjusted based upon the relative change in the pricing index and/or the inflation index. (2) The adjustment period can be any mutually agreed upon time period, provided only that the relative change in the index(es) is available from some authoritative source; and may be the same as the payment period. (3) The adjustment period for the securities issued by the conduit is typically the same as the adjustment period for the underlying assets to avoid a mismatch in cash flows, but need not always be so since the residual interests could absorb the difference.
AIO: See “accrued-interest-only”.
AIO strip: The derivative security, or strip, representing the payment of the accrued-interest-only, which is stripped, or derived, from the payment stream of the underlying asset(s). See “accrued-interest-only.”
amortization schedule: (1) Inasmuch as the system deals with four different monetary phases it is important for participants to understand that the actual amortization of any given real financial instrument occurs only in the real currency phase. (2) The real currency (R$) is in turn converted to the nominal currency (N$) or to master real currency (MR$), and the nominal currency is then recast to the currency ($). (3) To highlight this fact, we will refer to the real currency amortization schedule, the nominal currency conversion table, the master real currency conversion table or the dollar recasting table.
asset-backed securities: (1) Fixed income, or debt, securities collateralized by the cash flow from a pool of auto loans, credit card receivables, vehicle and equipment leases, consumer loans, mortgages, government bonds and other obligations. (2) The asset-backed securities give the holder an undivided interest in the securitized assets, and are funded by the cash flows received by the issuer from regular payments of principal and interest from the borrowers.
asset class: (1) The asset class refers to the assets that are used to secure the asset-backed securities issued by the conduits. (2) Asset classes are usually fixed-income obligations, but could be anything that can be pledged and that generate a stream of income for distribution to the conduit's investors. (3) Asset classes may include mortgages, auto loans, credit card receivables, consumer loans, bank loans, corporate and government bonds and so on. (4) However, any given REMIC conduit or defined marketplace typically deals in one asset class only and/or asset-backed securities already backed by that same asset class; however, FASITs can legally work with more than one asset class.
asset-backed real monetary equivalent: (1) A monetary equivalent that is backed by an asset that is designed to maintain a constant or real level of purchasing power over time. (2) The monetary unit used in a fully developed real monetary system. (3) A monetary unit that is either composed of a precious metal, or is backed by the real-principal-only (RPO) strip from a Real Mortgage-Backed Security™ (RMBS). (4) A monetary unit created by the Real Monetization™ process. (5) Historical examples includes the forging of coins from precious or semi-precious metals. (6) The only modern-day example is the Millennium Dollar™, which is created from securitization and Real Monetary Software™ (i.e. the invention.)
base-line-date: (1) The base-line-date is the point in time that the master inflationary adjustment factor (MIAF) is based upon for any given system. (2) It can be any date, but once selected it is constant for the calculation of all MIAFs for assets, real financial instruments, issued securities, accrual rights, conduits and defined marketplaces that are participating within a given system. (3) The adoption of the common base-line-date allows for the creation of the master real currency with a constant purchasing power, thereby allowing for the transfer of wealth by and between a wide range of entities in the master real currency that may each have a separate start-up or initiation date (thereby defining real currency units from one entity to the next that have a substantially different purchasing power from each other).
CIA: See “current inflationary adjustment”.
concept of whole numbers; (1) The concept of whole numbers assumes that the integers 1, 2, 3, etc. represent degrees of multiplicity, meaning that they represent whole units in successively higher amounts. (2) It is this characteristic of being “whole,” that allows us to add, subtract, divide and multiply these integers. (3) Understanding the concept of whole numbers is essential in understanding the nature of inflation. (4) Nominal currencies, that are not adjusted for inflation, retain their whole unit denominations despite the fact that their purchasing power is declining over time due to inflation. (5) These nominal currencies represent “money,” and money in turn is supposed to represent “purchasing power.” When these integers are used to count money, they are supposed to represent whole units of purchasing power, but they do not. (6) Assuming the numerical units of currency remain unchanged, but the actual purchasing power they represent is declining, then the nominal currency is violating the concept of whole numbers. (7) Violating the concept of whole numbers in monetary affairs results in inflation. (8) This cause-and-effect relationship suggests that inflation can be substantially eliminated whenever an economic system switches from a nominal currency to master real currency or real money supply.
conceptual bridge: (1) The purpose of Real Monetary Software™ is to create a conceptual bridge from the current nominal monetary paradigm to the real monetary paradigm. In essence, this conceptual bridge will allow participants in the marketplace to begin to understand the benefits of real financial instruments in traditional nominal monetary terms. (2) This is achieved by creating a multi-phase monetary system, whereby financial instruments are defined in the real currency. (3) However, real currency is currently an abstract concept, which means that the real currency payments must be converted to the nominal currency for actual payment until a real money supply can be issued. (4) Subsequently, the nominal currency “principal paid” column must be recast to currency for tax reporting, since it will be a multiple of the original nominal currency loan amount during inflationary time periods. (5) In addition, the real currency must be converted to master real currency with a constant purchasing power for all entities within the given system, so financial information can be transferred by and between entities that have a different defined value for the real currency. (6) While this last function could be performed by the traditional fiat currency, that would be regressive, promoting the continued use of the fiat currency that is causing inflation and deflation. (7) Perhaps the most important role played by the master real currency is to prepare participants in the marketplace for the issuance of an asset-backed real money supply. (8) The issuance of the real money supply, by the monetary conduits, will complete the journey across the conceptual bridge, since the participants can then begin to discard the complex multi-phase monetary system and simply transact business in the asset-backed real money supply. (9) In other words, the real currency will have moved from an abstract concept to a reality by the issuance of a n asset-backed real monetary equivalent such as the Millennium Dollar™, representing the purchasing power of the master real currency in the given system.
conduit: (1) The legal entity purchasing the qualified assets and issuing the securities. (2) An entity whereby the financial losses and gains are passed through on a proportional basis to the benefit or detriment of the securities holders. (3) The term is derived from the fact that such entities typically apply for treatment as a tax conduit, such as a real estate mortgage investment conduit (REMIC) or a financial asset securitization investment trust (FASIT). (4) Any legal entity that can be used for the securitization of the qualified assets, the subsequent stripping of the respective cash flows and the tax election as a conduit pursuant to (2) and (3) above. (See “real estate mortgage investment conduit” or “financial asset securitization investment trust”).
consumer price index for all urban consumers: (1) An inflation index sometimes referred to as the CPI-U that is tabulated by the U.S. government. (2) The CPI-U is the pricing Index for Treasury Inflation Protection Securities (TIPS) issued by the United States Treasury since January, 1997. (3) The most widely accepted inflationary index in the United States.
consumer price index for all wage earners: (1) An inflation index sometimes referred to as the CPI-W that is tabulated by the United States government, which is another example of an Inflation Index that could be adopted in the United States. (2) Certainly, an inflation index should be selected that is generated in the same country as the choice of the national fiat currency. To have any mismatch between the selection of the fiat currency and the inflation index in the creation of a system would result in the creation of a master currency that would have no relevance.
convention: (1) In addition to the parameters, the system will establish certain conventions, which simply state the preferred method of performing some function. (2) Any defined marketplace, conduit, primary asset, issued security or accrual right may vary from the system's conventions, provided that any such variance is offset in the software such that the change in the given convention does not affect the tabulation of the master real currency for the given entity or instrument. (3) Conventions may include such items as the (a) inflationary lag, the (b) prevailing inflation rate and how the (c) current inflationary adjustment are handled. (4) As a practical matter, it will be simpler for all such entities and instruments to adopt the system's conventions in addition to the system's parameters, which they must adopt if they are to function within the given system. (5) It should be expected that the conventions established by any given system will expanded and/or changed over time, as the Real Monetary Software™ is amended to reflect the increasing complexity within the given system.
conversion table: (1) The table used to convert the real currency to the nominal currency, or to the master real currency; or vice-versa. (2) The use of the term conversion table for the master real currency and the nominal currency (or the recasting table for the currency) is meant to denote that the actual amortization for the real financial instrument occurs only on the real currency amortization schedule. (3) Thereafter the real currency sums are converted to nominal currency using the inflationary adjustment factor (IAF), or to the master real currency using the master inflationary adjustment factor (MIAF); or vice-versa.
CPI-U: See “consumer price index for all urban consumers”.
CPI-W: See “consumer price index for all wage earners”.
current inflationary adjustment: (1) By convention, the inflationary adjustment factor for the first payment period is always 1.00, meaning that the real currency payment in the first period is multiplied times 1.00 to get the nominal currency payment. (2) Subsequently, the inflationary adjustment factor is equal to one plus the percentage change in the inflation index since the start-up date or initiation date. (3) Nonetheless, the payments are made in arrears, which means that the borrower has had the use of the principal paid during the each payment period, but has only paid interest at the designated real rate of interest. (4) As such, the borrower must be charged a current inflationary adjustment (or CIA) on the principal paid in order for the stated real rate of interest to be over and above the inflation rate as represented in the legal documents, and therefore actually be a real rate of interest. (5) Ignoring this point, could place the sponsor and the broker/dealer firm at legal risk, if the securities purchaser discovers that he, she or it is not receiving a real rate of interest as represented in the offering documents. (6) Conversely, any full disclosure or other method of rectifying the situation without employing the CIA could lead to massive confusion. (7) The current inflationary adjustment is simply the principal paid in the nominal currency times the inflation rate for the given payment period to determine the CIA payment that is due and owing. (8) Due to the timing of this calculation, the current inflationary adjustment will have to paid in the the subsequent payment period from which it is actually earned.
currency: (1) Currency ($) is the fourth phase of the multi-phase monetary system representing the fiat, or paper, money issued by the government, which is not backed by any tangible asset. (2) One unit of currency has the same purchasing power of the nominal currency, but the nominal currency conversion table is distorted by inflation or deflation and must be recast to the currency amortization schedule. (3) Both the currency and the nominal currency are “nominal” in the traditional sense. The distinction is made only to clarify the recasting process, which results in the currency recasting table. (4) It is the currency recasting table, which allows participants to see the benefits of using real financial instruments in traditional nominal terms they can understand. (See “$”, the initial definition listed in this section, for an in-depth explanation.)
defined marketplace: (1) The defined marketplace refers to the marketplace that is created for one or more asset classes, when one or more sponsors agree to a given set of parameters for the conduits they will be sponsoring. (2) These parameters include such matters as (a) the selection of a common base-line-date for the calculation of the MIAFs and (b) the common use of an established inflation index. (3) By synchronizing these selections within a defined marketplace, it will then be possible to (a) communicate the transfer of financial assets and/or monetary disbursements in a constant monetary unit, such as the master real currency (MR$), from one conduit to another; and (b) allow for the creation of a wholesale marketplace for accrual units secured by one or more common asset classes.
dollar: See “currency” or “$.”
effective nominal rate of interest: (1) The term “effective” is meant to denote that real financial instruments are actually amortized with real rates of interest. (2) Nonetheless, those functioning in the nominal monetary paradigm will still want to know what the nominal rate of interest is on real financial instruments for comparative purposes. (3) Hence, the term effective nominal rate is used to account for both (1) and (2) above. (4) For instance, the effective nominal rate of interest for a real financial instrument equals the margin plus the pricing index.
effective real rate of interest: (1) The term “effective” is meant to denote that nominal financial instruments are actually amortized with nominal rates of interest. (2) Nonetheless, those functioning in the real monetary paradigm may still want to know what the effective real rate of interest is on nominal financial instruments for comparative purposes. (3) Hence, the term effective real rate is used to account for both (1) and (2) above. The effective real rate of interest for nominal financial instruments equals the margin plus the pricing index less the prevailing inflation rate.
FASIT: See “financial asset securitization investment trust.”
fiat currency: (1) A currency that is issued, typically by the government, without any backing whatsoever. (2) Currency is supposed to represent purchasing power. However, the fiat currency is not designed to maintain its purchasing power during inflationary or deflationary time periods.
financial asset securitization investment trust: (1) The financial asset securitization investment trust (FASIT) refers to a tax election made by a “C-corporation” for the purpose of functioning as a tax conduit for the securitization of one or more approved asset classes. (2) The tax impact of the cash flows pass through the conduit to the holders of the regular interests, accrual rights and ownership interests. (3) This assures all concerned that the conduit will not be considered a normal corporation, or association, which would result in double taxation on the conduit's income. (4) FASITs are considered the new and improved version of the REMIC, since they are generally a more flexible entity. (5) The REMIC was formally recognized in the 1986 Tax Reform Act. (6) On Sep. 1, 1997, a new entity called the Financial Asset Securitization Investment Trust (FASIT) came into being, which will also function as a tax conduit. (6) In addition to REMICs, the Real Monetary Software™ (i.e. the invention) can be used with FASITs, or any other legally recognized tax conduit.
first generation real financial instruments: (1) Financial instruments that are priced at a fixed margin over an agreed upon inflation index, resulting in a fixed real rate of interest. (2) Such instruments include: the price-level-adjusted-mortgages (PLAMs) proposed by the U.S. Department of Housing and Urban Development (HUD), and the treasury inflation protection securities (TIPS) issued by the U.S. Treasury, and similar real bonds issued by other governments around the world.
IAF: See “inflationary adjustment factor.”
inflationary adjustment factor: (1) The inflationary adjustment factor (or IAF) equals one plus the percentage change in the inflation index since the day the real financial instrument was created (or conversely the start-up date of the conduit or the issuance date of the issued securities). (2) Assuming the inflation index is 150.0 on the said day (or date), and the current inflation index is 165.0, then the IAF equals 1.1000 or:
   IAF=165.0/150.0=1.1000%
(3) The IAF can be used to convert the real currency to the nominal currency, or vice-versa. (4) Please note: the MIAF is used to convert the master real currency to the real currency, and vice-versa. (5) The recasting of the nominal currency to the currency requires no inflationary adjustment, since the nominal currency and the currency have the same relative purchasing power.
inflationary premium: (1) The traditional nominal rate of interest can be broken down into three parts, including: (a) the real rate of interest, (b) the prevailing inflation rate and the (c) the inflationary Premium. (2) By subtracting the inflation rate from the nominal interest rate, you get the real rate of interest, except that this is a short-term real rate of interest if the nominal interest rate is fixed. (3) As the inflation rate varies over time, and the nominal interest rate is fixed, then the real rate of interest can vary over time. (4) Historical studies indicate that institutional-quality fixed income instruments will average about 2.1% real rate of interest for intermediate to long-term U.S. government bonds. (5) If one subtracts the historical real rate of interest from the current or short-term real rate of interest, then you will get an estimate of the inflationary premium that has been built-into the nominal rate of interest, assuming history repeats itself (6) Regression to the means suggest that history will repeat itself over longer time periods. (7) The inflationary premium is included in the nominal interest rate in nominal financial instruments in an attempt to protect the lender from inflation over the term of the loan. (8) While inflationary premiums provide a measure of protection when the change in the inflation rate is modest, it can be quickly overcome by substantial changes in the inflation rate. (9) This is what happened to the thrifts in the United States in the later 1970s and early 1980s, when the inflationary premium was quickly overcome by a substantial degree of inflation. (10) This frequently resulted in the U.S. thrifts earning net negative real rates of return on their mortgage portfolios. (11) In addition, the inflationary premium increases everyone's risk by lowering the debt-service-coverage ratio on loans, thereby increasing the probability of mortgage defaults in the early years.
inflation index: (1) The inflation index is a measure of the change in the price level of a basket of goods and services, which is usually generated by research performed by a government agency. (2) Examples may include the consumer price index for all urban consumers (CPI-U), the consumer price index for all wage earners (CPI-W) or the producer's price index. (3) In general, the inflation index is assumed to mean any inflation index that is selected by the system because it is generally accepted by the participants in the system and the defined marketplace where the real financial instruments are to be created, funded, issued, securitized, stripped and/or exchanged.
inflation rate: (1) The inflation rate is defined as the percentage change in the selected inflation index for a given period of time, but is typically presented in annualized terms. (2) It provides an indication of the additional fiat currency that will be required to purchase a given basket of goods and/or services at the end-date of the defined time period relative to the fiat currency that was required to make the same purchase on the beginning date. (3) Please note that the inflationary adjustment factor (IAF) measures one plus the percentage change in the inflation index since the real financial instrument was created, which could be years. However, the inflation rate only measures the percentage change in the inflation index for one year, or for a period of less than one year, which is then annualized. (4) The inflation rate in any given economy or marketplace is a relative term at best, since any given inflation index (based upon the price changes in hundreds if not thousands of products and services) will never perfectly match the purchases of any given consumer, business or government. (5) Therefore, those who regulate, issue and/or use real financial instruments must be satisfied with an inflation rate as defined by the sampling and formulas adopted by the accepted inflation index until they can substitute a better index. (6) Nonetheless, this is far closer to the respective truth for all concerned; than the current practice of nominal financial instruments, which do not formally recognize inflation beyond the inclusion of an inflationary premium.
interest-rate-anomaly: (1) The relative difference between the market rates of two competing fixed-income instruments. (2) The instrument with the higher rate of interest is said to have a “positive interest-rate-anomaly,” while the instrument with the lower rate will be said to have a “negative interest-rate-anomaly.” (3) Assuming the risk is deemed equivalent by investors, the instrument with the positive interest-rate-anomaly will be more competitive, and therefore will attract larger and larger amounts of capital over time, until the positive interest-rate-anomaly disappears. See “negative interest-rate-anomaly.”
I/O strip: The derivative security, or strip, representing the payment of the (nominal) interest-only (10), which is stripped, or derived, from the payment stream of the underlying nominal financial instruments. See “interest-only.”
issue date: (1) The date the issued securities are issued for any conduit, whether a REMIC or FASIT. (2) The same date as the start-up date of the of a REMIC, that issued the securities; since all securities issued by the REMIC must be on the start-up date. (3) The securities laws of the United States are referenced here as a example with the understanding that the appropriate revisions must be made for the securities laws of other countries, assuming systems are established in such countries.
issued securities: The securities issued by the conduit, including one or more classes of regular interests with attached accrual rights and one class of residual interests.
market index: (1) The market index refers to an interest-rate index that is generated by the activity of supply and demand in the marketplace, such as the U.S. treasury bill index or the London inter-bank offer rate (LIBOR). (2) Investors will trust a market (generated) index more than a government tabulated inflation index, since the government could arbitrarily decide to change the definition of the inflation index to lower its borrowing costs. (3) In addition, marketplaces functioning under the nominal monetary paradigm frequently have trouble understanding the pricing of real financial instruments off a an inflation index. (4) This occurs because the pricing off the inflation index is typically quoted in terms of a real rate of interest, while markets functioning in the nominal monetary paradigm are used to functioning in nominal rates of interest. (5) By using a market index, real financial instruments can be quoted an in effective nominal rate of interest, which can then be reduced by the prevailing inflation rate to get the real rate of interest used in the amortization. (6) Instruments quoting from a nominal market index, and then deducting the prevailing inflation rate to get the real amortizing rate of interest; are second generation real financial instruments. (7) Second generation real financial instruments are variable real rate instruments. (8) Second generation real financial instruments can de useful in resolving the problem of negative interest-rate-anomalies, which are associated with the first generation of (fixed) real financial instruments prior to the offering of asset-backed monetary equivalents. (9) The offering of asset-backed real monetary equivalents also resolves the negative interest-rate anomaly problem, and may be more competitive than the second generation.
master inflationary adjustment factor: (1) The master inflation adjustment factor (MIAF) is the inflationary adjustment factor adopted by the multi-phase monetary system, defined marketplace, conduits, qualified assets, issued securities and accrual rights for converting the master real currency to the real currency. (2) Each of the aforementioned entities functioning within the same system will have an MIAF with the same base-line-date, meaning that the purchasing power of the master real currency defined by that MIAF is constant throughout these entities. (3) However, the numerical value of the MIAF will vary from entity to entity depending upon its start-up, or issuance, date and the change in the prevailing rate of inflation between the respective dates. (4) Once determined, the MIAF for any given entity is constant over time; since the respective difference between the system's master real currency and any given-instrument's or entity's real currency is fixed, since each are in turn fixed to the same inflation index, simply on different dates.
measurement period: (1) Refers to the agreement by convention to defining the prevailing rate of inflation as being measured monthly (times 12), quarterly (times 4) or annually. (2) The general preference is annually, since any shorter period creates greater volatility in the amortizing (real) interest rates. (3) May also refer to the adjustment period of the amortizing (real) rate of interest and/or the inflationary adjustment factors, such as monthly, quarterly or annually. (4) If a real financial instrument is prepaid in the middle of an adjustment period, then the inflationary adjustment should be prorated.
MIAF: See: “master inflationary-adjustment factor.”
margin: (1) A fixed percentage of interest, added to the qualifying (or pricing) index, to determine the qualifying (or effective nominal) rate of interest. (If the pricing index is an inflationary index, then the pricing margin is also a fixed real rate of interest.) (2) Margins are generally determined by competition in the marketplace and the perceived quality, or relative risk, of the loan (or instrument). (3) As such, the margin can change for similar loans receiving a commitment at different time periods, or for dissimilar loans receiving a commitment in the same time period. (4) Other factors, such as the volume of loan applications from the respective customers may also affect the respective-margins. (5) Nonetheless, a pool of loans using the same pricing index can be said to have an average fixed margin from which the securitization professionals can price the securities to be issued relative to current market conditions.
market index: (1) The term “market index” refers to an interest rate index that is determined by the interaction of supply and demand in the marketplace. Examples would include the treasury bill index and the London inter-bank offer rate (LIBOR). (2) Conversely, an inflation index is not considered to be a market index, since it is tabulated by a government agency. (3) Investors trust market indexes more than inflation indexes, since the government could change the formula or process for determining an inflation index, thereby lowering its cost of funds at the expense of the investors. (4) In recent years, the United States government has redefined its primary inflation indexes for the direct purpose of lowering the cost-of-living-adjustments (COLAs) on the entitlement programs, such as social security and medicare.
master real currency: (1) The only monetary unit, or phase, that has a constant level of purchasing power for every instrument, entity and participant in a give system, during inflationary and deflationary time periods. (2) Inasmuch as the real currency defined by one instrument, or conduit, can have a different purchasing power than the real currency defined by another instrument, or conduit, (due to different initiation or start-up dates) it is necessary to establish a master real currency to facilitate the transfer of wealth via the accrual rights from one conduit in the defined marketplace to other conduits that are making a market for the accrual rights. (3) It might be argued that the transfers could be made in the nominal currency, since the nominal currency debited from one conduit and credited to the next conduit the same day would have the same relative purchasing power. However, this is regressive since it leads the participants within the defined marketplace in the wrong direction, towards the continued use of the nominal currency which causes inflation and deflation, instead of toward the master real currency which resolves inflation and deflation. (4) As the participants begin to understand the services that Real Monetary Software™ performs for them, they will also begin to see that this complexity can be overcome if everyone agrees to adopt an asset-backed real money supply. (5) The master real currency begins as an abstract mathematical concept, but it is the forerunner of the asset-backed real monetary equivalents. (7) At such time as the financial marketplaces shift from the use of the current nominal fiat money supply to the use of an asset-backed real money supply, then the journey across the conceptual bridge as envisioned by the Real Monetary Software™ will have been completed. (8) Nonetheless, the transformation of the marketplace from the Nominal Monetary Paradigm to the real monetary paradigm will require the liquid exchange of the currency to the master real currency and vice-versa; whether directly or indirectly through the real currency and the nominal currency. (9) Only in this manner can participants in the marketplace become familiar with use of the asset-backed real monetary equivalents and ultimately let go of its current preference for the nominal fiat currency, which causes inflation and deflation.
master real dollar: See “master real currency” or “MR$”
monetary conduit: (1) A conduit that has been created for the express purpose of issuing a class of securities (regular interests) that will be stripped into real-interest-only (RIO) and real-principal-only (RPO) components such that the RPO strips can be used to secure the issuance of an asset-backed real monetary equivalent or real money supply. (2) In essence, the monetary conduit will purchase the RPO strips to back the issuance of the real monetary, such as the Millennium Dollar™.
monetary equivalent: (1) Any financial instrument or device that is meant to take the place of the currency issued by the government. (2) Any financial instrument or device that attempts to function as a medium of exchange, a unit of account or a store of value. (3) Monetary equivalents include personal checks, drafts, money orders, credit cards, debit cards, stamps, travelers checks, coupons, vouchers, etc.
monetary phase: (1) The term “monetary phase” refers to the use of one of the four different monetary units, including the master real currency (MR$), real currency (R$), nominal currency (N$) or currency ($); that are used by Real Monetary Software™ to achieve its goals. (2) By tracking the financial activity of real financial instruments in the four monetary phases, we can create a conceptual bridge between the nominal monetary paradigm and the real monetary paradigm. (3) This will allow participants in the marketplace to understand the benefits of using real financial instruments in traditional nominal monetary terms.
monetary phase conversion: The term “monetary phase conversion” simply refers to converting sums defined in one monetary phase to another by multiplying or dividing by the appropriate IAF or MIAF, or by recasting the excess (or shortage) in “principal paid” column in the nominal currency N$ conversion table to the “interest paid” column in on the currency ($) recasting table, during inflationary (or deflationary) time periods.
MR$: See “master real currency.”
MR$ conversion table: See “conversion table.”
multi-phase: (1) Refers to the use of four monetary phases in the creation of a system, defined marketplace, conduit, qualified asset, issued security or accrual right that is bridging the conceptual differences between the nominal monetary paradigm and the real monetary paradigm. (2) Using the U.S. Dollar as an example, the four monetary phases include:
   (i) currency or the dollar ($)
   (ii) nominal currency or the nominal dollar (N$),
   (ii) real currency or the real dollar (R$) and the
   (iv) master real currency or the maser real dollar. (MR$).
   (3) Nonetheless, the four monetary phases could be defined in terms of any negotiable Currency accepted as legal tender, or any monetary equivalent accepted as preferred tender.
multi-phase monetary system: (1) The multi-phase monetary system (or system) creates a conceptual bridge between the nominal monetary paradigm and the real monetary paradigm by tracking a given financial activity in four monetary phases, including master real currency (MR$), real currency (R$), nominal currency (N$) and currency ($). (2) It creates an economic sphere that accommodates the transfer of wealth by means of a master real currency with a constant level of purchasing power. (3) By adopting the multi-phase monetary system's base-line date (for defining the purchasing power of the system's master real currency), defined marketplaces, conduits, qualified assets, issued securities and accrual rights can all transfer wealth between each other in constant terms. (4) Finally, the successful issuance of the asset-backed real monetary equivalent can permanently shift the negative interest-rate-anomaly from the offering of real financial instruments to nominal financial instruments, thereby giving real financial instruments a competitive edge in the marketplace.
N$: See “nominal currency.”
N$ conversion table: See “conversion table.”
negative interest-rate-anomaly: Long-term real financial instruments, priced off an inflation index, are not directly competitive with long-term nominal fixed rate instruments, due to the inflationary premium loaded into the nominal instruments. (2) The absence of the inflationary premium creates a negative interest-rate-anomaly, or lower effective nominal rate, for the real financial instrument by comparison to the nominal financial instrument. (3) Hence, the problem of the negative interest-rate-anomaly creates a marketing problem that makes it difficult to create a market for the first generation real financial instruments in a marketplace that is defined largely by the nominal monetary paradigm (4) The second generation of real financial instruments can resolve this problem by shifting from the inflation index to a short-term market index to price the instruments. (5) Inasmuch as even short-term nominal financial instruments have little or no inflationary premium, the negative interest-rate-anomaly typically becomes a positive interest-rate-anomaly: (6) Nonetheless, this advantage of the second generation can be lost on a comparative basis when the market yield curve begins to flatten. (7) The ultimate answer to the problem of the negative interest-rate-anomaly is the third generation of real financial instruments, or the issuance of asset-backed real monetary equivalents. (8) Inasmuch as the successful issuance of the asset-backed real monetary equivalent, such as the Real Mortgage-Backed Securities, will shift the capitalization rate of the real-principal-only (RPO) strip, backing the monetary equivalent, from a market interest rate to the prevailing rate of inflation; the remaining real-interest-only (RIO) strip becomes gross profit for the issuer. (9) This means that the RIO strip can be used to increase the competitive position of the third generation of real financial instruments until the nominal financial instruments in the marketplace are overwhelmed, since they are then offering an effective negative interest-rate-anomaly. (10) In essence, the competitive tables have been turned by moving from the first to the third generation of real financial instruments, which shifts the negative interest-rate-anomaly problem from the real financial instruments to the nominal financial instruments. (11) In this manner, it is possible to see that the marketplace can now be converted from the nominal monetary paradigm to the real monetary paradigm.
nominal currency: (1) To commence the creation of the multi-phase monetary system, the initial participants (and/or sponsor) must select a nominal currency that is unadjusted for inflation. (2) Normally, the nominal currency-selected will coincide with the nominal currency being used in the financial marketplace, where the loan instruments are generated and the resulting asset-backed securities will be sold. (3) Real financial instruments will then be originated by denominating them in real terms, such that the real currency will be established as equaling the nominal currency on the origination date of the instrument. (4) The later conversion of the real currency amortization schedule to the nominal dollar conversion table will create certain distortions. (5) these distortions will be corrected by recasting the nominal currency on the currency recasting table.
nominal dollar: See “nominal currency” or “N$.”
nominal financial instruments: (1) Financial instruments that are defined in nominal currencies and nominal rates of interest, which are not adjusted for inflation. (2) Any currency, or monetary equivalent, instrument or contract, whose monetary unit is defined in a fiat currency.
nominal monetary paradigm: The set of rules and beliefs that govern the use of the nominal currency, and other nominal financial instruments which are unadjusted for inflation.
nominal-principal-only: The stream of payments representing the repayment of the nominal currency originally borrowed, which is unadjusted for inflation or deflation.
NPO: See “nominal-principal-only.”
nominal rate of interest: The traditional rate of interest, commonly used in financial marketplaces, which is unadjusted for inflation; but usually contains an inflationary premium.
origination date: The date that the loan instrument is originated and funded.
ownership interests: The class of interests in a FASIT receiving any residual cash flow after all classes of the regular interests have received all of the current payments that have been promised to them. See “regular interests.”
parameters: (1) Each multi-phase monetary system must establish certain parameters, which will define the master real currency and the master inflationary adjustment factors (MIAFs). (2) The parameters include a) the fiat currency, such as the U.S. dollar, (b) the base-line-date of the system, which establishes the master real currency as being equal to the purchasing power of one unit of the fiat currency on said date and (3) the inflation index, such as the CPI-U in the United States, which is used to generate the MIAFs thereby tracking the change in the relative purchasing power of the designated real currencies of various instruments and entities functioning within the system.
par value: (1) The term “par value” shall be defined as the outstanding balance of the given asset, including any interest that may have accrued to the date of purchase by the conduit. (2) The presumption being that the par value is the conduit's purchase price of the qualified asset.
payment period: (1) The term “payment period” refers to the frequency of the payments to be made, such as monthly; quarterly; semi-annually or annually. (2) The payment period is simply determined by mutual agreement of the parties as stipulated in the legal documents at the creation of the assets or securities. (3) The payment period for any given securities class need not be identical to the payment periods of the other securities classes or to the payment periods of the underlying assets, since the residual or owner's interests may be allocated the relative difference.
positive interest-rate-anomaly: See “interest-rate-anomaly.”
preferred tender: (1) Currencies or monetary-equivalents that may not be formally recognized by any government as legal tender, but which are nonetheless generally accepted in the marketplace for the payment of goods and services. (2) Examples may include personal checks, credit cards, money orders, debit cards and so on. (3) Typically, preferred tender will require some-additional benefit for the users in order to be generally accepted in place of the government-issued legal tender, such as the real monetary feature of being self-adjusting for inflation. (4) For such acceptance to be achieved, it is also likely that there must be one or more market-makers, who will efficiently convert the preferred tender to legal tender for those who are not comfortable holding the preferred tender. (5) The financial strength of the market-makers will go a long way towards achieving this level of acceptance.
prevailing rate of inflation: (1) The rate of inflation used in the calculation of the real rate of interest and the current inflationary adjustment (CIA). (2) The prevailing rate of inflation can be determined by either the monthly, quarterly, semiannual or annual rate of change in the inflation index. (3) Typically, the sponsor will select the annual rate of change in the inflation index over a twelve-month period, as the prevailing inflation rate, to minimize the potential volatility that shorter periods of measurement might exhibit.
pricing margin: The fixed margin added to the percentage change in the inflation index, or the market index rate, for the purpose of determining the effective nominal rate of interest for the real financial instrument. See “margin” and “pricing index.”
pricing index: (1) The term “pricing index” is the index, combined with the fixed margin, used to determine the effective nominal rate of interest for the real financial instrument. (2) The pricing index may be either a market index or an inflationary index. (3) The use of a market index would be preferred as the pricing index in the traditional nominal monetary marketplace, as opposed to an inflationary index which would be preferred in a marketplace that has converted to real terms. (4) The exception to this would be the successful issuance of the asset-backed real monetary equivalent, which would then make the inflation index the preferred pricing index. (5) Nonetheless, a market index will result in a variable real rate of interest, while a fixed real rate of interest will result in the use of an inflationary index as the pricing index.
primary assets: (1) The term “primary assets” refers to the loan instruments that are directly secured by the borrower's asset (real estate, automobiles, etc.) or by the borrower's personal or corporate credit (2) Typically, the primary assets can be real estate mortgages, auto loans, credit card receivables, government bonds, consumer loans, etc.
qualified assets: The term “qualified assets” are simply the total of the primary assets and secondary assets of the given conduit.
qualifying margin: (1) The fixed margin added to the market index rate for the purpose of determining the qualifying interest rate for the real financial instrument, which is then used to qualify the borrower for the size of the loan to be made. (2) After the six of the loan is determined, the loan is converted to real terms. (3) Thereafter, the qualifying margin is no longer relevant, since the pricing margin is used to determine the effective nominal rate of the real financial instrument. (4) There need be no direct correlation between the qualifying margin and the pricing margin. See “margin” and “market index.”
R$: See: “real currency.”.
RABS: See “real asset-backed securities.”
real asset-backed securities: The term “real asset-backed securities” (RABS) are asset-backed securities that are defined in real currency and amortized in real interest rates. See “asset-backed securities.”
real currency; (1) The term “real currency” (R$) is defined by the given conduit as being equal to the nominal currency (N$) on the start-up date of the conduit, or conversely on the day the real financial instruments are originated, issued, stripped or otherwise created. (2) Please note that the purchasing power of the real currency defined by one entity or instrument will usually be different than the purchasing power of the real currency defined by another entity or instrument, assuming inflation has occurred between their respective start-up origination, issuance or stripping dates.
real currency phase: The monetary phase dealing with the real currency. See “monetary phase” and “real currency.”
real dollar: See “real currency” or “R$.”
real estate mortgage investment conduit: (1) The real estate mortgage investment conduit (REMIC) is a tax election made by the legal entity functioning as a conduit for the securitization of real estate mortgage loans and/or mortgage-backed securities. (2) The tax impact of the conduit's cash flows pass through to the holders of the regular interests, accrual rights and residual interests. (3) This assures all concerned that the conduit will not be considered a corporation, or association, which would result in double taxation on the conduit's income. (4) REMICs were formally recognized in the 1986 Tax Reform Act. (5) On Sep. 1, 1997, a new entity called the Financial Asset Securitization Investment Trust (FASIT) came into being, which will also function as a tax conduit. (6) In addition to REMICs, the Real Monetary Software™ (i.e. the invention) can be used with FASITs, or any other legally recognized tax conduit;
real financial instruments: Financial instruments that are defined in real terms, including real currency and real rates of interest, which means that they are self-adjusting for inflation and deflation.
real money supply: (1) Refers to the issuance a money supply that is properly backed by an asset and that maintains its purchasing power over time. (2) Such a real money supply can be created from real asset-backed securities (RABS), if the RABS are backed by an asset that is considered a good hedge against inflation. (3) An example would be Real Mortgage-Backed Securities (RMBS), whereby the Real Mortgages™ backing the RMBS are in turn secured by real estate. (4) The RMBS can then be stripped into real-principal-only (RPO) and real-interest-only (RIO) strips. (5) The RPO strip can be used to back the issuance of the real money supply. (6) Nonetheless, during the transformation of the marketplace from the nominal monetary paradigm to the real monetary paradigm, it will be necessary to maintain a liquid exchange of master real currency for the currency and vice-versa. (7) As such, it will be necessary to strip the RPO strip into its component parts including the nominal-principal-only (NPO) strip and the accrued-interest-only (AIO) strip. (8) A market can then be made for the AIO strip to furnish the market-makers with the stream of currency required to provide liquidity for the accrued interest owned by the holders of the original regular interests.
real monetary equivalents: A monetary equivalent that is defined in monetary units with a constant, or real, level of purchasing power over time.
real monetary paradigm: The set of rules and beliefs that govern the use of real currency and real financial instruments, which are self-adjusting for inflation and deflation.
Real Monetary-Software™: (1) The invention being patented. (2) The purpose of the Real Monetary Software™ is to create a conceptual bridge, whereby participants in the marketplace can see the benefits of using real financial instruments in traditional nominal monetary terms. (3) If Real Monetary Software™ is successful in its goal, then it will lead to the conversion of the financial marketplaces from the current nominal monetary paradigm to a real monetary paradigm. (4) The conversion will result in the issuance of an asset-backed real money supply, which will eventually eliminate the need to engage in monetary phase conversions; thereby completing the journey across the conceptual bridge.
real monetary system: (1) A monetary system, or paradigm, that is concerned with defining units of money that have a constant purchasing power over time. (2) A monetary system that is designed to protect participants in the marketplace from the destructive effects of inflation and deflation. (3) A monetary system that is being introduced into a nominal monetary marketplace that will provide a conceptual bridge to allow participants to see the value of real financial instruments in traditional nominal monetary terms. (4) A monetary system that will lead to a paradigm shift in the marketplace from nominal to real terms. (5) A monetary system that creates and uses asset-backed real monetary equivalents. (6) A monetary system whereby money can properly perform its primary functions by serving as a medium of exchange, unit of account and a store of value. (7) A monetary system that works.
real-interest-only: The stream of payments representing the payment of the real rate of interest due on the real financial instrument.
real-principal-only: (1) The stream of payments from a real financial instrument that represent the repayment of the principal borrowed in real, or constant, terms. (2) The real-principal-only (RPO) can be said to represent a combination of the nominal-principal-only (NPO) and the accrued-interest-only (AIO), which can then be stripped apart. (3) The addition of the accrued interest, represented by the AIO, to the NPO is what gives the RPO a constant level of purchasing power.
real interest rate: (1) The rate of interest equal to the nominal rate of interest less the prevailing inflation rate as measured by the percentage change in an agreed upon inflation index for a given period of time. (2) The real rate of interest is what the investor earns after he has been reimbursed for the devaluation of the currency by inflation.
recasting table: (1) The table used to convert nominal currency (N$) to currency ($). (2) The term “recasting table” is used to denote that the actual amortization for a real financial instrument occurs in the real currency (R$) amortization schedule. (3) Subsequently, the real currency payments can be converted to the nominal currency using the inflationary adjustment factor. (4) Nonetheless, this process will create a distortion in the nominal currency conversion table during inflationary and deflationary times, such that the “principal paid” column total will not equal the nominal currency borrowed at the origination or issuance of the instrument. (5) This results in a recasting process, which will correct the distortion; thereby providing a proper set of books for tax and book accounting purposes. (6) The recasting table will also allow participants in the marketplace to begin to understand the benefits of using real financial instruments in traditional nominal monetary terms.
regular interests: (1) The term “regular interests” is derived from United States tax law regarding Real Estate Mortgage Investment Conduits (REMICs) (and Financial Asset Securitization Investment Trusts (FASITs)). (2) The REMIC (or FASIT) may have any number of classes of regular interests, as defined by the given conduit's documentation, but can only have one class of residual interests (or ownership interests). (3) The successive classes of regular interests will have a declining priority of payment with the class of residual interests (or ownership interests) receiving any residual cash flows after all the regular interests have received the payments that have been promised to them
residual interests: The class of interests in a REMIC receiving any residual cash flow after all classes of the regular interests have received all of the current payments that have been promised to them. See “regular interests.”
REMIC: See: “real estate mortgage investment conduit.”
RIO: See “real-interest-only.”
RIO strip: (1) The derivative security, or strip, representing the payment of the real-interest-only (RIO), which is stripped, or derived, from the payment stream of the underlying real financial instruments. (2) Once stripped, the RIO strip no longer represents a real rate of interest to the new purchaser, but rather a nominal rate of interest; since the real-principal-only has been stripped away and sold to, or retained by, a separate party. (3) In effect, the RIO strip becomes like any other interest-only (IO) strip from a nominal financial instrument. See “accrued-interest-only.”
RPO: See “real-principal-only.”
RPO strip: (1) The derivative security, or strip, representing the payment of the real-principal-only (RPO), which is strip, or derived, from the payment stream of the underlying real financial instruments. (2) The RPO strip is composed of both the nominal-principal-only (NPO) and the accrued-interest-only (AIO) (3) It is the AIO that maintains the purchasing power of the RPO as being equal to the purchasing power of the NPO on a one-to-one basis since the day the real financial instrument was created. See “real-principal-only.”
secondary assets: (1) The secondary assets are previously issued asset-backed securities, and or the accrual rights or other derivatives stripped from the previously issued asset-backed securities. (2) Secondary assets may include mortgage-backed securities, regular interests in a REMIC, FASIT or similar entity, accrual rights, etc. (3) Typically, tax law prohibits the secondary assets from being a REMIC's residual interests or a FASIT's ownership interests. (The law does not use the terms “primary assets” or “secondary assets,” but rather “qualified investments;” which is effectively the same thing.)
Second Generation Real Financial Instruments: Financial Instruments that are priced at a fixed margin over an agreed upon Market Index, such as the Treasury Bill Index or the London InterBank Offer rate (LIBOR); and then deduct the percentage change in an agreed upon Inflation Index to generate a variable Real Rate of Interest.
Sponsor: The person or entity that organizes the Conduit that purchases the assets and issues the securities.
Start-Up. Date: The day the Conduit purchases the assets and issues the securities.
Stripping Date: The first date that the given Accrual Right can be stripped from the Issued Security that it was attached to on the Startup Date of the Conduit. Typically, the Accrual Right would not be stripped until after the amount of accrued interest it represents has been determined, if any. (The actual date that the Accrual Rights are stripped may be different than the Stripping Date. However, certain financial calculations depend upon the Stripping Date of the Accrual Right to assign a Real Currency value for this instrument. While the Accrual Right may be stripped later, the later date is not relevant to this calculation; although it may be used for pro rating a payment.)
System: (See: Multi-Phase Monetary System).
Substituted Inflation Index: As the financial markets shift from the Nominal Monetary Paradigm to the Real Monetary Paradigm, the inflation Index selected will likely come under more scrutiny. Hence, the legal documents should provide a mechanism for legally substituting the selected Inflation Index, or conversely for dealing with any revision of the selected Inflation Index. If governments persist in redefining, or otherwise substituting, the available-inflationary indexes to favor their fiscal responsibilities; then it is likely that private enterprise will take over the function of generating reliable Inflation Indexes. In the future, such Inflation Indexes may be more reliably tabulated by tracking actual sales occurring over the Internet, assuming that the markets used to calculate the indexes are so large that tampering becomes virtually impossible by any given party or government.
Third Generation Real Financial Instruments: Real Financial Instruments that are derived from, or that benefit by, First and Second Generation Real Financial Instruments. Examples would include a Real Money Supply backed by Real Mortgage-Backed Securities or Real Estate Investment Trust (REIT) stock whereby the underlying properties of the REIT were financed by Real Mortgages™.

### III. BRIEF DESCRIPTION OF THE DRAWINGS

A. The Real Monetary Software Box Diagram by Process is Shown In:
Processes I-XXXVI in FIGS. 9a & 9b.

B. Real Monetary Software—Module Diagram is Shown In:
Parts I-XII can be found in Table 31;
Parts XIII-XXIV can be found in Table 32 and
Parts XXV-XXVI can be found in Table 33.
Please Note: The “Parts” in the Module Diagram are substantially the same as the “Processes” in The Index for Real Monetary Software Box Diagram by Process in subsection “A” above; except that, the Parts omit conceptual diagrams in subsections “C,” “D” and “E” below, as well as material related to the qualification of borrowers, and the creation of presentations for marketing and stress tests. Nonetheless, the Figures (or Tables) following the Module Diagram(s) are comprehensive and include all of the material referenced in both subsection “A” above and subsections “C,” “D” and “G” below.

C. Real Monetary Software's Multi-Phase Monetary System is Shown In:
Tables 77a, 77b and 77c.

D. Conceptual Stages of the Monetary Paradigm Shift Creating the Conceptual Bridge is Shown In:
Table 78.

E. Accrued Interest: Stripping and Market-Making for Real Financial Instruments is Shown In:

FIGS. 1 through 7.

F. Real Mortgage Corporation Announces the Millennium Dollar is Shown In:

FIG. 8.

G. Establishing the System and the Master Real Currency to Create a Wholesale Market for the Accrual Rights Representing the Accrued Interest is Shown In:
Table 80

H. The Box Diagram of the Real Monetary Software is Shown In:

FIGS. 10a through 10bc.

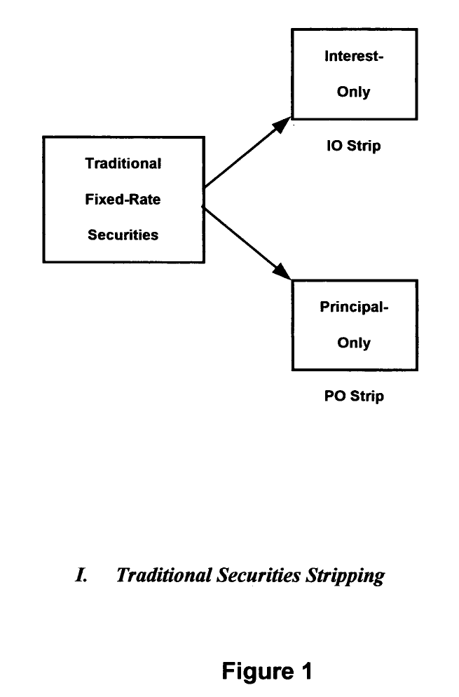

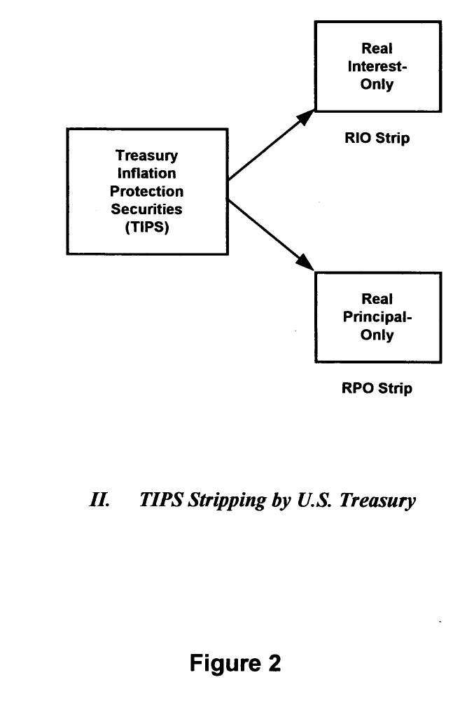

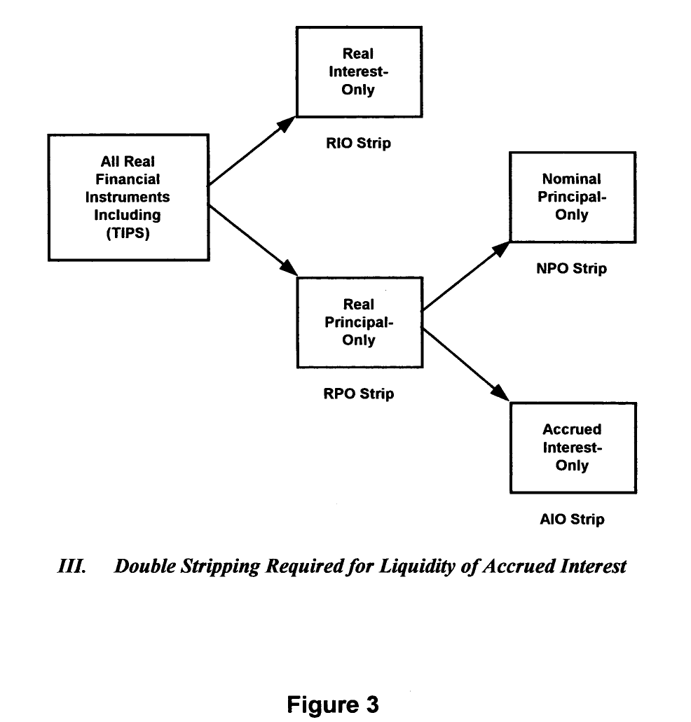

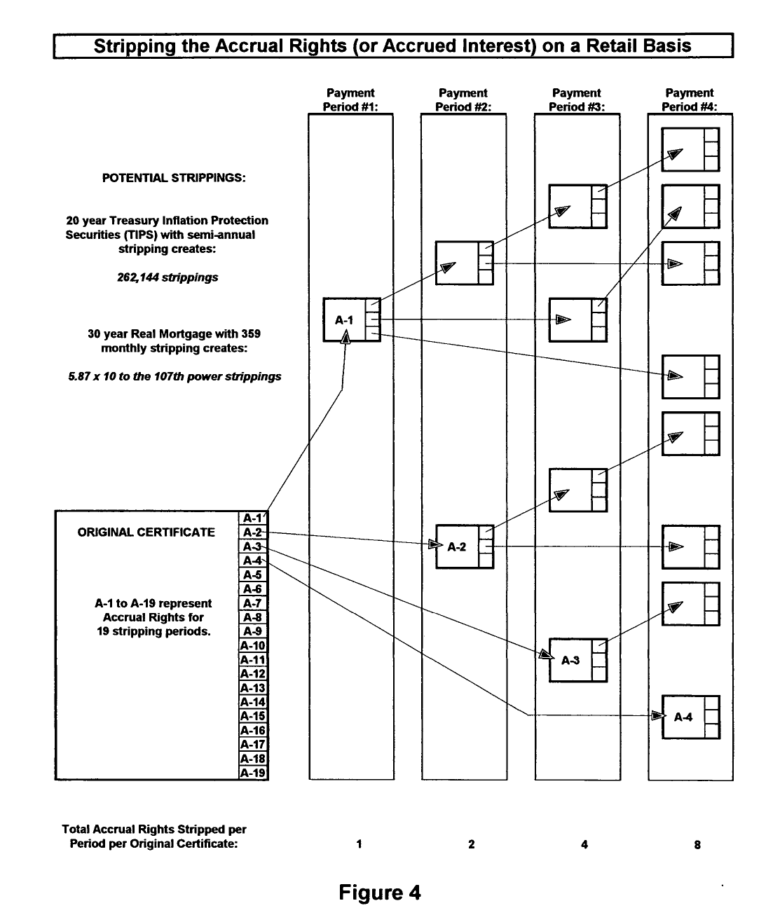

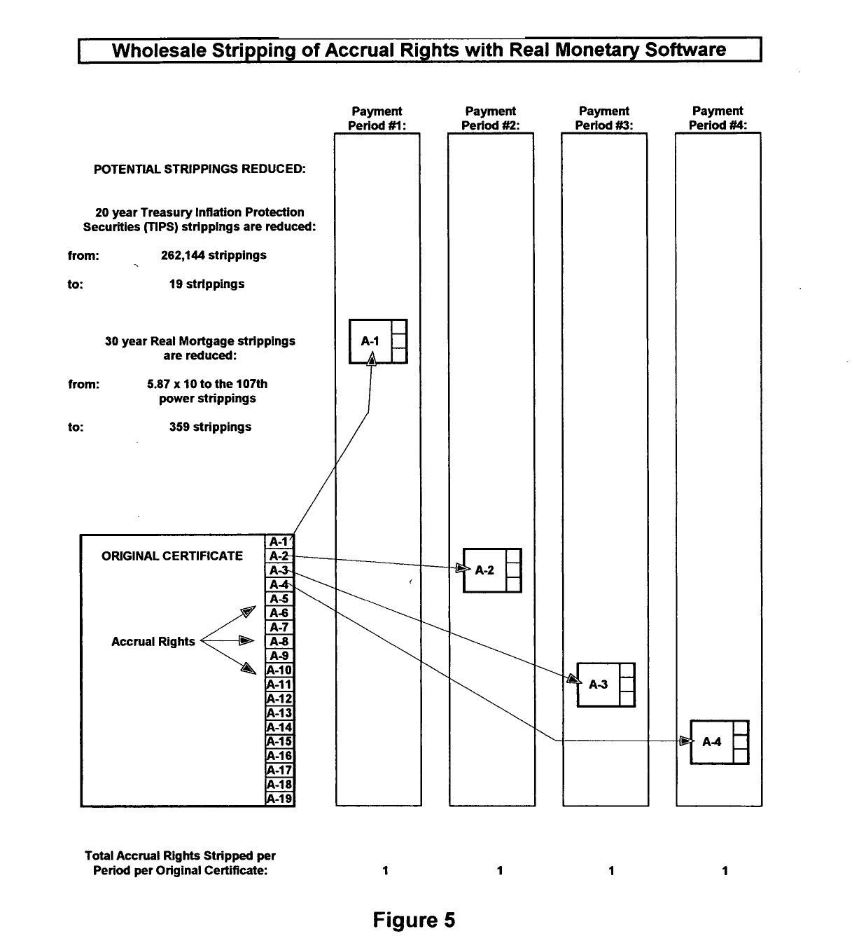

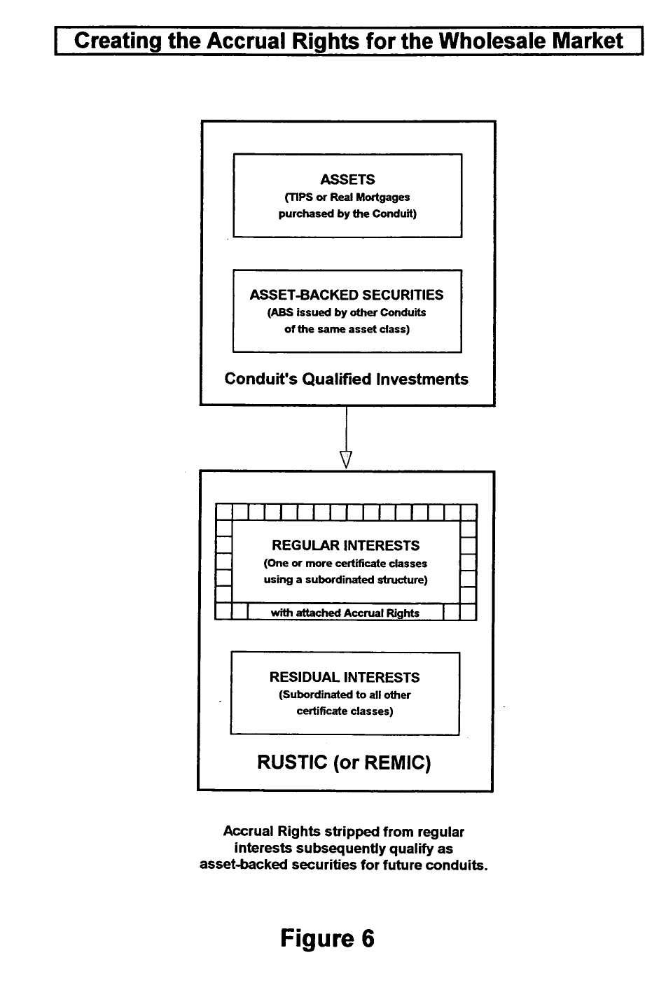

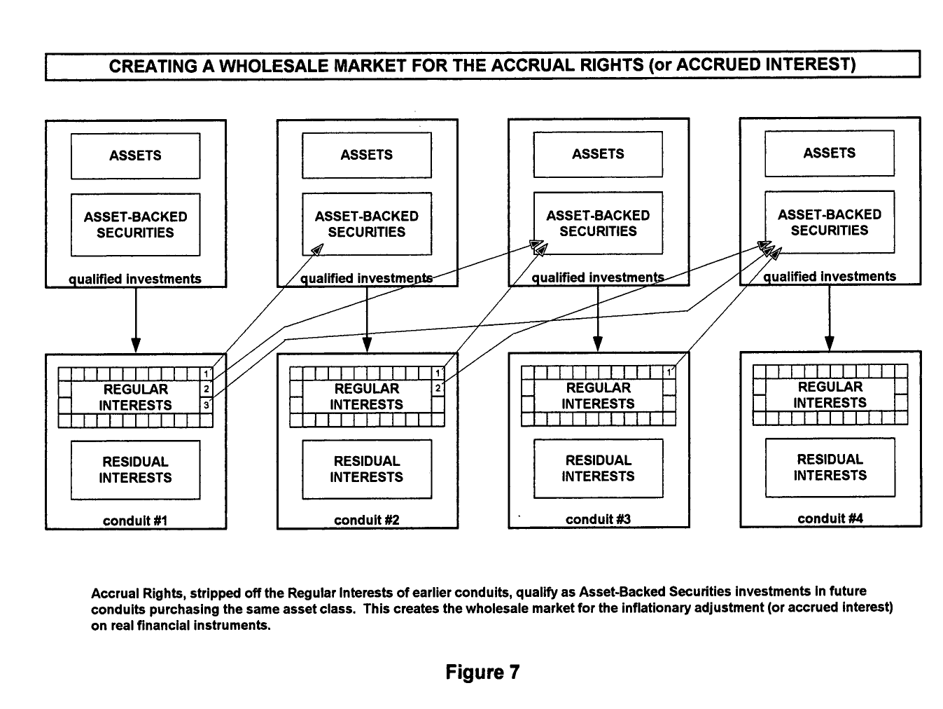

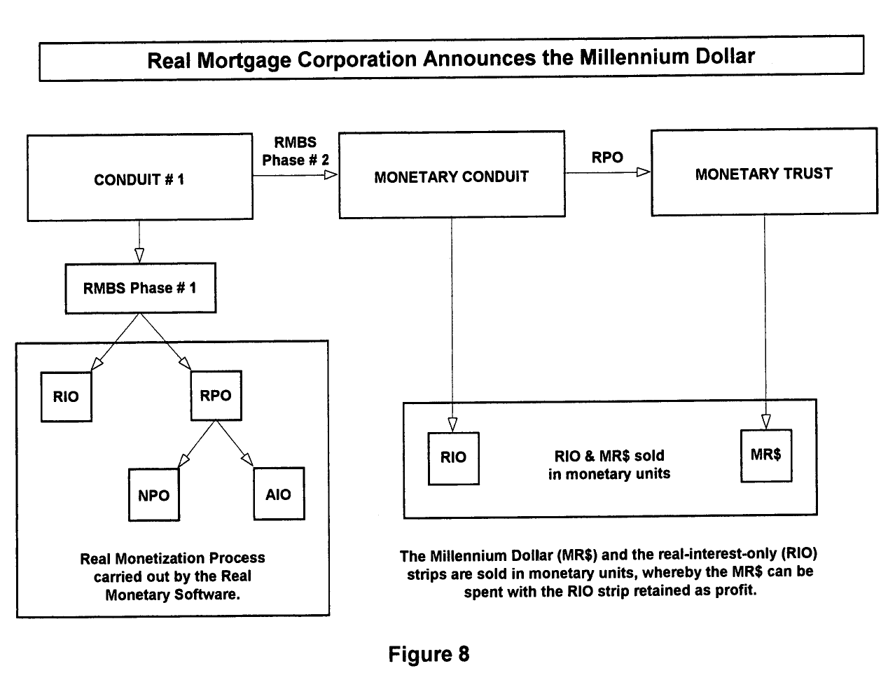

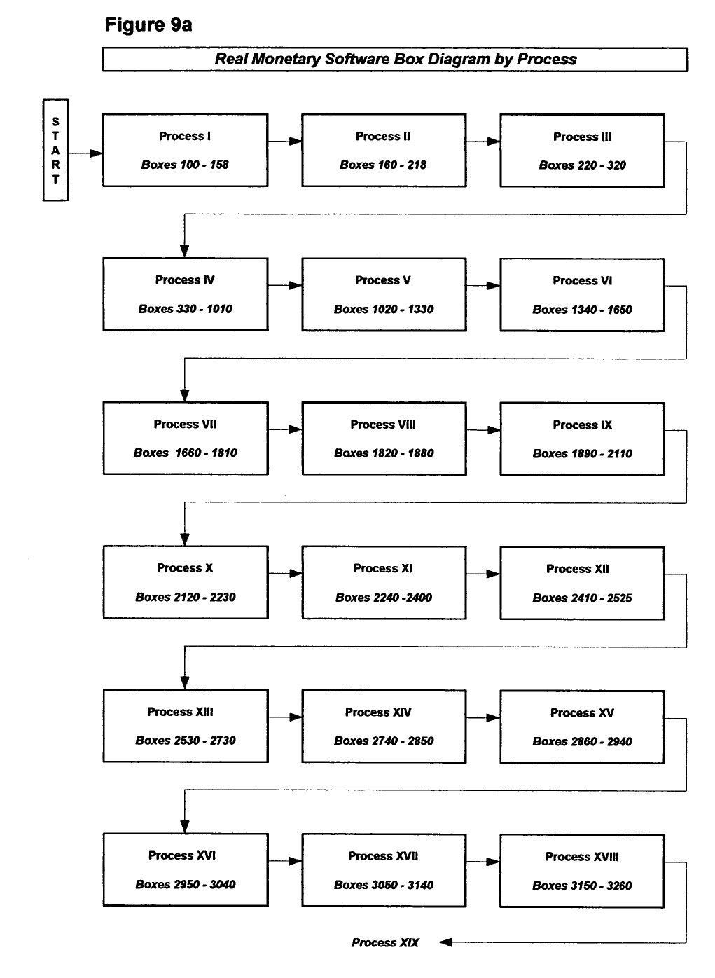

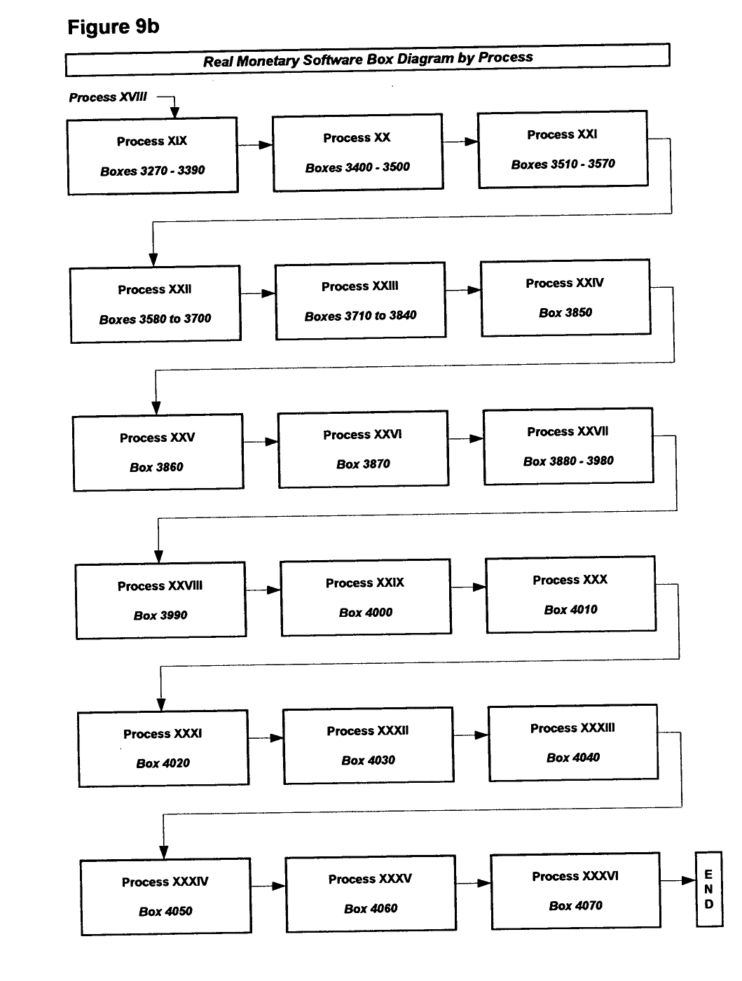

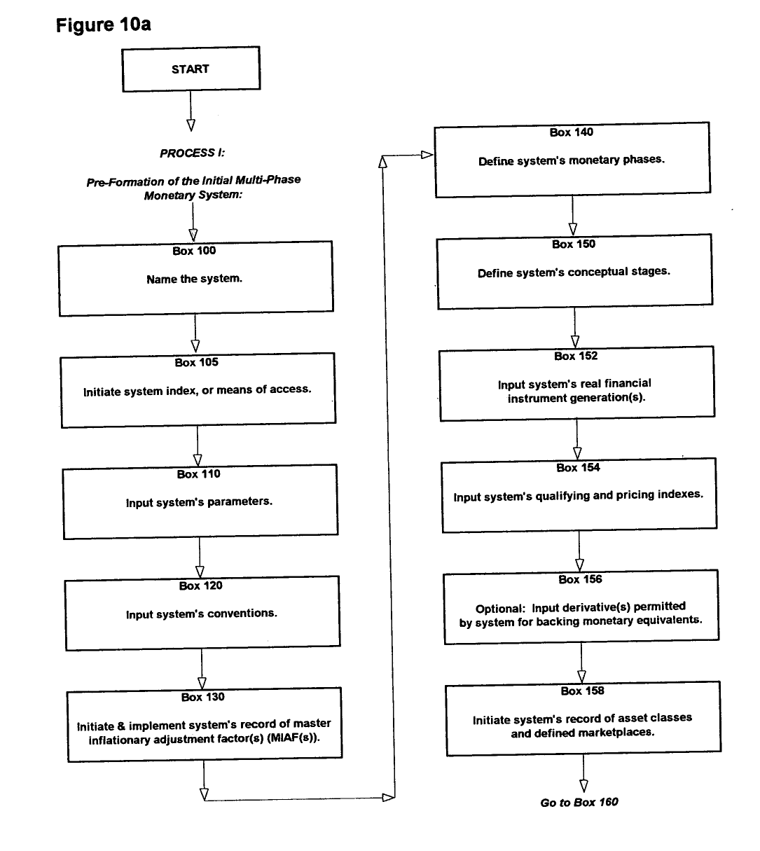

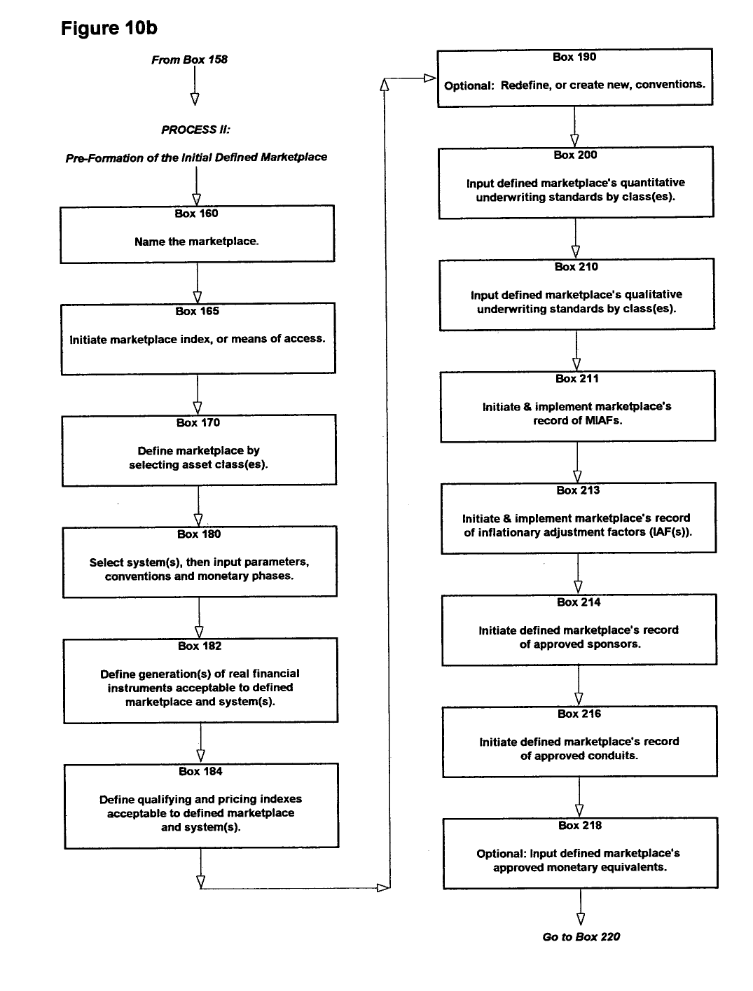

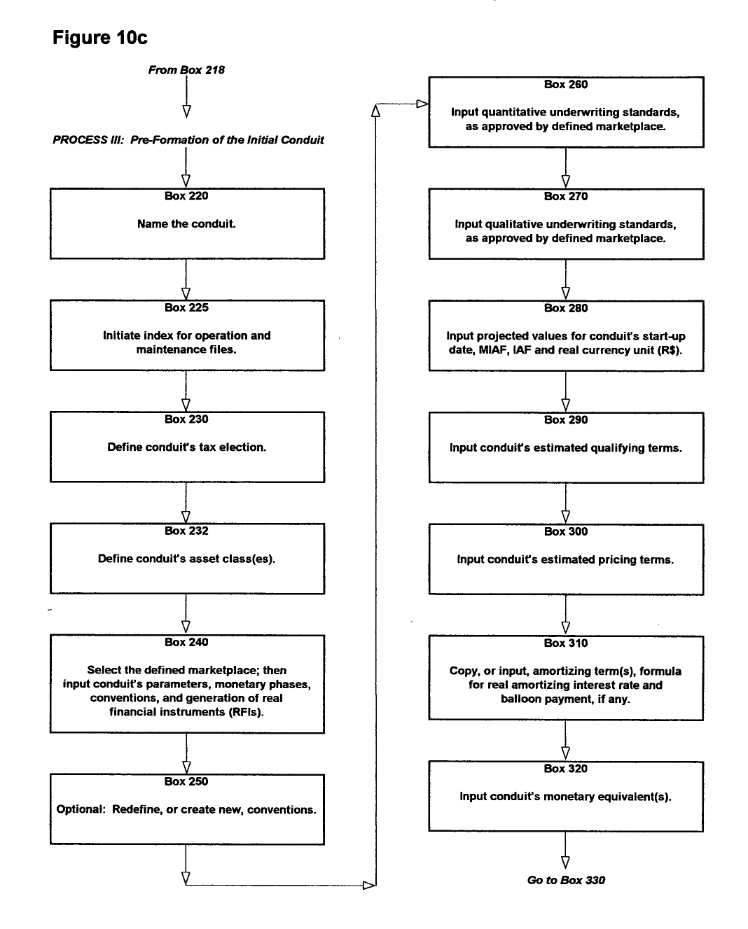

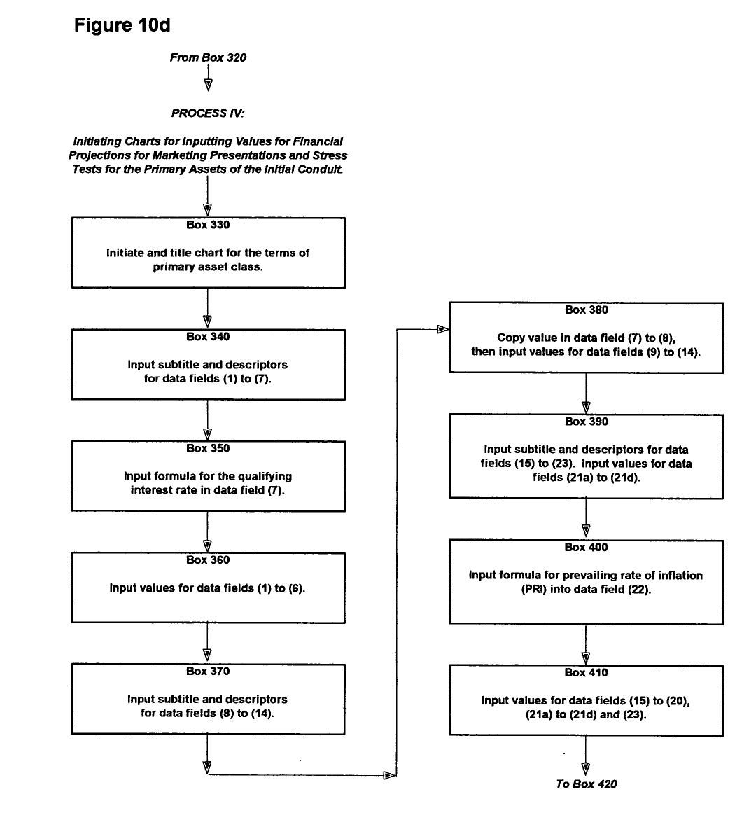

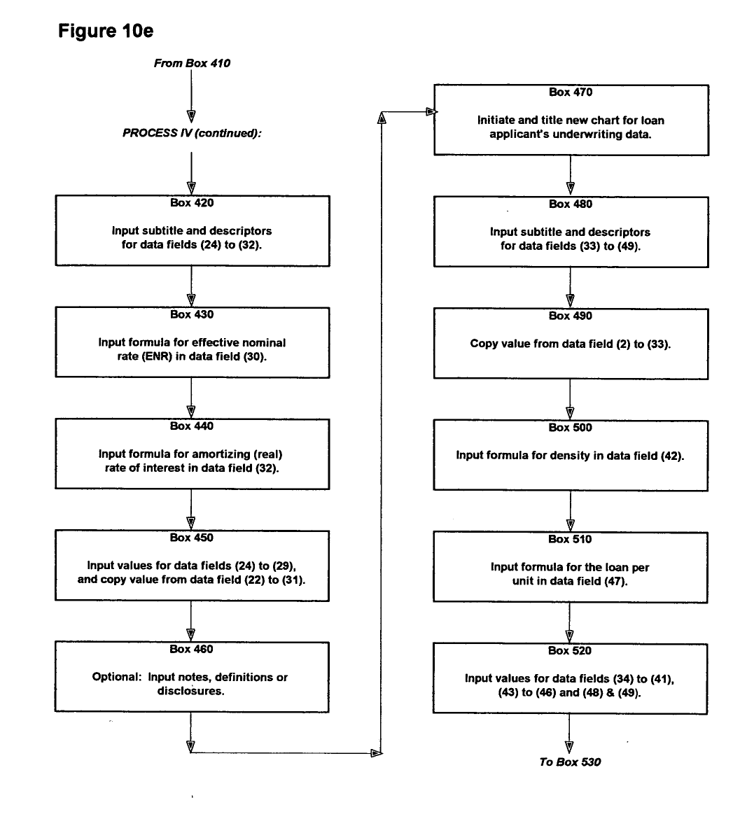

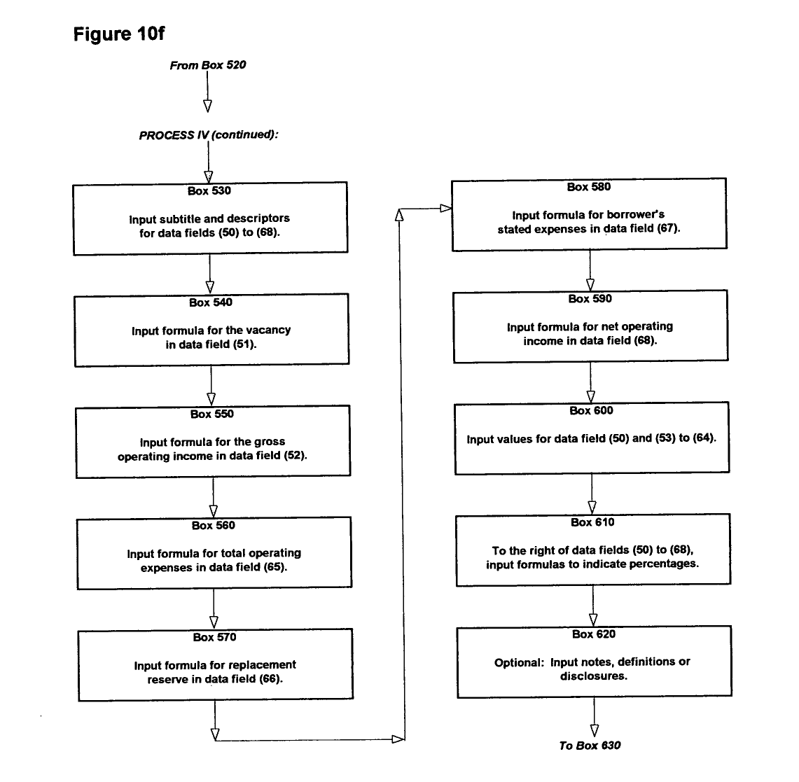

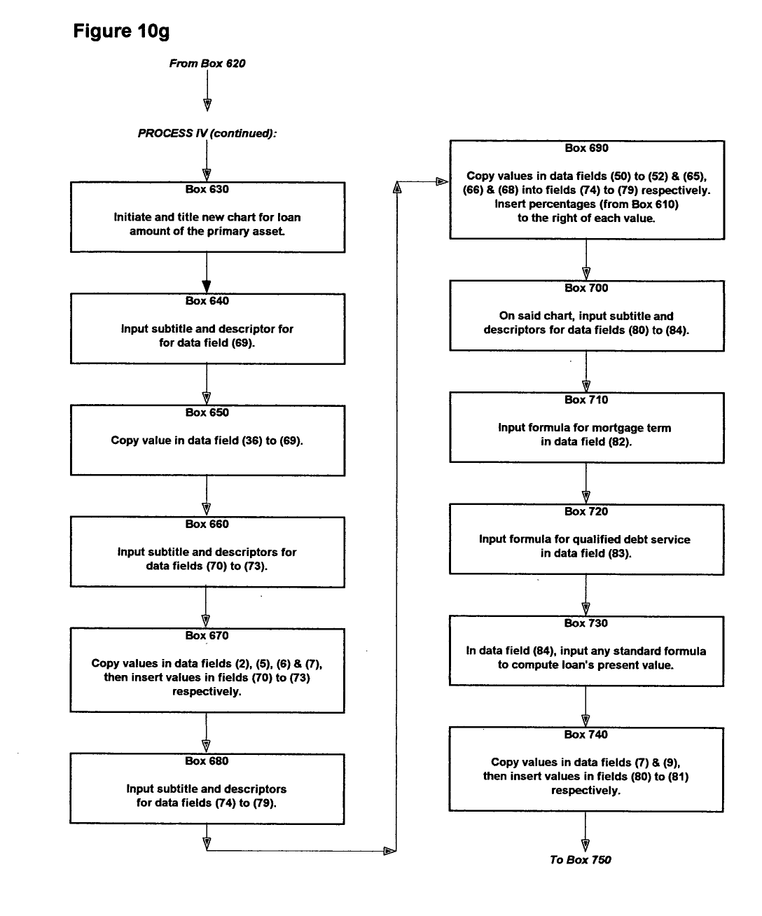

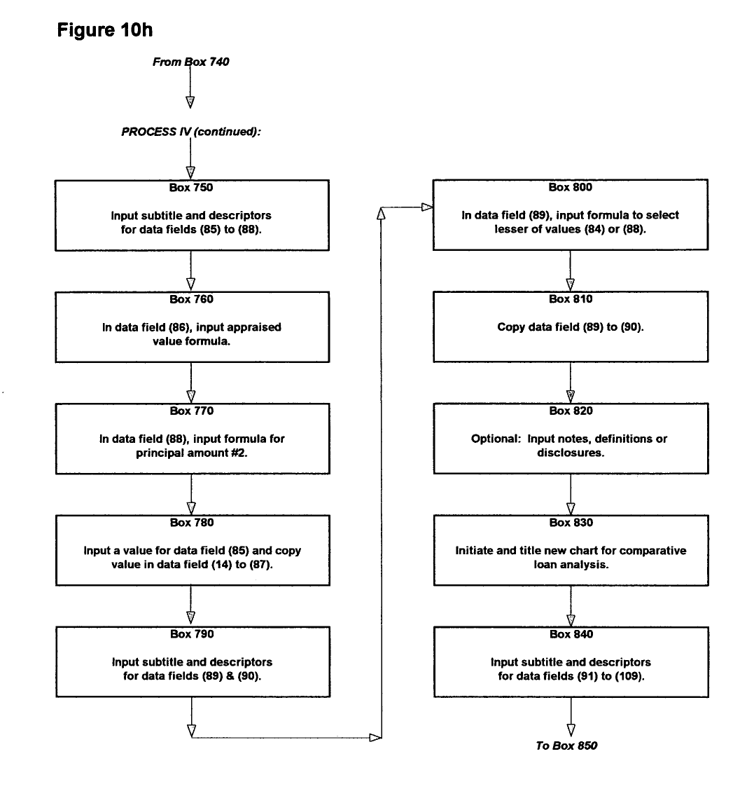

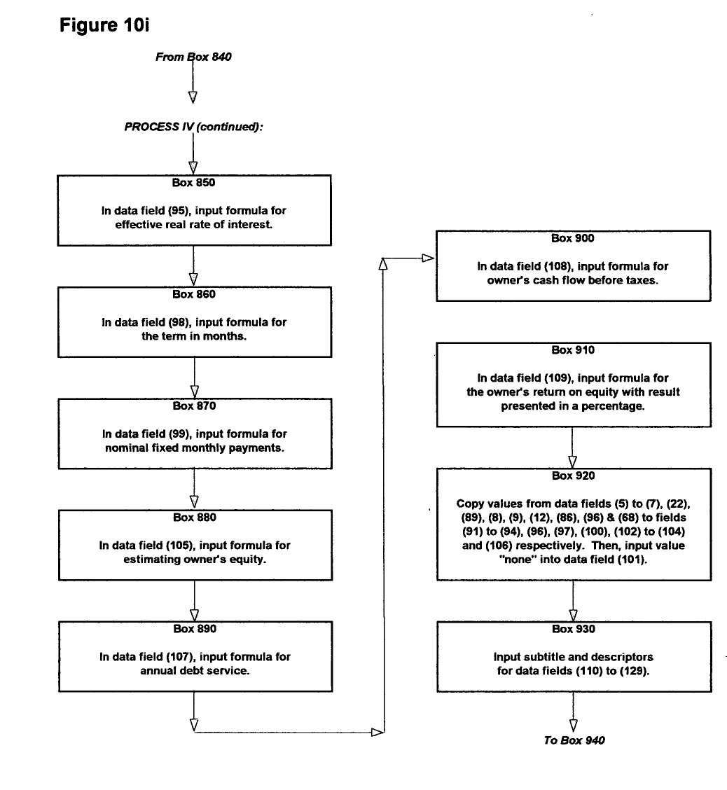

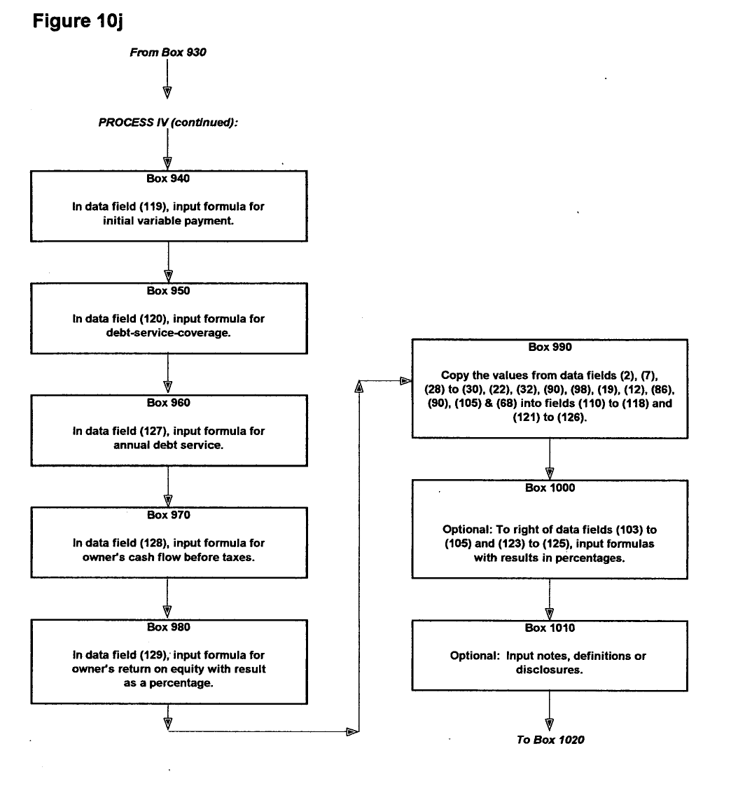

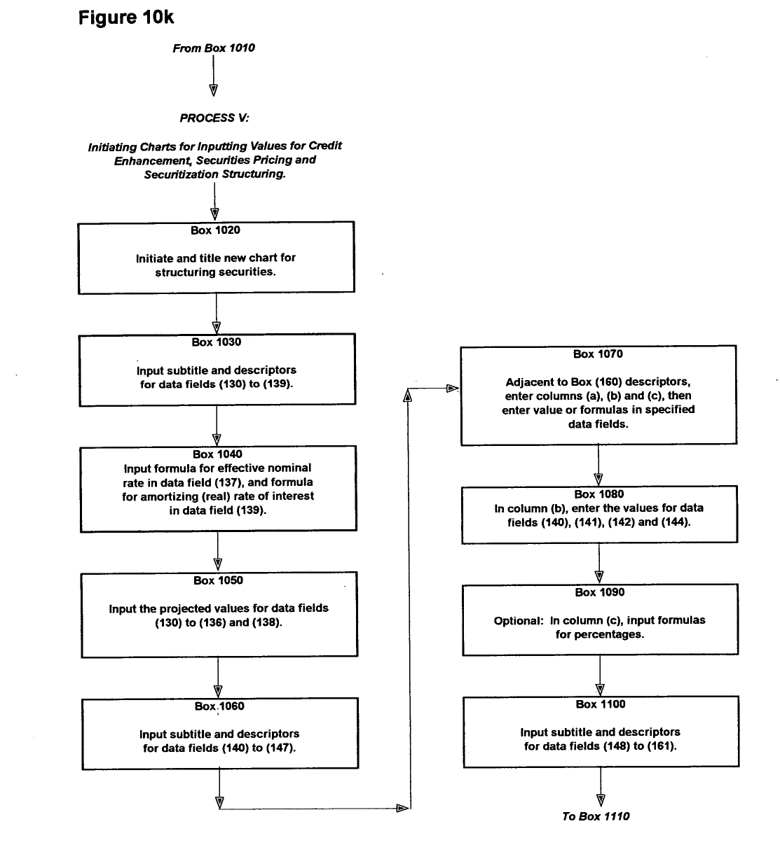

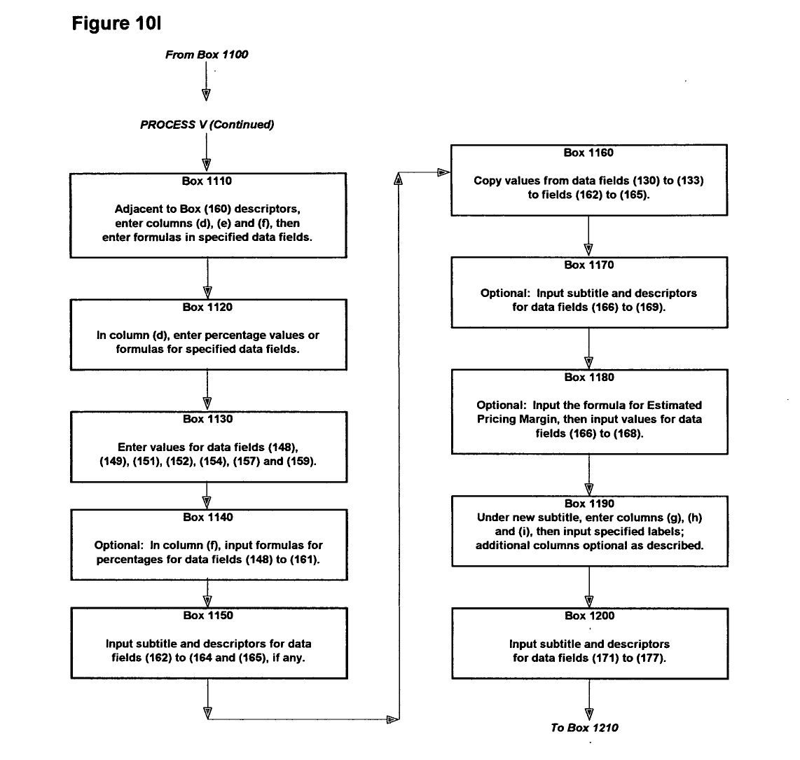

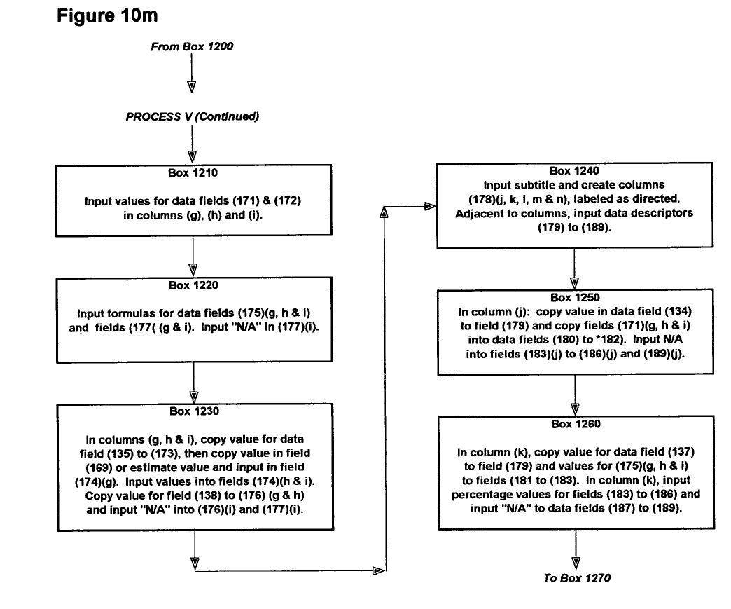

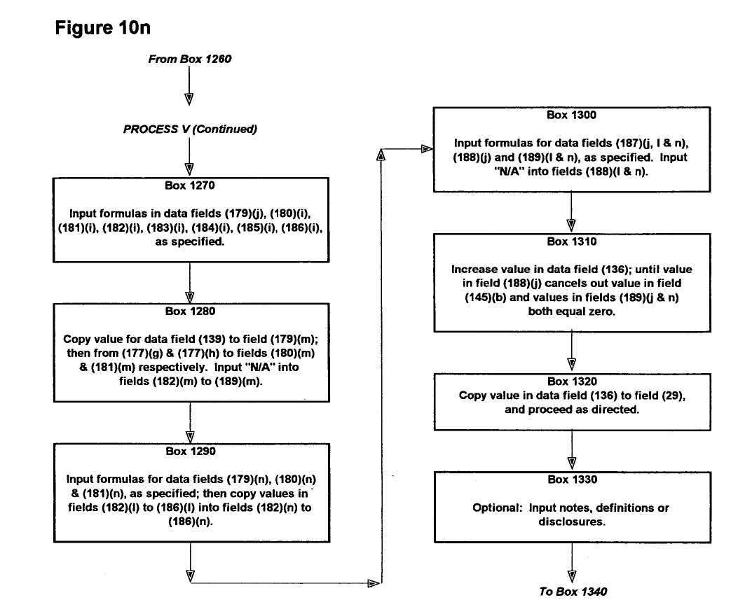

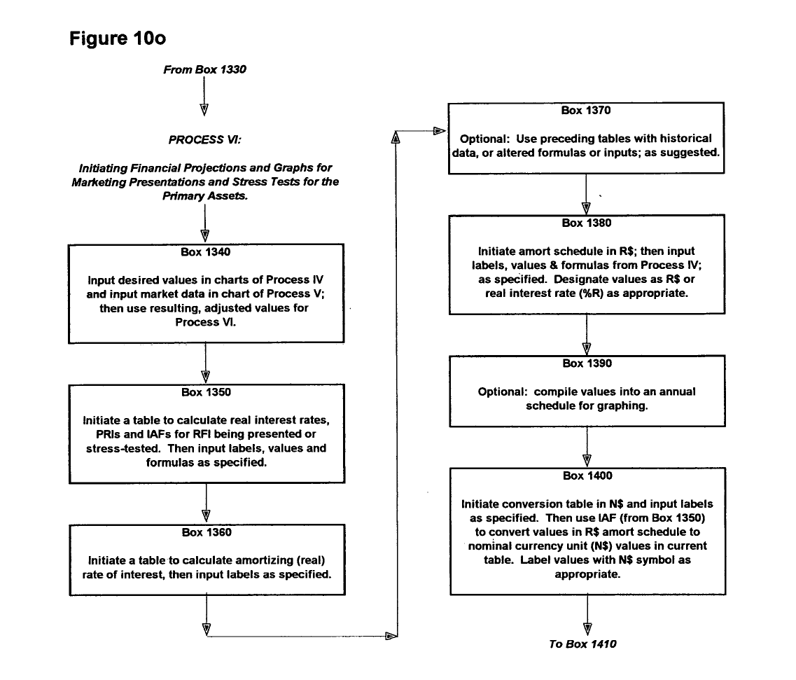

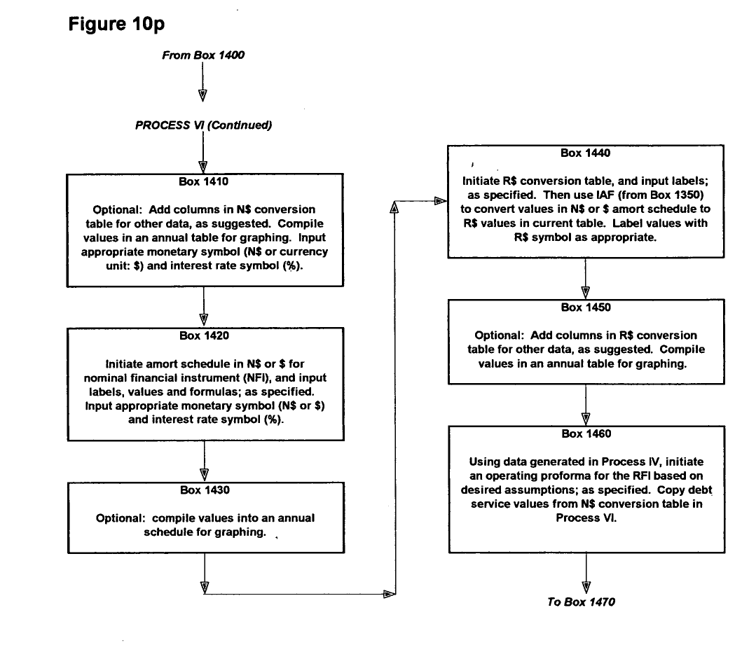

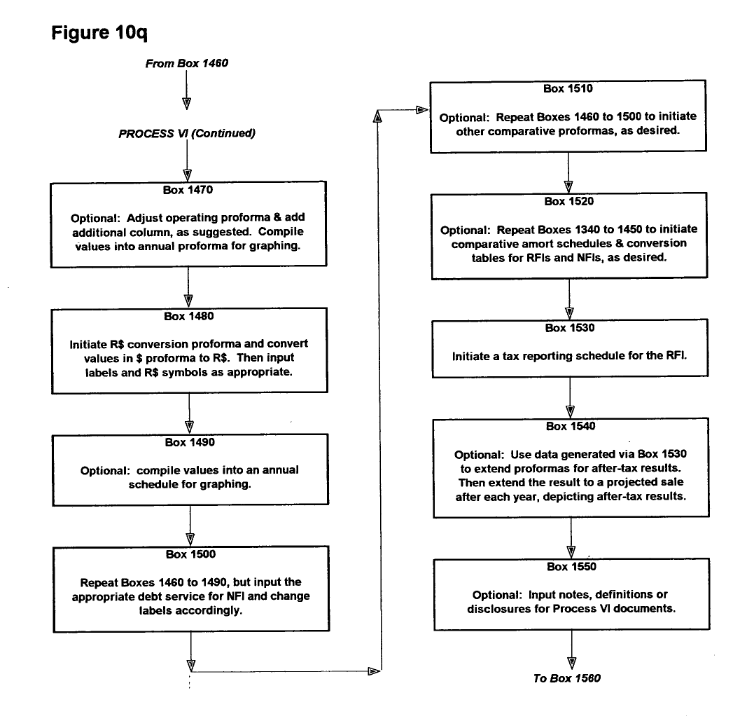

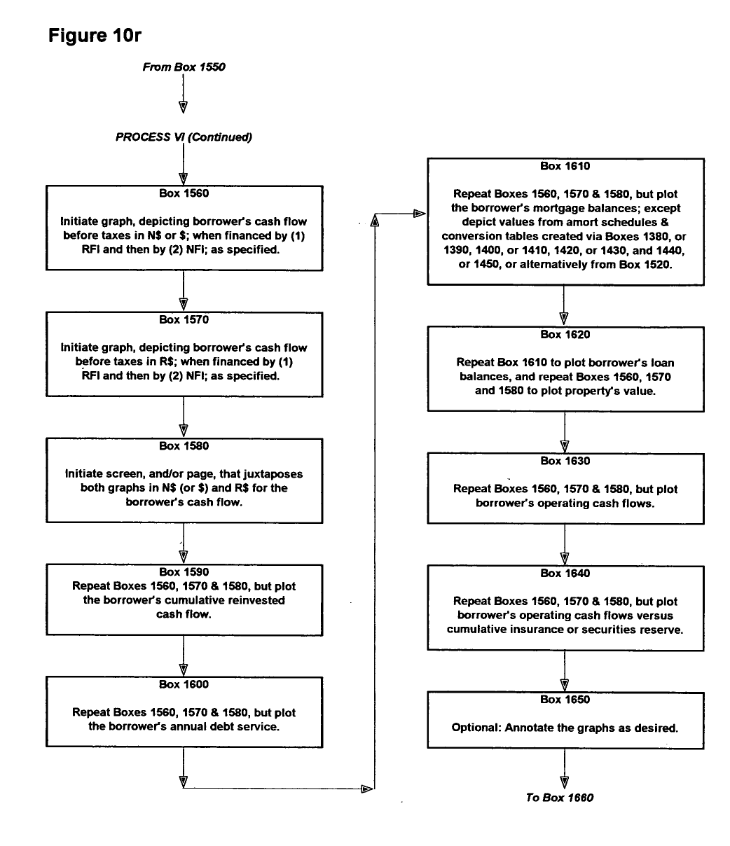

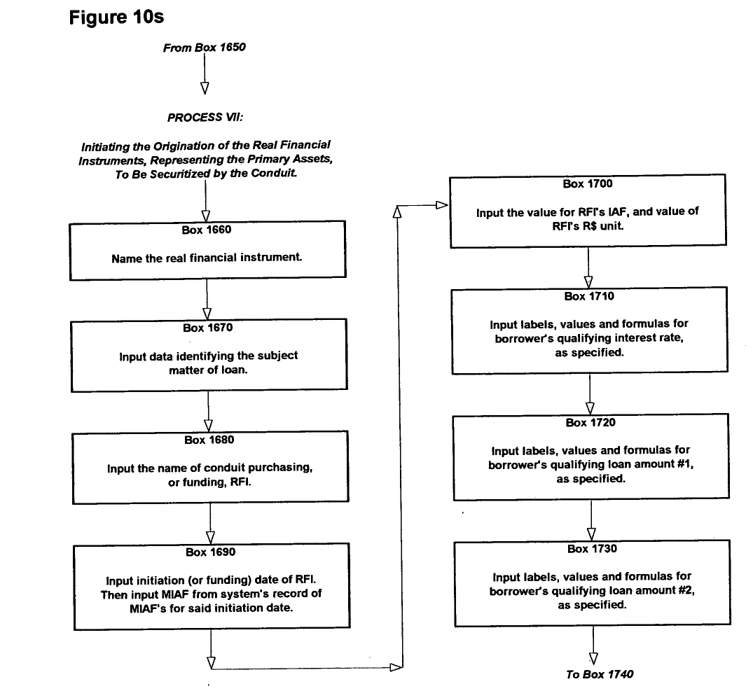

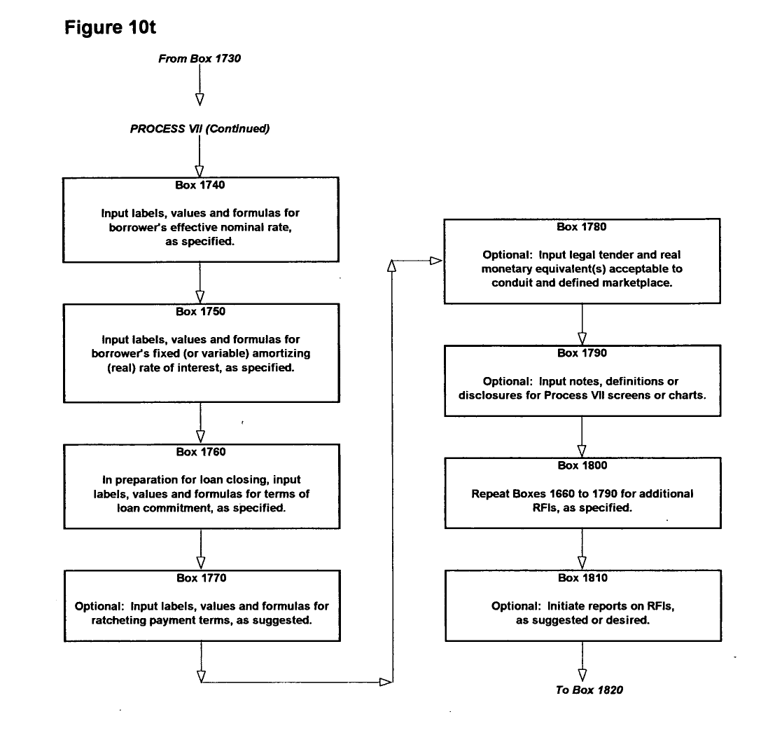

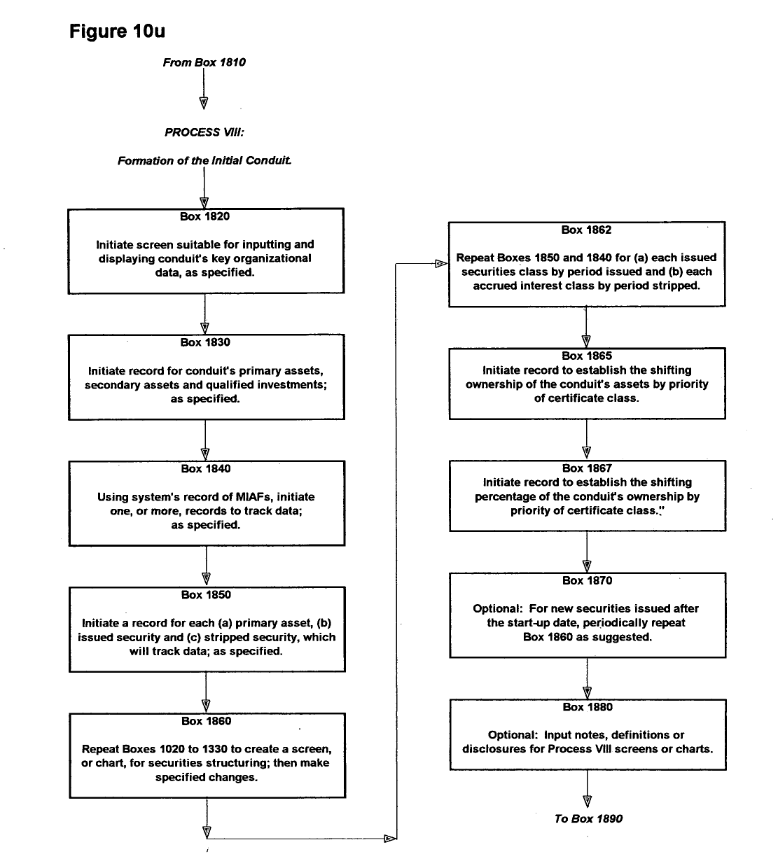

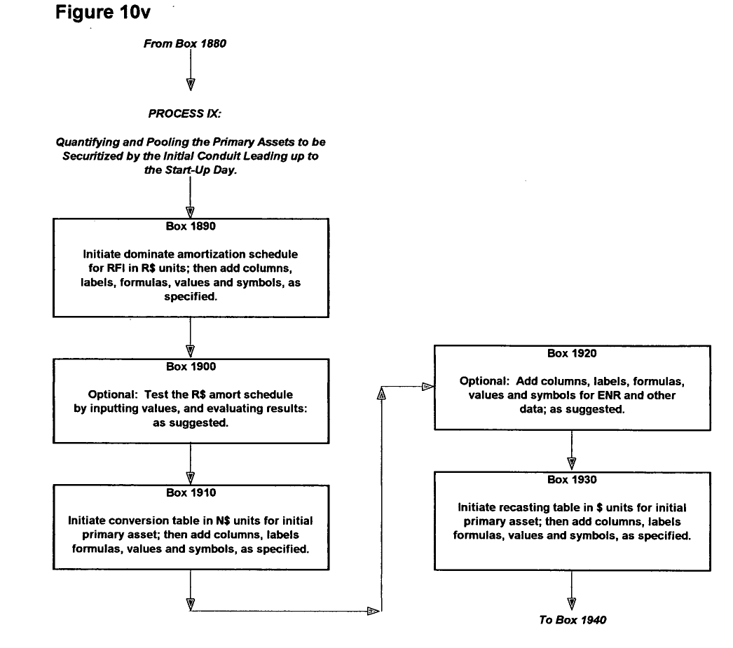

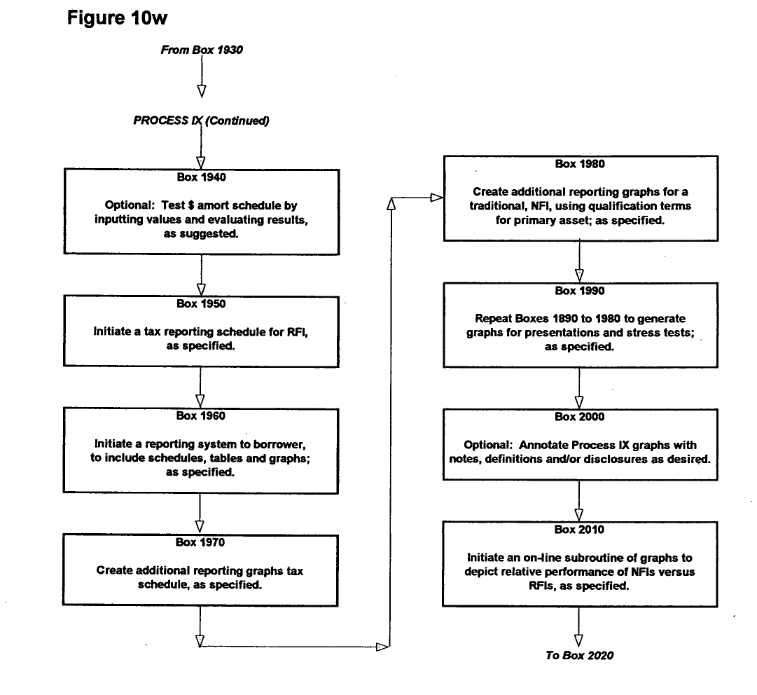

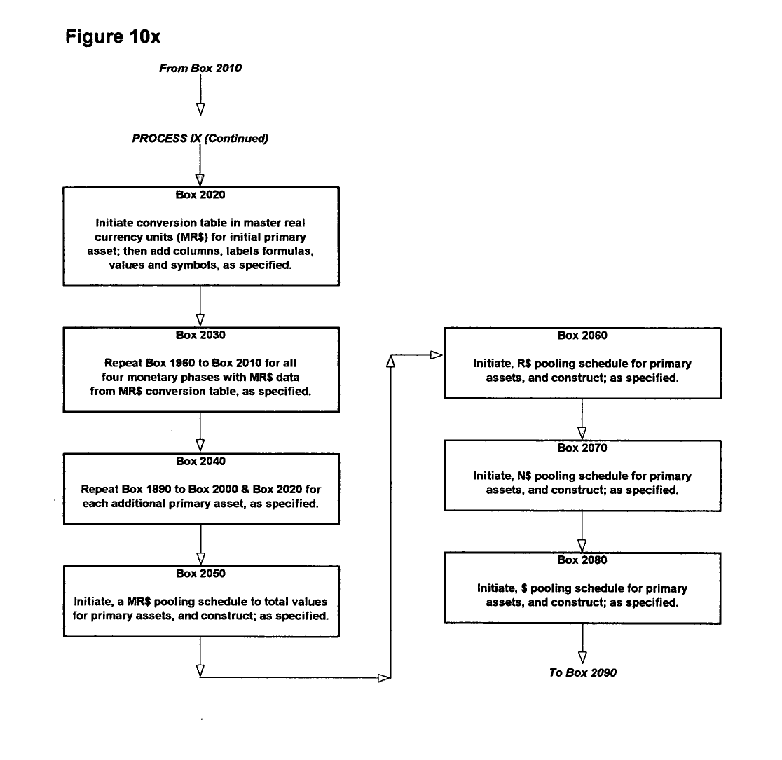

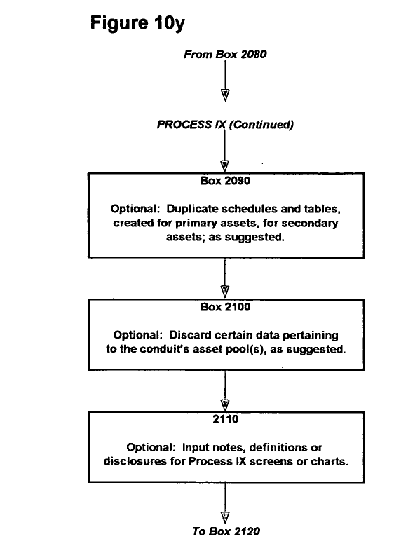

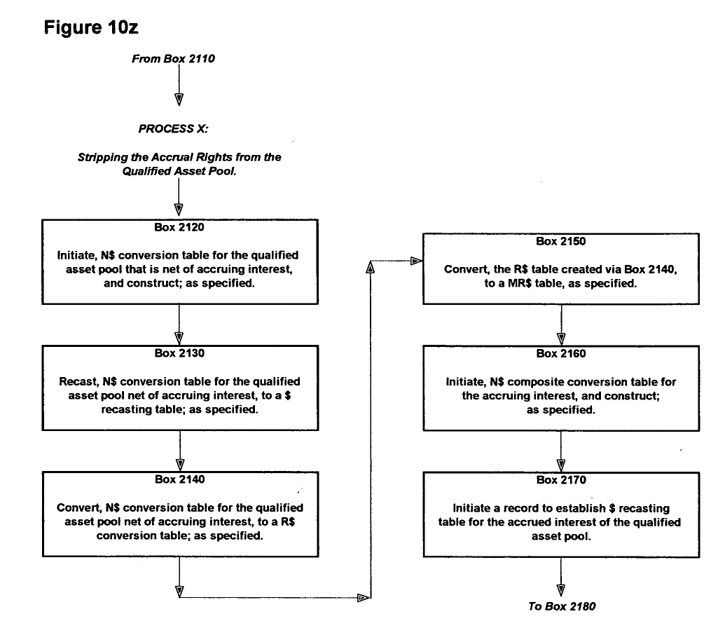

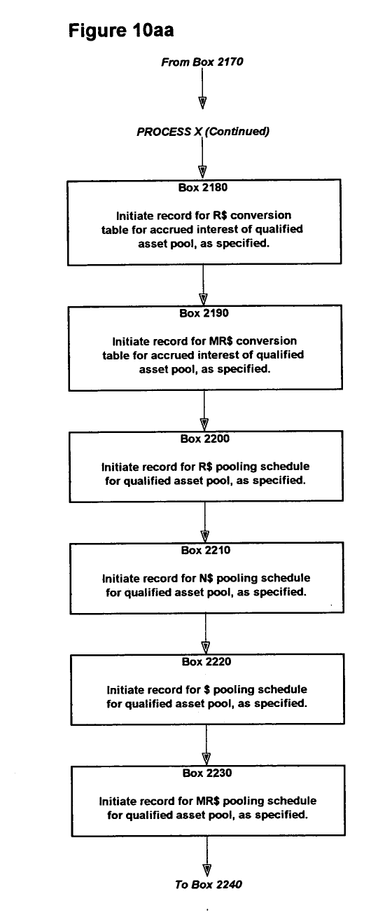

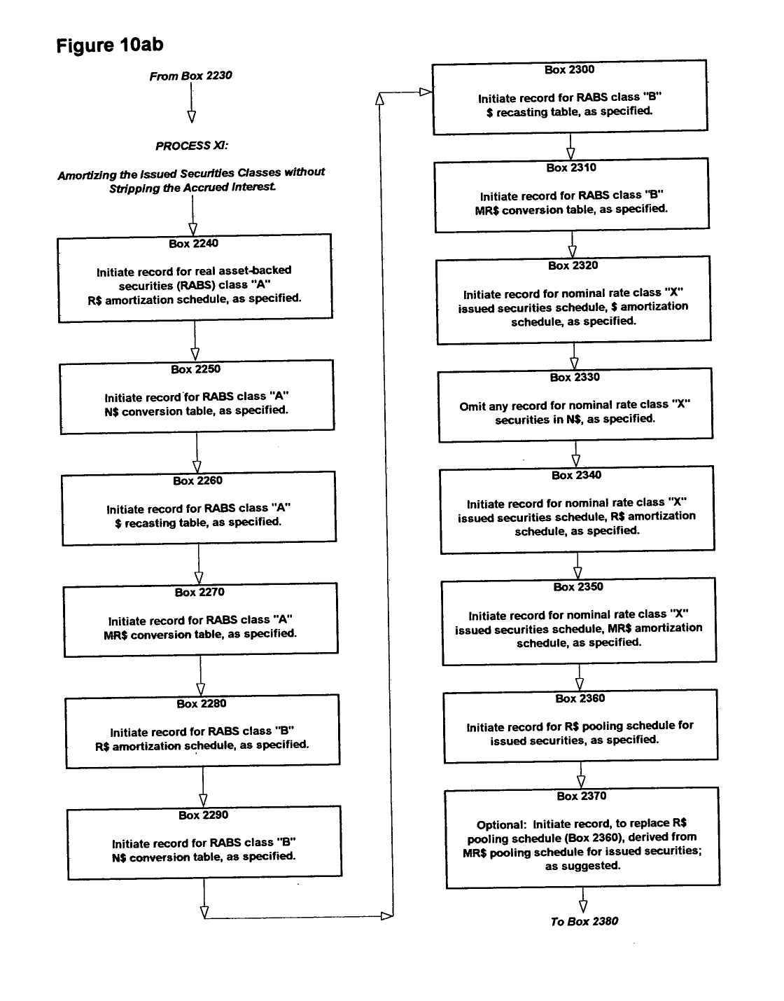

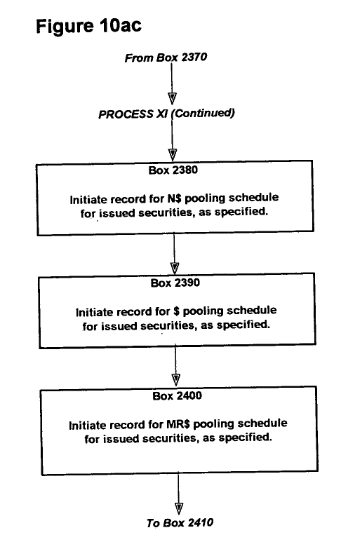

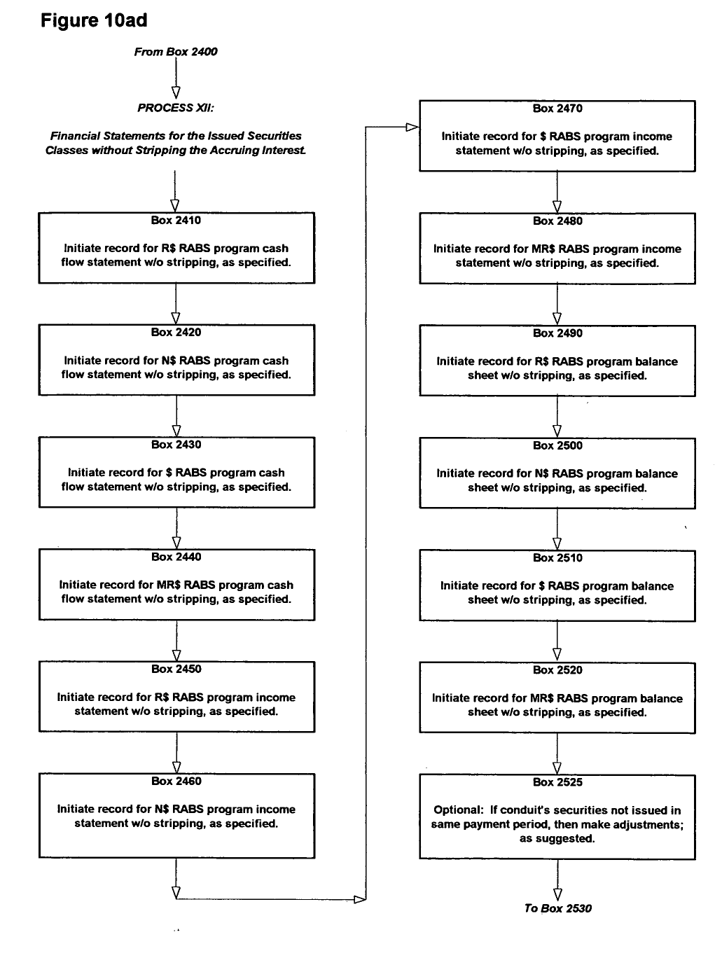

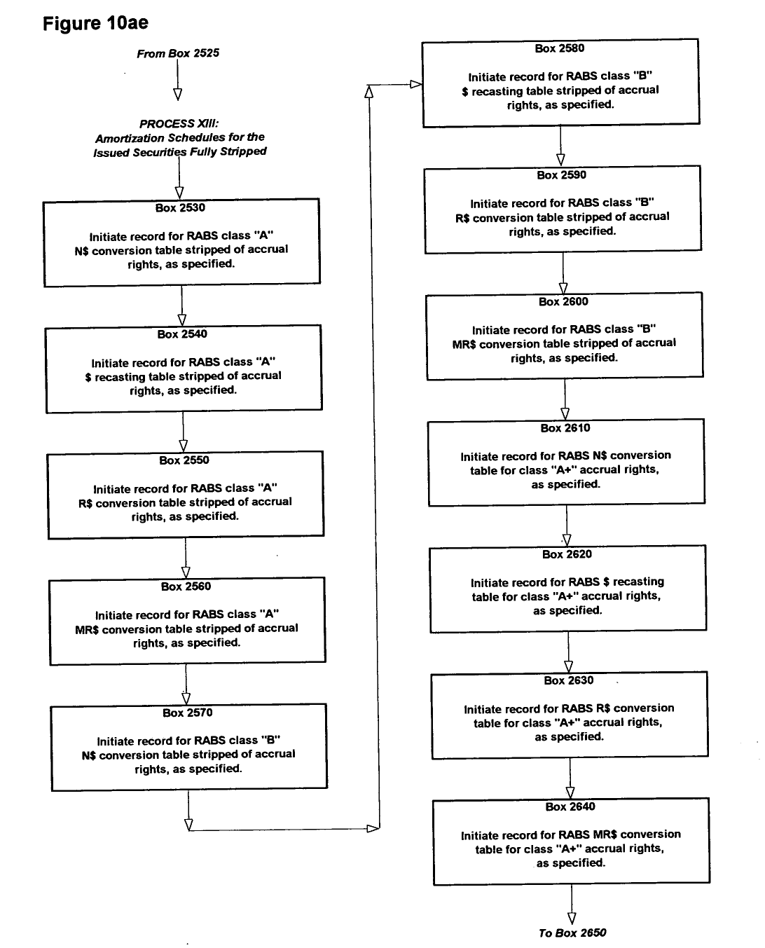

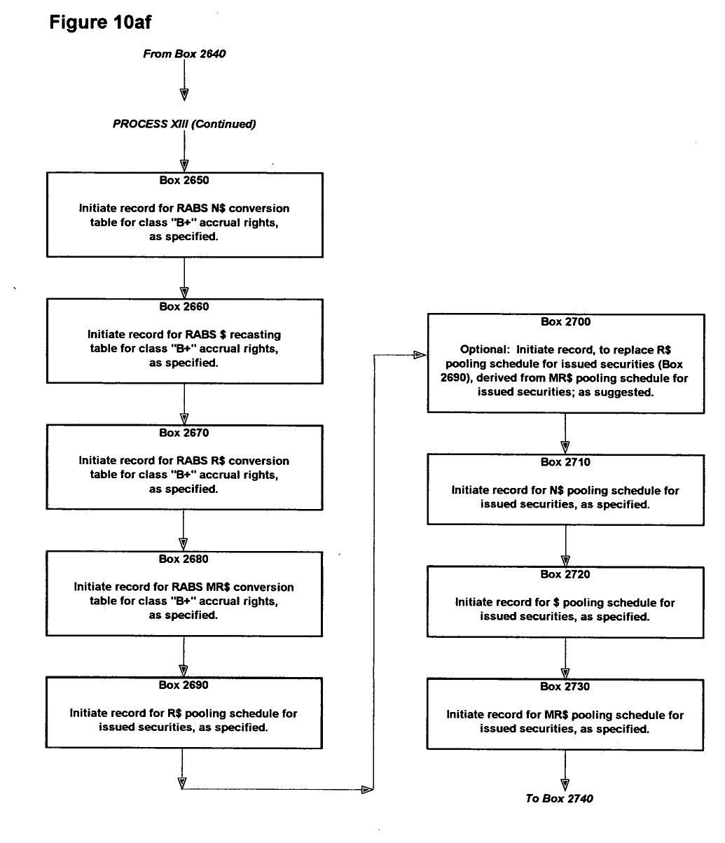

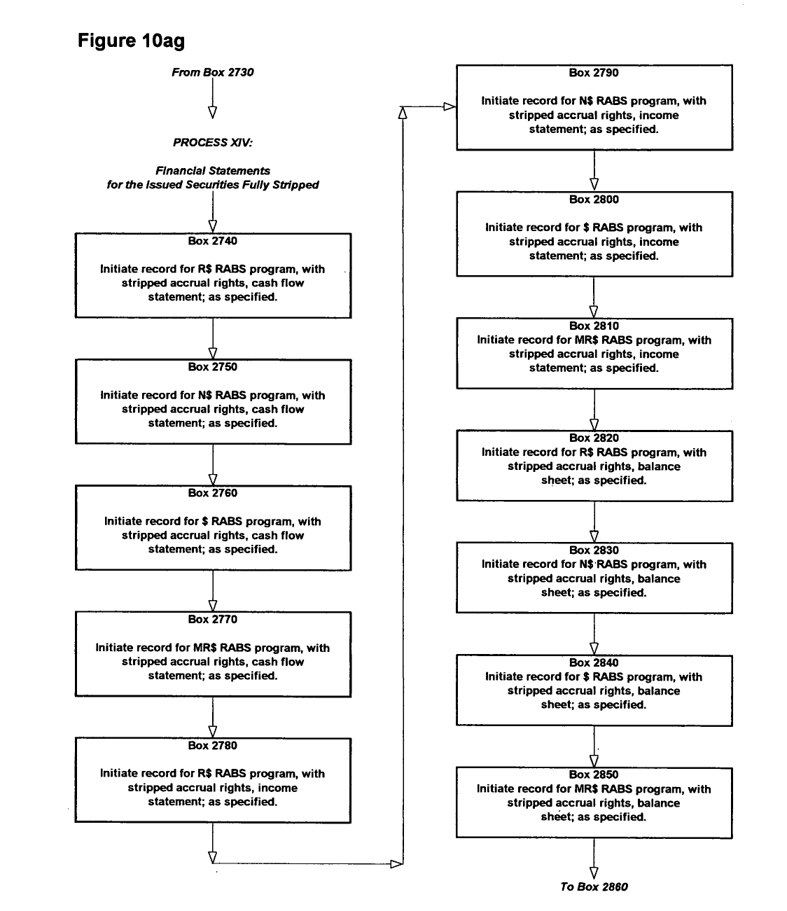

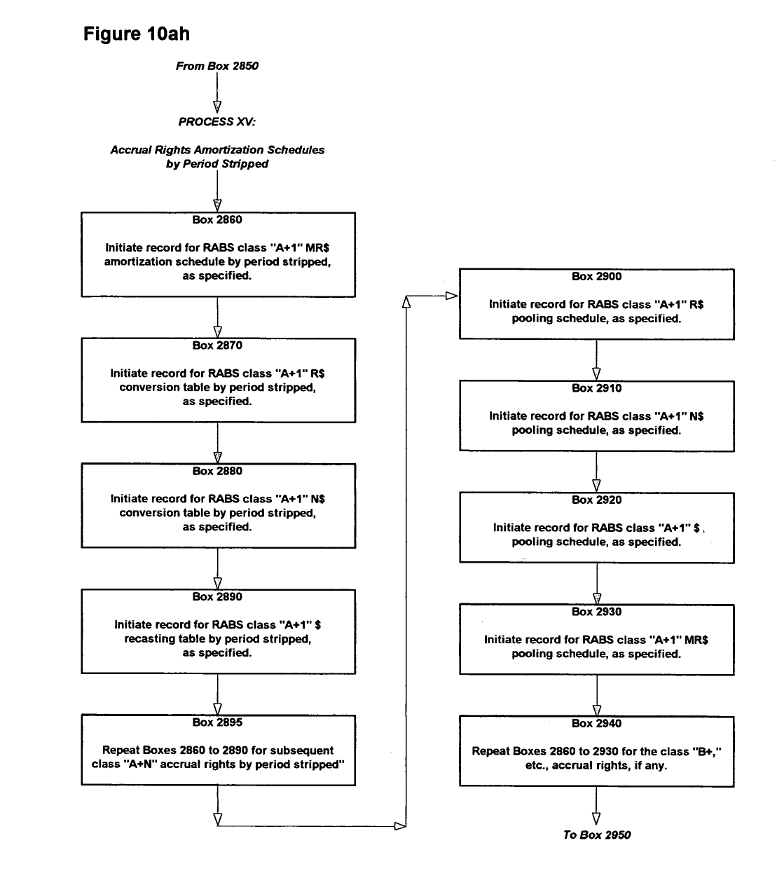

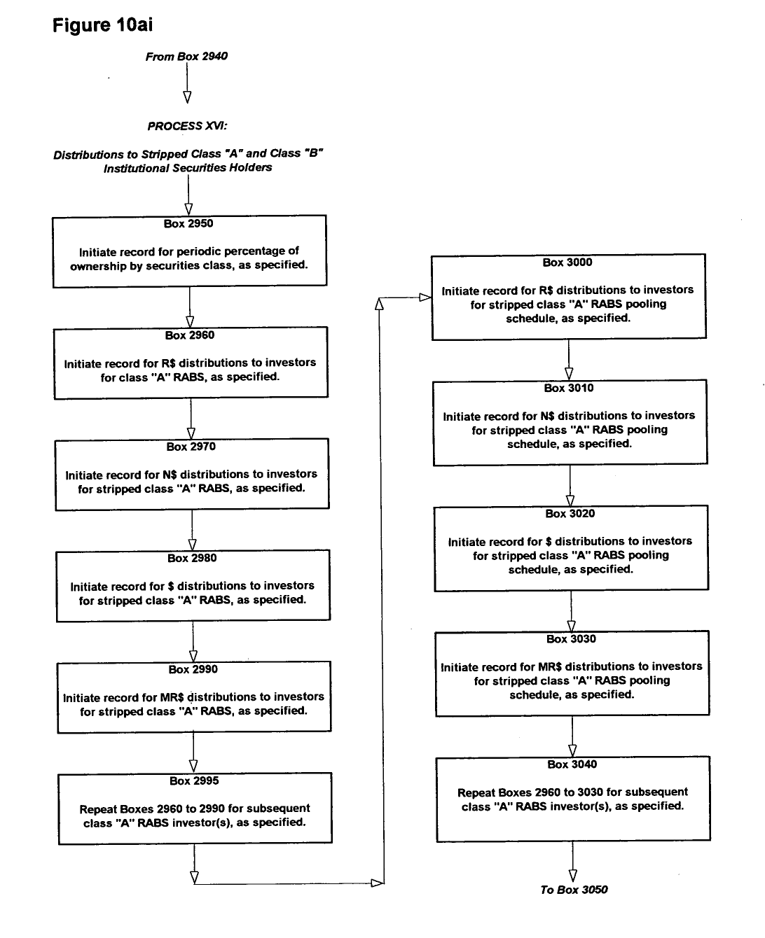

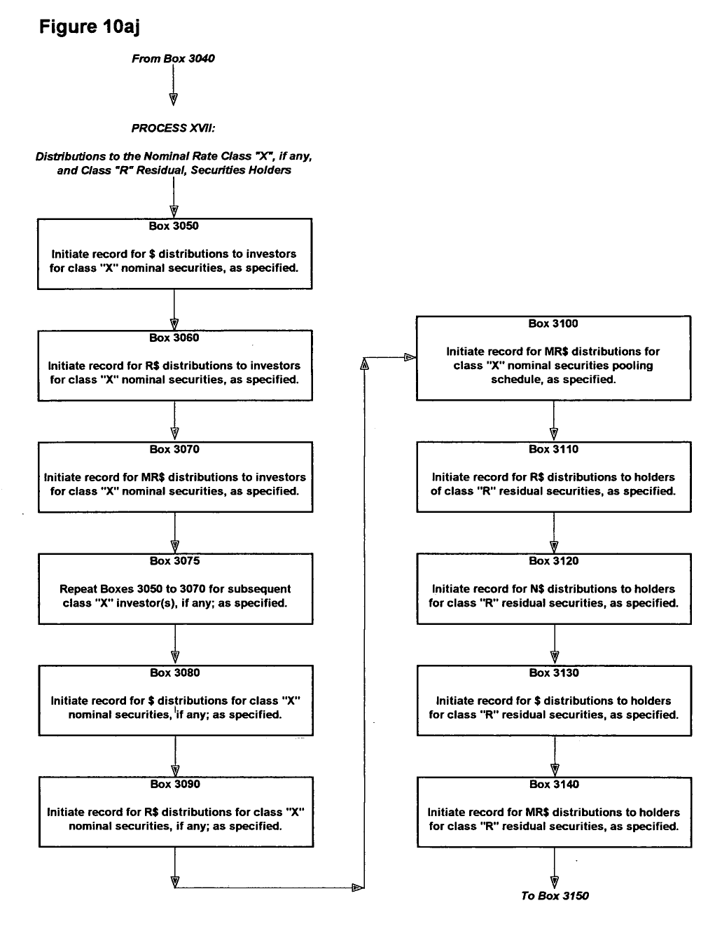

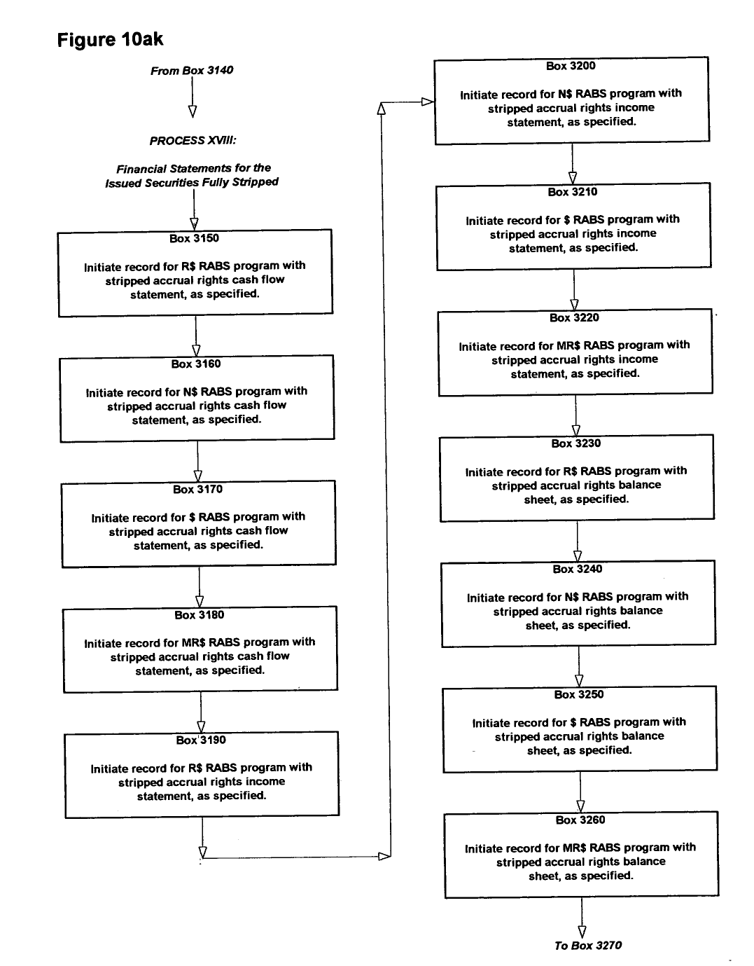

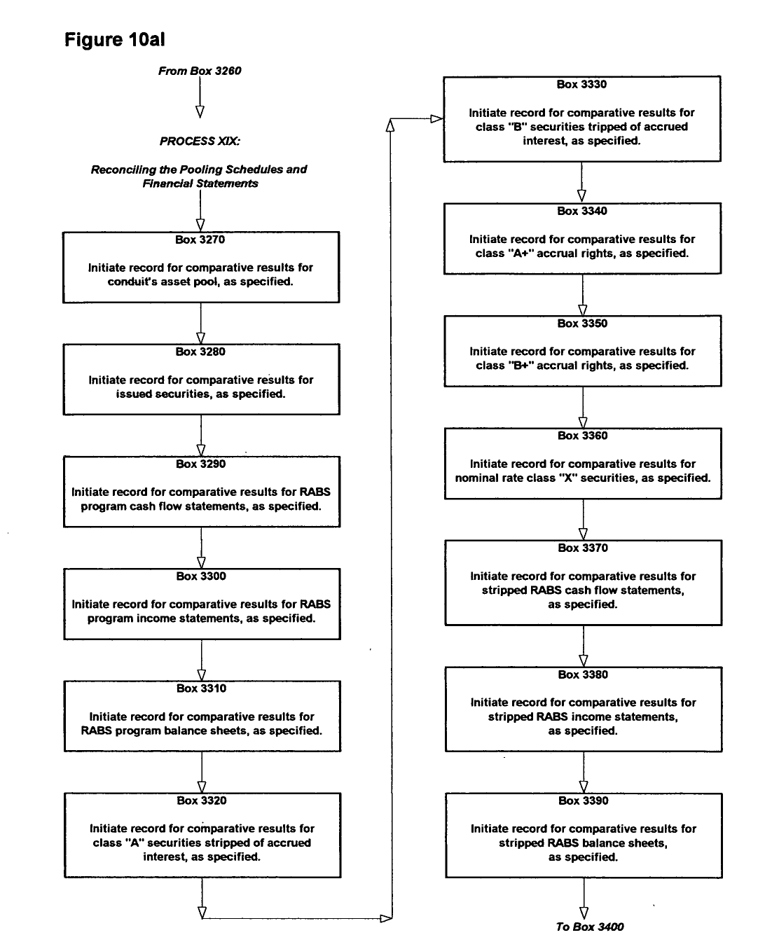

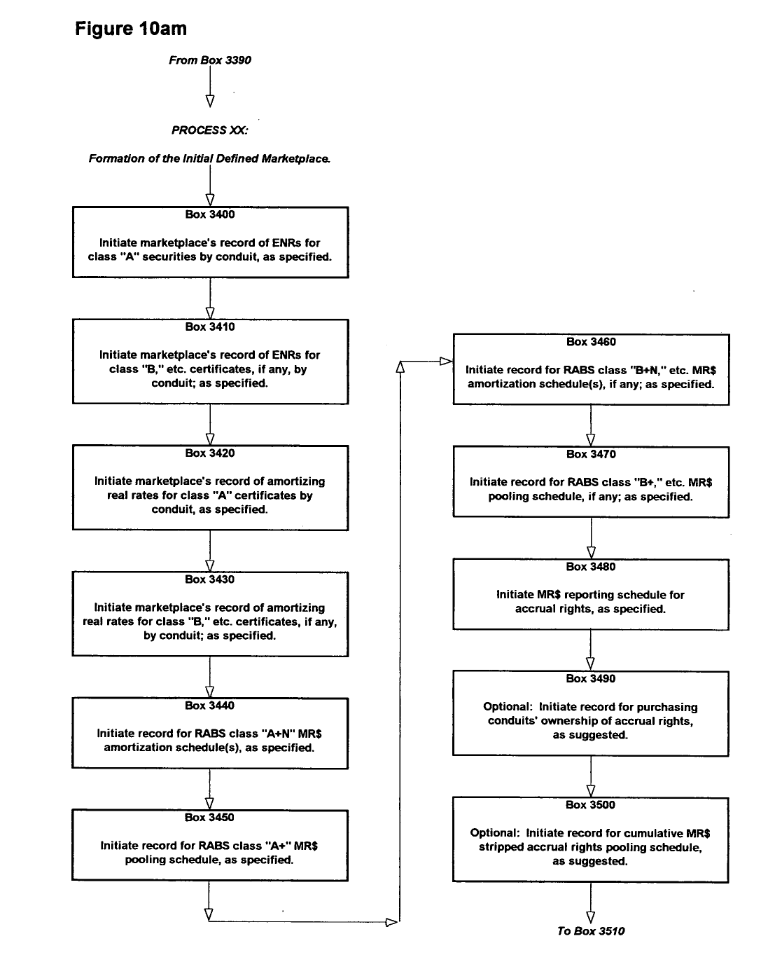

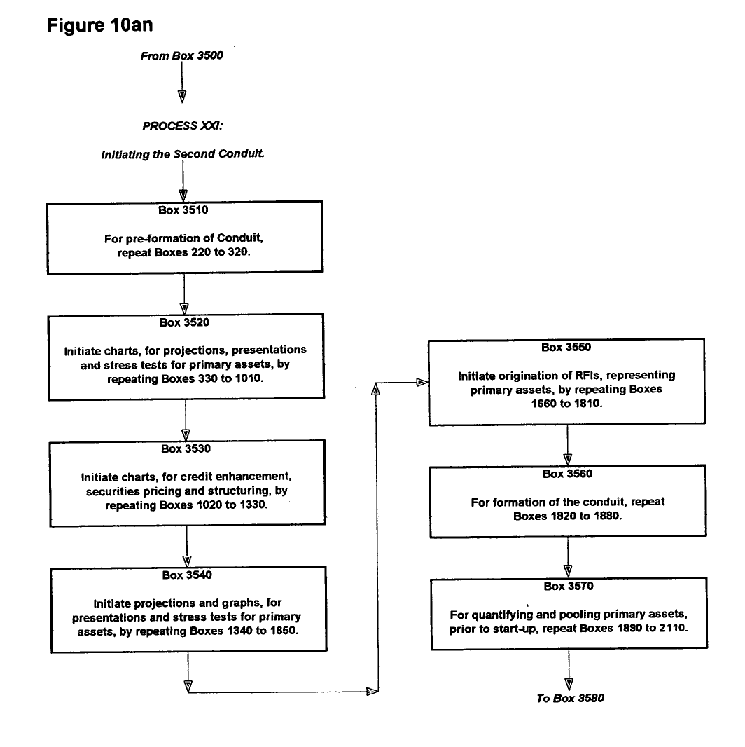

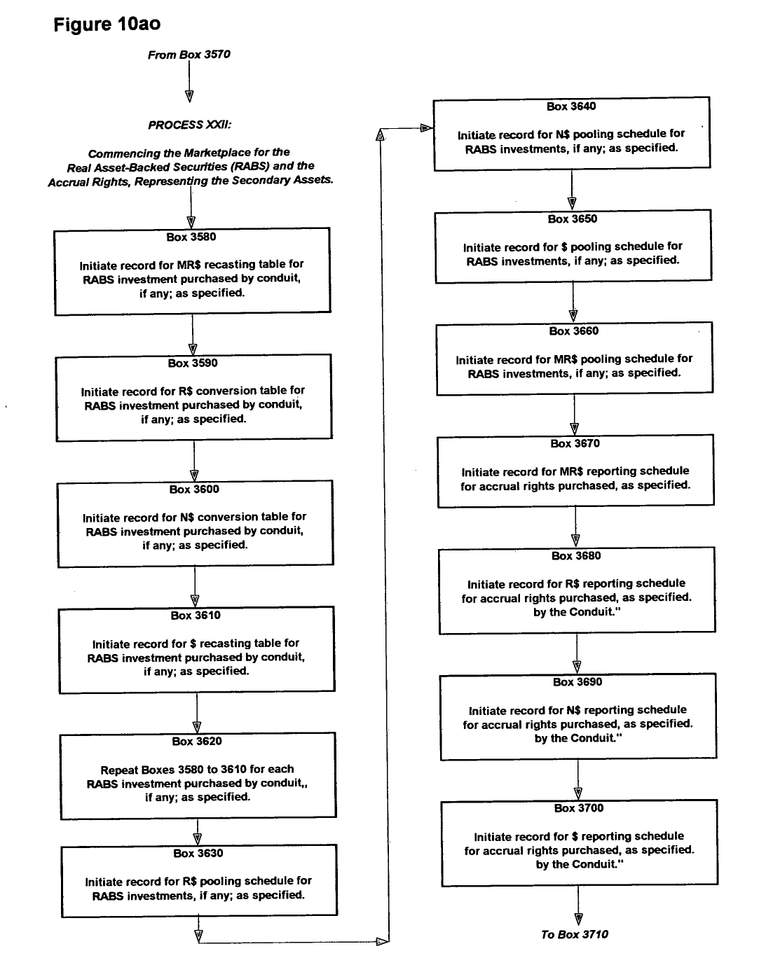

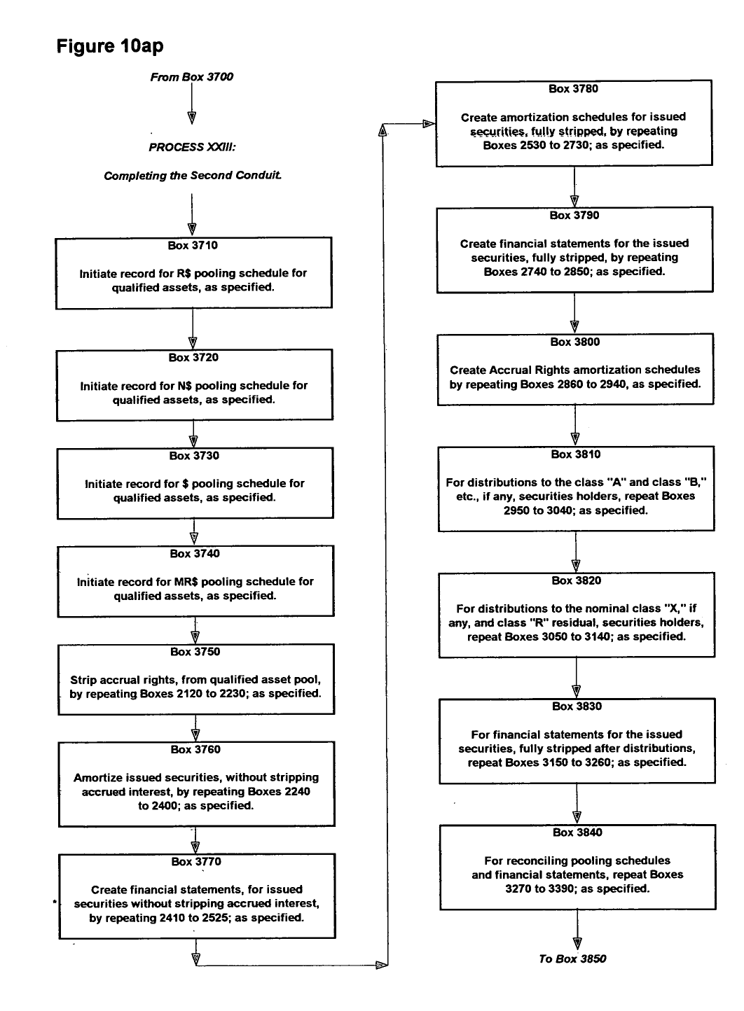

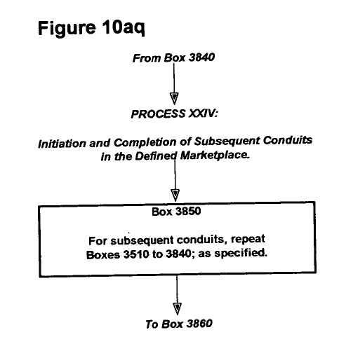

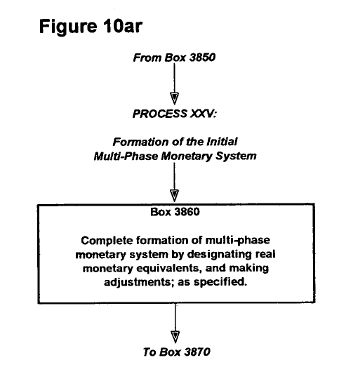

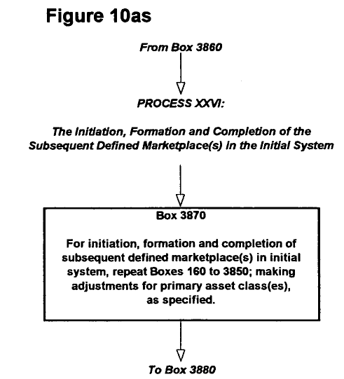

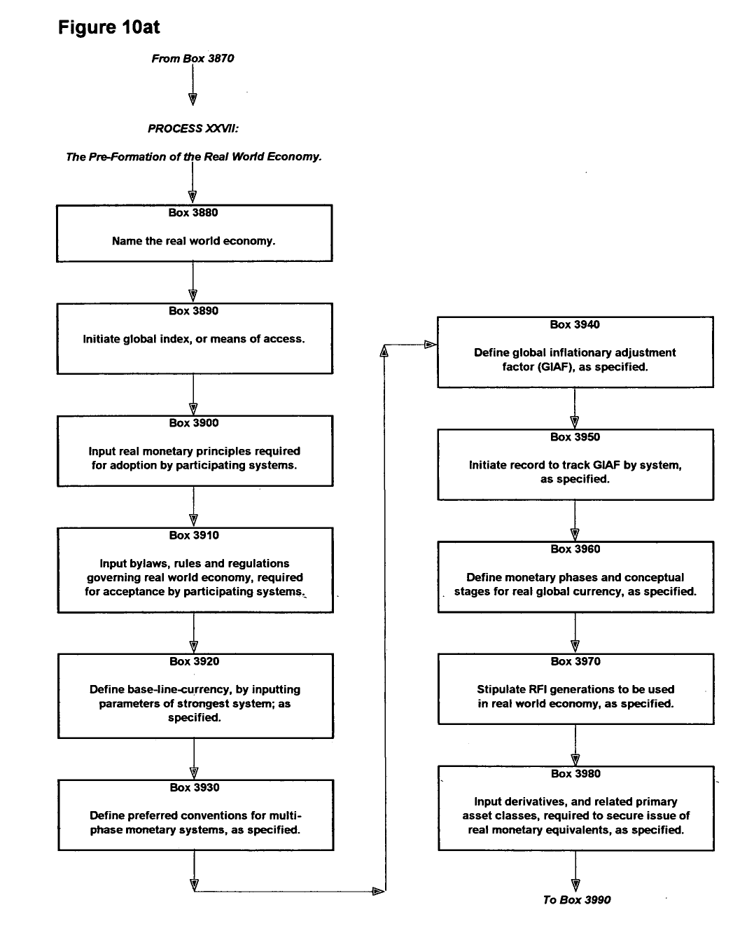

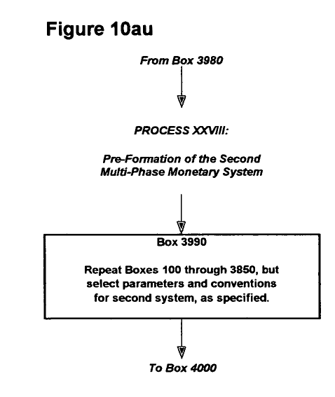

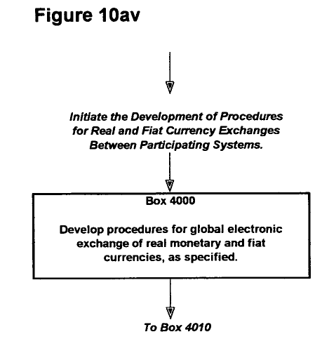

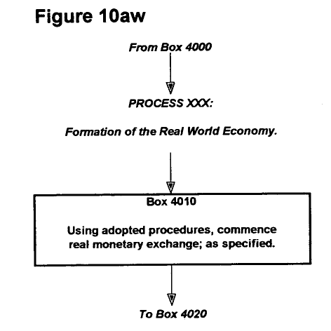

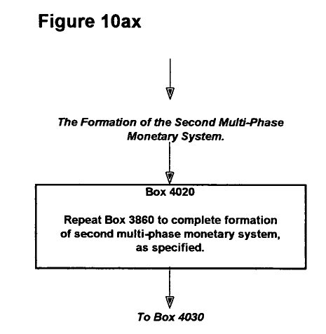

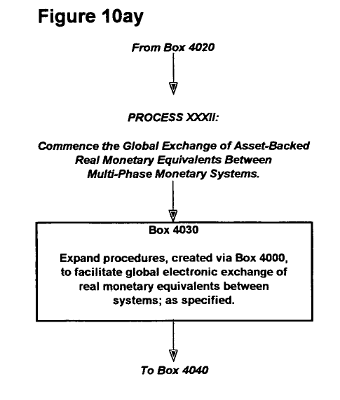

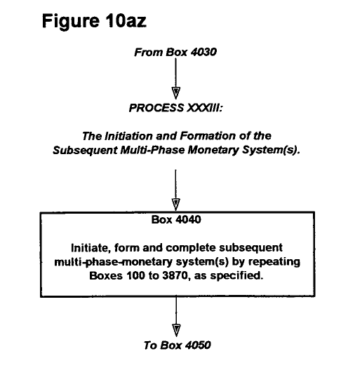

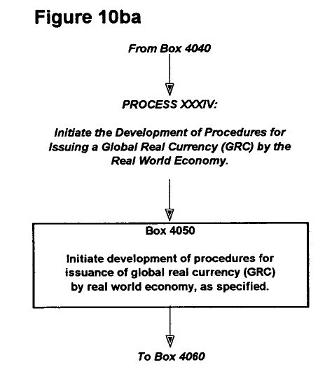

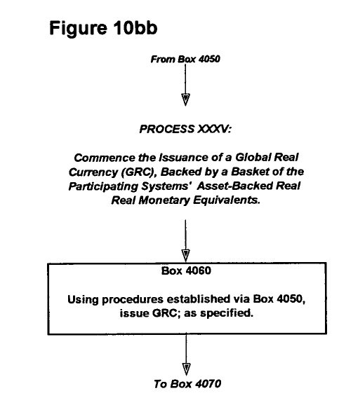

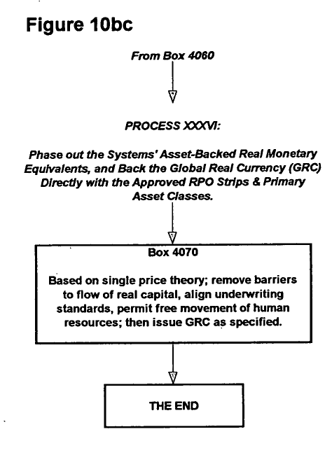

I. Other Introductory Figures (or Tables):
Background of the Invention: Related materials can be found in Tables 1 through 14.
Summary of the Invention: Related materials can be found in Tables 15 through 30.

### IV. DETAILED DESCRIPTION OF THE PREFERRED EMBODIMENTS

Introduction: Economics by Other Means

The introduction of real financial instruments creates an interesting dichotomy, which is crucial to understanding what is required to facilitate the paradigm shift from nominal financial instruments to real financial instruments in the marketplace. This dichotomy is defined by the dynamic tension between theory and application; between the intellectual task of defining and verifying the different aspects of real monetary theory, versus the practical task of developing and implementing a coherent strategy for the introduction of real financial instruments into the nominal monetary marketplace. This dynamic tension is akin to the preparations for war, just prior to the opening hostilities. The generals are debating military theory, while the master sergeants are planning the supply lines. Who is to say which task is more important? Yet, theory and application must be unified to achieve success.

By 1997, the governments of the world's most sophisticated economies had issued real bonds that were self-adjusting for inflation, yet such instruments are almost non-existent in the private sector. Great Britain first issued real bonds in 1981, and the United States Treasury followed in 1997 by issuing $40 billion in Treasury Inflation Protection Securities (TIPS) in approximately 12 months. Each of these governments has announced that they are pleased with these instruments, and that they intend to sell as many real bonds as the market will bear. Yet, very little is happening in the private sector. In 1989, the U.S. Department of Housing and Urban Development (HUD) announced its intention of offering price-level-adjusted-mortgages (PLAMs), but the marketplace still lacks any such instruments for residential or commercial-investment properties or any other asset class. While it is not surprising that the banking industry has shown little interest, since it is a regulated cartel; even the securities industry, with an aggressive record for adopting new theories, strategies and instruments, has largely failed to offer such instruments in the private sector. And the few offers that have been made by firms like J.P. Morgan, have met with a tepid response.

In fact, the introduction of real financial instruments into the nominal monetary marketplace represents nothing less than a monetary revolution. To paraphrase Karl von Clausewitz, if war is politics by other means, then real monetary theory is economics by other means. Politics and economics are the building blocks of the power structure in any society, so any challenge to either will not succeed easily. No matter the righteousness of the cause, no one likes to surrender their power base. Nor should any general attack the enemy's power structure in a frontal assault. The cost would be too high, and the probability of success to low. In economic terms, the risk/reward ratio is just not there.

This creates an interesting dichotomy, a dynamic tension, between real monetary theory, which can change the nature of economics; and the practical introduction of real financial instruments, which can appear threatening to the existing economic and financial power structure. It is this dichotomy, between theory and application, that creates the challenge that will be addressed by this patent application and answered by the invention, Real Monetary Software™.

Real monetary theory strongly supports the assertion that real financial instruments will substantially resolve society's inflationary and deflationary problems, thereby curbing the financial waste, desolation and poverty left in their wake. Certainly, we must consider the study of real monetary theory to be embryonic at this time, but the further expansion of real monetary theory requires the implementation and testing of real financial instruments in the marketplace. Given the existing economic and financial power structure, this is easier said then done. For the traditional practice of using nominal financial instruments in the marketplace is so pervasive, going beyond monopolistic to monolithic in nature; that the general acceptance of real financial instruments is problematic at best, and seemingly impossible at its worst. So, how does one breach a monetary monolith?

One begins by understanding the nature of the monolith, and by recognizing that its greatest strength may also be its Achilles heel. The challenge is to breach the monolithic nature of our nominal currencies, and the financial instruments, institutions and governments that are founded upon them. The most fundamental aspect of this monetary monolith is best described by Adam Smith's invisible hand. Participants in the marketplace are driven by the singular, virtually overwhelming, quest to maximize their financial position; which is measured in nominal monetary units. The one with the most loot, wins the game of life. But for most of us, this is a very serious game; even a matter of survival. In fact, the drive for material gratification can be just as strong as the drive for sexual fulfillment, since each in their own way represent both the challenge and affirmation of life . . . at least, for most of us.

So, the idea of shifting one's monetary strategy, based upon a mere theory, is untenable to most; perhaps even unthinkable. At the same time, the use of a currency unit, representing an abstract concept, is a social contract. This is especially true of the fiat currency unit issued by the government, which has no intrinsic value; only the firmly held belief and trust that others will accept this currency unit in exchange for goods and services that do have an intrinsic value. For many people, institutions and governments, in Asian countries over the past eighteen months, this trust has been rudely shattered. Nonetheless, one cannot begin to shift the terms of this monetary contract alone without receiving some level of acceptance from one's peers in the marketplace.

However, we can resolve the dynamic tension between theory and application by utilizing the marketplace's monolithic quest for the fiat currency as a Trojan Horse. We can do this by demonstrating the profitability of using real financial instruments by presenting the results in traditional, nominal monetary units. In so doing, we have fulfilled our social contract to society, while introducing the use of real financial instruments at the same time. We have also converted the monolithic quest for material affirmation into a distribution vehicle for real financial instruments, defined in real terms but then converted to the nominal, fiat currency for actual payment. Having structured our assault accordingly, we can then depend upon Adam Smith's invisible hand to shift the market's paradigm from nominal to real terms over time.

How can we be so certain? As it turns out, there is another historical financier that has commented on this situation. His name was Sir Thomas Gresham, and he was a merchant and financier in England in the sixteenth century. At one point, he was master of the mint during the reign of Queen Elizabeth I, when she asked him about the advisability of issuing a dual currency. His advice became a theory in economics known as Gresham's Law, which states that bad money will drive good money out of the marketplace. But why would this happen? The answer, of course, is Adam Smith's invisible hand. Gresham observed that in a dual currency situation, whereby one currency held its value against inflation, such as gold, while the other currency could not hold its value, such as paper currency; that people would hoard the gold and spend the paper currency. Adam Smith could not have predicted the outcome better, since each participant in the marketplace is doing what is in his or her own best interests.

The crux of our problem is that we must accept the nominal, fiat currency unit as the recognized measuring stick for material gratification, until the paradigm has shifted and people begin to recognize the real currency unit as the “good” currency. Should we be concerned that people will hoard the real currency unit, once it is recognized as the good currency? No, this is not a problem, since it only suggests that there will be an insatiable appetite for the real currency unit as it becomes established as the good currency. Can a new currency unit succeed without being circulated? This will not be a problem, since a sufficient amount of the good currency unit will reverse Gresham's Law; and drive the bad currency from the marketplace. This is especially true, since the successive issuance of a real currency, if asset-backed, will be inflationary to the existing fiat currency, unless it is properly recalled from the marketplace. In either event, this would only promote the greater use of the real monetary unit.

In addition, consider the application of Gresham's Law to any other product. Never, in the history of any class of products, has a bad product defeated a good product in open competition; unless there was a shortage of the good product, which is then hoarded. This occurred with cabbage patch dolls, and beanie babies, until a satisfactory supply was offered to the marketplace. The problem, that governments have, is that there is not enough gold to back the world's money supply, which is why dual currency situations were governed by Gresham's Law. As we shall demonstrate in this patent application, it will be possible to generate a substantial asset-backed real money supply, which will ultimately drive the nominal currency from the marketplace. It will also become obvious that the distribution of an asset-backed real money supply is the logical outcome of the introduction and acceptance of real financial instruments in the marketplace.

We have addressed the introduction of real financial instruments into the marketplace, but what about the theory behind them? Real monetary theory is relatively straight forward, since it is based upon certain fundamental and undeniable principles, which include:

### Real Monetary Principles

(1) Money begins as an abstract concept that represents purchasing power.
(2) The primary function of any monetary unit is to maintain a constant and consistent level of purchasing power.
(3) If the monetary unit maintains a constant and consistent level of purchasing power, then it can properly perform the secondary functions of acting as a medium of exchange, a unit of account and a store of value.
(4) In order to succeed in maintaining a constant and consistent level of purchasing power, the monetary unit must be able to function in four-dimensional space; which is to say, over time.
(5) In order to maximize society's economic benefits without jeopardizing the monetary unit's primary function; any substantial distribution of the monetary unit must be backed by a tangible asset, that is self-adjusting for inflation and deflation.
(6) Inflation and deflation are the result, not the cause, of the monetary unit's failure to maintain a constant and consistent level of purchasing power.
(7) Monetary units, that only function in three-dimensional space, violate the Concept of Whole Numbers; thereby causing inflation and/or deflation.

Just how does the destruction of our money supply happen? It happens when our nominal, fiat currency unit fails to properly function as a medium of exchange, a unit of account and a store of value, because it does not have a constant and consistent level of purchasing power over time. Which is to say, that the nominal, fiat currency unit creates inflation and/or deflation by violating the Concept of Whole Numbers, which is the foundation of simple arithmetic. The simple act of adding one plus two, plus three . . . assumes that we are adding whole units, but what if the relative purchasing power of these units is inconsistent over time? If we are adding, subtracting, multiplying and dividing with currency units that cannot maintain a constant and consistent level of purchasing power, then our calculations can yield volatile and potentially meaningless results. By violating the Concept of Whole Numbers, the nominal, fiat currency unit fails to perform both its primary and secondary functions, thereby causing inflation and/or deflation.

For many people, this is difficult to comprehend, since our currency units appear to have a constant value in the short-term, say one day or one week. It is only over longer time periods, that the purchasing power of our fiat currency units can shift; but even then one fiat currency unit will equal one other fiat currency unit at any point in time. The problem arises when money is borrowed in one time period, and then repaid in a later time period. Now our analysis has shifted, from the three-dimensional space of a single time period, to the four dimensional space spanning two separate time periods. Which is to say, that time becomes a relative factor in our calculations. We require not only a constant level of purchasing power in any given time period, but we also require a consistent level of purchasing power between time periods; hence the term “constant and consistent.” For instance, if an investor purchases a 30-year bond in 1965, will he or she be repaid in 1965 dollars or 1995 dollars? The relative difference in the purchasing power is about 78%, which is important since money is supposed to represent purchasing power.

This can be demonstrated further by contrasting the capabilities of our scientists and engineers versus our economists and financial professionals. Our scientists and engineers can launch a rocket on a twenty-year to a celestial body and hit their target, but our economists and financial professionals cannot tell you what the purchasing power of our nominal, fiat currency unit will be twelve months from now. The reason is simple. Our scientists and engineers are capable of projecting the rocket's trajectory in four-dimensional space. When the trajectory is determined, it is not aimed at the current location of the celestial body, but rather where the celestial body will be when the rocket arrives. At the same time, our economists and financial professionals are still relatively blind to four-dimensional space, since they lack the tools to plot the financial trajectory, or payment streams, of intermediate to long-term financial obligations. While the nominal, fiat currency may have a constant value in any given period of time, or three-dimensional space; it does not have a consistent value from one time period to the next assuming any level of inflation or deflation.

In summation, real monetary theory begins with the fundamental realization that money is an abstract concept that is supposed to represent purchasing power. It holds that the primary function of any monetary unit is to maintain a constant and consistent level of purchasing power. In essence, it must be able to perform in the fourth dimension, which is to say, over time. It recognizes that the failure of the monetary unit, to maintain a constant and consistent level of purchasing power, will destroy the monetary unit's ability to function as a medium of exchange, a unit of account and a store of value. It finds that inflation and deflation are not the cause of this monetary destruction, but rather the symptoms of the greater problem. Meaning that, we cannot directly cure inflation and deflation, which are monetary ghosts; but we can relatively eliminate the destructive effects on our money supply by insisting on the distribution and use of a monetary unit that will fulfill its obligation in maintaining a constant and consistent level of purchasing power.

In recognizing that the fiat currency unit, with an arbitrary purchasing power over time, destroys the fundamental uses of money, real monetary theory calls for the use of real financial instruments that are self-adjusting for inflation and deflation. It recognizes further, that the issuance of real financial instruments based upon an abstract real currency unit that is not properly backed by an asset that is self-adjusting for inflation and deflation, is in itself another fiat currency unit that is ultimately doomed to failure.

The historical evidence for this failure was the issuance of “gold bonds” in the United States between the late 1900s and 1933, which agreed to pay, at the holder's option, either gold or nominal currency as a hedge against inflation and deflation. When President Franklin Delano Roosevelt took office in 1934, he wanted to inflate commodity prices to help the farmers. So, FDR had congress pass a law outlawing the holding of gold bullion, which effectively released the corporate and government-issuers from paying the bond holders in gold. Then he devalued the dollar by 40%, which inflated commodity prices and generated a profit in excess of $2 billion for the U.S. Treasury. While the Supreme Court found the new law unconstitutional with respect to the government's gold bonds, it was upheld for the gold bonds issued by corporations. FDR's advisors stated that there really was no alternative, since there simply wasn't enough gold to meet all of the possible claims. At least one historian has estimated that there was in excess of $100 billion in corporate and government gold bonds outstanding by 1934, when the U.S. Treasury only held about $3 billion in gold.

In effect, the gold bonds had become fiat instruments. For this reason, the successful introduction of real financial instruments into the marketplace, while initially requiring only abstract real currency units; must ultimately depend upon the issuance of asset-backed real monetary equivalents. In addition, participants in the marketplace must be vigilant in seeing that the issuer's commitment, to back each real monetary unit with an asset that is self-adjusting for inflation, is properly fulfilled. Unfortunately, this vigilance cannot be entrusted to the government, which is the most likely party to violate this contract.

Real monetary theory foresees the transformation in the marketplace from the use of a nominal, fiat currency unit to an abstract real monetary unit, and then to an asset-backed real monetary equivalent. It recognizes that the actual issuer of this asset-backed real monetary equivalent is of less concern than the ability of the monetary equivalent to maintain a constant and consistent level of purchasing power. In fact, the governments of the world have wholly failed in this responsibility, nor should they be expected to succeed in the future; since the lack the asset required assets to back an ample real money supply. Only the marketplace controls such assets. As such, the acceptance of real monetary theory in the marketplace will mark the transformation of the marketplace from our current monetary contract, defined in the nominal, fiat currency unit, to an asset-backed real monetary equivalent.

Process I: The Pre-Formation of the Initial Multi-Phase Monetary System.

The purpose of the invention, Real Monetary Software™, is to create a conceptual bridge that will allow participants in the marketplace to see the benefits of using real financial instruments in traditional, nominal monetary terms. Then, as Adam Smith's invisible hand begins to function, each participant will select real monetary terms over nominal monetary terms in order to maximize their individual financial positions. The logical result will be the eventual conversion of the marketplace from the nominal monetary paradigm to the real monetary paradigm. This in turn will lead to the need for an asset-backed real monetary equivalent in the marketplace to replace the fiat currency. For without the introduction of the asset-backed real monetary equivalent to represent the master real currency, the conceptual journey across the bridge cannot be completed and the marketplace will continue to be hampered by inflation and deflation. In effect, the creation and distribution of the asset-backed real monetary equivalent represents the culmination of the journey across the conceptual bridge.

However, the direct conversion from the fiat currency to a master real currency (representing the asset-backed real monetary equivalent) is a powerful paradigm shift that few people are prepared to comprehend or accept. This creates the need for the Real Monetary Software™, which is designed to carry out a number of logical, progressive functions for the purpose of guiding people through transitional phases leading each individual to his or her own paradigm shift. As such, the invention creates a conceptual structure that can meet the needs of various individuals, institutions and governments simultaneously, regardless of their individual progress through these transitional phases. It will also promote the development of a wide range of financial instruments that mimic existing financial instruments in terms of function, but which are based upon real monetary terms. The resulting benefits, to the borrowers and the lenders alike, will promote the distribution and acceptance of these instruments in the marketplace; once again promoting the application of the invention and the use of the conceptual bridge to others. The conceptual bridge will in turn lead to the paradigm shift from nominal to real monetary terms, as well as to the issuance of an asset-backed real monetary equivalent. Overall, we shall refer to the creation of the conceptual bridge, and the carrying out of the functions and transitional phases, as the Real Monetization™ process. Therefore, we could also state that the purpose of the Real Monetary Software™ is to carry out the Real Monetization™ process.

We begin the Real Monetization™ process by using parameters and conventions to define the multi-phase monetary system that we wish to establish. We will define four (4) distinct monetary phases, which essentially establish the structure of the conceptual bridge. By defining the four monetary phases, we are also acknowledging how difficult it is for a marketplace to go directly from the fiat currency to the master real currency; representing the paradigm shift from nominal to real terms. At the same time we are beginning to create a financial bridge, or channel, by which financial professionals can begin to offer real financial instruments, which are defined in real terms but are then converted to the fiat currency currently in use in the marketplace. We are also creating the market structure for real financial instruments, which will allow financial professionals to resolve certain credit-related and market-related problems associated with the offering of real financial instruments in a nominal monetary marketplace.

Then, we will use this multi-phase monetary system for the creation of an asset-backed real monetary equivalent. As this asset-backed real monetary equivalent gains acceptance, the marketplace can shift to a direct conversion by and between the asset-backed real monetary equivalent and the fiat currency. Until finally, the continued issuance, and superior purchasing power of the asset-backed real monetary equivalent, will drive the fiat currency from the marketplace; thereby returning the marketplace to a single-phase monetary system. At this point, the marketplace will have completed the journey across the conceptual bridge, the monetary paradigm will have shifted from nominal to real terms, the Real Monetization™ process will be complete and the Real Monetary Software™ will have fulfilled its purpose.

However, we are still at the beginning, and not the ending. So we must begin with the pre-formation of the multi-phase monetary system (or “system”). In the course of developing the system, a number of tables and schedules will be created to carry out the securitization process in the monetary phases. Please see the Real Monetary Software™—Module Diagram, which should help to clarify the role of each of these tables and schedules. It should also show the general structure and interrelationship between the conduits, the defined marketplaces and the system. However, for the sake of simplicity, the Module Diagram does not include the tables and schedules created for the marketing presentations and stress testing. The Module Diagram is broken into three parts, representing the 1^{st}, 2^{nd} and 3^{rd} conduits created in the defined marketplace each of which contain successive changes. All conduits after the 3^{rd} conduit use the modules for the 3^{rd} conduit.
Box 100: Name the system.

There is a Chinese proverb that states: “To name something is the beginning of knowledge.” Names are essential communication tools, since they can provide us with a simple reference to anything the human mind can conceive. As such, the multi-phase monetary system requires a name, which provides us with a simple reference to the parameters, conventions and monetary phases that will define the multi-phase monetary system.

For illustrative purposes, we will create a multi-phase monetary system as we proceed with the Detailed Description of the Preferred Embodiments.

### EXAMPLE

Name of the System: American Real Monetary System (ARMS)

The name of the multi-phase monetary system could be generic in nature, or it could represent membership in an association of financial interests such as the New York Stock Exchange. But in either event, it would signify the acceptance of the system's parameters and conventions (subject to alteration) by those using the name.

See Tables 73, 74 and 75 as examples.
Box 105: Initiate a system index, or other means, that will logically allow users to access, screens, functions and data stored by the system.

Initiate the system index, or other means, as described in the Box above.

See Table 73 as an example.
Box 110: Input the system's parameters by selecting: (1) the fiat currency, (2) the base-line-date and (3) the inflation index.

By stipulating the parameters, including the fiat currency, the inflation index and the base-line-date, we can begin to define the system. The selection of the fiat currency denotes the geographic location of the marketplace where the system is to be established. Once the country or region is selected, then we should select an inflation index that is widely accepted as a reasonable measure of inflation within that country or region. (If no such inflation index exists, then one must be created.) Finally, it is necessary to select the base-line-date, which is essentially the initiation date of the system.

The base-line-date, coupled with the inflation index, will be used to track the relative purchasing power of the master real currency unit from the fiat currency unit over time. It also defines the date on which one unit of the master real currency equals one unit of the fiat currency. Thereafter, the purchasing power of the fiat currency will vary over time, due to the inflation and deflation measured by the inflation index; but the purchasing power of the master real currency will remain constant. Any subsequent changes in the parameters would begin to define a new system. As such, the parameters should remain relatively unchanged. In fact, the primary benefit of establishing a real monetary system is the monetary consistency it offers, thereby leading to financial and economic stability over time.

### EXAMPLE

### The American Real Monetary System's Parameters

(1) The fiat currency: United States dollar ($1.00)
(2) The base-line-date: Jan. 1, 2000 (subject to the inflationary lag)
(3) The inflation index: Consumer Price Index for all Urban Consumers (CPI-U)

The selection of a fiat currency and an inflation index, that are derived from different countries or regions, would have little value or purpose in establishing a real monetary system. While this may suit the intent of certain parties in one or more transactions, it serves little or no purpose for others participating in the larger marketplaces. It may also lead to distorted transfers of wealth, since there would be no relationship between the purchasing power of the fiat currency and the respective changes in the inflation index.

This highlights another benefit in establishing the real monetary system, which is the removal of the speculative aspect from monetary instruments. If one owes one hundred dollars in purchasing power, then one should repay one hundred dollars in purchasing power without regard to the relative inflation or deflation experienced during the repayment period. This does not occur with nominal financial instruments, which makes intermediate to long-term financial instruments a speculative gamble. This forces nominal monetary marketplaces to shift from long-term financial planning, which becomes virtually impossible, to short-term financial reacting. This is why our financial marketplaces and institutions today are dominated by traders. It is also why our public corporations are more concerned with this quarter's earnings, than the long-term prospects of the company's development.

See Tables 74 & 75 as examples.
Box 120: Input the system's conventions, including: (1) the inflationary lag, (2) the prevailing rate of inflation (or deflation) (PRI), (3) the inflation index default, (4) the inflationary adjustment default, (5) the current inflationary adjustment (CIA), (6) the rounding decimal, (7) the MIAF recalculation period and (8) the distribution rule.

While the parameters established by the system must be the same, participants using the system have some latitude with respect to adopting the conventions. Certainly, it is advisable for all participants using the system to adopt the same conventions, but it is not essential. Provided only, that any change in the system's conventions are properly offset, such that the purchasing power of the master real currency used by the participants is unchanged from the system's master real currency. This is important, since the master real currency is used to create a liquid market for the real financial instruments, thereby resolving certain marketing problems associated with offering real financial instruments in a nominal monetary marketplace. As such, it requires a constant level of purchasing power at all times for all those who wish to participate in the marketplace. It is also possible that the system, a defined marketplace, a conduit or certain participants within the system, will adopt additional conventions as the marketplace develops; which may or may not ultimately be accepted or even recognized by the system itself.

### EXAMPLE

### The American Real Monetary System's Conventions

(1) The inflationary lag: 2 months

This means that the inflationary adjustment calculations that are made in January, 2000 (for debt service payments due in February, 2000) are based upon the CPI-U issued for November, 1999 on or about Dec. 15, 1999.

Typically, the CPI-U in the United States is tabulated during the subject month, and then released on the 15^{th} of the following month. The two month inflationary lag, adopted by the ARMS System, means that we have at least a 45 day window to compute the upcoming nominal currency debt service payments. In addition, the extra 30 day period will allow the current inflationary adjustment to be calculated in advance, so that it can be paid with the basic payment for the payment period.
(2) The prevailing rate of inflation (or deflation) (PRI): The percentage change in the inflation index, during the preceding 12-month period, subject to the inflationary lag.

This means that the prevailing rate of inflation (PRI) for the ARMS System in January, 2000 for debt service payments due and owing in February, 2000) actually measures the rate of inflation from November 1998 to November 1999. This can be calculated as follows:

Hypothetically assuming that:
CPI-U¹=CPI-U for November, 1998=175
CPI-U²=CPI-U for November, 1999=190

Then the prevailing rate of inflation calculated in January, 2000 to determine debt service payments due and owing in February, 2000 is as follows:

$$\begin{matrix}Prevailing rate of inflation = \frac{( CPI \text{-} {U}^{2} - CPI \text{-} {U}^{1} )}{CPI \text{-} {U}^{1}} \\ = \frac{15}{175} \\ = 8.75 \%\end{matrix}$$

(3) The inflation index default: prevailing rate of inflation (PRI)

This means that in the event that the agency generating the inflation index is late in tabulating and issuing the index, then it is permissible for conduits in the system to use the prevailing rate of inflation for the previous payment calculation period to calculate the nominal currency debt service payments for the current time period for any given real financial instrument. It being agreed and understood by all concerned that this calculation will then determine the appropriate payments that are to be made, which will not thereafter be corrected. As such, the loss or benefit that shall accrue to any individual shall be permanent and shall not thereafter be corrected. In reality, the inflation index is cumulative. This means that while there may be a discrepancy in any given payment period in which the inflation index default is relied upon, that the cumulative inflation index will correct the default for any and all future payment periods. It is only the discrepancy in the given time period that will not be corrected, the assumption being that it will be too expensive to correct. This rule will also apply to the calculation of any and all MIAFs and IAFs in the payment period in questions, under the understanding that any future calculations using the MIAFs or IAFs will use the correct inflation index once it is issued. Once again, this means that any discrepance will be limited to the payment period in which the agency was late in issuing the proper inflation index number.
(4) Inflationary adjustment factor (IAF): The inflationary adjustment factor will begin at 1.0000 for the initial payment period, and then shall be adjusted only between payment periods.

Part of the complexity, of working with real financial instruments in a nominal monetary marketplace, is that the purchasing power difference between the master real currency and the fiat currency may be continuously changing due to inflation and/or deflation. For instance, the purchasing power of the nominal currency on an amortization schedule is usually different within the same row representing a single payment period. Consider the first payment period of the following nominal mortgage loan amortized over 12 months:

Constructing a Nominal Fixed-Rate Mortgage Amortization Schedule

| Pay- | Begin | | | Interest | | End |
|---|---|---|---|---|---|---|
| ment | Principal | | Monthly | Pay- | Principal | Principal |
| Period: | Balance | Rate: | Payment: | ment: | Payment: | Balance: |
| 1 | $1000.00 | 8.0% | $86.99 | $6.67 | $80.32 | $919.68 |

This nominal amortization schedule shown above appears to be very straight forward. It is certainly easy to understand. We can easily confirm the “interest paid” by multiplying $1,000 by 8.0%, and then dividing by 12 to get the monthly interest paid of $6.67. We can then subtract the “interest paid” from the “monthly payment” to arrive at the “principal payment” (or $86.99−$6.67=$80.32). Finally, we can subtract the “principal paid” from the “begin principal balance” to confirm the “end principal balance” (or $1,000.00−$80.32=$919.68). This is very simple and very straight forward, but it is almost always wrong; assuming money is supposed to represent purchasing power.

Unfortunately, nominal amortization schedules completely ignore the impact of inflation and deflation on the currency payments being made. For instance, they assume that all of the currency units represented have the same purchasing power, which would only be true if no inflation or deflation ensued from the funding of the mortgage loan through the entire amortization of the loan. By making this assumption, they are violating the Concept of Whole Numbers. One unit of the fiat currency does not have the same purchasing power of another unit of the fiat currency, if inflation or deflation ensues between the time that each fiat currency unit is used. The Concept of Whole Numbers simply states that each defined “unit” is whole, but if money is supposed to be a measure of purchasing power, then we know that the fiat currency unit does not hold a constant level of purchasing power over inflationary and/or deflationary time periods. It is this continued use of the fiat currency as a whole unit, this violation of the Concept of Whole Numbers, that causes inflation and deflation.

Let's assume that the prevailing rate of inflation (i.e. the annual rate) is three percent (3.0%) during the first payment period, then we could readjust the currency figures in each column to account for the inflation as shown below:

Adjusting the Nominal Amortization Schedule for Inflation

| Payment | Begin Principal | | Monthly | Interest | Principal | End Principal |
|---|---|---|---|---|---|---|
| Period: | Balance | Rate: | Payment: | Payment: | Payment: | Balance: |
| 1 | $1000.00 ÷ | 8.0% | $86.99 ÷ | $6.67 ÷ | $80.32 ÷ | $919.68 ÷ |
| | 1.0000 | | 1.0025 | 1.0025 | 1.0025 | 1.0025 |
| Revised for | $1,000.00 | | $86.77 | $6.65 | $80.12 | $917.39 |
| Inflation: | | | | | | |

Keep in mind that $1,000 was borrowed on the day the loan was funded, but the first payment was due and payable one month later. Assuming the prevailing inflation rate was 3.0%, then our inflation adjustment factor is 1.0025 (or 1+(3.0%/12)) after one month, but the inflationary adjustment factor is still 1.000 on the day the mortgage loan is funded. In essence, the purchasing power of the nominal dollar has changed by 0.25% in one month, which means that the original nominal amortization schedule that appeared to be so simple is actually misleading us.

So, how do we deal with the conversion of a real currency amortization schedule to a nominal currency amortization schedule? While the real amortization schedule is no problem by itself, we must then convert the real currency units to nominal currency units; since there are no real currency units available to make our loan payment. This means that the inflationary adjustment factor actually changes in the middle of any payment period (or row), as shown above. If we use two inflationary adjustment factors in the same row as shown above, then our amortization schedule no longer makes any sense. We can see this if we add the “principal paid” to the “end principal balance,” and discover that it does not equal the “begin principal balance” of $1,000.00. (i.e. $80.11+$917.39=$997.50). We have misplaced $2.50 in purchasing power.

We can begin to resolve this problem by resorting to a simple convention, which we will call the “inflationary adjustment default.” This simply means that when converting an amortization schedule denominated in one monetary phase to another, we will not change the inflationary adjustment factor until we have moved to the next payment period. This is crucial, assuming one understands the nature of amortization schedules; which requires that all parties can properly check to see that the payments are properly applied to the outstanding interest and principal balance. If the numbers do not add up, then how is everyone to know that the schedule is correct? By adopting the inflationary adjustment default; every currency figure in a given payment period will be multiplied (or divided, as the case may be) by the same inflationary adjustment factor, when converting from one monetary phase to another. This also means that the inflationary adjustment factor will always be 1.000 for every figure in the row representing the initial payment period.

Now that we have resolved this perceptual problem, we must account for the missing $2.50 of purchasing power.
(5) Current Inflationary

Adjustment (CIA): The prevailing inflation rate divided by 12 times the principal paid in the current payment period, which is then due and payable in the subsequent payment period.

Why did we lose the purchasing power ($2.50) in the above example, when we adjusted the currency units for inflation? The reason is that we applied our amortization formula to the outstanding balance based upon the original purchasing power of the currency on the day the loan was funded. By definition, we projected the amortization schedule in real currency units, since the real currency unit equals the fiat currency unit on the origination date of the loan. Inasmuch as we will be applying the inflationary adjustment factor (IAF) to the “end principal balance,” before recognizing it as the “begin principal balance” in the second payment period; we are not concerned with the ending principal balance. This will account for the lion's share of the missing $2.50 as follows:

$$End Principle Balance \times IAF = Begin Principle Balance ( in the subsequent row )$$

$$or$$

$$\$919 .68 \times 1.0025 \% = \$921 .98$$

$$and$$

$$\$921 .98 - \$919 .68 = \$2 .30$$

Where did the other $0.20 go? We have allowed the borrower to pay the “principal paid” in the current time period with a currency that has been devalued by the rate of inflation during the first time period. Inasmuch as we are not applying the IAF until after the payment period (i.e. row) is concluded, the application of the IAF to the “principal payment” is never made. This is why we need the current inflationary adjustment (CIA). If we multiple the inflation rate by the “principal payment,” then we can see that the borrower still owes an additional amount:

$$CIA = Principle Payment \times ( Prevailing Inflation Rate ) / 12$$

$$or$$

$$CIA = \$80 .32 \times .0025 \% = \$ .20$$

Taken altogether, the use of the inflationary adjustment factor (IAF), and the current inflationary adjustment (CIA), will reallocate the missing $2.50 in purchasing power back to the lender. As such, we will agree on a convention called the “current inflationary adjustment,” which simply accounts for this missing purchasing power due and owing to the lender. (The exact opposite would occur if deflation ensues). Inasmuch as the payment on such loans is made one payment period in arrears, then so too must the calculation of the CIA occur one payment period in arrears with respect to the inflationary lag in the determination of the prevailing rate of inflation. If the inflationary lag is two months, then the sponsor of the conduit may be able to calculate the CIA for the coming time period in advance, so that both the payment and the CIA it incurs are paid simultaneously. However, if the inflationary lag is only one period, then the CIA must be made with the subsequent payment period; so the sponsor has the time to properly calculate it.

Why is the current inflationary adjustment (CIA) important? It is important, because today's financial markets use securitization in order to create highly liquid markets for the funding of mortgages. The securitization of real financial instruments will entail detailed offering documents representing that the investor will receive a stipulated real rate of interest. If the current inflationary adjustment (CIA) is not properly made, then the real rate of interest promised to the investors cannot be properly paid. In the securities world, this could lead to claims of misrepresentation or even fraud.
(6) Rounding Decimal: Inflationary adjustment factors will be carried to the sixth decimal for all monetary conversions. In addition, all other calculations will be carried to the sixth decimal, until the final result is tabulated which will then be rounded to the closest penny.

Typically, inflation indexes are measured only to one decimal place. However, given the potentially huge sums of currency that can be developed in the marketplace for real financial instruments, it is important to extend this to six decimal places. This will apply to both inflationary adjustment factors (IAFs) and master inflationary adjustment factors (MIAFs) in monetary conversions and to all other calculations until the final number is rounded to the nearest penny.
(7) MIAF Recalculation Period: Monthly, subject to the inflationary lag.

This convention assumes that the system will recalculate the MIAF for new conduits and real financial instruments on a monthly basis only, subject to the agreed upon inflationary lag. As such, any and all conduits, assets, issued securities and stripped accrual rights that are initiated in a given month will share the same MIAF thereafter. The timing of the MIAF recalculation period could be made during any time period, such as daily, monthly, quarterly, semi-annually or annually. Obviously, the shorter the time period the more precise the monetary conversions will be. However, a time period that is too short may generate more extra work than it is worth, and may also lead to more confusion for all concerned.
(8) The distribution rule: The amortization schedule(s) for the issued securities will be synchronized with the amortization schedule(s) of the asset pool(s), such that the net cash disbursements of the collective asset pool(s) will equal the gross cash disbursements for the issued securities.

Expenses are incurred in the securitization process required for creating a liquid market for any asset class. In addition, the sponsors of such securitization programs must be able to generate a profit for their activities, or no one will be willing to perform this service for the marketplace. This problem is resolved by: (1) creating methods of credit enhancement, or (2) by otherwise supplying such credit enhancement from an outside source. One method of credit enhancement is the use of structured financing, which will create multiple classes of securities with each additional class being subordinate in payment to the earlier classes. An example of supplying external credit enhancement would be the effective guarantee of the issued securities by a government agency or a large financial institution. In either event, the quality of most, if not all, of the issued securities is enhanced, thereby reflecting a issued or implied higher credit rating in the financial marketplace. This means that while the asset class itself may offer an 8.0% yield, since it is effectively unrated; the issued securities receiving institutional quality credit ratings (“BBB” or higher) may be marketed at 7.0% or less. The spread between the collective rate on the asset pool(s) versus the lower collective rate on the issued securities, provides the sponsor of the conduit with the ability to: either sell the issued securities for more than the purchase price of the assets, or to retain a stream of excess interest by means of retaining the rights to the residual cash flows. This supplies the sponsor with the funds required to cover the securitization program's expenses and a tidy profit. Nonetheless, this can generate a cash flow mismatch.

The asset pool with the higher rate of interest will amortize the outstanding principal balance at a slower rate than the issued securities with a lower rate of interest. As this process of amortization proceeds, the net payments on the asset pool(s) (after related expenses such as mortgage servicing, etc.) begins to fall short of the distributions due on the issued securities, which is directly attributable to the fact that they are amortizing principal at different rates. While this may actually represent the potential for accruing profits on the part of the sponsor, assuming the sponsor is willing and able to make up the cash shortfalls; it also creates the potential for a default on the distributions to the issued securities holders in the event the sponsor is unable to keep up with the negative cash flows the program is generating.

The distribution rule simply states that the rate of amortization of the collective principal on all of the issued securities will equal the rate of principal amortization on the collective principal of the asset pool(s). By adhering to this rule, the sponsor will always have enough cash flow to make the promised distributions to the securities holders, thereby eliminating the potential for a default.

This can be summarized by the following formulas:

If:
PPAP=principal payment on the asset pool
A=outstanding principal balance on the Class “A” securities
T=outstanding principal balance on all securities classes
PPAC=principal payment on the Class “A” securities

then:
PPAC=(A/T)×PPAP

By using this formula, and applying it to each class of issued securities, the total amount of principal paid to the issued securities in any given payment period cannot exceed the amount of principal paid by the asset pool in the same time period. This formula assumes that the par value of the asset pool(s) collectively equals the par value of the issued securities, and it assumes that there has been no default on the payments due from the asset pool. Obviously, more complex formulas would be required to deal with such circumstances, nonetheless the general concept of the distribution rule can still be adhered to such that the amount of principal payments distributed will not exceed the amount of principal payments received in any time period.

See Tables 74 and 75 as examples.
Box 130: Define the master inflationary adjustment (MIAF) and initiate the system's record of MIAFs by inputting the inflation index as it is released each month.

Now that we have established the system's parameters and conventions, it is possible to define the master inflationary adjustment factor and initiate the system's record of MIAFs. Simply stated, the MIAF for the system equals 1.0000 on the base-line-date, but will then vary with the relative change in the inflation index over time. The system's record of MIAFs will effectively calculate a new MIAF for each new date that a real financial instrument is originated, issued or stripped or a conduit is started-up. Any and all real financial instruments and conduits that share the same date will have the same MIAF. Once established, the respective MIAFs do not change, unless the system's base-line-date, or the inflation index, is altered.

### EXAMPLE

ARMS Record of Master Inflationary Adjustment Factors (MIAFs)

| Year: | Month: | CPI-U: | Year: | Month: | MIAF: | |
|---|---|---|---|---|---|---|
| 1999 | Nov | 190.0 | 2000 | Jan | 1.000000 | BLD |
| 1999 | Dec | 193.0 | 2000 | Feb | 1.015789 | |
| 2000 | Jan | — | 2000 | Mar | — | |
| (etc.) | | | | | | |

The base-line-date (BLD) for the ARMS System is January, 2000, hence by definition the master inflationary adjustment factor for January, 2000 is 1.0000; which is then used for all master real currency conversions for conduits and real financial instruments that are initiated in January, 2000. Due to the agreed upon inflationary lag of two months, the base-line-date is anchored to the CPI-U for November.

The MIAF is then recalculated for February, 2000, subject to the inflationary lag, as follows:

$$Where \text{:} CPI \text{-} {U}^{Nov} = the designated CPI \text{-} U index for the base \text{-} line \text{-} date of January , 2000 , due to the 2 month inflationary lag$$

$$CPI \text{-} {U}^{Dec} = the CPI \text{-} U for February , 2000 , due to the 2 month inflationary lag$$

$${MIAF}^{Feb} = the master inflationary adjustment factor for February , 2000$$

$$Then \text{:} {MIAF}^{Feb} = \frac{CPI \text{-} {U}^{Dec}}{CPI \text{-} {U}^{Nov}} = \frac{193.0}{190.0} = 1.015789$$

Please note that the denominator (or CPI-U^{Nov}) in the formula never changes; since the MIAF measures the change in the inflation index since the base-line-date, and the CPI-U^{Nov} is the designated inflation index date for the BLD due to the 2 month inflationary lag. (This is different than the IAF, which measures the change in the inflation index since the initiation date of the instrument or conduit; unless the initiation date is the same as the base-line-date, which would make them the MIAF and the IAF the same.) The numerator (or CPI-U^{Dec}) is constant for the February initiation date for any given conduit or real financial instrument, but it changes with each new MIAF recalculation period (or month) for new conduits and new real financial instruments. Hence, the MIAF is constant, once calculated for any given conduit or real financial instrument; but may change between conduits and real financial instruments that are initiated in a different time periods, if inflation or deflation has ensued between the given MIAF recalculation periods. While the MIAF is fixed for any instrument or conduit, the IAF changes over time with respect to inflation. This occurs because the MIAF measures the difference between the master real currency and the real currency, which both have a fixed level of purchasing power; while the IAF measures the difference between the real currency with a fixed level of purchasing power and the nominal currency with a continually changing level of purchasing power due to inflation and deflation.

This process is then repeated for each additional MIAF recalculation period (or month) as the inflation index is announced, thereby creating the system's record of master inflationary adjustment factors (MIAFs). This record is useful in terms of consolidating the sheer volume of MIAF calculations over time, and it minimizes the risk of inputting the wrong formula into any given calculation of an MIAF factor. (This MIAF record can also be used to project the inflationary adjustment factors (IAFs) for each real financial instrument and conduit over time, as we will demonstrate later in the text.) Now all the MIAFs (and IAFs) generated for the system can be checked for accuracy in one record, provided only that the software programmers access the record for the proper MIAF (or IAF) whenever a monetary conversion involving the master real currency (or real nominal currency) occurs. It also gives the system greater flexibility in terms of altering the base-line-date. The entire system can be changed by altering the record only. This can be important for realigning a system or combining two systems that otherwise share the same fiat currency and inflation index. Such consolidations can bring economies of scale, as well as legitimizing both the systems and any asset-backed real monetary equivalents that may be issued from the systems.

See Table 76 as an example.
BOX 140: Define the system's monetary phases, including (1) the master real currency, (2) the real currency, (3) the nominal currency and the (4) (fiat) currency.

### EXAMPLE

The American Real Monetary System's Monetary Phases:

| | | |
|---|---|---|
| Phase 1: | master real currency (MR$) | MR$ × MIAF = R$ |
| Phase 2: | real currency (R$) | R$ × IAF = N$ |
| Phase 3: | nominal currency (N$) | N$ recast to $ |
| Phase 4: | (fiat) currency ($) | U.S. Dollar ($1.00) |

(Please note: the monetary phase number assignments (1-4) were made to provide for the logical order of presentations, and are not meant to suggest the order of the development of the monetary phases. The actual order of development occurs in the conceptual stages, which is discussed).

The need for creating a system, with the four monetary phases for the purpose of introducing real financial instruments into the nominal monetary marketplace, will be explained simultaneously with the six conceptual stages in Box 150 below.

In addition, the four monetary phases are summarized in Tables 75, 77a, 77b & 77c.
Box 150: Define the system's six conceptual stages for the purpose of establishing the six levels of monetary phase presentations that can be derived from the multi-phase monetary system.

In the beginning, the nominal monetary marketplace is defined by the fiat currency that is issued by the government. Certainly, monetary equivalents exist, such as personal checks, travelers checks, coupons, stamps, drafts, credit cards, smart cards, wire transfers, etc. However, they are all defined in units of the fiat currency. It is also possible that a dual currency situation exists, whereby one or more additional fiat currencies (issued by still other governments) compete with the government's fiat currency. Money changers, the historical forerunners of our financial institutions, provide participants in the marketplace with a means of exchanging the various fiat currencies in use. Certainly, barter also exists, usually in an inverse proportion to the quality of the fiat currency, whereby participants in the marketplace may attempt to directly exchange goods and/or services without the benefit of any currency. The increased use of barter indicates a currency in decline, while the substantial use of barter indicates a currency collapse. For the most part, we shall ignore nominal monetary equivalents, dual fiat currencies and barter situations, since none of these employ the concept of developing a monetary unit with a constant level of purchasing power. This is somewhat ironic, since money is supposed to represent purchasing power.

As such, the introduction of real financial instruments into the marketplace, where no asset-backed real monetary equivalent currently exists, will require the introduction of four monetary phases. In addition, the conceptual journey carrying out the monetary paradigm shift (from the sole use of a fiat currency to the sole use of a master real currency) will require participants in the marketplace to pass through six distinct conceptual stages. If Real Monetary Software™, the invention, is to succeed in its primary goal, then it must be capable of dealing with all four (4) monetary phases, and all six (6) conceptual stages, at the same time; as it services people, instruments, and institutions in different stages of their own paradigm shift.

In the end, we can see how these monetary phases, when combined with the conceptual stages, can create a conceptual bridge that will show participants in the marketplace the benefits of using real financial terms in traditional nominal terms. At the same time, it will provide financial professionals the market structure required for successfully introducing real financial instruments into a nominal monetary marketplace; as well as how to create a vibrant, liquid market for the resulting securities. This will represent a paradigm shift for each participant in the marketplace, and for the marketplace as a whole; a shift from the nominal monetary paradigm to the real monetary paradigm. Nonetheless, this passage will not occur at the same time for everyone, which means that the Real Monetary Software™ must be capable of dealing with all four monetary phases and all six conceptual stages simultaneously. Indeed, the shift for many participants may be intuitive or based upon trust, whereby they shift to the use of the master real currency without fully understanding the intermediary steps; if only because “everyone is doing it” or because their financial professionals advise them to use the resulting asset-backed real monetary equivalents.

We will explain the development of the monetary phases, and their role in the passage of marketplace participants from conceptual stage I to stage VI; inasmuch as the need for the four monetary phases is derived from this conceptual journey.

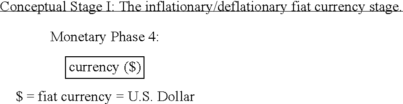

This stage simply refers to the use, by any participant, marketplace, system or economy, of one (or more) fiat currencies. The fiat currency is the paper currency issued by the government. It is called “fiat,” because it has no asset-backing and can be issued at-will by (fiat of) the government. While the use of the paper dollar in the United States has declined to about 8% of the total money supply, nonetheless the monetary unit represented by the paper U.S. dollar is universally used in all financial instruments and commerce in the U.S. The same is true of other fiat currencies issued by other governments and used in other marketplaces. Hence, even our electronic currency is effectively a fiat currency, since it is subject to inflation and deflation in the same degree as the paper currency issued by the government.

Obviously, the ability of a politically controlled entity to create money out of nothing can be highly inflationary over time. Unfortunately, the government is not the only source of inflation in the marketplace. Even great restraint, as exercised by the Federal Reserve in the United States in recent years, has still failed to totally eliminate inflation. In addition, the defeat of inflation in a nominal monetary marketplace, usually sets the stage for deflation; which is generally considered to be even more destructive. The bane of the Great Depression in the 1930s was deflation.

Nonetheless, it is important to remember that we can not directly eliminate inflation and deflation, since they are the symptoms but not the direct cause of monetary destruction. Rather, inflation and deflation occur as a direct result of the violation of the Concept of Whole Numbers by the fiat currency. As such, inflation and deflation can never be fully brought under control as long as we continue to use the fiat currency unit in our marketplaces. Therefore, while our current fiat currency defines one end of the conceptual bridge, we must realize that the other end of this bridge must lead us to a master real currency that does not violate the Concept of Whole Numbers. Only then, can we hope to bring inflation and deflation substantially under control.

Conceptual Stage II: The Introduction of the Real Financial Instrument.

We begin by defining the real currency (R$) as equaling the purchasing power of the nominal currency (N$) on the initiation date of the real financial instrument (or the conduit). (At this point in the presentation, the “nominal currency” and the fiat “currency” are synonymous, since they have the same purchasing power. However, we are going to distinguish between the nominal currency and the fiat currency for accounting and tax-reporting purposes; which will be explained as we proceed.) Thereafter, the real currency is said to have a constant level of purchasing power, while the purchasing power of the nominal currency will vary over time subject to inflation and deflation.

This simple definition of the real currency is an important marketing concept, that can be used to introduce the average participant in the nominal monetary marketplace to real financial instruments. The relationship between the real currency and the nominal currency can be expressed by the simple formula: the real currency times the inflationary adjustment factor (IAF) will equal the nominal currency.

The relationship can be summarized as follows:

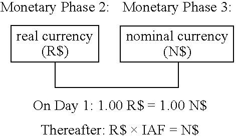

This simple ratio of one real currency unit being equal to one nominal currency unit is easy to understand for all concerned. It is also easy to understand that the nominal currency (and the fiat currency) are subject to inflation and deflation, which causes their purchasing power to change over time. And, it is easy to mutually agree that the real currency, as a mathematical concept, will maintain a constant level of purchasing power over time; but that it can also be converted to nominal dollars by multiplying it times an inflationary adjustment factor (IAF). Finally, the IAF is simply one plus the percentage change in the inflation index. These are simple concepts, which can be converted into the simple formulas.

We have proceeded, from the acknowledgment of the fiat currency ($) in stage I, to the introduction of the real currency (R$) and the nominal currency (N$) in stage II. This is important, since marketing real financial instruments to participants in the marketplace begins with their understanding these monetary relationships. Specifically, the borrower must be comfortable with the concept that he or she is entering into a loan that will be defined in the real currency, and then amortized with a real rate of interest to compute a real currency amortization schedule. Unfortunately, when real financial instruments are first introduced into the nominal monetary marketplace, there is no real currency that can be used to actually make the real currency debt service payments that are due and owing each payment period. At this time, the real currency is only an abstract mathematical expression of the purchasing power that is due and owing on the loan for the given payment period.

Therefore, we must use an inflationary adjustment factor to convert the real currency amortization schedule to a nominal currency conversion table. We use the term “conversion table” instead of “amortization schedule” for the nominal currency to remind participants that the actual amortization occurs in the real currency phase. This is important to remember, because the numerical amounts on the nominal conversion table will defy direct mathematical verification, since they are derived from the use of the inflationary adjustment factor and the real amortization schedule. So how do we define the “inflationary adjustment factor”?

The purpose of the inflationary adjustment factor (IAF) is to assist us in tracking the relative purchasing power between the real currency and the nominal currency over time. We know that the real currency by definition equals the nominal currency on the start-up date for conduits, the origination date for mortgages, auto loans, etc., the issuance date for asset-backed securities and the stripping date for accrual rights stripped from the issued securities. Hereinafter, we will refer collectively to these variously named dates as the “initiation date” for the given instrument or conduit. We also know that the system has adopted an inflation index, such as the CPI-U, to assist us in this tracking procedure. As such, we can define the inflationary adjustment factor (IAF) as follows:

$$\underline{Calculating an Inflationary Adjustment Factor ( IAF )}$$

$$On the initiation date , where \text{:}$$

$${IAF}^{X} = the inflationary adjustment factor for instrument “ X ” , or conduit “ X ”$$

$$then \text{:}$$

$${IAF}^{X} = 1.0000 for monetary conversions in the current period , but due and payable in the subsequent payment period$$

$$Thereafter , when \text{:}$$

$$CPI \text{-} {U}^{1} = the inflation index on the initiation date$$

$$CPI \text{-} {U}^{2} = the inflation index for the desired payment period$$

$$then \text{:}$$

$${IAF}^{X} = \frac{CPI \text{-} {U}^{2}}{CPI \text{-} {U}^{1}}$$

While the formulas above are correct, they imply that the system must keep a separate IAF record to service the monetary conversions for all the real financial instruments and conduits created in the system over time. Inasmuch as we are already keeping an MIAF record for the entire system, we can derive the individual IAF's as we need them from the MIAF schedule, since both the MIAFs and the IAFs are based upon the same inflation index. In effect, the percentage change between two MIAFs, calculated for two different MIAF adjustment periods, is the same percentage change as measured by the change in an IAF factor; assuming the IAF is measuring the percentage change in the same adjustment periods. This is true, since the percentage change in both cases is derived from the percentage change in the inflation index that each is based upon.

For instance, the IAF for instrument “X”, that was initiated in February, 2001, for the period of March, 2003 can be expressed as follows:

$$\underline{Using the MIAF Record to Project the IAF}$$

$$Where \text{:}$$

$${IAF}^{X} = the inflationary adjustment factor for instrument “ X ” during the payment period of March , 2003$$

$$and \text{:}$$

$${MIAF}^{X} = the MIAF readjustment period representing February , 2001 , which is the initiation period of instrument “ X ”$$

$${MIAF}^{C} = the MIAF readjustment period representing the period of March , 2000$$

$$then \text{:}$$

$${IAF}^{X} = \frac{{MIAF}^{C}}{{MIAF}^{X}}$$

As such, we can project the changing inflationary adjustment factor (IAF) for any instrument or conduit over time if we simply store the initiation period of the instrument or period, convert it to the correct MIAF adjustment period and then use the formulas stated above.

Conceptual Stage III: Differentiating Between the Nominal Currency and the (Flat) Currency

This explains how we will convert the real currency to the nominal currency, but it does not explain the need for differentiating between the nominal currency (N$) and the fiat currency ($). We can begin to understand the need for this differentiation, if we simply walk through the monetary phase conversion between the real currency and the nominal currency. For instance, we understand that all real financial instruments are amortized in real terms, including both the real currency and a real rate interest. We also understand that by convention (the inflationary adjustment default), we have agreed to change the IAF factor only as we move from one payment period to the next. Hence, we can convert the numerical figures in each row of the real currency amortization schedule, to the equivalent row in the nominal conversion table, by multiplying said numerical figures by the IAF for the given time period. As we move from row to row, and as inflation or deflation occurs, the IAF will adjust up or down as the case may be. Nonetheless, there will be a continuous process over the term of the loan for the nominal currency figures, to be inflated or deflated over time, relative to the real currency figures. As a result, the real currency amortization schedule will show that the 100 R$ borrowed was properly paid off with 100 R$, when we total the “principal paid” column.

However, the use of the IAF factor in converting the real currency to the nominal currency has distorted the nominal currency conversion table. While the nominal currency conversion table shows that 100 N$ was borrowed (since the IAF for the first time period is always 1.0000), when we total the “principal paid” column we will get a substantially different number unless no inflation or deflation ensued over the term of the loan. This distortion is caused by multiplying the ever-changing IAF factor times the real currency in the “principal paid” column of the real amortization schedule to derive the nominal currency paid in the nominal currency conversion table. In fact, most other figures on the nominal currency conversion table will also be distorted, including the “interest paid,” the “ending principal balance” and the “beginning principal amount” after the initial payment period. We will demonstrate this in the schedule and tables below:

Real Currency (R$) Amortization Schedule

| | Begin | | | | | End | |
|---|---|---|---|---|---|---|---|
| | Principal | Real | Monthly | Interest | Principal | Principal | |
| | Balance | Rate: | Payment: | Payment: | Payment: | Balance: | CIA: |
| Yr: | “A” | “B” | “C” | “D” | “E” | “F” | “G” |
| 1 | 100.00 R$ | 4.0% | 22.46 R$ | 4.00 R$ | 18.46 R$ | 81.54 R$ | .55 R$ |
| 2 | 81.54 R$ | 4.0% | 22.46 R$ | 3.26 R$ | 19.20 R$ | 62.34 R$ | .58 R$ |
| 3 | 62.34 R$ | 4.0% | 22.46 R$ | 2.49 R$ | 19.97 R$ | 42.37 R$ | .60 R$ |
| 4 | 42.37 R$ | 4.0% | 22.46 R$ | 1.69 R$ | 20.77 R$ | 21.60 R$ | .62 R$ |
| 5 | 21.60 R$ | 4.0% | 22.46 R$ | .86 R$ | 21.60 R$ | 0.00 R$ | .65 R$ |
| | N/A | N/A | 112.31 R$ | 12.31 R$ | 100.00 R$ | N/A | 3.00 R$ |

In the real currency amortization schedule, the “begin principal balance” of 100.00 R$ equals the total of the “principal payment” column, indicating the loan is properly repaid.

Nominal Currency (N$) Conversion Table

| | Begin | | | | | End | |
|---|---|---|---|---|---|---|---|
| | Principal | | Monthly | Interest | Principal | Principal | |
| | Balance | IAF: | Payment: | Payment: | Payment: | Balance: | CIA: |
| Yr: | “H” | “I” | “J” | “K” | “L” | “M” | “N” |
| 1 | 100.00 N$ | 1.0000 | 22.46 N$ | 4.00 N$ | 18.46 N$ | 81.54 N$ | .55 N$ |
| 2 | 83.98 N$ | 1.0300 | 23.14 N$ | 3.36 N$ | 19.78 N$ | 64.21 N$ | .59 N$ |
| 3 | 66.08 N$ | 1.0600 | 23.81 N$ | 2.64 N$ | 21.17 N$ | 44.91 N$ | .64 N$ |
| 4 | 46.18 N$ | 1.0900 | 24.48 N$ | 1.85 N$ | 22.64 N$ | 23.54 N$ | .68 N$ |
| 5 | 24.19 N$ | 1.1200 | 25.16 N$ | .97 N$ | 24.19 N$ | 0.00 N$ | .73 N$ |
| | N/A | N/A | 119.05 N$ | 12.82 N$ | 106.24 N$ | N/A | 3.19 N$ |

However, the “begin principal balance” on the nominal currency conversion table shows that 100.00 N$ are borrowed, but that 106.24 N$ are repaid in the total of the “principal paid” column.

Currency ($) Recasting Table

| | Begin | | | | | | |
|---|---|---|---|---|---|---|---|
| | Prin- | | | Interest | | End | |
| | cipal | | Monthly | Pay- | Principal | Principal | |
| | Balance | Rate: | Payment: | ment: | Payment: | Balance: | CIA: |
| Yr: | “O” | “P” | “Q” | “R” | “S” | “T” | “U” |
| 1 | $100.00 | N/A | $22.46 | $4.00 | $18.46 | $81.54 | $.55 |
| 2 | $81.54 | N/A | $23.14 | $3.94 | $19.20 | $62.34 | $.59 |
| 3 | $62.34 | N/A | $23.81 | $3.84 | $19.97 | $42.37 | $.64 |
| 4 | $42.37 | N/A | $24.48 | $3.72 | $20.77 | $21.60 | $.68 |
| 5 | $21.60 | N/A | $25.16 | $3.56 | $21.60 | $0.00 | $.73 |
| | N/A | N/A | $119.05 | $19.05 | $100.00 | N/A | $3.19 |

The distortion is corrected by recasting the figures in the nominal currency conversion table to those on the currency recasting table, where the $100.00 borrowed is properly repaid. The monetary phase relationship can now be summarized as follows: 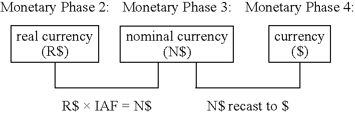
Conceptual Stage III

Unfortunately, the term “recasting” is rather vague. Exactly how does one convert the nominal currency conversion table to the currency recasting table? We know that we want to recast the “principal payment” column in the nominal currency conversion table to the “principal payment” column in the currency recasting table, since this will resolve our distortion problem. But how do we determine how much principal is actually paid during each time period? Quite simply, the “principal paid” in the currency recasting table should be equal to the “principal paid” in the real currency amortization schedule for each payment period. While this appears to be another “convention,” it actually generates the right numbers. But how can we know this?

Assuming one sets up both a real currency amortization schedule, and a nominal currency conversion schedule; as we have done above; and then generates a number of such related schedules and tables with the only change being the annual rate of inflation between each set. One will find that; while the outstanding principal balance of the nominal currency conversion tables increases as the assumed annual rate of inflation increases, no amount of change in the assumed inflation rate will affect the outstanding principal balance on the real currency amortization schedule. In addition, if we assume the annual rate of inflation to be zero, then the outstanding principal balance of the real currency amortization schedule and the nominal currency conversion table will be equal for each payment period. This makes sense, since the real currency by definition will equal the nominal currency over time if there is no inflation (or deflation). In essence, the IAF is always 1.000 if no inflation or deflation has occurred. As such, the outstanding principal balances on the nominal currency conversion tables, that were increasing with the annual inflation rate, were increasing due to the increase in the inflationary adjustment factor (IAF) representing the inflationary rate of change each payment period. Therefore, if we scoop the inflationary adjustment off the figures reported in the “principal payment” column of the nominal currency conversion table; we will get the same figures as shown on the real currency amortization schedule in the “principal payment” column for each respective time period; since any difference has to represent the payment of accrued interest. As such, we will shift this accrued interest payment into the “interest payment” column of the currency recasting table.

More specifically, we will use the formulas listed below to generate the figures in the respective schedule and tables. These formulas reference the columns in the schedule and tables above ranging from column columns “A” to “U”, and then use the “year” to indicate the row:

Real Currency (R$) Amortization Schedule

| | Begin | | | | | End | |
|---|---|---|---|---|---|---|---|
| | Principal | | Monthly | Interest | Principal | Principal | |
| | Balance | Rate: | Payment: | Payment: | Payment: | Balance: | CIA: |
| Yr: | “A” | “B” | “C” | “D” | “E” | “F” | “G” |
| 1 | (given) | (given) | (am. form.) | B1 × A1 | C1 − D1 | A1 − E1 | E1 × PRI¹ |
| 2 | +F1 | (given) | (am. form.) | B2 × A2 | C2 − D2 | A2 − E2 | E2 × PRI² |
| 3 | +F2 | (given) | (am. form.) | B3 × A3 | C3 − D3 | A3 − E3 | E3 × PRI³ |
| 4 | +F3 | (given) | (am. form.) | B4 × A4 | C4 − D4 | A4 − E4 | E4 × PRI⁴ |
| 5 | +F4 | (given) | (am. form.) | B5 × A5 | C5 − D5 | A5 − E5 | E5 × PRI⁵ |
| | N/A | N/A | C1 . . . C5 | D1 . . . D5 | E1 . . . E5 | N/A | G1 . . . G5 |

“given” = the initial principal amount and the real interest rate is assumed in this presentation
“am. form” = any valid amortization formula plus the rate, remaining term & remaining principal balance
PRI^{X} = the prevailing rate of inflation for payment period “X”

Nominal Currency (N$) Conversion Table

| | Begin Principal | | Monthly | Interest | Principal | End Principal | |
|---|---|---|---|---|---|---|---|
| | Balance | IAF: | Payment: | Payment: | Payment: | Balance: | CIA: |
| Yr: | “H” | “I” | “J” | “K” | “L” | “M” | “N” |
| 1 | A1 × I1 | IAF¹ | C1 × I1 | D1 × I1 | E1 × I1 | F1 × I1 | G1 × I1 |
| 2 | A1 × I2 | IAF² | C1 × I2 | D1 × I2 | E1 × I2 | F1 × I2 | G1 × I2 |
| 3 | A1 × I3 | IAF³ | C1 × I3 | D1 × I3 | E1 × I3 | F1 × I3 | G1 × I3 |
| 4 | A1 × I4 | IAF⁴ | C1 × I4 | D1 × I4 | E1 × I4 | F1 × I4 | G1 × I4 |
| 5 | A1 × I5 | IAF⁵ | C1 × I5 | D1 × I5 | E1 × I5 | F1 × I5 | G1 × I5 |
| | N/A | N/A | J1 . . . J5 | K1 . . . K5 | L1 . . . L5 | M1 . . . M5 | N1 . . . N5 |

“IAF^{X}” = the IAF for payment period “X” is generated from the MIAF record

Currency ($) Recasting Table

| | Begin | | | | | | |
|---|---|---|---|---|---|---|---|
| | Principal | | Monthly | Interest | Principal | End Principal | |
| | Balance | Rate: | Payment: | Payment: | Payment: | Balance: | CIA: |
| Yr: | “O” | “P” | “Q” | “R” | “S” | “T” | “U” |
| 1 | +H1 | N/A | +J1 | Q1 − S1 | +E1 | O1 − S1 | +N1 |
| 2 | +T1 | N/A | +J2 | Q2 − S2 | +E2 | O2 − S2 | +N2 |
| 3 | +T1 | N/A | +J3 | Q3 − S3 | +E3 | O3 − S3 | +N3 |
| 4 | +T1 | N/A | +J4 | Q4 − S4 | +E4 | O4 − S4 | +N4 |
| 5 | +T1 | N/A | +J5 | Q5 − S5 | +E5 | O5 − S5 | +N5 |
| | N/A | N/A | Q1 . . . Q5 | R1 . . . R5 | S1 . . . S5 | N/A | U1 . . . U5 |

In summation, the “begin principal balance” in row 1 is derived from the “begin principal balance” in row 1, column “H” of the nominal currency conversion table. The “principal payment” in column “S” is derived from the “principal payment,” or column “E” of the real currency amortization schedule. The “monthly payment” in column “Q” is derived from the “monthly payment” column “J” of the nominal currency conversion table. And, the current inflationary adjustment (CIA) in column “U” is derived from the CIA in column “N” of the nominal currency conversion table. All other figures can then be generated within the currency recasting schedule as indicated above.

The reason for generating a currency recasting table is twofold: (1) so that participants using real financial instruments can see the benefits in traditional nominal terms, and (2) so that they can properly adjust their books and records in nominal terms. (Nonetheless, an additional schedule will be developed to assist tax paying participants for tax reporting purposes.)

Conceptual Stage IV: Recognizing the Need for the Master Real Currency.

It is important to understand that each and every real financial instrument and conduit functioning within a given system may have different inflationary adjustment factors, since they may have been initiated during a different MIAF adjustment period. Although, many may also share the same origination date, the system as a whole can become a biblical Tower of Babel; since those instruments and conduits not sharing the same origination date may have different IAFs. And with different IAFs, they can also have real currencies with different levels of purchasing power. As an example, a pool of mortgages originated over a 6-month period may have many different origination dates, six (6) different IAFs and (6) different purchasing power values for their real currencies, assuming the MIAF adjustment period is one month. Therefore, we cannot compile the real currency amortization schedules for the individual real financial instruments in the asset pool(s) to project a composite real amortization schedule for the conduit.

If this problem was confined to one conduit, then we could resolve this problem by compiling either the nominal conversion tables or the fiat currency recasting tables; since by definition the nominal currencies and the fiat currencies used in all the instruments within a given time period have the same purchasing power. Unfortunately, this is regressive, since it involves the continued use of the fiat currency that is responsible for causing inflation and deflation. Even if this is deemed acceptable by some, there is a still larger problem. If we wish to create a viable liquid marketplace for real financial instruments in a nominal monetary marketplace, then we must bring liquidity to the accruing interest that is inherent with real financial instruments during inflationary time periods. In other words, we must consider the development of the larger marketplace for real financial instruments, if we are to them into the nominal marketplace. To do this, we must be able to create a marketplace for the accrual rights that will be stripped off the issued securities.

The accrual right, representing the ownership of the accrued interest on a given issued security for a given time period, must be stripped and sold in order to bring the desired liquidity to the accrued interest. Hence, we are no longer dealing with a problem that is confined to one conduit, but rather a common problem that applies to all conduits purchasing and/or issuing real financial instruments. Once again, the Tower of Babel returns. Could we revert to the fiat currency once again? Certainly, but once again it is regressive. It will leave us in a constant state of flux, whereby we are using three monetary phases to avoid inflation and deflation, including the real currency, the nominal currency and the fiat currency. There will be no escape from this state of flux unless, (a) we abandon our goal of taming inflation and deflation, or (b) we develop a fourth monetary phase. In essence, we will never cross the conceptual bridge from the nominal monetary paradigm to the real monetary paradigm.

Fortunately, the development of a fourth monetary phase is a relatively simple matter. The fourth monetary phase is the master real currency phase, which is defined by the system's parameters. It becomes the preferred currency by which any and all transfers of monetary wealth by and between conduits will occur for the purpose of exchanging issued securities and accrual rights that primarily define the secondary assets purchased by the conduit. While it begins by performing this simple chore, it also defines the far end of the conceptual bridge. In other words, we began in a marketplace that used the fiat currency exclusively. Then we showed participants in the marketplace how they could achieve greater benefits by using real financial instruments, which require the use of a real currency and a nominal currency.

As the participants begin to understand this logical progression, then it is possible for them to understand the need for the master real currency. As the system provides for the distribution of asset-backed real monetary equivalents, which have the purchasing power of the master real currency; then it is possible for them to shift exclusively to the master real currency phase. As this logical progression proceeds, more and more participants will begin to use the asset-backed real monetary equivalents whenever possible, thereby beginning the shift in the marketplace from the nominal monetary paradigm to the real monetary paradigm. By completing this paradigm shift, the marketplace can then return to the use of a single monetary phase, except this time they will use a monetary unit that protects them from inflation and deflation.

Hence, the interrelationship between the four monetary phases may be expressed as follows:

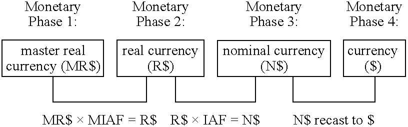

Thus we have defined the establishment of four monetary phases, which will effectively generate a real amortization schedule, a nominal conversion table, a (fiat) currency recasting table and finally a master real currency conversion table. This means that we may need as many as four separate schedules (or tables) to perform the desired calculations, depending on the function we are attempting to carry out. Some may suggest that this is a “brute force” approach to calculating our numbers. Is it not possible to consolidate these calculations into just one schedule? Inasmuch as one can theoretically compound formulas into infinity, assuming the computing power is available; then it may be possible to consolidate the calculations into just one schedule. Nonetheless, this destroys the primary objective of the Real Monetary Software™ (i.e. the invention), which is to create a conceptual bridge so participants in the marketplace can see the benefits of using real financial instruments in traditional, nominal terms.

By employing the four monetary phases, each participant in the marketplace can move at his or her own pace in deciphering the movement from the currency nominal monetary paradigm to the coming real monetary paradigm. Inasmuch as it could easily take decades to achieve the monetary paradigm shift for an entire marketplace, then the conceptual bridge built upon the system's four monetary phases becomes essential. Who among us could understand, or mathematically check, a compound amortization schedule projected over 360 monthly payments? One would need a super computer. But the whole point of an amortization schedule is to simply show the participants how the loan is properly amortized over its term.

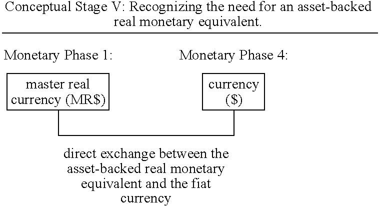

As real financial instruments are tracked in the four monetary phases, it is possible for participants to carefully check how their payments are applied to the repayment of the loan over its term. And by checking the movements of their payments from one monetary phase to the next, people soon begin to grasp that we can begin to discard the use of four monetary phases; if we simply begin to use an asset-backed real monetary equivalent in the marketplace. In other words, once people begin to grasp the true nature of real financial instruments by progressing from conceptual stage I to conceptual stage 1V, they will begin to see that they can move to a still higher level by defining their financial instruments in an asset-backed real monetary equivalent. This eliminates the need for monetary phase 3 (the real currency) and monetary phase 2 (the nominal currency). This will move the participant from four monetary phases to two phases: the asset-backed real monetary equivalent (defined in units of the master real currency) and the original fiat currency issued by the government.

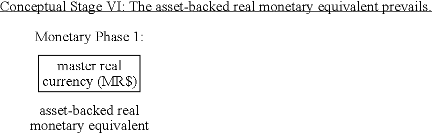

Eventually, as the marketplace converts to the use of the asset-backed real monetary equivalent, the use of the fiat currency will diminish. Hence, the marketplace will return to a single monetary phase, but this time it will use a monetary unit that properly holds its purchasing power over time. Nonetheless, the progression for each participant in the marketplace, whether consciously, intuitively or by trust is to move across the conceptual bridge from the use of the fiat currency to the use of asset-backed real monetary equivalent. As such, the Real Monetary Software™ must be prepared to function in each of the conceptual stages, which can only be achieved by the development of the multi-phase monetary system involving the four monetary phases defined herein.

| | Conceptual: |
|---|---|
| 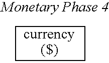 | Stage I |
| 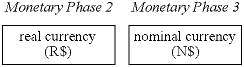 | Stage II |
| 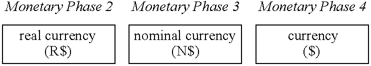 | Stage III |
| 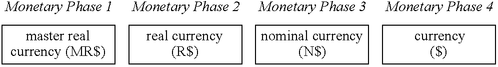 | Stage IV |
| 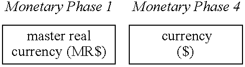 | Stage V |
| 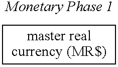 | Stage VI |

### The Conceptual Bridge

Taken altogether, we can see how the development of the invention, Real Monetary Software™, with four monetary phases can be used to provide a conceptual bridge through the six conceptual stages. These are the conceptual stages that participants must pass through to undergo the paradigm shift from the nominal to real terms. Regardless of the conceptual stage, that any given participant is currently going through, the Real Monetary Software™ will be able to respond with presentations and/or reports summarized in the combination of monetary phases that denote that participant's conceptual stage.

The conceptual bridge is summarized in Tables 75 and 78.
Box 152: Selecting from the three (3) generations of real financial institutions, input the permitted generations that can be introduced and utilized via the system.

This invention recognizes, and will provide for the development of, three separate generations of real financial instruments, which can be simply defined as follows:
First Generation: Fixed real rate instruments that are priced at a fixed margin over the selected inflation index.
Second Generation: Variable real rate instruments that are priced at a fixed margin over a traditional market index with the prevailing rate of inflation deducted to determine the variable amortizing (real) rate of interest.
Third Generation: Instruments that rely upon the use of first or second generation real financial instruments for their own creation. Such instruments may include both asset-backed real monetary equivalents as well as real high-yield equity REITs.

While the creation of first generation real financial instruments may be considered the most obvious development, they can often create certain market-related problems when initially offered in a nominal monetary marketplace. First, investors may object to the pricing of fixed-income instruments off a government-generated index instead of a market index that is the result of the interaction of supply and demand in the marketplace. Second, one of the primary goals of real financial instruments is to factor out the inflationary premium from the amortizing rate of interest. For intermediate to long-term instruments, this creates a negative interest-rate-anomaly, meaning simply that the effective nominal rate of the first generation real financial instrument is lower than the nominal rate of the competing nominal financial instruments. Hence, this negative interest-rate-anomaly makes it very difficult to market the resulting asset-backed securities, since investors inherently choose the higher nominal rate. This frequently results in the effective nominal rate of the first generation of real financial instruments to increase to compensate for this problem. Inasmuch as the government bond market provides the pricing mechanism for instruments in the private sector, the first generation real financial instruments (such as the Treasury Inflation Protection Securities or TIPS) effectively price the private sector offerings out of the market, since the TIPS real rate has increased to compensate for the negative interest-rate-anomaly. Finally, all real financial instruments accrue interest in nominal terms for at least part of their terms. In fact, bands will accrue interest for their full term. At the same time, some governments such as the United States, have declared their position that the accruing interest is taxable for tax paying entities. This substantially diminishes the demand for real financial instruments by investors, since no entity in the marketplace has yet to offer an acceptable means of providing liquidity for this accruing interest. This effectively eliminates the tax paying investor as an investment group, but the problem is even larger. Although such entities as pension funds are tax exempt, or tax deferred, they still need the full liquidity of the accruing interest so that they can meet their monthly cash distributions to the pensioners. So, the liquidity of the accruing interest poses a major problem in the development of a marketplace for real financial instruments.

The second generation can resolve the first two of these problems, but creates an even greater demand for the liquidity of the accruing interest. The second generation is priced at a fixed margin over a short-term market index rate, such as the 90-day Treasury Bills to determine the effective nominal rate. Then, the prevailing rate of interest, as determined by the selected inflation index, is deducted from the effective nominal rate to obtain the amortizing (real) rate of interest. This immediately resolves the problem of pricing off the government-generated inflation index, since the effective nominal rate is determined at a fixed margin over a market index. A short-term market index is selected, since short-term rates have little or no inflationary premium. The inflationary premium is not needed because the instrument is short term, so the rate can be readily readjusted to current market conditions. This resolves the negative interest-rate-anomaly. In fact, it can even create a positive interest rate anomaly for intermediate to long-term real financial instruments, that are now priced off a short-term market index but are actually lending long-term. As such, a portion of the inflationary premium can be maintained to create a positive interest-rate-anomaly for the short-term securities investor. However, now that the asset-backed securities are being marketed in the short-term securities market, complete liquidity becomes even more important. As this patent application is developed, it will be shown that the development of the defined marketplace(s), and the system(s) will create a workable institutional marketplace for the sale of the accrued interest.

The third generation of real financial instruments concerns those instruments that require the use of the first or second generation of the real financial instruments for their existence. This can include both high-yield real equity REITs and asset-backed real monetary equivalents. The high-yield real estate investment trusts (REITs) are simply entities that have used either first of second generation Real Mortgages™ to increase the cash distributions to their shareholders. In effect, they will form part of the borrowers class. The asset-backed real monetary equivalents are more important, since they are the ultimate goal of creating the conceptual bridge. In the beginning, the invention takes the marketplace participant's from the current use of the nominal, fiat currency up to a four phase monetary system. The last phase to be developed is the master real currency phase; which is defined by the system's parameters, including the fiat currency, the base-line-date and the inflation index. The master real currency is defined as equaling the purchasing power of the fiat currency on the base-line-date. Thereafter, the master real currency has a constant level of purchasing power, while the fiat currency's purchasing power varies with inflation and deflation over time. The inflation index is used to generate a master inflationary adjustment factor (MIAF), which represents the relative change in the purchasing power of the master real currency to the fiat currency from the base-line-date. The purpose of the asset-backed real monetary equivalent is to replace the nominal, fiat currency with a usable monetary unit that is actually backed by an asset that is self-adjusting for inflation and deflation. This asset can be the real-principal-only (RPO) strip from the government's real bonds (TIPS), or preferably from the Real Mortgage-Backed Securities™ (RMBS). Although it may be easier to initiate a System with TIPS RPO strips as security for the initial asset-backed real monetary equivalents, one must realize that the TIPS RPO strip is backed by nothing but the government's pledge. Governments are notorious for defaulting on their financial pledges. Hence, an asset-backed real monetary equivalent, such as the Millennium Dollar™, which is backed by RMBS RPO strips representing a claim on improved real estate; is a more secure monetary equivalent. Especially so, since real estate has always been considered a good hedge against inflation. It should be recognized that any system, defined marketplace, conduit or real financial instrument that approves the use of asset-backed real monetary equivalents are stating in essence that the approved monetary equivalents are being formally recognized as preferred tender for the payment of the loan obligations and/or the purchase of assets. Inasmuch as the issuance of any asset-backed real monetary equivalent essentially requires the issuer to provide a liquid market for the conversion of the monetary equivalent back to the fiat currency, making the commitment to accept such monetary equivalents becomes easier. In fact, Gresham's Law predicts that the market will prefer the asset-backed real monetary equivalents over the fiat currency. Finally, it should also be recognized that the acceptance of the asset-backed real monetary equivalent promises to reduce interest rates in the marketplace for borrowers. This provides another important reason to shift to the use of RMBS RPO strips, since they will recycle the funds back into providing lower cost mortgages in the local community, whereas TIPS RPO strips recycle the money and the interest rate savings back to the federal government.

As an example, see Table 79.
Box 154: Input the choice of qualifying and pricing indexes that may be acceptable for use with each of the permitted generations of real financial instruments.

In many countries, there are a number of inflation indexes, and a number of market indexes to choose from for the qualification and pricing of real financial instruments. The system should stipulate what indexes are acceptable for use within the system. Naturally, the system should begin with the most acceptable and widely-used inflation index and market index(es). Having more than one inflation index within a system may be problematic, since the value of the master real currency should be a universal constant for everyone functioning within the system. At the very least, the system should select one long-term market index for qualifying the real financial instruments, and a short-term market index assuming second generation real financial instruments, or variable real rate instruments, are to be allowed within the system. It may be best to begin with a minimum number of index options and proceed to a higher number later, since the use of each new index implies the establishment of a liquid securities market based upon that index.

As an example, see Table 79.
Box 156: Optional: If third generation real financial instruments have been approved by the system (see Box 154), then input the derivatives that are permitted for backing the asset-backed real monetary equivalents.

Once again, if the use of asset-backed real monetary equivalents are acceptable within the given system, then the system should specify just what types of derivatives are acceptable for such backing. The most obvious choices are the real-principal-only (RPO) strips from either Treasury Inflation Protection Securities (TIPS) or from Real Mortgage-Backed Securities™ (RMBS). The careful control of the issuance of the asset-backed real monetary equivalents is crucial, since any fraud or misrepresentation in this function could quickly destroy the system. The establishment of additional safeguards would be wise.

As an example, see Table 79.
Box 158: Initiate a record of permitted asset classes, along with the defined marketplaces that are formally recognized by the system for the securitization of the respective asset classes.

The larger purpose of the system is to establish an economic sphere that will not only adopt a single master real currency, even if represented by more than one asset-backed real monetary equivalents, but will also begin to form a financial communications network by and between the defined marketplaces that are dedicated to the various asset classes. The simple act of different defined marketplaces, each dedicated to a different primary asset class, all adopting the master real currency unit of the system; will validate the system and its master real currency unit. Therefore, any given system should make a concerted effort to promote the development of one or more defined marketplaces in a number of different primary asset classes. The record of permitted asset classes, along with the defined marketplaces that have already been recognized, begin to fulfill this goal. Just as no man is an island, neither is any defined marketplace. It is essential that wealth can be transferred in real terms from one industry to another.

As an example, see Tables 79 and 80.

Process II: The Pre-Formation of the Initial Defined Marketplace.

Over time, the development of a multi-phase monetary system may be affected by the acceptance the asset-backed monetary equivalent it essentially defines and supports. The wide-spread use of such an asset-backed real monetary system is therefore directly linked to the overall success of the system. As such, it should be immediately recognized that the multi-phase monetary system, once established, can be used to create a market for may different types of asset classes. We will refer to the development of a marketplace, utilizing the multi-phase monetary system, as a “defined marketplace.” At the same time, more than one defined marketplace may be developed for a single asset class, such as Fannie Mae and Freddie Mac which compete for single family home mortgages beneath a certain threshold amount. Therefore, it is important for each defined marketplace to be properly named, so the system can not only function with multiple defined marketplaces, but also distinguish between them. This is roughly equivalent to investors wanting to know if they are buying Fannie Maes or Freddie Macs.
Box 160: Name the marketplace.

Inasmuch as we are creating a new multi-phase monetary system, we must name the initial defined marketplace that is to function within the system with the understanding that many different conduits and sponsors may function within any given defined marketplace over time. Nonetheless, it is essential to properly name and define the marketplace, since all successful marketplaces must establish their own ways of doing business over time. The agreement of the participants in the defined marketplace to abide by its ways of doing business is typically signified by membership in the named marketplace. In the case of the invention, membership in various defined marketplaces, and the participants acceptance of various methods of doing business within their respective defined marketplaces, may be signified by the participants' agreement to the standards established by the Real Monetary Software™ license. No doubt, this would be in addition to other conventions established by the membership of the defined marketplaces themselves.

### EXAMPLE

Name of the defined marketplace: Real Mortgage™ Association (RMA)

See Tables 81 and 82 as additional examples.
Box 165: Initiate a marketplace index, or other means, that will logically allow users to access the screens, functions and data stored by the marketplace.

Initiate the marketplace index as described in the Box above.

See Table 81 as an example.
Box 170: Define the marketplace by selecting the asset class(es) that will directly or, indirectly, back the securities to be issued and traded in the defined marketplace.

In any modern economy, such as the United States's economy, both business interests and government functionaries have come to recognize the need to develop highly liquid financial markets; so that any given financial institution or investor may alter its investment portfolio in an efficient manner. The most successful way of developing highly liquid marketplaces for any given asset class is the use of securitization, whereby the assets are collected from participating institutions, then pooled and securitized. After the securitization process is complete, the institutions have effectively sold their assets for cash, or conversely, traded them for a highly liquid security such as Fannie Maes; after which the institution has the capital to fund additional assets for future securitization. In this manner, the defined marketplace becomes relatively liquid, such that institutions know that if they make a 30-year loan, they need not hold it until its term or its prepayment. Hence, the assets sold, traded and securitized within the marketplace, effectively define the marketplace. If we are to bring the benefits of real financial instruments to any given class of assets, such as mortgages, auto loans, consumer loans, etc., then we must establish a defined marketplace that is dedicated to this purpose.

### EXAMPLE

### The Asset Classes that Define the Marketplace Known as the Real Mortgage™ Association

(A) Primary Asset
Classes: Real Mortgages™ on:
   (1) multi-unit residential properties
   (2) single family homes
   (3) commercial properties subject to (1), (2) and (3) being located within the U.S.

(B) Secondary Asset
Classes: Issued &/or stripped securities, including:
   (1) Real Mortgage-Backed Securities
   (2) RMBS derivatives, including:
      (a) real-interest-only (RIO) strips
      (b) real-principal-only (RPO) strips
         (i) nominal principal-only (NPO) strips
         (ii) accrued-interest-only (AIO) strips (i.e. accrual rights)
      (provided (1) and (2) above qualify as “regular interests” issued by a REMIC or FASIT)
   (3) U.S. Treasuries
      (permitted for FASITs only)

(C) Qualified Asset
Classes: See (A) and (B) above

The primary asset classes and secondary asset classes (collectively the qualified asset classes) define the types of assets that will be used to directly, or indirectly, back the securities to be issued by conduits functioning within the defined marketplace. This nomenclature is derived from the United States's 1986 Tax Reform Act (TRA), which officially recognized real estate mortgage investment conduits (REMICs) by granting them the right to make a tax election as a tax conduit. Simply stated, this means that the sponsors of the conduit, and the investors purchasing the securities issued by the conduit, are assured that the entity will be treated as a tax conduit for federal income tax purposes; provided that the entity adhere to certain rules and restrictions. (In other words, the profits and losses of the conduit then flow to through to the individual investors, before they are subject to taxation by the federal government. Hence the term “conduit.”)

These rules say in essence that a REMIC can invest in two types of assets, including (a) qualified mortgages and (b) the regular interests (or mortgage-backed securities) issued by other qualified REMICs. Later, the government approved the financial asset securities investment trust (FASIT), which became available for use in 1997. The FASIT is also an election to be treated as a tax conduit, except that it allows for a much broader range of investments within a single FASIT. As such, it is permissible for the FASITs functioning within a defined marketplace to invest in additional asset classes beyond real estate mortgages. For this reason in the example above, the Real Mortgage™ Association has approved U.S. Treasuries as an acceptable asset class for FASITs. In actuality, it could approve many other asset classes as well for conduits qualifying as a FASIT, but more likely, it will elect to limit the asset classes to focus on developing the market for a given asset class such as mortgages. The addition of the U.S. Treasuries simply provides a convenient investment class for funds held on a shorter-term basis or for longer term liquidity.

See Table 82 as an additional example.
Box 180: Select the multi-phase monetary system(s) within which the defined marketplace will function, then input the system(s)'s parameters, conventions and monetary phases.

If the defined marketplace wishes to participate in the benefits that a well-organized multi-phase marketplace can offer, then it must effectively adopt the system's parameters, conventions and monetary phases. The participation of a number of defined marketplaces over time in a given system will generate credibility and market strength to the master real currency, and later the asset-backed real monetary equivalent, that is effectively created by the system. As this real monetary equivalent achieves a greater level of acceptance in the marketplace, the very use of the asset-backed real monetary equivalent can effectively reduce capital costs throughout the system; which is one of the primary incentives for participation.

Nonetheless, it should be further noted, that a defined marketplace may function in more than one multi-phase monetary system at the same time, assuming the systems share the same parameters, substantially the same conventions and the same monetary phases. A rough analogy in today's nominal monetary marketplace would include the sale of Fannie Mae securities, (with the market defined as Fannie Mae) by both the New York Stock Exchange (NYSE) and the National Association of Securities Dealers (NASD) representing different systems.

See Tables 75 and 82 as examples.
Box 182: Selecting from the generations of real financial instruments approved by the system, define the generations or real financial instruments approved by the defined marketplace for participating conduits.

While the system establishes the generations of real financial instruments that are permissible within the system; each individual defined marketplace may narrow this selection, but is limited to those selected by the system. It is important for conduit sponsors, and other participants, to know exactly what generations of real financial instruments are permitted within a given defined marketplace. The presence or absence of a given generation may affect their election to work within any given defined marketplace.

See Tables 76 and 83 as examples.
Box 184: Selecting from the indexes approved by the system, define the qualifying and pricing indexes that are approved by the defined marketplace for participating conduits.

Once again, the system establishes the permitted qualifying and pricing indexes, which the conduit can elect to adopt in full or reduce in number.

See Tables 76 and 83 as examples.
Box 190: Optional: The defined marketplace may readjust the system's conventions, and even create new conventions, provided that these changes do not affect the purchasing power of the master real currency unit.

While the parameters are absolutes, the system's conventions may be readjusted, and the system may even establish new conventions as guidelines for its participants; provided only that any and all such changes do not affect the purchasing power of the master real currency unit. This is crucial, since the primary benefit offered by the multi-phase monetary system is a currency with a constant level of purchasing power for use by and between the participants of different defined marketplaces.

See Table 82 as an example.
Box 200: Input the defined marketplace's quantitative underwriting standards for each selected asset class (or subclass) as the case may be.

Establishing the correct underwriting standards for the asset class(es) (or subclasses) for the offering of real financial instruments into a nominal monetary marketplace is crucial to the acceptance of the issued securities by investors. In 1989, the Department of Housing and Urban Development (HUD) announced in an article printed by Forbes magazine on Jan. 23, 1989 that it was going to begin offering price-level-adjusted (PLAM) mortgages for low-to-moderate income families. The PLAM mortgage is a first generation real financial instrument that is priced at a fixed margin (or real rate) over an agreed upon inflation index. HUD intended to help families that could not currently qualify for a mortgage, obtain financing to purchase a house. Many such families would qualify for a PLAM, HUD reasoned, if they were qualified at a 5.0% real rate of interest. While this will eventually work, when such borrowers are paid in an asset-backed real monetary equivalents; it will not work in a nominal monetary marketplace.

In the opinion of the inventor, this would not work because it created certain credit-related problems. Specifically, the payments on first generation real financial instruments increase in direct proportion to the rate of inflation over time. As such, the borrower's income must also increase at the rate of inflation, if the borrower is qualified at the real rate of interest. While historical studies in the United States indicate that rents and incomes do generally keep up with inflation over longer ten, twenty or thirty year time periods, the data also indicates that rents and incomes can lag behind inflation in shorter recessionary time periods of three to five years in duration.

In addition, at the time the Forbes article was printed, nominal fixed-rate mortgages were at about 9.0%. By qualifying people at the real rate of interest, instead of the nominal rate of interest, the borrower would qualify for a mortgage that would be 150% the size of the mortgage the borrower would otherwise qualify to receive. If this occurred, and the PLAM mortgage was offered on a wide-spread basis, it would lead to hyperinflation in the real estate market. Five years from now, everyone would still live in the house of their choice, but they would be paying 50% more for the house. And, everyone's income would have to keep up with inflation each year, since their mortgage payments would also be increasing with inflation each year. This is not a tenable situation in a nominal monetary marketplace. It will only work if rents and incomes are based in an asset-backed real monetary equivalent, then, rents, incomes and mortgage payments would all be fixed in the constant monetary unit of the asset-backed real monetary equivalent. Then, and only then, can we begin to qualify home owners at the real rate of interest, as HUD proposed to do. Unfortunately, we still live in a nominal monetary marketplace.

As such, it is essential to realize that these credit-related problems would effectively scare away institutional investors. In fact, HUD has yet to offer a PLAM mortgage to the general public, although it may have participated in some pilot programs. Nonetheless, these problems can be easily resolved for the general marketplace, although the method of correcting these credit-related problems may initially defeat HUD's original goal. However, as programs offering PLAM-type mortgages to the marketplace become established for suburban housing, it should be possible to create add-on programs that will begin to include inner-city housing under preferential terms. If the inner-city housing for low-to-moderate families is a small proportion of the total mortgage pool being securitized, then the securitization sponsor should still be able to market the issued securities. This means that the sponsor must tolerate a small decrease in the creditworthiness, and hence the marketable value, of the issued securities. As the marketplace converts from nominal to real terms, as evidenced by the wider-spread use of the asset-backed real monetary equivalent; then financial professionals should be able to shift from the use of nominal rates to real rates for underwriting the mortgages.

The answer to the credit-related problems is relatively simple, but employs an underwriting process that currently does not exist in the marketplace today. In essence, the assets should be underwritten using traditional nominal underwriting standards to determine the size of the qualified loan amount for each loan applicant. Once the qualified loan amount is ascertained, then the loan should be converted to real terms. As an example, the subsequent drop from the nominal amortizing rate to the real amortizing rate for a multi-unit residential property will increase the debt-service-coverage from about 1.25 to a range of 1.65 to 1.85, based upon recent terms in the marketplace.

As such, we have cured the credit-related problems associated with first generation PLAM mortgages. The institutional investor will be satisfied that the inflationary impact is gone, since we have committed to grant a loan no larger than the applicant will qualify for under traditional nominal terms. In addition, the borrower's rents and/or income no longer have to keep up with inflation, because we have over-qualified the borrower at the higher nominal rate. At an inflation rate of 3.0%, and assuming that the operating expenses and debt service payments both increase at the rate of inflation; it will take about nine years before the apartment building owner will have trouble making his debt service payments. In other words, if a problem does occur, the borrower should have ample opportunity to recognize the problem and refinance his or her property.

Finally, just as the use of nominal rates will ultimately be replaced by the use of real rates in the underwriting process, so too will the capitalization rates of properties in the marketplace. This will represent a one-time shift, that appears to be inflationary. In reality, the marketplace has been devaluing real estate properties, due to the inflationary premium that is built-into nominal fixed rates. By removing the inflationary premium, the Real Mortgage™ can increase the cash-on-cash return on an apartment building from about 7% to about 14%, assuming current rates and a 75% lone-to-value ratio. Therefore, as the Real Mortgage™ is introduced into the marketplace for investment properties, the higher cash-on-cash returns offered by the Real Mortgage™ will gradually increase the values in the marketplace until they reach a new equilibrium that could more appropriately be expressed by using a real capitalization rate. Once this one-time-only shift in property values occurs, then properties should have a constant real value less the untended depreciation and/or obsolescence of the property over time. Once again, based upon current rates and terms, a real estate property could depreciate in real value at the rate of two percent (2.0%) per year, and the Real Mortgage™ would still be properly secured over the thirty year term.

Therefore, the initial underwriting standards may be expressed in a format similar to the example below for mortgages with the understanding that the shift from nominal terms to real terms must be managed by the underwriters over time:

### EXAMPLE

The Real Mortgage ™ Associations's Quantitative
Underwriting Standards for Multi-Unit Residential Properties

| | |
|---|---|
| For mortgage qualification: | |
| Qualifying Index(es): | U.S. Treasuries (or LIBOR) |
| | of equal term |
| Maximum Term: | 30 years |
| Debt Service Coverage: | 1.25 |
| Margin: | 140 basis points |
| Maximum Leverage: | 75% loan-to-value based on |
| | an acceptable appraisal |

We can then use these quantitative underwriting standards to qualify the loan applicant for the size of the mortgage we are willing to grant, assuming the applicant meets the qualitative underwriting standards which are highly subjective from one lender to the next.

### QUALIFICATION EXAMPLE

| Item: | Amount: | Formula: |
|---|---|---|
| Property's Net Operating | $500,000 | NOI |
| Income: | | |
| Debt Service Coverage: | 1.25 | DSC |
| Property's Qualified Debt | $400,000 | NOI/DSC = QDS |
| Service: | | |
| Maximum Term in Years: | 30 | T |
| Qualifying Index Rate: | 6.00% | QIR |
| Margin: | 1.40% | M |
| Nominal Qualifying Rate: | 7.40% | QIR + M = NR |
| Qualified Principal | $4,814,313 | QPA¹ = @PV(QDS, NR, T) |
| Amount¹: | | |
| Appraised Value: | $6,400,000 | AV |
| Maximum LTV: | × .75 | LTV |
| Qualified Principal | $4,800,000 | QPA² = AV × LTV |
| Amount²: | | |
| Qualified Loan Amount: | $4,800,000 | the lower of QPA¹ or QPA² |

The Real Mortgage™ (or real financial instrument) is then granted in real terms. This is no problem, since by definition on the origination date of the loan the real currency unit is defined as being equal to the nominal currency unit. Therefore, we can summarize the result of this process below:

Comparing the Qualifying Terms of a Nominal Fixed-Rate
Mortgage To The Real Mortgage ™ Granted

| | Nominal | Actual |
|---|---|---|
| | Qualifying | Real |
| | Terms: | Terms: |
| Qualified Loan Amount: | $4,800,000 | $4,800,000 |
| Qualifying Interest Rate: | 7.40% | N/A |
| Actual Real Rate: | N/A | 5.00% R |
| Inflation Index: | N/A | CPI-U |
| Term of Loan in Years: | 30 | 30 |
| Debt Service Payment: | $400,000 (fixed) | $309,209 (variable) |
| Debt Service Coverage: | 1.25 | 1.62 |

In summation, we use the traditional, nominal underwriting standards in the marketplace to quantitatively underwrite the principal amount of the real financial instrument to be granted, then you convert to real terms using the same principal amount but a real rate of interest. Inasmuch as the real currency unit equals the nominal currency unit on the origination date of the real financial instrument, we can use the qualified loan amount for the traditional nominal financial instrument for the real financial instrument. In so doing, we satisfy the credit-related problems associated with offering real financial instruments in a nominal monetary marketplace. Then, as an asset-backed real monetary equivalent is introduced into the marketplace, underwriters can gradually shift towards the use of real rates of interest for qualifying the loan amounts. As asset prices accelerate due to the higher cash flows, and as rents and incomes begin to be paid in an asset-backed real currency; then the acceptance of real financial instruments qualified in real terms will become acceptable.

See Table 83 as an additional example.
Box 210: Input the defined marketplace's requirements for loan application data that will be used for qualified underwriting purposes for each asset class (or subclass) as the case may be.

In addition to quantitative data, certain qualitative data will also be required with each real financial instrument that is to be funded within a given defined marketplace or conduit. While the qualitative data, and the assessment thereof, may vary from one conduit to the next, there is a certain amount of qualitative data that should be included with each and every loan application. Certainly, this qualitative data may vary somewhat, depending upon the type of asset class. Just as Fannie Mae establishes such standards for Fannie Mae mortgages, so too will participating investors and conduits expect the defined marketplace to establish the minimum amount of qualified data that is required. Inasmuch as such data is not directly pertinent to the offering of real financial instruments, over and above normal nominal underwriting procedures; no examples are included herein.

The single exception may be the age of the physical assets to be financed. While it may appear that real estate almost always appreciates, this is an illusion caused by inflation. Certainly, the value of improved real estate increases with inflation, but this only represents the cheaper value of the nominal currency. In reality, real estate depreciates in real terms, very much like any other asset. Therefore, the age of the asset being financed is an important qualitative underwriting consideration.

See Table 83 as an example.
Box 211: Initiate the marketplace's record of master inflationary adjustment factors (MIAFs); then input each new month's inflation index number and MIAF, which are obtained from the systems's record of MIAFs created via Box 130.

The defined marketplace should maintain a record of the master inflationary adjustment factors (MIAFs) for each conduit participating within the defined marketplace. This will be an important informational resource for the conduits as they begin to purchase secondary assets from each other, including asset-backed securities, accrual rights and derivatives. The complexity of tracking the monetary values on each of these secondary assets is such, that many conduits may accept the payment streams as calculated by the issuing conduit. Nonetheless, there should be a way to audit this work, which will require ready access to the MIAFs of the various participating conduits.

See Tables 76 and 84 as examples.
Box 213: Initiate the marketplace's record of inflationary adjustment factors (IAFs); then input each month's new (1) inflation index number, (2) and the formulas for calculating (2) the prevailing rate of inflation (PRI) and (3) the IAF, whereby the required values for (1), (2) and (3) can all be obtained from the system's record of MIAFs created via Box 130 or Box 174.

The defined marketplace should maintain a record of the inflationary adjustment factors (IAFs) for each conduit participating within the defined marketplace. This will be an important informational resource for the conduits as they begin to purchase secondary assets from each other, including asset-backed securities, accrual rights and derivatives. The complexity of tracking the monetary values on each of these secondary assets is such, that many conduits may accept the payment streams as calculated by the issuing conduit. Nonetheless, there should be a way to audit this work, which will require ready access to the IAFs of the various participating conduits.

The formula for the prevailing rate of inflation (PRI) can be calculated from either the inflation index numbers, or for the MIAF's, for each successive month or other time period. The prevailing rate of inflation is simply the percentage change between the subject inflation index number (or MIAF) and the inflation index number (or MIAF) one year prior to the commencement of the subject period (all subject to the inflationary lag). This can be expressed as follows:

$$\underline{Using the Inflation Index to Calculate the PRI \text{:}}$$

$$Assuming \text{:}$$

$${CPI}^{Jan 97} = the inflation index number for January , 1997$$

$${CPI}^{Jan 98} = the inflation index number for January , 1998$$

$${PRI}^{MAR 98} = the prevailing rate of inflation for March , 1998 , ( assuming a two month inflationary lag )$$

$$Then \text{:}$$

$${PRI}^{MAR 98} = \frac{{CPI}^{Jan 98} - {CPI}^{Jan 97}}{{CPI}^{Jan 97}} \times 100$$

$$Or , conversely \text{:}$$

$$\underline{Using the MIAF to Calculate the PRI \text{:}}$$

$$Assuming \text{:}$$

$${MIAF}^{Jan 97} = the inflation index number for January , 1997$$

$${MIAF}^{Jan 98} = the inflation index number for January , 1998$$

$${PRI}^{MAR 98} = the prevailing inflation rate for March , 1998 , ( assuming a two month inflationary lag )$$

$$Then \text{:}$$

$${PRI}^{MAR 98} = \frac{{MIAF}^{Jan 98} - {MIAF}^{Jan 97}}{{MIAF}^{Jan 97}} \times 100$$

We can also use the either the inflation index, or the system's MIAFs, to calculate the inflationary adjustment factor. The formulas for calculating the IAF are as follows:

$$\underline{Using the Inflation Index to Calculate the IAF \text{:}}$$

$$Assuming \text{:}$$

$$January , 1997 = the initiation date of the subject instrument$$

$${CPI}^{Jan 97} = the inflation index number for January , 1997$$

$${CPI}^{Jan 98} = the inflation index number for January , 1998$$

$${IAF}^{MAR 98} = the inflationary adjustment factor for January , 1998 , \\ Then \text{:}$$

$${IAF}^{Jan 98} = 1 + \frac{{CPI}^{Jan 98} - {CPI}^{Jan 97}}{{CPI}^{Jan 97}}$$

$$Or , conversely \text{:} \\ \underline{Using the MIAF to Calculate the IAF \text{:}} \\ Assuming \text{:} \\ January , 1997 = the initiation date of the subject instrument \\ {MIAF}^{Jan 97} = the inflation index number for January , 1997 \\ {MIAF}^{Jan 98} = the inflation index number for January , 1998$$

$${IAF}^{MAR 98} = the inflationary adjustment factor for January , 1998 , \\ Then \text{:} \\ {IAF}^{Jan 98} = 1 + \frac{{MIAF}^{Jan 98} - {MIAF}^{Jan 97}}{{MIAF}^{Jan 97}}$$

The direct calculation of the marketplace's MIAF's and IAFs, using the systems's MIAFs, will assure that everyone receives the same value and will also make it an easy matter if a given system wishes to change it's base-line-date . . . perhaps to merge with another system. Everything will then self-calculate by itself throughout the system, the defined marketplaces, the conduits, the primary assets, the issued securities and the stripped securities. If everyone is using a different source for their numbers, changing the system's BLD could be a major challenge.

See Tables 76, 84 and 85 as examples.
Box 214: Initiate the defined marketplace's record of approved sponsors, including appropriate market data on each.

Simply stated, the defined marketplace should post a list of the approved conduit sponsors, along with any pertinent market data. This data should be accessible by other sponsors and investors, who are or intend to function within the defined marketplace.

See Table 86 as an example.
Box 216: Initiate the defined marketplace's record of approved conduits, including appropriate market data on each.

Once again, the defined marketplace should post a list of the approved conduits, along with any pertinent market data. This data should be accessible by other conduits, sponsors and investors, who are or intend to function within the defined marketplace.

See Table 86 as an example.
Box 218: Optional: Input the defined marketplace's approved monetary equivalents, including their respective (1) names, (2) asset-backing and (3) issuer, if more than just the fiat currency.

Once again, if the defined marketplace elects to accept the use of asset-backed real monetary equivalents, then it should specify just what monetary equivalents are approved by name, asset-backing and issuer. This list should include the fiat currency to avoid confusion and acknowledge that the fiat currency will still be accepted as the legal tender that it is. In the event that the defined marketplace has not elected to accept use of any third generation real financial instruments, such as the asset-backed real monetary equivalents; then no posting is required. It will be assumed that the default currency is the fiat currency as the legal tender that it is.

See Table 86 as an example.

Process III: The Pre-Formation of the Initial Conduit.

The conduit is the entity that will purchase the qualified assets and then issue the real asset-backed securities. The term “conduit” is derived from the entity applying to the Internal Revenue Service for treatment as a tax conduit, which simply means that the losses and gains of the conduit will pass through to the security holders without the conduit being taxed.
Box 220: Name the conduit.

Inasmuch as the invention, Real Monetary Software™, will be tracking multiple conduits over time, it is important that each conduit be given an easily recognizable name.

### EXAMPLE

Name of the Conduit: RMC Real Mortgage™ Senior/Subordinate Trust I (RMC “I”)

See Tables 82 and 89 as additional examples.
Box 225: Initiate an index for the screens, charts, projections, graphs, records, etc. that will be generated for the operation and maintenance of the conduit.

Initiate the conduit index, or other means, as described in the Box above.

See Table 82a-g as an example.
Box 230: Define the conduit's tax election.

By definition, the entity used for the securitization of the qualified assets should be a tax conduit. For instance, conduits securitizing mortgages may elect treatment as a real estate mortgage investment conduit (REMIC) or a financial asset securitization investment trust (FASIT). It is necessary to know what kind of tax election is being claimed, since each type will have certain limitations that must be adhered to. As such, we must make a tax election before defining the asset class(es) of the conduit.

### EXAMPLE

| Conduit: | Tax Election: |
|---|---|
| RMC Real Mortgage ™ Senior/ | REMIC |
| Subordinate Trust I (RMC “I”) | |

It is also important for the current and future investors purchasing the conduit's issued securities to know what the tax election will be, since many entities may be prohibited from making certain types of investment with respect to their tax elections. For instance, a financial asset securitization investment trust (FASIT) can purchase securities issued by a real estate mortgage investment conduit (REMIC), but a REMIC may not purchase FASIT-issued securities. Such information will be required by the larger marketplace, at such time as a liquid market for the accrual rights and derivatives is initiated.

See Table 88 as an additional example.
Box 232: Define the asset class(es) that will be funded by the sale of the conduit's issued securities.

Simply stated, the defined marketplace may have defined a broad range of real financial instruments that will be written within one or more given asset class(es), nonetheless most conduits will confine themselves to a narrower sub-class.

### EXAMPLE

Defining the Asset Classes of the Conduit

| Conduit: | Asset (Sub-)Class(es) |
|---|---|
| RMC Real Mortgage ™ Senior/ | (1) Real Mortgages ™ on multi- |
| Subordinate Trust I (RMC “I”) | unit residential properties |
| | *(2) Real Mortgage-Backed |
| | Securities (RMBS) from |
| | other conduits funding Real |
| | Mortgages ™ |
| | *(3) RMBS derivatives, including |
| | RIO strips |
| | RPO strips |
| | NPO strips |
| | AIO strips |
| *Please note that (2) and (3) does not apply to the initial conduit, but only to subsequent conduits; if the initial conduit is a REMIC. Basically, when initially introducing Real Mortgages ™ into the marketplace, there are no RMBS or RMBS derivatives for the initial conduit to purchase. This is especially true if the initial conduit is a REMIC, since the REMIC must purchase all the qualified assets with the start-up date with the exception of a small window for | |
| # exchanging purchased assets. If the initial conduit is a FASIT, then in theory it could purchase both its own and other conduit's RMBS and derivatives subsequent to the start-up date. | |

*Please note that (2) and (3) does not apply to the initial conduit, but only to subsequent conduits; if the initial conduit is a REMIC. Basically, when initially introducing Real Mortgages™ into the marketplace, there are no RMBS or RMBS derivatives for the initial conduit to purchase. This is especially true if the initial conduit is a REMIC, since the REMIC must purchase all the qualified assets with the start-up date with the exception of a small window for exchanging purchased assets. If the initial conduit is a FASIT, then in theory it could purchase both its own and other conduit's RMBS and derivatives subsequent to the start-up date.

See Table 88 as an additional example.
Box 240: Select the defined marketplace within which the conduit will market its issued securities and accrual rights, then input the parameters, conventions and monetary phases of the defined marketplace; which the defined marketplace substantially (see Box 190) adopted from its system.

Each conduit must select the defined marketplace within which it intends to market its issued securities. Once selected, the conduit must substantially (see Box 250) adopt the parameters, conventions and monetary phases of the defined marketplace. This is essential in order to resolve the key marketing problem associated with the introduction of real financial instruments into the nominal monetary marketplace. The key problem being to bring liquidity to the accrued interest that is inherent in all real financial instruments during inflationary time periods, unless the principal paid in such time periods exceeds the amount of interest being accrued due to the inflationary adjustment. Resolving this problem means that we must create a market for the accrual rights (or AIO strips) that are stripped off the real asset-backed securities. This market is best achieved by defining said market in terms of the master real currency, which can only be achieved if the conduits and defined marketplaces substantially adopt the system's conventions, parameters and monetary phases in such a way that everyone shares a common master real currency unit.

See Table 88 as an additional example.
Box 250: Optional: The conduit may readjust the defined marketplace's conventions, and even create new conventions, provided that these changes do not affect the purchasing power of the master real currency unit.

While the parameters and the monetary phases adopted from the defined marketplace (and indirectly from the system) cannot be altered, since it would directly affect the purchasing power of the master real currency; nonetheless it is possible for each conduit to adjust the defined marketplace's conventions or even create new conventions; provided only that such changes do no affect the purchasing power of the master real currency.

See Table 88 as an example.
Box 260: Input the defined marketplace's quantitative underwriting standards, which the conduit adopts for the given asset class; which will be used to determine the qualified loan amount for the real financial instruments being funded.

The conduit must adopt the defined marketplace's underwriting standards for the given asset class. If you want to do Fannie Mae mortgages, then you must abide by Fannie Mae's underwriting standards. (In addition, see the explanation for Box 200.)

See Table 89 as an example.
Box 270: Input the conduit's qualitative underwriting standards, which should include the defined marketplace's standards, to be used to subjectively underwrite the loan application.

The conduit's underwriters will need to know a variety of data concerning any given loan application. A very short list might include: the applicant's name, type of legal entity, street address, city, state, zip code, phone numbers; the asset's name, street address, city state, zip code, phone numbers, the amount of the mortgage being applied for, the management company, if any, the size of the building, the size of the real estate parcel, credit report, etc. All of this data is useful to the underwriters in ascertaining the size of the loan that should be granted, if any. Over time, different lenders (or conduit sponsors) will develop a slightly different idea of the importance of the individual data, nonetheless, there is a certain amount of data that the entire industry will want to know. The data considered pertinent on an industry-wide basis is usually reflected in the defined marketplace's qualitative underwriting standards, which the individual conduit will have to obtain at a minimum. (In addition, see the explanation for Box 210.)

See Table 89 as an example.
Box 280: Input the conduit's projected: (1) start-up date, then input the values for the conduit's (2) master inflationary adjustment factor (MIAF), (3) inflationary adjustment factor (IAF) and (4) real currency unit (R$). (Each to be adjusted, when the actual start-up date is known).

Each payment period since the system's base-line-date will have a different MIAF, assuming inflation and/or deflation occurs during each subsequent payment period. The conduit's MIAF can be obtained from the MIAF record established and maintained pursuant to Box 130. The conduit's MIAF is simply the MIAF that is calculated for the period that is also the initiation date of the conduit. In addition, one can also compute the conduit's changing IAF over time by using the MIAF record as disclosed in the discussion on Box 130. While the conduit's MIAF will remain fixed, once calculated, the IAF will change with the passing of each additional period assuming inflation and/or deflation ensues. Finally, the conduit defines a real currency unit to be equal to the nominal currency unit on the initiation date. Thereafter, the real currency unit maintains a constant level of purchasing power, while the nominal currency unit's purchasing power varies with inflation and deflation over time. This is explained in more depth in the description for Box 140 and Box 150.

See Table 89 as an example.
Box 290: Input the conduit's relative, or estimated, (1) qualifying date, (2) qualifying index, (3) range of qualifying index terms, (4) range of qualifying index rates, (5) range of qualifying margins; and then input (6) the formula for calculating the range of qualifying interest rate(s), which is the respective qualifying index rate plus the qualifying margin.

During the preformation of the conduit, it should be possible to estimate information stated above, which will be verified and confirmed upon the formation stage of the conduit. Nonetheless, this information will be used in the following stages for the purpose of generating marketing presentations, stress tests and the structuring and pricing of the resulting asset-backed securities. Each of these in turn will assist the conduit's sponsor in establishing the average returns that his primary asset pool (and later, his qualified asset pool) must have in order to achieve the competitive interest rates required to market the conduit's issued securities. If the sponsor does a poor job of making such pricing estimates, on both the issued securities and on the primary asset class, then he or she may very well suffer a loss on the offering of the issued securities.

The information requested in this Box can be defined as follows: (1) The qualifying date is that date that the index rate is quoted. (2) The qualifying index is the index, adopted from the defined marketplace, that will be used for qualifying the principal amount of the loan to be issued. (3) The range of the qualifying index term is the range of terms in years that will be permitted by the conduit for real financial instrument that are to be funded. (4) The range of qualifying index rates is the given index rate for the given term and date. (5) The range of qualifying margins is the estimated markup or spread the sponsor will try to obtain relative to the quality of the given loan applications. (6) The formula for calculating the qualifying interest rate is simply the qualifying index rate plus the qualifying margin agreed upon for any given loan application. This is the rate that will be used to help establish the principal amount of the loan that the borrower will be qualified to receive, assuming that the loan is acceptable with respect to all other underwriting standards.

See Table 89 as an example.
Box 300: Input the conduit's relative, or estimated, (1) pricing date, (2) pricing index, (3) range of pricing index terms, if any, (4) range of pricing index rates, if any, (5) range of fixed pricing margins; and then input the formula for calculating the effective nominal rate, which is the respective pricing index rate plus the fixed pricing margin.

There are two primary ways to price a real financial instrument. The first way is to price the instrument at a fixed margin over the percentage change in the agreed upon inflation index, which we refer to a first generation real financial instrument. (See Table 89 as an example). The second way is to price the real financial instrument at a fixed margin over a traditional market index, which is the second generation of real financial instruments. (See Table 90 as an example). Each method has certain advantages, depending upon the goals of the conduit's sponsor. In addition, either method of pricing can occur within the same conduit, the same defined marketplace and the same system. This is roughly tantamount to a thrift creating both fixed nominal rate, and variable nominal rate, instruments for sale through Fannie Mae; except that they will be amortized with a real rate of interest. For in either case, the prevailing rate of inflation is then deducted from the effective nominal rate, resulting from the pricing formula, to generate the real financial instrument's amortizing (real) rate of interest.

As we already discussed, the creation of the multi-phase monetary system will create the market structure for the creation of a liquid market for the accrual rights, representing the ownership of the accrued interest for each payment period; thereby resolving the (1) initial marketing problem of full payment liquidity. However, there are two additional marketing problems that occur during the introduction of first generation real financial instruments into the nominal monetary marketplace. These other problems include: (2) the fact that many investors do not trust the use of the inflation index as a pricing index, and (3) the factoring out of the inflationary premium from the real financial instrument's effective nominal rate creates a negative interest-rate-anomaly.

Traditional market indexes, such as the Treasury Bill index and the London interbank offer rate (LIBOR), fluctuate daily with supply and demand in the marketplace. However, the government usually computes the inflation rate from data collected from the marketplace. At the same time, the government is frequently the largest borrower in the marketplace. As such, how can we trust the government not to redefine the inflation index for the purpose of lowering the effective interest rates it must pay over time on real financial instruments that are priced off the inflation index? This is a marketing concern for many potential institutional investors with respect to the first generation of real financial instruments. They prefer that their financial instruments be priced off a market index and not a government-generated index. hence, the pricing off an inflation index creates the second marketing barrier to the introduction of such instruments.

In addition, first generation real financial instruments are usually compared to nominal financial instruments that are priced off a market index. The advantage to the real financial instrument is that it factors out the inflationary premium from the amortizing rate of interest. However, this results in the effective nominal rate of the real financial instrument being less than the nominal rate for the nominal financial instrument. This gap in the nominal rates creates a negative-interest-rate-anomaly, which generally leads to the investment manager investing in the instrument with the highest nominal rate on a current basis. Despite the fact that the selection of a fixed real rate of interest may perform better on an historical basis over time, the investment manager is graded upon his current level of performance this quarter. Hence, the negative interest-rate-anomaly that occurs with first generation real financial instruments creates the third marketing barrier to the introduction of such instruments.

Nonetheless, these marketing problems can be resolved by converting to the early use of the second generation of real financial instruments. Specifically, the real financial instrument can be priced off a short-term market index, such as the 90-day Treasury Bill Index to determine its effective nominal rate. The prevailing rate of inflation is still deducted from the effective nominal rate, to determine the real rate of interest. however, this real rate then becomes a variable real rate, in this case readjusting periodically (monthly or quarterly) with the 90-day Treasury Bill. This immediately resolves the investor's concerns about pricing off of a government-generated index. For while we may be using the annual percentage change inflation index to assist us in determining the real rate of interest, it plays no role in establishing the effective nominal rate of interest. In addition, we have resolved the negative interest-rate-anomaly problem, since short term market indexes have little, if any, inflationary premium built-into them. It simply is not necessary, since the investor will be able to reinvest his money in a short period of time at the new rates if changes occur in the marketplace. And, since the real financial instrument is able to factor out the inflationary premium, it can reallocate a portion of that premium in favor of the securities investor, thereby creating a positive interest-rate-anomaly for the second generation real financial instrument. As such, the second generation of real financial instruments can be very useful for the introduction of real financial instrument into a nominal monetary marketplace. As such, we can define the formulas for the pricing real financial instruments, and the determination of the effective nominal rates of interest, as follows:

### The Formulas Used to Price Real Financial Instruments

Option Number 1: First Generation (with a Fixed Real Rate)
Where:
   Pricing Index=the inflation index
and:
   PRI=the prevailing rate of inflation
   M=the fixed margin
   ENR¹=the effective nominal rate for the first generation of real financial instruments
then:
   ENR¹=PRI+M

Option Number 2: Second Generation (with a Variable Real Rate)
Where:
   Pricing Index=any market index (T. Bills, LIBOR, etc.)
and:
   TBR=90-day Treasury Bill rate
   M=the fixed margin
   ENR²=the effective nominal rate for the second generation of real financial instruments
then:
   ENR²=TBR+M

### EXAMPLE

Pricing Real Financial Instruments
Option Number 1: First Generation (with a fixed real rate)

| Pricing Index: | consumer price index for all |
|---|---|
| | urban consumers (CPI-U) |
| PRI (or percentage | 1.40% (the government-generated index) |
| change in the CPI-U): | |
| Fixed Margin: | 5.00% (also, the real rate) |
| Effective Nominal Rate: | 6.40% |

See Table 89 for another example.

Option Number 2: Second Generation (with a variable real rate)

| Pricing Index: | 90-Day Treasury Bill Index |
|---|---|
| Current 90-Day | 5.05% (the market index) |
| Treasury Bill: | |
| Fixed Margin: | 1.40% |
| Effective Nominal Rate: | 6.45% |

The amortizing (real) rate will be determined in Box 310 below.

See Table 90 for another example.
Box 310: Copy (1) the qualifying index term in years as the amortizing term in years, and (2) input the ratcheting term in months, if any; and then (3) input the formula for calculating the amortizing (real) rate of interest, which is the effective nominal rate of interest less the prevailing rate of interest; and (4) the balloon payment, if any.

The amortizing term should match the qualifying term. The election of a ratcheting term is optional for the individual borrower. It's purpose is to reduce the amount of negative amortization by increasing the amount of principal repayment in the early years without shortening the term of the mortgage. An example of how the ratcheting mortgage would work is just below:

### EXAMPLE

Defining a Ratcheting Term Mortgage

| | |
|---|---|
| Mortgage's Term: | 360 months |
| Amortizing Term: | 300 months |
| Ratchet Interval: | 12 months |
| Ratchet per Year: | 10 months |

EXAMPLE OF A RATCHETING TERM

| Payment | Actual Term | Ratcheting Term | Ratchet per Year |
|---|---|---|---|
| Period: | in Months: | in Months: | in Months: |
| 1 | 360 | 300 | 10 |
| 2 | 359 | 299 | |
| 3 | 358 | 298 | |
| 4 | 357 | 297 | |
| 5 | 356 | 296 | |
| 6 | 355 | 295 | |
| 7 | 354 | 294 | |
| 8 | 353 | 293 | |
| 9 | 352 | 292 | |
| 10 | 351 | 291 | |
| 11 | 350 | 290 | |
| 12 | 349 | 289 | |
| 13-24 | 348-337 | 290-279 | 10 |
| 25-36 | 336-325 | 280-269 | 10 |
| 37-48 | 324-313 | 270-259 | 10 |
| etc. | | | |
| 349-0 | 12-0 | 12-0 | 12 |

The final year of the actual term can be paid off in either ten or twelve months, assuming the instrument go to term; which would make the actual term either 358 or 360 months.

Using the same notation as set forth in the calculation of the effective nominal rates in Box 300 above, we can summarize formulas used in the calculation of the amortizing real rate of interest as follows:

### The Formulas Used To Determine the Amortizing (Real) Rates of Interest for the Real Financial Instruments

Option Number 1: First Generation (with a Fixed Real Rate)
Where:
   ARR=amortizing (real) rate of interest
   ENR¹=the effective nominal rate
   PRI=the prevailing rate of inflation
then:
   ARR=ENR¹−PRI

Option Number 2: Second Generation (with a Variable Real Rate)
Where:
   ARR=amortizing (real) rate of interest
   ENR²=the effective nominal rate
   PRI=the prevailing rate of inflation
then:
   ARR=ENR²−PRI

In essence, we can see that the conversion of the effective nominal rate to the amortizing (real) rate of interest is the same formula for either the first generation of real financial instruments (priced off the inflation index) or the second generation (priced off a market index.) Nonetheless, it is also important to note that the formula for the first generation will give us a fixed real rate of interest, since the margin floating over the inflation index is fixed; but that the second generation will give us a variable real rate of interest, since it is affected by the variance in both the market index and the inflation index. It is also interesting to note that the second generation of real financial instruments, while more marketable in the nominal monetary marketplace; can actually earn a negative real rate of interest.

Once again, the purpose of the ratcheting real financial instrument is to simply pay down the outstanding mortgage balance at a slightly faster rate. This will minimize the negative amortization that is inherent to real financial instruments over inflationary time periods, unless the amount principal paid in the given time period exceeds the inflationary adjustment. The ratcheting real financial instrument will be preferred by those borrowers who are concerned about the negative real rate of interest. Even though the conduit will typically allow the borrower to prepay any amount of principal with any mortgage payment, nonetheless, many borrowers feel that they lack the discipline to make the extra principal payments, unless it is a required part of the terms of their real financial instrument.

Certainly, a conduit could also require or offer a range of balloon payments on the real financial instruments it is offering to fund. However, this may be difficult to securitize due to the negatively amortizing nature of real financial instruments. In essence, a ten or fifteen year balloon may require the repayment of the outstanding balance, just when the negative amortizing in nominal terms is peaking. This will make it difficult to obtain the desired credit ratings on the securities to be issued by the conduits.

In addition, the traditional reasons for the lender's demanding balloon payments no longer apply to real financial instruments that have been securitized. Traditionally, lenders requested balloons, since they were committing to a fixed nominal rate of interest, or a variable nominal rate of interest with interest rate “stops” and “ceilings.” In essence, the lenders wanted a chance to be able to reset the interest rate on the financial instrument, so that it would be in line with the current rate of inflation. However, if properly structured, real financial instruments have no interest rate stops and ceilings. They are fully adjustable over time with respect to inflation and deflation, so the investor is substantially protected against inflation and deflation.

The only variability may arise from a fluctuation in the fixed margin over time; which should be minimal, if not a downward shift. This would make older real financial instruments with larger fixed margins more valuable. At the same time, if there is a shift, it is unlikely to be so great as to cause a wave of repayments. Traditional wisdom is that it takes a 2.0% drop in nominal interest rates, to cover the cost of refinancing; assuming the borrower remains in the property for an additional five years. A 2.0% drop in the real rate would be substantial, and relatively unlikely once the market for real financial instruments has been firmly established.

Lenders also liked balloons, because they wanted some degree of liquidity over time. When lenders made loans in the 1950s through the 1970s, they held most loans to term. However, the very process of securitization should bring a higher degree of liquidity to any type of financial instrument. Hence, given all these factors, the need or desirability for balloons on real financial instruments is minimal.

See Table 91 for an additional example.
Box 320: Input the status of the monetary equivalents for both payments and distributions by designating the conduit's approved monetary equivalents, if any, which must be chosen from the list of the defined marketplace.

Once again, the conduit must establish whether it will accept any, or all, of the monetary equivalents that are approved by the defined marketplace.

See Table 91 for an additional example.

Process IV: Initiating Charts for Inputting Values for Financial Projections for Marketing Presentations and Stress Tests for the Primary Assets for the Initial Conduit.
Box 330: Initiate a chart with the title: “(Real Financial Instrument) Terms”, where “Real Financial Instrument” describes the type of financial instrument that has been selected as the primary asset by the conduit.

Input the title for the chart as described in the Box description above.

The purpose of Boxes 330 to 450 is to create a standard presentation, or stress testing, chart depicting the terms for the primary asset of the initial conduit, which will provide for the appropriate inputs for the purpose of logically disclosing: (A) the calculation of the qualifying interest rate, (B) the qualification terms, (C) the calculation of the prevailing rate of interest and (D) the calculation of the amortizing (real) rate of interest. Inasmuch as the financial projections and graphs created via Process IV are for introductory marketing and stress testing purposes, they will effectively present the real financial instrument against a comparable nominal financial instrument in both the real currency and the nominal currency. This effectively represents the introduction of Conceptual Stage II, which deals with the real currency and the nominal currency only. The movement of active participants in the system to higher conceptual stages will be evident as the invention is developed further to respond to their needs.

The introduction of real financial instruments into the nominal monetary marketplace requires that the instruments be qualified in traditional, nominal terms, but then converted to real terms. The purpose of this chart is to logically set forth just how this is done, for presentation to both potential customers as well as to other interested parties, such as the agencies and credit rating authorities. (Boxes 340 to 450 will describe inputting the data field descriptors, formulas and/or values for this chart.) In addition, the qualification terms will also supply the terms for the nominal fixed rate instrument to be used in the comparison, since real financial instrument uses the same terms to qualify the borrower for the principal amount of the proposed loan.

See the chart entitled: “Real Mortgage™ Terms” in Table 92 as an example for Boxes 330 to 460.
Box 340: On the chart, input the subtitle, “Calculating the Qualifying Interest Rate.” Then, under this subtitle, input the following data field descriptors: (1) data source, (2) date, (3) qualifying market index, (4) market index term, (5) market index rate, (6) qualifying margin and (7) qualifying interest rate.

Input the subtitle and data descriptor fields as set forth in the Box description above.

See “Calculating the Qualifying Interest Rate” in Table 92 for an example.
Box 350: Input the formula for calculating the qualifying interest rate into data field (7), which is the qualifying market index rate in data field (5), plus the qualifying margin in data field (6).

Input the formula as stated in the Box description above.

The qualification formula used for the introduction of real financial instruments into the nominal monetary marketplace is the same as that used for competitive nominal financial instruments. Typically, nominal financial instruments are priced at a fixed margin over a market index rate, such as the Treasury Bill Index, LIBOR or some other approved index. By using the traditional, nominal method of qualifying the borrower for the amount of the real financial instrument, we resolve the credit-related problems discussed earlier. Specifically, the mortgage amount will not be inflationary, nor will the borrower's rents and/or incomes have to directly keep up with inflation. In effect, we are over-qualifying the borrower by using the traditional, nominal qualification rate, and then converting to a real rate for amortizing that has had the inflationary premium removed.

See: “Calculating the Qualifying Interest Rate” in Table 92 for an example.
Box 360: Input the values for the data fields (1) though (6). The qualifying interest rate in data field (7) will then self-calculate due to the formula entered via Box 350.

Input the values for the data fields, which can be described briefly as follows:
(1) Data Source: The source of the market index rate (i.e. the Wall Street Journal)
(2) Date: The date the market index rate was obtained from the data source.
(3) Qualifying Market Index: The market index used to establish the qualifying interest rate (i.e. Treasury Bill Index or LIBOR).
(4) Market Index Term: The term of the market index rate that coincides with the term of the real financial instrument (i.e. 30-year Treasury Bond for a 30-year Real Mortgage™).
(5) Market Index Rate: The current market index rate for the market index term (i.e. 5.70% for 30-Year Treasury Bond on Jun. 15, 1998.)
(6) Qualifying Margin: The margin is the spread over the market index rate that will be used to establish the qualifying interest rate. It is usually established subjectively by the conduit's sponsor, based upon competitive market conditions for the subject asset class.
(7) Qualifying Interest Rate: The rate used to qualify the borrower to determine the principal amount of (a) the real financial instrument and (b) the nominal financial instrument used for comparative purposes

See “Calculating the Qualifying Interest Rate” in Table 92 for an example.
Box 370: On the chart, input the subtitle: “(Real Financial Instrument) Qualification Terms,” where “Real Financial Instrument” describes the primary asset class. Then, under this subtitle, input the following data field descriptors: (8) qualifying interest rate, (9) debt-service-coverage (or equivalent term), (10) term in years, (11) payments per year, (12) balloon payments, (13) inflationary adjustments per year, and (14) maximum loan-to-value.

Input the subtitle and data descriptor fields as set forth in the Box description above.

See “Mortgage Qualification Terms” in Table 92 for an example.
Box 380: Copy the value for the qualifying interest rate, from data field (7) to data field (8). Then input the values for data fields (9) through (14).

Input the values for the data fields, which can be described briefly as follows:
(8) Qualifying Interest Rate: See the value for data field (7).
(9) Debt-Service-Coverage: A factor used by commercial-investment lenders to establish that the borrower will have a certain percentage of surplus cash flow over and above the debt service payment (i.e. a 1.25 DSC means the borrower will have 25% extra cash flow over his debt service payment.) Other types of assets will use a different terminology, but the goal is essentially the same.
(10) Amortizing Term in Years: The term over which the loan is to be amortized, but not necessarily the term of the loan. See “Balloon Payment(s).”
(11) Payments per Year: The frequency of the payments.
(12) Balloon Payment(s): The prepayment of an excess principal amount over and above the normal principal amortization, which is stipulated in the loan agreement.
(13) Inflationary Adjustments Per Year: The frequency of the adjustment of the amortizing interest rate on the real financial instrument, as well as the frequency in the change in the inflationary adjustment factor.
(14) Maximum Loan-to-Value: A set percentage multiplied times the appraised value of the property, which establishes the maximum amount that the lender will lend against the subject property.

See “Mortgage Qualification Terms” Table 92 for an example.
Box 390: On the chart, input the subtitle, “Calculating the Prevailing Rate of Interest.” Then, input the data field descriptors for (15) data source, (16) date, (17) inflation index, (18) measurement period, (19) adjustment period, (20) inflationary lag and (21) (inflation index), which is the value for data field (17). Then, provide of four values after data field descriptor (21), including two index dates in (21a) and (21b) and two inflation index numbers in (21c) and (21d). Finally, input the data field descriptors for (22) prevailing (annual) rate of inflation and (23) payment commencement date.

Input the subtitle and data descriptor fields as set forth in the Box description above.

In Boxes 340 to 380, we have established the data that we will use to qualify the principal amount of the real financial instrument that is to be granted to the borrower, now we must determine what amortizing (real) rate of interest will be granted to the borrower for the qualified principal amount. By presenting this data and the related calculations side-by-side on one chart, we can help the prospective borrower understand the total process.

See “Calculating the Prevailing Rate of Inflation” in Table 92, as an example.
Box 400: Input the formula for calculating the prevailing (annual) rate of inflation for the initial payment period into data field (22), which is the percentage change in the inflation index numbers in data fields (21c) and (21d). These inflation index numbers should represent the inflation index on the dates entered into data fields (21a) and (21b) respectively, with these dates reflecting the proper inflationary lag with respect to the payment commencement date in data field (23).

In the United States, the inflation index measured in any given month is usually compiled and released by the 15^{th} day of the subsequent month; assuming the government performs on a timely basis. Hence, March's inflation index will generally be released on the 15^{th} of April. A two month inflationary lag will then give us 45 days (from April 16^{th} to May 31^{st}) to use the March inflation index numbers to calculate and distribute proper notice for the payments due and payable in June. To make this clear to the prospective buyer, we include the inflation index numbers for March of the previous two years in our presentation chart, which will be used to calculate the prevailing rate of inflation for June, 1998. In essence, the prevailing rate of inflation (PRI) is calculated as follows:

### EXAMPLE

$$Where \text{:}$$

$$CPI \text{-} {U}^{1} = 160.0 for Mar \text{-} 97$$

$$CPI \text{-} {U}^{2} = 162.2 for Mar \text{-} 98$$

$$PRI = prevailing inflation rate for June , 1998$$

$$then \text{:}$$

$$PRI = \frac{( CPI - {U}^{2} - CPI - {U}^{1} )}{CPI - {U}^{1}} = \frac{( 162.2 - 160.0 )}{160.0} = 1.37 \%$$

See “Calculating the Prevailing Rate of Inflation” in Table 92.
Box 410: Input the values for the data field descriptors (15) through (20), (21a) through (21d) and (23). The prevailing rate of inflation in data field (22) will then self-calculate pursuant to the formula supplied in Box 400.

Input the values for the data fields, which can be described briefly as follows:
(15) Data Source: The data source supplying the inflation index data (i.e. the Bureau of Labor Statistics).
(16) Date: The date the inflation index data was obtained.
(17) Inflation Index: The selection of the inflation index to be used in the projections (i.e. the CPI-U).
(18) Measurement Period: The span of time between the two inflation index numbers that will be used to establish the prevailing rate of inflation (i.e. usually annually).
(19) Adjustment Period: How often the prevailing rate of inflation will be calculated to determine a new amortizing (real) rate of interest.
(20) Inflationary Lag: The span of time between (a) the month that the latest inflation index number is released, and (b) the payment commencement date. (The March CPI-U is released on April 15th, which gives us 45 days to project the payments due and owing on June 1^{st}. As such, a two-month inflationary lag (April and May) for payments due in June, would use the March index numbers.)
(21) (Inflation Index): The actual inflation index selected in data field (17), such as the CPI-U.
(21a): Assuming a two (2) month lag, plus the release of the inflation index numbers one (1) month in arrears, plus twelve (12) months earlier; then the value entered here would be the month and year of the inflation index that is fifteen (or 2+1+12) months prior to the month when the payments commence. (i.e. March, 1996 for payments commencing in June, 1998).
(21b): Assuming a two (2) month lag, plus the release of the inflation index numbers one (1) month in arrears, then the value entered here would be three (of 2+1) months prior to the month when the payments commence. (i.e. March, 1997 for payments commencing in June, 1998).
(21c): The respective inflation index number for (21a), such as 160.0 for the March, 1996 CPI-U.
(21d): The respective inflation index number for (21a), such as 162.2 for the March, 1997 CPI-U.
(22) Prevailing (Annual) Rate of Inflation: The annual rate of inflation, subject to the measurement period and the inflationary lag that is used to project the payment streams for the next payment period.
(23) Payment Commencement Date: The date the initial payments on the real financial instrument are projected to commence.

See “Calculating the Prevailing Rate of Inflation” in Table 92.
Box 420: On the chart, input the subtitle, “Calculating the Amortizing (Real) Rate of Interest.” Then, under this subtitle, input the following data field descriptors: (24) data source, (25) date, (26) pricing index, (27) pricing index term, if any, (28) pricing index rate, (29) fixed pricing margin, (30) effective nominal rate, (31) prevailing rate of inflation and (32) amortizing (real) rate of interest.

Input the subtitle and data descriptor fields as set forth in the Box description above.

See “Calculating the Amortizing (Real) Rate of Interest” in Table 92, as an example.
Box 430: Input the formula for calculating the effective nominal rate in data field (30), which is the pricing index rate in data field (28) plus the fixed pricing margin in data field (29).

Input the formula as set forth in the Box description above.

See: “Calculating the Amortizing (Real) Rate of Interest” in Table 92, as an example.
Box 440: Input the formula for calculating the amortizing (real) rate of interest into data field (32), which is the effective nominal rate in data field (30) plus the prevailing rate of interest in data field (31).

Input the formula as set forth in the Box description above.

See: “Calculating the Amortizing (Real) Rate of Interest” in Table 92, as an example.
Box 450: Input the values for the data fields (24) though (29) and copy the value for the prevailing (annual) rate of inflation from data field (22) to data field (31). Then, the effective nominal rate in data field (30), and the amortizing (real) rate of interest in data field (32), will self-calculate due to the formulas entered via Boxes 430 and 440 respectively.

Input the values for the data fields, which can be described briefly as follows:
(24) Data Source: The source of the pricing index rate, such as the Wall Street Journal, if a market index like the 90-day Treasury Bill is used for pricing, or the Bureau of labor Statistics, if an inflation index like the CPI-U is used for pricing.
(25) Date: The date the pricing index rate is quoted. If the pricing index is the CPI-U, then only the month is relevant; but if a market index rate is used, then the precise day is important.
(26) Pricing Index: This indicates the selection of the pricing index for the real financial instrument. If a fixed real rate instrument is desired, then an inflation index should be used. If a variable real rate instrument is desired, then a short-term market index rate should be used.
(27) Pricing Index Term, if any: If a market index is used for pricing, then this indicates the term of the market instrument that is being quoted, such as the 90-day Treasury Bill. The pricing index term does not apply (N/A) if an inflation index is used as the pricing index.
(28) Pricing Index Rate: If the pricing index is the inflation index, then this is the prevailing rate of inflation. If a market index is used, then this is the market index rate quoted on the specified date for the specified term. (i.e. on Jun. 15, 1998 the 90-day Treasury Bill is 5.07%).
(29) Fixed Pricing Margin: This is a subjective margin determined by the sponsor of the conduit subject to conditions in the marketplace. It represents the spread above the pricing index that the given asset class must pay to borrow funds in the marketplace.
(30) Effective Nominal Rate: The effective nominal rate that the borrower will pay for the projected payment period, which is the pricing index rate plus the fixed pricing margin. The term “effective” is used to denote that this is not the rate that is used for amortization purposes.
(31) Prevailing Rate of Inflation: See data field (22).
(32) Amortizing (Real) Rate of Interest: The rate of interest used to amortize the outstanding principal amount of the real financial instrument, which is defined in the real currency. The resulting payment in real currency is then converted to the nominal currency for actual payment using an inflationary adjustment factor. The amortizing (real) rate of interest is the effective nominal rate less the prevailing rate of inflation.

See “Calculating the Amortizing (Real) Interest Rate” in Table 92 for an example.
Box 460: Optional: Input any notes, definitions or disclosures that may be desired on the chart presenting the real financial instrument's terms.

Proceed as stated in the Box description above

See the chart entitled “Real Mortgage™ Terms” in Table 92 for an example.

Commentary on Second Generation Real Financial Instruments:

Please note that Boxes 330 to 460 are also structured to handle second generation real financial instruments, which are variable real rate instruments. By simply changing the values for five data fields, we will change the entire projection from a first generation (with a fixed real rate of interest) to a second generation real financial instrument (with a variable real rate). This can be done as shown below:

### EXAMPLE

| | 1^{st} Gen.: | 2^{nd} Gen: |
|---|---|---|
| (24B) Data Source | BLS | WSJ |
| (25) Date: | 15-Jun-98 | 15-Jun-98 |
| (26B) Pricing Index: | CPI-U | Treasury Bill |
| (27B) Pricing Index Term, if any: | N/A | 90-Day |
| (28B) Pricing Index Rate: | 1.37% | 5.10% |
| (29B) Fixed Pricing Margin: | 5.00% | 1.40% |
| (30) Effective Nominal Rate: | 6.37% | 6.50% |

The (25) date is presumably the same, and the (30) effective nominal rate may change, but it is self-calculating based upon the formula inputted in Box 430. The revised values for the other data fields, used to convert from the first to the second generation, can be described briefly as follows:
(24B) Data Source: This will change from the Bureau of labor Statistics (BLS) to some financial reporting service, such as the Wall Street Journal (WSJ).
(26B) Pricing Index: The pricing index will change from the selected inflation index (CPI-U) to a market index, such as the Treasury Bill. T
(27B) Pricing Index Term, if any: The pricing index term would change from not applicable (N/A) to a period of time, such as 90-Days.
(28B) Pricing Index Rate: The pricing index rate will change from the government-generated prevailing rate of inflation, derived from percentage change in the inflation index; to a market; to the market rate of a short-term market index, such as the 90-Day Treasury Bill, which is a function of supply and demand in the marketplace.
(29B) Fixed Pricing Margin: Although both fixed pricing margins are subjective, they may vary considerably. The fixed pricing margin for the first generation is essentially the real rate of interest; while the fixed pricing margin in the second generation is the current market spread over the market index, roughly equal to the qualifying margin.

It is significant to note here that the invention is employing a unique strategy to resolve certain market-related problems associated with the offering of real financial instruments in the nominal monetary marketplace. The first problem is that many sophisticated investors do not trust the pricing of fixed income instruments off a government-generated index, such as inflation indexes; since the government could later redefine how the index is to computed, thereby lowering its borrowing costs. The second problem is that the first generation real financial instrument tends to compete against the long-term market index, which includes an inflationary premium for the nominal fixed rate instruments priced in this manner. This creates a negative interest-rate-anomaly for the those trying to market the real financial instrument.

The second generation real financial instrument solves these problems by pricing off a short-term market index, such as the 90-Day Treasury Bill, and then deducting the prevailing rate of inflation to determine the amortizing (real) rate of interest. Investors will trust the short-term market index rate, since it is generated by the interaction of supply and demand in the marketplace. And, short-term nominal rates have little, if any, inflationary premium built into their rate structure. It simply is not needed since the outstanding principal will be paid in a relatively short time period. This can convert the negative interest-rate-anomaly to a positive interest-rate-anomaly, since the long-term real financial instrument can pay a premium over the short-term market rate and still be very competitive against long-term rates; despite the fact that it's rate will be readjusted periodically with respect to both the inflation index and the short-term market index.

This solution to the negative interest-rate-anomaly also resolves the problem of the real rate on government bonds, which is artificially high in order to compete with nominal government bonds. This artificial increase in the government bond rate effectively prices the private sector out of the marketplace for the offering of real financial instruments. Finally, we begin to see that the historical Treasury yield curve, spanning for 30-day to 30-year rates on the Treasuries is actually an artificial device effectively displaying the increase in the inflationary premium over this time period. The real yield curve should be relatively flat, despite the time period, since there should be no inflationary premium built into the real rates at any point on the 30-day to 30-year continuum. This is true because the real financial instrument is self-adjusting for inflation and deflation over time and requires no inflationary premium.

Nonetheless, in the early years of the offering of real financial instruments, two trends are likely. First, there will be some price volatility due to the fact that the pricing margin on real financial instruments will be higher upon their initial offering, but will then decline over time as the size of the market increases. In addition, there will be a tendency for real financial instruments priced off the inflation index to exhibit lower real yields for longer-term instruments, and higher real yields for short-term instruments. This will occur in the early years, since the relative scarcity of such instruments will bring a premium on the longer-term protection against inflation. Nonetheless, the development of a substantially larger market will diminish this tendency, as the prevalence of real financial instruments begins to minimize the long-term concern over inflation.

To summarize, the invention's use of the following formula to determine the amortizing (real) rate of interest for the second generation real financial instrument is unique to the marketplace and not obvious:

| CURRENT | |
|---|---|
| MARKET FORMULA: | UNIQUE NEW FORMULA: |
| 1^{st} Generation Formula: | 2^{nd} Generation Formula: |
| Prevailing Rate of Inflation | Short-Term Market Index |
| + Pricing Margin (real rate) | + Pricing Margin (i.e. market spread) |
| Effective Nominal Rate | Effective Nominal Rate |
| − Prevailing Rate of Inflation | − Prevailing Rate of Inflation |
| Amortizing (Real Rate) of Interest | Amortizing (Real Rate) of Interest |

See “Calculating the Amortizing (Real) Interest Rate” in Table 93 to see an example of the pricing of a second generation real financial instrument.
Box 470: Initiate a new chart with the title: “Underwriting Data Supplied by the Loan Applicant.”

Proceed as stated in the Box description above

See Table 94 as an example.
Box 480: On this new chart, input the subtitle: “Qualitative Underwriting Data.” Then, under this subtitle, input the following data field descriptors: (33) date, (34) property type, (35) borrower's name, (36) project name, (37) street address, (38) city, state and zip code, providing one space for each value. Then input data field descriptors for (39) number of units, (40) building size, (41) land area, (42) density, (43) age, (44) replacement reserve, (45) current occupancy, (46) requested loan amount, (47) loan per unit, (48) asbestos and (49) rent control.

Input the subtitle and the data field descriptors as stated in the Box description above.

See: “Qualitative Underwriting Data” in Table 94 as an example.
Box 490: Copy the value for the date, that the qualifying interest rate is determined, from data field (2) into data field (33).

Copy the value as described in the Box description above.

Inasmuch as the subject chart may be one of the print-outs received by a prospective purchaser, the relevant date is not the date the underwriting material is received; but rather the date that the nominal qualifying rate of interest is calculated. The specified date is more important, since the volatility of nominal interest rates in the marketplace can directly affect the principal amount of the loan that the borrower is qualified to receive. Hence, the primary presentation date is the date reflecting the quotation of the nominal interest that is used to qualify the borrower.

See: “Qualitative Underwriting Data” in Table 94 as an example.
Box 500: Input the formula for calculating the density into data field (42); which is the number of units in data field (39), divided by: the land areas in square feet in data field (41), divided by 43,560 square feet per acre.

The data provided in the qualitative underwriting section of this chart is used by financial professionals to develop a quick view of what the subject property is all about. The formula for density will tell us how many units there are per acre, which gives the underwriter a mental image of how many people are likely to be living in the subject property. If the density becomes too high, then the building will experience additional wear and tear; and as such many underwriters may pass on financing the building. Typically, the permitted density for modern buildings is established by the zoning ordinance for the local community.

We can summarize the formula being entered into data field (42) as follows:
Density=Number of Units/(Land Sq. Ft./43,560)=Units/Acre

See: “Qualitative Underwriting Data” in Table 94 as an example.
Box 510: Input the formula for calculating the loan per unit in data field (47) by dividing the requested loan amount in data field (46) by the number of units in data field (39).

Input the formula as set forth in the Box description above.

The amount of the loan per unit that is being requested from the borrower tells the underwriter how realistic the borrower is. If the loan per unit is substantially off, then most underwriters will pass on the loan application.

See: “Qualitative Underwriting Data” in Table 94 as an example.
Box 520: Input the values for data fields (34) through (41), (43) through (46) and (48) & (49). Data fields (42) and (47) will self-calculate due to the formulas input in Boxes 490 and 500 respectively.

Input the values for the data fields, which can be described briefly as follows:
(33) Date: See data field (1) and Box 490.
(34) Property Type: This is the type of property that will be used to secure the real financial instrument for the primary asset class. (i.e. multi-unit residential properties, single family homes, automobiles, etc.)
(35) Borrower's Name: For reference purposes.
(36) Project's Name: For reference purposes, since one borrower may be asking for projections on a number of properties.
(37) Street Address: For reference purposes, since many properties have similar names.
(38) City, State and Zip Code: Three separate data fields that can be used later by the conduit sponsor to sort and compare data from many different applicants based upon location.
(39) Number of Units: For residential properties, the number of living units. (Commercial properties will use net rentable square footage, instead of the number of units.)
(40) Building Size: The gross square footage of the building, measured by the outside perimeter of the building on a floor by floor basis and then totaled.
(41) Land Area: The area of the land upon which the improved property sits in square feet. The implication being that both the land and the building will secure the loan. In the case of a land lease, where only the building is being financed; then the remaining term of the land lease should be stated instead of the land area.
(42) Density: The number of units per acre. See Box 500.
(43) Age: The age of the improved property is important for a long-term real financial instrument; since it may be negatively amortizing in the nominal currency for many years. Despite the fact that inflation has always made real estate appear to appreciate in value over time, the truth is that improved real estate depreciates over time. Hence, the age of the building will have a greater affect on the underwriting of a real financial instrument than a nominal fixed-rate instrument, which is front-end loaded.
(44) Replacement Reserve: A monthly cash set-aside that is frequently required for mortgages on investment properties, that is held by the lender. The purpose of the cash set-aside is to cover capital improvements over the life of the property. As the owner completes the improvements, he is reimbursed by the lender releasing the appropriate amount of the replacement reserve. This minimizes the problem of the owner that refuses to properly care for his or her property.
(45) Current Occupancy: The percentage of the property that has been rented subject to the proposed rent schedule. The underwriter always assumes that the maximum occupancy rate is 95% for any property, but must be careful that it could be considerably less. This directly affects the property owner's ability to make the debt service payments.
(46) Requested Loan Amount: The amount of the loan being requested by the applicant.
(47) Loan per Unit: The requested loan amount divided by the number of units. See Box 510.
(48) Asbestos: Most lenders will not lend against a property with asbestos due to the high cost of removal.
(49) Rent Control: A real financial instrument should not be used to finance an income property where rent control is in place, since the real financial instrument's payments will move up with inflation over time in the nominal currency. If the owner cannot keep his rents up with inflation, then he is lost.

See: “Qualitative Underwriting Data” in Table 94 as an example.
Box 530: On the chart, input the title: “Quantitative Underwriting Data.” Then, under this subtitle, input the following data field descriptors: (50) gross schedule rental income, (51) vacancy, (52) gross operating income, (53) administrative expenses, (54) management fee, (55) utilities, (56) general services, (57) building maintenance, (58) grounds maintenance, (59) marketing expenses, (60) wages & payroll taxes, (61) amenities, (62) real estate taxes, (63) insurance, (64) miscellaneous, (65) total operating expenses, (66) replacement reserve, (67) borrower's stated expenses and (68) net operating income.

Input the subtitle and the data field descriptors as stated in the Box description above.

See: “Quantitative Underwriting Data” in Table 94 as an example.
Box 540: Input the formula for calculating the vacancy in data field (51); which is one minus the occupancy rate in data field (45), times the gross scheduled income in data field (50).

Input the following formula into data field (51):
Vacancy=(1−Occupancy Rate)×Gross Scheduled Rents

See: “Quantitative Underwriting Data” in Table 94 as an example.
Box 550: Input the formula for calculating the gross operating income in data field (52), which is the gross scheduled income in data field (50) minus the vacancy in data field (51).

Input the following formula into data field (52):
Gross Operating Income=Gross Scheduled Income−Vacancy

See: “Quantitative Underwriting Data” in Table 94 as an example.
Box 560: Input the formula for calculating the total operating expenses in data field (65), which is the total of the values in data fields (53) through (64).

Input the formula as described in the Box description above.

See: “Quantitative Underwriting Data” in Table 94 as an example.
Box 570: Input the formula for calculating the replacement reserve in data field (66), which is the replacement reserve per unit in data field (44) times the number of units in data field (39).

Input the formula as described in the Box description above.

See: “Quantitative Underwriting Data” in Table 94 as an example.
Box 580: Input the formula for calculating the borrower's stated expenses in data field (67), which is the total operating expenses in data field (65) plus the replacement reserve in data field (66).

Input the formula as described in the Box description above.

See: “Quantitative Underwriting Data” in Table 94 as an example.
Box 590: Input the formula for calculating the net operating income in data field (68), which is the gross operating income in data field (52) minus the borrower's stated expenses in data field (67).

Input the formula as described in the Box description above.

See: “Quantitative Underwriting Data” in Table 94 as an example.
Box 600: Input the values for data field (50), and data fields (53) through (64). Then, the vacancy in data field (51), the gross operating income in data field (52), the total operating expenses in data field (65), the replacement reserve in data field (66), the borrower's stated expenses in data field (67) and the net operating income in data field (68) will all self-calculate due to the formulas supplied via Boxes 540 to 590 respectively.

Input the values for the data fields, which can be described briefly as follows:
(50) Gross Schedule Income: The amount of income the property owner would receive if 100% of his or her units were fully rented at the scheduled rental rates.
(51) Vacancy: The loss due vacancies and/or bad debts.
(52) Gross Operating Income: The gross scheduled income less the vacancy, which is the gross income earned by the property owner before operating expenses and debt service.
(53) Administrative Expenses: The owner's general office overhead.
(54) Management Fee: The amount paid to the management company for managing the property.
(55) Utilities: Heating, cooling, lighting, sewer & water expenses, but not the mechanical expenses associated with same.
(56) General Services: Any third party services supplied to the building, such as security, mechanical, plumbing, and air conditioning services, etc.
(57) Building Maintenance: Staff expenses associated with maintaining the building.
(58) Grounds Maintenance: Staff expenses associated with maintaining the land site associated with the building.
(59) Marketing Expenses: Advertising, etc.
(60) Wages & Payroll Taxes: Staff compensation and related taxes.
(61) Amenities: Expenses associated with amenities, such as swimming pools, saunas, tennis courts, etc.
(62) Real Estate Taxes: Taxes assessed against the real estate by the local community.
(63) Insurance: Hazard insurance on the subject property, which is required by most loans.
(64) Miscellaneous: Anything not covered by (53) to (63).
(65) Total Operating Expenses: The cost of operating the property, including (53) to (64).
(66) Replacement Reserve: A reserve set aside for capital improvements on the property, including such items as new roofs, windows, air conditioners, furnaces, etc.
(67) Borrower's Stated Expenses: The gross operating income, less the total operating expenses and the replacement reserve.
(68) Net operating income: The gross operating income less the borrower's stated expenses. The net operating income (NOI) is the income the owner would receive after all expenses if he owned the building free and clear. As such, the NOI can be used to value the property.

See: “Quantitative Underwriting Data” in Table 94 as an example.
Box 610: To the right of data fields (50) through (68), for each data field (X) input the following formula: the value of data field (X), divided by the gross scheduled income value in data field (50). Then, display the result as a percentage.

An example of the formula to be entered is as follows:

$$Assuming \text{:}$$

$$Gross Scheduled Income ( GSI ) = \$842 , 400$$

$$Net Operating Income ( NOI ) = \$389 , 530$$

$$then \text{:}$$

$$NOI = .4624 \times 100 = 46.24 \%$$

$$GSI$$

Both experienced property owners, and experienced underwriters, will be able to use these percentages to determine the both the plausibility of the numbers as well as the health of the property being proposed for the financing.

See: “Quantitative Underwriting Data” in Table 94 as an example.
Box 620: Optional: Input notes, definitions or disclosures that may be desired on the chart presenting the underwriting data supplied by the loan applicant.

See: “Quantitative Underwriting Data” in Table 94 as an example.
Box 630: Initiate a new chart with the title: “(Real Financial Instrument) Loan Amount,” where “Real Financial Instrument” is the descriptive name for the loan instrument representing the primary asset class of the conduit.

Input the title for the chart as described in the Box description above.

See Table 95 as an example.
Box 640: On this chart, input the subtitle: “Subject Property.” Then, under this subtitle, enter the following data field descriptor: (69) property name.

Input the subtitle and the data field descriptors as stated in the Box description above.

See: “Subject Property” in Table 95 as an example.
Box 650: Copy the value for the property's name from data field (36) and enter it into data field (69).

Input the values for the data fields, which can be described briefly as follows:
(69) Property Name: See the description for data field (36).

See: “Subject Property” in Table 95 as an example.
Box 660: On this chart, input the subtitle: “Current Qualifying Rate.” Then, under this subtitle, enter the following data field descriptors: (70) qualifying rate, (71) (market index & term), (72) qualifying margin and (73) qualifying interest rate.

Input the subtitle and the data field descriptors as stated in the Box description above.

See: “Current Qualifying Rate” in Table 95 as an example.
Box 670: Copy the values from the data fields for the (2) date, (5) market index rate, (6) qualifying margin and (7) qualifying interest rate; then insert these values into data fields (70) to (73) respectively.

Copy the values for the data fields, which can be described briefly as follows:
(70) Qualifying Date: See the description for data field (2).
(71) (Market Index & Term): This is a composite statement of the values for data fields (3) and (4), such as 30-Year Treasury Bond.
(72) Qualifying Margin: See the description for data field (6).
(73) Qualifying Interest Rate: See the description for data field (7).

While much of the data on this chart appears to be redundant, one must remember the purpose of the chart; which is to educate the reader with respect to how real financial instruments function. As such, a certain amount of redundancy is necessary for clarity. Ideally, each of these charts should be able to stand alone, and answer the obvious questions about the final output on the chart, which is usually new material.

See: “Current Qualifying Rate” in Table 95 as an example.
Box 680: On this chart, input the subtitle: “Net Operating Income.” Then, under this subtitle, input the following data descriptors: (74) gross scheduled income, (75) vacancy, (76) gross operating income, (77) operating expenses, (78) replacement reserve and (79) net operating income.

Input the subtitle and the data field descriptors as stated in the Box description above.

See: “Net Operating Income” in Table 95 as an example.
Box 690: Copy the values from the data fields for the (50) gross scheduled income, (51) vacancy, (52) gross operating income, (65) total operating expenses, (66) replacement reserve and (68) net operating income; then insert these values into data fields (74) to (79) respectively. Then insert the relative percentage of each of these values, as calculated in Box 610, and display them to the right of each respective insertion data field.

Copy the values for the data fields, which can be described briefly as follows:
(74) Gross Scheduled Income: See the description for data field (50).
(75) Vacancy: See the description for data field (51).
(76) Gross Operating Income: See the description for data field (52).
(77) Operating Expenses: See the description for data field (65).
(78) Replacement Reserve: See the description for data field (66).
(79) Net Operating Income: See the description for data field (68).

See: “Net Operating Income” in Table 95 as an example.
Box 700: On this chart, input the subtitle: “Mortgage Qualification Terms.” then, under this subtitle, input the following data field descriptors: (80) qualifying interest rate, (81) debt-service-coverage, (82) mortgage term in months, (83) qualified debt service and (84) principal amount #1.

Input the subtitle and the data field descriptors as stated in the Box description above.

See: “Mortgage Qualification Terms” in Table 95 as an example.
Box 710: Input the formula in data field (82) to determine the mortgage term in months, which is the value in data field (10) times 12.

Input the formula as stated in the Box description above.

See: “Mortgage Qualification Terms” in Table 95 as an example.
Box 720: Input the formula in data field (83) to determine the qualified debt service, which is the net operating income in data field (68), divided by the debt-service-coverage in data field (9).

Input the formula as stated in the Box description above.

See: “Mortgage Qualification Terms” in Table 95 as an example.
Box 730: In data field (84), input any standard formula to compute the present value of a loan instrument, using the values provided in data fields (80), (82) and (83).

Input the formula as stated in the Box description above.

See: “Mortgage Qualification Terms” in Table 95 as an example.
Box 740: Copy the values from the data fields for the (7) qualifying interest rate and (9) debt-service-coverage, then insert them into data fields (80) and (81) respectively. Then, the (83) qualified debt service and (84) principal amount #1 will self-calculate, due to the formulas entered via Boxes 720 and 730.

Copy the values for the data fields as directed in the Box description above. The data fields established in this section can be described briefly as follows:
(80) Qualifying Interest Rate: See the description for data field (7).
(81) Debt-Service-Coverage: See the description for data field (9).
(82) Mortgage Term in Months: This assumes that the real financial instrument will have monthly payments, even if the inflationary adjustment may occur at other intervals.
(83) Qualified Debt Service: This is the annual amount of debt service the property can afford to pay, while maintaining the required debt-service-coverage.
(84) Principal Amount #1: This is the principal amount of the subject loan that the borrower is qualified to receive, based upon a quantitative analysis of the property's cash flow and the other respective terms.

See: “Mortgage Qualification Terms” in Table 95 as an example.
Box 750: On this chart, input the subtitle: “MAI Appraisal (or Acceptable Equivalent). Then, under this subtitle, enter the following data field descriptors: (85) estimated capitalization rate, (86) appraised value, (87) maximum loan-to-value and (88) principal amount #2.

Input the subtitle and the data field descriptors as stated in the Box description above.

See: “MAI Appraisal (or Acceptable Equivalent” in Table 95 as an example.
Box 760: In data field (86), enter the formula for calculating the appraisal value (in lieu of an actual appraisal); which is the value for the (68) net operating income, divided by the value for the (85) estimated capitalization rate.

Input the formula as stated in the Box description above.

See: “MAI Appraisal (or Acceptable Equivalent” in Table 95 as an example.
Box 770: In data field (88), enter the formula for calculating the principal amount #2; which is the (86) appraised value, times the (14) maximum loan-to-value.

Input the formula as stated in the Box description above.

See: “MAI Appraisal (or Acceptable Equivalent” in Table 95 as an example.
Box 780: In data field (85), input the value for the estimated capitalization rate. And, copy the value for the (14) maximum loan-to-value into data field (87). Then, the (86) appraised value and (88) principal amount #2 will self-calculate, due to the formulas entered via Boxes 760 and 770 respectively.

Input and copy the respective values, which can be described briefly below:
(85) Estimated Capitalization Rate: Inasmuch as the function of this section of the software is to prepare marketing presentations and stress tests, the subject properties will be hypothetical or the loan applications will be very preliminary in nature. As such, one must assume that there will be no qualified appraisal on the subject properties, at the current time, if ever. The estimated capitalization rate is a subjective number supplied by the sponsor, or his underwriter, which represents the current return the investors would expect for purchasing the property. By dividing the net operating income with the capitalization rate, we can project the market valuation for the subject property. Capitalization rates can vary substantially from urban areas to suburban areas, representing the relative risk of the investment. The higher the assumed risk, the higher the capitalization rate that the investor will demand when buying the property. Later, when a qualified appraisal is obtained, the appraiser will use an assumed capitalization rate for one method of valuing the subject income property.
(86) Appraised Value: The projected value of the subject property for the purposes of the presentation or stress test. See (85) above for additional information.
(87) Maximum Loan-To-Value: See the description for data field (14).
(88) Principal Amount #2: The projected qualified loan amount derived from the appraisal and the maximum loan-to-value ratio.

See: “MAI Appraisal (or Acceptable Equivalent” in Table 95 as an example.
Box 790: On the chart, input the subtitle: “(Real Financial Instrument) Principal Amount,” where “Real Financial Instrument” is a descriptive term for the subject loan instrument. Then, below this subtitle, input the following data field descriptors: (89) qualified nominal fixed-rate (instrument) principal amount, and (90) qualified real (instrument) principal amount; where “instrument” is a descriptive term for the type of loan instrument being presented.

Input the subtitle and the data field descriptors as stated in the Box description above.

See: “Real Mortgage™ Principal Amount” in Table 95 as an example.
Box 800: In data field (89), input the formula for selecting the lesser of (84) principal amount #1, or (88) principal amount #2; which will be the qualified nominal fixed-rate amount of the instrument.

The formula required here is a simple logic formula, which can be described as follows:

Where:
Cond=A logical expression representing the condition to be tested.
TrueExp=A numerical or string value representing the value to be used if the Cond is true.
FalseExp=A numerical or string value representing the value to be used if the Cond is false.

then:
@IF(Cond, TrueExp, FalseExp)=the desired value

As an example:

Where:
data field (84)=Principal Amount #1=$3,864,201
data field (88)=Principal Amount #2=$3,895,300

and:
Cond=data field (84)<data field (88)
TrueExp=data field (84)
FalseExp=data field (88)

Then, the formula would be:
@IF(data field (84)<data field (88), data field (84), data field (88))
or
@IF($3,864,201<$3,895,300, $3,864,201, $3,895,300)
The Cond being true, the value selected will be: $3,864,201

See: “Real Mortgage™ Principal Amount” in Table 95 as a further example.
Box 810: In data field (90), copy the value from data field (89); which will be the qualified principal amount for the real financial instrument being presented or tested.

Copy the value as directed in the Box above. The values for data fields (89) and (90) can be described briefly below:
(89) Qualified Nominal Fixed-Rate (Instrument) Principal Amount: The qualified amount of the nominal fixed-rate instrument that will be used in the projections.
(90) Qualified Real (Instrument) Principal Amount: The qualified amount of the real instrument that will be used in the projections, which will be the same as the value for data field (89).

As we have stated earlier, at the time that real financial instruments are being introduced into the nominal monetary marketplace, the traditional, nominal method of quantitatively qualifying the principal amount of the loan should be used. Hence, in the process leading up to Box 800, we have used the traditional, nominal method of qualifying the principal amount of the loan to be granted. Now, we simply copy that amount as the principal amount for the real financial instrument, which makes sense because by definition the real currency unit equals the nominal currency unit on the day the loan is initiated.

Please note, that it is the recognition that the principal amount of the real financial instrument and the nominal financial instrument should be the same on the initiation date of the instruments that contradicts traditional underwriting procedures; since such procedures would typically use the amortizing rate of interest to qualify the loan amount. In the case of the real financial instrument, the amortizing rate is the real rate with the inflationary premium factored out. This would lead to the credit-related problems discussed earlier, including the fact that it would be (a) hyper-inflationary and (b) the borrower's rents and/or income would then have to move up precisely with inflation over time. It is the concept of qualifying the borrower at the amortizing rate of interest, that is almost certainly responsible for the United States Department of Housing and Urban Development (H.U.D.) failing to successfully launched its price-level-adjusted-mortgage (PLAM) program. Hence, the transition represented in Box 810 is unique, not obvious, and its usage does not currently appear in the marketplace. This is supported by the fact that the use of real financial instruments in the private sector is almost non-existent, despite the fact that Great Britain has been issuing real bonds since about 1981; while a half dozen other governments have followed suit since then. Only debt, issued on the good faith and credit of the government, is free from such qualifying procedures.

See: “Real Mortgage™ Principal Amount” in Table 95 as a further example.
Box 820: Optional: Input any notes, definitions or disclosures that may be desired on the chart presenting the real financial instrument's loan amount.

See: “Real Mortgage™ Principal Amount” in Table 95 as a further example.
Box 830: Initiate a new chart with the title: “Comparative (Instrument) Analysis,” where “Instrument” is a descriptive word identifying the type of loan instrument being presented or stress tested.

Input the title for the chart as described in the Box description above.

See “Comparative Mortgage Analysis” in Table 95 as an example.
Box 840: On this chart, input the subtitle: “Resulting Nominal (Instrument) Terms,” where “Instrument” is a descriptive word for the type of loan instrument being described. Then, under this subtitle, enter the following data field descriptors: (91) market index rate, (92) qualifying margin, (93) qualifying interest rate, (94) prevailing rate of inflation, (95) effective real rate of interest, (96) qualified principal amount, (97) amortizing (nominal) rate of interest, (98) term in months, (99) fixed monthly payments, (100) debt-service-coverage, (101) inflationary adjustment, (102) balloon payments, (103) property's appraised value, (104) qualified principal amount, (105) owner's estimated equity, (106) net operating income, (107) annual debt service, (108) owner's cash flow before taxes and (109) owner's return on equity.

Input the subtitle and the data field descriptors as stated in the Box description above.

See: “Resulting Nominal Mortgage Terms” in Table 96 as an example.
Box 850: In data field (95), input the formula for calculating the effective real rate of interest, which is the (7) qualifying interest rate less (22) the prevailing rate of inflation.

Input the formula as stated in the Box description above.

See: “Resulting Nominal Mortgage Terms” in Table 96 as an example.
Box 860: In data field (98), input the formula for calculating the term in months, which is the value in data field (10) for the amortizing term in years, times twelve.

Input the formula as stated in the Box description above.

See: “Resulting Nominal Mortgage Terms” in Table 96 as an example.
Box 870: In data field (99), input the formula for calculating the fixed monthly payments for the nominal financial instrument, which is any standard amortization formula using the values for data fields: (89) qualified nominal fixed-rate (instrument) principal amount.

Input the formula as stated in the Box description above.

See: “Resulting Nominal Mortgage Terms” in Table 96 as an example.
Box 880: In data field (105), input the formula for the annual debt service, which is the value in data field (68) for the net operating income, less the value in data field (107) for the annual debt service.

Input the formula as stated in the Box description above.
See: “Resulting Nominal Mortgage Terms” in Table 96 as an example.
Box 890: In data field (107), input the formula for the annual debt service, which is the value for the fixed monthly payments in data field (99), times twelve.

Input the formula as stated in the Box description above.

See: “Resulting Nominal Mortgage Terms” in Table 96 as an example.
Box 900: In data field (108), input the formula for the owner's cash flow before taxes, which is the value in data field (68) for the net operating income, less the value in data field (107) for the annual debt service.

Input the formula as stated in the Box description above.

See: “Resulting Nominal Mortgage Terms” in Table 96 as an example.
Box 910: In data field (109), input the formula for the owner's return on equity, which is the value in data field (108) for the owner's cash flow before taxes, divided by the value in data field (105) representing the owner's estimated equity. The result should then be presented in a percentage format, by multiplying the value times 100 and adding a percent sign.

Input the formula as stated in the Box description above.

See: “Resulting Nominal Mortgage Terms” in Table 96 as an example.
Box 920: Copy the values from the data fields, for the (5) market index rate, (6) qualifying margin, (7) qualifying interest rate, (22) prevailing rate of inflation, (89) qualified nominal fixed-rate (instrument) principal amount, (8) qualifying interest rate, (9) debt-service-coverage, (12) balloon payment(s), (86) appraised value, (96) qualified real (instrument) principal amount and (68) net operating income; into data fields (91) to (94), (96), (97), (100), (102) to (104) and (106) respectively. Then, input the value “none” into data field (101). The values for data fields (95), (98), (99), (105) and (107) to (109) will self-calculate due to the formulas input via Boxes 850 to 910 respectively.

Copy, input and/or calculate the values as directed in the Box above, which can be described briefly below:
(91) Market Index Rate: See the description for data field (5).
(92) Qualifying margin: See the description for data field (6).
(93) Qualifying Interest Rate: See the description for data field (7).
(94) Prevailing Rate of Interest: See the description for data field (22).
(95) Effective Real Rate of Interest: The real rate of interest on the nominal fixed-rate instrument that the real financial instrument is being compared to in the projections. The term “effective” is meant to convey that this is not the rate of interest that will be used for amortizing the nominal fixed-rate instrument.
(96) Qualified Principal Amount: See the description for data field (89).
(97) Amortizing (Nominal) Interest Rate: See the description for data field (8).
(98) Term in Months: The term of the nominal fixed-rate financial instrument in months, required for amortizing the loan.
(99) Fixed Monthly Payments: The amortized monthly payments for the nominal fixed-rate instrument.
(100) Debt-Service-Coverage: See the description for data field (9).
(101) Inflationary Adjustment: See the description for data field ( ).
(102) Balloon Payments: Inasmuch as the credit rating authorities are not likely to approve a balloon payment on a real financial instrument that may be negatively amortizing for many years, it is also assumed that there will be no balloon payments on the nominal instrument used for comparison.
(103) Property's Appraised Value: See the description for data field (86).
(104) Qualified Principal Amount: See the description for data field (96).
(105) Owner's Estimated Equity: The estimated amount of equity the owner has in the subject property.
(106) Net Operating Income: See the description for data field (68).
(107) Annual Debt Service: The total payments due on the nominal fixed-rate instrument for one year.
(108) Owner's Cash Flow Before Taxes: The owner's cash flow on the property after all expenses and the annual debt service, but before income taxes.
(109) Owner's Return on Equity: The rate of return the owner is projected to receive on his or her equity investment in the property.

See: “Resulting Nominal Mortgage Terms” in Table 96 as an example.
Box 930: On the chart, input the subtitle: (Resulting Real (Instrument) Terms,” where “Instrument” is a descriptive word for the type of loan instrument being described. Then, under this subtitle, input the following data field descriptors: (110) date, (111) qualifying interest rate, (112) pricing index rate, (113) fixed pricing margin, (114) effective nominal rate of interest, (115) prevailing rate of inflation, (116) amortizing (real) rate of interest, (117) qualified principal amount, (118) term in months, (119) variable monthly payments, (120) resulting debt-service-coverage, (121) inflationary adjustment, (122) balloon payment(s), (123) property's appraised value, (124) qualified principal amount, (125) owner's estimated equity, (126) net operating income, (127) annual debt service, (128) owner's cash flow before taxes and (129) owner's return on equity.

Input the subtitle and the data field descriptors as stated in the Box description above.

See: “Resulting Nominal Mortgage Terms” in Table 96 as an example.
Box 940: In data field (119), input the formula for calculating the initial variable monthly payment for the real financial instrument, which is any standard amortization formula using the values for data fields: (90) qualified real (instrument) principal amount, the (32) amortizing (real) interest rate and the (98) term in months.

Input the formula as stated in the Box description above.

See: “Resulting Real Mortgage™ Terms” in Table 96 as an example.
Box 950: In data field (120), input the formula for calculating the resulting debt-service-coverage for the real financial instrument, which is the net operating income, divided by the (127) annual debt service.

Input the formula as stated in the Box description above.

See: “Resulting Real Mortgage™ Terms” in Table 96 as an example.
Box 960: In data field (127), input the formula for calculating the annual debt service for the real financial instrument, which is the (119) variable monthly payment, times twelve.

Input the formula as stated in the Box description above.

See: “Resulting Real Mortgage™ Terms” in Table 96 as an example.
Box 970: In data field (128), input the formula for calculating the owner's cash flow before taxes, which is the (68) net operating income, less the (127) annual debt service.

Input the formula as stated in the Box description above.

See: “Resulting Real Mortgage™ Terms” in Table 96 as an example.
Box 980: In data field (129), input the formula for calculating the owner's return on equity, which is the (128) owner's cash flow before taxes, divided by (125) the owner's estimated equity. The result should then be presented in a percentage format, by multiplying the value by 100 and adding a percent sign.

Input the formula as stated in the Box description above.

See: “Resulting Real Mortgage™ Terms” in Table 96 as an example.
Box 990: Copy the values from the data fields, for the (2) date, (7) qualifying interest rate, (28) pricing index rate, (29) fixed pricing margin, (30) effective nominal rate, (22) prevailing rate of inflation, (32) amortizing (real) rate of interest, (90) qualified principal amount, (98) term in months, (19) adjustment period, (12) balloon payment(s), (86) property's appraised value, (90) qualified principal amount, (105) owner's estimated equity and (68) net operating income; into data fields (110) to (118) and (121) to (126). The values for data fields (119), (120) and (127) to (129) will self-calculate due to the formulas input via Boxes 940 to 980 respectively.

Copy the values as stated in the Box above. The values, whether copied or calculated, can be briefly described as follows:
(110) Date: See the description for data field (2).
(111) Qualifying Interest Rate: See the description for data field (7).
(112) Pricing Index Rate: See the description for data field (28).
(113) Fixed Pricing Margin: See the description for data field (29).
(114) Effective Nominal Rate of Interest: See the description for data field (30).
(115) Prevailing Rate of Inflation: See the description for data field (22).
(116) Amortizing (Real) Rate of Interest: See the description for data field (32).
(117) Qualified Principal Amount: See the description for data field (90).
(118) Term in Months: See the description for data field (98).
(119) Variable Monthly Payments: The initial monthly payment on the real financial instrument, which will increase roughly with inflation over time.
(120) Resulting Debt-Service-Coverage: This is the resulting debt service coverage for the real financial instrument, which was qualified with the debt-service-coverage for nominal financial instruments. This process effectively over-qualifies the borrower, and limits the size of the real financial instrument's principal amount; effectively resolving the major credit-related problems.
(121) Inflationary Adjustment: See the description for data field (19).
(122) Balloon Payment(s): See the description for data field (12).
(123) Property's Appraised Value: See the description for data field (86).
(124) Qualified Principal Amount: See the description for data field (90).
(125) Owner's Estimated Equity: See the description for data field (105).
(126) Net Operating Income: See the description for data field (68).
(127) Annual Debt Service: A projection of the total annual payments due on the real financial instrument, which will vary somewhat if inflation and/or deflation ensues.
(128) Owner's Cash Flow Before Taxes: The owner's cash flow using the after all expenses and debt service on the real financial instrument, but before income taxes. Typically, the cash flow will be much larger in the early years, since we have factored out the inflationary premium. Eventually, the use of a nominal fixed-rate instrument will produce larger cash flows, but the real financial instrument will continue to excel in terms of cumulative cash flows after assuming the reinvestment of said cash flows. If the real financial instrument does not excel, then the real rate is probably too high.
(129) Owner's Return on Equity: The owner's return on the equity in his or her property, expressed as a rate of return. The real financial instrument should generate a higher rate of return in the early years, and a relatively stable rate of return over time. The use of the nominal financial instrument will lower the rate of return in the early years, thereby increasing the potential for a mortgage default by lowering the debt-service-coverage by comparison.

See: “Resulting Real Mortgage™ Terms” in Table 96 as an example.
Box 1000: Optional: To the right of data fields (103) to (105), and (123) to (125), input the following formula: divide the value of each data field by the value for the property's appraised value in data field (86). Then, present the resulting value in a percentage format, by multiplying the number by 100 and adding a percent sign.

Input the formula as stated in the Box description above.

See: “Resulting Real Mortgage™ Terms” in Table 96 as an example.
Box 1010: Optional: Input notes, definitions or disclosures that may be desired on the chart presenting the “Comparative (Instrument) Analysis.”

See: “Comparative Mortgage Analysis” in Table 96 as an example.

Process V: Initiating Charts for Inputting Values for Credit Enhancement, Securities Pricing and Securitization Structuring.
Box 1020: Initiate a chart with the title: (Primary Asset)-Backed Securities, Credit Enhancement, Securities Pricing & Securitization Structure.”

Thus far, we have created a number of charts culminating in a chart entitled: Comparative (Real financial Instrument) Analysis, which shows the comparative results in the first year of using the real financial instrument versus the traditional nominal instrument. To achieve the results on this chart, we had to make certain assumptions concerning the pricing of the real financial instrument; the most important of which was the fixed pricing margin. Now we must create a chart that will help us to determine whether our estimated fixed pricing margin was sufficient to market the resulting asset-backed securities. This chart created in this Box can be used to price and structure the proposed securities offering. In doing so, it will also help us to estimate the average fixed pricing margin that we will need on the primary asset pool in order to market the resulting asset-backed securities. Once established with this chart, we can go back to the earlier charts and fill in the proper fixed pricing margin to see if we have a competitively priced primary asset. If so, we can proceed to originate the primary assets, if not, then we should consider other options for the over-all program; which will become obvious later in the development of the software patent.

See “Mortgage Pool Assumptions” on Table 97 as an example.
Box 1030: On the chart, input the subtitle (Primary Asset) Pool Assumptions.” Then, under this subtitle, input the following data field descriptors: (130) Date, (131) Data Source, (132) Pricing Index, (133) Pricing Term, if any, (134) Par Value, (135) Pricing Index Rate, (136) Fixed Pricing Margin, (137) Effective Nominal Rate, (138) Prevailing Inflation Rate and (139) Amortizing (Real) Rate of Interest.

Input the subtitle and data field descriptors as set forth in the Box description above.

See “Mortgage Pool Assumptions” on Table 97 as an example.
Box 1040: Input the formula for the Effective Nominal Rate into data field (137), and the formula for the Amortizing (Real) Rate of Interest into data field (139).

The formula for the Effective Nominal Rate is the value for the Pricing Index Rate in data field (135), and the value for the Fixed pricing Margin in data field (138).

See “Mortgage Pool Assumptions” on Table 97 as an example.
Box 1050: Input the projected values for data fields (130) to (136) and (138). The Effective Nominal Rate and the Amortizing (Real) Rate of Interest in data fields 9137) and (139) respectively will self-calculate.

Input the data for the data fields, which can be described briefly as follows:
(130) Date: See the description for data field (16).
(131) Data Source: See the description for data field (15).
(132) Pricing Index: See the description for data field (26).
(133) Pricing Term, if any: See the description for data field (27).
(134) Par Value: The par, or face, value of the total primary asset pool to be securitized.
(135) Pricing Index Rate: See the description for data field (28).
(136) Fixed Pricing Margin: See the description for data field (29).
(137) Effective Nominal Rate: See the description for data field (30).
(138) Prevailing Inflation Rate: See the description for data field (31).
(139) Amortizing (Real) Rate of Interest: See the description for data field (32).

See “Mortgage Pool Assumptions” on Table 97 as an example.
Box 1060: On the chart, input the subtitle: “(Primary Asset-Backed Securities) Program Income at Closing.” Then, under this subtitle, input the following data field descriptors: (140) Class “A” Certificates, (141) Class “B” Certificates, (Class “B” and additional regular interest classes are optional), (142) Class “R” Certificates, (143) Total Income, (144) (Primary Asset) funding, (145) Net Securitization Proceeds, (146) Net Securitization Proceeds, (147) Gross (Primary Asset) Program Proceeds.

Input the subtitle and data field descriptors as set forth in the Box description above.

See “RMBS Program Income at Closing” on Table 97 as an example.
Box 1070: Adjacent to the data field descriptors from Box 1060, enter three columns for values referred to herein as (a), (b) and (c). Enter the percentage, if any, for Borrowers' Points into column (a) for data field (146). Then in column (b), enter the formula for Total Income into data field (143), which is the sum of all the Certificate Classes, or the values (140), (141) and (142) in the example shown. Then in column (b) enter the formula for the Net Securitization Proceeds into data field (145), which is the value for (143) less (144). Then enter the formula for the Borrowers' Points in column (b) data field (146), which is the value of data field (146)(a) times the value for data field (144)(b). Finally, enter the formula for the (Primary Asset)-Backed Program Proceeds into data field (147)(b), which is the value for data fields (145) plus (146).

The Total Income is simply the total income from the sale of all the issued securities. Each conduit typically requires at least one class of regular interests and only one class of residual interests. There may be as many class of regular interests as the sponsor desires, but only one class of residual interests. The Net Securitization Proceeds are the remainder of the Total Income raised less the cost of funding the assets purchased by the conduit. The Borrowers Points are fees that are typically charged to the borrower and used to cover the expense of generating the loan. The Gross (Primary Asset)-Backed Proceeds are the total of the Net Securitization Proceeds plus the Borrowers' Points, which together must cover all of the Program Expenses.

See “RMBS Program Income at Closing” on Table 97 as an example.
Box 1080: In column (b), enter the values for data fields (140), (141), (142) and

(144). Then the values for Total Income, Net Securitization Proceeds, Borrowers' Points, if any, and Gross (Primary Asset)-Backed Securities Program Proceeds in data fields (143)(b), (145)(b), (146)(b) and (147)(b) will self-calculate.

Input the data for the data fields, which can be described briefly as follows:
(140) Class “A” Certificates: The regular interest class with the highest priority of payment.
(141) Class “B” Certificates: Optional: The initial regular interest class that is subordinate to the class with the highest priority of payment. This may be followed by additional regular interest classes, each subordinate to the prior classes.
(142) Class “R” Certificates: The residual interest class, which receives any residual cash flow after all the expenses and all other regular classes have been properly paid for the given time period.
(143) Total Income: The total income from the sale of the issued securities.
(144) (Primary Asset) Funding: The cost of funding the purchase of the primary asset pool.
(145) Net Securitization Proceeds: The net proceeds of the securitization programs after funding the primary assets.
(146) Borrowers' Points: Optional fees charged to the borrowers to cover the expense of brokering and originating the loans.
(147) Gross RMBS Program Proceeds: The total of the net proceeds of the securities program plus the borrowers' points.

See “RMBS Program Income at Closing” on Table 97 as an example.
Box 1090: Optional: In column (c), input the formulas for calculating the percentage that each value for the data fields (140) to (145) represents as a proportion of the Total Income in data field (143).

Input the formulas for the relative percentages as described in the Box above.

See “RMBS Program Income at Closing” on Table 97 as an example.
Box 1100: On the chart, input the subtitle: “Program Expenses.” Then enter the following data descriptors: (148) Auditor, (149) Credit Rating Companies, (150) Insurance Premium, (151) Securities Attorney, (152) Broker/Dealer's Attorney, (153) Broker/Dealer, (154) Miscellaneous, (155) (Primary Asset) Brokerage, (156) (Primary Asset) Origination, (157) Printing & Postage, (158) RMC License Fee, (159) Trust Company Fees, (160) Total Expenses and (161) Net Cash at Closing.

Input the subtitle and data field descriptors as set forth in the Box description above.

See “Program Expenses” on Table 97 as an example.
Box 1110: Adjacent to the data field descriptors for Box (1100), create three columns referred to as (d), (e) and (f). In column (e), enter the formula for calculating the Total Expenses into data field (160), which is the sum of the values for data fields (148) to (159). And, enter the formula for the Net Cash at Closing into data field 9161), which is the value for data field (147) less the value for data field (160).

Enter the formulas as described in the Box above.

See “Program Expenses” on Table 97 as an example.
Box 1120: In column (d), enter the percentage values for data fields (150), (152), (155), (156) and (158). Then, input the formulas for calculating the Insurance Premium by multiplying the value for data field (150)(d) times (144)(b) and enter into data field (150)(e). Replicate this process for the Broker/Dealer, (Primary Asset) Brokerage, (Primary Asset) Origination and RMC License Fee and enter into data fields (153), (155), (156) and (158) respectively.

Enter the formulas indicated in the description for the Box above. Typically, the fees charged for the Insurance Premium, representing credit enhancement, and the fees for the Broker/Dealer, Brokerage and Origination are based upon a percentage of loan instruments created. Reasonable estimates must be made as to what these fees will be in order to project the Program Expenses.

See “Program Expenses” on Table 97 as an example.
BOX 1130: Enter the values for data fields (148), (149), (151), (152), (154), (157) and (159), which will cause the Total Expenses in data field (160), and the Net Cash at Closing, to self-calculate.

Input the data for the data fields, which can be described briefly as follows:
(148) Auditor: Estimate expense as stated.
(149) Credit Rating Companies: Optional, expense as stated.
(150) Insurance Premium: Optional, expense as stated.
(151) Securities Attorney; Estimate expense as stated.
(152) Broker/Dealers Attorney; Estimate expense as stated.
(153) Broker/Dealer: Estimate expense as stated.
(154) Miscellaneous: Estimate expense as stated.
(155) (Primary Asset) Brokerage: Estimate expense as stated.
(156) (Primary Asset) Origination: Estimate expense as stated.
(157) Printing & Postage: Estimate expense as stated.
(158) RMC License Fee: Software licensing fee.
(159) Trust Company Fees: Estimate expense as stated.
(160) Total Expenses: The total of all expenses.
(161) Net Cash at Closing: The Gross (Primary Asset)-Backed Securities Program Proceeds less the expenses, which would typically equal zero. Any excess is usually included in the miscellaneous data field.

See “Program Expenses” on Table 97 as an example.
Box 1140: Optional: In column (f), input the formulas for calculating the percentage that each value for data fields (148) to (161) represents as a proportion of the value of total income in data field (143).

As an option, input the relative percentages as described in the Box above.

See “Program Expenses” on Table 97 as an example.
Box 1150: On the chart, enter the subtitle: “(Primary Asset-Backed Securities) Securities Structuring.” Under this subtitle, enter the data field descriptors: (162) Date, (163) Data source, (164) Pricing Index and (165) Pricing Term, If Any.

Input the subtitle and data field descriptors as set forth in the Box description above.

See “RMBS Securities Structuring” on Table 97 as an example.
Box 1160: Enter the values for data fields (162) to (165) by copying the values for data fields (130) to (133) respectively, meaning simply that the securities should be priced off the same index as the primary assets in most cases.

Input the data for the data fields, which can be described briefly as follows:
(162) Date: See the description for data field (130).
(163) Data Source: See the description for data field (131).
(164) Pricing Index: See the description for data field (132).
(165) Pricing Term, If Any. See the description for data field (133).

See “RMBS Securities Structuring” on Table 97 as an example.
Box 1170: Optional: Input the subtitle: “Source of Fixed Income Margin.” Then under this subtitle, input the data field descriptors for (166) Correlating index, (167) Correlating Index Rate, (168) (Market) Margin Rate and (169) Estimated Pricing Margin.

Input the subtitle and data field descriptors as set forth in the Box description above.

When a new real financial instruments is introduced into the marketplace, it may be difficult to know what existing index it can be priced off. Hence, if you are pricing a first generation real financial instrument for a new primary asset class, then how do you estimate what the fixed pricing margin should be before the market even exists. As an option, we can often use a combination of other indexes. In the example shown in Table 97, we use the fixed margin for nominal commercial mortgage-backed securities (CMBS), but then we add it to the fixed margin of the U.S. Treasury Inflation Protection Securities (TIPS) to arrive at an estimate for the Fixed Pricing Margin of Real Mortgage-Backed Securities. Naturally, once the RMBS market exists, then we can exclude this optional pricing and price from the existing RMBS market.

See “Source of Fixed Pricing Margin” on Table 97 as an example.
Box 1180: Optional: Input the formula for calculating the Estimated Pricing Margin, which is the value for the Correlating Index Rate plus the value for the (Market) Margin in data fields (167) and (168) respectively. Then input the values for data fields (166) to (168), and the Estimated Pricing margin will self-calculate.

Input the formulas, and the values, as stated in the Box description above. These values can then be explained as follows:
(166) Correlating Index: The correlating index used to obtain the Correlating Index Rate.
(167) Correlating Index rate: The fixed real rate of interest that the correlating index currently uses for instruments with the same term as the primary assets.
(168) (Market) Margin: The current margin for the comparative nominal primary asset with the equivalent credit rating of the Class “A” Certificates to be issued. In essence, if the nominal primary asset at a given credit rating is “X” basis points over the nominal index, then this margin is assumed to be the same for the real financial instruments; even the market for such may, not yet exist.

See “Source of Fixed Pricing Margin” on Table 97 as an example.
Box 1190: Under the subtitle (Primary Asset-Backed Securities) Securities Structuring; establish three columns, labeled (g), (h) and (i) for our purposes herein, then input the following labels at the top of each column as follows: (170)(g) “Class “A”:”, (170)(h) “Class “B”:” and (170)(i) “Class “R”:”. Class “B”, and additional columns for additional regular interest classes are optional.

Establish the columns and labels as stated in the Box description above.

See “RMBS Securities Structuring” on Table 97 as an example.
Box 1200: Under the subtitle (Primary Asset-Backed Securities) Securities Structuring, input the data descriptor fields: (171) Projected Par Value, (172) Projected Rating, (173) Pricing Index Rate, (174) Fixed Pricing margin, (175) Effective Nominal Rate, (176) Prevailing Rate of inflation and (177) Amortizing (Real) Rate of Interest.

Enter the data descriptor fields as described in the Box above.

See “RBS Securities Structuring” on Table 97 as an example.
Box 1210: In each column created via Box 1190, input the values for the Projected Par Value and the projected Rating in data fields (171) & (172).

Input the values as stated in the Box description above, which can be explained as follows:
(171) Projected Par Value: The estimated par value for each class of securities to be issued as indicated by the label at the top of each column.
(172) Projected Rating; The projected credit rating, which will be issued by the credit rating companies or which may be implied by the participation of a government agency such as Fannie Mae.

See “RMBS Securities Structuring” on Table 97 as an example.
Box 1220: Input the term in years for each respective securities class into data fields (173)(g)(h)(i), and then input the number of payments per year into data fields (174)(g)(h)(i). Input the formulas for the Effective Nominal Rate into data fields (177)(g, h & i), which is the value for data fields (175) plus (176) in each respective column. Then input the formula for the Amortizing (Real) Rate of Interest into data fields (179)(g & h), and input “N/A” into data field (179(i).

Input the formulas as described in the Box description above. The resulting values can be described as follows:
(173) Term in Years: The term of each securities class in years.
(174) Payments per Year: Then number of payment periods per year for each securities class.
(175) Pricing Index Rate: See the description for data field (28).
(176) Fixed Pricing Margin: See the description for data field (29).
(177) Effective Nominal Rate: See the description for data field (30).
(178) Prevailing Rate of Inflation: See the description for data field (31).
(179) Amortizing (Real) Rate of Interest: See the description for data field (32).

See “RMBS Securities Structuring” on Table 97 as an example.
Box 1230: In columns (g) & (h) created via Box 1190, copy the value for data field (135) into data field (175). Then copy the value from data field (169), or alternatively estimate the value, and input it into data field (176)(g). Add the current market spreads between respective tranches, based upon credit ratings, to the Fixed Pricing margin in data field (176)(g) and insert the new values into data fields (176)(h) and (176)(i). Finally, copy the value for the Prevailing Rate of Inflation from data field (138) into data fields (176)(g) and (176)(h). Then the Effective Nominal Rate and the Amortizing (Real) Rates of Interest will self-calculate for data fields (176)(g) and (176)(h). Data field (176)(i) should read “N/A.”

Input the formulas and copy the values as described in the Box above.

See “RMBS Securities Structuring” on Table 97 as an example.
Box 1240: On the chart, input the subtitle: “Interest Reconciliation.” Then create five columns, referred to for our purposes herein as (180)(j, k, l, m & n). Then label each of these columns at the top as follows: (j) “Funds at Closing”, (k) “Effective Nominal Rate”, (l) “Effective Nominal Interest”, (m) “Real Rate”, and (n) “Real Interest.” Then, adjacent to these columns, input the following data field descriptors: (181) (Primary Asset) Pool, (182) Class “A” Certificates, (183) Class “B” Certificates, (Class “B” and additional regular interest classes are optional), (184) Class “R” Certificates, (185) Insurance Premium, (186) Servicing Fee, (187) RMC Licensing Fee, (188) Trustee, (189) Totals, (190) Program Budget and (191) Net Interest after Distributions.

Input the subtitle, columns, column labels and data field descriptors as described above.

See “RMBS Securities Structuring” on Table 97 as an example.
Box 1250: In column (j), copy the Par Value from data field (134) into data field (181), and copy the Projected Par Value from data fields (177)(g, h & i) into data fields (183), (184) and (185) respectively. Then in column (j), input the value “N/A” into data fields (185) to (188) and (191).

Copy and input the values as described in the Box above. These values can be explained as follows:
(180)(j) Funds at Closing: The purpose of the Interest Reconciliation performed in this section of the chart is to see that the total cash and interest income equals the total of cash and interest distributed. The Funds at Closing column concerns the funds raised by the sale of the issued securities versus the amount distributed to purchase the primary assets and pay the program expenses. As such, the value for data field (181)(j) must equal the value for data field (134), and the value for data field (190)(j) must offset the Net Securitization Proceeds in data field (145). Concurrently, Net Cash at Closing must equal zero in data field (161).
(180)(k) Effective Nominal Rate: See the description for data field (137).
(180)(l) Effective Nominal Interest: This is simply the Effective Nominal Rate in data field (180)(k) times the (Primary Asset) Pool in data field (181)(j). The value created herein is a projection of the first year's nominal interest payment by the borrowers and its distribution to the issued securities holders and the coverage of any ongoing expenses. While the actual amount of nominal interest may vary with many factors, we must be certain that on a percentage distribution basis we can cover all of our projected distributions, regardless of whether they are cash or accrual distributions. Hence, the value for the Net (Nominal) Interest after Distributions in data field (191)(1) must equal zero. If this value is negative, then the one or more distribution percentages in column (k) must be reduced, or if this is not feasible then the average Effective Nominal Rate for the (Primary Asset) Pool must be increased by increasing the average Fixed Pricing Margin in data field (138). If the value for data field (191)(l) is too high, then the opposite procedures must be followed to zero-out the Net interest after Distributions. At the very least, any shortage or excess could be borne by the Class “R” Certificates, which are designed to receive the residual cash flow. Frequently, the sponsor frequently retains the Class “R” Certificates.
(180)(m) Real Rate: This is the same as the Amortizing (Real) Rate of Interest respectively for the asset pool and each level of issued securities. No real rate is shown for the Class “R” Certificates, since by definition the residual ash simply receives the residual cash flow. Hence, no amortization with a real rate occurs. Another reason for this is that the total of the par values of the regular certificates, or Class “A” and Class “B” in the example, should equal the par value of the asset pool, since there must be a one-for-one correspondence here in order for the inflationary adjustment to flow through from the asset pool to the regular interests. This means that the Class “R” Certificates is paid with an interest-only (10) strip, which has no principal amortization per se. While we must project the Effective Nominal Rate for the purpose of pricing the Class “R” Certificates, and this rate must include the assumption that the purchase receives a return of his or her principal investment over some estimated term; nonetheless, the stream of interest paid is actually from an interest-only (10) strip peeled off the underlying asset pool.
(180)(n) Real Interest: For the asset pool and the regular interests, this is the actual real interest that would be paid in the first year based upon the relative rates at the time of the conduit's projected start-up. For all other distributions, this is the cash distribution that comes from the interest-only (10) strip that has been set aside to cover each such distribution. Hence, for the Class “R” Certificates and the ongoing expenses after closing, the dollar amount in column (1) must equal the dollar amount in column (n). Finally, the Net Interest after Distribution in data field (191)(n) must also zero-out for the same reasons that the nominal interest distributed in column (1) must zero-out. (See the description for (191)(1) for a broader description.)
(181) (Primary Asset) Pool: The assets purchased by the sale of the issued securities.
(182) Class “A” Certificates: The securities to be issued by the conduit representing the regular interest class with the highest priority of payment, which typically receives the highest credit rating and pays the lowest rate of return.
(183) Class “B” Certificates: The securities to be issued by the conduit representing the regular interest class that is subordinate in priority of payment to the Class “A” Certificates, which typically receive a lower credit rating and pay a higher rate of interest due to the additional risk. The issuance of the Class “B” Certificates, and additional subordinate regular interest classes, are optional.
(184) Class “R” Certificates: Typically, each conduit must have at least one class of regular interests, represented by the Class “A” Certificates, but can only have one class of residual certificates, represented by the Class “R” Certificates. By definition, the residual class of certificates take on the highest risk, since they receive the residual cash flow after the payment of all ongoing expenses and the distributions to all of the regular interest classes. As such, the residual class is frequently unrated, and usually pays the highest rate of return; frequently a junk-bond rate of return.
(185) Insurance Premium: This is an optional payment to either an insurance company, a federal agency or some other financial institution in return for some form of guarantee on the distributions for one or more of the issued securities classes, which may also be called “credit enhancement,” since the guarantee will assist the sponsor in obtaining the institutional-quality credit ratings (“BBB” or higher) that the conduit requires to sell the issued securities at lower rates. Typically, the conduit's sponsor makes a living from the spread that he or she can carve out from the total interest paid by the asset pool after the distributions for the issued securities and the ongoing expenses. Frequently, this profit simply flows through to the residual certificates, which the sponsor owns or sells.
(186) Servicing Fee: The fee charged by the financial institution that is responsible for servicing the asset pool, which may be mortgages, auto loans, credit card receivables, etc.
(187) RMC Licensing Fee: The annual fee paid by the conduit as a royalty for the use of the invention, Real Monetary Software. This may or may not include the ongoing expenses of periodically updating the software system.
(188) Trustee: Typically, the establishment of any conduit requires the engagement of a financial institution to represent the interests of the investors purchasing the issued securities.
(189) Totals: Simply the total of all the distributions in each given column representing cash or accrual distributions.
(190) Program Budget: The budget used to fund the Program Expenses, except for the distribution at closing of any brokering or origination fees that may be charged directly to the borrowers. The Program Budget represents the funds remaining after the sale of the issued securities and the funding of the asset pool.
(191) Net Interest after Distributions: See the description for data fields (180)(l) and (180)(n).

See “RABS Securities Structuring” on Table 97 as an example.
Box 1260: In column (k), copy the value for the Effective Nominal Rate in data field (137) into data field (181), and copy the values for data fields (177)(g, h & i) into data fields (183) to (185) respectively. Then in column (k), input the percentage values for data fields (185) to (188). finally, input the value “N/A” into data fields (189) to (191) in column (k).

Basically, we are simply inputting the par value for the asset pool, and for the issued securities, into column (k), so that we may deduct the latter from the former to determine the amount funds remaining for the Program Budget. The Program Budget in data field (190)(j) must offset the Program Expenses, less any fees charged directly to the borrowers. The value “N/A” is entered in column (k) for certain expenses that are to be paid annually over the life of the program. While fees may also be charged for some of these expenses at the closing of the asset pool or the conduit, those fees are included in the Program Expenses in data fields (148) to (159).

See “RMBS Securities Structuring” on Table 97 as an example.
Box 1270: In column (i), input the formula for calculating the Effective Nominal Interest into data field (181)(l), which is (181)(j) times (181)(k). Then input the formula for calculating the values for (182)(l), (183)(l) and (184)(l) by repeating the formula for (181)(l) on a relative basis. Then input the formula for data field (185)(l), which is (185)(k) times the value in data field (134). And repeat this exercise for calculating data fields (186)(l), (187)(l) and (188)(l) by multiplying the values in data fields (186)(k), (187)(k) and (188)(k) by the value in data field (134) respectively. These formulas will calculate the values for the Effective Nominal Interest (column (k)) for items in data fields (182) to (188).

Input the formulas as stated in the Box description above. Basically, this establishes the values for the nominal interest (cash and accrued) that will be earned on the asset pool versus the distributions to the issued securities and ongoing program expenses after the closing. Obviously, the total nominal interest received (cash and accrued) must equal the total distributions (cash and accrued), such that the value for data field (191)(l) for the Net (Nominal) Interest after Distributions is zero.

See “RMBS Securities Structuring” on Table 97 as an example.
Box 1280: Copy the value for the (Primary Asset) Pool's Real Rate from the data field (139) into data field (181)(m). Then copy the real rates from data fields (179)(g) and (179)(h) into data fields (182)(m) and (183)(m), and input the value “N/A” into data fields (184)(m) to (191)(m).

Copy the values as stated in the Box description above, which simply inputs the real rates of return for the primary asset pool and the regular interests. The value “N/A” is input for all other distributions, since they are paid from an 10 strip and are not amortized with a real rate of interest.

See “RMBS Securities Structuring” on Table 97 as an example.
Box 1290: Input the formula for calculating the Real Interest for the (Primary Asset) Pool into data field (181)(n), which is the value for data fields (181)(l) times (181)(m). On a relative basis, input the same formula into data fields (182)(n) and (183)(n). Then copy the values in data fields (184)(l) to (188)(l) into data fields (184)(n) to (188)(n). The values for the Real Interest for Class “A” and Class “B”, if any, will then self-calculate.

Input the formulas and copy the values as described in the Box above. This will balance out the real interest payment on the asset pool versus the distributions on both the regular interest(s), the residual interest and the ongoing expenses for the first year. This column is necessary, since we must be assured that not only the Effective Nominal Interest, including both cash and accrual distributions balances; but we must also know that the distribution of the Real Interest also balances with the Real Interest income from the asset pool. We are not concerned with the repayment of principal on either the asset pool or the issued securities in this Interest Reconciliation chart, since it is assumed that the principal repayments will simply flow through. Actually, a problem may occur with the principal repayment, since the issued securities will actually pay down the outstanding principal at a faster rate than the asset pool, since they will have lower rates of interest than the asset pool. While large financial institutions can handle the problem of distribution principal repayments faster to the issued securities than they are received from the asset pool payments; nonetheless the convention known as the “distribution rule,” can also resolve this problem. (See the explanation for Box 120.)

See “RMBS Securities Structuring” on Table 97 as an example.
Box 1300: Input the formula for calculating the Totals into data fields (189)(j, l & n) by totaling the values for data fields (182) to (188) in each respective column. Then input the formula for calculating the program Budget into data field (190)(j) by subtracting the values in data fields (189)(j) from (181)(j). Then, input the formulas for determining the Net Interest after Distributions in data fields (191)(l & n) from data fields (181)(l & n) respectively. Values for the Program Budget and the Net Interest after Distributions for both the Effective Nominal Interest and the Real Interest will self-calculate. Finally, input the value “N/A” into data fields (190)(l & n).

Input the formulas and values as stated. Once again, the resulting values for the Net Interest after Distributions must zero-out for both the Effective Nominal Interest and the Real Interest in data fields (191)(l & n) respectively. Assuming all of the steps decried have been properly performed, then this chart can assist the conduit sponsor in projecting the average Fixed Pricing Margin that he or she will require on the asset pool in order to cover all expenses, both at the start-up of the conduit and subsequent to the start-up, as well as distributions to the projected issued securities sufficient to properly market the issued securities.

See “RMBS Securities Structuring” on Table 97 as an example.
Box 1310: Increase the value of the Fixed Pricing Margin in data field (136) for the (Primary Asset) Pool until: the value for the Program Budget in data field (190)(j) cancels out the value for the Net Securitization Proceeds in data field (145)(b); and the values for data fields (191)(j & n) both equal zero. Assuming the Program Expenses, the Securities Structuring and the mathematics are all correct, then this chart will tell the sponsor the average Fixed Pricing Margin that he or she needs on the (Primary Asset) Pool to make the numbers work.

Basically, play “what if” with the chart until all of the goals described in Box 1310 are achieved.

See “RMBS Securities Structuring” on Table 97 as an example.
Box 1320: Copy the value of the average Fixed Pricing Margin from data field (136) into data field (29), then compare the relative performance of the Nominal (Primary Asset) in data field (109) to the Real (Primary Asset) in data field (129). If the performance of the Real (Primary Asset) is not deemed competitive with the Nominal (Primary Asset), then make the appropriate adjustments in the Program Expenses (at closing and/or subsequently), if possible; or consider a different generation of real financial instruments that may be more competitive.

Copy the value as indicated in the Box description above. Basically, the charts created thus far will allow the sponsor of the conduit to begin to project the terms under which he can offer the primary assets and the issues securities. It is a zero-sum game, since they must properly balance out and still be marketable on both ends of the proposed transaction. Two problems may occur at this juncture: (1) The first generation of real financial instruments may be priced out of the market by the government's issuance of a fixed real rate instrument, which has not properly resolved the interest-rate-anomaly problem. Hence, the real rate on the government's real financial instrument, such as the Treasury Inflation Protection Securities (or TIPS) may be high to offset the interest-rate-anomaly problem. This effectively prices the private sector out of the marketplace for real financial instruments, since the private sector instruments are usually priced at a margin over the government index. (2) While the second generation of variable real rate instruments was created to resolve both the interest-rate-anomaly and the use of a government-generated (inflation) index for pricing, nonetheless, the second generation will not be competitive if the yield curve for nominal financial instruments is relatively flat. At the time of this writing, the difference between the 90-day U.S. Treasury Bill and the 30-Year Treasury Bond was about 60 basis points. Inasmuch as one of the primary advantages of using real financial instruments is to factor out the inflationary premium, the relatively flat yield curve will make the introduction of even the second generation of real financial instruments difficult. At that point, it will be necessary to result to the third generation of real financial instruments, which includes asset-backed real monetary equivalents. Inasmuch as the asset-backed real monetary equivalents is backed by the real-principal-only strip of a given real financial instrument (preferably Real Mortgages™), the real-interest-only strip can be reduced substantially. Hence, the third generation should be highly competitive, but will require the establishment of institutions in the after-market that will assist in the recycling of the asset-backed real monetary equivalents. As the invention is developed further, the offering of third generation instruments will also be covered. Nonetheless, the development to this point in the invention will cover both the first and second generation, which merely entails the selection of a different pricing index.

See “RMBS Securities Structuring” on Table 97 as an example.
Box 1330: Optional: Input any notes, definitions or disclosures that may be desired on the chart presenting the structuring and pricing of the securities.

Input any desired notes, definitions or disclosures on the chart.

See “RMBS Securities Structuring” on Table 97 as an example.

Process VI: Initiating Financial Projections and Graphs for Marketing Presentations and Stress tests for the Primary Assets.
Box 1340: Using the charts created via Process IV, input the desired values for the real financial instrument that is to be the primary asset. Then, using the chart crated via Process V, input the current market data pertaining to the pricing of the asset-backed securities, and use the results to select the generation and set the pricing of the real financial instrument. Finally, use the values, as adjusted, for the real financial instrument in said charts for the financial projections created in Process VI for marketing presentations and stress tests.

The creation of asset-backed securities, whether real or nominal, is a balancing act. One must be sure that the pricing of the asset, which are used to backed the securities, is sufficient to meet the pricing required to properly market the asset-backed securities. This is not a new phenomenon for traditional, nominal asset-backed securities. Nonetheless, the invention herein takes this requirement into the realm of real financial instruments, by assisting the sponsor of the conduit in both the proper selection of the generation of real financial instruments to be created as well as the relative pricing of both the primary assets and the resulting (real) asset-backed securities. This is essential during the conversion of the marketplace from nominal to real monetary terms, since the nominal marketplace will frequently present marketing obstacles to the first and/or the second generation of real financial instruments. Nonetheless, the third generation of real financial instruments, which includes the asset-backed monetary equivalents, will be competitive at all times. The difficulty in launching the asset-backed real monetary equivalents is just getting started. It is not enough to simply arrange for their issuance. One must also begin to create real financial institutions in the after-market that will facilitate the recycling of these asset-backed real monetary equivalents. If this can be achieved, then the asset-backed real monetary equivalents will create a market for the first generation of real financial instruments. This market-generation may be direct in terms of Real Mortgages™ to back the asset-backed real monetary equivalents, or indirectly for other asset types as the distribution of the asset-backed real monetary equivalents eventually provides for the creation of other primary asset loans in the real monetary unit. The second generation can also be used to overcome the market problems with the first generation. Nonetheless, the second generation will only work in a an economy with current a inflationary problem, since its competitive edge rests upon its ability to remove the inflationary premium from the amortizing rate of interest. This means there must be a reasonable degree of inflationary premium, which is not the case with a relatively flat yield curve. At the time of the writing of this document, or July, 1998, the United States was experiencing a relatively flat yield curve with about 65 basis points between the 90-day Treasury Bill and the 30-year Treasury Bond. At the same time, the 30-year Treasury Inflation Protection Securities (TIPS) was priced at about 3.85% in real terms, which compares to an historical real rate for long-term government bonds in the United States of about 2.10% real rate. This additional 175 basis points has effectively priced the first generation of real financial instruments out of the market in the private sector. Hence, with the effective elimination of both the first generation of real financial instruments (with a fixed real rate) and the second generation of real financial instruments (with a variable real rate), this leaves only the possibility of offering the third generation of real financial instruments (or the asset-backed real monetary equivalent). Certainly, this situation may change from country to country. Once again, the use of the charts created via Processes IV and V will help the conduit sponsor establish just which generation of real financial instruments is competitive in the country selected for issuance.

See Processes IV and V
Box 1350: Initiate a table for the calculation of the prevailing rates of inflation (PRIs) and the inflationary adjustment factors (IAFs) for the real financial instrument being presented or stress tested. Then input the labels, values and formulas for the payment (number, year and month), the inflation index (year, month and number), the inflationary adjustment factor and the prevailing rate of inflation. This table will then be used to supply the inflationary adjustment factors and the prevailing rates of inflation, by payment period for the projections and graphs created via Process VI.

We begin by noting that inflationary indexes require a base period from which they are projected, such as 100=1982-1984. Then, as inflation ensues in the following years, the index is moved up incrementally, until it reaches approximately 160.0 by 1997. This means simply that by 1997 it will cost $160 to purchase the same basket of goods and services that only cost $100 in the 1982-1984 base period. In this computation, we can see that the current inflation index number of 160.0 is multiplied times the base amount of $1.00 to obtain the value of $160. This is true no matter how many years have transpired since the inflation index has moved from 100 to 160. In effect, the inflation index has established the 1982-1984 period as the base-line-date for a real currency unit.

Conversely, we tend to think about inflation in the most current terms. When the news media reports that inflation is 1.375%, we understand that the media is referring to what we have defined herein as the “prevailing rate of inflation” (PRI); meaning the relative rate of inflation over the past 12 months subject to a lag for measuring purposes. For situations involving only this 12 month period, such as the current annual rental increase for an apartment, the PRI is correct.

To begin with, let's see if our inflationary adjustment factor is properly calculated. We can do this by comparing the normal operation of the inflation index against the use of the IAF. For instance, we know that goods and services purchased for $160 in 1997 will cost $223.80 by the year 2026. In addition, we have made 1997 the initiation, or base-line-date, for the real financial instrument, which means simply that we have defined the purchasing power of one real currency unit to equal one nominal currency unit.

Hence, in January, 1997:
1.00 R$=$1.00
or
160.00 R$=$160.00

By definition, we also know that:
R$ times IAF=$
and
IAF for January 2026=1.398750

Therefore, by January, 2026, we can convert the 1997 real currency units to the nominal currency units in the year 2026 as follows:

$$\begin{matrix}\underline{\begin{matrix}160.00 R \$ \\ \times 1.398750\end{matrix}} \\ \$223 .80\end{matrix}$$

Since this result effectively matches the result indicated by the inflation index numbers of 160 for 1997 and 223.8 for 2026, we can be sure that our inflationary adjustment factors in Table 98 have been properly calculated.

Now, let us consider the incremental increases in the IAF factors in Table 98 beginning in the year 2000 and moving backwards:

| Year: | IAF: | Increment |
|---|---|---|
| 2000 | 1.041250 | |
| 1999 | 1.027500 | .013750 |
| 1998 | 1.013750 | .013750 |
| 1997 | 1.000000 | .013750 |

Or, for the entire period:
2026 − 1997 = 29 years
and
2026 IAF = 1.398750
1997 IAF = −1.000000
.398750
Finally:
.398750 = .01375
29 years

In essence, we have shown that the inflationary adjustment factor has been properly calculated, and now we have shown that the incremental increase in the IAF is 0.01375. Since this incremental increase of 0.01375, as part of the IAF, is multiplied against the real currency unit to obtain the nominal or fiat currency unit; it represents an increase of 1.375%. Inasmuch as real financial instruments use the IAF factor to make the inflationary adjustment, then in this example the inflation rate is 1.375%.

Now let's see what is happening to the prevailing rate of inflation. By definition, the prevailing rate of inflation is only concerned with the incremental rate of inflation over the past 12 months. Once again, using the data from Table 98, we can calculate the prevailing rate of inflation for 1998 as follows:

Calculating the Prevailing Rate of Inflation for Year 1

| | |
|---|---|
| 1998 Inflation Index Number = | 162.8 |
| 1997 Inflation Index Number = | −160.0 |
| | 2.8 |

and

| | |
|---|---|
| 2.8 | = 1.375% = PRI |
| 160 | |

As such, the pertinent formulas for the table to be created via Box 1350 are as follows:

| | | |
|---|---|---|
| Where: | 12 = | the number of payment periods per year |
| | N = | the number of the payment period |
| | BLD = | the assumed date representing the base-line-date |
| | CPI^{BLD =} | the assumed inflation index number on the BLD |
| | IAF^{BLD =} | 1.000000 representing the inflationary |
| | | adjustment factor on the BLD |
| Then: | CPI^{N =} | (1 + (PRI^{N}/12)) × CPI^{N-12} |
| | IAF^{N =} | CPI^{N}/CPI^{BLD} |
| | PRI^{N =} | CPI^{N}/CPI^{N-12} |

See Table 98 for an example of a complete table of IAFs and PRIs, but please note that the formulas above reflect twelve payments per year while the table in Table 98 assumes quarterly payments. Hence, the formulas above would have to be converted.
Box 1360: Initiate a table for the calculation of the amortizing (real) rate of interest for the real financial instrument by payment period. Then input the labels, values and formulas for the payment number, year, month, pricing index rate, effective nominal rate and the amortizing (real) rate of interest all by payment period. This table will then be used to supply the amortizing (real) rate of interest by payment period for the projections created via Process VI.

Initiate the table as described in Box 1360 above.

See Table 99 for an example.
Box 1370: Optional: The tables created via Boxes 1350 and 1360 can use historical data with the proper formula changes to calculate the historical results; or the formulas (or inputs) can be altered, to give fixed or arbitrary values, to generate the desired financial projections and stress tests.

Assuming historical values are input for the inflation index for the table created via Box 1350, then the following formulas should be input:

| | |
|---|---|
| Where: | |
| 12 = | the number of payment periods per year |
| N = | the number of the payment period |
| BLD = | the historical date representing the |
| | base-line-date |
| CPI^{BLD} = | the historical inflation index number on the BLD |
| CPI^{N} = | the historical inflation index number for |
| | payment period “N” |
| IAF^{BLD} = | 1.000000 representing the inflationary |
| | adjustment factor on the BLD |
| Then: | |
| RIR^{N} = | $\frac{( {CPI}^{N} - {CPI}^{N \text{-} 12} )}{{CPI}^{BLD}}$ |
| IAF^{N} = | $1 + \frac{( {CPI}^{N} - {CPI}^{BLD} )}{{CPI}^{BLD}}$ |
| PRIⁿ = | $\frac{( {CPI}^{N} - {CPI}^{N \text{-} 12} )}{{CPI}^{N \text{-} 12}}$ |

See Table 98 for an example of a complete table of IAFs and PRIs, upon which an historical table could be modeled.
Box 1380: Initiate an amortization schedule for the real financial instrument in the real currency unit. Input the labels, values and formulas as set forth in the charts created in Process IV, for the payment number, (&/or remaining term), the payment period by date, the beginning principal, the amortizing (real) rate of interest, the payment per period, the principal paid, the interest paid and the ending principal balance all in real terms. To the right of each monetary column, input a column with the real currency symbol (R$). Then, to the right of the interest rate column, input the real interest rate symbol (% R).

This is an amortization schedule like any other amortization schedule, except that we are amortizing a loan that is defined in the real currency unit with a real rate of interest. This correlation between the real currency unit and the real rate of interest is essential. If one amortizes a real currency balance with a nominal interest rate, then you will get values that are relatively meaningless. This is a very common mistake for those who are just being introduced to real financial instruments. Beyond that, any standard amortization formula can be used. The values for the term, initial payment date and beginning principal balance can all be taken from the inputs on the charts created in Process IV. The fixed, or variable, real interest rate can be taken from the chart values projected in the chart created via Box 1360.

See Tables 100a and 100b for an example of a real amortization schedule.
BOX 1390: Optional: If the amortization schedule created via Box 1380 has a payment period of less than one year, then compile the values into an annual schedule for presentation and graphing purposes.

If desired, compile the values as directed in the Box above.

See Table 101 an example of an annual real amortization schedule, which was compiled from the quarterly payment schedule in Tables 100a and 100b.
Box 1400: Initiate a conversion table for the real financial instrument in the nominal currency unit. Input the labels for payment period (or remaining term), the payment period by date, the beginning principal amount, the payment per period, the principal paid, the interest paid and the ending principal balance all in the nominal currency unit. Then, using the IAF for each payment period, as calculated in the table created via Box 1350, convert the real currency values in each payment period in the real amortization schedule created via Box 1360 to the nominal currency values for each payment period in the conversion table created herein (i.e. the real currency unit times the IAF equals the nominal currency units). Then, to the right of each monetary column, input a column with the nominal currency symbol (N$).

Create the conversion table as described in the Box above, which will convert the real financial instrument's real currency units (or monetary phase II) in the real amortization schedule to the nominal currency units (or monetary phase III). This conversion process is necessary, since the real currency unit begins as an abstract formula. Hence, the real financial instrument is tracked in the real currency unit, but must then be converted to the nominal currency unit for actual payment; since the asset-backed real monetary equivalent may not yet exist or may not yet be the currency of choice in the marketplace. The nominal currency conversion table is denoted by the use of the nominal currency symbol (N$) to denote the difference between the nominal currency conversion table and the currency recasting table using the traditional currency symbol ($). While the nominal currency (N$) unit and the currency ($) unit have the same purchasing power, the nominal conversion table will have an element of distortion in the principal paid column. This distortion will be eventually be corrected by the creation of the currency recasting table. Nonetheless, the currency recasting table is not required for presentations and stress testing purposes, so it is not included in this portion of the invention.

See Tables 102a and 102b for an example.
Box 1410: Optional: Add additional columns to the conversion table created via Box 1400, which may include values for the IAF, the effective nominal rate, the accrued interest balance and the revised interest balance. Then, if the conversion table has a payment period of less than one year, compile the values into an annual schedule for presentation and graphing purposes.

If desired, add one or more of the additional columns as described in the Box above. However, it may be best not to include the effective nominal rate of interest on the conversion table. Otherwise, the casual reader will assume that the conversion table is an amortization schedule that uses the effective nominal rate for amortizing. Of course, this is not the case and it will not work. The conversion table itself is not an amortization schedule, but rather represents the conversion of the real amortization schedule to the nominal currency units for payment. By not including the effective nominal rate, and by clearly labeling the conversion table as a “conversion table,” one may be able to minimize this misunderstanding.

See Tables 102a, 102b and 103 as an example.
Box 1420: For comparative purposes, initiate an amortization schedule in either the nominal currency (N$) unit, or currency ($) unit, for a nominal financial instrument, which uses the qualifying terms for the real financial instrument as set forth in Process IV. Input the labels, values and formulas as set forth in the charts created in Process IV for the payment number (or remaining term), the payment period by date, the beginning principal, the nominal interest rate, the payment per period, the principal paid, the interest paid and the ending principal balance, all in nominal terms. To the right of each monetary column, input a column with the nominal currency (N$) unit, or add the traditional currency ($) unit symbol to the left of the respective values, whichever is preferred. Then, to the right of the interest rate column, input the nominal interest rate symbol.

Initiate the amortization schedule for the nominal financial instrument as described in the Box above, which will be used for comparative purposes in the presentations and/or stress tests.

As far as the nominal financial instrument is concerned, there is no difference or distortion between the nominal currency (N$) unit (monetary phase III) and the currency ($) unit (monetary phase IV). While either monetary phase may be used at this juncture for the real financial instrument, any presentations made by this portion of the invention will frequently be shown to people who are still in the process of moving from conceptual stage I to conceptual stage II. As such, they have not yet been introduced to the distinction by and between the nominal currency (N$) unit and the real currency (R$) unit, which is presented to them for conceptual stage III. Hence, it is recommended that the nominal currency (N$) unit be used to coincide with its use in the nominal conversion table, which will require said level of distinction at a later point.

See Tables 104a and 104b as an example.
Box 1430: Optional: If the amortization schedule created in Box 1420 has a payment period of less than one year, then compile the values into an annual amortization schedule for presentation and graphing purposes.

If desired, compile the amortization schedule into an annual schedule as described in the Box above.

See Tables 104a, 104b and 105 as an example.
Box 1440: Initiate a conversion table for the nominal financial instrument in the real currency (R$) unit. Input the labels for the payment period (or remaining term), the payment period by date, the beginning principal amount, the payment per period, the principal paid, the interest paid and the ending principal balance all in the real currency (R$) unit. Then, using the IAF for each payment period, as calculated in the table created via Box 1350, convert the nominal currency (N$), or currency ($), values in the amortization schedule created via Box 1420 to the real currency (R$) values for each payment period in the conversion table created herein (i.e. the nominal currency (N$) units, or currency ($) units, divided by the IAF equals the real currency (R$) units.) Then, to the right of each monetary column, input a column with the real currency unit symbol (R$).

Initiate a conversion table in the real currency (R$) unit for the nominal financial instrument's amortization schedule as described in the Box above.

For presentation and stress testing purposes, we will want to compare the performance of both the real financial instrument and the nominal financial instrument in both the real currency (R$) unit and the nominal currency (N$) unit, or currency ($) unit. Once again, it is advisable to use the nominal currency (N$) unit at this point in the presentation materials, however, where the nominal financial instrument is concerned the nominal currency (N$) unit and the currency ($) unit are identical in all respects.

See Tables 106a and 106b as examples.
Box 1450: Optional: Add additional columns to the conversion table created via Box 1440, which may include values for the IAF, the effective real rate, the accrued interest balance and the revised principal balance. Then, if the conversion table has a payment period of less than one year, compile the values into an annual schedule for presentation and graphing purposes.

If desired, proceed with the additional columns and/or the compilation of the initial conversion table into an annual conversion table. Once again, it may be advisable to omit the effective real rate on the conversion table, or people may thing the conversion table is an amortization schedule using the effective real rate to amortize the loan. This is not the case, and will not work. The actual amortization for the nominal financial instrument occurs in the nominal currency (N$), or currency ($) amortization schedule. The conversion table merely reflects the results of the nominal amortization schedule in the real currency unit (R$).

See Tables 106a, 106b and 107 as examples.
Box 1460: Using the data provided in Process IV, initiate an operating pro form a for the term of the real financial instrument based upon the desired assumptions. The pro form a should break down the borrower's income into the logical categories for the given industry, which should include projected income, losses, operating income, operating expenses, replacement reserves, net operating income, debt service and cash flow before taxes; or the equivalent terminology, if any. The operating pro form a should be in the traditional currency ($) unit. The debt service values should be taken from the real financial instrument's nominal currency conversion table. All other values should be taken from the borrower's operating pro form a generated in Process IV for the initial time period, and then adjusted based upon the assumptions for future time periods.

Create the operating pro form a as described in the Box shown above. The operating pro form a is on either the borrower, or on the property owned by the borrower which secures the loan. By generating an operating pro form a on the same buyer, or property, with the same assumptions, but alternately with real or nominal financing; we can compare the impact of using real financial instruments versus nominal financial instruments.

See Tables 108a, 108b and 108c as an example.
Box 1470: Optional: Split the debt service column in the operating pro form a created via Box 1460 into the insurance (or securities) reserve and the net debt service, based upon the interest-only stream Process V dedicated to the ongoing insurance, or securities, reserve. Then add an additional column to show the cumulative reinvested cash flow before taxes, which is increased at the effective nominal rte of the real financial instrument. If the operating pro form a created via Box 1460 is reporting for periods of less than one year, then compile the values into an annual operating pro form a for presentation and graphing purposes.

Frequently, a portion of the borrower's debt service payment, which is derived from the interest-only portion of the payment; is allocated to an insurance payment or a securities reserve. The purpose of the insurance payment, or the securities reserve, is to convince the credit rating company that a higher proportion of the asset-backed securities deserve an institutional-quality credit rating. By splitting this interest-only stream from the net debt service payment, it can be tabulated and/or graphed separately so that the analyst at the credit rating company can appreciate the merits of these funds that are set-aside against any loan defaults. Then, by reinvesting the cash flow before taxes on the pro form a for the real financial instrument, the result over many years can be compared to the same column on the pro form a for the nominal financial instrument. Once again, this will help to demonstrate to the potential borrower the benefits of using real financial instruments over nominal financial instruments. Using the effective nominal rate on the real financial instrument is reasonable; since this is the least that the borrower could expect to earn on these funds, if he or she used the extra cash flow to pay down the unpaid principal balance on the real financial instrument. Finally, it is easier to present the annual results than quarterly or monthly results in projections and graphs.

See Tables 108a, 108b and 108c for an example.
Box 1480: Initiate a real currency conversion pro form a to convert the monetary values in the operating pro form a created via Box 1460 from the currency ($) units to the real currency (R$) units (i.e. divide the currency values ($) by the IAF for each given period, to obtain the real currency (R$) values.) Then, input the same labels, but to the right of each monetary column input the real currency symbol (R$).

Initiate the real currency conversion pro form a as described in the Box above.

See Tables 110a, 110b and 110c as an example.
Box 1490: Optional: If the conversion pro form a created via Box 1480 has a reporting period of less than one year, then compile the values into an annual schedule for presentation and graphing purposes.

See Tables 110a, 110b, 110c and 111 as an example.
Box 1500: Repeat Boxes 1460 to 1490, but input the appropriate debt service for the nominal financial instrument instead of the real financial instrument, and change the labels accordingly.

Essentially, do the same thing for the nominal financial instrument as you did for the real financial instrument in Boxes 1460 to 1490.

See Tables 112a, 112b, 112c, 113, 114a, 114b, 114c and 115 as an example.
Box 1510: Optional: Repeat Boxes 1460 to 1500 to initiate other comparative operating pro forma, but using different assumptions for the projected income, expense and reserve values to produce the desired marketing presentations and/or stress tests.

Generate additional scenarios, if desired.

See Tables 116a, 116b, 116c and 117 as an example.
Box 1520: Optional: Repeat Boxes 1340 to 1450 to initiate comparative amortization schedules and conversion tales for the real financial instrument and/or the nominal financial instrument using different assumptions. The results can then be used in association with the comparative pro form a created via Box 1510 to produce the desired marketing presentations and/or stress tests.

Generate additional scenarios, if desired.
Box 1530: Initiate a tax reporting schedule for the real financial instrument that will allow the respective parties to determine their respective tax reporting data, assuming they are each tax reporting entities.

Inasmuch as we have not yet introduced the currency ($) phase, or monetary phase IV, the use of the marketing materials created via Boxes 1340 to 1500 have yet to rectify the distortion in the nominal currency (N$) conversion table for the real financial instrument. As such, the total of the principal paid column, during net inflationary time periods, will exceed the amount of money borrowed on the initiation date, or base-line-date. While we would prefer to move the prospective borrower gradually from conceptual stage II, involving both the real currency (R$) unit and the nominal currency (N$) unit, to conceptual stage III, which will add the currency ($) unit; nonetheless, many borrowers will want to see the after-tax impact of the use of the real financial instrument. As such, we include this tax reporting schedule, which is laid out in such a way as to help the prospective borrower understand what is happening with respect to the accruing interest, etc. Nonetheless, the addition of monetary phase IV is still essential, since it is required for book reporting purposes. In other words, if you borrow one million dollars, then you must eventually show that you have repaid precisely one million dollars, or conversely the paid and unpaid balances must equal the million dollars originally borrowed.

As an example, input the appropriate title, labels and monetary phase symbols. Then establish columns for (1) the year or payment period, as desired, (2) the beginning principal with accrued interest, (3) the annual real financial instrument's (loan or investment) accrual, (4) the cumulative mortgage accrual, (5) accrual reduction, (6) real financial instrument's (loan or investment) accrual cash reduction, (7) beginning original principal reduction, (8) total cash payment, by year or payment period as desired, (9) the (tax authority's) recognized cash principal payment, (10) the (tax authority's) recognized cash interest payment, (11) the ending original principal payment.

In order to determine a number of the values, we will need to use the following conditional statement:

| Assuming: | @IF(Condition, True Expression, False Expression) | |
|---|---|---|
| Where: | Condition = | A logical expression representing the |
| | | condition to be tested. |
| | True Expression = | A numeric value representing the value |
| | | to use if the Condition is true. |
| | False Expression = | A numeric value representing the value |
| | | to use if the Condition is false. |

Then, using the @IF condition statement above, and using the alphanumeric labels in Table 118; the proper formulas for the columns listed are as follows:

| | | |
|---|---|---|
| (A) | Year: = | The year of term can be obtained from Table |
| | | 145, created via Box 1850. |
| (B) | Beginning Principal | |
| | with Accruals: | |
| | 1^{st} Row: = | The beginning principal balance in the first |
| | | row in Table103, created via Box 1410. |
| | Subsequent Rows: = | The ending principal balance for the prior |
| | | payment period. |
| (C) | Annual (Loan) Accrual: | |
| | 1^{st} Row: = | @IF ((B2 > B1), 1, 0) × (B2 − B1) |
| | Subsequent Rows: = | etc. |
| | Except, Last Row: = | @IF ((0 > B30), 1, 0) × (0 − B30) |
| (D) | Cumulative (Loan) Accrual: | |
| | 1^{st} Row = | D1 − F1 |
| | 2^{nd} row = | D2 + E1 − F2 |
| | Subsequent Rows: = | etc. |
| (E) | (Loan) Accrual Cash Reduction: | |
| | 1^{st} Row = | N/A |
| | 2^{nd} Row: = | @IF ((B2 − B3 − J2) > 0, 1, 0) × (B2 − B3 − J2) |
| | Subsequent Rows: = | etc. |
| | Except, Last Row: = | @IF ((B30 − 0 − J30) > 0, 1, 0) × (B30 − 0 − J30) |
| (F) | Beginning Original Principal Balance: | |
| | 1^{st} Row = | + B1 |
| | 2^{nd} Row = | + L1 |
| | Subsequent Rows: = | etc. |
| (G) | Total Annual Cash Payment: | |
| | 1^{st} Row = | The payment in the first row in Table 103, created |
| | | via Box 1410. |
| | Subsequent Rows: = | etc. |
| (H) | (Tax Authority's) Recognized Cash Principal Payment: | |
| | Where: ZN = | The ending principal balance with the accrued |
| | | interest in the Nth row in Table 103, created via Box |
| | | 1410. |
| | Then: | |
| | 1^{st} Row = | @IF((H1 − Z1) > 0, 1, 0) × (H1 − Z1) |
| | Subsequent Rows: = | etc. |
| (I) | (Tax Authority's) Recognized Cash Interest Payment: | |
| | 1^{st} Row = | I1 − J1 |
| | Subsequent Rows: = | etc. |
| (J) | Ending Original Principal Balance: | |
| | 1^{st} Row = | H1 − J1 |
| | Subsequent Rows: = | etc. |

Finally, total the items for (C), (E), (G), (H) and (I) for the total term of the real financial instrument. The total annual real financial instrument's (loan or investment) accrual (C) must equal the real financial instrument's (loan or investment) accrual cash reduction The total principal paid (G) must equal the beginning original principal balance (F) in the first payment period. And, the total principal paid (H) plus the total interest paid (I) must equal the total payments (G). If these results are not obtained, then find the mistakes and correct them.

Please note that when the inflation rate is minimal, as in the assumptions for Table 118, there will be minimal activity in the columns for the accruing interest. In essence, when the amount of principal payoff in a given payment period exceeds the inflationary adjustment for the payment period, then there will be no accruing interest. In order to present a more through perspective on the use of this schedule, please review Tables 119a and 119b. Table 119a is a duplicate of this schedule, but was prepared for the Real Mortgage™ amortization schedule shown in Table 119b. As such, Table 119a will provide the reader with a better perspective of the use of the schedule being created by this Box.

See Tables 118, 119a and 119b as examples.
Box 1540: Optional: Using the tax reporting data generated via Box 1530, extend the pro form a created via Boxes 1460 to 1510 to project the after-tax consequences of using the respective financial instruments each year. Then extend this to an assumed sale at the end of each year, once again showing the after-tax consequences for the borrower.

If desired, extend the pro form a as described in the Box above.
Box 1550: Optional: Input any notes, definitions and/or disclosures that may be desired on the schedules, tables and pro form a created in Process VI.

If desired, add any notes, definitions and/or disclosures as described in the Box above.

See Tables 98, 101, 103, 105, 107, 109, 111 and so on as examples.
Box 1560: Initiate a graph, which will plot the borrower's cash flow before taxes in the nominal currency (N$), or currency ($), unit for the borrower, or the subject property securing the loan; when financed by (1) the real financial instrument and (2) the nominal financial instrument. The values to be plotted will come from the operating pro form a created via Boxes 1460 (or 1470) and Box 1500 respectively, or alternatively from Box 1510. Add the descriptive title, labels, notes and legends as desired.

Initiate the graph as described in the Box above.

This Box, and those that follow for the remainder of Process VI, will compare various aspects of using the real financial instrument versus the nominal financial instrument, first in the nominal currency (N$), or currency ($), unit and then in the real currency (R$) unit. We have found that these graphs, depicting conceptual stage II, are essential in commencing the paradigm shift for new individuals. For the first time, they can see what is happening to them in real terms when they use a traditional nominal financial instrument. They can also begin to see the advantages of using the real financial instrument over the nominal financial instrument. Thus begins their paradigm shift from the sole use of nominal financial instruments, and nominal currencies, in conceptual stage I; to the use of real financial instruments with real currency units in conceptual stage II.

See Table 120 as an example.
Box 1570: Initiate a graph, which will plot the borrower's cash flow before taxes in the real currency (R$) unit for the borrower, or the subject property securing the loan; when financed by (1) the real financial instrument and (2) the nominal financial instrument. The values to be plotted will come from the operating pro form a created via Boxes 1480 (or 1490) and Box 1500 respectively, or alternatively from Box 1510. Add the descriptive title, labels, notes and legends as desired.

Initiate the graph as described in the Box above.

See Table 121 as an example.
Box 1580: Initiate a screen, and/or page print out, that will juxtapose the nominal currency (N$), or currency ($), graph created via Box 1560 at the top, and the real currency (R$) graph created via Box 1570 at the bottom. By juxtaposing the comparative results (of using a real financial instrument versus a nominal financial instrument) in both the nominal currency (N$), or currency ($), and the real currency (R$), one can begin to see the benefits of using real financial instruments; thereby beginning one's monetary paradigm shift.

Initiate the graph as described in the Box above. Please note, that it is not the graphs alone, by the proper juxtaposition of the graphs in two monetary phases that allows the viewer to begin to think in both real and nominal terms at the same time. This is an essential first step in one's monetary paradigm shift. If these two graphs were plotted on different screens, or different pages, most people would miss the direct comparison between the nominal and real effects of these instruments. As we begin to think in both real and nominal terms, then we have arrived at conceptual stage II; which is the primary goal of Processes IV, V and VI.

See Table 122 as an example.
Box 1590: Repeat Boxes 1560, 1570 and 1580, but plot the borrower's cumulative reinvested cash flow.

From this point forward, we can present the many relative aspects of the use of real financial instruments versus the traditional nominal financial instruments using graphs presenting the results in real and nominal currency units and then juxtaposing them for comparison.

See Tables 123, 124 and 125 as examples.
Box 1600: Repeat Boxes 1560, 1570 and 1580, but plot the borrower's annual debt service.

From this point forward, we can present the many relative aspects of the use of real financial instruments versus the traditional nominal financial instruments using graphs presenting the results in real and nominal currency units and then juxtaposing them for comparison.

See Tables 126, 127 and 128 as examples.
Box 1610: Repeat Boxes 1560, 1570 and 1580, but plot the borrower's mortgage balances; except that the values to be plotted will come from the amortization schedules and conversion schedules created via Boxes 1380, or 1390, 1400, or 1410, 1420, or 1430, and 1440, or 1450, or alternatively from Box 1520.

This juxtaposition of this particular set of graphs is very important, since it answers the marketing concern of both lenders (or investors) and borrowers with respect to the negatively amortizing nature of the real financial instrument. When the average annual inflation rate begins to exceed a certain percentage in the early years, then the outstanding principal balance of the real financial instrument will begin to negatively amortize. In the 1980s, certain mortgage forms were introduced that also negatively amortized, just when inflation was beginning to decline. It is important for everyone concerned to recognize the difference between a negative amortization in real terms versus a negative amortization in nominal terms. If properly structured, the real financial instrument will not negatively amortize in real terms, no matter how high the rate of inflation becomes. The mortgage forms offered in the 1980s actually experienced negative amortization in real terms, since the mortgages were nominal in nature and did not use an amortizing (real) rate of interest and real currency units. By using the graphs as created via Box 1610, one can carefully emphasize the lender, the investors and the borrowers that (1) real financial instruments will sometimes be negatively amortizing in the nominal currency unit, but (2) money is supposed to represent purchasing power, (2) only the graph of the outstanding principal balance in the real currency unit shows us what is really happening in terms of total purchasing power of the outstanding principal balance, (4) the reason that the principal balance is negatively amortizing in the nominal currency unit is that the nominal currency unit is being devalued by inflation and therefore requires an ever greater amount of units to equal the equivalent number of real currency units. As a result, the nominal currency graph tells us relatively little about the total purchasing power of the outstanding principal balance, since it is not adjusted for inflation. This presentation, which can be best demonstrated by the juxtaposition of the graphs created via Box 1610, is the most effective tool we have in answering the marketing concern about the negatively amortizing principal balances of real financial instruments. If this objection is not dealt with effectively, neither the lender, the investor or the borrower will trust real financial instruments for general usage in the marketplace.

See Tables 129, 130 and 131 as examples.
Box 1620: Repeat Box 1610 to plot the borrower's mortgage balances, and repeat Boxes 1560, 1570 and 1580 to plot the property's value.

The juxtaposition of the graphs created via Box 1620 reinforces the response to the negatively amortizing principal balance of the real financial instrument as addressed in the description of Box 1610.

See Tables 132, 133 and 134 as examples.
Box 1630: Repeat Boxes 1560, 1570 and 1580, but plot the borrower's operating cash flows.

Perform the function stated in the description of the Box above.

See Tables 135, 136 and 137 as examples.
Box 1640: Repeat Boxes 1560, 1570 and 1580, but plot the borrower's operating cash flows vs the cumulative insurance or securities reserve.

Perform the function stated in the description of the Box above.

See Tables 138, 139 and 140 as examples.
Box 1650: Optional: Annotate the graphs as desired.

The graphs are a wonderful way to point out the differences between real and nominal financial instruments. One should not assume that the viewer will understand the nuances without first being introduced to them.

Perform the function stated in the description of the Box above.

See Tables 120 to 140 as examples.

Process VII: Initiating the Origination of the Real financial Instruments to be Securitized by the Conduit.
Box 1660: Name the real financial instrument.

Perform the function stated in the description of the Box above.

See Table 141 as an example.
Box 1670: Input data identifying the subject matter of the loan. (Such as the borrower's name, the property securing the loan, if any, and/or the loan application file number.

Input essential information as stated in the Box description above.

See Table 141 as an example.
Box 1680: Input the name of the conduit purchasing, or funding, the real financial instrument; thereby adopting the conduit's defined marketplace and system. (By default, the selection of the conduit will also establish the parameters, monetary phases, conventions, primary asset class and the underwriting standards; which are derived from the system and the marketplace.)

In general, any given originator or underwriter of the loan could be generating loans for any number of conduits with each conduit looking to purchase loans with different characteristics. Hence, the underwriter must elect which conduit he wishes to market the loan to, and by so doing the invention will provide him with the pertinent data required for that conduit's underwriting standards, etc.

See Table 141 as an example.
Box 1690: Input the initiation (or funding) date of the real financial instrument.

Then input the master inflationary adjustment factor, which can be found on the system's record of MIAFs with respect to the instrument's initiation date. The MIAF record was created via Box 130.

The master inflationary adjustment factor is simply one plus the percentage change in the inflation index between the system base-line-date and the initiation date of the real financial instrument. Typically, the MIAF record will only change on a monthly basis, when the new inflation index number is released. As such, all instruments created in the same month will have the same MIAF. As an option, a system could be established on a different time period, but the current practices of major financial institutions indicates that this is not likely at this time. Nonetheless, once the MIF is issued it is constant thereafter for the given real financial instrument.

See Tables 76 and 141 as an example. (Unfortunately, the two examples cover different time periods, so there is not a common MIAF that can be shown. Nonetheless, the source of the MIAF for the real financial instrument should be obvious.)
Box 1700: Input the value for the real financial instrument's inflationary adjustment factor (IAF), which is always equal to 1.000000 on the initiation date of the instrument. And, input the value of the real financial instrument's real currency (R$) unit, which is always equal to on nominal, or fiat, currency unit ($1.00) on the initiation date of the real financial instrument.

Input the values as described in the Box above.

See Table 141 as an example.
Box 1710: Subject to the pricing criteria established by the conduit's sponsor pursuant to the pricing and securities structuring model derived from Process IV and V: input the labels, values and formula for determining the borrower's qualifying interest rate. This will include (1) the qualifying index, (2) the qualifying index term, (3) the qualifying date, (4) the qualifying index rate, (5) the qualifying margin and (6) the formula for calculating the qualifying interest rate, which is the qualifying interest rate plus the qualifying margin.

Input the labels, values and formula as described in the Box above. This repetitive process must be followed for each and every real financial instrument, since the indexes and/or rates may fluctuate from one day to the next, and the qualitative underwriting results can also affect the rate on any given instrument.

See Table 141 as an example.
Box 1720: Subject to the underwriting criteria established by the defined marketplace in Process II, and then adopted and amended by the conduit in Processes III and IV: input the labels, values and formulas for determining the borrower's qualified loan amount #1. This will include values for (1) the borrower's qualified income, (2) the required qualifying debt-service-coverage, (3) the formula for calculating the qualified annual payment and (4) the formula for calculating the qualified loan amount #1.

Input the borrower's qualified income, as supplied by the borrower but subject to the underwriter's adjustment, and the required debt-service-coverage as established by the conduit's underwriting guidelines. Then, input the formula for calculating the qualified annual payment, which is the borrower's qualified income divided by the required debt-service-coverage. Then, use (a) the qualified annual payment, (b) the qualifying index term (see Box 1710), (c) the qualifying interest rate (see Box 1710) and any acceptable amortization formula to project the qualified loan amount #1.

See Table 141 as an example.
Box 1730: Subject to the underwriting criteria established by the defined marketplace in Process II, and then adopted and amended by the conduit in Processes III and IV: input the labels, values and formulas for determining the borrower's qualified loan amount #2. This will include values for (1) the appraised value of the property, (2) the maximum loan-to-value, and (3) the formula for calculating the qualified loan amount #2.

The appraised value of the property must come from a qualified appraisal, and the appraisal must be found to be acceptable by the participating parties, such as the sponsor, the originator, the credit rating company or agency and so on. The value for the maximum loan-to-value is obtained from the quantitative underwriting standards established by the defined marketplace and then adopted by the conduit

See Tables 83, 89 or 90 and 141 as examples.
Box 1740: Subject to the pricing criteria established by the conduit's sponsor pursuant to the pricing and securities structuring model derived from Process IV and V: input the labels, values and formulas for determining the borrower's effective nominal rate. This will include values for (1) the pricing index term in months, if the real financial instrument is a second generation instrument, (2) the pricing index, (3) the pricing index rate, (4) the fixed pricing margin and (5) the formula for calculating the effective nominal rate.

If the real financial instrument is a second generation instrument; then we will need to know the pricing index term in months, so we can obtain the correct pricing index rate. Are we looking for the 30-day T. Bill rate or the 90-day T. Bill rate? With this information, along with the pricing index, we can obtain the pricing index rate from any number of third party sources. The fixed pricing margin is determined by the conduit sponsor, which he or she determines by created a financial model of the real financial instruments and the proposed securities offering via Process IV and V. Finally, the effective nominal rate is the pricing index rate plus the fixed pricing margin.

See Table 142 as an example.
Box 1750: Subject to the underwriting criteria established by the defined marketplace in Process H, and then adopted and amended by the conduit in Processes III and IV: input the labels, values and formula for determining the borrower's fixed (or variable) amortizing (real) rate of interest. This will include (1) the amortizing term, the ratcheting term in months, which includes both the initial amortizing term and the term of the real financial instrument, if elected by the borrower, (3) the ratchet per year in months, if any, (4) the balloon payment term, if any, (5) the effective nominal rate (from Box 1740), (6) the prevailing (or real) rate of inflation, (7) the formula for calculating the amortizing (real) rate and (8) the rate adjustment period.

The purpose of the ratcheting amortization schedule is to minimize the amount of negative amortization on a long-term real financial instrument. (See the description for Box 1610 for a more complete discussion of the negative amortization). The ratcheting amortization schedule simply amortizes the instrument using a short term. For instance, a 360 month Real Mortgage™ may begin by being amortized at 300 months. This amortization schedule is called ratcheting, because it periodically readjusts, or ratchets, to a new term. (See the description for Box 310). The ratchet per year is the number of months that the mortgage ratchets for each given time period, such as 10 months for each year of the actual term of the instrument.

A provision is made to indicate whether balloon payments will be permissible. Nonetheless, the whole concept of financial instruments that are self-adjusting for inflation obviates the need for balloon payments. In addition, during the transitional phase from the nominal monetary paradigm to the real monetary paradigm, the credit rating companies will be very uneasy about granting institutional-quality credit ratings on a pool of financial instruments that are ballooning just when the negative amortization may be reaching its peak. The reality is that balloon payments are another “fix” for nominal financial instruments, which tend to work very poorly. They are supposed to protect the lender/investor from the longer-term impact of inflation, by periodically demanding that the obligation be paid off so that the money can be recycled at the current nominal rate, which would include an inflationary premium. In realty, when this does occur, the borrower is frequently unable to refinance his or her property at the higher nominal rates in the marketplace when the balloon payment comes due. This causes a default on the financial instrument, which has a negative impact on everyone associated with the loan. The point of this exercise being, that balloon payments are neither necessary nor desirable for real financial instruments. Nonetheless, the underwriters and the potential borrowers need to know the conduit sponsor's position on this subject.

As discussed earlier, the prevailing and the real rate of inflation are the same during the first year, but then tend to move apart later assuming an inflationary economy. Hence, one can use either the term “prevailing” or “real” at this point to show how the amortizing (real) rate of inflation is determined. It is generally best at this point to use the “prevailing rate of inflation,” since these presentations will be shown to many prospective borrowers who are just moving from conceptual stage I to II. As such, they have not yet been introduced to the difference between the prevailing and the real rates of inflation, which should be introduced in conceptual stage III. Finally the rate adjustment period is simply how often the amortizing (real) rate of interest will be adjusted with respect to changes in the pricing and/or inflation index. This could be any reasonable and mutually agreed upon time period, such as monthly, quarterly, semi-annually, annually, etc. The conduit sponsor simply has to tailor the issued securities to adjust within the same time period, so that no one will incur any interest-rate risk.

See Table 142 as an example.
Box 1760: In preparation for the loan closing, input the labels, values and formulas for the terms of the loan commitment. This would include (1) the loan closing file number, (2) the initiation (or closing) date, (3) the qualified real loan amount, (4) the term of the loan, (5) the ratcheting payment election, if offered by the conduit, (6) the amortizing (real) rate of interest (from Box 1750), the formula for calculating the initial payment, (8) the inflationary adjustment period, (9) the current inflationary adjustment (CIA) and (10) the resulting debt-service-coverage.

Typically, loan closing file numbers are kept separate and apart from any file number issued to the real financial instrument after the closing for many reasons. Nonetheless, it is important for the ongoing file on an existing real financial instrument to have the original loan closing file number, so that historical data received during the application process may be retrieved if needed by the lender. This data may include important legal documents such as the borrower's representations, operating pro forma, credit reports, title searches and appraisals, all of which may be required by the lender in the event of a foreclosure of the loan.

The initiation, or closing, date is the day the loan is funded. This establishes the beginning of the amortization schedule, the MIAF and the IAF, all of which are important in tracking the financial activity of the loan. The qualified loan amount is the lesser of qualified loan amount #1 or #2, as determined via Boxes 1720 and 1730. The loan amount, along with the term of the loan, the ratcheting loan election, if any, the amortizing (real) rate of interest are all used in conjunction with any acceptable amortization formula to calculate the initial payment of the real financial instrument. Inasmuch as the real currency unit equals the nominal currency unit during the first payment period (by definition), there is no difference between the qualified loan amount in nominal or real currency units, and no difference in the initial loan payment.

The inflationary adjustment period is simply how frequently the real financial instrument moves up to the more current inflationary adjustment factor (IAF) or MIAF for the conversion of the real currency (R$) unit to either the nominal currency (N$) unit or the master real currency (MR$) unit respectively. This may be monthly, quarterly, etc. While the investors may prefer the short time periods, the borrowers may prefer the longer time periods. The conduit sponsor must arrive at an adjustment period that he can market to both the investors and the borrowers. Typically, the adjustment period for pricing the instrument will occur within the same time period as the inflationary adjustment period.

The current inflationary adjustment (CIA) is different than the adjustment made with the IAF or MIAF. While the IAF and the MIAF adjust the unpaid principal balance, the CIA is an adjustment for the principal that is repaid in the current time period. If the CIA is not properly carried out, then the amortizing (real) rate used to amortize the unpaid principal balance will not be a real rate of interest, since there has been no inflationary adjustment on the principal that is used for the current time period and then paid in arrears. This is very important with respect to representations made to securities investors that they will receive either a certain fixed real rate of interest, or a real rate of interest based upon a formula that does not take the CIA into effect.

Finally, the real financial instrument has been qualified in traditional nominal terms to avoid credit-related problems that would occur if we used the amortizing (real) rate of interest to qualify the borrowers. As such we use a debt-service-coverage that is currently acceptable in the marketplace to our traditional, nominal investors, such as 1.25 for a residential apartment building. (The terminology may be different for other asset classes, but the concept is effectively the same). Then, once the qualified loan amount is determined, the real loan is granted in the real currency unit and amortized with a real rate of interest. This essentially factors out the inflationary premium that is built-into the qualifying (nominal) rate of interest, such that the conversion of the real currency into the nominal currency reveals a substantial drop in the loan payment for the initial time period. This process results in a debt-service-coverage that is much higher than the qualifying debt service coverage. This process effectively increases the standard-of-living of the borrower, while protecting the investor from the ravages of inflation and deflation over time. It means that the use of nominal financial instruments with inflationary premiums is depressing the performance of our economies.

See Table 142 as an example.
Box 1770: Optional: If the conduit has elected to offer the real financial instrument with ratcheting terms, then input the labels, values and formulas for the ratcheting payment terms. This would include (1) the borrower's election, (2) the ratcheting term over the instrument's full term, (3) the ratchet per year in months, (4) the initial ratchet payment per month and (5) the ratchet debt-service-coverage.

The purpose of this section is to calculate the terms for the ratcheting instrument so that it can be discussed with the borrower, then the borrower's choice between the original terms of the real financial instrument and the ratcheting terms can be input.

See Table 142 as an example.
Box 1780: Optional: If the defined marketplace, and the conduit, have agreed to allow and/or accept real monetary equivalents in payment of the loan obligation, then input (1) the traditional legal tender as issued by the government and (2) the real monetary equivalents that will be accepted in payment.

As legal tender, the government-issued fiat currency should be included in any list of monetary equivalents that will be accepted by the conduit.

See Table 142 as an example.
Box 1790: Optional: Input any notes, definitions or disclosures that may be desired on the screens or charts created as a result of this Process VII.

See Tables 141 and 142 as an example.
Box 1800: Optional: Repeat Boxes 1660 to 1790 for additional real financial instruments of the given primary asset class to be purchased or funded by the conduit.

Inasmuch as the asset-backed securitization industry requires substantial monetary volumes, along with geographical distribution, to cover expenses and to obtain the required institutional-quality credit ratings; for all intense purposes only large pools of financial instruments can be securitized effectively.

See Tables 141 and 142 as an example.
Box 1810: Optional: Initiate reports on the real financial instrument(s) as desired for servicing, collections, billing, late payment tracking, foreclosures, etc.

Initiate additional reports as desired.

Process VIII: Formation of the Initial Conduit
Box 1820: Initiate a screen suitable for inputting and displaying the key organizational data that concerns the conduit, including but not limited to: (1) the monetary system, (2) the defined marketplace, (3) the conduit's name, (4) the sponsor, (5) the trustee, (6) the servicing company, (7) the back-up servicer, if any, (8) the primary asset class and (9) the start-up date of the conduit.

As the system and defined marketplace develop, investors purchasing the issued and/or stripped securities will need on-line access to key organizational data.

See Table 143 as an example.
Box 1830: Initiate a record of the primary assets, secondary assets, if any, and the qualified investments of the conduit, which should identify each individual asset and include key financial data required for the generation of the subsequent amortization schedules, financial projections and reports.

This record must be sufficiently complex to include any and all financial data that will be required to compute any and all financial reports.

See Table 144 as an example.
Box 1840: Using the system's record of master inflationary adjustment factors (MIAFs), created via Box 130: initiate one, or more, record(s) that will effectively track (1) the relative dates, (2) inflation index numbers, (3) prevailing rates of inflation, (4) inflationary adjustment factors, (5) IAF constants, (6) master inflationary adjustment factors (MIAFS) and (7) MIAF constants for each payment period of each primary asset. Except that, the identical data for any and all instruments initiated in the same month can be represented by one table, or by a portion of the same table, for this subset of instruments.

Initiate one, or more, records as described in the Box above.

See Tables 145 and 146a-c as examples.
Box 1850: Initiate a record for each primary asset, which will compute and track the respective amortizing (real) rate for each and every instrument. Instruments with the same pricing index and fixed pricing margin can share one table. For clarity, the resulting table(s) should include (1) the date by payment period, (2) the remaining term, represented by the number of payments remaining at the start of each payment period, (3) the pricing index rate, (4) the fixed pricing margin, (5) the effective nominal rate (%), (6) the prevailing rate of inflation (PRI) and (7) the amortizing (real) rate (% R).

Initiate one, or more, records as described in the Box above.

See Tables 146a-c as examples.
Box 1860: Repeat Boxes 1020 to 1330 to create a screen, or chart, to formally project the credit enhancement, securities pricing and securitization structure for the conduit's start-up. Except that, the primary asset pooling values should come via Box 1830, pooling values for the secondary assets, if any, should be set forth; and the cumulative total of the primary and secondary values should be shown as the pooling values for the qualified investments. Securities classes should be added, or deleted, as required for the desired securities structuring. Program expense and interest reconciliation categories should be amended as desired. Then the values for the conduit's current situation should be added, or deleted, as required for proper accounting purposes. The end result will be the conduit's credit enhancement, securities pricing and securitization structure for the securities to be issued on the start-up day.

Certainly, the conduit's sponsor should be using the chart created via Boxes 1020 to 1330, or some modified form thereof, to continuously projecting the credit enhancement, securities pricing and securitization structure as the start-up day approaches, but this will be the sponsor's final projection, and the conduit's official record, for the issuance of the securities on the start-up day. (See Box 1870 for the additional issuance of securities after the start-up day).

See Table 147 as an example
Box 1862: Repeat Boxes 1840 and 1850 for (a) each issued securities class by period issued and (b) each accrued interest class by period stripped.

Initiate one, or more, records as described in the Box above. Please note that the stripped Accrual Rights can use the same interest rate schedule as the issued securities class from which they were stripped, but will require a separate record for the IAF constant and the MIAF constant. These constants are used when there is a need for a projection from the perspective of the Accrual rights purchaser and not from the perspective of the issuing conduit. In order to assist in the development of a market for the Accrual rights, they should be given a priority of payment over the issued securities class from which they were stripped. This will increase the credit-quality of the Accrual Rights, thereby enhancing their value and marketability. Conversely, this will not increase the risk of the issued securities holders, since they will receive the proceeds of the sale less and discount.

See Tables 148, 149, 150 and 151a-e as examples.
Box 1865: Initiate the record to establish the “Shifting Ownership of the Conduit's Assets by Priority of Certificate Class.”

As an example, input the appropriate title, labels and monetary phase symbols. Then establish columns for (1) the month, quarter or year, reflecting the payment period, (2) each issued real securities class, (3) each Accrual Rights class, (4) any nominal rate classes, if any, (5) the residual, or ownership, class, and (6) the total. All (7) monetary columns should be defined in the conduit's real currency (R$) unit.

Input (A) the respective payment periods, as desired. For the first payment period, the values (B) for the issued real securities classes can each be obtained from Table 147, created via Box 1860, (C) for the Accrual Rights simply input “N/A” for not applicable, (D) for the nominal rate certificates, if any, input the value from Table 147, created via Box 1860. Then, (E) input the value for the residual class from Table 147, times a negative one. Then, (F) add the values from (2) through (6) in the first row to obtain the total.

For the subsequent payment periods, the values (G) for the issued real securities classes can be obtained from Table 203, created via Box 2550, and from Table 207, created via Box 2590, etc, if any, (H) for the Accrual Rights from Table 211, created via Box 2630, and Table 215, created via Box 2670, etc., if any, (I) for the nominal rate certificates, if any, input the value from Table 183, created via Box 2340. Then, (J) input the value for the residual class from Table 197, created via Box 2490. Then, (K) add the values from (2) through (6) for each respective row to obtain the total.

See Table 152 as an example.
Box 1867: Initiate the record to establish the “Shifting Percentage of the Conduit's Ownership by Priority of Certificate Class.”

As an example, input the appropriate title, labels and monetary phase symbols. Then establish columns for (1) the month, quarter or year, reflecting the payment period, (2) each issued real securities class, (3) each Accrual Rights class, (4) any nominal rate classes, if any, (5) the residual, or ownership, class, and (6) the total. All (7) monetary columns should be defined in the conduit's real currency (R$) unit.

Input (A) the respective payment periods, as desired. Then (B) divide each respective value in the monetary rows and columns by the total for each respective row, multiply this number by one hundred and input in the respective monetary row and column in the table created herein. Then, (C) add a percentage symbol to the right of each value, thereby converting the rows from monetary to percentage values. Finally, (D) add columns (2) through (6) to total the percentages. If the percentages for each row do not total to one hundred percent, then a mistake has been made. Find the mistake and correct it.

See Table 153 as an example.
Box 1870: Optional: For legal entities that are allowed to issue additional securities after the start-up day, periodically repeat Box 1860 as needed to include both the conduit's historical offering data along with the new credit enhancement, securities pricing and securities structuring data required for the subsequent issuance of securities by the conduit.

Update and revise the screen, or chart, created via Box 1860 for the new offering of securities. As an example in the United States, a relatively new entity called the financial asset securitization investment trust (FASIT) is allowed to issue securities on an ongoing basis, while the more traditional real estate mortgage investment conduit (REMIC) can only issue securities on the start-up date. Please note that this activity is not necessary for the stripping of securities that have already been issued, which the invention will provide for herein.

See Table 147 as an example.
Box 1880: Optional: Input any notes, definitions and/or disclosures that may be desired on the screens or charts created as a result of this Process VIII.

If desired, follow the instructions in Box 1880.

See Tables 143 to 147 as examples.

Process IX: Quantifying and Pooling the Primary Assets to be Securitized by the Initial Conduit Leading up to the Start-Up Day.
(Note: There are no secondary assets available at the time the initial conduit is formed.)
Box 1890: Real financial instruments are amortized in the real currency unit, using the amortizing (real) rate of interest. This makes the real currency amortization schedule the dominant schedule for the real financial instrument. As such, initiate a record for the initial primary asset purchased by the conduit, which will properly compute the amortization of this instrument in real terms by payment period. This schedule should include (1) the payment period by date and/or payment number, (2) the remaining term, (3) the beginning principal balance, (4) the real rate, (5) the payment, (6) the interest paid, (7) the principal paid, (8) the ending principal balance, (9) the current inflationary adjustment (CIA) and (10) the inflationary adjustment factor (IAF). Input the proper values, or formulas, for each payment period in each column. To the right of each monetary column, input the symbol for the real currency unit (R$), and to the right of the interest rate column input the real interest rate symbol (% R). Then, input the formula at the bottom of each respective column to total the values of (a) the payments, (b) the interest paid, (c) the principal paid and (d) the current inflationary adjustment. If desired, input the symbol “N/A” for not applicable at the bottom of the other columns.

The introduction of real financial instruments into a nominal monetary marketplace requires that we track the cash flows in four monetary phases. Therefore, we must create four schedules (and/or tables) for each instrument, which we can arrange in a row with four adjacent columns. For clarity, we shall label each column by its monetary unit as follows:

Visualizing the Schedules and Tables in Columns
Representing the Different Monetary Phases

| | | | | Column |
|---|---|---|---|---|
| | Column I: | Column II: | Column III: | IV: |
| Monetary Phase: | Master | Real | Nominal | Currency |
| | Real | Currency | Currency | Unit |
| | Currency | Unit | Unit | |
| | Unit | | | |
| Monetary Symbol: | MR$ | R$ | N$ | $ |
| As an Example | 157a | 154a | 155b | 156a |
| See Tables: | | | | |

Nonetheless, as we track the cash flows for each real financial instrument, it is important to realize that one, and only one, schedule in each row can be the dominant schedule in that row. By dominant, we simply mean that this is the origin of the values that will be converted or recast to the other monetary phases on the passive tables in that row. For instance, the actual amortizing will occur in the dominant column, unless the dominant column has received the values from another source; such as another conduit or from the defined marketplace. The exception, of course, are the financial statements, which tally the values of schedules in higher rows, but in the same column or monetary phase. But even then, we may refer to just one financial statement schedule in just one monetary phase as being dominant, due to the fact that the source schedules were largely dominant. All other financial statements in a given row are then considered passive. As one begins to understand this, the following presentation of schedules and tables becomes somewhat easier to follow. In addition, we can also refer to the Real Monetary Software™-System Flow Chart. Please note that (1) each box in the System Flow Chart represents a schedule, table or financial statement, but that (2) the dominate schedule (etc.) in each row is shaded for your convenience. In addition, if any schedule submits or receives data from a defined marketplace schedule, then it has a darker shade, nonetheless, it still represents the dominant schedule in the given row of schedules and tables. As such, if one wishes to audit the activity in a given row of schedules (etc.), then one should review the activity in the dominant schedule first. This is especially true, since any mistakes in this schedule will be transmitted to the passive schedules. This flow chart begins with this Process IX, since it was developed strictly as an aide in tracking the activity by and between the various schedules, tables, monetary phases and even between the conduit and the defined marketplace.

The values, or formulas, required for the creation of this amortization schedule are as follows:

Locating the Values and Inputting the Formulas
for the Real Amortization Schedule

| *Payment | | |
|---|---|---|
| Period(s): | Column Label: | Value Source or Formula: |
| 1 | (Payment Period) | See Table 145, created via |
| | | Box 1840, for the respective |
| | | real financial instrument. |
| 2 to “N” | (Payment Period) | The value for the prior payment |
| | | period, plus one payment period. |
| 1 | Remaining Term | See Table 144, created via |
| | | Box 1830, for the respective |
| | | real financial instrument. |
| 2-“N” | Remaining Term | The value for the remaining term is |
| | | the prior payment period, less one |
| | | payment period. (Conversely, see the |
| | | description for Box 310, if a |
| | | ratcheting mortgage is offered by the |
| | | conduit and elected by the borrower.) |
| 1 | Beginning Principal | See Table 144, created via |
| | Balance | Box 1830, for the respective |
| | | real financial instrument. |
| 2-“N” | Beginning Principal | Copy the value for the ending |
| | Balance | principal balance in the prior payment |
| | | period. |
| 2-“N” | Real Rate | See the interest rate schedule in |
| | | Table 145, created via Box 1850, for |
| | | the respective real financial |
| | | instrument, which should be reflected |
| | | as an annual rate. |
| 1-“N” | Payment | Using any acceptable amortization |
| | | formula, compute the payment for |
| | | each payment period using the |
| | | respective values for (a) the begin |
| | | balance, (b) the remaining term and |
| | | (c) the annual real rate divided by the |
| | | number of payments per year, as |
| | | provided in the material description |
| | | just above. |
| 1-“N” | Interest Paid | Input a formula which subtracts the |
| | | (a) principal paid from (b) the |
| | | payment made in each respective |
| | | payment period, which will equal the |
| | | interest paid. |
| 1-“N” | Principal Paid | Input a formula which subtracts the |
| | | (a) end balance from (b) the begin |
| | | balance in each respective payment |
| | | period, which will equal the principal |
| | | paid. |
| 1-“N” | Ending Principal | Input any acceptable formula for the |
| | Balance | calculation of the present value of an |
| | | annuity using the values for (a) the |
| | | remaining term less one payment |
| | | period, (b) the begin balance and (b) |
| | | the payment made in each respective |
| | | payment period, which will compute |
| | | the end balance. |
| 1-“N” | Current Inflationary | Input a formula that multiples the |
| | Adjustment (CIA) | |
| | | principal paid for each respective |
| | | payment period times the prevailing |
| | | rate of inflation (PRI), then divide |
| | | this product by the number of |
| | | payment periods that are being made |
| | | per year. The PRI can be obtained |
| | | from the interest rate schedule in |
| | | Table 145, created via Box 1850, for |
| | | the respective real financial |
| | | instrument. |
| 1-“N” | Inflationary | The IAF Constant can be obtained |
| | Adjustment | from the inflationary adjustment |
| | Factor (IAF) | index and adjustment factor schedule |
| | Constant | in Table 146a-c, created via Box |
| | | 1840, for the respective real financial |
| | | instrument. The IAF Constant is |
| | | used to convert the potentially |
| | | varying values of the primary assets’ |
| | | real currency (R$) units to the |
| | | conduit's real currency (R$) unit for |
| | | pooling. If the primary asset has |
| | | been created in the same time period |
| | | that the conduit's start-up date |
| | | occurs, then the IAF Constant will be |
| | | 1.000000. Once determined, the IAF |
| | | Constant has a fixed value, since it |
| | | measures the change in the value of |
| | | the fiat currency between the time |
| | | when the primary asset is created and |
| | | the day the conduit is initiated. Since |
| | | this time period is fixed, the IAF |
| | | Constant has a constant value. |

*The symbol “N” equals the total number of payment periods for the given instrument.

Finally, input the formulas for totaling the values in the columns for (a) the payment, (b) the interest paid, (c) principal paid and (d) the current inflationary adjustment (CIA). If desired, enter “N/A” at the bottom of the other columns that are not being totaled.

See Table 154a as an example.
Box 1900: Optional: Test the real currency amortization schedule created via Box 1890 by inputting values and projecting the schedule through a complete term. At the end of the term in the final payment period, the ending principal balance should be zero real currency units (0.00 R$). And, the total of the principal paid column must equal the beginning principal balance in the first payment period. If this does not occur, then find the wrong values, and/or formulaic mistakes, and correct them.

When an amortization schedule is initially established, it is a good idea to perform the test described in the Box above, but it is optional.

See Table 154a as an example.
Box 1910: Inasmuch as the real financial instrument is initially introduced into the nominal (or fiat) monetary marketplace, it is necessary to convert the values in the real amortization schedule to the nominal currency (N$) unit. As such, initiate a nominal currency conversion table for the initial primary asset, which will convert the real currency (R$) values into nominal currency values for actual payment. This can be achieved by duplicating the monetary columns create via Box 1890, but (1) changing the monetary symbol to the right of each monetary column to the nominal currency symbol (N$), (2) then, multiply the respective real currency (R$) value in each column and payment period by the inflationary adjustment factor (IAF) for that payment period. The IAF in the real amortization schedule can be used, or an additional column can be added to this table with the IAF values input as before. Then, input the formula at the bottom of each respective column to total the values of (a) the payment(s), (b) the interest paid, (c) the principal paid and (d) the current inflationary adjustment (CIA). If desired, input the symbol “N/A” for not applicable at the bottom of the other columns.

In this case, the nominal conversion table is passive, meaning that the values represented are taken from the real amortization schedule times the inflationary adjustment factor (IAF) for each payment period. Please note that the total of the principal paid column at the end of the full term is not equal to the beginning principal balance in the first payment period in Table 155a. Actually, there are three possible results. (1) If there is no inflation or deflation, then the total principal paid will equal the beginning principal balance in the first payment period. But, (2) if we incur a net inflationary time period, then the principal paid will exceed the original loan amount; or conversely, (3) if we have net deflation, then the total principal paid will be less then the original loan amount. Inasmuch as the prospect of having zero net inflation, and zero net deflation, is astronomical; it is necessary to recast the values nominal currency conversion table to the currency recasting table in currency ($) units. This creates the need for monetary phase IV.

See Table 155a as an example.
Box 1920: Optional: If desired, a column can be added for the effective nominal rate (ENR) on the nominal conversion table created via Box 1910. The ENR for each respective payment period is (1) the interest paid plus the (2) current inflationary adjustment, times (3) the prevailing rate of inflation; with this product (4) divided by the number of payments per year. In addition, columns can also be added for (a) the payment period by date, and/or (b) the payment number, and (c) the remaining term, if desired.

If desired, add a column to the nominal currency conversion table for the effective nominal rate (ENR). However, this is not recommended, since users will then assume that this schedule is supposed to be an amortization schedule. Then, if they use the ENR to check the amortizing values, the numbers will be incorrect. The nominal currency conversion table is not an amortization schedule, it is a conversion table. The amortization for real financial instruments occurs on the real amortization schedule. The nominal currency conversion table only converts the values from the real currency unit to the nominal currency unit for actual payment, which is why we call this a passive table.
Box 1930: Inasmuch as participants functioning in the nominal monetary paradigm must balance their books in the traditional fiat currency, it will be necessary to recast the values on the nominal currency table from the nominal currency (N$) units to currency ($) units. This can be achieved by duplicating the nominal conversion table, created via Box 1910, and Box 1920 as a option, but eliminating the nominal currency symbol (N$) to the right of each monetary column and replacing it with the currency symbol ($) to the left of each monetary column. Then the proper values and formulas should be input to provide the respective values for each payment period in each column, together with the same columns totaled as before.

The values, or formulas, required for the creation of this amortization schedule are as follows:

Locating the Values and Inputting the Formulas
for the Currency Recasting Table

| *Payment | | |
|---|---|---|
| Period(s): | Column Label: | Value Source or Formula: |
| 1 | (Payment Period) | Copy the initial payment period from |
| | | the nominal currency conversion table. |
| 2 to “N” | (Payment Period) | The value for the prior payment |
| | | period, plus one payment period. |
| 1 | Remaining Term | Copy the value for the initial |
| | | remaining term from the nominal |
| | | currency conversion table. |
| 2-“N” | Remaining Term | The value for the remaining term is |
| | | the prior payment period, less one |
| | | payment period. (Conversely, see the |
| | | description for Box 310, if a |
| | | ratcheting mortgage is offered by the |
| | | conduit and elected by the borrower.) |
| 1 | Beginning Principal | Copy the value for the beginning |
| | Balance | principal balance from the nominal |
| | | currency conversion table. |
| 2-“N” | Beginning Principal | Copy the value for the ending |
| | Balance | principal balance in the prior payment |
| | | period in this table. |
| 1-“N” | Payment | Copy the value for the payment from |
| | | the nominal currency conversion table. |
| 1-“N” | Interest Paid | Input a formula which subtracts the |
| | | (a) principal paid from (b) the |
| | | payment made in each respective |
| | | payment period, which will equal the |
| | | interest paid. |
| 1-“N” | Principal Paid | Copy the value for the principal paid |
| | | in the real amortization schedule for |
| | | each payment period. respectively. |
| 1-“N” | Ending Principal | Subtract the principal paid from the |
| | Balance | payment (all in this table) to calculate |
| | | the ending principal balance. |
| 1-“N” | Current Inflationary | Copy the value for the current |
| | Adjustment (CIA) | inflationary adjustment from the |
| | | nominal currency conversion table. |
| 1-“N” | Inflationary | The IAF can be obtained from the |
| | Adjustment | inflationary adjustment index and |
| | Factor (IAF) | adjustment factor schedule in Table |
| | | 145, created via Box 1840, for the |
| | | respective real financial instrument. |

*The symbol “N” equals the total number of payment periods for the given instrument.

Finally, input the formulas for totaling the values in the columns for (a) the payment, (b) the interest paid, (c) principal paid and (d) the current inflationary adjustment (CIA). If desired, enter “N/A” at the bottom of the other columns that are not being totaled. In addition, the current inflationary adjustment (CIA) is effectively additional interest. If desired, eliminate the CIA column and add this respective amount to the interest paid column for each payment period.

See Table 156a as an example.
Box 1940: Optional: Test the currency recasting table, created via Box 1920 by inputting values and projecting the schedule through a complete term. At the end of the term in the final payment period, the ending principal balance should be zero currency units ($0.00). And, the total of the principal paid column must equal the beginning principal balance in the first payment period. If this does not occur, then find the wrong values, and/or formulaic mistakes, and correct them.

When an amortization schedule is initially established, it is a good idea to perform the test described in the Box above, but it is optional.
Box 1950: Repeat Box 1530 to create a tax reporting schedule for the real financial instrument for the initial primary asset, that will allow the respective parties to determine their respective tax reporting data, assuming they are each tax reporting entities. Except that, the values for this tax reporting schedule should be derived from the real currency amortization schedule created via Box 1890, and the nominal currency conversion table created via Box 1910.

In some countries, such as the United States, the borrower cannot write off the accruing interest on a real financial instrument until it is actually paid. For this reason, the borrower will still need this tax reporting schedule to determine how the Internal Revenue Service will view the overall transaction for tax purposes. While this information may be derived from the real currency amortization schedule and the nominal currency conversion table, it is not obvious to those who are new in dealing with the paradigm shift from nominal to real monetary terms.

See Table 118 (created via Box 1530) and 19a-b as an example.
Box 1960: Initiate a reporting system to the borrower that will include print-outs of the (1) real amortization schedule, created via Box 1890, (2) the nominal currency conversion table, created via Box 1910, (3) the currency recasting table, created via Box 1930. Plot the respective payment streams, and principal balances, etc. from the above schedule and tables in their respective monetary phases (i.e. real currency (R$) units, nominal Currency (N$) units and currency ($) units) on a series of graphs to be included in the reports to the borrower.

For the sake of simplicity, the real financial instruments can be introduced to prospective borrowers with a conceptual stage II presentation, whish would include only the real currency and nominal currency graphs. However, as we proceed from marketing the mortgage, to making actual reports to the borrowers; it will be necessary to make our reports in the three monetary phases, including the real currency, nominal currency and currency units. This will begin their movement from conceptual stage II to conceptual stage III. While some people prefer to look at financial projections, many have found the graphic presentation of such material to be the critical turning point of their understanding of these matters. Given the volume of data being generated, this is certainly understandable. Hence, the graphic presentations of the financial activity of real financial instruments, as we move from one conceptual stage to the next, is essential in promoting the monetary paradigm shift.

See Tables 154a, 155a and 156a.
Box 1970: Plot the cash flow streams and unpaid principal balances, etc. from the tax schedule created via Box 1950 on a fourth graph, or series of graphs, to be presented to the borrower with the graphs created via Box 1960.

Once again, a picture is often easier to understand than streams of numbers on a schedule or table. Interestingly enough, setting forth how the Internal Revenue Service taxes interest income for tax paying entities will demonstrate that our government is frequently taxing the return of our original invested principal. No doubt this will one day lead to tax reform to correct this problem. If done properly, this will lead to the conversion of the tax code from a nominal monetary tax code to a real monetary tax code.

See Table 118, created via Box 1530, as an example.
Box 1980: Plot the cash flow streams and unpaid principal balances, etc. for a traditional, nominal financial instrument, using the original qualification terms for the primary asset. Present the results in the three different monetary phases on the graphs created via Box 1980 and/or Box 1970. Contrast the respective results of the nominal financial instrument versus the primary asset.

Once again, this will assist the borrower in understanding the difference between the traditional nominal financial instrument and the real financial instrument, or primary asset, that he has chosen. By continuously presenting these differences to the borrower, we will help to prepare the borrower for his or her movement to the next conceptual stage.
Box 1990: Repeat Boxes 1890 to 1980 with assumed, historical or actual values for the purpose of generating graphs for marketing presentation, and/or stress test, materials in the three monetary phases (i.e. R$, N$ and $).

Once again, these materials can be used to assist others in moving from conceptual stage II to conceptual stage II, and ultimately prepare them for the later conceptual stages. Keep in mind that one of the primary functions of the invention, Real Monetary Software™, is to create a conceptual bridge so that people can make the paradigm shift from the current nominal monetary marketplace to the coming real monetary marketplace.
Box 2000: Optional: Annotate the graphs created in this Process 1× with notes, definitions and/or disclosures as desired.

Annotate the graphs if desired.
Box 2010: Initiate a subroutine that will allow on-line users to access a series of graphic presentations, depicting the relative performance of nominal financial instruments versus real financial instruments for the given primary asset class in the appropriate monetary phases. The graph plotting systems created via Box 1960 to Box 200 can be used for this purpose. This subroutine should begin with conceptual stage I, move to conceptual stage H and then to conceptual stage III. Expand this subroutine as graphic presentations are developed for the remaining conceptual stages. Include the relevant annotations on the graphs, along with access to a list of the most commonly asked questions and answers pertaining to each new conceptual stage.

Once again, this will help to prepare the participants for the later conceptual stages that will lead to the offering and use of asset-backed real monetary equivalents.
Box 2020: Inasmuch as each individual real financial instrument and conduit can have a different initiation date, or start-up date, then each can also have a different value defined for its real currency unit. As such, it is necessary to convert each such real currency unit, from the different instruments (and later different conduits) into the master real currency (MR$), which has a constant level of purchasing power for all participants and entities functioning within a given monetary system. As such, initiate a master real currency conversion table for the initial primary asset. This can be achieved by copying the real currency amortization schedule created via Box 1890, but then making the following changes: (1) convert the real currency symbols (R$) to master real currency symbols (MR$), (2) replace the values for the inflationary adjustment factors (IAFs) with the primary asset's master inflationary adjustment factor (MIAF), which can be obtained from the MIAF record created for the initial primary asset via Box 1840, and (3) then divide the value for each payment period in each monetary column on the real amortization schedule created via Box 1890 with the primary asset's MIAF to obtain the respective values for the master currency conversion table. If desired, copy the values for (a) the payment period by date, and/or (b) the payment number, and (c) the remaining term from the real currency amortization schedule to the table created hereby.

It is expected that most payment periods will be monthly. This coupled with the fact that most inflation indexes numbers are issued monthly, will mean that all real financial instruments that have an initiation date, and all conduits that have a start-up date, in the same month will probably define the value of their real currency (R$) unit to equal the value of the nominal (or fiat) currency unit as defined by the inflation index for that month, subject to the inflationary lag. However, it is quite common to securitize pools of financial instruments that have been initiated over periods of twelve to eighteen months. In addition, the securities issued by the conduit on the start-up date will have their accrued interest, or accrual rights, stripped on a monthly basis going into the future. Assuming any degree of inflation, or deflation, from month to month means that every instrument, or conduit, that is commenced in a different month will have a different defined value for the real currency unit. If all of this activity was internal to the conduit, we could convert the instrument's real currency units to the conduit's real currency unit. However, the conduit will want to strip off the accrual rights for sale to other conduits, which will be explained in greater detail later. As such, we need a more universal currency unit than just the real currency unit of any given conduit. This creates the need for the monetary system with a set of parameters that will define the value of the master real currency (MR$) unit as being equal to the nominal dollar on the base-line-date of the monetary system. Thereafter, we can issue each and every financial instrument, conduit and accrual right its own master inflationary adjustment factor (MIAF); which will convert the respective real currency unit to the master real currency (MR$) unit with a universal value. This means that the monetary system can be composed of one or more defined marketplaces, each catering to a different asset class, with each marketplace catering to one or more conduits. And, so long as everyone functioning within this system adopts the system's parameters for defining the master real currency and the MIAFs, then value can be transferred back and forth and throughout the system in the MR$ unit. This is why we need the master currency phase for the creation of a marketplace for real financial instruments.

See Tables 145 and 157a as examples to see the inter-relationship between schedules and tables.
Box 2030: Repeat Box 1960 to Box 2010, but for all four monetary phases with the master real currency (MR$) data being generated via the master real currency conversion table created via Box 2020.

The addition of the master real currency phase will allow us to present conceptual stage 1V in a graphic format, which will assist participants in the journey across the conceptual bridge from the use of the fiat currency to the ultimate use of asset-backed real monetary equivalents.
Box 2040: Repeat Box 1890 to Box 2000 and Box 2020 for each additional primary asset purchased by the conduit.

Basically, we need to track the financial activity in each of the four monetary phases on each and every primary asset that the conduit purchases. By repeating the procedures described in the Boxes defined above, we can achieve this goal.

See Tables 154b, 154c, 155b, 155c, 140b, 156c, 157b and 157c as examples.
Box 2050: Now that we have established a procedure for projecting all of the cash flows for each primary asset purchased by the conduit, we must pool this data for the securitization process. While we could total this data in the currency ($) phase, this would be regressive. The whole point in using real financial instruments is to move away from the use of the nominal, or fiat, currency, which is inherently inflationary. At the same time, we cannot total the real currency ($) units, since each real currency amortization schedule could be using a real currency (R$) unit defined by a different purchasing power value. As such, initiate a master real currency pooling table that will total all of the values for each respective primary asset for each respective payment period and monetary column. Essentially, use a master real currency conversion table, but change the formulas for totaling the aforementioned values for each payment period and monetary column. Change any title to reflect that this is a pooling table, and not a conversion table.

In essence, compile the master currency conversion tables for all of the primary assets purchased by the conduit into one pooling table. This table will now show the total activity for the conduit's entire pool of primary assets in the MR$ unit.

See Tables 157a, 157b, 157c and 158 as an example.
Box 2060: Initiate a real currency (R$) pooling schedule for the primary assets by changing the labels and converting the values in the real currency (R$) pooling schedule (created via Box 2060) from R$ units to N$ units. This can be achieved by multiplying the R$ units by the conduit's inflationary adjustment factor (IAF), which will convert the R$ values into N$.

Proceed as described in the Box above.

See Tables 158 and 159 as an example.
Box 2070: Initiate a nominal currency (N$) pooling schedule for the primary assets by changing the labels and converting the values in the real currency (R$) pooling schedule (created via Box 2060) from R$ units to N$ units. This can be achieved by multiplying the R$ units by the conduit's inflationary adjustment factor (IAF), which will convert the R$ values into the N$ unit.

Proceed as described in the Box above.

See Tables 159 and 160 as an example.
Box 2080: Initiate a currency ($) pooling schedule for the primary assets by changing the labels and recasting the values in the nominal currency (N$) pooling schedule, created via Box 2070, from N$ units to $ units.

To achieve this see the description for Box 1930.

Proceed as described in the Box above.

See Tables 160 and 161 as an example.
Box 2090: On the start-up date of the initial conduit, there are no secondary assets by definition in the marketplace for the initial conduit to purchase. As such, (1) no schedules or tables are required for the secondary assets, and (2) the schedules and tables for the primary assets are effectively the same as the schedules and tables for the qualified asset pool.
   SPECIAL NOTE—for the initial conduit of the defined marketplace only: Some types of conduits, such as a Financial Asset Securitization Investment Trusts (FASITs) in the United States, are allowed to purchase additional assets after the start-up date. If the initial conduit is permitted to purchase secondary assets in the marketplace after the start-up date, and desires to do so, then elect to accelerate the development of the defined marketplace by inserting Boxes 3400 to 3500 here, and accelerate the development of the initial conduit by inserting Boxes 3580 to 3740 here. This will create the schedules and tables required for both the secondary assets, and the qualified assets (i.e. the total of the primary and secondary assets.)

Proceed as described in the Box above.
Box 2100: Optional: Regardless of one's election with respect to Box 2090, we have now totaled all of the assets being purchased by the Conduit, which we will henceforth refer to as the qualified asset pool. The whole being the sum of the parts, the pooling schedule for the qualified asset pool is effectively the amortization schedule for the qualified asset pool. The cash flows for both the individual primary assets, and secondary assets if any, are now being tracked in four monetary phases. While it is necessary to have access to this information to present the total activity to the participants, it is not necessary to store (1) any test projections that go to term or (2) any monetary phase with the exception of the real currency phase; since we can regenerate all of these schedules and/or tables from the real currency schedules. What we do save are the labels, source of values and the formulas for the other monetary phases. And most specifically, what we should save, is a history of (a) the billing, (b) the collections and (c) the late payments and/or default activities, for each asset for each payment period as it occurs.

Proceed as described in the Box above.
Box 2110: Optional: Input any notes, definitions and/or disclosures that may be desired on the screens, charts and/or graphs created as a result of this Process IX.

Proceed as described in the Box above.

See Tables 154a to 160 as examples.

Process X: Stripping the Accrued Interest from the Qualified Asset Pool
Box 2120: In order to bring full liquidity to the marketplace for any asset class of real financial instruments, it is necessary to develop a mechanism for providing liquidity for the accruing interest that is inherent in any and all real financial instruments during inflationary periods, unless the rate of principal amortization exceeds the rate of accrual in nominal terms. We must begin this process by determining just how much interest is accruing in nominal terms on the qualified asset pool for each respective payment period. As such initiate a nominal currency conversion table for the qualified asset pool, that is net of (or without) accruing interest. This can be achieved by inputting the proper labels and values. The value for each respective monetary column in each respective payment period is exactly equal to the respective value in the real currency pooling schedule, except that we convert the monetary symbol from R$ to N$. We know that this is correct, because we have defined the real currency unit to equal the nominal currency unit on the start-up day of the conduit. Hence, any increase in the numerical value above the values in the real currency pooling schedule have to be the result of accruing interest in nominal terms. This is confirmed by the fact that the real currency amortization schedule will be the same as the nominal conversion table, if there is no inflation (or deflation); since the inflationary adjustment factor would then be equal to one for the entire term. One times the real currency amortization schedule equals the nominal currency conversion table with the same numerical values.

Another way of proving that this is correct is to create a number of projections for a real financial instruments with only one variable, which is to increase the prevailing rate of inflation from zero in the first projection to successively higher levels of inflation. Then plot the outstanding principal balances for these projections in both the real currency unit and the nominal currency unit. If this is done properly, then one will see that the graph of the outstanding principal balance of the real financial instrument in the real currency unit never changes, while the graphs of the outstanding principal balance in the nominal currency unit will show an increasing level of negative amortization as the assumed rate of inflation increases. This difference between the outstanding principal balance in the real currency unit, versus the outstanding principal balance in the nominal unit, has to be the accruing interest.

See Table 162 as an example
Box 2130: Recast the nominal currency (N$) conversion table for the qualified asset pool net of the accruing interest, via Box 2120, to a currency ($) recasting table for the qualified asset pool net of the accruing interest. This can be achieved by following the same procedure for the prior recasting table (see Box 1930), but with the proper title change.

See the description for Box 1930.

See Table 163 as an example
Box 2140: Convert the nominal currency (N$) conversion table for the qualified asset pool net of accruing interest, created via Box 2120, to a real currency (R$) conversion table for the qualified asset pool net of accruing interest. This can be achieved by dividing each respective value in the nominal currency conversion table (above) by the conduit's inflationary adjustment factor (IAF) for the respective payment period.

Proceed as described in the Box above.

See Table 164 as an example.
Box 2150: Convert the “Real Currency (R$) Conversion Table for the Qualified Asset Pool Net of Accruing Interest,” in Table 164, created via Box 2140, to a “Master Real Currency (MR$) Conversion Table for the Qualified Assets Net of Accruing Interest,” see Table 165. This can be achieved by dividing each respective monetary value in Table 164 by the conduit's master inflationary adjustment factor (MIAF) (see Table 145). Then multiply the prevailing rate of inflation (see Table 145) times the principal paid to achieve the current inflationary adjustment (CIA) for each payment period.

Proceed as described in the Box above.

See Table 165 as an example.
Box 2160: Initiate a record to establish the “Nominal Currency (N$) Table for the Accrued Interest of the Qualified Asset Pool.” In addition to inputting the normal monetary columns for the accruing and repayment of the accrued interest and the CIA, add additional columns for (1) the total accrued interest, (2) the percentage sold and (3) the accrued interest sold.

The establishment, of the monetary columns for the accruing and repayment of the accrued interest, can be achieved by subtracting the respective values in the monetary columns in the “Nominal Currency (N$) Conversion Table Net of Accruing Interest,” (see Table 162, created via Box 2120), from the values in the “Nominal Currency (N$) Pooling Schedule for the Primary Assets (see Table 160, created via Box 2070) assuming there are no secondary assets, or from the “Nominal Currency (N$) Pooling Schedule for the Qualified Asset Pool, (see Table 350 created via Box 3720) if there are secondary assets. This will depend upon the election made in Box 2090. And, input a column and calculate the current inflationary adjustment (CIA), which is the prevailing rate of inflation (see Table 145, created via Box 1840) times the principal paid in each payment period.

Then input a column for the “total accrued interest,” which can be determined as follows:

| | | |
|---|---|---|
| Assuming: | TIA^{N} = | Total Interest Accrued for payment period “N” |
| | BPB^{N+1} = | Beginning Principal Balance for the subsequent |
| | | payment period after payment period “N” |
| | EPB^{N} = | Ending Principal Balance for payment period “N” |
| Then: | TIA^{N} = | BPB^{N+1} − EPB^{N} |

Then input a column for the “percent (of accrued interest) sold.” The values for this column can be calculated as follows:

| | |
|---|---|
| Assuming: | |
| PAIS^{N} = | Percentage of Accrued Interest Sold for payment |
| | period “N” |
| PP^{N} = | Principal Paid in time period “N” from either: |
| | (a) the Real Currency (R$) Pooling Schedule |
| | for the Primary Assets (see Table 159), or |
| | (b) the Real Currency (R$) Pooling Schedule for |
| | the Qualified Asset Pool (see Table 349, |
| | created via Box 3710); depending upon the |
| | election made pursuant to Box 2090. |
| PPAI^{N} = | Principal Paid in payment period “N” from the “Real |
| | Currency (R$) Conversion Table for the Accrued |
| | Interest of the Qualified Asset Pool” (see Table 168). |
| Then: | |
| PAIS^{N} = | $\frac{{PP}^{N} - {PPAI}^{N}}{{PP}^{N}} \times 100$ |

Finally, input a column for the “accrued interest sold.” The values for this column can be determined as follows:

| | | |
|---|---|---|
| Assuming: | AIS^{N} = | Accrued Interest Sold for payment period “N” |
| | TIA^{N} = | Total Interest Accrued for payment period “N” |
| | PAIS^{N} = | Percentage of Accrued Interest Sold for payment |
| | | period “N” |
| Then: | AIS^{N} = | TIA^{N} × PAIS^{N} |

One of the primary goals of the invention is to create a liquid market for the accruing interest. To achieve this goal, we must go through a number of steps, which begin by determining the total amount of accruing interest, as well as the interest accrued on the accruing interest, and finally how the total accruing interest is amortized over the term of the real financial instrument. With this information, and information calculated in earlier tables; we can determine the amount of accrued interest that is sold each payment period.

Creating a market for the accrued interest is a relatively complicated task. The problem is caused by the fact that the accrued interest, that is stripped from a security for each payment period, can then earn accrued interest itself in the following payment periods. Assuming the instrument has a 360 month term, such as a mortgage, then the total number of strippings for each initial issued security can reach 5.87×10¹⁰⁷, assuming some degree of inflation throughout the term. To understand how large this number is, it has been estimated that “the number of electrons, protons and neutrons in the universe (is) 10⁷⁹.” (This estimate is from page 135 of the book entitled: Keys To Infinity, written by Clifford A. Pickover and published by John Wiley & Sons, Inc.)

This invention resolves this problem by creating a mechanism (1) to strip the accrued interest from the originally issued real securities and then (2) offering this accrued interest for sale, as Accrual Rights via the defined marketplace, to other conduits. However, the accruing interest on the Accrual Rights is not subsequently stripped, which avoids the stripping problem referred to in the paragraph above. The additional calculations that we have performed in this table with respect to the total accruing interest, and the accruing interest sold, for each payment period, allows us to calculate precisely how much accruing interest is sold via Accrual Rights in each payment period. We will need to know this information as we proceed in later steps to determine the proper distributions to the various investors of the conduit.

In essence, a wholesale marketplace is developed, whereby only conduits are the participants, including both the buyers and sellers of the Accrual Rights. By selling the accruing interest, via stripped Accrual rights, only to other conduits, the interest that is accrued in subsequent payment periods by the selling conduit can flow through the purchasing conduit to the issued securities holders of the purchasing conduit.

As a result, the originally issued (real) securities are stripped once in each time period, except for the final payment period, or only 359 times over a 360 month term. However, this means that the Accrual Rights accrue interest during inflationary time periods, but need not be stripped; since the accruing interest is flowing through the purchasing conduit to its securities holders. And, some of these securities holders are conduits themselves, which have purchased the Accrual Rights from this conduit; as this process continues on and on.

This creates a very powerful marketplace that can resolve the problems associated with the accruing interest over time. As this marketplace matures, it will reduce the interest rate charges to the borrowers, since (1) it will attract more investors, that were otherwise deterred by the liquidity and taxation problems associated with the accrued interest, and (2) and will minimize the discounting of the accrued interest upon the resale of the issued securities in the after-market. It should also help to create “increasing returns,” similar to Microsoft's earnings on Windows, since the aforementioned benefits will make it very difficult for other marketplaces to compete with a marketplace that use the invention, or Real Monetary Software™, being described herein.

See Table 166 as an example.
Box 2170: Initiate a record to establish the “Currency ($) Recasting Table for the Accrued Interest of the Qualified Asset Pool.”

This is a very unique table, since it must be determined backwards. What we receive on this table are numerical values for the payment column and the interest paid column. In essence, this table is recording the interest that has been forfeited by the sale of the accrued interest by the originally issued securities holders. Normally, we would either compute values by the amortization process, or convert or transfer values from other schedules that are developed prior in the apparent sequence of events. However, the schedule being developed hereby is different, since attempting the normal approach of converting, or transferring values from prior schedules, will create a “loop’ for reasons that are not necessary to explain herein.

Therefore, to establish the values in this schedule (i.e. Table 167), we will take the respective values for each monetary column and each payment period from the “Currency ($) Pooling Schedule of the Qualified Assets” (see Table 172), and then subtract the respective numerical values from the “$ Recasting Table for the Qualified Asset Pool Net of the Accrued Interest” (see Table 163). This is backwards, since we would normally add the numerical values in Table 163 to the values in Table 167 to get the values in Table 172, but the loop prevents us from doing this. Fortunately, we can derive the numerical values for Table 172 from still other tables and/or schedules, as will be explained below, and we have already developed the respective values in Table 163. Therefore, we can create the table shown in Table 167 as described herein.

See Table 167 as an example.
Box 2180: Initiate a record to establish the “Real Currency (R$) Conversion Table for the Accrued Interest of the Qualified Asset Pool.”

This can be achieved by dividing the respective values for the monetary columns in the “Nominal Currency (N$) Conversion Table for the Accrued Interest of the Asset Pool,” (see Table 166) by the conduit's IAF for each respective payment period. If desired, add a column for the IAF, which can be obtained from Table 145 for each respective payment period. This shows us the amortization of the total accrued interest in the real currency (R$) unit.

See Table 168 as an example.
Box 2190: Initiate a record to establish the “Master Real Currency (MR$) Conversion Table for the Accrued Interest of the Qualified Asset Pool.”

This can be achieved by dividing the respective values for the monetary columns in the “Real Currency (R$) Conversion Table for the Accrued Interest of the Asset Pool,” (see Table 168) by the conduit's MIAF. If desired, add a column for the MIAF, which can be obtained from Table 145. This shows us the amortization of the total accrued interest in the master real currency (MR$) unit.

See Table 169 as an example.
Box 2200: Initiate a record to establish the “Real Currency (R$) Pooling Schedule for the Qualified Asset Pool.”

This can be achieved by adding the respective values from the “Real Currency (R$) Conversion Table for the Qualified Asset Pool Net of the Accrued Interest” (see Table 164) to the “Real Currency (R$) Conversion Table for the Accrued Interest of the Qualified Asset Pool” (see Table 168).

See Table 170 as an example.
Box 2210: Initiate a record to establish the “Nominal Currency (N$) Pooling Schedule for the Qualified Asset Pool.”

This can be achieved by adding the respective values from the “Nominal Currency (N$) Conversion Table for the Qualified Asset Pool Net of the Accrued Interest” (see Table 162) to the “Nominal Currency (N$) Conversion Table for the Accrued Interest of the Qualified Asset Pool” (see Table 166).

See Table 171 as an example.
Box 2220: Initiate a record to establish the “Currency ($) Pooling Schedule for the Qualified Asset Pool.”

Due to the looping problem described in Box 2170, the values for this table will not be generated from the values in Table 163 and 167. But rather, the (1) beginning principal balance for the first payment period, (2) the payments for all the payment periods and (3) the CIA for all the payment periods; are all taken from the respective numerical values in the “Nominal Currency (N$) Pooling Schedule for the Qualified Asset Pool” (see Table 171). The (4) principal paid is taken from the respective numerical values in the “Real Currency (R$) Pooling Schedule for the Qualified Asset Pool” (see Table 170). The (5) interest paid is then simply the payment amount less the principal paid for each payment period, and the (6) ending principal balance is the beginning principal balance less the principal paid. Finally, the (7) beginning principal balance in the second and subsequent payment periods is the ending principal balance from the prior payment period.

This takes us to the end of Process X, which has stripped the accrued interest from the qualified asset pool. This will prepare the way for stripping the Accrual Rights at a later stage. In addition, we can compare the numerical totals for the pooling schedules in Process X to the respective numerical totals in the pooling schedules for Process IX, and determine if we have made any errors; since the respective totals should be identical. Assuming these totals are identical, we can now proceed to the later Processes.

See Table 172 as an example.
Box 2230: Initiate a record to establish the “Master Real Currency (MR$) Pooling Schedule for the Qualified Asset Pool.”

This can be achieved by adding the respective values from the “Master Real Currency (MR$) Conversion Table for the Qualified Asset Pool Net of the Accrued Interest” (see Table 165) to the “Master Real Currency (MR$) Conversion Table for the Accrued Interest of the Qualified Asset Pool” (see Table 169).

See Table 173 as an example.

Process XI: Amortizing the Issued Securities Classes without Stripping the Accruing Interest.
Box 2240: Initiate the record to establish the “Real Asset-Backed Securities (RABS) Class “A” Real Currency (R$) Amortization Schedule.”

So far, we have established the appropriate schedules and tables for the individual assets purchased by the conduit, and we have pooled the financial results for the entire qualified asset pool. We have also established the schedules and tables for the qualified asset pool with the accrued interest, and with the accrued interest stripped. Earlier we also priced and structured the securities offering of the conduit. Now we can begin to develop the schedules and tables we need to track the cash flows for the various classes of securities issued on the conduit's start-up day.

Typically, structured financing is used for most conduits. This simply means that classes are established such that one class, typically the Class “A” securities has a priority of payment over all other classes. This lowers the risk for this class, which allows the conduit sponsor to obtain a higher institutional-quality credit rating; thereby lowering the rate of return that must be offered on the Class “A” securities. Additional classes can then be added in order, with each subsequent class (such as Class “B”) being subordinate in the order of payment to the prior class, but having a priority of payment over the alter classes. Finally, there is typically a residual class of securities, that receives any residual cash flow after all of the other classes have received their payments by priority. While there can be many regular classes of securities, such as Class “A” and Class “B,” there can only be one residual, or owner's, class of securities.

At other times, there may be only one class of securities issued, or the securities classes may be traunched such that 100% of the Class “A” securities is paid in full, then 100% of the Class “B” securities and so on. Whatever the nature of the structure of the securities offering, the Class “A”, Class “B,” (etc.) and Class “R” securities can be used, or certain classes can be omitted to modify the invention for the needs of the particular issuer. In fact, the issuer need not be a tax conduit. For instance, it could be a Fortune 500 company or a government. The word “conduit” is used loosely herein to represent the issuer of the securities. Nonetheless, it is assumed that the Class “A” schedules represents either the only class of securities being offered, or the one with the highest order payment priority. Obviously, there must be at least one class of securities, or there is no securitization of the qualified asset pool. And, if there is no securitization of the qualified asset pool, then it will not be possible to create a liquid market for either the specific asset class backing, nor the accruing interest of, the real financial instrument.

We begin the development of the record for the Real Asset-Backed Securities (RABS) Class “A” Amortization Schedule by inputting the appropriate title, subtitles, interest rate and monetary columns. If desired, a column may also be added for the inflationary adjustment factor of the Class “A” securities. Assuming that the securities are issued in the same day, week or month as the start up date of the conduit, then the IAF for the securities will be the same as the IAF for the conduit; since the inflation index numbers are only issued monthly. Unless of course, one intends to insert a subroutine that parcels out the inflationary changes in a shorter time period, such as weekly or daily. Generally speaking, this is more effort than it is worth, and most major financial institutions will be satisfied with monthly adjustments.

Input the appropriate title and labels; then, the values in this schedule, as represented in Table 174 as an example, can be determined as follows: the (1) remaining term for the first payment period is the term in years multiplied by the number of payments per year, which data can be obtained from Table 147, created via Box 1860; the (2) the remaining term is then reduced by one for each subsequent payment period; the (3) beginning principal balance for the first payment period is copied from Table 147, created via Box 1860; (4) the beginning principal balance for subsequent payment periods is copied from the ending principal balance for the prior payment period; the (5) the amortizing (real) rate for each payment period is copied from the interest rate table in Table 145, created via Box 1850; the (6) the payment per period is used by accessing the remaining term, the beginning principal balance and the amortizing (real) rate of interest for each payment period, and then computing the payment by using any acceptable amortization formula, (7) The interest paid for each payment period is the amortizing (real) interest rate, divided by the number of payments per year, times the beginning principal balance for each respective payment period; (8) the principal paid is the payment less the interest paid for each respective payment period; and the ending principal balance is the beginning principal balance less the principal paid for each payment period. The current inflationary adjustment is the prevailing rate of inflation, divided by the number of payments per year, times the principal paid in each respective payment period. If desired, the inflationary adjustment factor (IAF) can be input in another column by payment period. Both the prevailing rate of inflation and the IAF can be copied from Table 145, created via Box 1840. Total the columns for the payment, the interest paid, the principal paid and the CIA. The total for the principal paid column should equal the beginning balance in the first payment period, and the ending principal balance for the final payment period should equal zero. If these sums are not obtained, find your mistake(s) and correct them.

See Table 174 as an example.
Box 2250: Initiate the record to establish the “Real Asset-Backed Securities (RABS) Class “A” Nominal Currency (N$) Conversion Table.”

As an example, input the appropriate title, labels and monetary phase symbols. Then, (1) convert the real currency (R$) values in Table 174, created via Box 2240, to nominal currency (N$) units by multiplying these values with the Class “A” securities inflationary adjustment factor (IAF) for each respective payment period. The (2) current inflationary adjustment (CIA) can be determined by multiplying the prevailing rate of inflation (PRI), divided by the number of payment periods per year, times the principal paid in the current payment period. The (3) IAF, and the PRI, can be found in Table 145, created via Box 1850 and 1840 respectively. And (4) the payment periods per year can be obtained from Table 147, created via Box 1860. If desired, (5) add a column for the IAF. Total the columns for the payment, the interest paid, the principal paid and the CIA. The total for the principal paid column will not equal the beginning balance in the first payment period, if any inflation or deflation has occurred over the term of the instrument. However, the ending principal balance for the final payment period should equal zero. If these results are not obtained, find your mistake(s) and correct them. The only way to know if the principal paid column is correct on this N$ table, will be achieving the correct values for the $ recasting table created via Box 2260.

See Table 175 as an example.
Box 2260: Initiate the record to establish the “Real Asset-Backed Securities (RABS) Class “A” Currency ($) Recasting Table.”

As an example, input the appropriate title, labels and monetary phase symbols. Then, the (1) remaining term is the term in years times the number of payment periods per year, which can be obtained from Table 147, created via Box 1860; the (2) beginning principal balance for the first payment period can be copied from the respective position in Table 175, created via Box 2250; the (3) the beginning principal balance in subsequent payment periods is equal to the ending principal balance in the prior payment period; the (4) payment for each period can be copied from the respective position in Table 175, created via Box 2250; the (5) principal paid for each respective payment period can be copied from Table 174, created via Box 2240; the (6) interest paid is the payment less the principal paid for each respective payment period, the (7) ending principal balance is the beginning principal balance less the principal paid for each respective payment period. And the current inflationary adjustment (CIA) for each payment period can also be copied from Table 175, created via Box 2250. Total the columns for the payment, the interest paid, the principal paid and the CIA. The total for the principal paid column should equal the beginning balance in the first payment period, and the ending principal balance for the final payment period should equal zero. If these sums are not obtained, find your mistake(s) and correct them.

See Table 176 as an example.
Box 2270: Initiate the record to establish the “Real Asset-Backed Securities (RABS) Class “A” Master Real Currency (MR$) Conversion Table.”

As an example, input the appropriate title, labels and monetary phase symbols. Then, (1) multiply the numerical values in the amortization schedule in Table 174 by the Class “A” securities master inflationary adjustment factor (MIAF). Then (2) multiply the prevailing rate of inflation (PRI), divided by the number of payment periods per year, times the principal paid to obtain the current inflationary adjustment for each respective payment period. The (3) MIAF, and the PRI, can be found in Table 145, created via Box 1850 and 1840 respectively. And (4) the payment periods per year can be obtained from Table 147, created via Box 1860. If desired, (5) add a column for the MIAF. Then total the payment, interest paid, principal paid and CIA columns. The total for the principal paid column should equal the beginning balance in the first payment period, and the ending principal balance for the final payment period should equal zero. If these sums are not obtained, find your mistake(s) and correct them.

See Table 177 as an example.
Box 2280: Initiate the record to establish the “Real Asset-Backed Securities (RABS) Class “B,” (etc.) Real Currency (R$) Amortization Schedule.”

Repeat Box 2240, but use the input values for Class “B” securities, and for each additional class of real securities issued by the conduit on the start-up day, or subsequent issuance days in the case of a FASIT. These input values can be obtained from Tables 145 and 147, created respectively by Boxes 1840 & 1850 and 1860. However, this will not include any stripped Accrual Rights, representing the accruing interest; which will be handled later.

See Table 178 as an example.
Box 2290: Initiate the record to establish the “Real Asset-Backed Securities (RABS) Class “B,” (etc.) Nominal Currency (N$) Conversion Table.”

Repeat Box 2250 for Class “B” securities, and for each additional class of real securities issued by the conduit on the start-up day, or subsequent issuance days in the case of a FASIT. However, this does not include any stripped Accrual Rights, which will be handled later.

See Table 179 as an example.
Box 2300: Initiate the record to establish the “Real Asset-Backed Securities (RABS) Class “B,” (etc.) Currency ($) Recasting Table.”

Repeat Box 2260 for Class “B” securities, and for each additional class of real securities issued by the conduit on the start-up day, or subsequent issuance days in the case of a FASIT. However, this does not include any stripped Accrual Rights, which will be handled later.

See Table 180 as an example.
Box 2310: Initiate the record to establish the “Real Asset-Backed Securities (RABS) Class “B,” (etc.) Master Real Currency (MR$) Conversion Table.”

Repeat Box 2270 for Class “B” securities, and for each additional class of real securities issued by the conduit on the start-up day, or subsequent issuance days in the case of a FASIT. However, this does not include any stripped Accrual Rights, which will be handled later.

See Table 181 as an example.
Box 2320: Initiate the record to establish the “Nominal Rate, Class “X” Issued Securities Schedule Currency ($) Amortization Schedule.”

Typically, the conduit sponsor will want to recoup his expenses in the formation and marketing of asset, conduit and issued securities. However, if the assets are purchased at par, and the securities are sold at par; then the conduit sponsor will have to issue a class of nominal rate securities in order to recoup his or her expenses. This is likely to happen in the issuance of real financial instruments in a nominal monetary marketplace, since there must be a one-to-one relationship between these respective par values if there is to be a direct flowing through of the inflationary adjustments from the assets to the issued securities. While the sponsor may be able to lock-out an interest-only (IO) strip, it will not have the benefit of being adjusted for inflation or deflation over time. As such, there may be a need for a nominal rate class of issued securities, which will probably be unrated and will pay a junk bond return for the associated risk.

As an example, input the appropriate title and labels; then, the (1) remaining term for the first payment period is the term in years multiplied by the number of payments per year, which data can be obtained from Table 147, created via Box 1860; the (2) beginning principal balance for the first payment period for the nominal rate Class “X” securities can be copied from Table 147, created via Box 1860; the (3) beginning principal balance for the subsequent payment periods is equal to the value of the ending principal balance for the prior payment period; the (4) nominal rate by payment period can be obtained from Table 145, created via Box 1850; the (5) payment per period can be computed using the respective remaining term, the beginning principal balance and the nominal rate and any generally acceptable amortization formula; the (6) the interest paid equals the nominal rate, divided by the number of payment periods per year, times the beginning principal balance for each payment period; the (7) the principal paid equals the payment less the interest paid for each respective payment period; and the (8) ending principal balance equals the beginning principal balance less the principal paid for each respective payment period. Total the columns for the payment, the interest paid and the principal paid. The total for the principal paid column should equal the beginning balance in the first payment period, and the ending principal balance for the final payment period should equal zero. If these sums are not obtained, find your mistake(s) and correct them.

See Table 182 as an example.
Box 2330: Omit any record for the nominal rate Class “X” securities in the nominal currency (N$), since the respective values are identical to the schedule created via Box 2340.

Follow the directions in the Box description above.
Box 2340: Initiate the record to establish the “Nominal Rate, Class “X” Issued Securities Schedule Real Currency (R$) Amortization Schedule.”

As an example, input the appropriate title, labels and monetary phase symbols. Then, (1) convert the respective currency ($) values in Table 182, created via Box 2320, to real currency (R$) values by multiplying each respective currency ($) value by the inflationary adjustment factor (IAF) for the nominal rate Class “X” securities by payment period. If desired, add a column for the IAF, which can be obtained from Table 145, created via Box 1840. Total the columns for the payment, the interest paid and the principal paid. The total for the principal paid column should equal the beginning balance in the first payment period, and the ending principal balance for the final payment period should equal zero. If these sums are not obtained, find your mistake(s) and correct them.

See Table 183 as an example.
Box 2350: Initiate the record to establish the “Nominal Rate, Class “X” Issued Securities Schedule Master Real Currency (MR$) Amortization Schedule.”

As an example, input the appropriate title, labels and monetary phase symbols. Then, (1) convert the respective real currency (R$) values in Table 183, created via Box 2340, to master real currency (MR$) values by multiplying each respective real currency (R$) value by the master inflationary adjustment factor (MIAF) for the nominal rate Class “X” securities. If desired, add a column for the MIAF, which can be obtained from Table 145, created via Box 1840. Total the columns for the payment, the interest paid and the principal paid. The total for the principal paid column should equal the beginning balance in the first payment period, and the ending principal balance for the final payment period should equal zero. If these sums are not obtained, find your mistake(s) and correct them.

See Table 184 as an example.
Box 2360: Initiate the record to establish the “Real Currency (R$) Pooling Schedule for the Issued Securities.”

As an example, input the appropriate title, labels and monetary phase symbols. Then, (1) add the respective values for each monetary column and payment period in Table 174, Table(s) 178 (etc.), if any, and Table 183, if any; then (2) multiply the prevailing rate of inflation (PRI), divided by the number of payments per year, times the principal paid for each payment period; and (3) total the payments, interest paid, principal paid and current inflationary adjustment (CIA) columns. The PRI can be obtained from Table 145, created via Box 1840. The numerical values received for this table should be identical to Table 170, created via Box 2200. If this is not the case, then find your mistakes and correct them.

See Table 185 as an example.
Box 2370: Optional: Initiate a new record to replace the record created via Box 2360 for the “Real Currency (R$) Pooling Schedule for the Issued Securities,” which computes this schedule by converting the “Master Real Currency (MR$) Pooling Schedule for the Issued Securities,” to the subject schedule defined in the real currency (R$) unit.

In the event that the conduit is a FASIT, or other legal entity, that is permitted to issue securities over time, instead of 100% on the start-up date; then it must be recognized that the securities issued in different months over time, assuming any inflation or deflation, will have a different purchasing power for the real currency (R$) unit. Assuming this is the case, it will not be possible to add the respective real currency (R$) amortization schedules for the real financial instruments issued over time with varying purchasing power for the real currency (R$) unit. As such, to complete the schedule proposed in Box 2360, it will be necessary to convert the pooling schedule created via Box 2400, or Table 188, from the master real currency (MR$) unit to the real currency (R$) unit. This can be achieved by multiplying each MR$ values in Table 168 by the conduit's master inflationary adjustment factor (MIAF) to obtain the equivalent value in the conduit's real currency (R$) unit. Inasmuch as the MR$ units in Table 188 were derived from the R$ units for the various issued securities classes, we should still be able to use the values in Table 185 to compare them against the numerical values in Table 159, or alternatively in Table 349, created via Box 3710, depending upon the election in Box 2090; to ascertain if any mistakes have been made. Inasmuch as there must always be a one-to-one correspondence between the total asset pool and the total issued securities pool, we can use this fact to continuously check our work in each of the monetary phases.
Box 2380: Initiate the record to establish the “Nominal Currency (N$) Pooling Schedule for the Issued Securities.”

As an example, input the appropriate title, labels and monetary phase symbols. Then, (1) add the respective values for each monetary column and payment period in Table 175, Table(s) 179 (etc.), if any, and Table 182, if any; then (2) multiply the prevailing rate of inflation (PRI), divided by the number of payments per year, times the principal paid for each payment period; and (3) total the payments, interest paid, principal paid and current inflationary adjustment (CIA) columns. The PRI can be obtained from Table 145, created via Box 1840. The numerical values received for this table should be identical to Table 171, created via Box 2220. If this is not the case, then find your mistakes and correct them.

See Table 186 as an example.
Box 2390: Initiate the record to establish the “Currency ($) Pooling Schedule for the Issued Securities.”

As an example, input the appropriate title, labels and monetary phase symbols. Then, (1) add the respective values for each monetary column and payment period in Table 176, Table(s) 180 (etc.), if any, and Table 182, if any; then (2) multiply the prevailing rate of inflation (PRI), divided by the number of payments per year, times the principal paid for each payment period; and (3) total the payments, interest paid, principal paid and current inflationary adjustment (CIA) columns. The PRI can be obtained from Table 145, created via Box 1840. The numerical values received for this table should be identical to Table 171, created via Box 2220. If this is not the case, then find your mistakes and correct them.

See Table 187 as an example.
Box 2400: Initiate the record to establish the “Master Real Currency (MR$) Pooling Schedule for the Issued Securities.”

As an example, input the appropriate title, labels and monetary phase symbols. Then, (1) add the respective values for each monetary column and payment period in Table 177, Table(s) 181 (etc.), if any, and Table 184, if any; then (2) multiply the prevailing rate of inflation (PRI), divided by the number of payments per year, times the principal paid for each payment period; and (3) total the payments, interest paid, principal paid and current inflationary adjustment (CIA) columns. The PRI can be obtained from Table 145, created via Box 1840. The numerical values received for this table should be identical to Table 173, created via Box 2200. If this is not the case, then find your mistakes and correct them.

See Table 188 as an example.

Process XII: Financial Statements for the Issued Securities Classes without Stripping the Accruing Interest.
Box 2410: Initiate the record to establish the “Real Currency (R$) RABS Program Cash Flow Statement without Stripping.”

As an example, input the appropriate title, labels and monetary phase symbols. Then establish columns for (1) the time period by month, quarter or year, as desired, (2) each real securities class issued, (3) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 159, created via Box 2060, or Table 349, created via Box 3710, depending upon the election made in Box 2090; for the (B) respective real securities classes can be obtained from Table(s) 174 and 178 (etc.), if any, created via Boxes 2240 and 2280; for the (C) nominal rate securities class(es), if any, from Table 183, created via Box 2340; from the reserve, or insurance, rate obtained from Table 147 (created via Box 1860), multiplied times the outstanding primary asset pool balance from Table 159, created via Box 2060; for the (D) loan servicing by multiplying the loan servicing rate obtained from Table 147 (created via Box 1860) times the outstanding principal balance of the primary asset pool obtained from Table 159, created via Box 2060; for (E) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total for (B), (C), (D) and (E) from the value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 189 as an example.
Box 2420: Initiate the record to establish the “Nominal Currency (N$) RABS Program Cash Flow Statement without Stripping.”

As an example, input the appropriate title, labels and monetary phase symbols. Then establish columns for (1) the time period by month, quarter or year, as desired, (2) each real securities class issued, (3) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 160, created via Box 2070, or Table 350, created via Box 3720, depending upon the election made in Box 2090; for the (B) respective real securities classes can be obtained from Table(s) 175 and 179 (etc.), if any, created via Boxes 2250 and 2290; for the (C) nominal rate securities class(es), if any, from Table 182, created via Box 2320; from the reserve or insurance rate obtained from Table 147 (created via Box 1860), multiplied times the outstanding primary asset pool balance from Table 160, created via Box 2070; for the (D) loan servicing by multiplying the loan servicing rate obtained from Table 147 (created via Box 1860) times the outstanding principal balance of the primary asset pool obtained from Table 160, created via Box 2070; for (E) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total for (B), (C), (D) and (E) from the value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 190 as an example.
Box 2430: Initiate the record to establish the “Currency ($) RABS Program Cash Flow Statement without Stripping.”

As an example, input the appropriate title, labels and monetary phase symbols. Then establish columns for (1) the time period by month, quarter or year, as desired, (2) each real securities class issued, (3) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 161, created via Box 2080, or Table 351, created via Box 3730, depending upon the election made in Box 2090; for the (B) respective real securities classes can be obtained from Table(s) 176 and 180 (etc.), if any, created via Boxes 2260 and 2300; for the (C) nominal rate securities class(es), if any, from Table 182, created via Box 2340; from the reserve or insurance rate obtained from Table 147 (created via Box 1860), multiplied times the outstanding primary asset pool balance from Table 161, created via Box 2080; for the (D) loan servicing by multiplying the loan servicing rate obtained from Table 147 (created via Box 1860) times the outstanding principal balance of the primary asset pool obtained from Table 161, created via Box 2080; for (E) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total for (B), (C), (D) and (E) from the value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 191 as an example.
Box 2440: Initiate the record to establish the “Master Real Currency (MR$) RABS Program Cash Flow Statement without Stripping.”

As an example, input the appropriate title, labels and monetary phase symbols. Then establish columns for (1) the time period by month, quarter or year, as desired, (2) each real securities class issued, (3) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 158, created via Box 2050, or Table 352, created via Box 3740, depending upon the election made in Box 2090; for the (B) respective real securities classes can be obtained from Table(s) 177 and 181 (etc.), if any, created via Boxes 2270 and 2310; for the (C) nominal rate securities class(es), if any, from Table 184, created via Box 2350; from the reserve or insurance rate obtained from Table 147 (created via Box 1860), multiplied times the outstanding primary asset pool balance from Table 158, created via Box 2050; for the (D) loan servicing by multiplying the loan servicing rate obtained from Table 147 (created via Box 1860) times the outstanding principal balance of the primary asset pool obtained from Table 158, created via Box 2050; for (E) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total for (B), (C), (D) and (E) from the value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 192 as an example.
Box 2450: Initiate the record to establish the “Real Currency (R$) RABS Program Income Statement without Stripping.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to nominal rate securities by class, if any, (5) the distributions to any securities reserve or insurance premiums, (6) the distributions for loan servicing and (7) the distributions for any remaining expense categories, either individually or cumulatively. Then establish a column for the (8) residual cash flow to be distributed to the residual, or owner's, securities.

The numerical values: (A) for the qualified asset pool's total income can be obtained from either Table 159, created via Box 2060, or Table 349, created via Box 3710, depending upon the election made in Box 2090; for the (B) interest distributions to the respective real securities classes can be obtained from Table(s) 174 and 178 (etc.), if any, created via Boxes 2240 and 2280; for the (c) interest distributions to the nominal rate securities class(es), if any, from Table 183, created via Box 2340; from the reserve, or insurance, rate obtained from Table 147 (created via Box 1860), multiplied times the outstanding primary asset pool balance from Table 159, created via Box 2060; for the (D) distributions for the loan servicing by multiplying the loan servicing rate obtained from Table 147 (created via Box 1860) times the outstanding principal balance of the primary asset pool obtained from Table 159, created via Box 2060; for (E) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D) and (E) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 193 as an example.
Box 2460: Initiate the record to establish the “Nominal Currency (N$) RABS Program Income Statement without Stripping.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to nominal rate securities by class, if any, (5) the distributions to any securities reserve or insurance premiums, (6) the distributions for loan servicing and (7) the distributions for any remaining expense categories, either individually or cumulatively. Then establish a column for the (8) residual cash flow to be distributed to the residual, or owner's, securities.

The numerical values: (A) for the qualified asset pool's total income can be obtained from either Table 160, created via Box 2070, or Table 350, created via Box 3720, depending upon the election made in Box 2090; for the (B) interest distributions to the respective real securities classes can be obtained from Table(s) 175 and 179 (etc.), if any, created via Boxes 2250 and 2290; for the (c) interest distributions to the nominal rate securities class(es), if any, from Table 182, created via Box 2320; from the reserve, or insurance, rate obtained from Table 147 (created via Box 1860), multiplied times the outstanding primary asset pool balance from Table 160, created via Box 2070; for the (D) distributions for the loan servicing by multiplying the loan servicing rate obtained from Table 147 (created via Box 1860) times the outstanding principal balance of the primary asset pool obtained from Table 160, created via Box 2070; for (E) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D) and (E) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 194 as an example.
Box 2470: Initiate the record to establish the “Currency ($) RABS Program Income Statement without Stripping.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to nominal rate securities by class, if any, (5) the distributions to any securities reserve or insurance premiums, (6) the distributions for loan servicing and (7) the distributions for any remaining expense categories, either individually or cumulatively. Then establish a column for the (8) residual cash flow to be distributed to the residual, or owner's, securities.

The numerical values: (A) for the qualified asset pool's total income can be obtained from either Table 161, created via Box 2080, or Table 351, created via Box 3730, depending upon the election made in Box 2090; for the (B) interest distributions to the respective real securities classes can be obtained from Table(s) 176 and 180 (etc.), if any, created via Boxes 2260 and 2300; for the (c) interest distributions to the nominal rate securities class(es), if any, from Table 182, created via Box 2320; from the reserve or insurance rate obtained from Table 147 (created via Box 1860), multiplied times the outstanding primary asset pool balance from Table 161, created via Box 2080; for the (D) distributions for the loan servicing by multiplying the loan servicing rate obtained from Table 147 (created via Box 1860) times the outstanding principal balance of the primary asset pool obtained from Table 161, created via Box 2080; for (E) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D) and (E) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 195 as an example.
Box 2480: Initiate the record to establish the “Master Real Currency (MR$) RABS Program Income Statement without Stripping.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to nominal rate securities by class, if any, (5) the distributions to any securities reserve or insurance premiums, (6) the distributions for loan servicing and (7) the distributions for any remaining expense categories, either individually or cumulatively. Then establish a column for the (8) residual cash flow to be distributed to the residual, or owner's, securities.

The numerical values: (A) for the qualified asset pool's total income can be obtained from either 158, created via Box 2050, or Table 352, created via Box 3740, depending upon the election made in Box 2090; for the (B) interest distributions to the respective real securities classes can be obtained from Table(s) 177 and 181 (etc.), if any, created via Boxes 2270 and 2310; for the (C) interest distributions to the nominal rate securities class(es), if any, from Table 184, created via Box 2350; from the reserve, or insurance rate, obtained from Table 147 (created via Box 1860), multiplied times the outstanding primary asset pool balance from Table 158, created via Box 2050; for the (D) distributions for the loan servicing by multiplying the loan servicing rate obtained from Table 147 (created via Box 1860) times the outstanding principal balance of the primary asset pool obtained from Table 158, created via Box 2050; for (E) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D) and (E) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 196 as an example.
Box 2490: Initiate the record to establish the “Real Currency (R$) RABS Program Balance Sheet without Stripping.”

As an example, input the appropriate titles, labels and monetary the appropriate title, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the nominal rate Class “X” securities, if any, and (7) the residual, or ownership, securities. Finally, (8) establish a column to total (5), (6) and (7) to ascertain the total liabilities for a given time period. The total assets (4) must equal the total liabilities (8). If this is not the case, then find the errors and correct them.

The numerical values: (A) for the qualified asset pool can be obtained from either Table 159, created via Box 2060, or Table 349, created via Box 3710, depending upon the election made in Box 2090; (B) for the reserve set-asides by adding the total reserves distributed to the Trustee through the current payment period, less any distributions made from the reserve fund, which can be obtained from Table 193, created via Box 2450; (C) for the various securities classes from Table 174 and Table 178, if any, created respectively via Box 2240 and Box 2280; and (D) for the nominal rate Class “X” securities, if any, from Table 183, created via Box 2340, if any. By definition, the value for the residual, or the owner's, class of liabilities is the total assets from (4) above, less the total of (C) and (D). The formulas for the total assets, and total liabilities, are shown in the paragraph above.

See Table 197 as an example.
Box 2500: Initiate the record to establish the “Nominal Currency (N$) RABS Program Balance Sheet without Stripping.”

As an example, input the appropriate titles, labels and monetary the appropriate title, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the nominal rate Class “X” securities, if any, and (7) the residual, or ownership, securities. Finally, (8) establish a column to total (5), (6) and (7) to ascertain the total liabilities for a given time period. The total assets (4) must equal the total liabilities (8). If this is not the case, then find the errors and correct them.

The numerical values: (A) for the qualified asset pool can be obtained from either Table 160, created via Box 2070, or Table 350, created via Box 3720, depending upon the election made in Box 2090; (B) for the reserve set-asides by adding the total reserves distributed to the Trustee through the current payment period, less any distributions made from the reserve fund, which can be obtained from Table 194, created via Box 2460; (C) for the various securities classes from Table 175 and Table 179, if any, created respectively via Box 2250 and Box 2290; and (D) for the nominal rate Class “X” securities, if any, from Table 182, created via Box 2320, if any. By definition, the value for the residual, or the owner's, class of liabilities is the total assets from (4) above, less the total of (C) and (D). The formulas for the total assets, and total liabilities, are shown in the paragraph above.

See Table 198 as an example.
Box 2510: Initiate the record to establish the “Currency ($) RABS Program Balance Sheet without Stripping.”

As an example, input the appropriate titles, labels and monetary the appropriate title, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the nominal rate Class “X” securities, if any, and (7) the residual, or ownership, securities. Finally, (8) establish a column to total (5), (6) and (7) to ascertain the total liabilities for a given time period. The total assets (4) must equal the total liabilities (8). If this is not the case, then find the errors and correct them.

The numerical values: (A) for the qualified asset pool can be obtained from either Table 161, created via Box 2080, or Table 349, created via Box 3710, depending upon the election made in Box 2090; (B) for the reserve set-asides by adding the total reserves distributed to the Trustee through the current payment period, less any distributions made from the reserve fund, which can be obtained from Table 195, created via Box 2470; (C) for the various securities classes from Table 176 and Table 180, if any, created respectively via Box 2260 and Box 2300; and (D) for the nominal rate Class “X” securities, if any, from Table 182, created via Box 2320, if any. By definition, the value for the residual, or the owner's, class of liabilities is the total assets from (4) above, less the total of (C) and (D). The formulas for the total assets, and total liabilities, are shown in the paragraph above.

See Table 199 as an example.
Box 2520: Initiate the record to establish the “Master Real Currency (MR$) RABS Program Balance Sheet without Stripping.”

As an example, input the appropriate titles, labels and monetary the appropriate title, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the nominal rate Class “X” securities, if any, and (7) the residual, or ownership, securities. Finally, (8) establish a column to total (5), (6) and (7) to ascertain the total liabilities for a given time period. The total assets (4) must equal the total liabilities (8). If this is not the case, then find the errors and correct them.

The numerical values: (A) for the qualified asset pool can be obtained from either Table 158, created via Box 2050, or Table 352, created via Box 3740, depending upon the election made in Box 2090; (B) for the reserve set-asides by adding the total reserves distributed to the Trustee through the current payment period, less any distributions made from the reserve fund, which can be obtained from Table 196, created via Box 2480; (C) for the various securities classes from Table 177 and Table 181, if any, created respectively via Box 2270 and Box 2310; and (D) for the nominal rate Class “X” securities, if any, from Table 184, created via Box 2350, if any. By definition, the value for the residual, or the owner's, class of liabilities is the total assets from (4) above, less the total of (C) and (D). The formulas for the total assets, and total liabilities, are shown in the paragraph above.

See Table 200 as an example.
Box 2525: Optional: In the event that the conduit's securities are not issued within the same payment period, resulting in varying purchasing powers for their respective real currency units; then adjustments must be made in Tables 189, 193 and 197, created respectively by Boxes 2410, 2450 and 2490. The purpose of the adjustments will be to standardize the respective real currency (R$) units from the various classes of issued securities, so that they may be totaled in these tables.

This can be achieved by converting the numerical values expressed in the individual real currency (R$) units, for each class of issued securities in Tables 189, 193 and 197, to the master real currency (MR$) unit; and then multiplying this product by the conduit's master inflationary adjustment factor (MIAF). The first part of this formula has already been computed when the tables in Tables 189, 193 and 197 were converted from the real currency (R$) unit to the master real currency unit as shown respectively in Tables 192. 196 and 200, created via Boxes 2440, 2480 and 2520. Hence, the “product” referred to above can be drawn directly from these latter tables, and then multiplied by the conduit's MIAF to achieve the proper values in the conduit's real currency (R$) unit. For clarity, one may wish to make a subroutine that creates a record for each class of issued securities in both (i) the individual classes real currency (R$) unit and (ii) the conduit's real currency (R$) unit.

Process XIII: Amortization Schedules for the Issued Securities Fully Stripped.
Box 2530: Initiate the record to establish the “RABS Class “A” Nominal Currency (N$) Conversion Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the designation for Accrual rights sold, (9) the total accrued interest, (10) the percentage of accruing interest sold and (11) the accrued interest sold.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5) and (6) above, can be copied respectively from Table 174, created via Box 2240. The (C) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. The (D) Accrual Rights being stripped each payment period should be given a designation, or name, so that they can be properly tracked throughout the system. We have used the names “A+1”, “A+2”, “A+3” . . . etc. to name the successive classes of Accrual rights that are stripped for payment period one, two and three . . . etc. respectively, as an example herein.

The (E) interest accrued for the first payment period can be determined by subtracting the (i) ending principal balance for the first payment period, from (ii) the beginning principal balance for the second payment period, with each of these values from Table 174, created via Box 2240. This formula can then be repeated, respectively, to determine the total accruing interest for each additional payment period. The (F) percentage of accrued interest sold for the first payment period is the (iii) ending principal balance for the first payment period in Table 174, created via Box 2240, less (iv) the ending principal balance for the first payment period in Table 211, created via Box 2630; with the resulting value then divided by the (v) ending principal balance for the first payment period in Table 174, created via Box 2240. This formula can then be repeated, respectively, for each additional payment period to determine the changing percentage of accrued interest sold.

(The percentage of accruing interest sold changes, because the accruing interest is only stripped off the originally issued real securities. The Accrual Rights themselves are not stripped, since it is assumed that they are marketed and purchased in a wholesale marketplace where only conduits are bidders. This means that the accruing interest, on the Accrual Rights from the selling conduit; simply flows through the purchasing conduit to its issued securities holders, who have their securities stripped of the accruing interest each payment period. This process develops a powerful marketplace that provides liquidity for the accruing interest, and reduces the total interest charges, since no major discounting is required for the accruing interest upon resale.)

Then, the (G) accruing interest sold for any given payment period is the total accruing interest (E), times the percentage of accruing interest sold (F) for each respective payment period. Finally, (H) input the desired names for the Accrual Rights.

See Table 201 as an example.
Box 2540: Initiate the record to establish the “RABS Class “A” Currency ($) Recasting Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the accrued interest sold and (9) the total taxable interest.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) numerical values for (2), (3), (4), (5), (6), (7) and (8) can all be copied from the respective columns and rows in Table 201, created via Box 2530. Finally, (C) the total taxable income is the sum of the values in columns (4), (7) and (8) above for each respective payment period.

See Table 202 as an example.
Box 2550: Initiate the record to establish the “RABS Class “A” Real Currency (R$) Conversion Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the inflationary adjustment factor (IAF), if desired, (9) the designation for the Accrual Rights classes being stripped and sold by payment period and (10) the accrued interest sold.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values for each row and column for items (2), (3), (4), (5), (6) and (10) above, can be calculated by dividing the respective values in Table 201, created via Box 2530, by the conduit's inflationary adjustment factor (IAF) for each respective payment period. The Class “A” securities' IAF can be obtained from Table 145, created via Box 1850. Then, the (C) CIA can be calculated by multiplying the prevailing rate of inflation, divided by the number of payments per year, times the principal paid for each respective payment period. The PRI can be obtained from Table 145, created via Box 1840; and the number of payments per year can be obtained from Table 147, created via Box 1860. Finally, (D) input the designated names for the Accrual Rights classes.

See Table 203 as an example.
Box 2560: Initiate the record to establish the “RABS Class “A” Master Real Currency (MR$) Conversion Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the master inflationary adjustment factor (MIAF), if desired, (9) the designation for the Accrual Rights classes being stripped and sold by payment period and (10) the accrued interest sold.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values for each row and column for items (2), (3), (4), (5), (6) and (10) above, can be calculated by dividing the respective values in Table 203, created via Box 2530, by the conduit's master inflationary adjustment factor (MIAF). The Class “A” securities' MIAF can be obtained from Table 145, created via Box 1850. Then, the (C) CIA can be calculated by multiplying the prevailing rate of inflation, divided by the number of payments per year, times the principal paid for each respective payment period. The PRI can be obtained from Table 145, created via Box 1840; and the number of payments per year can be obtained from Table 147, created via Box 1860. Finally, (D) input the designated names for the Accrual Rights classes to be sold.

See Table 204 as an example.
Box 2570: Initiate the record to establish the “RABS Class “B” Nominal Currency (N$) Conversion Table Stripped of Accrual Rights,” if any.

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the designation for Accrual Rights sold, (9) the total accrued interest, (10) the percentage of accruing interest sold and (11) the accrued interest sold.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5) and (6) above, can be copied respectively from Table 178, created via Box 2280. (When the accrued interest is stripped from the originally issued securities, then the remainder in the nominal currency (N$) phase will have the same numerical values as the same table in the real currency (R$) phase.) The (C) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. The (D) Accrual Rights being stripped each payment period should be given a designation, or name, so that they can be properly tracked throughout the system. We have used the names “A+1”, “A+2”, “A+3” . . . etc. to name the successive classes of Accrual rights that are stripped for payment period one, two and three . . . etc. respectively, as an example herein.

The (E) interest accrued for the first payment period can be determined by subtracting the (i) ending principal balance for the first payment period, from (ii) the beginning principal balance for the second payment period, with each of these values from Table 179, created via Box 2290. This formula can then be repeated, respectively, to determine the total accruing interest for each additional payment period. The (F) percentage of accrued interest sold for the first payment period is the (iii) ending principal balance for the first payment period in Table 178, created via Box 2280, less (iv) the ending principal balance for the first payment period in Table 215, created via Box 2670; with the resulting value then divided by the (v) ending principal balance for the first payment period in Table 178, created via Box 2280. This formula can then be repeated, respectively, for each additional payment period to determine the changing percentage of accrued interest sold.

(The percentage of accruing interest sold changes, because the accruing interest is only stripped off the originally issued real securities. The Accrual Rights themselves are not stripped, since it is assumed that they are marketed and purchased in a wholesale marketplace where only conduits are bidders. This means that the accruing interest, on the Accrual Rights from the selling conduit; simply flows through the purchasing conduit to its issued securities holders, who have their securities stripped of the accruing interest each payment period. This process develops a powerful marketplace that provides liquidity for the accruing interest, and reduces the total interest charges, since no major discounting is required for the accruing interest upon resale.)

Then, the (G) accruing interest sold for any given payment period is the total accruing interest (E), times the percentage of accruing interest sold (F) for each respective payment period. Finally, (H) input the desired names for the Accrual Rights.

See Table 205 as an example.
Box 2580: Initiate the record to establish the “RABS Class “B” Currency ($) Recasting Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the accrued interest sold and (9) the total taxable interest.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) numerical values for (2), (3), (4), (5), (6), (7) and (8) can all be copied from the respective columns and rows in Table 205, created via Box 2570. Finally, (C) the total taxable income is the sum of the values in columns (4), (7) and (8) above for each respective payment period.

See Table 206 as an example.
Box 2590: Initiate the record to establish the “RABS Class “B” Real Currency (R$) Conversion Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the inflationary adjustment factor (IAF), if desired, (9) the designation for the Accrual Rights classes being stripped and sold by payment period and (10) the accrued interest sold.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values for each row and column for items (2), (3), (4), (5), (6) and (10) above, can be calculated by dividing the respective values in Table 205, created via Box 2570, by the Class “B” securities' inflationary adjustment factor (IAF) for each respective payment period. The conduit's IAF can be obtained from Table 145, created via Box 1840. Then, the (C) CIA can be calculated by multiplying the prevailing rate of inflation, divided by the number of payments per year, times the principal paid for each respective payment period. The PRI can be obtained from Table 145, created via Box 1840; and the number of payments per year can be obtained from Table 147, created via Box 1860. Finally, (D) input the designated names for the Accrual Rights classes.

See Table 207 as an example.
Box 2600: Initiate the record to establish the “RABS Class “B” Master Real Currency (MR$) Conversion Table Stripped of Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the master inflationary adjustment factor (MIAF), if desired, (9) the designation for the Accrual Rights classes being stripped and sold by payment period and (10) the accrued interest sold.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values for each row and column for items (2), (3), (4), (5), (6) and (10) above, can be calculated by dividing the respective values in Table 207, created via Box 2590, by the conduit's master inflationary adjustment factor (OAF). The Class “B”securities' MIAF can be obtained from Table 145, created via Box 1850. Then, the (C) CIA can be calculated by multiplying the prevailing rate of inflation, divided by the number of payments per year, times the principal paid for each respective payment period. The PRI can be obtained from Table 145, created via Box 1840; and the number of payments per year can be obtained from Table 147, created via Box 1860. Finally, (D) input the designated names for the Accrual Rights classes to be sold.

See Table 208 as an example.
Box 2610: Initiate the record to establish the “RABS Nominal Currency (N$) Conversion Table for the Class “A+” Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the designation for Accrual Rights purchased, (9) the accrued interest purchased.

Please note that this table represents a different point of view. For the investor who purchased the original real securities, and then stripped the accrued interest off for sale; the transaction was effectively the sale of an interest-only (10) strip. But for the purchaser of this 10 strip, the cash flows being purchased must be divided between (a) the repayment of the principal paid to purchase the 10 strip along with (b) a stream of interest payments thereon. For the first time now, we are seeing the stripping of the Accrual Rights from the collective perspective of the purchasers of the Accrual Rights.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5) and (6) above, can be obtained by subtracting the respective numerical values from Table 201, created via Box 2530, from the numerical values in Table 175, created via Box 2250. (In essence, we have just subtracted the nominal currency (N$) conversion table for the stripped Class “A” securities from the nominal currency (N$) conversion table for the Class “A” securities, which were not stripped. Simple logic tells us that the remainder must be the composite nominal currency (N$) schedule for the stripped Class “A” Accrual Rights.)

The (C) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. The (D) designation for the Accrual Rights being stripped and purchased should be copied from a prior table for consistency in record keeping.

Then, the (E) accruing interest purchased can be copied from Table 201, created via Box 2530, for each respective payment period. Finally, the (F) numbers projected herein assume that the Accrual rights are sold at par value without any discount or expense. Make the suitable adjustments to account for any discounting or related expenses.

See Table 209 as an example.
Box 2620: Initiate the record to establish the “RABS Currency ($) Recasting Table for the Class “A+” Accrual Rights.”

This table will now show the sale of the Accrual Rights from the perspective of the Class “A” securities investors. In essence they have sold an interest-only (10) strip, which is reflected only in the payment, interest paid and current inflationary adjustment columns.

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the designation for Accrual Rights purchased, (9) the accrued interest purchased.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5), (6) and (7) above, can be obtained by subtracting the respective numerical values from Table 202, created via Box 2540, from the numerical values in Table 176, created via Box 2260. (In essence, we have just subtracted the currency ($) conversion table for the stripped Class “A” securities from the currency ($) conversion table for the Class “A” securities, which were not stripped. Simple logic tells us that the remainder must be the composite currency ($) schedule for the stripped Class “A+” Accrual Rights.)

The (C) designation for the Accrual Rights being stripped and purchased should be copied from a prior table for consistency in record keeping. Then, the (D) accruing interest purchased can be copied from Table 209, created via Box 2610, for each respective payment period. Finally, the (E) numbers projected herein assume that the Accrual rights are sold at par value without any discount or expense. Make the suitable adjustments to account for any discounting or related expenses.

See Table 210 as an example.
Box 2630: Initiate the record to establish the “RABS Real Currency (R$) Conversion Table for the Class “A+” Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) The inflationary adjustment factor (IAF), (9) the designation for Accrual Rights purchased and (10) the accrued interest purchased.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5), (6) and (10) above, can be obtained by dividing the respective numerical values from Table 209, created via Box 2610, by the inflationary adjustment factor for the Class “A” securities. (However, it is important to note that the Accrual Rights, representing the accruing interest, is stripped after each payment period. This means that our numerical values in the first row of this table will always be zero, and that the numerical values in row two will use the IAF for the second payment period. Only this formula will give us the correct purchasing power in the real currency unit as defined for the Class “A” securities.)

The (C) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. The (D) designation for the Accrual Rights being stripped and purchased should be copied from a prior table for consistency in record keeping. Finally, the (E) numbers projected herein assume that the Accrual rights are sold at par value without any discount or expense. Make the suitable adjustments to account for any discounting or related expenses.

See Table 211 as an example.
Box 2640: Initiate the record to establish the “RABS Master Real Currency (MR$) Conversion Table for the Class “A+” Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) The master inflationary adjustment factor (MIAF), (9) the designation for Accrual Rights purchased and (10) the accrued interest purchased.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5), (6), (7) and (10) above, can be obtained by dividing the respective numerical values from Table 211, created via Box 2630, by the master inflationary adjustment factor (MIAF) for the Class “A” securities.

The (C) designation for the Accrual Rights being stripped and purchased should be copied from a prior table for consistency in record keeping. Finally, the (E) numbers projected herein assume that the Accrual rights are sold at par value without any discount or expense. Make the suitable adjustments to account for any discounting or related expenses.

See Table 212 as an example.
Box 2650: Initiate the record to establish the “RABS Nominal Currency (N$) Conversion Table for the Class “B+” Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the designation for Accrual Rights purchased, (9) the accrued interest purchased.

Please note that this table represents a different point of view. For the investor who purchased the original real securities, and then stripped the accrued interest off for sale; the transaction was effectively the sale of an interest-only (IO) strip. But for the purchaser of this IO strip, the cash flows being purchased must be divided between (a) the repayment of the principal paid to purchase the IO strip along with (b) a stream of interest payments thereon. We are seeing the stripping of the Accrual Rights from the collective perspective of the purchasers of the Accrual Rights.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5) and (6) above, can be obtained by subtracting the respective numerical values from Table 205, created via Box 2537, from the numerical values in Table 179, created via Box 2290. (In essence, we have just subtracted the nominal currency (N$) conversion table for the stripped Class “B” securities from the nominal currency (N$) conversion table for the Class “B” securities, which were not stripped. Simple logic tells us that the remainder must be the composite nominal currency (N$) schedule for the stripped Class “B” Accrual Rights.)

The (C) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. The (D) designation for the Accrual Rights being stripped and purchased should be copied from a prior table for consistency in record keeping.

Then, the (E) accruing interest purchased can be copied from Table 205, created via Box 2570, for each respective payment period. Finally, the (F) numbers projected herein assume that the Accrual rights are sold at par value without any discount or expense. Make the suitable adjustments to account for any discounting or related expenses.

See Table 213 as an example.
Box 2660: Initiate the record to establish the “RABS Currency ($) Recasting Table for the Class “B+” Accrual Rights.”

This table will now show the sale of the Accrual Rights from the perspective of the Class “B” securities investors. In essence they have sold an interest-only (10) strip, which is reflected only in the payment, interest paid and current inflationary adjustment columns.

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) the designation for Accrual Rights purchased, (9) the accrued interest purchased.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5), (6) and (7) above, can be obtained by subtracting the respective numerical values from Table 206, created via Box 2580, from the numerical values in Table 180, created via Box 2300. (In essence, we have just subtracted the currency ($) conversion table for the stripped Class “B” securities from the currency ($) conversion table for the Class “B” securities, which were not stripped. Simple logic tells us that the remainder must be the composite currency ($) schedule for the Class “B+” stripped Accrual Rights.)

The (C) designation for the Accrual Rights being stripped and purchased should be copied from a prior table for consistency in record keeping. Then, the (D) accruing interest purchased can be copied from Table 213, created via Box 2650, for each respective payment period. Finally, the (E) numbers projected herein assume that the Accrual rights are sold at par value without any discount or expense. Make the suitable adjustments to account for any discounting or related expenses.

See Table 214 as an example.
Box 2670: Initiate the record to establish the “RABS Real Currency (R$) Conversion Table for the Class “B+” Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) The inflationary adjustment factor (IAF), (9) the designation for Accrual Rights purchased and (10) the accrued interest purchased.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5), (6) and (10) above, can be obtained by dividing the respective numerical values from Table 213, created via Box 2650, by the inflationary adjustment factor for the Class “B” securities. (However, it is important to note that the Accrual Rights, representing the accruing interest, is stripped after each payment period. This means that our numerical values in the first row of this table will always be zero, and that the numerical values in row two will use the IAF for the second payment period. Only this formula will give us the correct purchasing power in the real currency unit as defined for the Class “A” securities.)

The (C) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. The (D) designation for the Accrual Rights being stripped and purchased should be copied from a prior table for consistency in record keeping. Finally, the (E) numbers projected herein assume that the Accrual rights are sold at par value without any discount or expense. Make the suitable adjustments to account for any discounting or related expenses.

See Table 215 as an example.
Box 2680: Initiate the record to establish the “RABS Master Real Currency (MR$) Conversion Table for the Class “B+” Accrual Rights.”

As an example, input the appropriate title, labels and monetary phase. Then, establish a column for (1) the remaining term, (2) the beginning principal balance, (3) the payment, (4) the interest paid, (5) the principal paid, (6) the ending principal balance, (7) the current inflationary adjustment (CIA), (8) The master inflationary adjustment factor (MIAF), (9) the designation for Accrual Rights purchased and (10) the accrued interest purchased.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) values, for each row and column for (2), (3), (4), (5), (6), (7) and (10) above, can be obtained by dividing the respective numerical values from Table 215, created via Box 2670, by the master inflationary adjustment factor (MIAF) for the Class “B” securities.

The (C) designation for the Accrual Rights being stripped and purchased should be copied from a prior table for consistency in record keeping. Finally, the (E) numbers projected herein assume that the Accrual rights are sold at par value without any discount or expense. Make the suitable adjustments to account for any discounting or related expenses.

See Table 216 as an example.
Box 2690: Initiate the record to establish the “Real Currency (R$) Pooling Schedule for the Issued Securities.”

As an example, input the appropriate title, labels and monetary phase symbols. Then, (1) add the respective values for each monetary column and payment period in Table 183, if any, Table 203, Table(s) 207 (etc.), if any, Table 211, Table(s) 215 (etc.), if any; all of which were created respectively by Boxes, 2340, 2550, 2590, 2630 and 2670. Then (2) multiply the prevailing rate of inflation (PRI), divided by the number of payments per year, times the principal paid for each payment period. Then, (3) add an additional column for the accrued interest transferred, which is will add the accrued interest sold for each respective payment period in Tables 203 and 207, created respectively by Boxes 2550 and 2590. And, (4) total the payments, interest paid, principal paid and current inflationary adjustment (CIA) columns. The PRI can be obtained from Table 145, created via Box 1840. Finally, the numerical values received for this table should be identical to Tables 170 and 185, created respectively via Box 2200 and 2360. If this is not the case, then find your mistakes and correct them.

See Table 217 as an example.
Box 2700: Optional: Initiate a new record to replace the record created via Box 2690 for the “Real Currency (R$) Pooling Schedule for the Issued Securities,” which computes this schedule by converting the “Master Real Currency (MR$) Pooling Schedule for the Issued Securities,” to the subject schedule defined in the real currency (R$) unit.

In the event that the conduit is a FASIT, or other legal entity, that is permitted to issue securities over time, instead of 100% on the start-up date; then it must be recognized that the securities issued in different months over time, assuming any inflation or deflation, will have a different purchasing power for the real currency (R$) unit. Assuming this is the case, it will not be possible to add the respective real currency (R$) amortization schedules for the real financial instruments issued over time with varying purchasing power for the real currency (R$) unit. As such, to complete the schedule proposed in Box 2690, it will be necessary to convert the pooling schedule created via Box 2730, or Table 220, from the master real currency (MR$) unit to the real currency (R$) unit. This can be achieved by multiplying each MR$ values in Table 220 by the conduit's master inflationary adjustment factor (MIAF) to obtain the equivalent value in the conduit's real currency (R$) unit. Inasmuch as the MR$ units in Table 220 were derived from the R$ units for the various issued securities classes, we should still be able to use the values in Table 217 to compare them against the numerical values in Table 185, and Table 159 or alternatively in or Table 349, created via Box 3710, depending upon the election made in Box 2090; to ascertain if any mistakes have been made. Inasmuch as there must always be a one-to-one correspondence between the total asset pool and the total issued securities pool, we can use this fact to continuously check our work in each of the monetary phases.
Box 2710: Initiate the record to establish the “Nominal Currency (N$) Pooling Schedule for the Issued Securities.”

As an example, input the appropriate title, labels and monetary phase symbols. Then, (1) add the respective values for each monetary column and payment period in Table 182, if any, Table 201, Table(s) 205 (etc.), if any, Table 209, Table(s) 213 (etc.), if any; all of which were created respectively by Boxes, 2320, 2530, 2570, 2610 and 2650. Then (2) multiply the prevailing rate of inflation (PRI), divided by the number of payments per year, times the principal paid for each payment period. Then, (3) add an additional column for the accrued interest transferred, which is the total of the accrued interest sold for each respective payment period in Tables 201 and 205, created respectively by Boxes 2530 and 2570. And, (4) total the payments, interest paid, principal paid and current inflationary adjustment (CIA) columns. The PRI can be obtained from Table 145, created via Box 1840. Finally, the numerical values received for this table should be identical to Tables 171 and 186, created respectively via Box 2220 and 2380. If this is not the case, then find your mistakes and correct them.

See Table 218 as an example.
Box 2720: Initiate the record to establish the “Currency ($) Pooling Schedule for the Issued Securities.”

As an example, input the appropriate title, labels and monetary phase symbols. Then, (1) add the respective values for each monetary column and payment period in Table 182, if any, Table 202, Table(s) 206 (etc.), if any, Table 210, Table(s) 214 (etc.), if any; all of which were created respectively by Boxes, 2320, 2540, 2580, 2620 and 2660. Then (2) multiply the prevailing rate of inflation (PRI), divided by the number of payments per year, times the principal paid for each payment period. Then, (3) add an additional column for the accrued interest transferred, which is the total of the accrued interest sold for each respective payment period in Tables 202 and 206, created respectively by Boxes 2540 and 2580. And, (4) total the payments, interest paid, principal paid and current inflationary adjustment (CIA) columns. The PRI can be obtained from Table 145, created via Box 1840. Finally, the numerical values received for this table should be identical to Tables 172 and 187, created respectively via Box 2230 and 2390. If this is not the case, then find your mistakes and correct them.

See Table 219 as an example.
Box 2730: Initiate the record to establish the “Master Real Currency (MR$) Pooling Schedule for the Issued Securities.”

As an example, input the appropriate title, labels and monetary phase symbols. Then, (1) add the respective values for each monetary column and payment period in Table 184, if any, Table 204, Table(s) 208 (etc.), if any, Table 212, Table(s) 216 (etc.), if any; all of which were created respectively by Boxes, 2350, 2560, 2600, 2640 and 2680. Then (2) multiply the prevailing rate of inflation (PRI), divided by the number of payments per year, times the principal paid for each payment period. Then, (3) add an additional column for the accrued interest transferred, which is the total of the accrued interest sold for each respective payment period in Tables 204 and 208, created respectively by Boxes 2560 and 2600. And, (4) total the payments, interest paid, principal paid and current inflationary adjustment (CIA) columns. The PRI can be obtained from Table 145, created via Box 1840. Finally, the numerical values received for this table should be identical to Tables 173 and 188, created respectively via Box 2210 and 2400. If this is not the case, then find your mistakes and correct them.

See Table 220 as an example.

Process XIV: Financial Statements for the Issued Securities Fully Stripped.
Box 2740: Initiate the record to establish the “Real Currency (R$) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 159, created via Box 2060, or Table 349, created via Box 3710, depending upon the election made in Box 2090; for the (B) respective real securities classes can be obtained from Table(s) 203 and 207 (etc.), if any, created via Boxes 2550 and 2590; for the (C) respective Accrual Rights classes can be obtained from Table(s) 211 and 215 (etc.), if any, created via Boxes 2630 and 2670; (D) nominal rate securities class(es), if any, from Table 183, created via Box 2340; (E) from the reserve, or insurance, rate obtained from Table 147 (created via Box 1860), multiplied times the outstanding primary asset pool balance from Table 159, created via Box 2060; for the (F) loan servicing by multiplying the loan servicing rate obtained from Table 147 (created via Box 1860) times the outstanding principal balance of the primary asset pool obtained from Table 159, created via Box 2060; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 221 as an example.
Box 2750: Initiate the record to establish the “Nominal Currency (N$) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 160, created via Box 2070, or Table 350, created via Box 3720, depending upon the election made in Box 2090; for the (B) respective real securities classes can be obtained from Table(s) 201 and 205 (etc.), if any, created via Boxes 2530 and 2570; for the (C) respective Accrual Rights classes can be obtained from Table(s) 209 and 213 (etc.), if any, created via Boxes 2610 and 2650; (D) nominal rate securities class(es), if any, from Table 182, created via Box 2320; (E) from the reserve, or insurance, rate obtained from Table 147 (created via Box 1860), multiplied times the outstanding primary asset pool balance from Table 160, created via Box 2070; for the (F) loan servicing by multiplying the loan servicing rate obtained from Table 147 (created via Box 1860) times the outstanding principal balance of the primary asset pool obtained from Table 160, created via Box 2070; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 222 as an example.
Box 2760: Initiate the record to establish the “Currency ($) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 161, created via Box 2080, or Table 351, created via Box 3730, depending upon the election made in Box 2090; for the (B) respective real securities classes can be obtained from Table(s) 202 and 206 (etc.), if any, created via Boxes 2540 and 2580; for the (C) respective Accrual Rights classes can be obtained from Table(s) 210 and 214 (etc.), if any, created via Boxes 2620 and 2660; (D) nominal rate securities class(es), if any, from Table 182, created via Box 2320; (E) from the reserve, or insurance, rate obtained from Table 147 (created via Box 1860), multiplied times the outstanding primary asset pool balance from Table 161, created via Box 2080; for the (F) loan servicing by multiplying the loan servicing rate obtained from Table 147 (created via Box 1860) times the outstanding principal balance of the primary asset pool obtained from Table 161, created via Box 2080; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 223 as an example.
Box 2770: Initiate the record to establish the “Master Real Currency (MR$) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual class of issued securities.

The numerical values: (A) for the gross cash flow can be obtained from either Table 158, created via Box 2050, or Table 352, created via Box 3740, depending upon the election made in Box 2090; for the (B) respective real securities classes can be obtained from Table(s) 204 and 208 (etc.), if any, created via Boxes 2560 and 2600; for the (C) respective Accrual Rights classes can be obtained from Table(s) 212 and 216 (etc.), if any, created via Boxes 2640 and 2680; (D) nominal rate securities class(es), if any, from Table 184, created via Box 2350; (E) from the reserve, or insurance, rate obtained from Table 147 (created via Box 1860), multiplied times the outstanding primary asset pool balance from Table 158, created via Box 2050; for the (F) loan servicing by multiplying the loan servicing rate obtained from Table 147 (created via Box 1860) times the outstanding principal balance of the primary asset pool obtained from Table 158, created via Box 2050; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 224 as an example.
Box 2780: Initiate the record to establish the “Real Currency (R$) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 159, created via Box 2060, or Table 349, created via Box 3710, depending upon the election made in Box 2090; for the (B) interest distributions to the respective real securities classes can be obtained from Table(s) 203 and 207 (etc.), if any, created via Boxes 2550 and 2590; for the (c) interest distributions to the respective Accrual Rights classes can be obtained from Table(s) 212 and 216 (etc.), if any, created via Boxes 2640 and 2680; for the (D) interest distributions to the nominal rate securities class(es), if any, from Table 184, created via Box 2350; from the reserve, or insurance, rate obtained from Table 147 (created via Box 1860), multiplied times the outstanding primary asset pool balance from Table 159, created via Box 2060; for the (E) distributions for the loan servicing by multiplying the loan servicing rate obtained from Table 147 (created via Box 1860) times the outstanding principal balance of the primary asset pool obtained from Table 159, created via Box 2060; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 225 as an example.
Box 2790: Initiate the record to establish the “Nominal Currency (N$) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 160, created via Box 2070, or Table 350, created via Box 3720, depending upon the election made in Box 2090; for the (13) interest distributions to the respective real securities classes can be obtained from Table(s) 201 and 205 (etc.), if any, created via Boxes 2530 and 2570; for the (c) interest distributions to the respective Accrual Rights classes can be obtained from Table(s) 209 and 213 (etc.), if any, created via Boxes 2610 and 2650; for the (D) interest distributions to the nominal rate securities class(es), if any, from Table 182, created via Box 2320; from the reserve, or insurance, rate obtained from Table 147 (created via Box 1860), multiplied times the outstanding primary asset pool balance from Table 160, created via Box 2070; for the (E) distributions for the loan servicing by multiplying the loan servicing rate obtained from Table 147 (created via Box 1860) times the outstanding principal balance of the primary asset pool obtained from Table 160, created via Box 2070; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 226 as an example.
Box 2800: Initiate the record to establish the “Currency ($) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 161, created via Box 2080, or Table 351, created via Box 3730, depending upon the election made in Box 2090; for the (13) interest distributions to the respective real securities classes can be obtained from Table(s) 202 and 206 (etc.), if any, created via Boxes 2540 and 2580; for the (c) interest distributions to the respective Accrual Rights classes can be obtained from Table(s) 210 and 214 (etc.), if any, created via Boxes 2620 and 2660; for the (D) interest distributions to the nominal rate securities class(es), if any, from Table 182, created via Box 2320; from the reserve, or insurance, rate obtained from Table 147 (created via Box 1860), multiplied times the outstanding primary asset pool balance from Table 161, created via Box 2080; for the (E) distributions for the loan servicing by multiplying the loan servicing rate obtained from Table 147 (created via Box 1860) times the outstanding principal balance of the primary asset pool obtained from Table 161, created via Box 2080; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 227 as an example.
Box 2810: Initiate the record to establish the “Master Real Currency (MR$) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 158, created via Box 2050, or Table 352, created via Box 3740, depending upon the election made in Box 2090; for the (B) interest distributions to the respective real securities classes can be obtained from Table(s) 204 and 208 (etc.), if any, created via Boxes 2560 and 2600; for the (c) interest distributions to the respective Accrual Rights classes can be obtained from Table(s) 212 and 216 (etc.), if any, created via Boxes 2640 and 2680; for the (D) interest distributions to the nominal rate securities class(es), if any, from Table 184, created via Box 2350; from the reserve, or insurance, rate obtained from Table 147 (created via Box 1860), multiplied times the outstanding primary asset pool balance from Table 158, created via Box 2050; for the (E) distributions for the loan servicing by multiplying the loan servicing rate obtained from Table 147 (created via Box 1860) times the outstanding principal balance of the primary asset pool obtained from Table 158, created via Box 2050; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 228 as an example.
Box 2820: Initiate the record to establish the “Real Currency (R$) RABS Program with Stripped Accrual rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 159, created via Box 2060, or Table 349, created via Box 3710, depending upon the election made in Box 2090; (B) for the reserve set-asides by adding the total reserves distributed to the Trustee through the current payment period, less any distributions made from the reserve fund, which can be obtained from Table 225, created via Box 2780; (C) for the various issued securities classes from Table 203 and Table 207, if any, created respectively via Box 2550 and Box 2590; (D) for the Accrual Rights classes from Tables 211 and 215, created via Boxes 2630 and 2670 and (E) for the nominal rate Class “X” securities, if any, from Table 183, created via Box 2340, if any. By definition, (F) the value for the residual, or the owner's, class of liabilities is the total assets from (4) above, less the total of (C), (D) and (E). The formulas for the total assets, and total liabilities, are shown in the paragraph above.

See Table 229 as an example.
Box 2830: Initiate the record to establish the “Nominal Currency (N$) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 160, created via Box 2070, or Table 350, created via Box 3720, depending upon the election made in Box 2090; (B) for the reserve set-asides by adding the total reserves distributed to the Trustee through the current payment period, less any distributions made from the reserve fund, which can be obtained from Table 226, created via Box 2790; (C) for the various issued securities classes from Table 201 and Table 205, if any, created respectively via Box 2530 and Box 2570; (D) for the Accrual Rights classes from Tables 209 and 213, created via Boxes 2610 and 2650 and (E) for the nominal rate Class “X” securities, if any, from Table 182, created via Box 2320, if any. By definition, (F) the value for the residual, or the owner's, class of liabilities is the total assets from (4) above, less the total of (C), (D) and (E). The formulas for the total assets, and total liabilities, are shown in the paragraph above.

See Table 205 as an example.
Box 2840: Initiate the record to establish the “Currency ($) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 161, created via Box 2080, or Table 351, created via Box 3730, depending upon the election made in Box 2090; (B) for the reserve set-asides by adding the total reserves distributed to the Trustee through the current payment period, less any distributions made from the reserve fund, which can be obtained from Table 227, created via Box 2800; (C) for the various issued securities classes from Table 202 and Table 206, if any, created respectively via Box 2540 and Box 2580; (D) for the Accrual Rights classes from Tables 210 and 214, created via Boxes 2620 and 2660 and (E) for the nominal rate Class “X” securities, if any, from Table 182, created via Box 2320, if any. By definition, (F) the value for the residual, or the owner's, class of liabilities is the total assets from (4) above, less the total of (C), (D) and (E). The formulas for the total assets, and total liabilities, are shown in the paragraph above.

See Table 231 as an example.
Box 2850: Initiate the record to establish the “Master Real Currency (MR$) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 158, created via Box 2050, or Table 352, created via Box 3740, depending upon the election made in Box 2090; (B) for the reserve set-asides by adding the total reserves distributed to the Trustee through the current payment period, less any distributions made from the reserve fund, which can be obtained from Table 228, created via Box 2810; (C) for the various issued securities classes from Table 204 and Table 208, if any, created respectively via Box 2560 and Box 2600; (D) for the Accrual Rights classes from Tables 212 and 216, created via Boxes 2900 and 2950 and (E) for the nominal rate Class “X” securities, if any, from Table 184, created via Box 2350, if any. By definition, (F) the value for the residual, or the owner's, class of liabilities is the total assets from (4) above, less the total of (C), (D) and (E). The formulas for the total assets, and total liabilities, are shown in the paragraph above.

See Table 232 as an example.

Process XV: Accrual Rights Amortization Schedules by Period Stripped.
Box 2860: Initiate the record to establish the “Real Asset Backed-Securities Class “A+1” Master Real Currency (MR$) Amortization Schedule (by Period Stripped).”

Inasmuch as one of the primary goals of the invention is to develop a liquid market for the accruing interest, represented by the Accrual Rights; it is necessary to prepare the information that will be necessary to report the financial activity to the purchasers of the Accrual rights as they are stripped and sold to other conduits over time. The invention has established the master real currency as a universal currency for the transfer of wealth by and between conduits, and defined marketplaces, that may have varying purchasing powers defined for their respective real currency (R$) units. While this might be accomplished in the fiat currency ($) unit, we know that it is the fiat currency ($) that causes inflation and deflation to begin with. Hence, the logic is to move towards the use of the master real currency unit. As such, the amortization table, created in via this Box, is the dominant schedule in its row of schedules and tables. Especially so, since this schedule will for the first time begin to report to the larger defined marketplace with respect to the financial activity of the Accrual Rights that are sold in the defined marketplace over time. While we have a table as shown in Table 212, created via Box 2640, that shows the cash flows for the total Class “A+” Stripped Accrual Rights, we must recognize that these rights are stripped each payment period and may have been purchased by any number of other conduits. Hence, we need to create an individual record on each class of stripped Accrual Rights, so that we can later make the proper distributions to the purchasing conduits.

As an example, input the appropriate titles, labels and monetary phase symbols. Then, establish a column for (1) the remaining term, (2) the beginning principal balance, (3) the amortizing (real) rate of interest, (4) the payment, (5) the interest paid, (6) the principal paid, (7) the ending principal balance and (8) the current inflationary adjustment (CIA).

The (A) remaining term for the first payment period is the term in years, times the number of payments per year, for the given securities class, both of which can be obtained from Table 147, created via Box 1860. The remaining term in subsequent payment periods is the remaining term for the prior payment period less one. Please note that the first class of Accrual Rights is not stripped until the end of the first payment period, assuming that inflation has occurred during this period. As such, the (B) beginning principal balance for the first payment period of the conduit should be “N/A” for not applicable. The beginning principal balance for the second payment period will be the numerical value for the Class “A+1” Accrual Rights, which is available in Table 212, created via Box 2640. Inasmuch as this schedule will represent only the Class “A+1” Accrual Rights, no other values will be drawn from Table 212 for this schedule. (However, each successive class of Accrual Rights, by period stripped, can obtain the par value of the respective class of Accrual Rights from Table 212. It should be recognized that each successive class of Accrual Rights will begin their amortization schedules one period later than the previous class.) The subsequent values for the beginning principal balance will be the ending principal balance in the prior payment period.

The (C) amortizing (real) rate of interest for the Class “A+” Accrual Rights will be the same as the class of securities from which they were stripped, meaning the Class “A” securities. The actual rates can be obtained from Table 145, created via Box 1850 for the Class “A” securities. The payment (D) can be determined by using the (i) remaining term, (ii) the principal balance and (iii) the amortizing (real) rate of interest, along with any acceptable amortization formula. The (E) interest paid will equal the amortizing (real) rate of interest, divided by the number of payment periods per year, times the beginning principal balance for each respective payment period. The (F) principal paid is the payment less the interest paid. The (G) ending principal balance is the record on each class of stripped Accrual Rights, so that we can later make the proper distributions to the purchasing conduits.

As an example, input the appropriate titles, labels and monetary phase symbols. Then, establish a column for (1) the remaining term, (2) the beginning principal balance, (3) the amortizing (real) rate of interest, (4) the payment, (5) the interest paid, (6) the principal paid, (7) the ending principal balance and (8) the current inflationary adjustment (CIA).

The (A) remaining term for the first payment period is the term in years, times the number of payments per year, for the given securities class, both of which can be obtained from Table 147, created via Box 1860. The remaining term in subsequent payment periods is the remaining term for the prior payment period less one. Please note that the first class of Accrual Rights is not stripped until the end of the first payment period, assuming that inflation has occurred during this period. As such, the (B) beginning principal balance for the first payment period of the conduit should be “N/A” for not applicable. The beginning principal balance for the second payment period will be the numerical value for the Class “A+1” Accrual Rights, which is available in Table 212, created via Box 2640. Inasmuch as this schedule will represent only the Class “A+1” Accrual Rights, no other values will be drawn from Table 212 for this schedule. (However, each successive class of Accrual Rights, by period stripped, can obtain the par value of the respective class of Accrual Rights from Table 212. It should be recognized that each successive class of Accrual Rights will begin their amortization schedules one period later than the previous class.) The subsequent values for the beginning principal balance will be the ending principal balance in the prior payment period.

The (C) amortizing (real) rate of interest for the Class “A+” Accrual Rights will be the same as the class of securities from which they were stripped, meaning the Class “A” securities. The actual rates can be obtained from Table 145, created via Box 1850 for the Class “A” securities. The payment (D) can be determined by using the (i) remaining term, (ii) the principal balance and (iii) the amortizing (real) rate of interest, along with any acceptable amortization formula. The (E) interest paid will equal the amortizing (real) rate of interest, divided by the number of payment periods per year, times the beginning principal balance for each respective payment period. The (F) principal paid is the payment less the interest paid. The (G) ending principal balance is the beginning principal balance, less the principal paid, for each respective payment period.

The (H) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. Finally, the columns for the payment, the interest paid and the principal paid should be totaled. The first numerical value for the beginning principal balance should equal the total principal paid at the end of the full term. In addition, the ending principal balance in the final payment period should equal zero. If these results are not obtained, then find the mistakes and correct them.

See Table 233a as an example.
Box 2870: Initiate the record to establish the “Real Asset Backed-Securities Class “A+1” Real Currency (R$) Conversion Table (by Period Stripped).”

As an example, input the appropriate titles, labels and monetary phase symbols. Then, establish a column for (1) the remaining term, (2) the master inflationary adjustment factor (MIAF), if desired, (3) the beginning principal balance, (4) the payment, (5) the interest paid, (6) the principal paid, (7) the ending principal balance and (8) the current inflationary adjustment (CIA).

The (A) remaining term for the first payment period is the term in years, times the number of payments per year, for the given securities class, both of which can be obtained from Table 147, created via Box 1860. The remaining term in subsequent payment periods is the remaining term for the prior payment period less one. Please note that the first class of Accrual Rights is not stripped until the end of the first payment period, assuming that inflation has occurred during this period. As such, the (B) the MIAF for the Class “A+” Accrual Rights is the same as for the Class “A” Securities, which can be obtained from Table 145, created via Box 1850. The (C) beginning principal balance for the first payment period of the conduit should be “N/A” for not applicable. Then, the numerical values for the respective payment periods and columns for (3), (4), (5), (6) and for the Class “A” securities, and so on. The (C) beginning principal balance for the first payment period of the conduit should be “N/A” for not applicable. Then, the numerical values for the respective payment periods and columns for (3), (4), (5), (6) and (7) will be the respective values in Table 233a, created via Box 2860, times the respective IAF.

The (D) CIA can be calculated by multiplying the prevailing rate of inflation (PRI), divided by the number of payments per year, times the principal paid for each respective payment period. The PRI can be obtained from Table 145, created via Box 1840, and the number of payments per year can be obtained from Table 147, created via Box 1860. Finally, the columns for the payment, the interest paid and the principal paid should be totaled. The first numerical value for the beginning principal balance should not equal the total principal paid at the end of the full term, assuming any degree of inflation and/or deflation has occurred; unless they perfectly offset each other. In addition, the ending principal balance in the final payment period should equal zero. If these results are not obtained, then find the mistakes and correct them.

See Table 235a as an example.
Box 2890: Initiate the record to establish the “Real Asset Backed-Securities Class “A+1” Currency (N$) Recasting Table (by Period Stripped).”

In order to properly understand this recasting table, one must realize that we are moving from the frame of reference of the Class “A” issued securities, which were assumed in the attached figures to be the same day as the start-up of the conduit; to the frame of reference of the purchaser of the Class “A+1” Accrual rights, which were assumed to be stripped immediately following the first payment period. The purpose of this table is to assist the purchaser in balancing his or her books. As such, we must understand that the purchasing power for the Class “A+” Accrual Rights is defined in real currency (R$) units one payment period later than the definition of the real currency (R$) units defined by Class “A” issued securities. The key to the development of a recasting table is that the numerical values in the principal paid column are identical to the numerical values in the same table expressed in real currency (R$) units. However, in this case, the real currency (R$) units in Table 234 were defined by the Class “A” issued securities perspective. Hence, we must make an adjustment to our normal practice. We can achieve this adjustment by using the IAF for the Class “A” issued securities for the payment period in which the Accrual rights were stripped (i.e. the payment period following the period in which the interest accrued). We then multiple this IAF times the principal paid in Table 234, created via Box 2870, to obtain the principal paid from the perspective of the purchaser of the Accrual Rights. We then use this same value for the IAF in each subsequent row of this recasting table. As such, we refer to this IF as the IAF Constant. It is the only time that the IAF does not change over time, assuming some degree of inflation or deflation. The IAF Constant, once determined, is fixed, just as the MIAF for any given conduit or instrument is fixed.

As an example, input the appropriate titles, labels and monetary phase symbols. Then, establish a column for (1) the remaining term, (2) the beginning principal balance, (3) the payment, (4) the interest paid, (5) the principal paid, (6) the ending principal balance, (7) the current inflationary adjustment (CIA) and (8) the IAF Constant, if desired.

The (A) remaining term for the first payment period is the term in years, times the number of payments per year, for the given securities class, both of which can be obtained from Table 147, created via Box 1860. The remaining term in subsequent payment periods is the remaining term for the prior payment period less one. The (B) beginning principal balance for the first payment period of the conduit should be “N/A” for not applicable, since the payments on the Class “A+1” Accrual Rights do not begin until the second payment period. The value for the beginning principal balance in the second payment period is equal to the respective value in Table 235, created via Box 2880. Thereafter, the value for the beginning principal balance in each subsequent row is the value for the ending principal balance in the prior payment period. The (C) payments for each respective payment period are copied directly from Table 235, created via Box 2880. The values for the principal paid is the respective value for principal paid in Table 234, created via Box 2870, times the IAF Constant.

The (D) interest paid is the payment less the principal paid. The (E) ending principal balance is the beginning principal balance less the principal paid in each payment period. The current inflationary adjustment can be copied from its respective position in Table 235, created via Box 2880. The IAF Constant is the inflationary adjustment factor for the Class “A” issued securities in the payment period in which the Accrual Rights were stripped, or conversely in the payment period following the period during which the interest accrued. Once determined, the IAF Constant does not change for the term of the Accrual Right class. Finally, the columns for the payment, the interest paid and the principal paid should be totaled. The first numerical value for the beginning principal balance should equal the total principal paid at the end of the full term. In addition, the ending principal balance in the final payment period should equal zero. If these results are not obtained, then find the mistakes and correct them.

See Table 236 as an example.
Box 2895: Repeat Boxes 2860, 2870, 2880 and 2890 for Each Additional Stripping of RABS Class “A+N” Accrual Rights by Period Stripped.

Perform the task described in the Box description above.

See Tables 233b to 233i, 2324b to 234i, 235b to 235i and 236b to 236i as examples.
Box 2900: Initiate the record to establish the “Real Asset-Backed Securities (RABS) Class “A+” Real Currency (R$) Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance and (7) the current inflationary adjustment (CIA).

Then for each similarly labeled row and column, add the respective numerical values in Tables 147a to 147i, created via Boxes 2870 and 2895. The monetary values in this table should match the monetary values in Table 211, created via Box 2630. If the figures do not match, then find the mistakes and correct them.

See Table 237 as an example.
Box 2910: Initiate the record to establish the “Real Asset-Backed Securities (RABS) Class “A+” Nominal Currency (N$) Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance and (7) the current inflationary adjustment (CIA).

Then for each similarly labeled row and column, add the respective numerical values in FIGS. 148a to 148i, created via Boxes 2880 and 2895. The monetary values in this table should match the monetary values in Table 209, created via Box 2610. If the figures do not match, then find the mistakes and correct them.

See Table 238 as an example.
Box 2920: Initiate the record to establish the “Real Asset-Backed Securities (RABS) Class “A+” Currency ($) Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance and (7) the current inflationary adjustment (CIA).

Then for each similarly labeled row and column, add the respective numerical values in FIGS. 149a to 149i, created via Boxes 2860 and 2895. The monetary values for the payment column and the current inflationary adjustment (CIA) column in this table should match the respective values in Table 210, created via Box 2620. If the figures do not match, then find the mistakes and correct them.

See Table 239 as an example.
Box 2930: Initiate the record to establish the “Real Asset-Backed Securities (RABS) Class “A+” Nominal Currency (N$) Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance and (7) the current inflationary adjustment (CIA).

Then for each similarly labeled row and column, add the respective numerical values in FIGS. 146a to 146i, created via Boxes 2860 and 2895. The monetary values in this table should match the monetary values in Table 212, created via Box 2640. If the figures do not match, then find the mistakes and correct them.

See Table 240 as an example.
Box 2940: Repeat Boxes 2860 to 2930 for the Class “B+,” etc., Accrual Rights, if any.

Perform the task described in the Box description above. Be sure to access the respective Figures and Boxes, which pertain to the Class “B+” Accrual Rights.

See Tables 241a to 241i, 242a to 242i, 243a to 243i, 244a to 244i, 245, 246, 247 and 248.

Process XVI: Distributions to Stripped Class “A and Class “B” Institutional Securities Holders.
Box 2950: Initiate the record to establish the “Investors' Periodic Ownership by Class of Securities.”

As an example, input titles, subtitles, labels and monetary phase. Then, establish a column for (1) the customer number, (2) the issue date, (3) the cancellation date, (4) the investor's name, (5) the securities class, (6) the CUSIP number, (7) the certificate number, (8) the original par value, (9) the constant percentage ownership of the class and (10) the initial percentage ownership of the conduit. Then subdivide into sections for (11) the Class “A” certificate holders, (12) the Class “B” certificate holders, if any, (13) the Class “X” certificate holders, if any, and (14) the Class “R” certificate holders.

Then, for each issued securities investor with respect to the proper subdivided section, input the (A) customer number, (B) the issue date of the securities, (C) the cancellation date, if and when the certificate is canceled, (D) the investor's name, (E) the securities class, (F) the CUSIP number issued to that particular class of securities, (G) the certificate number, (H) the original par value of the issued certificate in the conduit's real currency (R$) unit, (I) the investor's constant percentage ownership of the given securities class and (J) the investor's initial percentage ownership of the conduit. Then total columns (8), (9) and (10) for each class of certificates, and then for all of the originally issued securities classes (i.e. (11), (12), (13) and (14).

The investor's constant percentage ownership of the given securities class, represented by (I) above, can be determined by dividing the investor's original par value (H) for his or her certificates by the total for column (8).

Then, initiate a new chart for the Accrual Rights. As an example, titles, subtitles, labels and monetary phase. Then, establish a column for (15) the customer number, (16) the stripping date, (17) the cancellation date, (18) the investor's name, (19) the securities class, (20) the CUSIP number, (21) the certificate number, (22) the original par value, (23) the initial percentage ownership of the class and (24) the initial percentage ownership of the conduit. Then subdivide into sections for (25) the Class “A+” Accrual Rights certificate holders and (26) the Class “B+,” etc., Accrual Rights certificate holders, if any.

Then, for each Accrual Rights securities investor with respect to the proper subdivided section, input the (A) customer number, (B) the stripping date of the securities, (C) the cancellation date, if and when the certificate is canceled, (D) the investor's name, (E) the securities class, (F) the CUSIP number issued to that particular class of securities, (G) the certificate number, (H) the original par value of the Accrual Right certificate in the conduit's real currency (R$) unit, (I) the investor's initial percentage ownership of the given securities class and (J) the investor's initial percentage ownership of the conduit. Then total columns (22), (23) and (24) for each class of certificates, and then for all of the Accrual Rights classes (i.e. (15) and (16), etc. if any).

The investor's initial percentage ownership of the class (I) is the original par value (H) divided by the outstanding balance of the Accrual Rights stripped from a given issued securities class, which can be found in Table 152, created via Box 1865. Then, the investor's initial percentage of ownership of the conduit (J) is the original par value (H) divided by the total outstanding balance of the conduit's issued and stripped securities, which can be found in Table 152, created via Box 1865.

See Table 249 as an example.
Box 2960: Initiate the record to establish the “Real Currency (R$) Distributions to Individual Investors for the (Stripped) Class “A” RABS.”

As an example, input the appropriate titles, labels and monetary phase symbols, and the data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, establish a column for (7) the month, quarter or year, reflecting the payment period, (8) the beginning principal balance, (9) the amortizing (real) rate of interest, (10) the payment, (11) the interest paid, (12) the principal paid, (13) the ending principal balance, (14) the current inflationary adjustment (CIA), (15) the Accrual Rights sold and (16) the inflationary adjustment factor (IAF).

Input (A) the appropriate values for (1) through (6), and (B) the month, quarter or year, reflecting the payment period. Then, (C) the values for (8), (10), (11), (12), (13) and (14) can be calculated by multiplying the respective value in Table 203, created via Box 2550, times the investor's constant percentage of ownership of the issued securities class from Table 249, created via Box 2950. The (D) value for the amortizing (real) rate of interest can be copied from Table 145, created via Box 1850. The (E) value of the Accrual Rights sold is then the value for the prior payment period for the Accrual Rights sold from Table 251a, created via Box 2970, divided by the inflationary adjustment factor (IAF) for the Class “A” securities. Then, (F) input the values for the Class “A” securities IAF, which can be obtained from Table 145, created via Box 1850, if desired.

See Table 250a as an example.
Box 2970: Initiate the record to establish the “Nominal Currency (N$) Distributions to Individual Investors for the (Stripped) Class “A” RABS.”

As an example, input the appropriate titles, labels and monetary phase symbols, and the data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, establish a column for (7) the month, quarter or year, reflecting the payment period, (8) the beginning principal balance, (9) the payment, (10) the interest paid, (11) the principal paid, (12) the ending principal balance, (13) the current inflationary adjustment (CIA) and (14) the Accrual Rights sold.

Input (A) the appropriate values for (1) through (6), and (B) the month, quarter or year, reflecting the payment period. Then, (C) the values for (8), (9), (10), (11), (12) and (13) can be calculated by multiplying the respective value in Table 250a, created via Box 2960, times inflationary adjustment factor (IAF) for the Class “A” securities; which can be found in Table 145, created via Box 1850. The (D) value of the Accrual Rights sold is the investor's percentage ownership of the class of issued securities in Table 249, created via Box 2950, times the Accrual Rights sold in Table 201, created via Box 2530.

See Table 251a as an example.
Box 2980: Initiate the record to establish the “Currency ($) Distributions to Individual Investors for the (Stripped) Class “A” RABS.”

As an example, input the appropriate titles, labels and monetary phase symbols, and the data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, establish a column for (7) the month, quarter or year, reflecting the payment period, (8) the beginning principal balance, (9) the payment, (10) the interest paid, (11) the principal paid, (12) the ending principal balance, (13) the current inflationary adjustment (CIA), (14) the Accrual Rights sold and the (15) total income.

Input (A) the appropriate values for (1) through (6), and (B) the month, quarter or year, reflecting the payment period. Then, (C) the value for the beginning principal balance in the first payment period is taken respectively from Table 250a, created via Box 2960, and the subsequent values for the beginning principal balance are copied from the ending principal balance for the prior payment period. The (D) values for (9), (11), (13) and (14) are also taken respectively from Table 250a, created via Box 2960. The (E) interest paid is then calculated by subtracting the principal paid from the payment for each payment period. The ending principal balance is the beginning principal balance less the principal paid for each payment period. And, the total income is the sum of the interest paid, the current inflationary adjustment and the Accrual rights sold for each payment period.

See Table 252a as an example.
Box 2990: Initiate the record to establish the “Master Real Currency (MR$) Distributions to Individual Investors for the (Stripped) Class “A” RABS.”

As an example, input the appropriate titles, labels and monetary phase symbols, and the data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, establish a column for (7) the month, quarter or year, reflecting the payment period, (8) the beginning principal balance, (9) the payment, (10) the interest paid, (11) the principal paid, (12) the ending principal balance, (13) the current inflationary adjustment (CIA), (14) the Accrual Rights sold and (15) the master inflationary adjustment factor (MIAF), if desired.

Input (A) the appropriate values for (1) through (6), and (B) the month, quarter or year, reflecting the payment period. Then, (C) the values for (8), (9), (10), (11), (12), (13) and (14) can be calculated by dividing the respective values in Table 250a, created via Box 2960, by the master inflationary adjustment factor (MIAF) for the Class “A” securities; which can be found in Table 145, created via Box 1840 (i.e. the same as the conduit's MIAF in the example).

See Table 253a as an example.
Box 2995: Repeat Boxes 2960, 2970, 2980 and 2990 for each additional investor, who has invested in the Class “A” issued securities.

Perform the task described in the Box description above. Be sure to access the respective Tables and Boxes, which pertain to the Class “B” issued securities after the stripping.

See Tables 250b to 250g, 251b to 251g, 252b to 252g and 253b to 253g, as examples.
Box 3000: Initiate the record to establish the “Real Currency (R$) Distributions for the (Stripped) Class “A” Real Asset-Backed Securities Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance, (7) the current inflationary adjustment (CIA) and (8) the Accrual rights sold.

Then for each similarly labeled row and column, add the respective numerical values in Tables 250a to 250g, created via Boxes 2960 and 2995. The monetary values in this table should match the monetary values in Table 203, created via Box 2550. If the figures do not match, then find the mistakes and correct them.

See Table 254 as an example.
Box 3010: Initiate the record to establish the “Nominal Currency (N$) Distributions for the (Stripped) Class “A” Real Asset-Backed Securities Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance, (7) the current inflationary adjustment (CIA) and (8) the Accrual rights sold.

Then for each similarly labeled row and column, add the respective numerical values in Tables 251a to 251g, created via Boxes 2970 and 2995. The monetary values in this table should match the monetary values in Table 201, created via Box 2530. If the figures do not match, then find the mistakes and correct them.

See Table 255 as an example.
Box 3020: Initiate the record to establish the “Currency ($) Distributions for the (Stripped) Class “A” Real Asset-Backed Securities Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance, (7) the current inflationary adjustment (CIA) and (8) the Accrual rights sold.

Then for each similarly labeled row and column, add the respective numerical values in Tables 252a to 252g, created via Boxes 2980 and 2995. The monetary values in this table should match the monetary values in Table 202, created via Box 2540. If the figures do not match, then find the mistakes and correct them.

See Table 256 as an example.
Box 3030: Initiate the record to establish the “Master Real Currency (MR$) Distributions for the (Stripped) Class “A” Real Asset-Backed Securities Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid, (6) the ending principal balance, (7) the current inflationary adjustment (CIA) and (8) the Accrual rights sold.

Then for each similarly labeled row and column, add the respective numerical values in Tables 255a to 255g, created via Boxes 2990 and 2995. The monetary values in this table should match the monetary values in Table 204, created via Box 2560. If the figures do not match, then find the mistakes and correct them.

See Table 257 as an example.
Box 3040: Repeat Boxes 2960, 2970, 2980, 2990, 2995, 3000, 3010, 3020 and 3030 for each additional investor, who has invested in the Class “A” issued securities.

Perform the task described in the Box description above. Be sure to access the respective Tables and Boxes, which pertain to the Class “B” issued securities after the stripping.

See Tables 258a to 258d, 259a to 259d, 260a to 260d, 261a to 261d, 262, 263, 264 and 265 as examples.

Process XVII: Distributions to the Nominal Rate Class “X,” if any, and Class “R” Residual, Securities Holders.
Box 3050: Initiate the record to establish the “Currency ($) Distributions to Institutional Investors for the Nominal Rate Class “X” Securities, If Any.”

As an example, input the appropriate titles and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) the beginning principal balance, (9) the nominal rate, (10) the payment, (11) the interest paid, (12) the principal paid and (13) the ending principal balance.

Input the values for (1) through (6). Then, input the (A) month, quarter or year representing the payment periods for the nominal rate Class “X” securities, and the (B) fixed nominal rate; which can both be obtained from Table 145, created via Box 1850. Then, the (C) numerical values for (8), (10), (11), (12) and (13) can be calculated by the investor's initial percentage of ownership of the class, copied from Table 249, created via Box 2950, times the respective value in Table 182, created via Box 2320. Alternatively, one could also do a new amortization schedule for each nominal rate Class “X” investor, but this is rather cumbersome; and would create a greater potential for error. Nonetheless, one should do just such an amortization for any given investor, simply to check the validity of the preferred method of calculating these values.

See Table 266a as an example.
Box 3060: Initiate the record to establish the “Real Currency (R$) Distributions for the Nominal Rate Class “X” Securities, If Any.”

As an example, input the appropriate titles and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) the beginning principal balance, (9) the payment, (10) the interest paid, (11) the principal paid, (12) the ending principal balance and the (13) inflationary adjustment factor (IAF), if desired.

Input the values for (1) through (6). Then, input the (A) month, quarter or year representing the payment periods for the nominal rate Class “X” securities, which can be obtained from Table 145, created via Box 1850. The monetary values for this table can be obtained by dividing the respective values in Table 266a, created via Box 3050, by the inflationary adjustment factor (IAF) for each respective payment period. The IAF can be obtained from Table 145, created via Box 1840.

See Table 267a as an example.
Box 3070: Initiate the record to establish the “Conversion Table for the Master Real Currency (MR$) Distributions for the Nominal Rate Class “X” Securities, If Any.”

As an example, input the appropriate titles, and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) the beginning principal balance, (9) the payment, (10) the interest paid, (11) the principal paid, (12) the ending principal balance and the (13) inflationary adjustment factor (IAF), if desired.

Input the (A) month, quarter or year representing the payment periods for the nominal rate Class “X” securities, which can be obtained from Table 145, created via Box 1850. The monetary values for this table can be obtained by dividing the respective values in Table 266a, created via Box 3050, by the master inflationary adjustment factor (MIAF) for each respective payment period. The MIAF can be obtained from Table 145, created via Box 1840.

See Table 268a as an example.
Box 3075: Repeat Boxes 3050, 3060 and 3070 for each additional investor, who purchase the nominal rate Class “X” securities, if any.

Perform the task described in the Box description above. Be sure to access the respective Tables and Boxes, which pertain to the nominal rate Class “X” issued securities.

See Tables 266b to 266d, 267b to 267d and 268b to 268d as examples.
Box 3080: Initiate the record to establish the “Currency ($) Distributions for the Nominal Rate Class “X” Securities, if any, Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid and (6) the ending principal balance.

Then total the monetary values in Tables 266a to 266d, etc., created via Boxes 3050 and 3075, in each respective row and column to obtain the numerical values for this table. The numerical values in this table should match the numerical values in Table 182, created via Box 2320. If this result is not obtained, then find the mistakes and correct them.

See Table 269 as an example.
Box 3090: Initiate the record to establish the “Real Currency (R$) Distributions for the Nominal Rate Class “X” Securities, if any, Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid and (6) the ending principal balance.

Then total the monetary values in Tables 267a to 267d, etc., created via Boxes 3060 and 3075, in each respective row and column to obtain the numerical values for this table. The numerical values in this table should match the numerical values in Table 183, created via Box 2340. If this result is not obtained, then find the mistakes and correct them.

See Table 270 as an example.
Box 3100: Initiate the record to establish the “Master Real Currency (MR$) Distributions for the Nominal Rate Class “X” Securities, if any, Pooling Schedule.”

As an example, input the appropriate titles, labels and monetary phase symbols. Then, establish a column for (1) the month, quarter or year, reflecting the payment period, (2) the beginning principal balance, (3) the payment, (4) the interest paid, (5) the principal paid and (6) the ending principal balance.

Then total the monetary values in Tables 268a to 268d, etc., created via Boxes 3070 and 3075, in each respective row and column to obtain the numerical values for this table. The numerical values in this table should match the numerical values in Table 184, created via Box 2350. If this result is not obtained, then find the mistakes and correct them.

See Table 271 as an example.
Box 3110: Initiate the record to establish the “Real Currency (R$) Distributions to the Certificate Holders of the Residual Class “R” Securities.”

As an example, input the appropriate and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) securities reserve payments, (9) cumulative securities reserves, (10) the principal reserve, (11) the losses covered by the reserves, (12) the total assets, (13) the residual payments, (14) the securities reserve dispersed, (15) the principal reserve dispersed and (16) the total income.

Input the values for (1) through (6). Then, input the (A) month, quarter or year representing the payment periods for the Class “R” securities. The (B) the securities reserve payments, and the (C) residual payments, can both be obtained from Table 276, created via Box 3150. The (D) cumulative securities reserve is simply the ongoing total of column (8). Any (E) losses paid out of the securities reserve should be input into column (11). The (F) principal reserve can be obtained from subtracting the value for the securities reserve in Table 284, created via Box 3230, from the residual net assets in Table 285, created via Box 3240. The (G) total assets is the sum of columns (9), (10) and (11) for each respective payment period. If (H) and when any part of the securities reserve, typically held by the Trustee, is released to the residual certificate holders, then it should be entered in column (14). If (I) any of the principal reserve, which is a non-cash reserve, is distributed as the result of the premature payment of a loan obligation, then it should be input into column (15). Then, the total income for each payment period is the sum of columns (13), (14) and (15). Finally, columns (8), (11), (13), (14), (15) and (16) should all be totaled over the term of the securities.

It should be noted that the securities offering can be structured such that the Class “R” residual certificates can generate substantial profits for the conduit's sponsors, or conversely so there is little or no distributions to the residual certificate holders. For tax and other reasons, pertaining to funding and/or risk, the conduit's sponsors are sometimes better off receiving their profits in a different format than as the owners of the residual certificates.

See Table 272 as an example.
Box 3120: Initiate the record to establish the “Nominal Currency (N$) Distributions to the Certificate Holders of the Residual Class “R” Securities.”

As an example, input the appropriate and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) inflationary adjustment factor (IAF), if desired, (9) cumulative securities reserves, (10) the principal reserve, (11) the losses covered by the reserves, (12) the total assets, (13) the residual payments, (14) the securities reserve dispersed, (15) the principal reserve dispersed and (16) the total income.

Input the values for (1) through (6). Then, input the (A) month, quarter or year representing the payment periods for the Class “R” securities. The (B) the cumulative securities reserve, (C) the principal reserve and the (D) residual payments, can all be obtained from Table 272, created via Box 3110, by multiplying the respective values times the inflationary adjustment factor (IAF). The (E) IAF can be obtained from Table 145, created via Box 1840.

Any (F) losses paid out of the securities reserve should be input into column (11). The (G) total assets is the sum of columns (9), (10) and (11) for each respective payment period. If (H) and when any part of the securities reserve, typically held by the Trustee, is released to the residual certificate holders, then it should be entered in column (14). If (I) any of the principal reserve, which is a non-cash reserve, is distributed as the result of the premature payment of a loan obligation, then it should be input into column (15). Then, the total income for each payment period is the sum of columns (13), (14) and (15). Finally, columns (11), (13), (14), (15) and (16) should all be totaled over the term of the securities.

It should be noted that the securities offering can be structured such that the Class “R” residual certificates can generate substantial profits for the conduit's sponsors, or conversely so there is little or no distributions to the residual certificate holders. For tax and other reasons, pertaining to funding and/or risk, the conduit's sponsors are sometimes better off receiving their profits in a different format than as the owners of the residual certificates.

See Table 273 as an example.
Box 3130: Initiate the record to establish the “Currency ($) Distributions to the Certificate Holders of the Residual Class “R” Securities.”

As an example, input the appropriate and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) cumulative securities reserves, (9) the principal reserve, (10) the losses covered by the reserves, (11) the total assets, (12) the residual payments, (13) the securities reserve dispersed, (14) the principal reserve dispersed and (15) the total income.

Input the values for (1) through (6). Then, input the (A) month, quarter or year representing the payment periods for the Class “R” securities. The (B) the cumulative securities reserve, (C) the principal reserve and the (D) residual payments, can all be obtained from Table 272, created via Box 3110. Any (E) losses paid out of the securities reserve should be input into column (10). The (F) total assets is the sum of columns (8), (9) and (10) for each respective payment period. If (G) and when any part of the securities reserve, typically held by the Trustee, is released to the residual certificate holders, then it should be entered in column (13). If (H) any of the principal reserve, which is a non-cash reserve, is distributed as the result of the premature payment of a loan obligation, then it should be input into column (14). Then, the total income for each payment period is the sum of columns (12), (13) and (14). Finally, columns (10), (12), (13), (14) and (15) should all be totaled over the term of the securities.

It should be noted that the securities offering can be structured such that the Class “R” residual certificates can generate substantial profits for the conduit's sponsors, or conversely so there is little or no distributions to the residual certificate holders. For tax and other reasons, pertaining to funding and/or risk, the conduit's sponsors are sometimes better off receiving their profits in a different format than as the owners of the residual certificates.

See Table 274 as an example.
Box 3140: Initiate the record to establish the “Master Real Currency (MR$) Distributions to the Certificate Holders of the Residual Class “R” Securities.”

As an example, input the appropriate and data categories to identify the subject investor. Such data categories might include, (1) the customer number, (2) the investor's name, (3) the conduit's name, (4) the real asset-backed securities class purchased, (5) the issued securities class CUSIP number and (6) the certificate number(s).

Then, input the appropriate titles, labels and monetary phase symbols to establish columns for (7) the month, quarter or year, reflecting the payment period, (8) cumulative securities reserves, (9) the principal reserve, (10) the losses covered by the reserves, (11) the total assets, (12) the residual payments, (13) the securities reserve dispersed, (14) the principal reserve dispersed, (15) the total income and the (16) master inflationary adjustment factor, if desired.

Input the values for (1) through (6). Then, input the (A) month, quarter or year representing the payment periods for the Class “R” securities. The (B) the cumulative securities reserve, (C) the principal reserve and the (D) residual payments, are each the respective values from Table 276, created via Box 3150, divided by the master inflationary adjustment factor (MIAF). The (E) MIAF can be obtained from Table 145, created via Box 1840. Any (F) losses paid out of the securities reserve should be input into column (10). The (G) total assets is the sum of columns (8), (9) and (10) for each respective payment period. If (H) and when any part of the securities reserve, typically held by the Trustee, is released to the residual certificate holders, then it should be entered in column (13). If (I) any of the principal reserve, which is a non-cash reserve, is distributed as the result of the premature payment of a loan obligation, then it should be input into column (14). Then, the total income for each payment period is the sum of columns (12), (13) and (14). Finally, columns (10), (12), (13), (14) and (15) should all be totaled over the term of the securities.

It should be noted that the securities offering can be structured such that the Class “R” residual certificates can generate substantial profits for the conduit's sponsors, or conversely so there is little or no distributions to the residual certificate holders. For tax and other reasons, pertaining to funding and/or risk, the conduit's sponsors are sometimes better off receiving their profits in a different format than as the owners of the residual certificates.

See Table 275 as an example.

Process XVIII: Financial Statements for the Issued Securities, Fully Stripped.
Box 3150: Initiate the record to establish the “Real Currency (R$) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual cash flow for the residual class of issued securities.

The numerical values: (A) for the gross cash flow can be obtained from either Table 159, created via Box 2060, or Table 349, created via Box 3710, depending upon the election made in Box 2090; for the (B) respective real securities classes can be obtained from Table(s) 254 and 262 (etc.), if any, created via Boxes 3000 and 3040; for the (C) respective Accrual Rights classes can be obtained from Table(s) 237 and 245 (etc.), if any, created via Boxes 2900 and 2940; (D) nominal rate securities class(es), if any, from Table 270, created via Box 3160; (E) from the reserve, or insurance, rate obtained from Table 147 (created via Box 1860), multiplied times the outstanding primary asset pool balance from Table 159, created via Box 2060; for the (F) loan servicing by multiplying the loan servicing rate obtained from Table 147 (created via Box 1860) times the outstanding principal balance of the primary asset pool obtained from Table 159, created via Box 2060; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 276 as an example.
Box 3160: Initiate the record to establish the “Nominal Currency (N$) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) each nominal rate securities classes issued, if any, (4) any reserves or insurance, (5) loan servicing, (6) each additional expense category, or combination thereof, and (7) the residual class flow for the residual class of issued securities.

The numerical values: (A) for the gross cash flow can be obtained from either Table 160, created via Box 2070, or Table 350, created via Box 3720, depending upon the election made in Box 2090; for the (B) respective real securities classes can be obtained from Table(s) 255 and 263 (etc.), if any, created via Boxes 3010 and 3040; for the (C) respective Accrual Rights classes can be obtained from Table(s) 238 and 246 (etc.), if any, created via Boxes 2910 and 2940; (D) nominal rate securities class(es), if any, from Table 269, created via Box 3150; (E) from the reserve, or insurance, rate obtained from Table 147 (created via Box 1860), multiplied times the outstanding primary asset pool balance from Table 160, created via Box 2070; for the (F) loan servicing by multiplying the loan servicing rate obtained from Table 147 (created via Box 1860) times the outstanding principal balance of the primary asset pool obtained from Table 160, created via Box 2070; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 277 as an example.
Box 3170: Initiate the record to establish the “Currency ($) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual cash flow distributed to the residual class of issued securities.

The numerical values: (A) for the gross cash flow can be obtained from either Table 161, created via Box 2080, or Table 351, created via Box 3730, depending upon the election made in Box 2090; for the (B) respective real securities classes can be obtained from Table(s) 256 and 264 (etc.), if any, created via Boxes 3020 and 3100; for the (C) respective Accrual Rights classes can be obtained from Table(s) 239 and 247 (etc.), if any, created via Boxes 2920 and 2940; (D) nominal rate securities class(es), if any, from Table 269, created via Box 3150; (E) from the reserve, or insurance, rate obtained from Table 147 (created via Box 1860), multiplied times the outstanding primary asset pool balance from Table 161, created via Box 2080; for the (F) loan servicing by multiplying the loan servicing rate obtained from Table 147 (created via Box 1860) times the outstanding principal balance of the primary asset pool obtained from Table 161, created via Box 2080; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 278 as an example.
Box 3180: Initiate the record to establish the “Master Real Currency (MR$) RABS Program with Stripped Accrual Rights Cash Flow Statement.”

As an example, input the appropriate title, labels and monetary phase symbols. Then establish columns for (1) the time period by month, quarter or year, as desired, (2) each real securities class issued, (3) each Accrual Rights class stripped, (4) any nominal rate securities classes issued, (4) any reserves or insurance, (5) loan servicing, (6) each additional expense category, or combination thereof, and (7) the residual cash flow distributed to the residual class of issued securities.

The numerical values: (A) for the gross cash flow can be obtained from either Table 158, created via Box 2050, or Table 352, created via Box 3740, depending upon the election made in Box 2090; for the (B) respective real securities classes can be obtained from Table(s) 257 and 265 (etc.), if any, created via Boxes 3030 and 3110; for the (C) respective Accrual Rights classes can be obtained from Table(s) 240 and 248 (etc.), if any, created via Boxes 2930 and 2940; (D) nominal rate securities class(es), if any, from Table 271, created via Box 3100; (E) from the reserve, or insurance, rate obtained from Table 147 (created via Box 1860), multiplied times the outstanding primary asset pool balance from Table 158, created via Box 2050; for the (F) loan servicing by multiplying the loan servicing rate obtained from Table 147 (created via Box 1860) times the outstanding principal balance of the primary asset pool obtained from Table 158, created via Box 2050; for (G) each additional expense category by multiplying the respective rates in Table 147, created via Box 1860, times the appropriate principal balance and totaling, or by totaling the actual billings received, as the case may be. Finally, the residual class flow for the residual class of securities can be determined by subtracting the total numerical values for (B), (C), (D), (E), (F) and (G) from the numerical value for (A).

For reasons discussed earlier, the residual cash flow may be negative, which means that either the sponsor must fund the negative cash flow, or the “distribution rule” should be agreed to in advance by the issued securities holders. By agreeing to the distribution rule, the principal paid in each payment period for each class of real securities will be equal to: (i) each individual classes proportionate percentage of the total investment pool (not including the issuance of any nominal rate securities), times (ii) the principal paid by the qualified asset pool. This creates a wash situation, that will eliminate any negative cash flow in the residual cash flow category; unless such negative cash flows are caused by loan defaults. Negative cash flows caused by loan defaults will begin to minimize or limit the distributions to the securities holders in inverse relation to their seniority in the payment structure.

See Table 279 as an example.
Box 3190: Initiate the record to establish the “Real Currency (R$) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 159, created via Box 2060, or Table 349, created via Box 3710, depending upon the election made in Box 2090; for the (B) interest distributions to the respective real issued securities classes can be obtained from Table(s) 254 and 262 (etc.), if any, created via Boxes 3000 and 3040; for the (C) interest distributions to the respective Accrual Rights classes can be obtained from Table(s) 237 and 245 (etc.), if any, created via Boxes 2900 and 2940; for the (D) interest distributions to the nominal rate securities class(es), if any, from Table 270, created via Box 3090; from the reserve, or insurance, rate obtained from Table 147 (created via Box 1860), multiplied times the outstanding primary asset pool balance from Table 159, created via Box 2060; for the (E) distributions for the loan servicing by multiplying the loan servicing rate obtained from Table 147 (created via Box 1860) times the outstanding principal balance of the primary asset pool obtained from Table 159, created via Box 2060; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 280 as an example.
Box 3200: Initiate the record to establish the “Nominal Currency (N$) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 160, created via Box 2070, or Table 350, created via Box 3720, depending upon the election made in Box 2090; for the (B) interest distributions to the respective real securities classes can be obtained from Table(s) 260 and 263 (etc.), if any, created via Boxes 3010 and 3040; for the (c) interest distributions to the respective Accrual Rights classes can be obtained from Table(s) 238 and 246 (etc.), if any, created via Boxes 2910 and 2940; for the (D) interest distributions to the nominal rate securities class(es), if any, from Table 269, created via Box 3080; from the reserve, or insurance, rate obtained from Table 147 (created via Box 1860), multiplied times the outstanding primary asset pool balance from Table 160, created via Box 2070; for the (E) distributions for the loan servicing by multiplying the loan servicing rate obtained from Table 147 (created via Box 1860) times the outstanding principal balance of the primary asset pool obtained from Table 160, created via Box 2070; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 281 as an example.
Box 3210: Initiate the record to establish the “Currency ($) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 161, created via Box 2080, or Table 351, created via Box 3730, depending upon the election made in Box 2090; for the (B) interest distributions to the respective real securities classes can be obtained from Table(s) 256 and 264 (etc.), if any, created via Boxes 3020 and 3040; for the (c) interest distributions to the respective Accrual Rights classes can be obtained from Table(s) 239 and 247 (etc.), if any, created via Boxes 2920 and 2940; for the (D) interest distributions to the nominal rate securities class(es), if any, from Table 269, created via Box 3080; from the reserve, or insurance, rate obtained from Table 147 (created via Box 1860), multiplied times the outstanding primary asset pool balance from Table 161, created via Box 2080; for the (E) distributions for the loan servicing by multiplying the loan servicing rate obtained from Table 147 (created via Box 1860) times the outstanding principal balance of the primary asset pool obtained from Table 161, created via Box 2080; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 282 as an example.
Box 3220: Initiate the record to establish the “Master Real Currency (MR$) RABS Program with Stripped Accrual Rights Income Statement.”

As an example, input the appropriate title, labels and monetary phase symbols. Then establish columns for (1) the time period by month, quarter or year, as desired and (2) the qualified asset pool's total income; then establish columns for the disbursements, which will include: (3) the interest distributed to the real securities holders by class, (4) the interest distributed to the Accrual Rights holders by class, (5) the interest distributed to nominal rate securities by class, if any, (6) the distributions to any securities reserve or insurance premiums, (7) the distributions for loan servicing and (8) the distributions for any remaining expense categories, either individually or cumulatively. Then establish a column for the (9) residual cash flow to be distributed to the residual, or owner's, securities.

The numerical values: (A) for the qualified asset pool's total income can be obtained from either Table 158, created via Box 2050, or Table 352, created via Box 3740, depending upon the election made in Box 2090; for the (B) interest distributions to the respective real securities classes can be obtained from Table(s) 257 and 265 (etc.), if any, created via Boxes 3030 and 3040; for the (c) interest distributions to the respective Accrual Rights classes can be obtained from Table(s) 240 and 248 (etc.), if any, created via Boxes 2930 and 2940; for the (D) interest distributions to the nominal rate securities class(es), if any, from Table 271, created via Box 3100; from the reserve, or insurance, rate obtained from Table 147 (created via Box 1860), multiplied times the outstanding primary asset pool balance from Table 158, created via Box 2050; for the (E) distributions for the loan servicing by multiplying the loan servicing rate obtained from Table 147 (created via Box 1860) times the outstanding principal balance of the primary asset pool obtained from Table 158, created via Box 2050; for (F) each additional expense category by multiplying the respective rates in Table 147, created via Box 1860, times the appropriate principal balance and totaling, or by totaling the actual billings received, as the case may be. Finally, the distribution to the residual class of securities can be determined by subtracting the total for (B), (C), (D), (E) and (F) from the value for (A).

Finally, please note that while the residual cash flow distributed on the income statement is negative for a few years, that the total over the term of the qualified asset pool's life is positive. It is not unusual for large financial institutions to fund the negative cash flows in the early years with respect to the cash flow statements in order to earn profits in the longer run by doing so. If the distribution rule is adopted, these profits will be forfeited; but the institution will not have to fund the negative cash flows.

See Table 283 as an example.
Box 3230: Initiate the record to establish the “Real Currency (R$) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 159, created via Box 2060, or Table 349, created via Box 3710, depending upon the election made in Box 2090; (B) for the reserve set-asides by adding the total reserves distributed to the Trustee through the current payment period, less any distributions made from the reserve fund, which can be obtained from Table 280, created via Box 3190; (C) for the various issued securities classes from Table 254 and Table 262, if any, created respectively via Box 3000 and Box 3040; (D) for the Accrual Rights classes from Tables 237 and 245, created via Boxes 2900 and 2950 and (E) for the nominal rate Class “X” securities, if any, from Table 183, created via Box 2340, if any. By definition, (F) the value for the residual, or the owner's, class of liabilities is the total assets from (4) above, less the total of (C), (D) and (E). The formulas for the total assets, and total liabilities, are shown in the paragraph above.

See Table 284 as an example.
Box 3240: Initiate the record to establish the “Nominal Currency (N$) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 160, created via Box 2070, or Table 350, created via Box 3720, depending upon the election made in Box 2090; (B) for the reserve set-asides by adding the total reserves distributed to the Trustee through the current payment period, less any distributions made from the reserve fund, which can be obtained from Table 281, created via Box 3200; (C) for the various issued securities classes from Table 255 and Table 263, if any, created respectively via Box 3010 and Box 3040; (D) for the Accrual Rights classes from Tables 238 and 246, created via Boxes 2910 and 2940 and (E) for the nominal rate Class “X” securities, if any, from Table 269, created via Box 3080, if any. By definition, (F) the value for the residual, or the owner's, class of liabilities is the total assets from (4) above, less the total of (C), (D) and (E). The formulas for the total assets, and total liabilities, are shown in the paragraph above.

See Table 285 as an example.
Box 3250: Initiate the record to establish the “Currency ($) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 161, created via Box 2080, or Table 351, created via Box 3730, depending upon the election made in Box 2090; (B) for t he reserve set-asides by adding the total reserves distributed to the Trustee through the current payment period, less any distributions made from the reserve fund, which can be obtained from Table 282, created via Box 3210; (C) for the various issued securities classes from Table 256 and Table 264, if any, created respectively via Box 3020 and Box 3040; (D) for the Accrual Rights classes from Tables 239 and 247, created via Boxes 2920 and 2940 and (E) for the nominal rate Class “X” securities, if any, from Table 269, created via Box 3080, if any. By definition, (F) the value for the residual, or the owner's, class of liabilities is the total assets from (4) above, less the total of (C), (D) and (E). The formulas for the total assets, and total liabilities, are shown in the paragraph above.

See Table 286 as an example.
Box 3260: Initiate the record to establish the “Master Real Currency (MR$) RABS Program with Stripped Accrual Rights Balance Sheet.”

As an example, input the appropriate titles, labels and monetary phase symbols. Then, establish a column for (1) the time period by month, quarter or year, as desired. Establish additional columns for the conduit's assets, including (2) the qualified asset pool with the asset classes presented cumulatively or individually and (3) any reserve set-asides that are the property of the conduit until distributed. (It is assumed that the insurance premiums are paid to third parties, such as agencies or insurance companies.) Then, (4) establish a column to total (2) and (3) to ascertain the conduit's total assets. Then establish columns for the conduit's liabilities, which will include (5) the various real securities classes, represented cumulatively or individually, (6) the various Accrual Rights classes, represented cumulatively or individually, (7) the nominal rate Class “X” securities, if any, and (8) the residual, or ownership, securities. Finally, (9) establish a column to total (5), (6), (7) and (8) to ascertain the total liabilities for a given time period. The total assets (4) must equal the total liabilities (9). If this is not the case, then find the errors and correct them.

The numerical values: (A) for the qualified asset pool can be obtained from either Table 158, created via Box 2050, or Table 351, created via Box 3730, depending upon the election made in Box 2090; (B) for the reserve set-asides by adding the total reserves distributed to the Trustee through the current payment period, less any distributions made from the reserve fund, which can be obtained from Table 283, created via Box 3220; (C) for the various issued securities classes from Table 257 and Table 265, if any, created respectively via Box 3030 and Box 3040; (D) for the Accrual Rights classes from Tables 238 and 248, created via Boxes 2930 and 2940 and (E) for the nominal rate Class “X” securities, if any, from Table 271, created via Box 3100, if any. By definition, (F) the value for the residual, or the owner's, class of liabilities is the total assets from (4) above, less the total of (C), (D) and (E). The formulas for the total assets, and total liabilities, are shown in the paragraph above.

See Table 287 as an example.

Process XIX: Reconciling the Pooling Schedules and Financial Statements.
Box 3270: Initiate the record to establish the “Comparative Results for the Conduit's Asset Pool.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then (A) in the first column input Module “H1” (from Table 158, created via Box 2050), or Module “J1” (from Table 352, created via Box 3740), depending upon the election made in Box 2090; in the first row, and (B) Module “M1” (from Table 173, created via Box 2210) in the second row. Then, (C) input the totals from each respective module in the first and second rows respectively. Finally, (D) in each column, subtract the values in row two from the values in row one. The value received from this calculation should equal zero, however there could be a small discrepancy due to rounding error. If this result is not achieved, then a mistake has been made some where. Check this record, along with the respective modules until the result is found and corrected.

Repeat (E) the above paragraph for Modules “H2” (or “J2”) and “M2”, “H3” (or “J3”) and “M3” and “H4” (or “J4”) and “M4” respectively (from Tables 159 (or 349) and 170, 160 (or 350) and 171, and 161 (or 351) and 172, created respectively by Boxes 2060 (or 3710) and 2200, 2070 (or 3720) and 2220, 2080 and 2230.)

Then, (F) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 288 as an example.
Box 3280: Initiate the record to establish the “Comparative Results for the Conduit's Issued Securities.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “Q1” | 188 | 2400 |
| “Y1” | 218 | 2730 |
| “Q2” | 185 | 2360 |
| “Y2” | 217 | 2690 |
| “Q3” | 186 | 2380 |
| “Y3” | 218 | 2710 |
| “Q4” | 187 | 2390 |
| “Y4” | 219 | 2720 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 289 as an example.
Box 3290: Initiate the record to establish the “Comparative Results for the Real Asset-Backed Securities (RABS) Program Cash Flow Statements.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “R1” | 192 | 2240 |
| “Z1” | 224 | 2770 |
| “R2” | 189 | 2410 |
| “Z2” | 221 | 2740 |
| “R3” | 190 | 2420 |
| “Z3” | 222 | 2750 |
| “R4” | 191 | 2430 |
| “Z4” | 223 | 2760 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 290 as an example.
Box 3300: Initiate the record to establish the “Comparative Results for the Real Asset-Backed Securities (RABS) Program Income Statements.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “S1” | 196 | 2480 |
| “AA1” | 228 | 2810 |
| “S2” | 193 | 2450 |
| “AA2” | 224 | 2780 |
| “S3” | 194 | 2460 |
| “AA3” | 226 | 2790 |
| “S4” | 195 | 2470 |
| “AA4” | 227 | 2800 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 291 as an example.
Box 3310: Initiate the record to establish the “Comparative Results for the Real Asset-Backed Securities (RABS) Program Balance Sheets.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “T1” | 200 | 2520 |
| “AB1” | 232 | 2850 |
| “T2” | 197 | 2490 |
| “AB2” | 232 | 2850 |
| “T3” | 198 | 2500 |
| “AB3” | 232 | 2850 |
| “T4” | 199 | 2510 |
| “AB4” | 232 | 2850 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 292 as an example.
Box 3320: Initiate the record to establish the “Comparative Results for the Class “A” Securities, Stripped of Accrued Interest.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “U1” | 204 | 2560 |
| “AI1” | 257 | 3030 |
| “U2” | 203 | 2550 |
| “AI2” | 254 | 3000 |
| “U3” | 201 | 2530 |
| “AI3” | 255 | 3010 |
| “U4” | 202 | 2540 |
| “AI4” | 256 | 3020 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 293 as an example.
Box 3330: Initiate the record to establish the “Comparative Results for the Class “B” Securities, Stripped of Accrued Interest.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “V1” | 208 | 2600 |
| “AK1” | 265 | 3040 |
| “V2” | 207 | 2590 |
| “AK2” | 262 | 3040 |
| “V3” | 205 | 2570 |
| “AK3” | 263 | 3040 |
| “V4” | 206 | 2580 |
| “AK4” | 264 | 3040 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 294 as an example.
Box 3340: Initiate the record to establish the “Comparative Results for the Class “A+” Accrual Rights.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “W1” | 212 | 2640 |
| “AD1” | 240 | 2930 |
| “W2” | 211 | 2630 |
| “AD2” | 237 | 2900 |
| “W3” | 209 | 2610 |
| “AD3” | 238 | 2910 |
| “W4” | 210 | 2620 |
| “AD4” | 239 | 2920 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 295 as an example.
Box 3350: Initiate the record to establish the “Comparative Results for the Class “B+” Accrual Rights.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “X1” | 216 | 2680 |
| “AF1” | 248 | 2940 |
| “X2” | 215 | 2670 |
| “AF2” | 245 | 2940 |
| “X3” | 213 | 2650 |
| “AF3” | 246 | 2940 |
| “X4” | 214 | 2660 |
| “AF4” | 247 | 2940 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 296 as an example.
Box 3360: Initiate the record to establish the “Comparative Results for the Nominal Rate Class “X” Securities, if any.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “P1” | 184 | 2350 |
| “AM1” | 271 | 3100 |
| “P2” | 183 | 2340 |
| “AM2” | 270 | 3090 |
| “P4” | 182 | 2320 |
| “AM4” | 269 | 3080 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 297 as an example.
Box 3370: Initiate the record to establish the “Comparative Results for the (Stripped) Real Asset-Backed Securities (RABS) Program Cash Flow Statements.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “Z1” | 224 | 2770 |
| “AO1” | 279 | 3180 |
| “Z2” | 221 | 2740 |
| “AO2” | 276 | 3150 |
| “Z3” | 222 | 2750 |
| “AO3” | 277 | 3160 |
| “Z4” | 223 | 2760 |
| “AO4” | 278 | 3170 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 298 as an example.
Box 3380: Initiate the record to establish the “Comparative Results for the (Stripped) Real Asset-Backed Securities (RABS) Program Income Statements.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “AA1” | 228 | 2810 |
| “AP1” | 283 | 3220 |
| “AA2” | 225 | 2780 |
| “AP2” | 280 | 3190 |
| “AA3” | 226 | 2790 |
| “AP3” | 281 | 3200 |
| “AA4” | 227 | 2800 |
| “AP4” | 282 | 3210 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 299 as an example.
Box 3390: Initiate the record to establish the “Comparative Results for the (Stripped) Real Asset-Backed Securities (RABS) Program Balance Sheets.”

As an example, input the appropriate titles, labels and monetary phase symbols. Then, establish a column for (1) the comparative modules, (2) the original principal balance, (3) the total payments, (4) the total interest paid, (5) the total principal paid, (6) the ending principal balance, (7) the total current inflationary adjustment (CIA) and (8) the cumulative error.

Then, (A) repeat the processes described in Box 3270 for the following modules, but omit the modules associated with the election in Box 2090:

| Module: | From Table: | Created via Box: |
|---|---|---|
| “AB1” | 232 | 2850 |
| “AQ1” | 287 | 3260 |
| “AB2” | 229 | 2820 |
| “AQ2” | 284 | 3230 |
| “AB3” | 230 | 2830 |
| “AQ3” | 285 | 3240 |
| “AB4” | 231 | 2840 |
| “AQ4” | 286 | 3250 |

Then, (B) total all the subtotals for each set of modules across the columns, and input the result in the cumulative error column. And, total all the subtotals in the columns, and input them in a cumulative error total at the bottom of each columns. Now, the comparative results can be quickly audited by scanning the cumulative error column and row. The value received from this calculation should equal zero, however there could be a small discrepancy due to rounding error. If this result is not achieved, then a mistake has been made some where. Check this record, along with the respective modules until the result is found and corrected.

See Table 300 as an example.

Process XX: Formation of the Initial Defined Marketplace.
Box 3400: Initiate the record to establish the “Marketplace's Record of Effective Nominal Interest Rates for the Class “A” Certificates by the Issuing Conduits.”

As an example, input the appropriate titles, labels and monetary phase symbols. Then, establish a column for (1) the time period by month, quarter or year, as desired. Establish additional columns for the pricing index options, which may include (2) the inflation index number by selected period, and/or (3) a market index rate by selected period, and (4) establish a column for each new conduit created within the defined marketplace. Then, at or near the top of each column for the conduit, provide a space to enter the conduit's fixed margin for the Class “A” certificates.

The numerical values: (A) for the time period should begin with one selected time period prior to the base-line-date of the system, or the initiation date of the defined marketplace; (B) the inflation index numbers can be obtained from Table 306, created via Box 213; (C) the market index rates can be obtained from the market for the instrument comprising the market index rate, such as the U.S. Treasury market in the United States; and finally, (D) the fixed margin for the Class “A” Certificates can be obtained from the issuing conduit as it is entered into the record as shown in Table 147 for Conduit #1, or Table 316 for Conduit #2, each created via Box 1870.

Then, (E) in each column beginning with conduit's first interest-bearing period, enter the proper formula for calculating the effective nominal rate for the Class “A” certificates of each conduit; which is the fixed margin at the top of the column plus the appropriate pricing index rate for each period.

See Table 307 as an example.
Box 3410: Initiate the record to establish the “Marketplace's Record of Effective Nominal Interest Rates for the Class “B,” etc., Certificates, if any, by the Issuing Conduits.”

Repeat the descriptive example for Box 3420, but enter the fixed margin for the Class “B,” etc. Certificates, if any.

See Table 308 as an example.
Box 3420: Initiate the record to establish the “Marketplace's Record of Amortizing Real Rates of Interest Rates for the Class “A” Certificates by the Issuing Conduits.”

As an example, input the appropriate titles, labels and monetary phase symbols. Then, establish a column for (1) the time period by month, quarter or year, as desired. Establish additional columns for (2) the prevailing rate of inflation, and (3) a column for each conduit as it commit to participate in the defined marketplace over time.

The numerical values: (A) for the time period should begin with one selected time period prior to the base-line-date of the system, or the initiation date of the defined marketplace, and (13) the prevailing rate of inflation can be obtained from Table 305, created via Box 211.

Then, (C) in each column beginning with the conduit's first interest-bearing period, enter the formula for the amortizing real rate of interest; which is the effective nominal rate of interest from Table 307, created via Box 3400, less the prevailing rate of interest for each respective period.

See Table 309 as an example.
Box 3430: Initiate the record to establish the “Marketplace's Record of Amortizing Real Rates of Interest Rates for the Class “B,” etc., Certificates, if any, by the Issuing Conduits.”

As an example, input the appropriate titles, labels and monetary phase symbols. Then, establish a column for (1) the time period by month, quarter or year, as desired. Establish additional columns for (2) the prevailing rate of inflation, and (3) a column for each conduit as it commit to participate in the defined marketplace over time.

The numerical values: (A) for the time period should begin with one selected time period prior to the base-line-date of the system, or the initiation date of the defined marketplace, and (B) the prevailing rate of inflation can be obtained from Table 305, created via Box 211.

Then, (C) in each column beginning with the conduit's first interest-bearing period, enter the formula for the amortizing real rate of interest; which is the effective nominal rate of interest from Table 308, created via Box 3410, less the prevailing rate of interest for each respective period.

See Table 310 as an example.
Box 3440: Initiate the record to establish the “Real Asset-Backed Securities (RABS) Class “A+N” (Stripped Accrual Rights) Master Real Currency (MR$) Amortization Schedule(s).”

As an example, input the appropriate title, labels and monetary phase symbols. In particular, the masthead of this schedule should indicate the name or identifying number of the conduit, which is the source of the Accrual Right. Then establish columns for (1) the remaining term, (2) the beginning balance, (3) the amortizing real rate of interest, (4) the payment, (5) the interest paid, (6) the principal paid, (7) the ending principal balance and (8) the current inflationary adjustment (CIA).

The numerical values: (A) for the remaining term comes from Table 233a, created via Box 2860; (B) for the beginning principal balance for the initial period comes from Table 233a, created via Box 2860; and (C) for the amortizing real rate from the schedule for the certificate class from which the Accrual Right was stripped, or Table 309, created via Box 3420 for each respective time period.

Then, (D) any standard amortization schedule can be used along with the values input for (i) the remaining term, (ii) the beginning principal balance and (iii) the real amortizing rate of interest to calculate the payment per period; (E) the interest paid is simply the real rate of interest, divided by the number of payments per year, times the beginning principal balance; (F) the principal paid is the payment less the interest paid for each respective period; (G) the ending principal balance is the beginning principal balance less the principal paid for each respective payment period; and (H) the beginning principal balance in the second and subsequent payment periods is simply the ending principal balance from the prior payment period. Finally, (I) the current inflationary adjustment is the prevailing rate of inflation, divided by the number of payment periods per year, times the principal paid in each respective payment period. The prevailing rate of inflation can be obtained Table 305, created via Box 211. In addition, (J) total the columns for the payment, interest paid, principal paid and the current inflationary adjustment.

If the amortization schedule is projected for the full term, then the ending principal balance in the final payment period should be zero and the total in the principal paid column must equal the beginning principal balance in the first payment period. If this is not the case, then correct the mistakes.

See Table 323a1 as an example.
Box 3450: Initiate the record to establish the “Real Asset-Backed Securities (RABS) Class “A+” (Stripped Accrual Rights) Master Real Currency (MR$) Pooling Schedule.”

As an example, input the appropriate titles, labels and monetary phase symbols. In particular, the masthead of this schedule should indicate the name or identifying number of the conduit, which is the source of the Accrual Right. Then, establish a column for (1) the time period by month, quarter or year, as desired. Establish additional columns for (2) the beginning balance, (3) the amortizing real rate of interest, if desired, (4) the payment, (5) the interest paid, (6) the principal paid, (7) the ending principal balance and (8) the current inflationary adjustment (CIA).

Then (A) input the appropriate formulas that will total the respective values for (2), (4), (5), (6), (7) and (8) in each row and column for each respective payment period from Table 323a1, etc., created via Box 3440. And if desired, (B) compute the real rate of interest for each period; which is the interest paid, divided by the beginning principal balance, times the number of payments per year. Finally, total columns (2), (4), (5), (6), (7) and (8).

If the amortization schedule(s) being totaled are projected for the full term, then the ending principal balance in the final payment period should be zero and the total in the principal paid column must equal the beginning principal balance in the first payment period. If this is not the case, then correct the mistakes

See Table 324a as an example.
Box 3460: Initiate the record to establish the “Real Asset-Backed Securities (RABS) Class “B+N,” etc., (Stripped Accrual Rights) Master Real Currency (MR$) Amortization Schedule(s), if any.”

As an example, input the appropriate title, labels and monetary phase symbols. In particular, the masthead of this schedule should indicate the name or identifying number of the conduit, which is the source of the Accrual Right. Then establish columns for (1) the remaining term, (2) the beginning balance, (3) the amortizing real rate of interest, (4) the payment, (5) the interest paid, (6) the principal paid, (7) the ending principal balance and (8) the current inflationary adjustment (CIA).

The numerical values: (A) for the remaining term comes from Table 241a, created via Box 2940; (B) for the beginning principal balance for the initial period comes from Table 241a, created via Box 2940; and (C) for the amortizing real rate from the schedule for the certificate class from which the Accrual Right was stripped, or Table 309, created via Box 3420 for each respective time period.

Then, (D) any standard amortization schedule can be used along with the values input for (i) the remaining term, (ii) the beginning principal balance and (iii) the real amortizing rate of interest to calculate the payment per period; (E) the interest paid is simply the real rate of interest, divided by the number of payments per year, times the beginning principal balance; (F) the principal paid is the payment less the interest paid for each respective period; (G) the ending principal balance is the beginning principal balance less the principal paid for each respective payment period; and (H) the beginning principal balance in the second and subsequent payment periods is simply the ending principal balance from the prior payment period. Finally, (I) the current inflationary adjustment is the prevailing rate of inflation, divided by the number of payment periods per year, times the principal paid in each respective payment period. The prevailing rate of inflation can be obtained Table 305, created via Box 211. In addition, (J) total the columns for the payment, interest paid, principal paid and the current inflationary adjustment.

If the amortization schedule is projected for the full term, then the ending principal balance in the final payment period should be zero and the total in the principal paid column must equal the beginning principal balance in the first payment period. If this is not the case, then correct the mistakes.

See Table 325 as an example.
Box 3470: Initiate the record to establish the “Real Asset-Backed Securities (RABS) Class “B+.” etc., (Stripped Accrual Rights) Master Real Currency (MR$) Pooling Schedule, if any.”

As an example, input the appropriate titles, labels and monetary phase symbols. In particular, the masthead of this schedule should indicate the name or identifying number of the conduit, which is the source of the Accrual Right. Then, establish a column for (1) the time period by month, quarter or year, as desired. Establish additional columns for (2) the beginning balance, (3) the amortizing real rate of interest, if desired, (4) the payment, (5) the interest paid, (6) the principal paid, (7) the ending principal balance and (8) the current inflationary adjustment (CIA).

Then (A) input the appropriate formulas that will total the respective values for (2), (4), (5), (6), (7) and (8) in each row and column for each respective payment period from Table(s) 325, etc., created via Box 3460. And if desired, (B) compute the real rate of interest for each period; which is the interest paid, divided by the beginning principal balance, times the number of payments per year. Finally, total columns (2), (4), (5), (6), (7) and (8).

If the amortization schedule(s) being totaled are projected for the full term, then the ending principal balance in the final payment period should be zero and the total in the principal paid column must equal the beginning principal balance in the first payment period. If this is not the case, then correct the mistakes

See Table 326 as an example.
Box 3480: Initiate the record to establish the “Master Real Currency Reporting Schedule for the Accrual Rights.”

The purpose of this schedule is to total the amortization schedules for the Accrual Rights that have been stripped by participating conduits from their issued securities and offered for sale through the defined marketplace for a given payment period. For simplicity our examples combines the Class “A+” and Class “B+” Accrual Rights, but they can be pooled separately for resale. Once again, for simplicity our example assumes that the pooled Accrual Rights are sold to one purchaser, specifically the next conduit to be formed. In reality, the Accrual Rights may be resold individually, or the auction pool may be distributed to a number of bidding conduits. (See Box 3490 below.) In either event, the defined marketplace serves as the focal point for collection and reporting of the distributions on the Accrual Rights, thereby creating an orderly market.

In effect, this schedule will be used to act as the intermediary to collect the distributions from the conduits that have stripped and resold their Accrual Rights over time, and then to redistribute them in the proper proportion and along with the proper reports to the purchasing conduits. This will be shown as the development of the second conduit is completed.

As an example, input the appropriate titles, labels and monetary phase symbols. In particular, the masthead of this schedule should indicate the name or identifying number of the auction pool, or whether the Accrual Rights were resold individually. Then, establish a column for (1) the time period by month, quarter or year, as desired. Establish additional columns for (2) the beginning balance, (3) the amortizing real rate of interest, if desired, (4) the payment, (5) the interest paid, (6) the principal paid, (7) the ending principal balance and (8) the current inflationary adjustment (CIA).

Then (A) input the appropriate formulas that will total the respective values for (2), (4), (5), (6), (7) and (8) in each row and column for each respective payment period from Table(s) 324 and 326; created via Boxes 3450 and 3470. This assumes the Class “A+” and “B+” Accrual Rights are to be pooled and auction together, or the respective Accrual Rights classes may be totaled and auctioned separately. And if desired, (B) compute the real rate of interest for each period; which is the interest paid, divided by the beginning principal balance, times the number of payments per year. Finally, total columns (2), (4), (5), (6), (7) and (8).

If the amortization schedule(s) being totaled are projected for the full term, then the ending principal balance in the final payment period should be zero and the total in the principal paid column must equal the beginning principal balance in the first payment period. If this is not the case, then correct the mistakes

See Table 327 as an example.
Box 3490: Initiate the record to establish the “Purchasing Conduits' Periodic Ownership of the Stripped Accrual Rights.”

For the sake of simplicity, we are assuming in our example that the Accrual Rights are pooled for each payment period and then auctioned off to the next conduit to be initiated in the defined marketplace. In reality, it will be necessary to maintain a record of the owners of the resold Accrual Rights, which may be purchased whole or may be sold as part of an auction pool with fractional owners. A similar record was created in Table 249, created via Box 2950, for the initial conduit.
Box 3500: Optional: Initiate the record to establish the “Cumulative Master Real Currency (MR$) Stripped Accrual rights Pooling Schedule.”

It should be recognized that the schedule, created via Box 3480, and represented by Table 327; will have to be created for each payment period, or collection of payment periods, from which the resale will be offered. As such, the schedule created herein is simply the total of all of the schedules created over time via Box 3480, which will effectively allow everyone to see the total volume of Accrual Rights business being administered by the defined marketplace for each respective period. Certainly, this schedule may be the cumulative total of individual schedules created for each of the respective Accrual Rights classes, assuming they are not pooled and sold together in some fashion.

See Table 328 as an example.

Process XXI: Initiating the Second Conduit.
Box 3510: For the preformation of the second conduit, repeat Boxes 220 to 320.

Perform the tasks as described in the Box description above.

See Table 311a-g as an example.
Box 3520: For initiating charts for inputting values for financial projections for marketing presentations and stress tests for the primary assets to be purchased, repeat Boxes 330 to 1010.

Perform the tasks as described in the Box description above.
Box 3530: For initiating charts for inputting values for credit enhancement, securities pricing and securitization structuring, repeat Boxes 1020 to 1330.

Perform the tasks as described in the Box description above.
Box 3540: For initiating the origination of the real financial instruments, representing the primary assets, to be securitized by the conduit; repeat Boxes 1660 to 1810.

Perform the tasks as described in the Box description above.
Box 3550: For initiating the origination of the real financial instruments, representing the primary assets, to be securitized by the conduit, repeat Boxes 1660 to 1810.

Perform the tasks as described in the Box description above.
Box 3560: For the formation of the conduit, repeat Boxes 1820 to 1880.

Perform the tasks as described in the Box description above.

See Tables 312 to 322 as examples.
Box 3570: For quantifying and pooling the primary assets to be securitized by the conduit leading up to the start-up day, repeat Boxes 1890 to 2110.

Perform the tasks as described in the Box description above.

See Tables 329a, etc. to 336 as examples.

Process XXII: Commencing the Marketplace for the Real Asset-Backed Securities (RABS) and the Accrual Rights, Representing the Secondary Assets.
Box 3580: Initiate the record to establish the “Master Real Currency (MR$) Recasting Table for the Real Asset-Backed Securities (RABS) Investment Instrument(s) Purchased by the Conduit, if any.”

As an example, input the appropriate title, labels and monetary phase symbols. Then establish columns for (1) the period and/or the remaining term, (2) the beginning principal balance, (3) the payment, (4) the interest paid, (5) the principal paid, (6) the ending principal balance, (7) the current inflationary adjustment (CIA) and (8) the master inflationary adjustment factor (MIAF) constant.

The numerical values: (A) the year and/or the remaining term, (B) the beginning principal balance for the first period, (C) the payment per period, (D) the principal paid per period and (E) the current inflationary adjustment per period; are all obtained from the selling conduit (i.e. Conduit #1 in this example) from Table 253a, created via Box 2990.

In addition, (F) to properly show that the beginning principal, or presumed purchase price, has been repaid in full; we have added the proceeds from the sale of the Accrual Rights (also from Table 253a, created via Box 2990) for each period to the (i) payment and (ii) to the principal paid. This makes this a recasting table for the real asset-backed (RABS) security purchased by the current conduit from the prior conduit. The (G) interest paid is then the payment less the principal paid foe each period; the (H) ending principal balance is the beginning principal balance less the principal paid; and (I) the beginning principal balance in subsequent periods is the ending principal balance from the prior period. The (J) the MIAF Constant was obtained from Table 314, created via Box 2020 (repeated for the current conduit). Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 337 as an example.
Box 3590: Initiate the record to establish the “Real Currency Conversion (R$) Table for the Real Asset-Backed Securities (RABS) Investment Instrument(s) Purchased by the Conduit, if any.”

As an example, input the appropriate title, labels and monetary phase symbols. Then establish columns for (1) the period and/or the remaining term, (2) the beginning principal balance, (3) the payment, (4) the interest paid, (5) the principal paid, (6) the ending principal balance, (7) the current inflationary adjustment (CIA) and (8) the master inflationary adjustment factor (MIAF) constant.

The numerical values: (A) the year and/or the remaining term can be copied from Table 337, created via Box 3580; then (B) the beginning principal balance, (C) the payment per period, (D) the interest paid per period, (E) the principal paid per period, (E) the ending principal balance and (F) the current inflationary adjustment per period; are all obtained from multiplying the respective values in Table 337, created via Box 3580, times the MIAF Constant. Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 338 as an example.
Box 3600: Initiate the record to establish the “Nominal Currency (N$) Conversion Table for the Asset-Backed Securities (RABS) Investment Instrument(s) Purchased by the Conduit, if any.”

As an example, input the appropriate title, labels and monetary phase symbols. Then establish columns for (1) the period and/or the remaining term, (2) the inflationary adjustment factor (IAF), (3) the beginning principal balance, (4) the payment, (5) the interest paid, (6) the principal paid, (7) the ending principal balance and (8) the current inflationary adjustment (CIA).

The numerical values: (A) the year and/or the remaining term can be copied from Table 338, created via Box 3590; the (B) inflationary adjustment factor by period can be obtained from Table 314, created via Box 2020 (repeated for the current conduit); then (C) the beginning principal balance, (D) the payment per period, (E) the interest paid per period, (F) the principal paid per period, (G) the ending principal balance and (H) the current inflationary adjustment per period; are all obtained from multiplying the respective values in Table 337, created via Box 3580, times the respective IAF by period.

If the amortization schedule is projected for the full term, then the ending principal balance in the final payment period should be zero, but if any inflation or deflation has occurred then the total in the principal paid column will not equal the beginning principal balance in the first payment period.

See Table 339 as an example.
Box 3610: Initiate the record to establish the “Currency ($) Recasting Table for the Real Asset-Backed Securities (RABS) Investment Instrument(s) Purchased by the Conduit, if any.”

As an example, input the appropriate title, labels and monetary phase symbols. Then establish columns for (1) the period and/or the remaining term, (2) the beginning principal balance, (3) the payment, (4) the interest paid, (5) the principal paid, (6) the ending principal balance and (7) the current inflationary adjustment (CIA).

The numerical values: (A) the year and/or the remaining term can be copied from Table 339, created via Box 3600; then (B) the beginning principal balance for the first period, (C) the payment per period and (D) the current inflationary adjustment per period are all copied from their respective positions from Table 339, created via Box 3600; and the (E) principal paid per period is copied from the respective position from Table 338, created via Box 3590.

Then formulas should be input to calculate: the (F) interest paid per period, which is the payment less the principal paid per period; the (G) ending principal balance, which is the beginning principal balance less the principal paid each period; and (I) the beginning principal balance for the second and subsequent periods, which is the ending principal balance from the prior period.

If the amortization schedule is projected for the full term, then the ending principal balance in the final payment period should be zero and the total in the principal paid column must equal the beginning principal balance in the first payment period. If this is not the case, then correct the mistakes.

See Table 340 as an example.
Box 3620: Repeat Boxes 3580 to 3610 for each Real Asset-Backed Securities (RABS) Investment Instrument Purchased by the Conduit, if any.

Perform the tasks as described in the Box description above.
Box 3630: Initiate the record to establish the “Real Currency (R$) Pooling Schedule for the Real Asset-Backed Securities (RABS) Investment Instrument(s) Purchased by the Conduit, if any.”

As an example, input the appropriate title, labels and monetary phase symbols. Then establish columns for (1) the period and/or remaining term, (2) the beginning balance, (3) the amortizing real rate of interest, if desired (4) the payment, (5) the interest paid, (6) the principal paid, (7) the ending principal balance and (8) the current inflationary adjustment (CIA).

The numerical values: (A) the year and/or the remaining term can be copied from Table 338, created via Box 3590; then the respective values for columns (2) through (8) are the cumulative respective values from Table 338, created via Box 3590, and all of the additional Tables (i.e. schedules) created via Box 3620 in the real currency (R$) phase. Finally, total columns (4), (5), (6) and (8).

If the amortization schedule is projected for the full term, then the ending principal balance in the final payment period should be zero and the total in the principal paid column must equal the beginning principal balance in the first payment period. If this is not the case, then correct the mistakes.

See Table 341 as an example.
Box 3640: Initiate the record to establish the “Nominal Currency (N$) Pooling Schedule for the Real Asset-Backed Securities (RABS) Investment Instrument(s) Purchased by the Conduit, if any.”

As an example, input the appropriate title, labels and monetary phase symbols. Then establish columns for (1) the period and/or remaining term, (2) the beginning balance, (3) the payment, (4) the interest paid, (5) the principal paid, (6) the ending principal balance and (7) the current inflationary adjustment (CIA).

The numerical values: (A) the year and/or the remaining term can be copied from Table 339, created via Box 3600; then the respective values for columns (2) through (7) are the cumulative respective values from Table 339, created via Box 3600, and all of the additional Tables (i.e. schedules) created via Box 3620 in the nominal currency (N$) phase. Finally, total columns (3) (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 342 as an example.
Box 3650: Initiate the record to establish the “Currency Pooling Schedule for the Real Asset-Backed Securities (RABS) Investment Instrument(s) Purchased by the Conduit, if any.”

As an example, input the appropriate title, labels and monetary phase symbols. Then establish columns for (1) the period and/or remaining term, (2) the beginning balance, (3) the payment, (4) the interest paid, (5) the principal paid, (6) the ending principal balance and (7) the current inflationary adjustment (CIA).

The numerical values: (A) the year and/or the remaining term can be copied from Table 340, created via Box 3610; then the respective values for columns (2) through (7) are the cumulative respective values from Table 340, created via Box 3610, and all of the additional Tables (i.e. schedules) created via Box 3620 in the currency ($) phase. Finally, total columns (3) (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 343 as an example.
Box 3660: Initiate the record to establish the “Master Real Currency (MR$) Pooling Schedule for the Real Asset-Backed Securities (RABS) Investment Instrument(s) Purchased by the Conduit, if any.”

As an example, input the appropriate title, labels and monetary phase symbols. Then establish columns for (1) the period and/or remaining term, (2) the beginning balance, (3) the payment, (4) the interest paid, (5) the principal paid, (6) the ending principal balance and (7) the current inflationary adjustment (CIA).

The numerical values: (A) the year and/or the remaining term can be copied from Table 337, created via Box 3580; then the respective values for columns (2) through (7) are the cumulative respective values from Table 337, created via Box 3580, and all of the additional Tables (i.e. schedules) created via Box 3620 in the master real currency (MR$) phase. Finally, total columns (3) (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 344 as an example.
Box 3670: Initiate the record to establish the “Master Real Currency (MR$) Reporting Schedule for the Accrual Rights Purchased by the Conduit.”

As an example, input the appropriate title, labels and monetary phase symbols. Then establish columns for (1) the period and/or the remaining term, (2) the beginning principal balance, (3) the payment, (4) the interest paid, (5) the principal paid, (6) the ending principal balance, (7) the current inflationary adjustment (CIA) and (8) the master inflationary adjustment factor (MIAF) constant.

The numerical values: (A) the year and/or the remaining term can be copied from Table 327, created via Box 3480; then (B) the values for columns (2) through (7) may be copied from the respective values in Table 327, created via Box 3480. The MIAF Constant is from Table 314, created via Box 2020 (repeated for the current conduit). Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 345 as an example.
Box 3680: Initiate the record to establish the “Real Currency (R$) Reporting Schedule for the Accrual Rights Purchased by the Conduit.”

As an example, input the appropriate title, labels and monetary phase symbols. Then establish columns for (1) the period and/or the remaining term, (2) the beginning principal balance, (3) the payment, (4) the interest paid, (5) the principal paid, (6) the ending principal balance and (7) the current inflationary adjustment (CIA).

The numerical values: (A) the year and/or the remaining term can be copied from Table 345, created via Box 3670; then (B) the beginning principal balance, (C) the payment per period, (D) the interest paid per period, (E) the principal paid per period, (E) the ending principal balance and (F) the current inflationary adjustment per period; are all obtained from multiplying the respective values in Table 345, created via Box 3670, times the MIAF Constant. Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 346 as an example.
Box 3690: Initiate the record to establish the “Nominal Currency (N$) Reporting Schedule for the Accrual Rights Purchased by the Conduit.”

As an example, input the appropriate title, labels and monetary phase symbols. Then establish columns for (1) the period and/or the remaining term, (2) the inflationary adjustment factor (IAF), (3) the beginning principal balance, (4) the payment, (5) the interest paid, (6) the principal paid, (7) the ending principal balance and (8) the current inflationary adjustment (CIA).

The numerical values: (A) the year and/or the remaining term can be copied from Table 346, created via Box 3680; the (B) inflationary adjustment factor by period can be obtained from Table 314, created via Box 2020 (repeated for the current conduit); then (C) the beginning principal balance, (D) the payment per period, (E) the interest paid per period, (F) the principal paid per period, (G) the ending principal balance and (H) the current inflationary adjustment per period; are all obtained from multiplying the respective values in Table 346, created via Box 3680, times the respective IAF by period.

If the amortization schedule is projected for the full term, then the ending principal balance in the final payment period should be zero, but if any inflation or deflation has occurred then the total in the principal paid column will not equal the beginning principal balance in the first payment period.

See Table 347 as an example.
Box 3700: Initiate the record to establish the “Currency ($) Reporting Schedule for the Accrual Rights Purchased by the Conduit.”

As an example, input the appropriate title, labels and monetary phase symbols. Then establish columns for (1) the period and/or the remaining term, (2) the beginning principal balance, (3) the payment, (4) the interest paid, (5) the principal paid, (6) the ending principal balance and (7) the current inflationary adjustment (CIA).

The numerical values: (A) the year and/or the remaining term can be copied from Table 347, created via Box 3690; then (B) the beginning principal balance for the first period, (C) the payment per period and (D) the current inflationary adjustment per period are all copied from their respective positions from Table 347, created via Box 3690; and the (E) principal paid per period is copied from the respective position from Table 346, created via Box 3680.

Then formulas should be input to calculate: the (F) interest paid per period, which is the payment less the principal paid per period; the (G) ending principal balance, which is the beginning principal balance less the principal paid each period; and (I) the beginning principal balance for the second and subsequent periods, which is the ending principal balance from the prior period.

If the amortization schedule is projected for the full term, then the ending principal balance in the final payment period should be zero and the total in the principal paid column must equal the beginning principal balance in the first payment period. If this is not the case, then correct the mistakes.

See Table 348 as an example.

Process XXIII: Completing the Second Conduit.
Box 3710: Initiate the record to establish the “Real Currency (R$) Pooling Schedule for the Qualified Asset Pool.”

As an example, input the appropriate title, labels and monetary phase symbols. Then establish columns for (1) the period and/or remaining term, (2) the beginning balance, (3) the amortizing real rate of interest, if desired (4) the payment, (5) the interest paid, (6) the principal paid, (7) the ending principal balance and (8) the current inflationary adjustment (CIA).

The numerical values: (A) the year and/or the remaining term can be copied from Table 346, created via Box 3680; then the respective values for columns (2) through (8) are the cumulative respective values from Table 333, 341 and 346, created via Boxes 2060 (repeated for the current conduit), 3630 and 3680. Finally, total columns (4), (5), (6) and (8).

If the amortization schedule is projected for the full term, then the ending principal balance in the final payment period should be zero and the total in the principal paid column must equal the beginning principal balance in the first payment period. If this is not the case, then correct the mistakes.

See Table 349 as an example.
Box 3720: Initiate the record to establish the “Nominal Currency (N$) Pooling Schedule for the Qualified Asset Pool.”

As an example, input the appropriate title, labels and monetary phase symbols. Then establish columns for (1) the period and/or remaining term, (2) the beginning balance, (3) the payment, (4) the interest paid, (5) the principal paid, (6) the ending principal balance and (7) the current inflationary adjustment (CIA).

The numerical values: (A) the year and/or the remaining term can be copied from Table 347, created via Box 3690; then the respective values for columns (2) through (7) are the cumulative respective values from Tables 334, 342 and 347, created via Boxes 2070 (repeated for the current conduit), 3640 and 3690. Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 350 as an example.
Box 3730: Initiate the record to establish the “Currency ($) Pooling Schedule for the Qualified Asset Pool.”

As an example, input the appropriate title, labels and monetary phase symbols. Then establish columns for (1) the period and/or remaining term, (2) the beginning balance, (3) the payment, (4) the interest paid, (5) the principal paid, (6) the ending principal balance and (7) the current inflationary adjustment (CIA).

The numerical values: (A) the year and/or the remaining term can be copied from Table 348, created via Box 3700; then the respective values for columns (2) through (7) are the cumulative respective values from Table 335, 343 and 348, created via Boxes 2080 (repeated for the current conduit), 3650 and 3700. Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 351 as an example.
Box 3740: Initiate the record to establish the “Master Real Currency (MR$) Pooling Schedule for the Qualified Asset Pool.”

As an example, input the appropriate title, labels and monetary phase symbols. Then establish columns for (1) the period and/or remaining term, (2) the beginning balance, (3) the payment, (4) the interest paid, (5) the principal paid, (6) the ending principal balance and (7) the current inflationary adjustment (CIA).

The numerical values: (A) the year and/or the remaining term can be copied from Table 345, created via Box 3670; then the respective values for columns (2) through (7) are the cumulative respective values from Table 336, 344 and 345, created via Boxes 2090 (repeated for the current conduit), 3660 and 3670. Finally, total columns (3), (4), (5) and (7).

If the amortization schedule is projected for the full term, then the ending principal balance in the final payment period should be zero and the total in the principal paid column must equal the beginning principal balance in the first payment period. If this is not the case, then correct the mistakes.

See Table 352 as an example.
Box 3750: For stripping the Accrual rights from the qualified asset pool, repeat Boxes 2120 to 2230.

Perform the tasks as described in the Box description above.

See Tables 353 to 364 as examples.
Box 3760: For amortizing the issued securities classes without stripping the accrued interest, repeat Boxes 2240 to 2400.

Perform the tasks as described in the Box description above.

See Tables 365 to 379 as examples.
Box 3770: For amortizing the issued securities classes without stripping the accrued interest, repeat Boxes 2410 to 2525.

Perform the tasks as described in the Box description above.

See Tables 380 to 391 as examples.
Box 3780: For the amortization schedules for the issued securities, fully stripped, repeat Boxes 2530 to 2730.

Perform the tasks as described in the Box description above.

See Tables 392 to 411 as examples.
Box 3790: For the financial statements for the issued securities fully stripped, repeat Boxes 2740 to 2850.

Perform the tasks as described in the Box description above.

See Tables 412 to 423 as examples.
Box 3800: For the Accrual rights amortization schedules by period stripped, repeat Boxes 2860 to 2940.

Perform the tasks as described in the Box description above.

See Tables 424a-i, etc., to 439 as examples.
Box 3810: For distributions to the Class “A” and Class “B,” etc., if any, securities holders, repeat Boxes 2950 to 3040.

Perform the tasks as described in the Box description above.

See Tables 440 to 456 as examples.
Box 3820: For distributions to the nominal rate Class “X,” if any, and Class “R” residual, securities holders, repeat Boxes 3050 to 3140.

Perform the tasks as described in the Box description above.

See Tables 457a-c, etc., to 466 as examples.
Box 3830: For financial statements for the issued securities, fully stripped, after the distributions, repeat Boxes 3150 to 3260.

Perform the tasks as described in the Box description above.

See Tables 467 to 478 as examples.
Box 3840: For reconciling the pooling schedules and the financial statements, repeat Boxes 3270 to 3390.

Perform the tasks as described in the Box description above.

See Tables 479 to 491 as examples.

Process XXIV: Initiation and Completion of Subsequent Conduits in the Defined Marketplace.
Box 3850: To initiate and complete subsequent conduits in the defined marketplace, repeat Boxes 3510 to 3840.

Perform the tasks as described in the Box description above.

See Tables 505 to 1108 as examples.

Process XXV: Formation of the Initial Multi-Phase Monetary System.
Box 3860: Complete the formation of the multi-phase monetary system by designating the system itself as the exclusive defined marketplace for the issuance of the third generation real financial instrument(s) to be known as the asset-backed real monetary equivalents(s). This can be accomplished by designating the real-principal-only (RPO) strips (from approved issues securities) as the primary asset class for the Real Monetary Conduits, which will be served by the system as the defined marketplace. The issued securities (excluding the residual and nominal rate classes, if any) of the Real Monetary Conduit will then be the real monetary equivalents, backed by the approved RPO strips. While conduits in other defined marketplaces may perform the initial securitization, thereby creating the real-principal-only (RPO) strips; the system will administer the Real Monetary Conduits issuing the asset-backed real monetary equivalents. This creates a necessary dichotomy, whereby the system oversees the asset-backed real monetary equivalents as fixed income instruments, but the other defined marketplaces treat them as monetary equivalents. This also allows the system to establish a higher level of safeguards for the conduits issuing the asset-backed real monetary equivalents. As such, no single conduit should be allowed to participate in the issuance of both the securities providing the RPO strips, and the issuance of the asset-backed real monetary equivalents. To establish the system as the defined marketplace for the asset-backed real monetary equivalents, repeat Boxes 160 to 3850, but making the appropriate adjustments to (1) issue a third generation real financial instrument, (2) backed by the RPO strips of approved issued securities, (3) backed in turn by the system-approved primary asset class(es) and (4) by designating the resulting issued securities as an asset-backed real monetary equivalent for use throughout the system.

Perform the tasks as described in the Box description above.

Process XXVI: The Initiation, Formation and Completion of the Subsequent Defined Marketplace(s) in the Initial System.
Box 3870: For the initiation, formation and completion of the subsequent defined marketplace(s) in the system, repeat Boxes 160 to 3850, but adjust, amend and/or augment these Boxes as appropriate for the primary asset class that is selected by the newly defined marketplace and the initial conduit.

Perform the tasks as described in the Box description above.

Process XXVII: The Pre-Formation of the Real World Economy.
Box 3880: Name the real world economy.

Perform the tasks as described in the Box description above.
Box 3890: Initiate an index, or other means, that will logically allow users to access the screens, functions and data stored by the real economy.

Perform the tasks as described in the Box description above.
Box 3900: Input the real monetary principles that must be adopted by participating systems.

Perform the tasks as described in the Box description above.
Box 3910: Input the bylaws, rules and regulations that will govern the real world economy, which must be accepted by participating systems.

Perform the tasks as described in the Box description above.
Box 3920: Define the base-line-currency, by inputting the parameters of the strongest system, which has the world's most recognized reserve currency as its fiat currency.

Perform the tasks as described in the Box description above.
Box 3930: Define the preferred conventions for multi-phase monetary systems by adopting the conventions of the system cited in Box 4100, but then by amending the conventions pursuant to the common good of the participants of the participating systems.

Perform the tasks as described in the Box description above.
Box 3940: Define the Global Inflationary Adjustment Factor (GIAF), which will use competent inflation indexes selected by the participating systems to measure the relative change in each fiat currency from the base-line-currency. This means that we do not simply measure the percentage change in one inflation index from the real world economy's base-line-date; but rather we measure the relative change in all the inflation indexes from the base-line-date of the base-line-currency to project the GIAF for each system's real monetary equivalents relative to the base-line-currency.

Perform the tasks as described in the Box description above.
Box 3950: Initiate a record to track the relative Global Inflationary Adjustment Factor (GIAF) for each system relative to the base-line-currency.

Perform the tasks as described in the Box description above.
Box 3960: Define the real world's economy's monetary phases and the conceptual stages for the adoption of a real global currency.

Perform the tasks as described in the Box description above.
Box 3970: Stipulate the generations of real financial instruments that can be introduced and utilized via the real world economy.

Perform the tasks as described in the Box description above.
Box 3980: Input the derivatives, and related primary asset classes, that will be permitted to secure the issuance of the asset-backed real monetary equivalents.

Perform the tasks as described in the Box description above.

Process XXVIII: Pre-Formation of the Second Multi-Phase Monetary System.
Box 3990: Repeat Boxes 100 through 3850, but select parameters and conventions that are appropriate for the setting of the second system.

Perform the tasks as described in the Box description above.

Process XXIX: Initiate the Development of Procedures for Real and Fiat Currency Exchanges Between Participating Systems.
Box 4000: Develop procedures for the global electronic exchange of the asset-backed real monetary equivalents to be issued by participating systems for both (1) fiat currencies and (2) for other asset-backed real monetary equivalents.

Perform the tasks as described in the Box description above.

Process XXX: Formation of the Real World Economy.
Box 4010: Form the real world economy by using the procedures created via Box 4000 to commence the exchange of the asset-backed real monetary equivalent, from the initial system, for other fiat currencies from around the world.

Perform the tasks as described in the Box description above.

Process XXXI: The Formation of the Second Multi-Phase Monetary System.
Box 4020: Repeat Box 3860 to complete the formation of the second multi-phase monetary system.

Perform the tasks as described in the Box description above.

Process XXXII: Commence the Global Exchange of Asset-Backed Real Monetary Equivalents Between Multi-Phase Systems.
Box 4030: Expand the function of the real world economy by using the procedures created via Box 4000 to facilitate the global electronic exchange of asset-backed real monetary equivalents between systems.

Perform the tasks as described in the Box description above.

Process XXXIII: The Initiation and Formation of the Subsequent Multi-Phase Monetary System(s).
Box 4040: Initiate, form and complete the subsequent multi-phase monetary systems by repeating Boxes 100 to 3870.

Perform the tasks as described in the Box description above.

Process XXXIV: Initiate the Development of Procedures for Issuing a Global Real Currency (GRC) by the Real World Economy.
Box 4050: Initiate the development of procedures for the issuance of a global real currency (GRC) by the real world economy in two phases: (1) the issuance of the GRC backed by a basket of asset-backed real monetary equivalents from the participating systems, and (2) later phasing out the asset-backed real monetary equivalents such that the GRC is backed directly by the real-principal-only (RPO) strips and the approved primary assets.

Perform the tasks as described in the Box description above.

Process XXXV: Commence the Issuance of a Global Real Currency (GRC), Backed by a Basket of the Participating Systems' Asset-Backed Real Monetary Equivalents.
Box 4060: Using the procedures established in Box 4050, issue a global real currency that is backed by the participating systems' asset-backed real monetary equivalents with the real world economy functioning as the (defined) marketplace for the currency exchanges.

Perform the tasks as described in the Box description above.

Process XXXVI: Phase out the Systems' Asset-Backed Real Monetary Equivalents, and Back the Global Real Currency (GRC) Directly with the Approved RPO Strips & Primary Asset Class(es).
Box 4070: Based upon the theory of a Single Price, (1) remove all the national, political, cultural and systemic barriers to the flow of real capital, (2) standardize the quantitative and qualitative underwriting standards to be used on the primary assets used to issue the RPO strips backing the GRC, (3) provide for the free movement of human resources within the global real economy; and then use a basket of RPO strips from participating systems to back the global real currency (GRC). Assuming that improved real estate is used to back the primary assets (i.e. Real Mortgages™), then the (a) intrinsic value of the improved real estate will (b) move towards a single relative price subject to the positive and/or negative influence of the environment and the proximity of the real estate to marketplaces and other social centers. This should coincide with the standardization of other prices, thereby allowing for the standardization of inflation and deflation around the globe. As this occurs, fiat currencies can be abandoned completely and the real monetary unit of purchasing power can be tied directly to the intrinsic value of improved real estate.

Perform the tasks as described in the Box description above.

THE END.

LENGTHY TABLE REFERENCED HERE
US20070027787A1-20070201-T00001
Please refer to the end of the specification for access instructions.

LENGTHY TABLE REFERENCED HERE
US20070027787A1-20070201-T00002
Please refer to the end of the specification for access instructions.

LENGTHY TABLE REFERENCED HERE
US20070027787A1-20070201-T00003
Please refer to the end of the specification for access instructions.

LENGTHY TABLE REFERENCED HERE
US20070027787A1-20070201-T00004
Please refer to the end of the specification for access instructions.

LENGTHY TABLE REFERENCED HERE
US20070027787A1-20070201-T00005
Please refer to the end of the specification for access instructions.

LENGTHY TABLE REFERENCED HERE
US20070027787A1-20070201-T00006
Please refer to the end of the specification for access instructions.

LENGTHY TABLE REFERENCED HERE
US20070027787A1-20070201-T00007
Please refer to the end of the specification for access instructions.

LENGTHY TABLE REFERENCED HERE
US20070027787A1-20070201-T00008
Please refer to the end of the specification for access instructions.

LENGTHY TABLE REFERENCED HERE
US20070027787A1-20070201-T00009
Please refer to the end of the specification for access instructions.

LENGTHY TABLE REFERENCED HERE
US20070027787A1-20070201-T00010
Please refer to the end of the specification for access instructions.

LENGTHY TABLE REFERENCED HERE
US20070027787A1-20070201-T00011
Please refer to the end of the specification for access instructions.

LENGTHY TABLE REFERENCED HERE
US20070027787A1-20070201-T00012
Please refer to the end of the specification for access instructions.

LENGTHY TABLE REFERENCED HERE
US20070027787A1-20070201-T00013
Please refer to the end of the specification for access instructions.

LENGTHY TABLE REFERENCED HERE
US20070027787A1-20070201-T00014
Please refer to the end of the specification for access instructions.

LENGTHY TABLE REFERENCED HERE
US20070027787A1-20070201-T00015
Please refer to the end of the specification for access instructions.

LENGTHY TABLE REFERENCED HERE
US20070027787A1-20070201-T00016
Please refer to the end of the specification for access instructions.

LENGTHY TABLE REFERENCED HERE
US20070027787A1-20070201-T00017
Please refer to the end of the specification for access instructions.

LENGTHY TABLE REFERENCED HERE
US20070027787A1-20070201-T00018
Please refer to the end of the specification for access instructions.

LENGTHY TABLE REFERENCED HERE
US20070027787A1-20070201-T00019
Please refer to the end of the specification for access instructions.

LENGTHY TABLE REFERENCED HERE
US20070027787A1-20070201-T00020
Please refer to the end of the specification for access instructions.

LENGTHY TABLE REFERENCED HERE
US20070027787A1-20070201-T00021
Please refer to the end of the specification for access instructions.

LENGTHY TABLE REFERENCED HERE
US20070027787A1-20070201-T00022
Please refer to the end of the specification for access instructions.

LENGTHY TABLE REFERENCED HERE
US20070027787A1-20070201-T00023
Please refer to the end of the specification for access instructions.

LENGTHY TABLE REFERENCED HERE
US20070027787A1-20070201-T00024
Please refer to the end of the specification for access instructions.

LENGTHY TABLE REFERENCED HERE
US20070027787A1-20070201-T00025
Please refer to the end of the specification for access instructions.

LENGTHY TABLE REFERENCED HERE
US20070027787A1-20070201-T00026
Please refer to the end of the specification for access instructions.

LENGTHY TABLE REFERENCED HERE
US20070027787A1-20070201-T00027
Please refer to the end of the specification for access instructions.

LENGTHY TABLE REFERENCED HERE
US20070027787A1-20070201-T00028
Please refer to the end of the specification for access instructions.

LENGTHY TABLE REFERENCED HERE
US20070027787A1-20070201-T00029
Please refer to the end of the specification for access instructions.

LENGTHY TABLE REFERENCED HERE
US20070027787A1-20070201-T00030
Please refer to the end of the specification for access instructions.

LENGTHY TABLE REFERENCED HERE
US20070027787A1-20070201-T00031
Please refer to the end of the specification for access instructions.

LENGTHY TABLE REFERENCED HERE
US20070027787A1-20070201-T00032
Please refer to the end of the specification for access instructions.

LENGTHY TABLE REFERENCED HERE
US20070027787A1-20070201-T00033
Please refer to the end of the specification for access instructions.

LENGTHY TABLE REFERENCED HERE
US20070027787A1-20070201-T00034
Please refer to the end of the specification for access instructions.

LENGTHY TABLE REFERENCED HERE
US20070027787A1-20070201-T00035
Please refer to the end of the specification for access instructions.

LENGTHY TABLE REFERENCED HERE
US20070027787A1-20070201-T00036
Please refer to the end of the specification for access instructions.

LENGTHY TABLE REFERENCED HERE
US20070027787A1-20070201-T00037
Please refer to the end of the specification for access instructions.

LENGTHY TABLE REFERENCED HERE
US20070027787A1-20070201-T00038
Please refer to the end of the specification for access instructions.

LENGTHY TABLE REFERENCED HERE
US20070027787A1-20070201-T00039
Please refer to the end of the specification for access instructions.

LENGTHY TABLE REFERENCED HERE
US20070027787A1-20070201-T00040
Please refer to the end of the specification for access instructions.

LENGTHY TABLE REFERENCED HERE
US20070027787A1-20070201-T00041
Please refer to the end of the specification for access instructions.

LENGTHY TABLE REFERENCED HERE
US20070027787A1-20070201-T00042
Please refer to the end of the specification for access instructions.

LENGTHY TABLE REFERENCED HERE
US20070027787A1-20070201-T00043
Please refer to the end of the specification for access instructions.

LENGTHY TABLE REFERENCED HERE
US20070027787A1-20070201-T00044
Please refer to the end of the specification for access instructions.

LENGTHY TABLE REFERENCED HERE
US20070027787A1-20070201-T00045
Please refer to the end of the specification for access instructions.

LENGTHY TABLE REFERENCED HERE
US20070027787A1-20070201-T00046
Please refer to the end of the specification for access instructions.

LENGTHY TABLE REFERENCED HERE
US20070027787A1-20070201-T00047
Please refer to the end of the specification for access instructions.

LENGTHY TABLE REFERENCED HERE
US20070027787A1-20070201-T00048
Please refer to the end of the specification for access instructions.

LENGTHY TABLE REFERENCED HERE
US20070027787A1-20070201-T00049
Please refer to the end of the specification for access instructions.

LENGTHY TABLE REFERENCED HERE
US20070027787A1-20070201-T00050
Please refer to the end of the specification for access instructions.

LENGTHY TABLE REFERENCED HERE
US20070027787A1-20070201-T00051
Please refer to the end of the specification for access instructions.

LENGTHY TABLE REFERENCED HERE
US20070027787A1-20070201-T00052
Please refer to the end of the specification for access instructions.

LENGTHY TABLE REFERENCED HERE
US20070027787A1-20070201-T00053
Please refer to the end of the specification for access instructions.

LENGTHY TABLE REFERENCED HERE
US20070027787A1-20070201-T00054
Please refer to the end of the specification for access instructions.

LENGTHY TABLE REFERENCED HERE
US20070027787A1-20070201-T00055
Please refer to the end of the specification for access instructions.

LENGTHY TABLE REFERENCED HERE
US20070027787A1-20070201-T00056
Please refer to the end of the specification for access instructions.

LENGTHY TABLE REFERENCED HERE
US20070027787A1-20070201-T00057
Please refer to the end of the specification for access instructions.

LENGTHY TABLE REFERENCED HERE
US20070027787A1-20070201-T00058
Please refer to the end of the specification for access instructions.

LENGTHY TABLE REFERENCED HERE
US20070027787A1-20070201-T00059
Please refer to the end of the specification for access instructions.

LENGTHY TABLE REFERENCED HERE
US20070027787A1-20070201-T00060
Please refer to the end of the specification for access instructions.

LENGTHY TABLE REFERENCED HERE
US20070027787A1-20070201-T00061
Please refer to the end of the specification for access instructions.

LENGTHY TABLE REFERENCED HERE
US20070027787A1-20070201-T00062
Please refer to the end of the specification for access instructions.

LENGTHY TABLE REFERENCED HERE
US20070027787A1-20070201-T00063
Please refer to the end of the specification for access instructions.

LENGTHY TABLE REFERENCED HERE
US20070027787A1-20070201-T00064
Please refer to the end of the specification for access instructions.

LENGTHY TABLE REFERENCED HERE
US20070027787A1-20070201-T00065
Please refer to the end of the specification for access instructions.

LENGTHY TABLE REFERENCED HERE
US20070027787A1-20070201-T00066
Please refer to the end of the specification for access instructions.

LENGTHY TABLE REFERENCED HERE
US20070027787A1-20070201-T00067
Please refer to the end of the specification for access instructions.

LENGTHY TABLE REFERENCED HERE
US20070027787A1-20070201-T00068
Please refer to the end of the specification for access instructions.

LENGTHY TABLE REFERENCED HERE
US20070027787A1-20070201-T00069
Please refer to the end of the specification for access instructions.

LENGTHY TABLE REFERENCED HERE
US20070027787A1-20070201-T00070
Please refer to the end of the specification for access instructions.

LENGTHY TABLE REFERENCED HERE
US20070027787A1-20070201-T00071
Please refer to the end of the specification for access instructions.

LENGTHY TABLE REFERENCED HERE
US20070027787A1-20070201-T00072
Please refer to the end of the specification for access instructions.

LENGTHY TABLE REFERENCED HERE
US20070027787A1-20070201-T00073
Please refer to the end of the specification for access instructions.

LENGTHY TABLE REFERENCED HERE
US20070027787A1-20070201-T00074
Please refer to the end of the specification for access instructions.

LENGTHY TABLE REFERENCED HERE
US20070027787A1-20070201-T00075
Please refer to the end of the specification for access instructions.

LENGTHY TABLE REFERENCED HERE
US20070027787A1-20070201-T00076
Please refer to the end of the specification for access instructions.

LENGTHY TABLE REFERENCED HERE
US20070027787A1-20070201-T00077
Please refer to the end of the specification for access instructions.

LENGTHY TABLE REFERENCED HERE
US20070027787A1-20070201-T00078
Please refer to the end of the specification for access instructions.

LENGTHY TABLE REFERENCED HERE
US20070027787A1-20070201-T00079
Please refer to the end of the specification for access instructions.

LENGTHY TABLE REFERENCED HERE
US20070027787A1-20070201-T00080
Please refer to the end of the specification for access instructions.

LENGTHY TABLE REFERENCED HERE
US20070027787A1-20070201-T00081
Please refer to the end of the specification for access instructions.

LENGTHY TABLE REFERENCED HERE
US20070027787A1-20070201-T00082
Please refer to the end of the specification for access instructions.

LENGTHY TABLE REFERENCED HERE
US20070027787A1-20070201-T00083
Please refer to the end of the specification for access instructions.

LENGTHY TABLE REFERENCED HERE
US20070027787A1-20070201-T00084
Please refer to the end of the specification for access instructions.

LENGTHY TABLE REFERENCED HERE
US20070027787A1-20070201-T00085
Please refer to the end of the specification for access instructions.

LENGTHY TABLE REFERENCED HERE
US20070027787A1-20070201-T00086
Please refer to the end of the specification for access instructions.

LENGTHY TABLE REFERENCED HERE
US20070027787A1-20070201-T00087
Please refer to the end of the specification for access instructions.

LENGTHY TABLE REFERENCED HERE
US20070027787A1-20070201-T00088
Please refer to the end of the specification for access instructions.

LENGTHY TABLE REFERENCED HERE
US20070027787A1-20070201-T00089
Please refer to the end of the specification for access instructions.

LENGTHY TABLE REFERENCED HERE
US20070027787A1-20070201-T00090
Please refer to the end of the specification for access instructions.

LENGTHY TABLE REFERENCED HERE
US20070027787A1-20070201-T00091
Please refer to the end of the specification for access instructions.

LENGTHY TABLE REFERENCED HERE
US20070027787A1-20070201-T00092
Please refer to the end of the specification for access instructions.

LENGTHY TABLE REFERENCED HERE
US20070027787A1-20070201-T00093
Please refer to the end of the specification for access instructions.

LENGTHY TABLE REFERENCED HERE
US20070027787A1-20070201-T00094
Please refer to the end of the specification for access instructions.

LENGTHY TABLE REFERENCED HERE
US20070027787A1-20070201-T00095
Please refer to the end of the specification for access instructions.

LENGTHY TABLE REFERENCED HERE
US20070027787A1-20070201-T00096
Please refer to the end of the specification for access instructions.

LENGTHY TABLE REFERENCED HERE
US20070027787A1-20070201-T00097
Please refer to the end of the specification for access instructions.

LENGTHY TABLE REFERENCED HERE
US20070027787A1-20070201-T00098
Please refer to the end of the specification for access instructions.

LENGTHY TABLE REFERENCED HERE
US20070027787A1-20070201-T00099
Please refer to the end of the specification for access instructions.

LENGTHY TABLE REFERENCED HERE
US20070027787A1-20070201-T00100
Please refer to the end of the specification for access instructions.

LENGTHY TABLE REFERENCED HERE
US20070027787A1-20070201-T00101
Please refer to the end of the specification for access instructions.

LENGTHY TABLE REFERENCED HERE
US20070027787A1-20070201-T00102
Please refer to the end of the specification for access instructions.

LENGTHY TABLE REFERENCED HERE
US20070027787A1-20070201-T00103
Please refer to the end of the specification for access instructions.

LENGTHY TABLE REFERENCED HERE
US20070027787A1-20070201-T00104
Please refer to the end of the specification for access instructions.

LENGTHY TABLE REFERENCED HERE
US20070027787A1-20070201-T00105
Please refer to the end of the specification for access instructions.

LENGTHY TABLE REFERENCED HERE
US20070027787A1-20070201-T00106
Please refer to the end of the specification for access instructions.

LENGTHY TABLE REFERENCED HERE
US20070027787A1-20070201-T00107
Please refer to the end of the specification for access instructions.

LENGTHY TABLE REFERENCED HERE
US20070027787A1-20070201-T00108
Please refer to the end of the specification for access instructions.

LENGTHY TABLE REFERENCED HERE
US20070027787A1-20070201-T00109
Please refer to the end of the specification for access instructions.

LENGTHY TABLE REFERENCED HERE
US20070027787A1-20070201-T00110
Please refer to the end of the specification for access instructions.

LENGTHY TABLE REFERENCED HERE
US20070027787A1-20070201-T00111
Please refer to the end of the specification for access instructions.

LENGTHY TABLE REFERENCED HERE
US20070027787A1-20070201-T00112
Please refer to the end of the specification for access instructions.

LENGTHY TABLE REFERENCED HERE
US20070027787A1-20070201-T00113
Please refer to the end of the specification for access instructions.

LENGTHY TABLE REFERENCED HERE
US20070027787A1-20070201-T00114
Please refer to the end of the specification for access instructions.

LENGTHY TABLE REFERENCED HERE
US20070027787A1-20070201-T00115
Please refer to the end of the specification for access instructions.

LENGTHY TABLE REFERENCED HERE
US20070027787A1-20070201-T00116
Please refer to the end of the specification for access instructions.

LENGTHY TABLE REFERENCED HERE
US20070027787A1-20070201-T00117
Please refer to the end of the specification for access instructions.

LENGTHY TABLE REFERENCED HERE
US20070027787A1-20070201-T00118
Please refer to the end of the specification for access instructions.

LENGTHY TABLE REFERENCED HERE
US20070027787A1-20070201-T00119
Please refer to the end of the specification for access instructions.

LENGTHY TABLE REFERENCED HERE
US20070027787A1-20070201-T00120
Please refer to the end of the specification for access instructions.

LENGTHY TABLE REFERENCED HERE
US20070027787A1-20070201-T00121
Please refer to the end of the specification for access instructions.

LENGTHY TABLE REFERENCED HERE
US20070027787A1-20070201-T00122
Please refer to the end of the specification for access instructions.

LENGTHY TABLE REFERENCED HERE
US20070027787A1-20070201-T00123
Please refer to the end of the specification for access instructions.

LENGTHY TABLE REFERENCED HERE
US20070027787A1-20070201-T00124
Please refer to the end of the specification for access instructions.

LENGTHY TABLE REFERENCED HERE
US20070027787A1-20070201-T00125
Please refer to the end of the specification for access instructions.

LENGTHY TABLE REFERENCED HERE
US20070027787A1-20070201-T00126
Please refer to the end of the specification for access instructions.

LENGTHY TABLE REFERENCED HERE
US20070027787A1-20070201-T00127
Please refer to the end of the specification for access instructions.

LENGTHY TABLE REFERENCED HERE
US20070027787A1-20070201-T00128
Please refer to the end of the specification for access instructions.

LENGTHY TABLE REFERENCED HERE
US20070027787A1-20070201-T00129
Please refer to the end of the specification for access instructions.

LENGTHY TABLE REFERENCED HERE
US20070027787A1-20070201-T00130
Please refer to the end of the specification for access instructions.

LENGTHY TABLE REFERENCED HERE
US20070027787A1-20070201-T00131
Please refer to the end of the specification for access instructions.

LENGTHY TABLE REFERENCED HERE
US20070027787A1-20070201-T00132
Please refer to the end of the specification for access instructions.

LENGTHY TABLE REFERENCED HERE
US20070027787A1-20070201-T00133
Please refer to the end of the specification for access instructions.

LENGTHY TABLE REFERENCED HERE
US20070027787A1-20070201-T00134
Please refer to the end of the specification for access instructions.

LENGTHY TABLE REFERENCED HERE
US20070027787A1-20070201-T00135
Please refer to the end of the specification for access instructions.

LENGTHY TABLE REFERENCED HERE
US20070027787A1-20070201-T00136
Please refer to the end of the specification for access instructions.

LENGTHY TABLE REFERENCED HERE
US20070027787A1-20070201-T00137
Please refer to the end of the specification for access instructions.

LENGTHY TABLE REFERENCED HERE
US20070027787A1-20070201-T00138
Please refer to the end of the specification for access instructions.

LENGTHY TABLE REFERENCED HERE
US20070027787A1-20070201-T00139
Please refer to the end of the specification for access instructions.

LENGTHY TABLE REFERENCED HERE
US20070027787A1-20070201-T00140
Please refer to the end of the specification for access instructions.

LENGTHY TABLE REFERENCED HERE
US20070027787A1-20070201-T00141
Please refer to the end of the specification for access instructions.

LENGTHY TABLE REFERENCED HERE
US20070027787A1-20070201-T00142
Please refer to the end of the specification for access instructions.

LENGTHY TABLE REFERENCED HERE
US20070027787A1-20070201-T00143
Please refer to the end of the specification for access instructions.

LENGTHY TABLE REFERENCED HERE
US20070027787A1-20070201-T00144
Please refer to the end of the specification for access instructions.

LENGTHY TABLE REFERENCED HERE
US20070027787A1-20070201-T00145
Please refer to the end of the specification for access instructions.

LENGTHY TABLE REFERENCED HERE
US20070027787A1-20070201-T00146
Please refer to the end of the specification for access instructions.

LENGTHY TABLE REFERENCED HERE
US20070027787A1-20070201-T00147
Please refer to the end of the specification for access instructions.

LENGTHY TABLE REFERENCED HERE
US20070027787A1-20070201-T00148
Please refer to the end of the specification for access instructions.

LENGTHY TABLE REFERENCED HERE
US20070027787A1-20070201-T00149
Please refer to the end of the specification for access instructions.

LENGTHY TABLE REFERENCED HERE
US20070027787A1-20070201-T00150
Please refer to the end of the specification for access instructions.

LENGTHY TABLE REFERENCED HERE
US20070027787A1-20070201-T00151
Please refer to the end of the specification for access instructions.

LENGTHY TABLE REFERENCED HERE
US20070027787A1-20070201-T00152
Please refer to the end of the specification for access instructions.

LENGTHY TABLE REFERENCED HERE
US20070027787A1-20070201-T00153
Please refer to the end of the specification for access instructions.

LENGTHY TABLE REFERENCED HERE
US20070027787A1-20070201-T00154
Please refer to the end of the specification for access instructions.

LENGTHY TABLE REFERENCED HERE
US20070027787A1-20070201-T00155
Please refer to the end of the specification for access instructions.

LENGTHY TABLE REFERENCED HERE
US20070027787A1-20070201-T00156
Please refer to the end of the specification for access instructions.

LENGTHY TABLE REFERENCED HERE
US20070027787A1-20070201-T00157
Please refer to the end of the specification for access instructions.

LENGTHY TABLE REFERENCED HERE
US20070027787A1-20070201-T00158
Please refer to the end of the specification for access instructions.

LENGTHY TABLE REFERENCED HERE
US20070027787A1-20070201-T00159
Please refer to the end of the specification for access instructions.

LENGTHY TABLE REFERENCED HERE
US20070027787A1-20070201-T00160
Please refer to the end of the specification for access instructions.

LENGTHY TABLE REFERENCED HERE
US20070027787A1-20070201-T00161
Please refer to the end of the specification for access instructions.

LENGTHY TABLE REFERENCED HERE
US20070027787A1-20070201-T00162
Please refer to the end of the specification for access instructions.

LENGTHY TABLE REFERENCED HERE
US20070027787A1-20070201-T00163
Please refer to the end of the specification for access instructions.

LENGTHY TABLE REFERENCED HERE
US20070027787A1-20070201-T00164
Please refer to the end of the specification for access instructions.

LENGTHY TABLE REFERENCED HERE
US20070027787A1-20070201-T00165
Please refer to the end of the specification for access instructions.

LENGTHY TABLE REFERENCED HERE
US20070027787A1-20070201-T00166
Please refer to the end of the specification for access instructions.

LENGTHY TABLE REFERENCED HERE
US20070027787A1-20070201-T00167
Please refer to the end of the specification for access instructions.

LENGTHY TABLE REFERENCED HERE
US20070027787A1-20070201-T00168
Please refer to the end of the specification for access instructions.

LENGTHY TABLE REFERENCED HERE
US20070027787A1-20070201-T00169
Please refer to the end of the specification for access instructions.

LENGTHY TABLE REFERENCED HERE
US20070027787A1-20070201-T00170
Please refer to the end of the specification for access instructions.

LENGTHY TABLE REFERENCED HERE
US20070027787A1-20070201-T00171
Please refer to the end of the specification for access instructions.

LENGTHY TABLE REFERENCED HERE
US20070027787A1-20070201-T00172
Please refer to the end of the specification for access instructions.

LENGTHY TABLE REFERENCED HERE
US20070027787A1-20070201-T00173
Please refer to the end of the specification for access instructions.

LENGTHY TABLE REFERENCED HERE
US20070027787A1-20070201-T00174
Please refer to the end of the specification for access instructions.

LENGTHY TABLE REFERENCED HERE
US20070027787A1-20070201-T00175
Please refer to the end of the specification for access instructions.

LENGTHY TABLE REFERENCED HERE
US20070027787A1-20070201-T00176
Please refer to the end of the specification for access instructions.

LENGTHY TABLE REFERENCED HERE
US20070027787A1-20070201-T00177
Please refer to the end of the specification for access instructions.

LENGTHY TABLE REFERENCED HERE
US20070027787A1-20070201-T00178
Please refer to the end of the specification for access instructions.

LENGTHY TABLE REFERENCED HERE
US20070027787A1-20070201-T00179
Please refer to the end of the specification for access instructions.

LENGTHY TABLE REFERENCED HERE
US20070027787A1-20070201-T00180
Please refer to the end of the specification for access instructions.

LENGTHY TABLE REFERENCED HERE
US20070027787A1-20070201-T00181
Please refer to the end of the specification for access instructions.

LENGTHY TABLE REFERENCED HERE
US20070027787A1-20070201-T00182
Please refer to the end of the specification for access instructions.

LENGTHY TABLE REFERENCED HERE
US20070027787A1-20070201-T00183
Please refer to the end of the specification for access instructions.

LENGTHY TABLE REFERENCED HERE
US20070027787A1-20070201-T00184
Please refer to the end of the specification for access instructions.

LENGTHY TABLE REFERENCED HERE
US20070027787A1-20070201-T00185
Please refer to the end of the specification for access instructions.

LENGTHY TABLE REFERENCED HERE
US20070027787A1-20070201-T00186
Please refer to the end of the specification for access instructions.

LENGTHY TABLE REFERENCED HERE
US20070027787A1-20070201-T00187
Please refer to the end of the specification for access instructions.

LENGTHY TABLE REFERENCED HERE
US20070027787A1-20070201-T00188
Please refer to the end of the specification for access instructions.

LENGTHY TABLE REFERENCED HERE
US20070027787A1-20070201-T00189
Please refer to the end of the specification for access instructions.

LENGTHY TABLE REFERENCED HERE
US20070027787A1-20070201-T00190
Please refer to the end of the specification for access instructions.

LENGTHY TABLE REFERENCED HERE
US20070027787A1-20070201-T00191
Please refer to the end of the specification for access instructions.

LENGTHY TABLE REFERENCED HERE
US20070027787A1-20070201-T00192
Please refer to the end of the specification for access instructions.

LENGTHY TABLE REFERENCED HERE
US20070027787A1-20070201-T00193
Please refer to the end of the specification for access instructions.

LENGTHY TABLE REFERENCED HERE
US20070027787A1-20070201-T00194
Please refer to the end of the specification for access instructions.

LENGTHY TABLE REFERENCED HERE
US20070027787A1-20070201-T00195
Please refer to the end of the specification for access instructions.

LENGTHY TABLE REFERENCED HERE
US20070027787A1-20070201-T00196
Please refer to the end of the specification for access instructions.

LENGTHY TABLE REFERENCED HERE
US20070027787A1-20070201-T00197
Please refer to the end of the specification for access instructions.

LENGTHY TABLE REFERENCED HERE
US20070027787A1-20070201-T00198
Please refer to the end of the specification for access instructions.

LENGTHY TABLE REFERENCED HERE
US20070027787A1-20070201-T00199
Please refer to the end of the specification for access instructions.

LENGTHY TABLE REFERENCED HERE
US20070027787A1-20070201-T00200
Please refer to the end of the specification for access instructions.

LENGTHY TABLE REFERENCED HERE
US20070027787A1-20070201-T00201
Please refer to the end of the specification for access instructions.

LENGTHY TABLE REFERENCED HERE
US20070027787A1-20070201-T00202
Please refer to the end of the specification for access instructions.

LENGTHY TABLE REFERENCED HERE
US20070027787A1-20070201-T00203
Please refer to the end of the specification for access instructions.

LENGTHY TABLE REFERENCED HERE
US20070027787A1-20070201-T00204
Please refer to the end of the specification for access instructions.

LENGTHY TABLE REFERENCED HERE
US20070027787A1-20070201-T00205
Please refer to the end of the specification for access instructions.

LENGTHY TABLE REFERENCED HERE
US20070027787A1-20070201-T00206
Please refer to the end of the specification for access instructions.

LENGTHY TABLE REFERENCED HERE
US20070027787A1-20070201-T00207
Please refer to the end of the specification for access instructions.

LENGTHY TABLE REFERENCED HERE
US20070027787A1-20070201-T00208
Please refer to the end of the specification for access instructions.

LENGTHY TABLE REFERENCED HERE
US20070027787A1-20070201-T00209
Please refer to the end of the specification for access instructions.

LENGTHY TABLE REFERENCED HERE
US20070027787A1-20070201-T00210
Please refer to the end of the specification for access instructions.

LENGTHY TABLE REFERENCED HERE
US20070027787A1-20070201-T00211
Please refer to the end of the specification for access instructions.

LENGTHY TABLE REFERENCED HERE
US20070027787A1-20070201-T00212
Please refer to the end of the specification for access instructions.

LENGTHY TABLE REFERENCED HERE
US20070027787A1-20070201-T00213
Please refer to the end of the specification for access instructions.

LENGTHY TABLE REFERENCED HERE
US20070027787A1-20070201-T00214
Please refer to the end of the specification for access instructions.

LENGTHY TABLE REFERENCED HERE
US20070027787A1-20070201-T00215
Please refer to the end of the specification for access instructions.

LENGTHY TABLE REFERENCED HERE
US20070027787A1-20070201-T00216
Please refer to the end of the specification for access instructions.

LENGTHY TABLE REFERENCED HERE
US20070027787A1-20070201-T00217
Please refer to the end of the specification for access instructions.

LENGTHY TABLE REFERENCED HERE
US20070027787A1-20070201-T00218
Please refer to the end of the specification for access instructions.

LENGTHY TABLE REFERENCED HERE
US20070027787A1-20070201-T00219
Please refer to the end of the specification for access instructions.

LENGTHY TABLE REFERENCED HERE
US20070027787A1-20070201-T00220
Please refer to the end of the specification for access instructions.

LENGTHY TABLE REFERENCED HERE
US20070027787A1-20070201-T00221
Please refer to the end of the specification for access instructions.

LENGTHY TABLE REFERENCED HERE
US20070027787A1-20070201-T00222
Please refer to the end of the specification for access instructions.

LENGTHY TABLE REFERENCED HERE
US20070027787A1-20070201-T00223
Please refer to the end of the specification for access instructions.

LENGTHY TABLE REFERENCED HERE
US20070027787A1-20070201-T00224
Please refer to the end of the specification for access instructions.

LENGTHY TABLE REFERENCED HERE
US20070027787A1-20070201-T00225
Please refer to the end of the specification for access instructions.

LENGTHY TABLE REFERENCED HERE
US20070027787A1-20070201-T00226
Please refer to the end of the specification for access instructions.

LENGTHY TABLE REFERENCED HERE
US20070027787A1-20070201-T00227
Please refer to the end of the specification for access instructions.

LENGTHY TABLE REFERENCED HERE
US20070027787A1-20070201-T00228
Please refer to the end of the specification for access instructions.

LENGTHY TABLE REFERENCED HERE
US20070027787A1-20070201-T00229
Please refer to the end of the specification for access instructions.

LENGTHY TABLE REFERENCED HERE
US20070027787A1-20070201-T00230
Please refer to the end of the specification for access instructions.

LENGTHY TABLE REFERENCED HERE
US20070027787A1-20070201-T00231
Please refer to the end of the specification for access instructions.

LENGTHY TABLE REFERENCED HERE
US20070027787A1-20070201-T00232
Please refer to the end of the specification for access instructions.

LENGTHY TABLE REFERENCED HERE
US20070027787A1-20070201-T00233
Please refer to the end of the specification for access instructions.

LENGTHY TABLE REFERENCED HERE
US20070027787A1-20070201-T00234
Please refer to the end of the specification for access instructions.

LENGTHY TABLE REFERENCED HERE
US20070027787A1-20070201-T00235
Please refer to the end of the specification for access instructions.

LENGTHY TABLE REFERENCED HERE
US20070027787A1-20070201-T00236
Please refer to the end of the specification for access instructions.

LENGTHY TABLE REFERENCED HERE
US20070027787A1-20070201-T00237
Please refer to the end of the specification for access instructions.

LENGTHY TABLE REFERENCED HERE
US20070027787A1-20070201-T00238
Please refer to the end of the specification for access instructions.

LENGTHY TABLE REFERENCED HERE
US20070027787A1-20070201-T00239
Please refer to the end of the specification for access instructions.

LENGTHY TABLE REFERENCED HERE
US20070027787A1-20070201-T00240
Please refer to the end of the specification for access instructions.

LENGTHY TABLE REFERENCED HERE
US20070027787A1-20070201-T00241
Please refer to the end of the specification for access instructions.

LENGTHY TABLE REFERENCED HERE
US20070027787A1-20070201-T00242
Please refer to the end of the specification for access instructions.

LENGTHY TABLE REFERENCED HERE
US20070027787A1-20070201-T00243
Please refer to the end of the specification for access instructions.

LENGTHY TABLE REFERENCED HERE
US20070027787A1-20070201-T00244
Please refer to the end of the specification for access instructions.

LENGTHY TABLE REFERENCED HERE
US20070027787A1-20070201-T00245
Please refer to the end of the specification for access instructions.

LENGTHY TABLE REFERENCED HERE
US20070027787A1-20070201-T00246
Please refer to the end of the specification for access instructions.

LENGTHY TABLE REFERENCED HERE
US20070027787A1-20070201-T00247
Please refer to the end of the specification for access instructions.

LENGTHY TABLE REFERENCED HERE
US20070027787A1-20070201-T00248
Please refer to the end of the specification for access instructions.

LENGTHY TABLE REFERENCED HERE
US20070027787A1-20070201-T00249
Please refer to the end of the specification for access instructions.

LENGTHY TABLE REFERENCED HERE
US20070027787A1-20070201-T00250
Please refer to the end of the specification for access instructions.

LENGTHY TABLE REFERENCED HERE
US20070027787A1-20070201-T00251
Please refer to the end of the specification for access instructions.

LENGTHY TABLE REFERENCED HERE
US20070027787A1-20070201-T00252
Please refer to the end of the specification for access instructions.

LENGTHY TABLE REFERENCED HERE
US20070027787A1-20070201-T00253
Please refer to the end of the specification for access instructions.

LENGTHY TABLE REFERENCED HERE
US20070027787A1-20070201-T00254
Please refer to the end of the specification for access instructions.

LENGTHY TABLE REFERENCED HERE
US20070027787A1-20070201-T00255
Please refer to the end of the specification for access instructions.

LENGTHY TABLE REFERENCED HERE
US20070027787A1-20070201-T00256
Please refer to the end of the specification for access instructions.

LENGTHY TABLE REFERENCED HERE
US20070027787A1-20070201-T00257
Please refer to the end of the specification for access instructions.

LENGTHY TABLE REFERENCED HERE
US20070027787A1-20070201-T00258
Please refer to the end of the specification for access instructions.

LENGTHY TABLE REFERENCED HERE
US20070027787A1-20070201-T00259
Please refer to the end of the specification for access instructions.

LENGTHY TABLE REFERENCED HERE
US20070027787A1-20070201-T00260
Please refer to the end of the specification for access instructions.

LENGTHY TABLE REFERENCED HERE
US20070027787A1-20070201-T00261
Please refer to the end of the specification for access instructions.

LENGTHY TABLE REFERENCED HERE
US20070027787A1-20070201-T00262
Please refer to the end of the specification for access instructions.

LENGTHY TABLE REFERENCED HERE
US20070027787A1-20070201-T00263
Please refer to the end of the specification for access instructions.

LENGTHY TABLE REFERENCED HERE
US20070027787A1-20070201-T00264
Please refer to the end of the specification for access instructions.

LENGTHY TABLE REFERENCED HERE
US20070027787A1-20070201-T00265
Please refer to the end of the specification for access instructions.

LENGTHY TABLE REFERENCED HERE
US20070027787A1-20070201-T00266
Please refer to the end of the specification for access instructions.

LENGTHY TABLE REFERENCED HERE
US20070027787A1-20070201-T00267
Please refer to the end of the specification for access instructions.

LENGTHY TABLE REFERENCED HERE
US20070027787A1-20070201-T00268
Please refer to the end of the specification for access instructions.

LENGTHY TABLE REFERENCED HERE
US20070027787A1-20070201-T00269
Please refer to the end of the specification for access instructions.

LENGTHY TABLE REFERENCED HERE
US20070027787A1-20070201-T00270
Please refer to the end of the specification for access instructions.

LENGTHY TABLE REFERENCED HERE
US20070027787A1-20070201-T00271
Please refer to the end of the specification for access instructions.

LENGTHY TABLE REFERENCED HERE
US20070027787A1-20070201-T00272
Please refer to the end of the specification for access instructions.

LENGTHY TABLE REFERENCED HERE
US20070027787A1-20070201-T00273
Please refer to the end of the specification for access instructions.

LENGTHY TABLE REFERENCED HERE
US20070027787A1-20070201-T00274
Please refer to the end of the specification for access instructions.

LENGTHY TABLE REFERENCED HERE
US20070027787A1-20070201-T00275
Please refer to the end of the specification for access instructions.

LENGTHY TABLE REFERENCED HERE
US20070027787A1-20070201-T00276
Please refer to the end of the specification for access instructions.

LENGTHY TABLE REFERENCED HERE
US20070027787A1-20070201-T00277
Please refer to the end of the specification for access instructions.

LENGTHY TABLE REFERENCED HERE
US20070027787A1-20070201-T00278
Please refer to the end of the specification for access instructions.

LENGTHY TABLE REFERENCED HERE
US20070027787A1-20070201-T00279
Please refer to the end of the specification for access instructions.

LENGTHY TABLE REFERENCED HERE
US20070027787A1-20070201-T00280
Please refer to the end of the specification for access instructions.

LENGTHY TABLE REFERENCED HERE
US20070027787A1-20070201-T00281
Please refer to the end of the specification for access instructions.

LENGTHY TABLE REFERENCED HERE
US20070027787A1-20070201-T00282
Please refer to the end of the specification for access instructions.

LENGTHY TABLE REFERENCED HERE
US20070027787A1-20070201-T00283
Please refer to the end of the specification for access instructions.

LENGTHY TABLE REFERENCED HERE
US20070027787A1-20070201-T00284
Please refer to the end of the specification for access instructions.

LENGTHY TABLE REFERENCED HERE
US20070027787A1-20070201-T00285
Please refer to the end of the specification for access instructions.

LENGTHY TABLE REFERENCED HERE
US20070027787A1-20070201-T00286
Please refer to the end of the specification for access instructions.

LENGTHY TABLE REFERENCED HERE
US20070027787A1-20070201-T00287
Please refer to the end of the specification for access instructions.

LENGTHY TABLE REFERENCED HERE
US20070027787A1-20070201-T00288
Please refer to the end of the specification for access instructions.

LENGTHY TABLE REFERENCED HERE
US20070027787A1-20070201-T00289
Please refer to the end of the specification for access instructions.

LENGTHY TABLE REFERENCED HERE
US20070027787A1-20070201-T00290
Please refer to the end of the specification for access instructions.

LENGTHY TABLE REFERENCED HERE
US20070027787A1-20070201-T00291
Please refer to the end of the specification for access instructions.

LENGTHY TABLE REFERENCED HERE
US20070027787A1-20070201-T00292
Please refer to the end of the specification for access instructions.

LENGTHY TABLE REFERENCED HERE
US20070027787A1-20070201-T00293
Please refer to the end of the specification for access instructions.

LENGTHY TABLE REFERENCED HERE
US20070027787A1-20070201-T00294
Please refer to the end of the specification for access instructions.

LENGTHY TABLE REFERENCED HERE
US20070027787A1-20070201-T00295
Please refer to the end of the specification for access instructions.

LENGTHY TABLE REFERENCED HERE
US20070027787A1-20070201-T00296
Please refer to the end of the specification for access instructions.

LENGTHY TABLE REFERENCED HERE
US20070027787A1-20070201-T00297
Please refer to the end of the specification for access instructions.

LENGTHY TABLE REFERENCED HERE
US20070027787A1-20070201-T00298
Please refer to the end of the specification for access instructions.

LENGTHY TABLE REFERENCED HERE
US20070027787A1-20070201-T00299
Please refer to the end of the specification for access instructions.

LENGTHY TABLE REFERENCED HERE
US20070027787A1-20070201-T00300
Please refer to the end of the specification for access instructions.

LENGTHY TABLE REFERENCED HERE
US20070027787A1-20070201-T00301
Please refer to the end of the specification for access instructions.

LENGTHY TABLE REFERENCED HERE
US20070027787A1-20070201-T00302
Please refer to the end of the specification for access instructions.

LENGTHY TABLE REFERENCED HERE
US20070027787A1-20070201-T00303
Please refer to the end of the specification for access instructions.

LENGTHY TABLE REFERENCED HERE
US20070027787A1-20070201-T00304
Please refer to the end of the specification for access instructions.

LENGTHY TABLE REFERENCED HERE
US20070027787A1-20070201-T00305
Please refer to the end of the specification for access instructions.

LENGTHY TABLE REFERENCED HERE
US20070027787A1-20070201-T00306
Please refer to the end of the specification for access instructions.

LENGTHY TABLE REFERENCED HERE
US20070027787A1-20070201-T00307
Please refer to the end of the specification for access instructions.

LENGTHY TABLE REFERENCED HERE
US20070027787A1-20070201-T00308
Please refer to the end of the specification for access instructions.

LENGTHY TABLE REFERENCED HERE
US20070027787A1-20070201-T00309
Please refer to the end of the specification for access instructions.

LENGTHY TABLE REFERENCED HERE
US20070027787A1-20070201-T00310
Please refer to the end of the specification for access instructions.

LENGTHY TABLE REFERENCED HERE
US20070027787A1-20070201-T00311
Please refer to the end of the specification for access instructions.

LENGTHY TABLE REFERENCED HERE
US20070027787A1-20070201-T00312
Please refer to the end of the specification for access instructions.

LENGTHY TABLE REFERENCED HERE
US20070027787A1-20070201-T00313
Please refer to the end of the specification for access instructions.

LENGTHY TABLE REFERENCED HERE
US20070027787A1-20070201-T00314
Please refer to the end of the specification for access instructions.

LENGTHY TABLE REFERENCED HERE
US20070027787A1-20070201-T00315
Please refer to the end of the specification for access instructions.

LENGTHY TABLE REFERENCED HERE
US20070027787A1-20070201-T00316
Please refer to the end of the specification for access instructions.

LENGTHY TABLE REFERENCED HERE
US20070027787A1-20070201-T00317
Please refer to the end of the specification for access instructions.

LENGTHY TABLE REFERENCED HERE
US20070027787A1-20070201-T00318
Please refer to the end of the specification for access instructions.

LENGTHY TABLE REFERENCED HERE
US20070027787A1-20070201-T00319
Please refer to the end of the specification for access instructions.

LENGTHY TABLE REFERENCED HERE
US20070027787A1-20070201-T00320
Please refer to the end of the specification for access instructions.

LENGTHY TABLE REFERENCED HERE
US20070027787A1-20070201-T00321
Please refer to the end of the specification for access instructions.

LENGTHY TABLE REFERENCED HERE
US20070027787A1-20070201-T00322
Please refer to the end of the specification for access instructions.

LENGTHY TABLE REFERENCED HERE
US20070027787A1-20070201-T00323
Please refer to the end of the specification for access instructions.

LENGTHY TABLE REFERENCED HERE
US20070027787A1-20070201-T00324
Please refer to the end of the specification for access instructions.

LENGTHY TABLE REFERENCED HERE
US20070027787A1-20070201-T00325
Please refer to the end of the specification for access instructions.

LENGTHY TABLE REFERENCED HERE
US20070027787A1-20070201-T00326
Please refer to the end of the specification for access instructions.

LENGTHY TABLE REFERENCED HERE
US20070027787A1-20070201-T00327
Please refer to the end of the specification for access instructions.

LENGTHY TABLE REFERENCED HERE
US20070027787A1-20070201-T00328
Please refer to the end of the specification for access instructions.

LENGTHY TABLE REFERENCED HERE
US20070027787A1-20070201-T00329
Please refer to the end of the specification for access instructions.

LENGTHY TABLE REFERENCED HERE
US20070027787A1-20070201-T00330
Please refer to the end of the specification for access instructions.

LENGTHY TABLE REFERENCED HERE
US20070027787A1-20070201-T00331
Please refer to the end of the specification for access instructions.

LENGTHY TABLE REFERENCED HERE
US20070027787A1-20070201-T00332
Please refer to the end of the specification for access instructions.

LENGTHY TABLE REFERENCED HERE
US20070027787A1-20070201-T00333
Please refer to the end of the specification for access instructions.

LENGTHY TABLE REFERENCED HERE
US20070027787A1-20070201-T00334
Please refer to the end of the specification for access instructions.

LENGTHY TABLE REFERENCED HERE
US20070027787A1-20070201-T00335
Please refer to the end of the specification for access instructions.

LENGTHY TABLE REFERENCED HERE
US20070027787A1-20070201-T00336
Please refer to the end of the specification for access instructions.

LENGTHY TABLE REFERENCED HERE
US20070027787A1-20070201-T00337
Please refer to the end of the specification for access instructions.

LENGTHY TABLE REFERENCED HERE
US20070027787A1-20070201-T00338
Please refer to the end of the specification for access instructions.

LENGTHY TABLE REFERENCED HERE
US20070027787A1-20070201-T00339
Please refer to the end of the specification for access instructions.

LENGTHY TABLE REFERENCED HERE
US20070027787A1-20070201-T00340
Please refer to the end of the specification for access instructions.

LENGTHY TABLE REFERENCED HERE
US20070027787A1-20070201-T00341
Please refer to the end of the specification for access instructions.

LENGTHY TABLE REFERENCED HERE
US20070027787A1-20070201-T00342
Please refer to the end of the specification for access instructions.

LENGTHY TABLE REFERENCED HERE
US20070027787A1-20070201-T00343
Please refer to the end of the specification for access instructions.

LENGTHY TABLE REFERENCED HERE
US20070027787A1-20070201-T00344
Please refer to the end of the specification for access instructions.

LENGTHY TABLE REFERENCED HERE
US20070027787A1-20070201-T00345
Please refer to the end of the specification for access instructions.

LENGTHY TABLE REFERENCED HERE
US20070027787A1-20070201-T00346
Please refer to the end of the specification for access instructions.

LENGTHY TABLE REFERENCED HERE
US20070027787A1-20070201-T00347
Please refer to the end of the specification for access instructions.

LENGTHY TABLE REFERENCED HERE
US20070027787A1-20070201-T00348
Please refer to the end of the specification for access instructions.

LENGTHY TABLE REFERENCED HERE
US20070027787A1-20070201-T00349
Please refer to the end of the specification for access instructions.

LENGTHY TABLE REFERENCED HERE
US20070027787A1-20070201-T00350
Please refer to the end of the specification for access instructions.

LENGTHY TABLE REFERENCED HERE
US20070027787A1-20070201-T00351
Please refer to the end of the specification for access instructions.

LENGTHY TABLE REFERENCED HERE
US20070027787A1-20070201-T00352
Please refer to the end of the specification for access instructions.

LENGTHY TABLE REFERENCED HERE
US20070027787A1-20070201-T00353
Please refer to the end of the specification for access instructions.

LENGTHY TABLE REFERENCED HERE
US20070027787A1-20070201-T00354
Please refer to the end of the specification for access instructions.

LENGTHY TABLE REFERENCED HERE
US20070027787A1-20070201-T00355
Please refer to the end of the specification for access instructions.

LENGTHY TABLE REFERENCED HERE
US20070027787A1-20070201-T00356
Please refer to the end of the specification for access instructions.

LENGTHY TABLE REFERENCED HERE
US20070027787A1-20070201-T00357
Please refer to the end of the specification for access instructions.

LENGTHY TABLE REFERENCED HERE
US20070027787A1-20070201-T00358
Please refer to the end of the specification for access instructions.

LENGTHY TABLE REFERENCED HERE
US20070027787A1-20070201-T00359
Please refer to the end of the specification for access instructions.

LENGTHY TABLE REFERENCED HERE
US20070027787A1-20070201-T00360
Please refer to the end of the specification for access instructions.

LENGTHY TABLE REFERENCED HERE
US20070027787A1-20070201-T00361
Please refer to the end of the specification for access instructions.

LENGTHY TABLE REFERENCED HERE
US20070027787A1-20070201-T00362
Please refer to the end of the specification for access instructions.

LENGTHY TABLE REFERENCED HERE
US20070027787A1-20070201-T00363
Please refer to the end of the specification for access instructions.

LENGTHY TABLE REFERENCED HERE
US20070027787A1-20070201-T00364
Please refer to the end of the specification for access instructions.

LENGTHY TABLE REFERENCED HERE
US20070027787A1-20070201-T00365
Please refer to the end of the specification for access instructions.

LENGTHY TABLE REFERENCED HERE
US20070027787A1-20070201-T00366
Please refer to the end of the specification for access instructions.

LENGTHY TABLE REFERENCED HERE
US20070027787A1-20070201-T00367
Please refer to the end of the specification for access instructions.

LENGTHY TABLE REFERENCED HERE
US20070027787A1-20070201-T00368
Please refer to the end of the specification for access instructions.

LENGTHY TABLE REFERENCED HERE
US20070027787A1-20070201-T00369
Please refer to the end of the specification for access instructions.

LENGTHY TABLE REFERENCED HERE
US20070027787A1-20070201-T00370
Please refer to the end of the specification for access instructions.

LENGTHY TABLE REFERENCED HERE
US20070027787A1-20070201-T00371
Please refer to the end of the specification for access instructions.

LENGTHY TABLE REFERENCED HERE
US20070027787A1-20070201-T00372
Please refer to the end of the specification for access instructions.

LENGTHY TABLE REFERENCED HERE
US20070027787A1-20070201-T00373
Please refer to the end of the specification for access instructions.

LENGTHY TABLE REFERENCED HERE
US20070027787A1-20070201-T00374
Please refer to the end of the specification for access instructions.

LENGTHY TABLE REFERENCED HERE
US20070027787A1-20070201-T00375
Please refer to the end of the specification for access instructions.

LENGTHY TABLE REFERENCED HERE
US20070027787A1-20070201-T00376
Please refer to the end of the specification for access instructions.

LENGTHY TABLE REFERENCED HERE
US20070027787A1-20070201-T00377
Please refer to the end of the specification for access instructions.

LENGTHY TABLE REFERENCED HERE
US20070027787A1-20070201-T00378
Please refer to the end of the specification for access instructions.

LENGTHY TABLE REFERENCED HERE
US20070027787A1-20070201-T00379
Please refer to the end of the specification for access instructions.

LENGTHY TABLE REFERENCED HERE
US20070027787A1-20070201-T00380
Please refer to the end of the specification for access instructions.

LENGTHY TABLE REFERENCED HERE
US20070027787A1-20070201-T00381
Please refer to the end of the specification for access instructions.

LENGTHY TABLE REFERENCED HERE
US20070027787A1-20070201-T00382
Please refer to the end of the specification for access instructions.

LENGTHY TABLE REFERENCED HERE
US20070027787A1-20070201-T00383
Please refer to the end of the specification for access instructions.

LENGTHY TABLE REFERENCED HERE
US20070027787A1-20070201-T00384
Please refer to the end of the specification for access instructions.

LENGTHY TABLE REFERENCED HERE
US20070027787A1-20070201-T00385
Please refer to the end of the specification for access instructions.

LENGTHY TABLE REFERENCED HERE
US20070027787A1-20070201-T00386
Please refer to the end of the specification for access instructions.

LENGTHY TABLE REFERENCED HERE
US20070027787A1-20070201-T00387
Please refer to the end of the specification for access instructions.

LENGTHY TABLE REFERENCED HERE
US20070027787A1-20070201-T00388
Please refer to the end of the specification for access instructions.

LENGTHY TABLE REFERENCED HERE
US20070027787A1-20070201-T00389
Please refer to the end of the specification for access instructions.

LENGTHY TABLE REFERENCED HERE
US20070027787A1-20070201-T00390
Please refer to the end of the specification for access instructions.

LENGTHY TABLE REFERENCED HERE
US20070027787A1-20070201-T00391
Please refer to the end of the specification for access instructions.

LENGTHY TABLE REFERENCED HERE
US20070027787A1-20070201-T00392
Please refer to the end of the specification for access instructions.

LENGTHY TABLE REFERENCED HERE
US20070027787A1-20070201-T00393
Please refer to the end of the specification for access instructions.

LENGTHY TABLE REFERENCED HERE
US20070027787A1-20070201-T00394
Please refer to the end of the specification for access instructions.

LENGTHY TABLE REFERENCED HERE
US20070027787A1-20070201-T00395
Please refer to the end of the specification for access instructions.

LENGTHY TABLE REFERENCED HERE
US20070027787A1-20070201-T00396
Please refer to the end of the specification for access instructions.

LENGTHY TABLE REFERENCED HERE
US20070027787A1-20070201-T00397
Please refer to the end of the specification for access instructions.

LENGTHY TABLE REFERENCED HERE
US20070027787A1-20070201-T00398
Please refer to the end of the specification for access instructions.

LENGTHY TABLE REFERENCED HERE
US20070027787A1-20070201-T00399
Please refer to the end of the specification for access instructions.

LENGTHY TABLE REFERENCED HERE
US20070027787A1-20070201-T00400
Please refer to the end of the specification for access instructions.

LENGTHY TABLE REFERENCED HERE
US20070027787A1-20070201-T00401
Please refer to the end of the specification for access instructions.

LENGTHY TABLE REFERENCED HERE
US20070027787A1-20070201-T00402
Please refer to the end of the specification for access instructions.

LENGTHY TABLE REFERENCED HERE
US20070027787A1-20070201-T00403
Please refer to the end of the specification for access instructions.

LENGTHY TABLE REFERENCED HERE
US20070027787A1-20070201-T00404
Please refer to the end of the specification for access instructions.

LENGTHY TABLE REFERENCED HERE
US20070027787A1-20070201-T00405
Please refer to the end of the specification for access instructions.

LENGTHY TABLE REFERENCED HERE
US20070027787A1-20070201-T00406
Please refer to the end of the specification for access instructions.

LENGTHY TABLE REFERENCED HERE
US20070027787A1-20070201-T00407
Please refer to the end of the specification for access instructions.

LENGTHY TABLE REFERENCED HERE
US20070027787A1-20070201-T00408
Please refer to the end of the specification for access instructions.

LENGTHY TABLE REFERENCED HERE
US20070027787A1-20070201-T00409
Please refer to the end of the specification for access instructions.

LENGTHY TABLE REFERENCED HERE
US20070027787A1-20070201-T00410
Please refer to the end of the specification for access instructions.

LENGTHY TABLE REFERENCED HERE
US20070027787A1-20070201-T00411
Please refer to the end of the specification for access instructions.

LENGTHY TABLE REFERENCED HERE
US20070027787A1-20070201-T00412
Please refer to the end of the specification for access instructions.

LENGTHY TABLE REFERENCED HERE
US20070027787A1-20070201-T00413
Please refer to the end of the specification for access instructions.

LENGTHY TABLE REFERENCED HERE
US20070027787A1-20070201-T00414
Please refer to the end of the specification for access instructions.

LENGTHY TABLE REFERENCED HERE
US20070027787A1-20070201-T00415
Please refer to the end of the specification for access instructions.

LENGTHY TABLE REFERENCED HERE
US20070027787A1-20070201-T00416
Please refer to the end of the specification for access instructions.

LENGTHY TABLE REFERENCED HERE
US20070027787A1-20070201-T00417
Please refer to the end of the specification for access instructions.

LENGTHY TABLE REFERENCED HERE
US20070027787A1-20070201-T00418
Please refer to the end of the specification for access instructions.

LENGTHY TABLE REFERENCED HERE
US20070027787A1-20070201-T00419
Please refer to the end of the specification for access instructions.

LENGTHY TABLE REFERENCED HERE
US20070027787A1-20070201-T00420
Please refer to the end of the specification for access instructions.

LENGTHY TABLE REFERENCED HERE
US20070027787A1-20070201-T00421
Please refer to the end of the specification for access instructions.

LENGTHY TABLE REFERENCED HERE
US20070027787A1-20070201-T00422
Please refer to the end of the specification for access instructions.

LENGTHY TABLE REFERENCED HERE
US20070027787A1-20070201-T00423
Please refer to the end of the specification for access instructions.

LENGTHY TABLE REFERENCED HERE
US20070027787A1-20070201-T00424
Please refer to the end of the specification for access instructions.

LENGTHY TABLE REFERENCED HERE
US20070027787A1-20070201-T00425
Please refer to the end of the specification for access instructions.

LENGTHY TABLE REFERENCED HERE
US20070027787A1-20070201-T00426
Please refer to the end of the specification for access instructions.

LENGTHY TABLE REFERENCED HERE
US20070027787A1-20070201-T00427
Please refer to the end of the specification for access instructions.

LENGTHY TABLE REFERENCED HERE
US20070027787A1-20070201-T00428
Please refer to the end of the specification for access instructions.

LENGTHY TABLE REFERENCED HERE
US20070027787A1-20070201-T00429
Please refer to the end of the specification for access instructions.

LENGTHY TABLE REFERENCED HERE
US20070027787A1-20070201-T00430
Please refer to the end of the specification for access instructions.

LENGTHY TABLE REFERENCED HERE
US20070027787A1-20070201-T00431
Please refer to the end of the specification for access instructions.

LENGTHY TABLE REFERENCED HERE
US20070027787A1-20070201-T00432
Please refer to the end of the specification for access instructions.

LENGTHY TABLE REFERENCED HERE
US20070027787A1-20070201-T00433
Please refer to the end of the specification for access instructions.

LENGTHY TABLE REFERENCED HERE
US20070027787A1-20070201-T00434
Please refer to the end of the specification for access instructions.

LENGTHY TABLE REFERENCED HERE
US20070027787A1-20070201-T00435
Please refer to the end of the specification for access instructions.

LENGTHY TABLE REFERENCED HERE
US20070027787A1-20070201-T00436
Please refer to the end of the specification for access instructions.

LENGTHY TABLE REFERENCED HERE
US20070027787A1-20070201-T00437
Please refer to the end of the specification for access instructions.

LENGTHY TABLE REFERENCED HERE
US20070027787A1-20070201-T00438
Please refer to the end of the specification for access instructions.

LENGTHY TABLE REFERENCED HERE
US20070027787A1-20070201-T00439
Please refer to the end of the specification for access instructions.

LENGTHY TABLE REFERENCED HERE
US20070027787A1-20070201-T00440
Please refer to the end of the specification for access instructions.

LENGTHY TABLE REFERENCED HERE
US20070027787A1-20070201-T00441
Please refer to the end of the specification for access instructions.

LENGTHY TABLE REFERENCED HERE
US20070027787A1-20070201-T00442
Please refer to the end of the specification for access instructions.

LENGTHY TABLE REFERENCED HERE
US20070027787A1-20070201-T00443
Please refer to the end of the specification for access instructions.

LENGTHY TABLE REFERENCED HERE
US20070027787A1-20070201-T00444
Please refer to the end of the specification for access instructions.

LENGTHY TABLE REFERENCED HERE
US20070027787A1-20070201-T00445
Please refer to the end of the specification for access instructions.

LENGTHY TABLE REFERENCED HERE
US20070027787A1-20070201-T00446
Please refer to the end of the specification for access instructions.

LENGTHY TABLE REFERENCED HERE
US20070027787A1-20070201-T00447
Please refer to the end of the specification for access instructions.

LENGTHY TABLE REFERENCED HERE
US20070027787A1-20070201-T00448
Please refer to the end of the specification for access instructions.

LENGTHY TABLE REFERENCED HERE
US20070027787A1-20070201-T00449
Please refer to the end of the specification for access instructions.

LENGTHY TABLE REFERENCED HERE
US20070027787A1-20070201-T00450
Please refer to the end of the specification for access instructions.

LENGTHY TABLE REFERENCED HERE
US20070027787A1-20070201-T00451
Please refer to the end of the specification for access instructions.

LENGTHY TABLE REFERENCED HERE
US20070027787A1-20070201-T00452
Please refer to the end of the specification for access instructions.

LENGTHY TABLE REFERENCED HERE
US20070027787A1-20070201-T00453
Please refer to the end of the specification for access instructions.

LENGTHY TABLE REFERENCED HERE
US20070027787A1-20070201-T00454
Please refer to the end of the specification for access instructions.

LENGTHY TABLE REFERENCED HERE
US20070027787A1-20070201-T00455
Please refer to the end of the specification for access instructions.

LENGTHY TABLE REFERENCED HERE
US20070027787A1-20070201-T00456
Please refer to the end of the specification for access instructions.

LENGTHY TABLE REFERENCED HERE
US20070027787A1-20070201-T00457
Please refer to the end of the specification for access instructions.

LENGTHY TABLE REFERENCED HERE
US20070027787A1-20070201-T00458
Please refer to the end of the specification for access instructions.

LENGTHY TABLE REFERENCED HERE
US20070027787A1-20070201-T00459
Please refer to the end of the specification for access instructions.

LENGTHY TABLE REFERENCED HERE
US20070027787A1-20070201-T00460
Please refer to the end of the specification for access instructions.

LENGTHY TABLE REFERENCED HERE
US20070027787A1-20070201-T00461
Please refer to the end of the specification for access instructions.

LENGTHY TABLE REFERENCED HERE
US20070027787A1-20070201-T00462
Please refer to the end of the specification for access instructions.

LENGTHY TABLE REFERENCED HERE
US20070027787A1-20070201-T00463
Please refer to the end of the specification for access instructions.

LENGTHY TABLE REFERENCED HERE
US20070027787A1-20070201-T00464
Please refer to the end of the specification for access instructions.

LENGTHY TABLE REFERENCED HERE
US20070027787A1-20070201-T00465
Please refer to the end of the specification for access instructions.

LENGTHY TABLE REFERENCED HERE
US20070027787A1-20070201-T00466
Please refer to the end of the specification for access instructions.

LENGTHY TABLE REFERENCED HERE
US20070027787A1-20070201-T00467
Please refer to the end of the specification for access instructions.

LENGTHY TABLE REFERENCED HERE
US20070027787A1-20070201-T00468
Please refer to the end of the specification for access instructions.

LENGTHY TABLE REFERENCED HERE
US20070027787A1-20070201-T00469
Please refer to the end of the specification for access instructions.

LENGTHY TABLE REFERENCED HERE
US20070027787A1-20070201-T00470
Please refer to the end of the specification for access instructions.

LENGTHY TABLE REFERENCED HERE
US20070027787A1-20070201-T00471
Please refer to the end of the specification for access instructions.

LENGTHY TABLE REFERENCED HERE
US20070027787A1-20070201-T00472
Please refer to the end of the specification for access instructions.

LENGTHY TABLE REFERENCED HERE
US20070027787A1-20070201-T00473
Please refer to the end of the specification for access instructions.

LENGTHY TABLE REFERENCED HERE
US20070027787A1-20070201-T00474
Please refer to the end of the specification for access instructions.

LENGTHY TABLE REFERENCED HERE
US20070027787A1-20070201-T00475
Please refer to the end of the specification for access instructions.

LENGTHY TABLE REFERENCED HERE
US20070027787A1-20070201-T00476
Please refer to the end of the specification for access instructions.

LENGTHY TABLE REFERENCED HERE
US20070027787A1-20070201-T00477
Please refer to the end of the specification for access instructions.

LENGTHY TABLE REFERENCED HERE
US20070027787A1-20070201-T00478
Please refer to the end of the specification for access instructions.

LENGTHY TABLE REFERENCED HERE
US20070027787A1-20070201-T00479
Please refer to the end of the specification for access instructions.

LENGTHY TABLE REFERENCED HERE
US20070027787A1-20070201-T00480
Please refer to the end of the specification for access instructions.

LENGTHY TABLE REFERENCED HERE
US20070027787A1-20070201-T00481
Please refer to the end of the specification for access instructions.

LENGTHY TABLE REFERENCED HERE
US20070027787A1-20070201-T00482
Please refer to the end of the specification for access instructions.

LENGTHY TABLE REFERENCED HERE
US20070027787A1-20070201-T00483
Please refer to the end of the specification for access instructions.

LENGTHY TABLE REFERENCED HERE
US20070027787A1-20070201-T00484
Please refer to the end of the specification for access instructions.

LENGTHY TABLE REFERENCED HERE
US20070027787A1-20070201-T00485
Please refer to the end of the specification for access instructions.

LENGTHY TABLE REFERENCED HERE
US20070027787A1-20070201-T00486
Please refer to the end of the specification for access instructions.

LENGTHY TABLE REFERENCED HERE
US20070027787A1-20070201-T00487
Please refer to the end of the specification for access instructions.

LENGTHY TABLE REFERENCED HERE
US20070027787A1-20070201-T00488
Please refer to the end of the specification for access instructions.

LENGTHY TABLE REFERENCED HERE
US20070027787A1-20070201-T00489
Please refer to the end of the specification for access instructions.

LENGTHY TABLE REFERENCED HERE
US20070027787A1-20070201-T00490
Please refer to the end of the specification for access instructions.

LENGTHY TABLE REFERENCED HERE
US20070027787A1-20070201-T00491
Please refer to the end of the specification for access instructions.

LENGTHY TABLE REFERENCED HERE
US20070027787A1-20070201-T00492
Please refer to the end of the specification for access instructions.

LENGTHY TABLE REFERENCED HERE
US20070027787A1-20070201-T00493
Please refer to the end of the specification for access instructions.

LENGTHY TABLE REFERENCED HERE
US20070027787A1-20070201-T00494
Please refer to the end of the specification for access instructions.

LENGTHY TABLE REFERENCED HERE
US20070027787A1-20070201-T00495
Please refer to the end of the specification for access instructions.

LENGTHY TABLE REFERENCED HERE
US20070027787A1-20070201-T00496
Please refer to the end of the specification for access instructions.

LENGTHY TABLE REFERENCED HERE
US20070027787A1-20070201-T00497
Please refer to the end of the specification for access instructions.

LENGTHY TABLE REFERENCED HERE
US20070027787A1-20070201-T00498
Please refer to the end of the specification for access instructions.

LENGTHY TABLE REFERENCED HERE
US20070027787A1-20070201-T00499
Please refer to the end of the specification for access instructions.

LENGTHY TABLE REFERENCED HERE
US20070027787A1-20070201-T00500
Please refer to the end of the specification for access instructions.

LENGTHY TABLE REFERENCED HERE
US20070027787A1-20070201-T00501
Please refer to the end of the specification for access instructions.

LENGTHY TABLE REFERENCED HERE
US20070027787A1-20070201-T00502
Please refer to the end of the specification for access instructions.

LENGTHY TABLE REFERENCED HERE
US20070027787A1-20070201-T00503
Please refer to the end of the specification for access instructions.

LENGTHY TABLE REFERENCED HERE
US20070027787A1-20070201-T00504
Please refer to the end of the specification for access instructions.

LENGTHY TABLE REFERENCED HERE
US20070027787A1-20070201-T00505
Please refer to the end of the specification for access instructions.

LENGTHY TABLE REFERENCED HERE
US20070027787A1-20070201-T00506
Please refer to the end of the specification for access instructions.

LENGTHY TABLE REFERENCED HERE
US20070027787A1-20070201-T00507
Please refer to the end of the specification for access instructions.

LENGTHY TABLE REFERENCED HERE
US20070027787A1-20070201-T00508
Please refer to the end of the specification for access instructions.

LENGTHY TABLE REFERENCED HERE
US20070027787A1-20070201-T00509
Please refer to the end of the specification for access instructions.

LENGTHY TABLE REFERENCED HERE
US20070027787A1-20070201-T00510
Please refer to the end of the specification for access instructions.

LENGTHY TABLE REFERENCED HERE
US20070027787A1-20070201-T00511
Please refer to the end of the specification for access instructions.

LENGTHY TABLE REFERENCED HERE
US20070027787A1-20070201-T00512
Please refer to the end of the specification for access instructions.

LENGTHY TABLE REFERENCED HERE
US20070027787A1-20070201-T00513
Please refer to the end of the specification for access instructions.

LENGTHY TABLE REFERENCED HERE
US20070027787A1-20070201-T00514
Please refer to the end of the specification for access instructions.

LENGTHY TABLE REFERENCED HERE
US20070027787A1-20070201-T00515
Please refer to the end of the specification for access instructions.

LENGTHY TABLE REFERENCED HERE
US20070027787A1-20070201-T00516
Please refer to the end of the specification for access instructions.

LENGTHY TABLE REFERENCED HERE
US20070027787A1-20070201-T00517
Please refer to the end of the specification for access instructions.

LENGTHY TABLE REFERENCED HERE
US20070027787A1-20070201-T00518
Please refer to the end of the specification for access instructions.

LENGTHY TABLE REFERENCED HERE
US20070027787A1-20070201-T00519
Please refer to the end of the specification for access instructions.

LENGTHY TABLE REFERENCED HERE
US20070027787A1-20070201-T00520
Please refer to the end of the specification for access instructions.

LENGTHY TABLE REFERENCED HERE
US20070027787A1-20070201-T00521
Please refer to the end of the specification for access instructions.

LENGTHY TABLE REFERENCED HERE
US20070027787A1-20070201-T00522
Please refer to the end of the specification for access instructions.

LENGTHY TABLE REFERENCED HERE
US20070027787A1-20070201-T00523
Please refer to the end of the specification for access instructions.

LENGTHY TABLE REFERENCED HERE
US20070027787A1-20070201-T00524
Please refer to the end of the specification for access instructions.

LENGTHY TABLE REFERENCED HERE
US20070027787A1-20070201-T00525
Please refer to the end of the specification for access instructions.

LENGTHY TABLE REFERENCED HERE
US20070027787A1-20070201-T00526
Please refer to the end of the specification for access instructions.

LENGTHY TABLE REFERENCED HERE
US20070027787A1-20070201-T00527
Please refer to the end of the specification for access instructions.

LENGTHY TABLE REFERENCED HERE
US20070027787A1-20070201-T00528
Please refer to the end of the specification for access instructions.

LENGTHY TABLE REFERENCED HERE
US20070027787A1-20070201-T00529
Please refer to the end of the specification for access instructions.

LENGTHY TABLE REFERENCED HERE
US20070027787A1-20070201-T00530
Please refer to the end of the specification for access instructions.

LENGTHY TABLE REFERENCED HERE
US20070027787A1-20070201-T00531
Please refer to the end of the specification for access instructions.

LENGTHY TABLE REFERENCED HERE
US20070027787A1-20070201-T00532
Please refer to the end of the specification for access instructions.

LENGTHY TABLE REFERENCED HERE
US20070027787A1-20070201-T00533
Please refer to the end of the specification for access instructions.

LENGTHY TABLE REFERENCED HERE
US20070027787A1-20070201-T00534
Please refer to the end of the specification for access instructions.

LENGTHY TABLE REFERENCED HERE
US20070027787A1-20070201-T00535
Please refer to the end of the specification for access instructions.

LENGTHY TABLE REFERENCED HERE
US20070027787A1-20070201-T00536
Please refer to the end of the specification for access instructions.

LENGTHY TABLE REFERENCED HERE
US20070027787A1-20070201-T00537
Please refer to the end of the specification for access instructions.

LENGTHY TABLE REFERENCED HERE
US20070027787A1-20070201-T00538
Please refer to the end of the specification for access instructions.

LENGTHY TABLE REFERENCED HERE
US20070027787A1-20070201-T00539
Please refer to the end of the specification for access instructions.

LENGTHY TABLE REFERENCED HERE
US20070027787A1-20070201-T00540
Please refer to the end of the specification for access instructions.

LENGTHY TABLE REFERENCED HERE
US20070027787A1-20070201-T00541
Please refer to the end of the specification for access instructions.

LENGTHY TABLE REFERENCED HERE
US20070027787A1-20070201-T00542
Please refer to the end of the specification for access instructions.

LENGTHY TABLE REFERENCED HERE
US20070027787A1-20070201-T00543
Please refer to the end of the specification for access instructions.

LENGTHY TABLE REFERENCED HERE
US20070027787A1-20070201-T00544
Please refer to the end of the specification for access instructions.

LENGTHY TABLE REFERENCED HERE
US20070027787A1-20070201-T00545
Please refer to the end of the specification for access instructions.

LENGTHY TABLE REFERENCED HERE
US20070027787A1-20070201-T00546
Please refer to the end of the specification for access instructions.

LENGTHY TABLE REFERENCED HERE
US20070027787A1-20070201-T00547
Please refer to the end of the specification for access instructions.

LENGTHY TABLE REFERENCED HERE
US20070027787A1-20070201-T00548
Please refer to the end of the specification for access instructions.

LENGTHY TABLE REFERENCED HERE
US20070027787A1-20070201-T00549
Please refer to the end of the specification for access instructions.

LENGTHY TABLE REFERENCED HERE
US20070027787A1-20070201-T00550
Please refer to the end of the specification for access instructions.

LENGTHY TABLE REFERENCED HERE
US20070027787A1-20070201-T00551
Please refer to the end of the specification for access instructions.

LENGTHY TABLE REFERENCED HERE
US20070027787A1-20070201-T00552
Please refer to the end of the specification for access instructions.

LENGTHY TABLE REFERENCED HERE
US20070027787A1-20070201-T00553
Please refer to the end of the specification for access instructions.

LENGTHY TABLE REFERENCED HERE
US20070027787A1-20070201-T00554
Please refer to the end of the specification for access instructions.

LENGTHY TABLE REFERENCED HERE
US20070027787A1-20070201-T00555
Please refer to the end of the specification for access instructions.

LENGTHY TABLE REFERENCED HERE
US20070027787A1-20070201-T00556
Please refer to the end of the specification for access instructions.

LENGTHY TABLE REFERENCED HERE
US20070027787A1-20070201-T00557
Please refer to the end of the specification for access instructions.

LENGTHY TABLE REFERENCED HERE
US20070027787A1-20070201-T00558
Please refer to the end of the specification for access instructions.

LENGTHY TABLE REFERENCED HERE
US20070027787A1-20070201-T00559
Please refer to the end of the specification for access instructions.

LENGTHY TABLE REFERENCED HERE
US20070027787A1-20070201-T00560
Please refer to the end of the specification for access instructions.

LENGTHY TABLE REFERENCED HERE
US20070027787A1-20070201-T00561
Please refer to the end of the specification for access instructions.

LENGTHY TABLE REFERENCED HERE
US20070027787A1-20070201-T00562
Please refer to the end of the specification for access instructions.

LENGTHY TABLE REFERENCED HERE
US20070027787A1-20070201-T00563
Please refer to the end of the specification for access instructions.

LENGTHY TABLE REFERENCED HERE
US20070027787A1-20070201-T00564
Please refer to the end of the specification for access instructions.

LENGTHY TABLE REFERENCED HERE
US20070027787A1-20070201-T00565
Please refer to the end of the specification for access instructions.

LENGTHY TABLE REFERENCED HERE
US20070027787A1-20070201-T00566
Please refer to the end of the specification for access instructions.

LENGTHY TABLE REFERENCED HERE
US20070027787A1-20070201-T00567
Please refer to the end of the specification for access instructions.

LENGTHY TABLE REFERENCED HERE
US20070027787A1-20070201-T00568
Please refer to the end of the specification for access instructions.

LENGTHY TABLE REFERENCED HERE
US20070027787A1-20070201-T00569
Please refer to the end of the specification for access instructions.

LENGTHY TABLE REFERENCED HERE
US20070027787A1-20070201-T00570
Please refer to the end of the specification for access instructions.

LENGTHY TABLE REFERENCED HERE
US20070027787A1-20070201-T00571
Please refer to the end of the specification for access instructions.

LENGTHY TABLE REFERENCED HERE
US20070027787A1-20070201-T00572
Please refer to the end of the specification for access instructions.

LENGTHY TABLE REFERENCED HERE
US20070027787A1-20070201-T00573
Please refer to the end of the specification for access instructions.

LENGTHY TABLE REFERENCED HERE
US20070027787A1-20070201-T00574
Please refer to the end of the specification for access instructions.

LENGTHY TABLE REFERENCED HERE
US20070027787A1-20070201-T00575
Please refer to the end of the specification for access instructions.

LENGTHY TABLE REFERENCED HERE
US20070027787A1-20070201-T00576
Please refer to the end of the specification for access instructions.

LENGTHY TABLE REFERENCED HERE
US20070027787A1-20070201-T00577
Please refer to the end of the specification for access instructions.

LENGTHY TABLE REFERENCED HERE
US20070027787A1-20070201-T00578
Please refer to the end of the specification for access instructions.

LENGTHY TABLE REFERENCED HERE
US20070027787A1-20070201-T00579
Please refer to the end of the specification for access instructions.

LENGTHY TABLE REFERENCED HERE
US20070027787A1-20070201-T00580
Please refer to the end of the specification for access instructions.

LENGTHY TABLE REFERENCED HERE
US20070027787A1-20070201-T00581
Please refer to the end of the specification for access instructions.

LENGTHY TABLE REFERENCED HERE
US20070027787A1-20070201-T00582
Please refer to the end of the specification for access instructions.

LENGTHY TABLE REFERENCED HERE
US20070027787A1-20070201-T00583
Please refer to the end of the specification for access instructions.

LENGTHY TABLE REFERENCED HERE
US20070027787A1-20070201-T00584
Please refer to the end of the specification for access instructions.

LENGTHY TABLE REFERENCED HERE
US20070027787A1-20070201-T00585
Please refer to the end of the specification for access instructions.

LENGTHY TABLE REFERENCED HERE
US20070027787A1-20070201-T00586
Please refer to the end of the specification for access instructions.

LENGTHY TABLE REFERENCED HERE
US20070027787A1-20070201-T00587
Please refer to the end of the specification for access instructions.

LENGTHY TABLE REFERENCED HERE
US20070027787A1-20070201-T00588
Please refer to the end of the specification for access instructions.

LENGTHY TABLE REFERENCED HERE
US20070027787A1-20070201-T00589
Please refer to the end of the specification for access instructions.

LENGTHY TABLE REFERENCED HERE
US20070027787A1-20070201-T00590
Please refer to the end of the specification for access instructions.

LENGTHY TABLE REFERENCED HERE
US20070027787A1-20070201-T00591
Please refer to the end of the specification for access instructions.

LENGTHY TABLE REFERENCED HERE
US20070027787A1-20070201-T00592
Please refer to the end of the specification for access instructions.

LENGTHY TABLE REFERENCED HERE
US20070027787A1-20070201-T00593
Please refer to the end of the specification for access instructions.

LENGTHY TABLE REFERENCED HERE
US20070027787A1-20070201-T00594
Please refer to the end of the specification for access instructions.

LENGTHY TABLE REFERENCED HERE
US20070027787A1-20070201-T00595
Please refer to the end of the specification for access instructions.

LENGTHY TABLE REFERENCED HERE
US20070027787A1-20070201-T00596
Please refer to the end of the specification for access instructions.

LENGTHY TABLE REFERENCED HERE
US20070027787A1-20070201-T00597
Please refer to the end of the specification for access instructions.

LENGTHY TABLE REFERENCED HERE
US20070027787A1-20070201-T00598
Please refer to the end of the specification for access instructions.

LENGTHY TABLE REFERENCED HERE
US20070027787A1-20070201-T00599
Please refer to the end of the specification for access instructions.

LENGTHY TABLE REFERENCED HERE
US20070027787A1-20070201-T00600
Please refer to the end of the specification for access instructions.

LENGTHY TABLE REFERENCED HERE
US20070027787A1-20070201-T00601
Please refer to the end of the specification for access instructions.

LENGTHY TABLE REFERENCED HERE
US20070027787A1-20070201-T00602
Please refer to the end of the specification for access instructions.

LENGTHY TABLE REFERENCED HERE
US20070027787A1-20070201-T00603
Please refer to the end of the specification for access instructions.

LENGTHY TABLE REFERENCED HERE
US20070027787A1-20070201-T00604
Please refer to the end of the specification for access instructions.

LENGTHY TABLE REFERENCED HERE
US20070027787A1-20070201-T00605
Please refer to the end of the specification for access instructions.

LENGTHY TABLE REFERENCED HERE
US20070027787A1-20070201-T00606
Please refer to the end of the specification for access instructions.

LENGTHY TABLE REFERENCED HERE
US20070027787A1-20070201-T00607
Please refer to the end of the specification for access instructions.

LENGTHY TABLE REFERENCED HERE
US20070027787A1-20070201-T00608
Please refer to the end of the specification for access instructions.

LENGTHY TABLE REFERENCED HERE
US20070027787A1-20070201-T00609
Please refer to the end of the specification for access instructions.

LENGTHY TABLE REFERENCED HERE
US20070027787A1-20070201-T00610
Please refer to the end of the specification for access instructions.

LENGTHY TABLE REFERENCED HERE
US20070027787A1-20070201-T00611
Please refer to the end of the specification for access instructions.

LENGTHY TABLE REFERENCED HERE
US20070027787A1-20070201-T00612
Please refer to the end of the specification for access instructions.

LENGTHY TABLE REFERENCED HERE
US20070027787A1-20070201-T00613
Please refer to the end of the specification for access instructions.

LENGTHY TABLE REFERENCED HERE
US20070027787A1-20070201-T00614
Please refer to the end of the specification for access instructions.

LENGTHY TABLE REFERENCED HERE
US20070027787A1-20070201-T00615
Please refer to the end of the specification for access instructions.

LENGTHY TABLE REFERENCED HERE
US20070027787A1-20070201-T00616
Please refer to the end of the specification for access instructions.

LENGTHY TABLE REFERENCED HERE
US20070027787A1-20070201-T00617
Please refer to the end of the specification for access instructions.

LENGTHY TABLE REFERENCED HERE
US20070027787A1-20070201-T00618
Please refer to the end of the specification for access instructions.

LENGTHY TABLE REFERENCED HERE
US20070027787A1-20070201-T00619
Please refer to the end of the specification for access instructions.

LENGTHY TABLE REFERENCED HERE
US20070027787A1-20070201-T00620
Please refer to the end of the specification for access instructions.

LENGTHY TABLE REFERENCED HERE
US20070027787A1-20070201-T00621
Please refer to the end of the specification for access instructions.

LENGTHY TABLE REFERENCED HERE
US20070027787A1-20070201-T00622
Please refer to the end of the specification for access instructions.

LENGTHY TABLE REFERENCED HERE
US20070027787A1-20070201-T00623
Please refer to the end of the specification for access instructions.

LENGTHY TABLE REFERENCED HERE
US20070027787A1-20070201-T00624
Please refer to the end of the specification for access instructions.

LENGTHY TABLE REFERENCED HERE
US20070027787A1-20070201-T00625
Please refer to the end of the specification for access instructions.

LENGTHY TABLE REFERENCED HERE
US20070027787A1-20070201-T00626
Please refer to the end of the specification for access instructions.

LENGTHY TABLE REFERENCED HERE
US20070027787A1-20070201-T00627
Please refer to the end of the specification for access instructions.

LENGTHY TABLE REFERENCED HERE
US20070027787A1-20070201-T00628
Please refer to the end of the specification for access instructions.

LENGTHY TABLE REFERENCED HERE
US20070027787A1-20070201-T00629
Please refer to the end of the specification for access instructions.

LENGTHY TABLE REFERENCED HERE
US20070027787A1-20070201-T00630
Please refer to the end of the specification for access instructions.

LENGTHY TABLE REFERENCED HERE
US20070027787A1-20070201-T00631
Please refer to the end of the specification for access instructions.

LENGTHY TABLE REFERENCED HERE
US20070027787A1-20070201-T00632
Please refer to the end of the specification for access instructions.

LENGTHY TABLE REFERENCED HERE
US20070027787A1-20070201-T00633
Please refer to the end of the specification for access instructions.

LENGTHY TABLE REFERENCED HERE
US20070027787A1-20070201-T00634
Please refer to the end of the specification for access instructions.

LENGTHY TABLE REFERENCED HERE
US20070027787A1-20070201-T00635
Please refer to the end of the specification for access instructions.

LENGTHY TABLE REFERENCED HERE
US20070027787A1-20070201-T00636
Please refer to the end of the specification for access instructions.

LENGTHY TABLE REFERENCED HERE
US20070027787A1-20070201-T00637
Please refer to the end of the specification for access instructions.

LENGTHY TABLE REFERENCED HERE
US20070027787A1-20070201-T00638
Please refer to the end of the specification for access instructions.

LENGTHY TABLE REFERENCED HERE
US20070027787A1-20070201-T00639
Please refer to the end of the specification for access instructions.

LENGTHY TABLE REFERENCED HERE
US20070027787A1-20070201-T00640
Please refer to the end of the specification for access instructions.

LENGTHY TABLE REFERENCED HERE
US20070027787A1-20070201-T00641
Please refer to the end of the specification for access instructions.

LENGTHY TABLE REFERENCED HERE
US20070027787A1-20070201-T00642
Please refer to the end of the specification for access instructions.

LENGTHY TABLE REFERENCED HERE
US20070027787A1-20070201-T00643
Please refer to the end of the specification for access instructions.

LENGTHY TABLE REFERENCED HERE
US20070027787A1-20070201-T00644
Please refer to the end of the specification for access instructions.

LENGTHY TABLE REFERENCED HERE
US20070027787A1-20070201-T00645
Please refer to the end of the specification for access instructions.

LENGTHY TABLE REFERENCED HERE
US20070027787A1-20070201-T00646
Please refer to the end of the specification for access instructions.

LENGTHY TABLE REFERENCED HERE
US20070027787A1-20070201-T00647
Please refer to the end of the specification for access instructions.

LENGTHY TABLE REFERENCED HERE
US20070027787A1-20070201-T00648
Please refer to the end of the specification for access instructions.

LENGTHY TABLE REFERENCED HERE
US20070027787A1-20070201-T00649
Please refer to the end of the specification for access instructions.

LENGTHY TABLE REFERENCED HERE
US20070027787A1-20070201-T00650
Please refer to the end of the specification for access instructions.

LENGTHY TABLE REFERENCED HERE
US20070027787A1-20070201-T00651
Please refer to the end of the specification for access instructions.

LENGTHY TABLE REFERENCED HERE
US20070027787A1-20070201-T00652
Please refer to the end of the specification for access instructions.

LENGTHY TABLE REFERENCED HERE
US20070027787A1-20070201-T00653
Please refer to the end of the specification for access instructions.

LENGTHY TABLE REFERENCED HERE
US20070027787A1-20070201-T00654
Please refer to the end of the specification for access instructions.

LENGTHY TABLE REFERENCED HERE
US20070027787A1-20070201-T00655
Please refer to the end of the specification for access instructions.

LENGTHY TABLE REFERENCED HERE
US20070027787A1-20070201-T00656
Please refer to the end of the specification for access instructions.

LENGTHY TABLE REFERENCED HERE
US20070027787A1-20070201-T00657
Please refer to the end of the specification for access instructions.

LENGTHY TABLE REFERENCED HERE
US20070027787A1-20070201-T00658
Please refer to the end of the specification for access instructions.

LENGTHY TABLE REFERENCED HERE
US20070027787A1-20070201-T00659
Please refer to the end of the specification for access instructions.

LENGTHY TABLE REFERENCED HERE
US20070027787A1-20070201-T00660
Please refer to the end of the specification for access instructions.

LENGTHY TABLE REFERENCED HERE
US20070027787A1-20070201-T00661
Please refer to the end of the specification for access instructions.

LENGTHY TABLE REFERENCED HERE
US20070027787A1-20070201-T00662
Please refer to the end of the specification for access instructions.

LENGTHY TABLE REFERENCED HERE
US20070027787A1-20070201-T00663
Please refer to the end of the specification for access instructions.

LENGTHY TABLE REFERENCED HERE
US20070027787A1-20070201-T00664
Please refer to the end of the specification for access instructions.

LENGTHY TABLE REFERENCED HERE
US20070027787A1-20070201-T00665
Please refer to the end of the specification for access instructions.

LENGTHY TABLE REFERENCED HERE
US20070027787A1-20070201-T00666
Please refer to the end of the specification for access instructions.

LENGTHY TABLE REFERENCED HERE
US20070027787A1-20070201-T00667
Please refer to the end of the specification for access instructions.

LENGTHY TABLE REFERENCED HERE
US20070027787A1-20070201-T00668
Please refer to the end of the specification for access instructions.

LENGTHY TABLE REFERENCED HERE
US20070027787A1-20070201-T00669
Please refer to the end of the specification for access instructions.

LENGTHY TABLE REFERENCED HERE
US20070027787A1-20070201-T00670
Please refer to the end of the specification for access instructions.

LENGTHY TABLE REFERENCED HERE
US20070027787A1-20070201-T00671
Please refer to the end of the specification for access instructions.

LENGTHY TABLE REFERENCED HERE
US20070027787A1-20070201-T00672
Please refer to the end of the specification for access instructions.

LENGTHY TABLE REFERENCED HERE
US20070027787A1-20070201-T00673
Please refer to the end of the specification for access instructions.

LENGTHY TABLE REFERENCED HERE
US20070027787A1-20070201-T00674
Please refer to the end of the specification for access instructions.

LENGTHY TABLE REFERENCED HERE
US20070027787A1-20070201-T00675
Please refer to the end of the specification for access instructions.

LENGTHY TABLE REFERENCED HERE
US20070027787A1-20070201-T00676
Please refer to the end of the specification for access instructions.

LENGTHY TABLE REFERENCED HERE
US20070027787A1-20070201-T00677
Please refer to the end of the specification for access instructions.

LENGTHY TABLE REFERENCED HERE
US20070027787A1-20070201-T00678
Please refer to the end of the specification for access instructions.

LENGTHY TABLE REFERENCED HERE
US20070027787A1-20070201-T00679
Please refer to the end of the specification for access instructions.

LENGTHY TABLE REFERENCED HERE
US20070027787A1-20070201-T00680
Please refer to the end of the specification for access instructions.

LENGTHY TABLE REFERENCED HERE
US20070027787A1-20070201-T00681
Please refer to the end of the specification for access instructions.

LENGTHY TABLE REFERENCED HERE
US20070027787A1-20070201-T00682
Please refer to the end of the specification for access instructions.

LENGTHY TABLE REFERENCED HERE
US20070027787A1-20070201-T00683
Please refer to the end of the specification for access instructions.

LENGTHY TABLE REFERENCED HERE
US20070027787A1-20070201-T00684
Please refer to the end of the specification for access instructions.

LENGTHY TABLE REFERENCED HERE
US20070027787A1-20070201-T00685
Please refer to the end of the specification for access instructions.

LENGTHY TABLE REFERENCED HERE
US20070027787A1-20070201-T00686
Please refer to the end of the specification for access instructions.

LENGTHY TABLE REFERENCED HERE
US20070027787A1-20070201-T00687
Please refer to the end of the specification for access instructions.

LENGTHY TABLE REFERENCED HERE
US20070027787A1-20070201-T00688
Please refer to the end of the specification for access instructions.

LENGTHY TABLE REFERENCED HERE
US20070027787A1-20070201-T00689
Please refer to the end of the specification for access instructions.

LENGTHY TABLE REFERENCED HERE
US20070027787A1-20070201-T00690
Please refer to the end of the specification for access instructions.

LENGTHY TABLE REFERENCED HERE
US20070027787A1-20070201-T00691
Please refer to the end of the specification for access instructions.

LENGTHY TABLE REFERENCED HERE
US20070027787A1-20070201-T00692
Please refer to the end of the specification for access instructions.

LENGTHY TABLE REFERENCED HERE
US20070027787A1-20070201-T00693
Please refer to the end of the specification for access instructions.

LENGTHY TABLE REFERENCED HERE
US20070027787A1-20070201-T00694
Please refer to the end of the specification for access instructions.

LENGTHY TABLE REFERENCED HERE
US20070027787A1-20070201-T00695
Please refer to the end of the specification for access instructions.

LENGTHY TABLE REFERENCED HERE
US20070027787A1-20070201-T00696
Please refer to the end of the specification for access instructions.

LENGTHY TABLE REFERENCED HERE
US20070027787A1-20070201-T00697
Please refer to the end of the specification for access instructions.

LENGTHY TABLE REFERENCED HERE
US20070027787A1-20070201-T00698
Please refer to the end of the specification for access instructions.

LENGTHY TABLE REFERENCED HERE
US20070027787A1-20070201-T00699
Please refer to the end of the specification for access instructions.

LENGTHY TABLE REFERENCED HERE
US20070027787A1-20070201-T00700
Please refer to the end of the specification for access instructions.

LENGTHY TABLE REFERENCED HERE
US20070027787A1-20070201-T00701
Please refer to the end of the specification for access instructions.

LENGTHY TABLE REFERENCED HERE
US20070027787A1-20070201-T00702
Please refer to the end of the specification for access instructions.

LENGTHY TABLE REFERENCED HERE
US20070027787A1-20070201-T00703
Please refer to the end of the specification for access instructions.

LENGTHY TABLE REFERENCED HERE
US20070027787A1-20070201-T00704
Please refer to the end of the specification for access instructions.

LENGTHY TABLE REFERENCED HERE
US20070027787A1-20070201-T00705
Please refer to the end of the specification for access instructions.

LENGTHY TABLE REFERENCED HERE
US20070027787A1-20070201-T00706
Please refer to the end of the specification for access instructions.

LENGTHY TABLE REFERENCED HERE
US20070027787A1-20070201-T00707
Please refer to the end of the specification for access instructions.

LENGTHY TABLE REFERENCED HERE
US20070027787A1-20070201-T00708
Please refer to the end of the specification for access instructions.

LENGTHY TABLE REFERENCED HERE
US20070027787A1-20070201-T00709
Please refer to the end of the specification for access instructions.

LENGTHY TABLE REFERENCED HERE
US20070027787A1-20070201-T00710
Please refer to the end of the specification for access instructions.

LENGTHY TABLE REFERENCED HERE
US20070027787A1-20070201-T00711
Please refer to the end of the specification for access instructions.

LENGTHY TABLE REFERENCED HERE
US20070027787A1-20070201-T00712
Please refer to the end of the specification for access instructions.

LENGTHY TABLE REFERENCED HERE
US20070027787A1-20070201-T00713
Please refer to the end of the specification for access instructions.

LENGTHY TABLE REFERENCED HERE
US20070027787A1-20070201-T00714
Please refer to the end of the specification for access instructions.

LENGTHY TABLE REFERENCED HERE
US20070027787A1-20070201-T00715
Please refer to the end of the specification for access instructions.

LENGTHY TABLE REFERENCED HERE
US20070027787A1-20070201-T00716
Please refer to the end of the specification for access instructions.

LENGTHY TABLE REFERENCED HERE
US20070027787A1-20070201-T00717
Please refer to the end of the specification for access instructions.

LENGTHY TABLE REFERENCED HERE
US20070027787A1-20070201-T00718
Please refer to the end of the specification for access instructions.

LENGTHY TABLE REFERENCED HERE
US20070027787A1-20070201-T00719
Please refer to the end of the specification for access instructions.

LENGTHY TABLE REFERENCED HERE
US20070027787A1-20070201-T00720
Please refer to the end of the specification for access instructions.

LENGTHY TABLE REFERENCED HERE
US20070027787A1-20070201-T00721
Please refer to the end of the specification for access instructions.

LENGTHY TABLE REFERENCED HERE
US20070027787A1-20070201-T00722
Please refer to the end of the specification for access instructions.

LENGTHY TABLE REFERENCED HERE
US20070027787A1-20070201-T00723
Please refer to the end of the specification for access instructions.

LENGTHY TABLE REFERENCED HERE
US20070027787A1-20070201-T00724
Please refer to the end of the specification for access instructions.

LENGTHY TABLE REFERENCED HERE
US20070027787A1-20070201-T00725
Please refer to the end of the specification for access instructions.

LENGTHY TABLE REFERENCED HERE
US20070027787A1-20070201-T00726
Please refer to the end of the specification for access instructions.

LENGTHY TABLE REFERENCED HERE
US20070027787A1-20070201-T00727
Please refer to the end of the specification for access instructions.

LENGTHY TABLE REFERENCED HERE
US20070027787A1-20070201-T00728
Please refer to the end of the specification for access instructions.

LENGTHY TABLE REFERENCED HERE
US20070027787A1-20070201-T00729
Please refer to the end of the specification for access instructions.

LENGTHY TABLE REFERENCED HERE
US20070027787A1-20070201-T00730
Please refer to the end of the specification for access instructions.

LENGTHY TABLE REFERENCED HERE
US20070027787A1-20070201-T00731
Please refer to the end of the specification for access instructions.

LENGTHY TABLE REFERENCED HERE
US20070027787A1-20070201-T00732
Please refer to the end of the specification for access instructions.

LENGTHY TABLE REFERENCED HERE
US20070027787A1-20070201-T00733
Please refer to the end of the specification for access instructions.

LENGTHY TABLE REFERENCED HERE
US20070027787A1-20070201-T00734
Please refer to the end of the specification for access instructions.

LENGTHY TABLE REFERENCED HERE
US20070027787A1-20070201-T00735
Please refer to the end of the specification for access instructions.

LENGTHY TABLE REFERENCED HERE
US20070027787A1-20070201-T00736
Please refer to the end of the specification for access instructions.

LENGTHY TABLE REFERENCED HERE
US20070027787A1-20070201-T00737
Please refer to the end of the specification for access instructions.

LENGTHY TABLE REFERENCED HERE
US20070027787A1-20070201-T00738
Please refer to the end of the specification for access instructions.

LENGTHY TABLE REFERENCED HERE
US20070027787A1-20070201-T00739
Please refer to the end of the specification for access instructions.

LENGTHY TABLE REFERENCED HERE
US20070027787A1-20070201-T00740
Please refer to the end of the specification for access instructions.

LENGTHY TABLE REFERENCED HERE
US20070027787A1-20070201-T00741
Please refer to the end of the specification for access instructions.

LENGTHY TABLE REFERENCED HERE
US20070027787A1-20070201-T00742
Please refer to the end of the specification for access instructions.

LENGTHY TABLE REFERENCED HERE
US20070027787A1-20070201-T00743
Please refer to the end of the specification for access instructions.

LENGTHY TABLE REFERENCED HERE
US20070027787A1-20070201-T00744
Please refer to the end of the specification for access instructions.

LENGTHY TABLE REFERENCED HERE
US20070027787A1-20070201-T00745
Please refer to the end of the specification for access instructions.

LENGTHY TABLE REFERENCED HERE
US20070027787A1-20070201-T00746
Please refer to the end of the specification for access instructions.

LENGTHY TABLE REFERENCED HERE
US20070027787A1-20070201-T00747
Please refer to the end of the specification for access instructions.

LENGTHY TABLE REFERENCED HERE
US20070027787A1-20070201-T00748
Please refer to the end of the specification for access instructions.

LENGTHY TABLE REFERENCED HERE
US20070027787A1-20070201-T00749
Please refer to the end of the specification for access instructions.

LENGTHY TABLE REFERENCED HERE
US20070027787A1-20070201-T00750
Please refer to the end of the specification for access instructions.

LENGTHY TABLE REFERENCED HERE
US20070027787A1-20070201-T00751
Please refer to the end of the specification for access instructions.

LENGTHY TABLE REFERENCED HERE
US20070027787A1-20070201-T00752
Please refer to the end of the specification for access instructions.

LENGTHY TABLE REFERENCED HERE
US20070027787A1-20070201-T00753
Please refer to the end of the specification for access instructions.

LENGTHY TABLE REFERENCED HERE
US20070027787A1-20070201-T00754
Please refer to the end of the specification for access instructions.

LENGTHY TABLE REFERENCED HERE
US20070027787A1-20070201-T00755
Please refer to the end of the specification for access instructions.

LENGTHY TABLE REFERENCED HERE
US20070027787A1-20070201-T00756
Please refer to the end of the specification for access instructions.

LENGTHY TABLE REFERENCED HERE
US20070027787A1-20070201-T00757
Please refer to the end of the specification for access instructions.

LENGTHY TABLE REFERENCED HERE
US20070027787A1-20070201-T00758
Please refer to the end of the specification for access instructions.

LENGTHY TABLE REFERENCED HERE
US20070027787A1-20070201-T00759
Please refer to the end of the specification for access instructions.

LENGTHY TABLE REFERENCED HERE
US20070027787A1-20070201-T00760
Please refer to the end of the specification for access instructions.

LENGTHY TABLE REFERENCED HERE
US20070027787A1-20070201-T00761
Please refer to the end of the specification for access instructions.

LENGTHY TABLE REFERENCED HERE
US20070027787A1-20070201-T00762
Please refer to the end of the specification for access instructions.

LENGTHY TABLE REFERENCED HERE
US20070027787A1-20070201-T00763
Please refer to the end of the specification for access instructions.

LENGTHY TABLE REFERENCED HERE
US20070027787A1-20070201-T00764
Please refer to the end of the specification for access instructions.

LENGTHY TABLE REFERENCED HERE
US20070027787A1-20070201-T00765
Please refer to the end of the specification for access instructions.

LENGTHY TABLE REFERENCED HERE
US20070027787A1-20070201-T00766
Please refer to the end of the specification for access instructions.

LENGTHY TABLE REFERENCED HERE
US20070027787A1-20070201-T00767
Please refer to the end of the specification for access instructions.

LENGTHY TABLE REFERENCED HERE
US20070027787A1-20070201-T00768
Please refer to the end of the specification for access instructions.

LENGTHY TABLE REFERENCED HERE
US20070027787A1-20070201-T00769
Please refer to the end of the specification for access instructions.

LENGTHY TABLE REFERENCED HERE
US20070027787A1-20070201-T00770
Please refer to the end of the specification for access instructions.

LENGTHY TABLE REFERENCED HERE
US20070027787A1-20070201-T00771
Please refer to the end of the specification for access instructions.

LENGTHY TABLE REFERENCED HERE
US20070027787A1-20070201-T00772
Please refer to the end of the specification for access instructions.

LENGTHY TABLE REFERENCED HERE
US20070027787A1-20070201-T00773
Please refer to the end of the specification for access instructions.

LENGTHY TABLE REFERENCED HERE
US20070027787A1-20070201-T00774
Please refer to the end of the specification for access instructions.

LENGTHY TABLE REFERENCED HERE
US20070027787A1-20070201-T00775
Please refer to the end of the specification for access instructions.

LENGTHY TABLE REFERENCED HERE
US20070027787A1-20070201-T00776
Please refer to the end of the specification for access instructions.

LENGTHY TABLE REFERENCED HERE
US20070027787A1-20070201-T00777
Please refer to the end of the specification for access instructions.

LENGTHY TABLE REFERENCED HERE
US20070027787A1-20070201-T00778
Please refer to the end of the specification for access instructions.

LENGTHY TABLE REFERENCED HERE
US20070027787A1-20070201-T00779
Please refer to the end of the specification for access instructions.

LENGTHY TABLE REFERENCED HERE
US20070027787A1-20070201-T00780
Please refer to the end of the specification for access instructions.

LENGTHY TABLE REFERENCED HERE
US20070027787A1-20070201-T00781
Please refer to the end of the specification for access instructions.

LENGTHY TABLE REFERENCED HERE
US20070027787A1-20070201-T00782
Please refer to the end of the specification for access instructions.

LENGTHY TABLE REFERENCED HERE
US20070027787A1-20070201-T00783
Please refer to the end of the specification for access instructions.

LENGTHY TABLE REFERENCED HERE
US20070027787A1-20070201-T00784
Please refer to the end of the specification for access instructions.

LENGTHY TABLE REFERENCED HERE
US20070027787A1-20070201-T00785
Please refer to the end of the specification for access instructions.

LENGTHY TABLE REFERENCED HERE
US20070027787A1-20070201-T00786
Please refer to the end of the specification for access instructions.

LENGTHY TABLE REFERENCED HERE
US20070027787A1-20070201-T00787
Please refer to the end of the specification for access instructions.

LENGTHY TABLE REFERENCED HERE
US20070027787A1-20070201-T00788
Please refer to the end of the specification for access instructions.

LENGTHY TABLE REFERENCED HERE
US20070027787A1-20070201-T00789
Please refer to the end of the specification for access instructions.

LENGTHY TABLE REFERENCED HERE
US20070027787A1-20070201-T00790
Please refer to the end of the specification for access instructions.

LENGTHY TABLE REFERENCED HERE
US20070027787A1-20070201-T00791
Please refer to the end of the specification for access instructions.

LENGTHY TABLE REFERENCED HERE
US20070027787A1-20070201-T00792
Please refer to the end of the specification for access instructions.

LENGTHY TABLE REFERENCED HERE
US20070027787A1-20070201-T00793
Please refer to the end of the specification for access instructions.

LENGTHY TABLE REFERENCED HERE
US20070027787A1-20070201-T00794
Please refer to the end of the specification for access instructions.

LENGTHY TABLE REFERENCED HERE
US20070027787A1-20070201-T00795
Please refer to the end of the specification for access instructions.

LENGTHY TABLE REFERENCED HERE
US20070027787A1-20070201-T00796
Please refer to the end of the specification for access instructions.

LENGTHY TABLE REFERENCED HERE
US20070027787A1-20070201-T00797
Please refer to the end of the specification for access instructions.

LENGTHY TABLE REFERENCED HERE
US20070027787A1-20070201-T00798
Please refer to the end of the specification for access instructions.

LENGTHY TABLE REFERENCED HERE
US20070027787A1-20070201-T00799
Please refer to the end of the specification for access instructions.

LENGTHY TABLE REFERENCED HERE
US20070027787A1-20070201-T00800
Please refer to the end of the specification for access instructions.

LENGTHY TABLE REFERENCED HERE
US20070027787A1-20070201-T00801
Please refer to the end of the specification for access instructions.

LENGTHY TABLE REFERENCED HERE
US20070027787A1-20070201-T00802
Please refer to the end of the specification for access instructions.

LENGTHY TABLE REFERENCED HERE
US20070027787A1-20070201-T00803
Please refer to the end of the specification for access instructions.

LENGTHY TABLE REFERENCED HERE
US20070027787A1-20070201-T00804
Please refer to the end of the specification for access instructions.

LENGTHY TABLE REFERENCED HERE
US20070027787A1-20070201-T00805
Please refer to the end of the specification for access instructions.

LENGTHY TABLE REFERENCED HERE
US20070027787A1-20070201-T00806
Please refer to the end of the specification for access instructions.

LENGTHY TABLE REFERENCED HERE
US20070027787A1-20070201-T00807
Please refer to the end of the specification for access instructions.

LENGTHY TABLE REFERENCED HERE
US20070027787A1-20070201-T00808
Please refer to the end of the specification for access instructions.

LENGTHY TABLE REFERENCED HERE
US20070027787A1-20070201-T00809
Please refer to the end of the specification for access instructions.

LENGTHY TABLE REFERENCED HERE
US20070027787A1-20070201-T00810
Please refer to the end of the specification for access instructions.

LENGTHY TABLE REFERENCED HERE
US20070027787A1-20070201-T00811
Please refer to the end of the specification for access instructions.

LENGTHY TABLE REFERENCED HERE
US20070027787A1-20070201-T00812
Please refer to the end of the specification for access instructions.

LENGTHY TABLE REFERENCED HERE
US20070027787A1-20070201-T00813
Please refer to the end of the specification for access instructions.

LENGTHY TABLE REFERENCED HERE
US20070027787A1-20070201-T00814
Please refer to the end of the specification for access instructions.

LENGTHY TABLE REFERENCED HERE
US20070027787A1-20070201-T00815
Please refer to the end of the specification for access instructions.

LENGTHY TABLE REFERENCED HERE
US20070027787A1-20070201-T00816
Please refer to the end of the specification for access instructions.

LENGTHY TABLE REFERENCED HERE
US20070027787A1-20070201-T00817
Please refer to the end of the specification for access instructions.

LENGTHY TABLE REFERENCED HERE
US20070027787A1-20070201-T00818
Please refer to the end of the specification for access instructions.

LENGTHY TABLE REFERENCED HERE
US20070027787A1-20070201-T00819
Please refer to the end of the specification for access instructions.

LENGTHY TABLE REFERENCED HERE
US20070027787A1-20070201-T00820
Please refer to the end of the specification for access instructions.

LENGTHY TABLE REFERENCED HERE
US20070027787A1-20070201-T00821
Please refer to the end of the specification for access instructions.

LENGTHY TABLE REFERENCED HERE
US20070027787A1-20070201-T00822
Please refer to the end of the specification for access instructions.

LENGTHY TABLE REFERENCED HERE
US20070027787A1-20070201-T00823
Please refer to the end of the specification for access instructions.

LENGTHY TABLE REFERENCED HERE
US20070027787A1-20070201-T00824
Please refer to the end of the specification for access instructions.

LENGTHY TABLE REFERENCED HERE
US20070027787A1-20070201-T00825
Please refer to the end of the specification for access instructions.

LENGTHY TABLE REFERENCED HERE
US20070027787A1-20070201-T00826
Please refer to the end of the specification for access instructions.

LENGTHY TABLE REFERENCED HERE
US20070027787A1-20070201-T00827
Please refer to the end of the specification for access instructions.

LENGTHY TABLE REFERENCED HERE
US20070027787A1-20070201-T00828
Please refer to the end of the specification for access instructions.

LENGTHY TABLE REFERENCED HERE
US20070027787A1-20070201-T00829
Please refer to the end of the specification for access instructions.

LENGTHY TABLE REFERENCED HERE
US20070027787A1-20070201-T00830
Please refer to the end of the specification for access instructions.

LENGTHY TABLE REFERENCED HERE
US20070027787A1-20070201-T00831
Please refer to the end of the specification for access instructions.

LENGTHY TABLE REFERENCED HERE
US20070027787A1-20070201-T00832
Please refer to the end of the specification for access instructions.

LENGTHY TABLE REFERENCED HERE
US20070027787A1-20070201-T00833
Please refer to the end of the specification for access instructions.

LENGTHY TABLE REFERENCED HERE
US20070027787A1-20070201-T00834
Please refer to the end of the specification for access instructions.

LENGTHY TABLE REFERENCED HERE
US20070027787A1-20070201-T00835
Please refer to the end of the specification for access instructions.

LENGTHY TABLE REFERENCED HERE
US20070027787A1-20070201-T00836
Please refer to the end of the specification for access instructions.

LENGTHY TABLE REFERENCED HERE
US20070027787A1-20070201-T00837
Please refer to the end of the specification for access instructions.

LENGTHY TABLE REFERENCED HERE
US20070027787A1-20070201-T00838
Please refer to the end of the specification for access instructions.

LENGTHY TABLE REFERENCED HERE
US20070027787A1-20070201-T00839
Please refer to the end of the specification for access instructions.

LENGTHY TABLE REFERENCED HERE
US20070027787A1-20070201-T00840
Please refer to the end of the specification for access instructions.

LENGTHY TABLE REFERENCED HERE
US20070027787A1-20070201-T00841
Please refer to the end of the specification for access instructions.

LENGTHY TABLE REFERENCED HERE
US20070027787A1-20070201-T00842
Please refer to the end of the specification for access instructions.

LENGTHY TABLE REFERENCED HERE
US20070027787A1-20070201-T00843
Please refer to the end of the specification for access instructions.

LENGTHY TABLE REFERENCED HERE
US20070027787A1-20070201-T00844
Please refer to the end of the specification for access instructions.

LENGTHY TABLE REFERENCED HERE
US20070027787A1-20070201-T00845
Please refer to the end of the specification for access instructions.

LENGTHY TABLE REFERENCED HERE
US20070027787A1-20070201-T00846
Please refer to the end of the specification for access instructions.

LENGTHY TABLE REFERENCED HERE
US20070027787A1-20070201-T00847
Please refer to the end of the specification for access instructions.

LENGTHY TABLE REFERENCED HERE
US20070027787A1-20070201-T00848
Please refer to the end of the specification for access instructions.

LENGTHY TABLE REFERENCED HERE
US20070027787A1-20070201-T00849
Please refer to the end of the specification for access instructions.

LENGTHY TABLE REFERENCED HERE
US20070027787A1-20070201-T00850
Please refer to the end of the specification for access instructions.

LENGTHY TABLE REFERENCED HERE
US20070027787A1-20070201-T00851
Please refer to the end of the specification for access instructions.

LENGTHY TABLE REFERENCED HERE
US20070027787A1-20070201-T00852
Please refer to the end of the specification for access instructions.

LENGTHY TABLE REFERENCED HERE
US20070027787A1-20070201-T00853
Please refer to the end of the specification for access instructions.

LENGTHY TABLE REFERENCED HERE
US20070027787A1-20070201-T00854
Please refer to the end of the specification for access instructions.

LENGTHY TABLE REFERENCED HERE
US20070027787A1-20070201-T00855
Please refer to the end of the specification for access instructions.

LENGTHY TABLE REFERENCED HERE
US20070027787A1-20070201-T00856
Please refer to the end of the specification for access instructions.

LENGTHY TABLE REFERENCED HERE
US20070027787A1-20070201-T00857
Please refer to the end of the specification for access instructions.

LENGTHY TABLE REFERENCED HERE
US20070027787A1-20070201-T00858
Please refer to the end of the specification for access instructions.

LENGTHY TABLE REFERENCED HERE
US20070027787A1-20070201-T00859
Please refer to the end of the specification for access instructions.

LENGTHY TABLE REFERENCED HERE
US20070027787A1-20070201-T00860
Please refer to the end of the specification for access instructions.

LENGTHY TABLE REFERENCED HERE
US20070027787A1-20070201-T00861
Please refer to the end of the specification for access instructions.

LENGTHY TABLE REFERENCED HERE
US20070027787A1-20070201-T00862
Please refer to the end of the specification for access instructions.

LENGTHY TABLE REFERENCED HERE
US20070027787A1-20070201-T00863
Please refer to the end of the specification for access instructions.

LENGTHY TABLE REFERENCED HERE
US20070027787A1-20070201-T00864
Please refer to the end of the specification for access instructions.

LENGTHY TABLE REFERENCED HERE
US20070027787A1-20070201-T00865
Please refer to the end of the specification for access instructions.

LENGTHY TABLE REFERENCED HERE
US20070027787A1-20070201-T00866
Please refer to the end of the specification for access instructions.

LENGTHY TABLE REFERENCED HERE
US20070027787A1-20070201-T00867
Please refer to the end of the specification for access instructions.

LENGTHY TABLE REFERENCED HERE
US20070027787A1-20070201-T00868
Please refer to the end of the specification for access instructions.

LENGTHY TABLE REFERENCED HERE
US20070027787A1-20070201-T00869
Please refer to the end of the specification for access instructions.

LENGTHY TABLE REFERENCED HERE
US20070027787A1-20070201-T00870
Please refer to the end of the specification for access instructions.

LENGTHY TABLE REFERENCED HERE
US20070027787A1-20070201-T00871
Please refer to the end of the specification for access instructions.

LENGTHY TABLE REFERENCED HERE
US20070027787A1-20070201-T00872
Please refer to the end of the specification for access instructions.

LENGTHY TABLE REFERENCED HERE
US20070027787A1-20070201-T00873
Please refer to the end of the specification for access instructions.

LENGTHY TABLE REFERENCED HERE
US20070027787A1-20070201-T00874
Please refer to the end of the specification for access instructions.

LENGTHY TABLE REFERENCED HERE
US20070027787A1-20070201-T00875
Please refer to the end of the specification for access instructions.

LENGTHY TABLE REFERENCED HERE
US20070027787A1-20070201-T00876
Please refer to the end of the specification for access instructions.

LENGTHY TABLE REFERENCED HERE
US20070027787A1-20070201-T00877
Please refer to the end of the specification for access instructions.

LENGTHY TABLE REFERENCED HERE
US20070027787A1-20070201-T00878
Please refer to the end of the specification for access instructions.

LENGTHY TABLE REFERENCED HERE
US20070027787A1-20070201-T00879
Please refer to the end of the specification for access instructions.

LENGTHY TABLE REFERENCED HERE
US20070027787A1-20070201-T00880
Please refer to the end of the specification for access instructions.

LENGTHY TABLE REFERENCED HERE
US20070027787A1-20070201-T00881
Please refer to the end of the specification for access instructions.

LENGTHY TABLE REFERENCED HERE
US20070027787A1-20070201-T00882
Please refer to the end of the specification for access instructions.

LENGTHY TABLE REFERENCED HERE
US20070027787A1-20070201-T00883
Please refer to the end of the specification for access instructions.

LENGTHY TABLE REFERENCED HERE
US20070027787A1-20070201-T00884
Please refer to the end of the specification for access instructions.

LENGTHY TABLE REFERENCED HERE
US20070027787A1-20070201-T00885
Please refer to the end of the specification for access instructions.

LENGTHY TABLE REFERENCED HERE
US20070027787A1-20070201-T00886
Please refer to the end of the specification for access instructions.

LENGTHY TABLE REFERENCED HERE
US20070027787A1-20070201-T00887
Please refer to the end of the specification for access instructions.

LENGTHY TABLE REFERENCED HERE
US20070027787A1-20070201-T00888
Please refer to the end of the specification for access instructions.

LENGTHY TABLE REFERENCED HERE
US20070027787A1-20070201-T00889
Please refer to the end of the specification for access instructions.

LENGTHY TABLE REFERENCED HERE
US20070027787A1-20070201-T00890
Please refer to the end of the specification for access instructions.

LENGTHY TABLE REFERENCED HERE
US20070027787A1-20070201-T00891
Please refer to the end of the specification for access instructions.

LENGTHY TABLE REFERENCED HERE
US20070027787A1-20070201-T00892
Please refer to the end of the specification for access instructions.

LENGTHY TABLE REFERENCED HERE
US20070027787A1-20070201-T00893
Please refer to the end of the specification for access instructions.

LENGTHY TABLE REFERENCED HERE
US20070027787A1-20070201-T00894
Please refer to the end of the specification for access instructions.

LENGTHY TABLE REFERENCED HERE
US20070027787A1-20070201-T00895
Please refer to the end of the specification for access instructions.

LENGTHY TABLE REFERENCED HERE
US20070027787A1-20070201-T00896
Please refer to the end of the specification for access instructions.

LENGTHY TABLE REFERENCED HERE
US20070027787A1-20070201-T00897
Please refer to the end of the specification for access instructions.

LENGTHY TABLE REFERENCED HERE
US20070027787A1-20070201-T00898
Please refer to the end of the specification for access instructions.

LENGTHY TABLE REFERENCED HERE
US20070027787A1-20070201-T00899
Please refer to the end of the specification for access instructions.

LENGTHY TABLE REFERENCED HERE
US20070027787A1-20070201-T00900
Please refer to the end of the specification for access instructions.

LENGTHY TABLE REFERENCED HERE
US20070027787A1-20070201-T00901
Please refer to the end of the specification for access instructions.

LENGTHY TABLE REFERENCED HERE
US20070027787A1-20070201-T00902
Please refer to the end of the specification for access instructions.

LENGTHY TABLE REFERENCED HERE
US20070027787A1-20070201-T00903
Please refer to the end of the specification for access instructions.

LENGTHY TABLE REFERENCED HERE
US20070027787A1-20070201-T00904
Please refer to the end of the specification for access instructions.

LENGTHY TABLE REFERENCED HERE
US20070027787A1-20070201-T00905
Please refer to the end of the specification for access instructions.

LENGTHY TABLE REFERENCED HERE
US20070027787A1-20070201-T00906
Please refer to the end of the specification for access instructions.

LENGTHY TABLE REFERENCED HERE
US20070027787A1-20070201-T00907
Please refer to the end of the specification for access instructions.

LENGTHY TABLE REFERENCED HERE
US20070027787A1-20070201-T00908
Please refer to the end of the specification for access instructions.

LENGTHY TABLE REFERENCED HERE
US20070027787A1-20070201-T00909
Please refer to the end of the specification for access instructions.

LENGTHY TABLE REFERENCED HERE
US20070027787A1-20070201-T00910
Please refer to the end of the specification for access instructions.

LENGTHY TABLE REFERENCED HERE
US20070027787A1-20070201-T00911
Please refer to the end of the specification for access instructions.

LENGTHY TABLE REFERENCED HERE
US20070027787A1-20070201-T00912
Please refer to the end of the specification for access instructions.

LENGTHY TABLE REFERENCED HERE
US20070027787A1-20070201-T00913
Please refer to the end of the specification for access instructions.

LENGTHY TABLE REFERENCED HERE
US20070027787A1-20070201-T00914
Please refer to the end of the specification for access instructions.

LENGTHY TABLE REFERENCED HERE
US20070027787A1-20070201-T00915
Please refer to the end of the specification for access instructions.

LENGTHY TABLE REFERENCED HERE
US20070027787A1-20070201-T00916
Please refer to the end of the specification for access instructions.

LENGTHY TABLE REFERENCED HERE
US20070027787A1-20070201-T00917
Please refer to the end of the specification for access instructions.

LENGTHY TABLE REFERENCED HERE
US20070027787A1-20070201-T00918
Please refer to the end of the specification for access instructions.

LENGTHY TABLE REFERENCED HERE
US20070027787A1-20070201-T00919
Please refer to the end of the specification for access instructions.

LENGTHY TABLE REFERENCED HERE
US20070027787A1-20070201-T00920
Please refer to the end of the specification for access instructions.

LENGTHY TABLE REFERENCED HERE
US20070027787A1-20070201-T00921
Please refer to the end of the specification for access instructions.

LENGTHY TABLE REFERENCED HERE
US20070027787A1-20070201-T00922
Please refer to the end of the specification for access instructions.

LENGTHY TABLE REFERENCED HERE
US20070027787A1-20070201-T00923
Please refer to the end of the specification for access instructions.

LENGTHY TABLE REFERENCED HERE
US20070027787A1-20070201-T00924
Please refer to the end of the specification for access instructions.

LENGTHY TABLE REFERENCED HERE
US20070027787A1-20070201-T00925
Please refer to the end of the specification for access instructions.

LENGTHY TABLE REFERENCED HERE
US20070027787A1-20070201-T00926
Please refer to the end of the specification for access instructions.

LENGTHY TABLE REFERENCED HERE
US20070027787A1-20070201-T00927
Please refer to the end of the specification for access instructions.

LENGTHY TABLE REFERENCED HERE
US20070027787A1-20070201-T00928
Please refer to the end of the specification for access instructions.

LENGTHY TABLE REFERENCED HERE
US20070027787A1-20070201-T00929
Please refer to the end of the specification for access instructions.

LENGTHY TABLE REFERENCED HERE
US20070027787A1-20070201-T00930
Please refer to the end of the specification for access instructions.

LENGTHY TABLE REFERENCED HERE
US20070027787A1-20070201-T00931
Please refer to the end of the specification for access instructions.

LENGTHY TABLE REFERENCED HERE
US20070027787A1-20070201-T00932
Please refer to the end of the specification for access instructions.

LENGTHY TABLE REFERENCED HERE
US20070027787A1-20070201-T00933
Please refer to the end of the specification for access instructions.

LENGTHY TABLE REFERENCED HERE
US20070027787A1-20070201-T00934
Please refer to the end of the specification for access instructions.

LENGTHY TABLE REFERENCED HERE
US20070027787A1-20070201-T00935
Please refer to the end of the specification for access instructions.

LENGTHY TABLE REFERENCED HERE
US20070027787A1-20070201-T00936
Please refer to the end of the specification for access instructions.

LENGTHY TABLE REFERENCED HERE
US20070027787A1-20070201-T00937
Please refer to the end of the specification for access instructions.

LENGTHY TABLE REFERENCED HERE
US20070027787A1-20070201-T00938
Please refer to the end of the specification for access instructions.

LENGTHY TABLE REFERENCED HERE
US20070027787A1-20070201-T00939
Please refer to the end of the specification for access instructions.

LENGTHY TABLE REFERENCED HERE
US20070027787A1-20070201-T00940
Please refer to the end of the specification for access instructions.

LENGTHY TABLE REFERENCED HERE
US20070027787A1-20070201-T00941
Please refer to the end of the specification for access instructions.

LENGTHY TABLE REFERENCED HERE
US20070027787A1-20070201-T00942
Please refer to the end of the specification for access instructions.

LENGTHY TABLE REFERENCED HERE
US20070027787A1-20070201-T00943
Please refer to the end of the specification for access instructions.

LENGTHY TABLE REFERENCED HERE
US20070027787A1-20070201-T00944
Please refer to the end of the specification for access instructions.

LENGTHY TABLE REFERENCED HERE
US20070027787A1-20070201-T00945
Please refer to the end of the specification for access instructions.

LENGTHY TABLE REFERENCED HERE
US20070027787A1-20070201-T00946
Please refer to the end of the specification for access instructions.

LENGTHY TABLE REFERENCED HERE
US20070027787A1-20070201-T00947
Please refer to the end of the specification for access instructions.

LENGTHY TABLE REFERENCED HERE
US20070027787A1-20070201-T00948
Please refer to the end of the specification for access instructions.

LENGTHY TABLE REFERENCED HERE
US20070027787A1-20070201-T00949
Please refer to the end of the specification for access instructions.

LENGTHY TABLE REFERENCED HERE
US20070027787A1-20070201-T00950
Please refer to the end of the specification for access instructions.

LENGTHY TABLE REFERENCED HERE
US20070027787A1-20070201-T00951
Please refer to the end of the specification for access instructions.

LENGTHY TABLE REFERENCED HERE
US20070027787A1-20070201-T00952
Please refer to the end of the specification for access instructions.

LENGTHY TABLE REFERENCED HERE
US20070027787A1-20070201-T00953
Please refer to the end of the specification for access instructions.

LENGTHY TABLE REFERENCED HERE
US20070027787A1-20070201-T00954
Please refer to the end of the specification for access instructions.

LENGTHY TABLE REFERENCED HERE
US20070027787A1-20070201-T00955
Please refer to the end of the specification for access instructions.

LENGTHY TABLE REFERENCED HERE
US20070027787A1-20070201-T00956
Please refer to the end of the specification for access instructions.

LENGTHY TABLE REFERENCED HERE
US20070027787A1-20070201-T00957
Please refer to the end of the specification for access instructions.

LENGTHY TABLE REFERENCED HERE
US20070027787A1-20070201-T00958
Please refer to the end of the specification for access instructions.

LENGTHY TABLE REFERENCED HERE
US20070027787A1-20070201-T00959
Please refer to the end of the specification for access instructions.

LENGTHY TABLE REFERENCED HERE
US20070027787A1-20070201-T00960
Please refer to the end of the specification for access instructions.

LENGTHY TABLE REFERENCED HERE
US20070027787A1-20070201-T00961
Please refer to the end of the specification for access instructions.

LENGTHY TABLE REFERENCED HERE
US20070027787A1-20070201-T00962
Please refer to the end of the specification for access instructions.

LENGTHY TABLE REFERENCED HERE
US20070027787A1-20070201-T00963
Please refer to the end of the specification for access instructions.

LENGTHY TABLE REFERENCED HERE
US20070027787A1-20070201-T00964
Please refer to the end of the specification for access instructions.

LENGTHY TABLE REFERENCED HERE
US20070027787A1-20070201-T00965
Please refer to the end of the specification for access instructions.

LENGTHY TABLE REFERENCED HERE
US20070027787A1-20070201-T00966
Please refer to the end of the specification for access instructions.

LENGTHY TABLE REFERENCED HERE
US20070027787A1-20070201-T00967
Please refer to the end of the specification for access instructions.

LENGTHY TABLE REFERENCED HERE
US20070027787A1-20070201-T00968
Please refer to the end of the specification for access instructions.

LENGTHY TABLE REFERENCED HERE
US20070027787A1-20070201-T00969
Please refer to the end of the specification for access instructions.

LENGTHY TABLE REFERENCED HERE
US20070027787A1-20070201-T00970
Please refer to the end of the specification for access instructions.

LENGTHY TABLE REFERENCED HERE
US20070027787A1-20070201-T00971
Please refer to the end of the specification for access instructions.

LENGTHY TABLE REFERENCED HERE
US20070027787A1-20070201-T00972
Please refer to the end of the specification for access instructions.

LENGTHY TABLE REFERENCED HERE
US20070027787A1-20070201-T00973
Please refer to the end of the specification for access instructions.

LENGTHY TABLE REFERENCED HERE
US20070027787A1-20070201-T00974
Please refer to the end of the specification for access instructions.

LENGTHY TABLE REFERENCED HERE
US20070027787A1-20070201-T00975
Please refer to the end of the specification for access instructions.

LENGTHY TABLE REFERENCED HERE
US20070027787A1-20070201-T00976
Please refer to the end of the specification for access instructions.

LENGTHY TABLE REFERENCED HERE
US20070027787A1-20070201-T00977
Please refer to the end of the specification for access instructions.

LENGTHY TABLE REFERENCED HERE
US20070027787A1-20070201-T00978
Please refer to the end of the specification for access instructions.

LENGTHY TABLE REFERENCED HERE
US20070027787A1-20070201-T00979
Please refer to the end of the specification for access instructions.

LENGTHY TABLE REFERENCED HERE
US20070027787A1-20070201-T00980
Please refer to the end of the specification for access instructions.

LENGTHY TABLE REFERENCED HERE
US20070027787A1-20070201-T00981
Please refer to the end of the specification for access instructions.

LENGTHY TABLE REFERENCED HERE
US20070027787A1-20070201-T00982
Please refer to the end of the specification for access instructions.

LENGTHY TABLE REFERENCED HERE
US20070027787A1-20070201-T00983
Please refer to the end of the specification for access instructions.

LENGTHY TABLE REFERENCED HERE
US20070027787A1-20070201-T00984
Please refer to the end of the specification for access instructions.

LENGTHY TABLE REFERENCED HERE
US20070027787A1-20070201-T00985
Please refer to the end of the specification for access instructions.

LENGTHY TABLE REFERENCED HERE
US20070027787A1-20070201-T00986
Please refer to the end of the specification for access instructions.

LENGTHY TABLE REFERENCED HERE
US20070027787A1-20070201-T00987
Please refer to the end of the specification for access instructions.

LENGTHY TABLE REFERENCED HERE
US20070027787A1-20070201-T00988
Please refer to the end of the specification for access instructions.

LENGTHY TABLE REFERENCED HERE
US20070027787A1-20070201-T00989
Please refer to the end of the specification for access instructions.

LENGTHY TABLE REFERENCED HERE
US20070027787A1-20070201-T00990
Please refer to the end of the specification for access instructions.

LENGTHY TABLE REFERENCED HERE
US20070027787A1-20070201-T00991
Please refer to the end of the specification for access instructions.

LENGTHY TABLE REFERENCED HERE
US20070027787A1-20070201-T00992
Please refer to the end of the specification for access instructions.

LENGTHY TABLE REFERENCED HERE
US20070027787A1-20070201-T00993
Please refer to the end of the specification for access instructions.

LENGTHY TABLE REFERENCED HERE
US20070027787A1-20070201-T00994
Please refer to the end of the specification for access instructions.

LENGTHY TABLE REFERENCED HERE
US20070027787A1-20070201-T00995
Please refer to the end of the specification for access instructions.

LENGTHY TABLE REFERENCED HERE
US20070027787A1-20070201-T00996
Please refer to the end of the specification for access instructions.

LENGTHY TABLE REFERENCED HERE
US20070027787A1-20070201-T00997
Please refer to the end of the specification for access instructions.

LENGTHY TABLE REFERENCED HERE
US20070027787A1-20070201-T00998
Please refer to the end of the specification for access instructions.

LENGTHY TABLE REFERENCED HERE
US20070027787A1-20070201-T00999
Please refer to the end of the specification for access instructions.

LENGTHY TABLE REFERENCED HERE
US20070027787A1-20070201-T01000
Please refer to the end of the specification for access instructions.

LENGTHY TABLE REFERENCED HERE
US20070027787A1-20070201-T01001
Please refer to the end of the specification for access instructions.

LENGTHY TABLE REFERENCED HERE
US20070027787A1-20070201-T01002
Please refer to the end of the specification for access instructions.

LENGTHY TABLE REFERENCED HERE
US20070027787A1-20070201-T01003
Please refer to the end of the specification for access instructions.

LENGTHY TABLE REFERENCED HERE
US20070027787A1-20070201-T01004
Please refer to the end of the specification for access instructions.

LENGTHY TABLE REFERENCED HERE
US20070027787A1-20070201-T01005
Please refer to the end of the specification for access instructions.

LENGTHY TABLE REFERENCED HERE
US20070027787A1-20070201-T01006
Please refer to the end of the specification for access instructions.

LENGTHY TABLE REFERENCED HERE
US20070027787A1-20070201-T01007
Please refer to the end of the specification for access instructions.

LENGTHY TABLE REFERENCED HERE
US20070027787A1-20070201-T01008
Please refer to the end of the specification for access instructions.

LENGTHY TABLE REFERENCED HERE
US20070027787A1-20070201-T01009
Please refer to the end of the specification for access instructions.

LENGTHY TABLE REFERENCED HERE
US20070027787A1-20070201-T01010
Please refer to the end of the specification for access instructions.

LENGTHY TABLE REFERENCED HERE
US20070027787A1-20070201-T01011
Please refer to the end of the specification for access instructions.

LENGTHY TABLE REFERENCED HERE
US20070027787A1-20070201-T01012
Please refer to the end of the specification for access instructions.

LENGTHY TABLE REFERENCED HERE
US20070027787A1-20070201-T01013
Please refer to the end of the specification for access instructions.

LENGTHY TABLE REFERENCED HERE
US20070027787A1-20070201-T01014
Please refer to the end of the specification for access instructions.

LENGTHY TABLE REFERENCED HERE
US20070027787A1-20070201-T01015
Please refer to the end of the specification for access instructions.

LENGTHY TABLE REFERENCED HERE
US20070027787A1-20070201-T01016
Please refer to the end of the specification for access instructions.

LENGTHY TABLE REFERENCED HERE
US20070027787A1-20070201-T01017
Please refer to the end of the specification for access instructions.

LENGTHY TABLE REFERENCED HERE
US20070027787A1-20070201-T01018
Please refer to the end of the specification for access instructions.

LENGTHY TABLE REFERENCED HERE
US20070027787A1-20070201-T01019
Please refer to the end of the specification for access instructions.

LENGTHY TABLE REFERENCED HERE
US20070027787A1-20070201-T01020
Please refer to the end of the specification for access instructions.

LENGTHY TABLE REFERENCED HERE
US20070027787A1-20070201-T01021
Please refer to the end of the specification for access instructions.

LENGTHY TABLE REFERENCED HERE
US20070027787A1-20070201-T01022
Please refer to the end of the specification for access instructions.

LENGTHY TABLE REFERENCED HERE
US20070027787A1-20070201-T01023
Please refer to the end of the specification for access instructions.

LENGTHY TABLE REFERENCED HERE
US20070027787A1-20070201-T01024
Please refer to the end of the specification for access instructions.

LENGTHY TABLE REFERENCED HERE
US20070027787A1-20070201-T01025
Please refer to the end of the specification for access instructions.

LENGTHY TABLE REFERENCED HERE
US20070027787A1-20070201-T01026
Please refer to the end of the specification for access instructions.

LENGTHY TABLE REFERENCED HERE
US20070027787A1-20070201-T01027
Please refer to the end of the specification for access instructions.

LENGTHY TABLE REFERENCED HERE
US20070027787A1-20070201-T01028
Please refer to the end of the specification for access instructions.

LENGTHY TABLE REFERENCED HERE
US20070027787A1-20070201-T01029
Please refer to the end of the specification for access instructions.

LENGTHY TABLE REFERENCED HERE
US20070027787A1-20070201-T01030
Please refer to the end of the specification for access instructions.

LENGTHY TABLE REFERENCED HERE
US20070027787A1-20070201-T01031
Please refer to the end of the specification for access instructions.

LENGTHY TABLE REFERENCED HERE
US20070027787A1-20070201-T01032
Please refer to the end of the specification for access instructions.

LENGTHY TABLE REFERENCED HERE
US20070027787A1-20070201-T01033
Please refer to the end of the specification for access instructions.

LENGTHY TABLE REFERENCED HERE
US20070027787A1-20070201-T01034
Please refer to the end of the specification for access instructions.

LENGTHY TABLE REFERENCED HERE
US20070027787A1-20070201-T01035
Please refer to the end of the specification for access instructions.

LENGTHY TABLE REFERENCED HERE
US20070027787A1-20070201-T01036
Please refer to the end of the specification for access instructions.

LENGTHY TABLE REFERENCED HERE
US20070027787A1-20070201-T01037
Please refer to the end of the specification for access instructions.

LENGTHY TABLE REFERENCED HERE
US20070027787A1-20070201-T01038
Please refer to the end of the specification for access instructions.

LENGTHY TABLE REFERENCED HERE
US20070027787A1-20070201-T01039
Please refer to the end of the specification for access instructions.

LENGTHY TABLE REFERENCED HERE
US20070027787A1-20070201-T01040
Please refer to the end of the specification for access instructions.

LENGTHY TABLE REFERENCED HERE
US20070027787A1-20070201-T01041
Please refer to the end of the specification for access instructions.

LENGTHY TABLE REFERENCED HERE
US20070027787A1-20070201-T01042
Please refer to the end of the specification for access instructions.

LENGTHY TABLE REFERENCED HERE
US20070027787A1-20070201-T01043
Please refer to the end of the specification for access instructions.

LENGTHY TABLE REFERENCED HERE
US20070027787A1-20070201-T01044
Please refer to the end of the specification for access instructions.

LENGTHY TABLE REFERENCED HERE
US20070027787A1-20070201-T01045
Please refer to the end of the specification for access instructions.

LENGTHY TABLE REFERENCED HERE
US20070027787A1-20070201-T01046
Please refer to the end of the specification for access instructions.

LENGTHY TABLE REFERENCED HERE
US20070027787A1-20070201-T01047
Please refer to the end of the specification for access instructions.

LENGTHY TABLE REFERENCED HERE
US20070027787A1-20070201-T01048
Please refer to the end of the specification for access instructions.

LENGTHY TABLE REFERENCED HERE
US20070027787A1-20070201-T01049
Please refer to the end of the specification for access instructions.

LENGTHY TABLE REFERENCED HERE
US20070027787A1-20070201-T01050
Please refer to the end of the specification for access instructions.

LENGTHY TABLE REFERENCED HERE
US20070027787A1-20070201-T01051
Please refer to the end of the specification for access instructions.

LENGTHY TABLE REFERENCED HERE
US20070027787A1-20070201-T01052
Please refer to the end of the specification for access instructions.

LENGTHY TABLE REFERENCED HERE
US20070027787A1-20070201-T01053
Please refer to the end of the specification for access instructions.

LENGTHY TABLE REFERENCED HERE
US20070027787A1-20070201-T01054
Please refer to the end of the specification for access instructions.

LENGTHY TABLE REFERENCED HERE
US20070027787A1-20070201-T01055
Please refer to the end of the specification for access instructions.

LENGTHY TABLE REFERENCED HERE
US20070027787A1-20070201-T01056
Please refer to the end of the specification for access instructions.

LENGTHY TABLE REFERENCED HERE
US20070027787A1-20070201-T01057
Please refer to the end of the specification for access instructions.

LENGTHY TABLE REFERENCED HERE
US20070027787A1-20070201-T01058
Please refer to the end of the specification for access instructions.

LENGTHY TABLE REFERENCED HERE
US20070027787A1-20070201-T01059
Please refer to the end of the specification for access instructions.

LENGTHY TABLE REFERENCED HERE
US20070027787A1-20070201-T01060
Please refer to the end of the specification for access instructions.

LENGTHY TABLE REFERENCED HERE
US20070027787A1-20070201-T01061
Please refer to the end of the specification for access instructions.

LENGTHY TABLE REFERENCED HERE
US20070027787A1-20070201-T01062
Please refer to the end of the specification for access instructions.

LENGTHY TABLE REFERENCED HERE
US20070027787A1-20070201-T01063
Please refer to the end of the specification for access instructions.

LENGTHY TABLE REFERENCED HERE
US20070027787A1-20070201-T01064
Please refer to the end of the specification for access instructions.

LENGTHY TABLE REFERENCED HERE
US20070027787A1-20070201-T01065
Please refer to the end of the specification for access instructions.

LENGTHY TABLE REFERENCED HERE
US20070027787A1-20070201-T01066
Please refer to the end of the specification for access instructions.

LENGTHY TABLE REFERENCED HERE
US20070027787A1-20070201-T01067
Please refer to the end of the specification for access instructions.

LENGTHY TABLE REFERENCED HERE
US20070027787A1-20070201-T01068
Please refer to the end of the specification for access instructions.

LENGTHY TABLE REFERENCED HERE
US20070027787A1-20070201-T01069
Please refer to the end of the specification for access instructions.

LENGTHY TABLE REFERENCED HERE
US20070027787A1-20070201-T01070
Please refer to the end of the specification for access instructions.

LENGTHY TABLE REFERENCED HERE
US20070027787A1-20070201-T01071
Please refer to the end of the specification for access instructions.

LENGTHY TABLE REFERENCED HERE
US20070027787A1-20070201-T01072
Please refer to the end of the specification for access instructions.

LENGTHY TABLE REFERENCED HERE
US20070027787A1-20070201-T01073
Please refer to the end of the specification for access instructions.

LENGTHY TABLE REFERENCED HERE
US20070027787A1-20070201-T01074
Please refer to the end of the specification for access instructions.

LENGTHY TABLE REFERENCED HERE
US20070027787A1-20070201-T01075
Please refer to the end of the specification for access instructions.

LENGTHY TABLE REFERENCED HERE
US20070027787A1-20070201-T01076
Please refer to the end of the specification for access instructions.

LENGTHY TABLE REFERENCED HERE
US20070027787A1-20070201-T01077
Please refer to the end of the specification for access instructions.

LENGTHY TABLE REFERENCED HERE
US20070027787A1-20070201-T01078
Please refer to the end of the specification for access instructions.

LENGTHY TABLE REFERENCED HERE
US20070027787A1-20070201-T01079
Please refer to the end of the specification for access instructions.

LENGTHY TABLE REFERENCED HERE
US20070027787A1-20070201-T01080
Please refer to the end of the specification for access instructions.

LENGTHY TABLE REFERENCED HERE
US20070027787A1-20070201-T01081
Please refer to the end of the specification for access instructions.

LENGTHY TABLE REFERENCED HERE
US20070027787A1-20070201-T01082
Please refer to the end of the specification for access instructions.

LENGTHY TABLE REFERENCED HERE
US20070027787A1-20070201-T01083
Please refer to the end of the specification for access instructions.

LENGTHY TABLE REFERENCED HERE
US20070027787A1-20070201-T01084
Please refer to the end of the specification for access instructions.

LENGTHY TABLE REFERENCED HERE
US20070027787A1-20070201-T01085
Please refer to the end of the specification for access instructions.

LENGTHY TABLE REFERENCED HERE
US20070027787A1-20070201-T01086
Please refer to the end of the specification for access instructions.

LENGTHY TABLE REFERENCED HERE
US20070027787A1-20070201-T01087
Please refer to the end of the specification for access instructions.

LENGTHY TABLE REFERENCED HERE
US20070027787A1-20070201-T01088
Please refer to the end of the specification for access instructions.

LENGTHY TABLE REFERENCED HERE
US20070027787A1-20070201-T01089
Please refer to the end of the specification for access instructions.

LENGTHY TABLE REFERENCED HERE
US20070027787A1-20070201-T01090
Please refer to the end of the specification for access instructions.

LENGTHY TABLE REFERENCED HERE
US20070027787A1-20070201-T01091
Please refer to the end of the specification for access instructions.

LENGTHY TABLE REFERENCED HERE
US20070027787A1-20070201-T01092
Please refer to the end of the specification for access instructions.

LENGTHY TABLE REFERENCED HERE
US20070027787A1-20070201-T01093
Please refer to the end of the specification for access instructions.

LENGTHY TABLE REFERENCED HERE
US20070027787A1-20070201-T01094
Please refer to the end of the specification for access instructions.

LENGTHY TABLE REFERENCED HERE
US20070027787A1-20070201-T01095
Please refer to the end of the specification for access instructions.

LENGTHY TABLE REFERENCED HERE
US20070027787A1-20070201-T01096
Please refer to the end of the specification for access instructions.

LENGTHY TABLE REFERENCED HERE
US20070027787A1-20070201-T01097
Please refer to the end of the specification for access instructions.

LENGTHY TABLE REFERENCED HERE
US20070027787A1-20070201-T01098
Please refer to the end of the specification for access instructions.

LENGTHY TABLE REFERENCED HERE
US20070027787A1-20070201-T01099
Please refer to the end of the specification for access instructions.

LENGTHY TABLE REFERENCED HERE
US20070027787A1-20070201-T01100
Please refer to the end of the specification for access instructions.

LENGTHY TABLE REFERENCED HERE
US20070027787A1-20070201-T01101
Please refer to the end of the specification for access instructions.

LENGTHY TABLE REFERENCED HERE
US20070027787A1-20070201-T01102
Please refer to the end of the specification for access instructions.

LENGTHY TABLE REFERENCED HERE
US20070027787A1-20070201-T01103
Please refer to the end of the specification for access instructions.

LENGTHY TABLE REFERENCED HERE
US20070027787A1-20070201-T01104
Please refer to the end of the specification for access instructions.

LENGTHY TABLE REFERENCED HERE
US20070027787A1-20070201-T01105
Please refer to the end of the specification for access instructions.

LENGTHY TABLE REFERENCED HERE
US20070027787A1-20070201-T01106
Please refer to the end of the specification for access instructions.

LENGTHY TABLE REFERENCED HERE
US20070027787A1-20070201-T01107
Please refer to the end of the specification for access instructions.

LENGTHY TABLE REFERENCED HERE
US20070027787A1-20070201-T01108
Please refer to the end of the specification for access instructions.

LENGTHY TABLE REFERENCED HERE
US20070027787A1-20070201-T01109
Please refer to the end of the specification for access instructions.

LENGTHY TABLE REFERENCED HERE
US20070027787A1-20070201-T01110
Please refer to the end of the specification for access instructions.

LENGTHY TABLE REFERENCED HERE
US20070027787A1-20070201-T01111
Please refer to the end of the specification for access instructions.

LENGTHY TABLE REFERENCED HERE
US20070027787A1-20070201-T01112
Please refer to the end of the specification for access instructions.

LENGTHY TABLE REFERENCED HERE
US20070027787A1-20070201-T01113
Please refer to the end of the specification for access instructions.

LENGTHY TABLE REFERENCED HERE
US20070027787A1-20070201-T01114
Please refer to the end of the specification for access instructions.

LENGTHY TABLE REFERENCED HERE
US20070027787A1-20070201-T01115
Please refer to the end of the specification for access instructions.

LENGTHY TABLE REFERENCED HERE
US20070027787A1-20070201-T01116
Please refer to the end of the specification for access instructions.

LENGTHY TABLE REFERENCED HERE
US20070027787A1-20070201-T01117
Please refer to the end of the specification for access instructions.

LENGTHY TABLE REFERENCED HERE
US20070027787A1-20070201-T01118
Please refer to the end of the specification for access instructions.

LENGTHY TABLE REFERENCED HERE
US20070027787A1-20070201-T01119
Please refer to the end of the specification for access instructions.

LENGTHY TABLE REFERENCED HERE
US20070027787A1-20070201-T01120
Please refer to the end of the specification for access instructions.

LENGTHY TABLE REFERENCED HERE
US20070027787A1-20070201-T01121
Please refer to the end of the specification for access instructions.

LENGTHY TABLE REFERENCED HERE
US20070027787A1-20070201-T01122
Please refer to the end of the specification for access instructions.

LENGTHY TABLE REFERENCED HERE
US20070027787A1-20070201-T01123
Please refer to the end of the specification for access instructions.

LENGTHY TABLE REFERENCED HERE
US20070027787A1-20070201-T01124
Please refer to the end of the specification for access instructions.

LENGTHY TABLE REFERENCED HERE
US20070027787A1-20070201-T01125
Please refer to the end of the specification for access instructions.

LENGTHY TABLE REFERENCED HERE
US20070027787A1-20070201-T01126
Please refer to the end of the specification for access instructions.

LENGTHY TABLE REFERENCED HERE
US20070027787A1-20070201-T01127
Please refer to the end of the specification for access instructions.

LENGTHY TABLE REFERENCED HERE
US20070027787A1-20070201-T01128
Please refer to the end of the specification for access instructions.

LENGTHY TABLE REFERENCED HERE
US20070027787A1-20070201-T01129
Please refer to the end of the specification for access instructions.

LENGTHY TABLE REFERENCED HERE
US20070027787A1-20070201-T01130
Please refer to the end of the specification for access instructions.

LENGTHY TABLE REFERENCED HERE
US20070027787A1-20070201-T01131
Please refer to the end of the specification for access instructions.

LENGTHY TABLE REFERENCED HERE
US20070027787A1-20070201-T01132
Please refer to the end of the specification for access instructions.

LENGTHY TABLE REFERENCED HERE
US20070027787A1-20070201-T01133
Please refer to the end of the specification for access instructions.

LENGTHY TABLE REFERENCED HERE
US20070027787A1-20070201-T01134
Please refer to the end of the specification for access instructions.

LENGTHY TABLE REFERENCED HERE
US20070027787A1-20070201-T01135
Please refer to the end of the specification for access instructions.

LENGTHY TABLE REFERENCED HERE
US20070027787A1-20070201-T01136
Please refer to the end of the specification for access instructions.

LENGTHY TABLE REFERENCED HERE
US20070027787A1-20070201-T01137
Please refer to the end of the specification for access instructions.

LENGTHY TABLE REFERENCED HERE
US20070027787A1-20070201-T01138
Please refer to the end of the specification for access instructions.

LENGTHY TABLE REFERENCED HERE
US20070027787A1-20070201-T01139
Please refer to the end of the specification for access instructions.

LENGTHY TABLE REFERENCED HERE
US20070027787A1-20070201-T01140
Please refer to the end of the specification for access instructions.

LENGTHY TABLE REFERENCED HERE
US20070027787A1-20070201-T01141
Please refer to the end of the specification for access instructions.

LENGTHY TABLE REFERENCED HERE
US20070027787A1-20070201-T01142
Please refer to the end of the specification for access instructions.

LENGTHY TABLE REFERENCED HERE
US20070027787A1-20070201-T01143
Please refer to the end of the specification for access instructions.

LENGTHY TABLE REFERENCED HERE
US20070027787A1-20070201-T01144
Please refer to the end of the specification for access instructions.

LENGTHY TABLE REFERENCED HERE
US20070027787A1-20070201-T01145
Please refer to the end of the specification for access instructions.

LENGTHY TABLE REFERENCED HERE
US20070027787A1-20070201-T01146
Please refer to the end of the specification for access instructions.

LENGTHY TABLE REFERENCED HERE
US20070027787A1-20070201-T01147
Please refer to the end of the specification for access instructions.

LENGTHY TABLE REFERENCED HERE
US20070027787A1-20070201-T01148
Please refer to the end of the specification for access instructions.

LENGTHY TABLE REFERENCED HERE
US20070027787A1-20070201-T01149
Please refer to the end of the specification for access instructions.

LENGTHY TABLE REFERENCED HERE
US20070027787A1-20070201-T01150
Please refer to the end of the specification for access instructions.

LENGTHY TABLE REFERENCED HERE
US20070027787A1-20070201-T01151
Please refer to the end of the specification for access instructions.

LENGTHY TABLE REFERENCED HERE
US20070027787A1-20070201-T01152
Please refer to the end of the specification for access instructions.

LENGTHY TABLE REFERENCED HERE
US20070027787A1-20070201-T01153
Please refer to the end of the specification for access instructions.

LENGTHY TABLE REFERENCED HERE
US20070027787A1-20070201-T01154
Please refer to the end of the specification for access instructions.

LENGTHY TABLE REFERENCED HERE
US20070027787A1-20070201-T01155
Please refer to the end of the specification for access instructions.

LENGTHY TABLE REFERENCED HERE
US20070027787A1-20070201-T01156
Please refer to the end of the specification for access instructions.

LENGTHY TABLE REFERENCED HERE
US20070027787A1-20070201-T01157
Please refer to the end of the specification for access instructions.

LENGTHY TABLE REFERENCED HERE
US20070027787A1-20070201-T01158
Please refer to the end of the specification for access instructions.

LENGTHY TABLE REFERENCED HERE
US20070027787A1-20070201-T01159
Please refer to the end of the specification for access instructions.

LENGTHY TABLE REFERENCED HERE
US20070027787A1-20070201-T01160
Please refer to the end of the specification for access instructions.

LENGTHY TABLE REFERENCED HERE
US20070027787A1-20070201-T01161
Please refer to the end of the specification for access instructions.

LENGTHY TABLE REFERENCED HERE
US20070027787A1-20070201-T01162
Please refer to the end of the specification for access instructions.

LENGTHY TABLE REFERENCED HERE
US20070027787A1-20070201-T01163
Please refer to the end of the specification for access instructions.

LENGTHY TABLE REFERENCED HERE
US20070027787A1-20070201-T01164
Please refer to the end of the specification for access instructions.

LENGTHY TABLE REFERENCED HERE
US20070027787A1-20070201-T01165
Please refer to the end of the specification for access instructions.

LENGTHY TABLE REFERENCED HERE
US20070027787A1-20070201-T01166
Please refer to the end of the specification for access instructions.

LENGTHY TABLE REFERENCED HERE
US20070027787A1-20070201-T01167
Please refer to the end of the specification for access instructions.

LENGTHY TABLE REFERENCED HERE
US20070027787A1-20070201-T01168
Please refer to the end of the specification for access instructions.

LENGTHY TABLE REFERENCED HERE
US20070027787A1-20070201-T01169
Please refer to the end of the specification for access instructions.

LENGTHY TABLE REFERENCED HERE
US20070027787A1-20070201-T01170
Please refer to the end of the specification for access instructions.

LENGTHY TABLE REFERENCED HERE
US20070027787A1-20070201-T01171
Please refer to the end of the specification for access instructions.

LENGTHY TABLE REFERENCED HERE
US20070027787A1-20070201-T01172
Please refer to the end of the specification for access instructions.

LENGTHY TABLE REFERENCED HERE
US20070027787A1-20070201-T01173
Please refer to the end of the specification for access instructions.

LENGTHY TABLE REFERENCED HERE
US20070027787A1-20070201-T01174
Please refer to the end of the specification for access instructions.

LENGTHY TABLE REFERENCED HERE
US20070027787A1-20070201-T01175
Please refer to the end of the specification for access instructions.

LENGTHY TABLE REFERENCED HERE
US20070027787A1-20070201-T01176
Please refer to the end of the specification for access instructions.

LENGTHY TABLE REFERENCED HERE
US20070027787A1-20070201-T01177
Please refer to the end of the specification for access instructions.

LENGTHY TABLE REFERENCED HERE
US20070027787A1-20070201-T01178
Please refer to the end of the specification for access instructions.

LENGTHY TABLE REFERENCED HERE
US20070027787A1-20070201-T01179
Please refer to the end of the specification for access instructions.

LENGTHY TABLE REFERENCED HERE
US20070027787A1-20070201-T01180
Please refer to the end of the specification for access instructions.

LENGTHY TABLE REFERENCED HERE
US20070027787A1-20070201-T01181
Please refer to the end of the specification for access instructions.

LENGTHY TABLE REFERENCED HERE
US20070027787A1-20070201-T01182
Please refer to the end of the specification for access instructions.

LENGTHY TABLE REFERENCED HERE
US20070027787A1-20070201-T01183
Please refer to the end of the specification for access instructions.

LENGTHY TABLE REFERENCED HERE
US20070027787A1-20070201-T01184
Please refer to the end of the specification for access instructions.

LENGTHY TABLE REFERENCED HERE
US20070027787A1-20070201-T01185
Please refer to the end of the specification for access instructions.

LENGTHY TABLE REFERENCED HERE
US20070027787A1-20070201-T01186
Please refer to the end of the specification for access instructions.

LENGTHY TABLE REFERENCED HERE
US20070027787A1-20070201-T01187
Please refer to the end of the specification for access instructions.

LENGTHY TABLE REFERENCED HERE
US20070027787A1-20070201-T01188
Please refer to the end of the specification for access instructions.

LENGTHY TABLE REFERENCED HERE
US20070027787A1-20070201-T01189
Please refer to the end of the specification for access instructions.

LENGTHY TABLE REFERENCED HERE
US20070027787A1-20070201-T01190
Please refer to the end of the specification for access instructions.

LENGTHY TABLE REFERENCED HERE
US20070027787A1-20070201-T01191
Please refer to the end of the specification for access instructions.

LENGTHY TABLE REFERENCED HERE
US20070027787A1-20070201-T01192
Please refer to the end of the specification for access instructions.

LENGTHY TABLE REFERENCED HERE
US20070027787A1-20070201-T01193
Please refer to the end of the specification for access instructions.

LENGTHY TABLE REFERENCED HERE
US20070027787A1-20070201-T01194
Please refer to the end of the specification for access instructions.

LENGTHY TABLE REFERENCED HERE
US20070027787A1-20070201-T01195
Please refer to the end of the specification for access instructions.

LENGTHY TABLE REFERENCED HERE
US20070027787A1-20070201-T01196
Please refer to the end of the specification for access instructions.

LENGTHY TABLE REFERENCED HERE
US20070027787A1-20070201-T01197
Please refer to the end of the specification for access instructions.

LENGTHY TABLE REFERENCED HERE
US20070027787A1-20070201-T01198
Please refer to the end of the specification for access instructions.

LENGTHY TABLE REFERENCED HERE
US20070027787A1-20070201-T01199
Please refer to the end of the specification for access instructions.

LENGTHY TABLE REFERENCED HERE
US20070027787A1-20070201-T01200
Please refer to the end of the specification for access instructions.

LENGTHY TABLE REFERENCED HERE
US20070027787A1-20070201-T01201
Please refer to the end of the specification for access instructions.

LENGTHY TABLE REFERENCED HERE
US20070027787A1-20070201-T01202
Please refer to the end of the specification for access instructions.

LENGTHY TABLE REFERENCED HERE
US20070027787A1-20070201-T01203
Please refer to the end of the specification for access instructions.

LENGTHY TABLE REFERENCED HERE
US20070027787A1-20070201-T01204
Please refer to the end of the specification for access instructions.

LENGTHY TABLE REFERENCED HERE
US20070027787A1-20070201-T01205
Please refer to the end of the specification for access instructions.

LENGTHY TABLE REFERENCED HERE
US20070027787A1-20070201-T01206
Please refer to the end of the specification for access instructions.

LENGTHY TABLE REFERENCED HERE
US20070027787A1-20070201-T01207
Please refer to the end of the specification for access instructions.

LENGTHY TABLE REFERENCED HERE
US20070027787A1-20070201-T01208
Please refer to the end of the specification for access instructions.

LENGTHY TABLE REFERENCED HERE
US20070027787A1-20070201-T01209
Please refer to the end of the specification for access instructions.

LENGTHY TABLE REFERENCED HERE
US20070027787A1-20070201-T01210
Please refer to the end of the specification for access instructions.

LENGTHY TABLE REFERENCED HERE
US20070027787A1-20070201-T01211
Please refer to the end of the specification for access instructions.

LENGTHY TABLE REFERENCED HERE
US20070027787A1-20070201-T01212
Please refer to the end of the specification for access instructions.

LENGTHY TABLE REFERENCED HERE
US20070027787A1-20070201-T01213
Please refer to the end of the specification for access instructions.

LENGTHY TABLE REFERENCED HERE
US20070027787A1-20070201-T01214
Please refer to the end of the specification for access instructions.

LENGTHY TABLE REFERENCED HERE
US20070027787A1-20070201-T01215
Please refer to the end of the specification for access instructions.

LENGTHY TABLE REFERENCED HERE
US20070027787A1-20070201-T01216
Please refer to the end of the specification for access instructions.

LENGTHY TABLE REFERENCED HERE
US20070027787A1-20070201-T01217
Please refer to the end of the specification for access instructions.

LENGTHY TABLE REFERENCED HERE
US20070027787A1-20070201-T01218
Please refer to the end of the specification for access instructions.

LENGTHY TABLE REFERENCED HERE
US20070027787A1-20070201-T01219
Please refer to the end of the specification for access instructions.

LENGTHY TABLE REFERENCED HERE
US20070027787A1-20070201-T01220
Please refer to the end of the specification for access instructions.

LENGTHY TABLE REFERENCED HERE
US20070027787A1-20070201-T01221
Please refer to the end of the specification for access instructions.

LENGTHY TABLE REFERENCED HERE
US20070027787A1-20070201-T01222
Please refer to the end of the specification for access instructions.

LENGTHY TABLE REFERENCED HERE
US20070027787A1-20070201-T01223
Please refer to the end of the specification for access instructions.

LENGTHY TABLE REFERENCED HERE
US20070027787A1-20070201-T01224
Please refer to the end of the specification for access instructions.

LENGTHY TABLE REFERENCED HERE
US20070027787A1-20070201-T01225
Please refer to the end of the specification for access instructions.

LENGTHY TABLE REFERENCED HERE
US20070027787A1-20070201-T01226
Please refer to the end of the specification for access instructions.

LENGTHY TABLE REFERENCED HERE
US20070027787A1-20070201-T01227
Please refer to the end of the specification for access instructions.

LENGTHY TABLE REFERENCED HERE
US20070027787A1-20070201-T01228
Please refer to the end of the specification for access instructions.

LENGTHY TABLE REFERENCED HERE
US20070027787A1-20070201-T01229
Please refer to the end of the specification for access instructions.

LENGTHY TABLE REFERENCED HERE
US20070027787A1-20070201-T01230
Please refer to the end of the specification for access instructions.

LENGTHY TABLE REFERENCED HERE
US20070027787A1-20070201-T01231
Please refer to the end of the specification for access instructions.

LENGTHY TABLE REFERENCED HERE
US20070027787A1-20070201-T01232
Please refer to the end of the specification for access instructions.

LENGTHY TABLE REFERENCED HERE
US20070027787A1-20070201-T01233
Please refer to the end of the specification for access instructions.

LENGTHY TABLE REFERENCED HERE
US20070027787A1-20070201-T01234
Please refer to the end of the specification for access instructions.

LENGTHY TABLE REFERENCED HERE
US20070027787A1-20070201-T01235
Please refer to the end of the specification for access instructions.

LENGTHY TABLE REFERENCED HERE
US20070027787A1-20070201-T01236
Please refer to the end of the specification for access instructions.

LENGTHY TABLE REFERENCED HERE
US20070027787A1-20070201-T01237
Please refer to the end of the specification for access instructions.

LENGTHY TABLE REFERENCED HERE
US20070027787A1-20070201-T01238
Please refer to the end of the specification for access instructions.

LENGTHY TABLE REFERENCED HERE
US20070027787A1-20070201-T01239
Please refer to the end of the specification for access instructions.

LENGTHY TABLE REFERENCED HERE
US20070027787A1-20070201-T01240
Please refer to the end of the specification for access instructions.

LENGTHY TABLE REFERENCED HERE
US20070027787A1-20070201-T01241
Please refer to the end of the specification for access instructions.

LENGTHY TABLE REFERENCED HERE
US20070027787A1-20070201-T01242
Please refer to the end of the specification for access instructions.

LENGTHY TABLE REFERENCED HERE
US20070027787A1-20070201-T01243
Please refer to the end of the specification for access instructions.

LENGTHY TABLE REFERENCED HERE
US20070027787A1-20070201-T01244
Please refer to the end of the specification for access instructions.

LENGTHY TABLE REFERENCED HERE
US20070027787A1-20070201-T01245
Please refer to the end of the specification for access instructions.

LENGTHY TABLE REFERENCED HERE
US20070027787A1-20070201-T01246
Please refer to the end of the specification for access instructions.

LENGTHY TABLE REFERENCED HERE
US20070027787A1-20070201-T01247
Please refer to the end of the specification for access instructions.

LENGTHY TABLE REFERENCED HERE
US20070027787A1-20070201-T01248
Please refer to the end of the specification for access instructions.

LENGTHY TABLE REFERENCED HERE
US20070027787A1-20070201-T01249
Please refer to the end of the specification for access instructions.

LENGTHY TABLE REFERENCED HERE
US20070027787A1-20070201-T01250
Please refer to the end of the specification for access instructions.

LENGTHY TABLE REFERENCED HERE
US20070027787A1-20070201-T01251
Please refer to the end of the specification for access instructions.

LENGTHY TABLE REFERENCED HERE
US20070027787A1-20070201-T01252
Please refer to the end of the specification for access instructions.

LENGTHY TABLE REFERENCED HERE
US20070027787A1-20070201-T01253
Please refer to the end of the specification for access instructions.

LENGTHY TABLE REFERENCED HERE
US20070027787A1-20070201-T01254
Please refer to the end of the specification for access instructions.

LENGTHY TABLE REFERENCED HERE
US20070027787A1-20070201-T01255
Please refer to the end of the specification for access instructions.

LENGTHY TABLE REFERENCED HERE
US20070027787A1-20070201-T01256
Please refer to the end of the specification for access instructions.

LENGTHY TABLE REFERENCED HERE
US20070027787A1-20070201-T01257
Please refer to the end of the specification for access instructions.

LENGTHY TABLE REFERENCED HERE
US20070027787A1-20070201-T01258
Please refer to the end of the specification for access instructions.

LENGTHY TABLE REFERENCED HERE
US20070027787A1-20070201-T01259
Please refer to the end of the specification for access instructions.

LENGTHY TABLE REFERENCED HERE
US20070027787A1-20070201-T01260
Please refer to the end of the specification for access instructions.

LENGTHY TABLE REFERENCED HERE
US20070027787A1-20070201-T01261
Please refer to the end of the specification for access instructions.

LENGTHY TABLE REFERENCED HERE
US20070027787A1-20070201-T01262
Please refer to the end of the specification for access instructions.

LENGTHY TABLE REFERENCED HERE
US20070027787A1-20070201-T01263
Please refer to the end of the specification for access instructions.

LENGTHY TABLE REFERENCED HERE
US20070027787A1-20070201-T01264
Please refer to the end of the specification for access instructions.

LENGTHY TABLE REFERENCED HERE
US20070027787A1-20070201-T01265
Please refer to the end of the specification for access instructions.

LENGTHY TABLE REFERENCED HERE
US20070027787A1-20070201-T01266
Please refer to the end of the specification for access instructions.

LENGTHY TABLE REFERENCED HERE
US20070027787A1-20070201-T01267
Please refer to the end of the specification for access instructions.

LENGTHY TABLE REFERENCED HERE
US20070027787A1-20070201-T01268
Please refer to the end of the specification for access instructions.

LENGTHY TABLE REFERENCED HERE
US20070027787A1-20070201-T01269
Please refer to the end of the specification for access instructions.

LENGTHY TABLE REFERENCED HERE
US20070027787A1-20070201-T01270
Please refer to the end of the specification for access instructions.

LENGTHY TABLE REFERENCED HERE
US20070027787A1-20070201-T01271
Please refer to the end of the specification for access instructions.

LENGTHY TABLE REFERENCED HERE
US20070027787A1-20070201-T01272
Please refer to the end of the specification for access instructions.

LENGTHY TABLE REFERENCED HERE
US20070027787A1-20070201-T01273
Please refer to the end of the specification for access instructions.

LENGTHY TABLE REFERENCED HERE
US20070027787A1-20070201-T01274
Please refer to the end of the specification for access instructions.

LENGTHY TABLE REFERENCED HERE
US20070027787A1-20070201-T01275
Please refer to the end of the specification for access instructions.

LENGTHY TABLE REFERENCED HERE
US20070027787A1-20070201-T01276
Please refer to the end of the specification for access instructions.

LENGTHY TABLE REFERENCED HERE
US20070027787A1-20070201-T01277
Please refer to the end of the specification for access instructions.

LENGTHY TABLE REFERENCED HERE
US20070027787A1-20070201-T01278
Please refer to the end of the specification for access instructions.

LENGTHY TABLE REFERENCED HERE
US20070027787A1-20070201-T01279
Please refer to the end of the specification for access instructions.

LENGTHY TABLE REFERENCED HERE
US20070027787A1-20070201-T01280
Please refer to the end of the specification for access instructions.

LENGTHY TABLE REFERENCED HERE
US20070027787A1-20070201-T01281
Please refer to the end of the specification for access instructions.

LENGTHY TABLE REFERENCED HERE
US20070027787A1-20070201-T01282
Please refer to the end of the specification for access instructions.

LENGTHY TABLE REFERENCED HERE
US20070027787A1-20070201-T01283
Please refer to the end of the specification for access instructions.

LENGTHY TABLE REFERENCED HERE
US20070027787A1-20070201-T01284
Please refer to the end of the specification for access instructions.

LENGTHY TABLE REFERENCED HERE
US20070027787A1-20070201-T01285
Please refer to the end of the specification for access instructions.

LENGTHY TABLE REFERENCED HERE
US20070027787A1-20070201-T01286
Please refer to the end of the specification for access instructions.

LENGTHY TABLE REFERENCED HERE
US20070027787A1-20070201-T01287
Please refer to the end of the specification for access instructions.

LENGTHY TABLE REFERENCED HERE
US20070027787A1-20070201-T01288
Please refer to the end of the specification for access instructions.

LENGTHY TABLE REFERENCED HERE
US20070027787A1-20070201-T01289
Please refer to the end of the specification for access instructions.

LENGTHY TABLE REFERENCED HERE
US20070027787A1-20070201-T01290
Please refer to the end of the specification for access instructions.

LENGTHY TABLE REFERENCED HERE
US20070027787A1-20070201-T01291
Please refer to the end of the specification for access instructions.

LENGTHY TABLE REFERENCED HERE
US20070027787A1-20070201-T01292
Please refer to the end of the specification for access instructions.

LENGTHY TABLE REFERENCED HERE
US20070027787A1-20070201-T01293
Please refer to the end of the specification for access instructions.

LENGTHY TABLE REFERENCED HERE
US20070027787A1-20070201-T01294
Please refer to the end of the specification for access instructions.

LENGTHY TABLE REFERENCED HERE
US20070027787A1-20070201-T01295
Please refer to the end of the specification for access instructions.

LENGTHY TABLE REFERENCED HERE
US20070027787A1-20070201-T01296
Please refer to the end of the specification for access instructions.

LENGTHY TABLE REFERENCED HERE
US20070027787A1-20070201-T01297
Please refer to the end of the specification for access instructions.

LENGTHY TABLE REFERENCED HERE
US20070027787A1-20070201-T01298
Please refer to the end of the specification for access instructions.

LENGTHY TABLE REFERENCED HERE
US20070027787A1-20070201-T01299
Please refer to the end of the specification for access instructions.

LENGTHY TABLE REFERENCED HERE
US20070027787A1-20070201-T01300
Please refer to the end of the specification for access instructions.

LENGTHY TABLE REFERENCED HERE
US20070027787A1-20070201-T01301
Please refer to the end of the specification for access instructions.

LENGTHY TABLE REFERENCED HERE
US20070027787A1-20070201-T01302
Please refer to the end of the specification for access instructions.

LENGTHY TABLE REFERENCED HERE
US20070027787A1-20070201-T01303
Please refer to the end of the specification for access instructions.

LENGTHY TABLE REFERENCED HERE
US20070027787A1-20070201-T01304
Please refer to the end of the specification for access instructions.

LENGTHY TABLE REFERENCED HERE
US20070027787A1-20070201-T01305
Please refer to the end of the specification for access instructions.

LENGTHY TABLE REFERENCED HERE
US20070027787A1-20070201-T01306
Please refer to the end of the specification for access instructions.

LENGTHY TABLE REFERENCED HERE
US20070027787A1-20070201-T01307
Please refer to the end of the specification for access instructions.

LENGTHY TABLE REFERENCED HERE
US20070027787A1-20070201-T01308
Please refer to the end of the specification for access instructions.

LENGTHY TABLE REFERENCED HERE
US20070027787A1-20070201-T01309
Please refer to the end of the specification for access instructions.

LENGTHY TABLE REFERENCED HERE
US20070027787A1-20070201-T01310
Please refer to the end of the specification for access instructions.

LENGTHY TABLE REFERENCED HERE
US20070027787A1-20070201-T01311
Please refer to the end of the specification for access instructions.

LENGTHY TABLE REFERENCED HERE
US20070027787A1-20070201-T01312
Please refer to the end of the specification for access instructions.

LENGTHY TABLE REFERENCED HERE
US20070027787A1-20070201-T01313
Please refer to the end of the specification for access instructions.

LENGTHY TABLE REFERENCED HERE
US20070027787A1-20070201-T01314
Please refer to the end of the specification for access instructions.

LENGTHY TABLE REFERENCED HERE
US20070027787A1-20070201-T01315
Please refer to the end of the specification for access instructions.

LENGTHY TABLE REFERENCED HERE
US20070027787A1-20070201-T01316
Please refer to the end of the specification for access instructions.

LENGTHY TABLE REFERENCED HERE
US20070027787A1-20070201-T01317
Please refer to the end of the specification for access instructions.

LENGTHY TABLE REFERENCED HERE
US20070027787A1-20070201-T01318
Please refer to the end of the specification for access instructions.

LENGTHY TABLE REFERENCED HERE
US20070027787A1-20070201-T01319
Please refer to the end of the specification for access instructions.

LENGTHY TABLE REFERENCED HERE
US20070027787A1-20070201-T01320
Please refer to the end of the specification for access instructions.

LENGTHY TABLE REFERENCED HERE
US20070027787A1-20070201-T01321
Please refer to the end of the specification for access instructions.

LENGTHY TABLE REFERENCED HERE
US20070027787A1-20070201-T01322
Please refer to the end of the specification for access instructions.

LENGTHY TABLE REFERENCED HERE
US20070027787A1-20070201-T01323
Please refer to the end of the specification for access instructions.

LENGTHY TABLE REFERENCED HERE
US20070027787A1-20070201-T01324
Please refer to the end of the specification for access instructions.

LENGTHY TABLE REFERENCED HERE
US20070027787A1-20070201-T01325
Please refer to the end of the specification for access instructions.

LENGTHY TABLE REFERENCED HERE
US20070027787A1-20070201-T01326
Please refer to the end of the specification for access instructions.

LENGTHY TABLE REFERENCED HERE
US20070027787A1-20070201-T01327
Please refer to the end of the specification for access instructions.

LENGTHY TABLE REFERENCED HERE
US20070027787A1-20070201-T01328
Please refer to the end of the specification for access instructions.

LENGTHY TABLE REFERENCED HERE
US20070027787A1-20070201-T01329
Please refer to the end of the specification for access instructions.

LENGTHY TABLE REFERENCED HERE
US20070027787A1-20070201-T01330
Please refer to the end of the specification for access instructions.

LENGTHY TABLE REFERENCED HERE
US20070027787A1-20070201-T01331
Please refer to the end of the specification for access instructions.

LENGTHY TABLE REFERENCED HERE
US20070027787A1-20070201-T01332
Please refer to the end of the specification for access instructions.

LENGTHY TABLE REFERENCED HERE
US20070027787A1-20070201-T01333
Please refer to the end of the specification for access instructions.

LENGTHY TABLE REFERENCED HERE
US20070027787A1-20070201-T01334
Please refer to the end of the specification for access instructions.

LENGTHY TABLE REFERENCED HERE
US20070027787A1-20070201-T01335
Please refer to the end of the specification for access instructions.

LENGTHY TABLE REFERENCED HERE
US20070027787A1-20070201-T01336
Please refer to the end of the specification for access instructions.

LENGTHY TABLE REFERENCED HERE
US20070027787A1-20070201-T01337
Please refer to the end of the specification for access instructions.

LENGTHY TABLE REFERENCED HERE
US20070027787A1-20070201-T01338
Please refer to the end of the specification for access instructions.

LENGTHY TABLE REFERENCED HERE
US20070027787A1-20070201-T01339
Please refer to the end of the specification for access instructions.

LENGTHY TABLE REFERENCED HERE
US20070027787A1-20070201-T01340
Please refer to the end of the specification for access instructions.

LENGTHY TABLE REFERENCED HERE
US20070027787A1-20070201-T01341
Please refer to the end of the specification for access instructions.

LENGTHY TABLE REFERENCED HERE
US20070027787A1-20070201-T01342
Please refer to the end of the specification for access instructions.

LENGTHY TABLE REFERENCED HERE
US20070027787A1-20070201-T01343
Please refer to the end of the specification for access instructions.

LENGTHY TABLE REFERENCED HERE
US20070027787A1-20070201-T01344
Please refer to the end of the specification for access instructions.

LENGTHY TABLE REFERENCED HERE
US20070027787A1-20070201-T01345
Please refer to the end of the specification for access instructions.

LENGTHY TABLE REFERENCED HERE
US20070027787A1-20070201-T01346
Please refer to the end of the specification for access instructions.

LENGTHY TABLE REFERENCED HERE
US20070027787A1-20070201-T01347
Please refer to the end of the specification for access instructions.

LENGTHY TABLE REFERENCED HERE
US20070027787A1-20070201-T01348
Please refer to the end of the specification for access instructions.

LENGTHY TABLE REFERENCED HERE
US20070027787A1-20070201-T01349
Please refer to the end of the specification for access instructions.

LENGTHY TABLE REFERENCED HERE
US20070027787A1-20070201-T01350
Please refer to the end of the specification for access instructions.

LENGTHY TABLE REFERENCED HERE
US20070027787A1-20070201-T01351
Please refer to the end of the specification for access instructions.

LENGTHY TABLE REFERENCED HERE
US20070027787A1-20070201-T01352
Please refer to the end of the specification for access instructions.

LENGTHY TABLE REFERENCED HERE
US20070027787A1-20070201-T01353
Please refer to the end of the specification for access instructions.

LENGTHY TABLE REFERENCED HERE
US20070027787A1-20070201-T01354
Please refer to the end of the specification for access instructions.

LENGTHY TABLE REFERENCED HERE
US20070027787A1-20070201-T01355
Please refer to the end of the specification for access instructions.

LENGTHY TABLE REFERENCED HERE
US20070027787A1-20070201-T01356
Please refer to the end of the specification for access instructions.

LENGTHY TABLE REFERENCED HERE
US20070027787A1-20070201-T01357
Please refer to the end of the specification for access instructions.

LENGTHY TABLE REFERENCED HERE
US20070027787A1-20070201-T01358
Please refer to the end of the specification for access instructions.

LENGTHY TABLE REFERENCED HERE
US20070027787A1-20070201-T01359
Please refer to the end of the specification for access instructions.

LENGTHY TABLE REFERENCED HERE
US20070027787A1-20070201-T01360
Please refer to the end of the specification for access instructions.

LENGTHY TABLE REFERENCED HERE
US20070027787A1-20070201-T01361
Please refer to the end of the specification for access instructions.

LENGTHY TABLE REFERENCED HERE
US20070027787A1-20070201-T01362
Please refer to the end of the specification for access instructions.

LENGTHY TABLE REFERENCED HERE
US20070027787A1-20070201-T01363
Please refer to the end of the specification for access instructions.

LENGTHY TABLE REFERENCED HERE
US20070027787A1-20070201-T01364
Please refer to the end of the specification for access instructions.

LENGTHY TABLE REFERENCED HERE
US20070027787A1-20070201-T01365
Please refer to the end of the specification for access instructions.

LENGTHY TABLE REFERENCED HERE
US20070027787A1-20070201-T01366
Please refer to the end of the specification for access instructions.

LENGTHY TABLE REFERENCED HERE
US20070027787A1-20070201-T01367
Please refer to the end of the specification for access instructions.

LENGTHY TABLE REFERENCED HERE
US20070027787A1-20070201-T01368
Please refer to the end of the specification for access instructions.

LENGTHY TABLE REFERENCED HERE
US20070027787A1-20070201-T01369
Please refer to the end of the specification for access instructions.

LENGTHY TABLE REFERENCED HERE
US20070027787A1-20070201-T01370
Please refer to the end of the specification for access instructions.

LENGTHY TABLE REFERENCED HERE
US20070027787A1-20070201-T01371
Please refer to the end of the specification for access instructions.

LENGTHY TABLE REFERENCED HERE
US20070027787A1-20070201-T01372
Please refer to the end of the specification for access instructions.

LENGTHY TABLE REFERENCED HERE
US20070027787A1-20070201-T01373
Please refer to the end of the specification for access instructions.

LENGTHY TABLE REFERENCED HERE
US20070027787A1-20070201-T01374
Please refer to the end of the specification for access instructions.

LENGTHY TABLE REFERENCED HERE
US20070027787A1-20070201-T01375
Please refer to the end of the specification for access instructions.

LENGTHY TABLE REFERENCED HERE
US20070027787A1-20070201-T01376
Please refer to the end of the specification for access instructions.

LENGTHY TABLE REFERENCED HERE
US20070027787A1-20070201-T01377
Please refer to the end of the specification for access instructions.

LENGTHY TABLE
The patent application contains a lengthy table section. A copy of the table is available in electronic form from the USPTO web site (http://seqdata.uspto.gov/?pageRequest=docDetail&DocID=US20070027787A1) An electronic copy of the table will also be available from the USPTO upon request and payment of the fee set forth in 37 CFR 1.19(b)(3).

What is claimed:

1. A data processing method for introducing an asset-backed fixed-income security that will function as a master real currency unit with a constant value, comprising the steps of:
1) tracking by means of a digital computer, the flow of quantitative data generated by originating financial instruments that are denominated in a real currency unit, and amortized with a real rate of interest,
2) tracking by means of a digital computer pooling the real financial instruments for the purpose of establishing a tax conduit to issue asset-backed securities,
3) tracking by means of a digital computer, the flow of quantitative data generated by using structured financing, such that the conduit issues a class of regular certificates, and a residual class of certificates, as follows:
a) Class “A” Certificates with a priority of payment, which will receive a real-principal-only (RPO) cash flow stream,
b) Class “R” Certificates that are subordinate to the Class “A” Certificates, which will receive a residual cash flow, and then
4) denominating the Class “A” certificates in a master real currency unit, which can then be used by the holders to represent and transfer purchasing power in a constant monetary unit.

2. The data processing method of claim 1, whereby one, or more, additional classes of regular certificates are issued, that are:
1) subordinate to the Class “A” Certificates,
2) subordinate in order of designation to each prior class of regular certificates, but then
3) having a priority of payment over the residual certificates,
whereby the subordinate regular certificate class(es) issued, share in some, or all, of the class flows generated by a real-interest-only (RIO) cash flow stream.
